(19) United States
(12) Patent Application Publication
(10) Pub. No.: US 2025/0361333 A1
(43) Pub. Date: Nov. 27, 2025

(54) METHODS FOR PREPARING COPOLYMERS AND FOR THE OXIDATIVE DEGRADATION THEREOF

(71) Applicant: UNIVERSITY OF HOUSTON SYSTEM, Houston, TX (US)

(72) Inventors: Loi H. Do, Manvel, TX (US); Tuhin Ganguly, Houston, TX (US); Lorenzo C. Ruiz De Castilla, Splendora, TX (US)

(73) Assignee: UNIVERSITY OF HOUSTON SYSTEM, Houston, TX (US)

(21) Appl. No.: 19/238,788

(22) Filed: Jun. 16, 2025

Related U.S. Application Data
(63) Continuation-in-part of application No. 18/734,299, filed on Jun. 5, 2024.
Application No. 18/734,299 is a continuation of application No. 17/982,767, filed on Nov. 8, 2022, now Pat. No. 12,049,532.
(60) Provisional application No. 63/392,560, filed on Jul. 27, 2022.
(60) Provisional application No. 63/402,749, filed on Aug. 31, 2022.
(60) Provisional application No. 63/662,991, filed on Jun. 21, 2024.
(60) Provisional application No. 63/779,550, filed on Mar. 28, 2025.

(51) Int. Cl. C08F 4/70; C08F 2/06; C08F 10/02; C08F 210/02

(52) U.S. Cl. CPC C08F 4/7098; C08F 2/06; C08F 10/02; C08F 210/02

(57) ABSTRACT

This invention relates to nickel catalysts with alkali ions for homopolymerization and copolymerization. This invention also relates to methods of preparing copolymers and to methods of degrading copolymers.

### CROSS-REFERENCE TO RELATED APPLICATIONS

This application claims the benefit of priority under 35 U.S.C. § 120 as a continuation-in-part application of U.S. patent application Ser. No. 18/734,299 filed Jun. 5, 2024, which is a continuation of U.S. patent application Ser. No. 17/982,767 filed Nov. 8, 2022, now U.S. Pat. No. 12,049,532, which claims the benefit of priority under 35 U.S.C. § 119 (e) of U.S. Provisional Patent Application No. 63/392,560 filed Jul. 27, 2022, and U.S. Provisional Patent Application No. 63/402,749 filed Aug. 31, 2022; and also claims the benefit of priority under 35 U.S.C. § 119 (e) of U.S. Provisional Patent Application No. 63/662,991 filed Jun. 21, 2024, and U.S. Provisional Patent Application No. 63/779,550 filed Mar. 28, 2025, all of which are incorporated herein by reference in their entirety.

### STATEMENT REGARDING FEDERALLY SPONSORED RESEARCH OR DEVELOPMENT

This invention was made with government support under Grant Nos. CHE-1750411 and CHE-2154532 awarded by the National Science Foundation. The government has certain rights in the invention.

### FIELD OF THE INVENTION

This invention relates to nickel catalysts with alkali ions for homopolymerization and copolymerization. This invention also relates to methods of preparing copolymers and to methods of degrading copolymers.

### BACKGROUND

All publications herein are incorporated by reference to the same extent as if each individual publication or patent application was specifically and individually indicated to be incorporated by reference. The following description includes information that may be useful in understanding the present invention. It is not an admission that any of the information provided herein is prior art or relevant to the presently claimed invention, or that any publication specifically or implicitly referenced is prior art.

Controlling the chain growth process in non-living polymerization reactions is a problem because chain termination typically occurs faster than the time it takes to apply external stimuli. Therefore, there is an ongoing need for improvements in order to better understand how to control the chain growth process in non-living polymerization reactions. The embodiments of the present invention address that need.

In addition, industrial synthesis of functional polyolefins relies on free radical polymerization, which requires high temperature and pressure and offers poor microstructure control. Therefore, there is an ongoing need for improved methods for preparing copolymers, for example functional polyolefins, with improved degradability. The embodiments of the present invention address that need.

### SUMMARY OF THE INVENTION

The following embodiments and aspects thereof are described and illustrated in conjunction with compositions, methods, and articles of manufacture which are meant to be exemplary and illustrative, not limiting in scope.

In various embodiments, the present invention provides a bimetallic catalyst complex having a structure selected from Formula (5) and Formula (6):

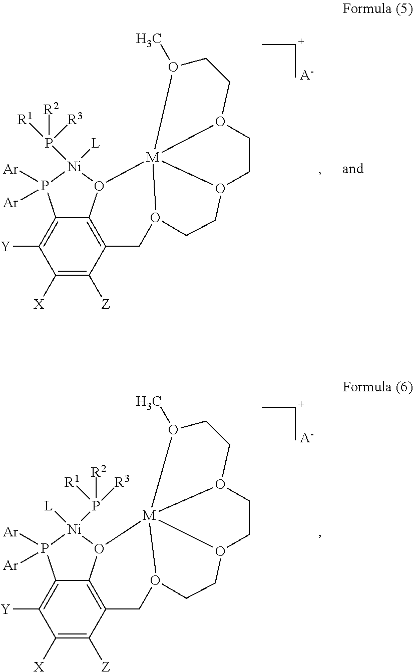

wherein in Formula (5) and Formula (6): Ar is 2,6-dimethoxyphenyl; L is an optionally substituted phenyl group; M is Li, Na, K, or Cs; A⁻ is a weakly coordinating anion; X, Y, and Z are each independently selected from hydrogen, an electron donating group, and an electron withdrawing group; and R¹, R², and R³ are each independently selected from optionally substituted aryl, optionally substituted alkyl, and optionally substituted cycloalkyl. In some embodiments, the electron donating group is selected from the group consisting of: alkoxy, phenoxy, amino, alkylamino, dialkylamino, hydroxy, alkyl, and cycloalkyl; and the the electron withdrawing group is selected from the group consisting of: NO₂, —CN, —C(O)-alkyl, C(O)Oalkyl, C(O)Nalkyl, —SO₃H, —SO₂alkyl, —PO₃H, —PO₃alkyl, —CF₃, and halo. In some embodiments, Ar is 2,6-dimethoxyphenyl; L is a phenyl group; M is Li, Na, K, or Cs; A⁻ is [(3,5-(CF₃)₂C₆H₃)₄B]⁻; X is methyl; Y is hydrogen; Z is hydrogen; and R¹, R², and R³ are each methyl.

In various embodiments, the present invention provides a method for catalyzing homopolymerization of an optionally substituted olefin, comprising: contacting an optionally substituted olefin with the bimetallic catalyst complex of Formula (5) and/or Formula (6), whereby the optionally substituted olefin undergoes homopolymerization. In some embodiments, the step of contacting the optionally substituted olefin with the bimetallic catalyst complex is performed in the presence of at least one solvent. In some embodiments, the at least one solvent is a non-polar solvent, a polar solvent, or combination thereof. In some embodiments the method further comprises contacting at least one activator with the bimetallic catalyst complex and the optionally substituted olefin. In some embodiments, the at least one activator is selected from the group consisting of Ni(COD)₂, triarylborane, methylaluminoxane, and trialkylaluminum. In some embodiments, the optionally substituted olefin is an optionally substituted terminal olefin or an optionally substituted internal olefin. In some embodiments, the optionally substituted olefin is ethylene.

In various embodiments, the present invention provides a polymer formed by the method for catalyzing homopolymerization of an optionally substituted olefin. In some embodiments, the polymer is monomodal or bimodal.

In various embodiments, the present invention provides a method for catalyzing copolymerization of a first optionally substituted olefin and at least one other optionally substituted olefin, comprising: contacting a first optionally substituted olefin and at least one other optionally substituted olefin with the bimetallic catalyst complex of Formula (5) and/or Formula (6), whereby the first optionally substituted olefin and the at least one other optionally substituted olefin undergoes copolymerization, and wherein the first optionally substituted olefin and the at least one other optionally substituted olefin are different from one another. In some embodiments, the step of contacting the first optionally substituted olefin and the at least one other optionally substituted olefin with the bimetallic catalyst complex is performed in the presence of at least one solvent. In some embodiments, the at least one solvent is a non-polar solvent, a polar solvent, or combination thereof. In some embodiments, the method further comprises contacting at least one activator with the bimetallic catalyst complex, the first optionally substituted olefin, and the at least one other optionally substituted olefin. In some embodiments, the at least one activator is selected from the group consisting of Ni(COD)₂, triarylborane, methylaluminoxane, and trialkylaluminum. In some embodiments, the first optionally substituted olefin and the at least one other optionally substituted olefin are each independently an optionally substituted terminal olefin or an optionally substituted internal olefin.

In various embodiments, the present invention provides a copolymer formed by the method for catalyzing copolymerization of a first optionally substituted olefin and at least one other optionally substituted olefin. In some embodiments, the copolymer is monomodal or bimodal.

In various embodiments, the present invention provides a method for catalyzing copolymerization of a first optionally substituted olefin and at least one other optionally substituted olefin, comprising: providing at least one catalyst having a structure selected from Formula (1) and Formula (2):

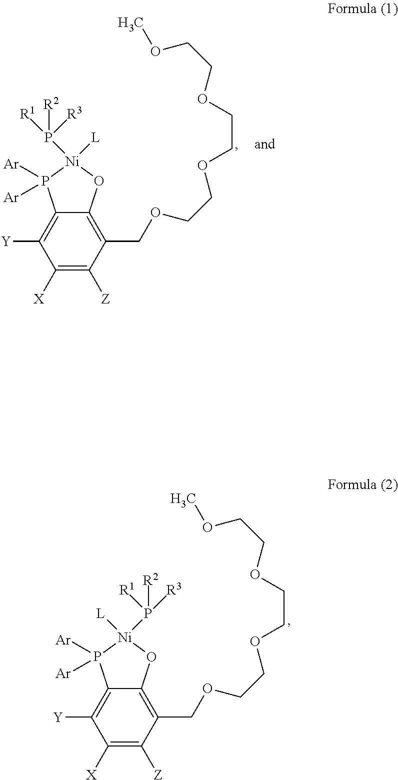

wherein in Formula (1) and Formula (2):
Ar is 2,6-dimethoxyphenyl or 2-methoxyphenyl;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl;
providing at least one alkali salt;
providing a first optionally substituted olefin;
providing at least one other optionally substituted olefin, wherein the at least one other optionally substituted olefin is an acrylamide, acrylic acid, acrylic ester, vinyl halide, vinyl alcohol, or allyl alcohol; and contacting the first optionally substituted olefin and the at least one other optionally substituted olefin with the at least one catalyst and the at least one alkali salt, whereby the first optionally substituted olefin and the at least one other optionally substituted olefin undergoes copolymerization to form a copolymer, and wherein the first optionally substituted olefin and the at least one other optionally substituted olefin are different from one another.

In some embodiments, X is selected from hydrogen, an electron donating group, and an electron withdrawing group; and Y and Z are each independently selected from hydrogen, an electron donating group, and an electron withdrawing group, provided that Y and Z are not both hydrogen.

In some embodiments, the electron donating group is selected from the group consisting of: alkoxy, phenoxy, amino, alkylamino, dialkylamino, hydroxy, alkyl, and cycloalkyl; and the electron withdrawing group is selected from the group consisting of: —NO₂, —CN, —C(O)-alkyl, —C(O)Oalkyl, —C(O)Nalkyl, —SO₃H, —SO₂alkyl, —PO₃H, —PO₃alkyl, —CF₃, and -halo.

In some embodiments, the at least one alkali salt comprises an alkali cation and a weakly coordinating anion. In some embodiments, the alkali cation is Li+, Na+, K+, or Cs+. In some embodiments, the weakly coordinating anion is tetrakis(3,5-bis(trifluoromethyl)phenyl)borate, tetrakis(pentafluorophenyl)borate, tetraphenylborate, trifluoromethylsulfonate, hexafluorophosphate, hexafluoroantimonate, or tetrafluoroborate.

In some embodiments, the at least one alkali salt is lithium tetrakis(3,5-bis(trifluoromethyl)phenyl)borate, sodium tetrakis(3,5-bis(trifluoromethyl)phenyl)borate, potassium tetrakis(3,5-bis(trifluoromethyl)phenyl)borate, or cesium tetrakis(3,5-bis(trifluoromethyl)phenyl)borate, or any combination thereof.

In some embodiments, the first optionally substituted olefin is ethylene, propene, butene, 1-hexene, 1-heptene, 1-octene, styrene, allylbenzene, 2-hexene, 3-hexene, 2-heptene, 3-heptene, 2-octene, 3-octene, or 4-octene. In some embodiments, the first optionally substituted olefin is ethylene.

In some embodiments, the at least one other optionally substituted olefin is an acrylic ester. In some embodiments, the acrylic ester is methyl acrylate, ethyl acrylate, n-propyl acrylate, isopropyl acrylate, n-butyl acrylate, isobutyl acrylate, or tert-butyl acrylate, or any combination thereof.

In some embodiments, the step of contacting the first optionally substituted olefin and the at least one other optionally substituted olefin with the at least one catalyst and the at least one alkali salt is performed in the presence of at least one solvent. In some embodiments, the at least one solvent is a non-polar solvent, a polar solvent, or combination thereof.

In some embodiments, the method further comprises contacting at least one activator with the at least one catalyst, the at least one alkali salt, the first optionally substituted olefin, and the at least one other optionally substituted olefin. In some embodiments, the at least one activator is selected from the group consisting of Ni(COD)₂, triarylborane, methylaluminoxane, and trialkylaluminum.

In some embodiments, the method further comprises contacting the copolymer with at least one peroxide. In some embodiments, the at least one peroxide is at least one organic peroxide, at least one inorganic peroxide, or any combination thereof. In some embodiments, the at least one peroxide is tert-butylperoxy 2-ethylhexyl carbonate, dicumyl peroxide, polyether poly(t-butyl)-peroxycarbonate, or t-amyl peroxyacetate.

Exemplary embodiments are illustrated in referenced figures. It is intended that the embodiments and figures disclosed herein are to be considered illustrative rather than restrictive.

### BRIEF DESCRIPTION OF THE DRAWINGS

FIG. 1A-FIG. 1C depicts in accordance with various embodiments of the invention, representative examples of switchable (FIG. 1A), oscillating (FIG. 1B), and dynamically switchable (FIG. 1C) catalysts that produce monodispersed polymers (Ð≤2) in olefin polymerization studies. Complexes Cat1, Cat1′, Ni0, and Ni0-Cs are non-living whereas all forms of Cat2 are living. Ar=2,6-iPr₂Ph in Cat1 and 2-MeOPh or 2,6-(MeO)₂Ph in Ni0.

FIG. 2A-FIG. 2B depicts in accordance with various embodiments of the invention, (FIG. 2A) the addition of M⁺ (where M⁺=Li⁺, Na⁺, K⁺, and Cs⁺) to the nickel complexes (Ni1 or Ni2) led to formation of trans and cis isomers. The ratio of trans-Ni-M:cis-Ni-M depends on the alkali ion and solvent conditions. (FIG. 2B) The molecular structures of cis-Ni2-Li (left) and trans-Ni2-Cs (right) are shown with displacement ellipsoids drawn at 50% probability. The borate anions were omitted for clarity.

FIG. 3A-FIG. 3D depicts in accordance with various embodiments of the invention, (FIG. 3A) correlating the catalytic properties of the nickel complexes (FIG. 3B) with their ethylene polymerization behavior (FIG. 3C and FIG. 3D). The full polymerization data is provided in Tables 11 and 12. The ν_{growth} and νₜₑᵣₘ values were determined using the equations shown in FIG. 4. Units: ν_{growth}=mol C₂H₄/mol Ni·h, νₜₑᵣₘ=mol PE/mol Ni·h, activity=kg PE/mol Ni·h, Mₙ=kg/mol.

FIG. 4 depicts in accordance with various embodiments of the invention, without being bound by theory, a proposed catalytic cycle for ethylene polymerization by Ni(P,O-donor) complexes. The rate approximation for ν_{growth} and νₜₑᵣₘ are also shown.

FIG. 5A-FIG. 5B depicts in accordance with various embodiments of the invention, plots showing the effect of temperature on the chain growth (ν_{growth}, FIG. 5A) and chain termination (νₜₑᵣₘ, FIG. 5B) rates of the nickel catalysts in ethylene polymerization. The complete polymerization data are provided in Table 12.

FIG. 6A-FIG. 6B depicts in accordance with various embodiments of the invention, without being bound by theory a proposed process for both non-switching (FIG. 6A) and dynamic switching (FIG. 6B) modes in olefin polymerization by non-living cation-tunable nickel complexes using 1 cation. The squiggly lines represent polymer segments produced by different catalyst forms. In this work, both “blocks” comprise entirely of ethylene. However, it may be possible to use this strategy to produce block copolymers when starting with more than one type of monomer.

FIG. 7A-FIG. 7B depicts in accordance with various embodiments of the invention, (FIG. 7A) ³¹P NMR spectra (toluene-d₈/Et₂O (100:0.2), 202 MHz, RT) of Ni1 with LiBAr^{F}₄ and/or NaBAr^{F}₄. The Ni1/Li⁺/Na⁺ sample clearly showed the presence of both Ni1-Li and Ni1-Na. Only the major stereoisomers are labeled in the spectra. (FIG. 7B) ¹H NMR spectra (toluene-d₈/Et₂O-d₁₀ (98:2), 600 MHz, RT) of Ni2 with CsBAr^{F}₄. The addition of Cs⁺ led to clear upfield shifts of the resonances corresponding to the benzylic and PEG hydrogen atoms.

FIG. 8A-FIG. 8B depicts in accordance with various embodiments of the invention, ethylene polymerization using nickel catalysts under non-switching conditions at 30° C. (FIG. 8A) The reaction of Ni1/Ni(COD)₂ with various ratios of LiBAr^{F}₄/NaBAr^{F}₄ in toluene/Et₂O) (100:0.2) in the presence of ethylene. The GPC traces are provided and the full polymerization data are given in Table 13. (FIG. 8B) The reaction of Ni2/Ni(COD)₂ with various amounts of CsBAr^{F}₄ in toluene/hexane (1:3) in the presence of ethylene. The polymerization data are given in Table 14.

FIG. 9A-FIG. 9C depicts in accordance with various embodiments of the invention, the reaction of Ni2 with up to 5.0 equiv. of CsBAr^{F}₄ in toluene/Et₂O (98:2), followed by activation with Ni(COD)₂ in the presence of ethylene at 60° C. The empirical formula was derived by fitting the χ vs. Mₙ data to a single exponential growth function. The polymerization data are given in Table 16.

FIG. 10 depicts in accordance with various embodiments of the invention, the reaction of Ni2 with various ratios of LiBAr^{F}₄/CsBAr^{F}₄ (5.0 equiv. of salt total relative to Ni) in toluene/Et₂O (98:2), followed by activation with Ni(COD)₂ in the presence of ethylene 30° C. The polymerization data are given in Table 17.

FIG. 11A-FIG. 11C depicts in accordance with various embodiments of the invention, synthesis of compounds 8 (FIG. 11B), 9 (FIG. 11C), and Ni2 (FIG. 11A).

FIG. 12 depicts in accordance with various embodiments of the invention, Job Plot showing the coordination interactions between complex Ni2 and LiBAr^{F}₄. The peak maximum occurs at χ_{Ni}=0.5, which suggests that the optimal nickel:lithium binding stoichiometry is 1:1. The y-axis value (A_{obs}−εₕ·[H]ₜ) is proportional to the concentration of the nickel-lithium complex Ni2-Li. The x-axis is the molar ratio of nickel (χ_{Ni}=[Ni2]/([Ni2]+[Li⁺])).

FIG. 13 depicts in accordance with various embodiments of the invention, Job Plot showing the coordination interactions between complex Ni2 and NaBAr^{F}₄. The peak maximum occurs at χ_{Ni}=0.5, which suggests that the optimal nickel:sodium binding stoichiometry is 1:1. The y-axis value (A_{obs}−εₕ·[H]ₜ) is proportional to the concentration of the nickel-sodium complex Ni2-Na. The x-axis is the molar ratio of nickel (χ_{Ni}=[Ni2]/([Ni2]+[Na⁺])).

FIG. 14 depicts in accordance with various embodiments of the invention, Job Plot showing the coordination interactions between complex Ni2 and KBAr^{F}₄. The peak maximum occurs at χ_{Ni}=0.5, which suggests that the optimal nickel:potassium binding stoichiometry is 1:1. The y-axis value (A_{obs}−εₕ·[H]ₜ) is proportional to the concentration of the nickel-potassium complex Ni2-K. The x-axis is the molar ratio of nickel (χ_{Ni}=[Ni2]/([Ni2]+[K⁺])).

FIG. 15 depicts in accordance with various embodiments of the invention, Job Plot showing the coordination interactions between complex Ni2 and CsBAr^{F}₄. The peak maximum occurs at χ_{Ni}=0.5, which suggests that the optimal nickel:cesium binding stoichiometry is 1:1. The y-axis value (A_{obs}−εₕ*[H]ₜ) is proportional to the concentration of the nickel-cesium complex Ni2-Cs. The x-axis is the molar ratio of nickel (χ_{Ni}=[Ni2]/([Ni2]+[Cs⁺])).

FIG. 16 depicts in accordance with various embodiments of the invention, UV-vis absorbance spectra of complex Ni2 (100 μM in 1:1 Et₂O/Toluene) after the addition of up to 2.0 equiv. of CsBAr^{F}₄. The starting trace of Ni2 is shown in black and the final trace (+2.0 equiv. of Cs⁺ relative to Ni) is shown in red.

FIG. 17 depicts in accordance with various embodiments of the invention, ³¹P NMR spectra (202 MHz) of complex Ni1 only, Ni1 with LiBAr_{F}⁴, Ni1 with NaBAr_{F}⁴, or Ni1 with LiBAr_{F}⁴/NaBAr_{F}⁴ in toluene-d₈/Et₂O (100:0.2). The presence of both trans-Ni1-Li and cis-Ni1-Na species observed in spectrum of Ni1 with LiBAr_{F}⁴/NaBAr_{F}⁴ indicate that the cations are not exchanging under these conditions. Furthermore, no mononuclear Ni1 was detected in this sample.

FIG. 18 depicts in accordance with various embodiments of the invention, ¹H NMR spectra (600 MHZ) of complex Ni2 (20.8 mM) before and after the addition of various equivalence of CsBAr_{F}⁴ in toluene-d₈:Et₂O-d₁₀ (98:2) at 60° C. The benzylic hydrogen peak at 4.75 ppm shifts upfield upon the introduction of Cs⁺. The presence of only one species in different nickel:cesium ratios suggests that cation exchange is fast on the ³¹P NMR timescale under these conditions. The relative amounts of cesium salt present in each sample were calculated based on the peak integration values for the benzylic vs. BAr^{F}₄⁻ hydrogen atoms.

FIG. 19 depicts in accordance with various embodiments of the invention, ³¹P NMR spectra (202 MHz) of complex Ni2 (80 mM) before and after the addition of various equivalence of CsBAr_{F}⁴ in toluene-d₈:Et₂O (98:2) at 60° C. The relative amounts of cesium salt present in each sample were calculated based on the peak integration values for the benzylic vs. BAr^{F}₄⁻ hydrogen atoms in FIG. 17. These results suggest that the polymerizations performed in Table 14 are under dynamic switching conditions.

FIG. 20 depicts in accordance with various embodiments of the invention, ¹H NMR spectra (400 MHz) of complex Ni2 (9.0 mM) before and after the addition of various equivalence of CsBAr^{F}₄ in toluene-d₈:hexane-d₁₄ (1:3) at RT. The relative amounts of cesium salt present in each sample were calculated based on the peak integration values for the benzylic vs. BAr^{F}₄⁻ hydrogen atoms, not on the amount of salt added in the experiment. Spectrum with Ni2+0.32 equiv. Cs⁺ shows two different sets of aromatic C—H peaks corresponding to the BAr^{F}₄⁻ anion.

FIG. 21 depicts in accordance with various embodiments of the invention, ¹H NMR spectra (400 MHz) showing the PEG region of complex Ni2 (9.0 mM) before and after the addition of various equivalence of CsBAr^{F}₄ in toluene-d₈:hexane-d₁₄ (1:3) at RT. The full spectra are shown in FIG. 20. The relative amounts of cesium salt present in each sample were calculated based on the peak integration values for the benzylic vs. BAr^{F}₄⁻ hydrogen atoms, not on the amount of salt added in the experiment.

FIG. 22 depicts in accordance with various embodiments of the invention, Plot of the titration data in FIG. 18 for the binding of Cs⁺ to Ni2 in toluene-d₈:Et₂O-d₁₀ (98:2) at RT. The data were fit using BindFit to a 1:1 binding model to yield Kₐ=199±139 M⁻¹ (data points are shown as black dots and the fit is shown as a black curve). Without being bound by theory, the large error in the calculated Kₐ is most likely due to the lack of data points in the saturated region of the curve, which was not possible to obtain because CsBAr^{F}₄ has low solubility in the solvent mixture.

FIG. 23A-FIG. 23D depicts in accordance with various embodiments of the invention, Topographic steric maps of FIG. 23A) Ni2-Li, FIG. 23B) Ni2-Na, FIG. 23C) Ni2-K, and FIG. 23D) Ni2-Cs complexes calculated from their X-ray structures using SambVca 2.1. Only the phenoxyphosphine ligands were considered in the calculation of % V_{bur}. The nickel atom was set as the center of the coordination sphere, the nickel square plane defined the xz-plane, and the z-axis bisects the P(1)-Ni(1)-O(1) angle.

FIG. 24 depicts in accordance with various embodiments of the invention, Plot of Li⁺/Na⁺ molar ratio vs. A_{15.8}/A_{18.2} obtained from ethylene polymerization studies of Ni1 with LiBAr_{F}⁴ and NaBAr^{F}₄ salts (see Table 12). The data (black dots) were fit to an exponential function to give an empirical relationship between Li⁺/Na⁺ molar ratio and A_{15.8}/A_{18.2}. The data points obtained from Li⁺/Na⁺>1.0 have large experimental error because the amount of the PE produced at 18.2 mL retention volume was very small so its quantification from the GPC trace is not accurate.

FIG. 25A-FIG. 25D depicts in accordance with various embodiments of the invention, Proposed process for both non-switching (FIG. 25A, FIG. 25C) and dynamic switching (FIG. 25B, FIG. 25D) modalities in olefin polymerization by non-living cation-tunable nickel complexes. It is possible that species with nuclearity greater than 2 could form but are not considered in FIG. 25A-FIG. 25D. The squiggly lines represent polymer segments produced by different catalyst forms. Here, both “blocks” comprise entirely of ethylene. However, without being bound by theory, it may be possible to use this strategy to produce block copolymers when starting with more than one type of monomer.

FIG. 26A-FIG. 26E depicts in accordance with various embodiments of the invention, GPC chromatograms of the polyethylene samples obtained from the reactions shown in Table 12, entries 1 (FIG. 26A), 2 (FIG. 26B), 3 (FIG. 26C), 4 (FIG. 26D), and 5 (FIG. 26E). The peak at ˜22 mL retention volume marked with an asterisk (*) is derived from a contaminant in the GPC column, not the sample itself.

FIG. 27A-FIG. 27I depicts in accordance with various embodiments of the invention, GPC chromatograms of the polyethylene obtained in Table 13, in which various Ni1:Na⁺:Li⁺ ratios were used. The black traces are the raw data and the Gaussian fits are shown in dashed and dotted traces.

FIG. 28 depicts in accordance with various embodiments of the invention, GPC of monomodal polyethylene obtained in Table 16, entries 2-7 (from the addition of 0.25 to 5.00 equiv. of CsBAr^{F}₄ relative to Ni2). Without being bound by theory, The GPC trace for entry 7 (Ni2+5.00 equiv. Cs⁺) is not smooth most likely because of either the poor solubility of the polymer in trichlorobenzene at 160° C. or the difficulty of the instrument to detect ultra-high molecular weight polymers.

FIG. 29 depicts in accordance with various embodiments of the invention, Crystallographic asymmetric unit showing complex Ni2-Li from two different perspectives (ORTEP view, displacement ellipsoids drawn at 50% probability level). Hydrogen atoms, pentane solvent, and borate anion have been omitted for clarity.

FIG. 30 depicts in accordance with various embodiments of the invention, Crystallographic asymmetric unit showing complex Ni2-Na from two different perspectives (ORTEP view, displacement ellipsoids drawn at 50% probability level). Hydrogen atoms, pentane solvent, and borate anion have been omitted for clarity.

FIG. 31 depicts in accordance with various embodiments of the invention, Crystallographic asymmetric unit showing complex Ni2-K from two different perspectives (ORTEP view, displacement ellipsoids drawn at 50% probability level). Hydrogen atoms, pentane solvent, and borate anion have been omitted for clarity.

FIG. 32 depicts in accordance with various embodiments of the invention, Crystallographic asymmetric unit showing complex Ni2-Cs from two different perspectives (ORTEP view, displacement ellipsoids drawn at 50% probability level). Hydrogen atoms, pentane solvent, and borate anion have been omitted for clarity.

FIG. 33 depicts in accordance with various embodiments of the invention, cation exchange in the presence of methyl acrylate.

FIG. 34 depicts in accordance with various embodiments of the invention, ethylene and methyl acrylate copolymerization.

FIG. 35 depicts in accordance with various embodiments of the invention, ethylene and methyl acrylate copolymerization.

FIG. 36A-FIG. 36B depicts in accordance with various embodiments of the invention, dynamic switching varying molecular weight.

FIG. 37A-FIG. 37B depicts in accordance with various embodiments of the invention, dynamic switching varying molecular weight.

FIG. 38A-FIG. 38B depicts in accordance with various embodiments of the invention, dynamic switching varying methyl acrylate (MA) incorporation.

FIG. 39A-FIG. 39B depicts in accordance with various embodiments of the invention, synthesis using Ni1/Cs⁺.

FIG. 40A-FIG. 40B depicts in accordance with various embodiments of the invention, proposed mechanism for dynamic switching and non-switching polymerization. FIG. 40A depicts dynamic switching: fast cation exchange regime. FIG. 40B depicts non-switching: slow cation exchange regime.

FIG. 41A-FIG. 41B depicts in accordance with various embodiments of the invention, different applications of ethylene-alkyl acrylate (EAA) copolymers (FIG. 41A) and various methods to synthesize them (FIG. 41B). Our approach using dynamic cation switching polymerization enables the preparation of EAA with precisely controlled MW and/or alkyl acrylate incorporation.

FIG. 42A-FIG. 42C depicts in accordance with various embodiments of the invention, addition of M⁺ to Ni1 leads to the formation of cis and trans Ni1-M species in solution (FIG. 42A). ³¹P NMR spectra (202 MHz) of Ni1 after the addition of up to 1.0 equiv. of NaBAr^{F}₄ in the absence (FIG. 42B) and presence (FIG. 42C) of MA. Ar=2-methoxyphenyl.

FIG. 43 depicts in accordance with various embodiments of the invention, determining various reaction conditions for ethylene and alkyl acrylate copolymerization using the Ni1-M catalysts. These values are obtained from the average of at least duplicate experiments. R=Me, Et, or t-Bu.

FIG. 44 depicts in accordance with various embodiments of the invention, representative examples of the most active catalysts for ethylene and methyl acrylate copolymerization reported to date. See FIG. 82 and Table 26A for more examples.

FIG. 45A-FIG. 45B depicts in accordance with various embodiments of the invention, simplified catalytic cycles for non-switching (FIG. 45A) and dynamic cation switching (FIG. 45B) copolymerization of ethylene and methyl acrylate using Ni1/M⁺/M′⁺. P=polymer segment controlled by Ni-M⁺, P′=polymer segment controlled by Ni-M′, MA=methyl acrylate.

FIG. 46 depicts in accordance with various embodiments of the invention, study of solvent polarity on the modality of polymers obtained from the copolymerization of ethylene and MA with Ni1/M⁺/M′⁺. The traces show the gel permeation chromatograms of the products obtained when different toluene/Et₂O mixtures were used.

FIG. 47 depicts in accordance with various embodiments of the invention, ethylene and MA copolymerization under non-switching conditions using Ni1, LiBAr^{F}₄, and NaBAr^{F}₄. The thick black trace shows the GPC data, whereas the thin black and small black dashed traces are fits from the data deconvolution. The A/B term is defined as the integration of peak A divided by the integration of peak B. Detailed polymerization results are given in Table 12A.

FIG. 48A-FIG. 48D depicts in accordance with various embodiments of the invention, plots showing the use of Li⁺/Na⁺ (FIG. 48A), Cs⁺/Na⁺ (FIG. 48B), or Li⁺/Cs⁺ (FIG. 48C) with Ni1 under dynamic cation switching conditions to obtain EMA with varying molecular weight and MA incorporation. For comparison, EMA synthesis was attempted by varying the MA concentration using Ni1-Cs (FIG. 48D). The empirical formulas for each polymerization set were derived from mathematical fitting. The polymerization data are provided in Table 2A, Table 13A, Table 14A, Table 15A, Table 16A, Table 17A, Table 18A.

FIG. 49A-FIG. 49E depicts in accordance with various embodiments of the invention, comparison of the tensile strength (FIG. 49A) and water contact angles (FIG. 49B-FIG. 49E) of the EMA copolymers with different MA incorporation and similar molecular weight (˜20 kg/mol). The data shown were acquired for specific samples. The averaged data are given in Table 3A.

FIG. 50A-FIG. 50D depicts in accordance with various embodiments of the invention, comparison of polymer MW with and without TBEC treatment after thermal degradation (FIG. 50A). The ¹H NMR (FIG. 50B) and IR (FIG. 50C-FIG. 50D) spectra of the starting and degraded polymers are provided. The ¹H NMR peak at 3.7 ppm is assigned to the methyl hydrogens in the methyl ester group.

FIG. 51 depicts in accordance with various embodiments of the invention, synthesis of Ni1 modified from a literature procedure (Tran, T. V.; Nguyen, Y. H.; Do, L. H. Development of Highly Productive Nickel-Sodium Phenoxyphosphine Ethylene Polymerization Catalysts and Their Reaction Temperature Profiles. Polym. Chem. 2019, 10, 3718-3721).

FIG. 52 depicts in accordance with various embodiments of the invention, binding of M′ to the nickel complex. In some embodiments the starting Ni complex exists in the trans form, whereas the nickel-alkali species can exist in either the cis or trans forms.

FIG. 53 depicts in accordance with various embodiments of the invention, ³¹P NMR spectra (202 MHz) of complex Ni1 with NaBAr^{F}₄ in toluene-d₈/Et₂O (48:2).

FIG. 54 depicts in accordance with various embodiments of the invention, ³¹P NMR spectra (202 MHz) of complex Ni1 in the presence of 0.05 M methyl acrylate with NaBAr^{F}₄ in toluene-d₈/Et₂O (48:2).

FIG. 55 depicts in accordance with various embodiments of the invention, ³¹P NMR spectra (202 MHz) of complex Ni1 with CsBAr^{F}₄ in toluene-d₈/Et₂O (48:2).

FIG. 56 depicts in accordance with various embodiments of the invention, activity vs. time plot of Ni1-Na in ethylene and methyl acrylate copolymerization at 400 psi. The activity was highest at 0.5 h.

FIG. 57 depicts in accordance with various embodiments of the invention, activity vs. temperature plot of Ni1-Cs in ethylene and methyl acrylate copolymerization at 400 psi. The catalyst was observed to be active even up to 90° C.

FIG. 58 depicts in accordance with various embodiments of the invention, GPC traces of products obtained from ethylene and methyl acrylate copolymerization using Ni1 and Cs/Na⁺ (1:1) in solvents with different polarity (see Table 10A).

FIG. 59 depicts in accordance with various embodiments of the invention, GPC traces of the products obtained from ethylene and methyl acrylate copolymerization using Ni1 and Li⁺/Na⁺ (1:1) in solvents with different polarity (see Table 11A).

FIG. 60 depicts in accordance with various embodiments of the invention, deconvolution of the GPC trace for the ethylene and methyl acrylate copolymer obtained using Ni1-Li/Na(Li⁺:Na⁺=3:1) in toluene/ether (49.8:0.2) with 0.05 M methyl acrylate at 30° C. for 0.5 h (Table 12A, entry 2). Peak integration: thick black peak=178, thick gray peak=206. The original data is the thick black dashed trace, whereas the combined fit is the small black dashed trace.

FIG. 61 depicts in accordance with various embodiments of the invention, deconvolution of the GPC trace for the ethylene and methyl acrylate copolymer obtained using Ni1-Li/Na(Li⁺:Na⁺=1:1) in toluene/ether (49.8:0.2) with 0.05 M methyl acrylate at 30° C. for 0.5 h (Table 12A, entry 3). Peak integration: thick black=126, thick gray peak=461. The original data is the thick black dashed trace, whereas the combined fit is the small black dashed trace.

FIG. 62 depicts in accordance with various embodiments of the invention, deconvolution of GPC trace for the ethylene and methyl acrylate copolymer obtained using Ni1-Li/Na(Li⁺:Na⁺=1:3) in toluene/ether (49.8:0.2) with 0.05 M ethyl acrylate at 30° C. for 0.5 h (Table 12A, entry 4). Peak integration: thick black peak=113, thick gray peak=439. The original data is the thick black dashed trace, whereas the combined fit is the small black dashed trace.

FIG. 63 depicts in accordance with various embodiments of the invention, GPC traces of different ethylene/methyl acrylate copolymers obtained using Ni1 with different ratios of Li⁺/Na⁺.

FIG. 64 depicts in accordance with various embodiments of the invention, GPC traces of different ethylene/methyl acrylate copolymers obtained using Ni1 with different ratios of Cs⁺/Na⁺.

FIG. 65 depicts in accordance with various embodiments of the invention, GPC traces of different ethylene/methyl acrylate copolymers obtained using Ni1 with different ratios of Li⁺/Cs⁺.

FIG. 66 depicts in accordance with various embodiments of the invention, the Li⁺/Na⁺ ratio vs. Mₙ plot based on copolymerizations using Ni1 and different ratios of Li⁺/Na⁺. The polymerization data are given in Table 13A and Table 14A. The data points were fit to the exponential equation: z=17.896−15.95^{[-(x+0.0148)/1.105]}, where x=Li⁺/Na⁺ ratio and z=Mₙ of the copolymers.

FIG. 67 depicts in accordance with various embodiments of the invention, the Li⁺/Na⁺ ratio vs. MA incorporation plot based on the copolymerization results obtained using Ni1 with different ratios of Li⁺/Na⁺. The polymerization data are given in Table 13A and Table 14A. The data points were fit to the linear equation: y=1.1067-0.0785x, where x=the Li⁺/Na⁺ ratio and y=mol % of MA incorporation.

FIG. 68 depicts in accordance with various embodiments of the invention, a three-dimensional plot showing the MA incorporation and Mₙ of the copolymers obtained from the copolymerizations using Ni1 and different ratios of Li⁺/Na⁺. The polymerization data are given in Table 13A and Table 14A. The data points were fit to the non-linear equation: x=5.92y+1.043z−0.895yz−6.542, where x=Li⁺/Na⁺ ratio, y=mol % of MA incorporation, and z=Mₙ of copolymers.

FIG. 69 depicts in accordance with various embodiments of the invention, the Cs⁺/Na⁺ ratio vs. Mₙ plot obtained from copolymerization using Ni1 and different ratios of Cs⁺/Na⁺. The polymerization data are given in Table 15A and Table 16A. The data were fit to the linear equation: z=1.049x+3.336, where x=Cs⁺/Na⁺ ratio and z=Mₙ of the copolymers.

FIG. 70 depicts in accordance with various embodiments of the invention, the Cs⁺/Na⁺ ratio vs. MA incorporation plot obtained from copolymerizations using Ni1 and different ratios of Cs⁺/Na⁺. The polymerization data are given in Table 15A and Table 16A. The data were fit to the linear equation: y=0.057x+1.234, where x=Cs/Na⁺ ratio and y=mol % of MA incorporation.

FIG. 71 depicts in accordance with various embodiments of the invention, a three-dimensional plot showing the MA incorporation and Mₙ of the copolymers obtained from the copolymerizations using Ni1 and different ratios of Cs⁺/Na⁺. The polymerization data are given in Table 15A and Table 16A. The data were fit to the non-linear equation: x=14.198e^{y}+0.587z−48.237y+8.82, where x=Cs/Na⁺ ratio, y=% mol of MA incorporation, and z=Mₙ of the copolymers.

FIG. 72 depicts in accordance with various embodiments of the invention, the Li⁺/Cs⁺ ratio vs. Mₙ plot obtained from copolymerizations using Ni1 and different ratios of Li⁺/Cs⁺. The polymerization data are given in Table 17A and Table 18A. The data were fit to the linear equation: z=19.42-0.115x, where x=Li⁺/Cs⁺ ratio and z=Mₙ of the copolymers.

FIG. 73 depicts in accordance with various embodiments of the invention, the Li⁺/Cs⁺ ratio vs. MA incorporation plot obtained from copolymerizations using Ni1 and different ratios of Li⁺/Cs⁺. The polymerization data are given in Table 17A and Table 18A. The data were fit to the exponential equation: y=1.015+0.447e^{[-(x-0.013)/1.392]}, where x=Li⁺/Cs⁺ ratio, and y=mol % of MA incorporation.

FIG. 74 depicts in accordance with various embodiments of the invention, a three-dimensional plot showing the MA incorporation and Mₙ of the copolymers obtained from the copolymerizations using Ni1 and different ratios of Li⁺/Cs⁺. The polymerization data are given in Table 17A and Table 18A. The data were fit to the non-linear equation: x=10⁻⁸e^{z}−14.99y−3.015z+74.816, where x=Li⁺/Cs⁺ ratio, y=mol % of MA incorporation, and z=Mₙ of the copolymer.

FIG. 75 depicts in accordance with various embodiments of the invention, degradation of ethylene homopolymers and ethylene-MA copolymers using TBEC (tert-butylperoxy 2-ethylhexyl carbonate).

FIG. 76 depicts in accordance with various embodiments of the invention, proposed mechanism for peroxide-initiated radical degradation of polymer. This mechanistic proposal is based on literature studies (Gewert, B.; Plassmann, M. M.; MacLeod, M. Pathways for degradation of plastic polymers floating in the marine environment. Environ. Sci.: Processes Impacts 2015, 17, 1513-1521; Lu, B.; Takahashi, K.; Zhou, J.; Nakagawa, S.; Yamamoto, Y.; Katashima, T.; Yoshie, N.; Nozaki, K. Mild Catalytic Degradation of Crystalline Polyethylene Units in a Solid State Assisted by Carboxylic Acid Groups. J. Am. Chem. Soc. 2024, 146, 19599-19608).

FIG. 77 depicts in accordance with various embodiments of the invention, relationship between polymer degradability and methyl acrylate incorporation.

FIG. 78 depicts in accordance with various embodiments of the invention, comparison of tensile properties for low molecular weight ethylene homopolymer and ethylene-MA copolymer.

FIG. 79 depicts in accordance with various embodiments of the invention, comparison of tensile properties for high molecular weight ethylene homopolymer and ethylene-MA copolymer.

FIG. 80A-FIG. 80B depicts in accordance with various embodiments of the invention, water contact angle images of ethylene homopolymer (FIG. 80A) (Table 25A, Entry 1) and ethylene-MA copolymer (FIG. 80B) (Table 25A, Entry 4).

FIG. 81 depicts in accordance with various embodiments of the invention, dependence of water contact angle on methyl acrylate incorporation.

FIG. 82 depicts in accordance with various embodiments of the invention, various metal catalysts for ethylene and methyl acrylate copolymerization.

FIG. 83 depicts in accordance with various embodiments of the invention, IR spectrum of normal HDPE [obtained from the reaction of Ni1+2Li⁺ in toluene/ether (toluene:ether=47:3) at 30° C. for 0.75 h] and the same HDPE after degradation.

FIG. 84 depicts in accordance with various embodiments of the invention, IR spectrum of normal ethylene/methyl acrylate copolymer [obtained from the reaction of Ni1+Li⁺/Cs⁺ (Li⁺:Cs⁺=1.5:0.5) in toluene/ether (toluene:ether=47:3) with 0.05 M MA at 30° C. for 0.5 h] and the same copolymer after degradation.

FIG. 85A-FIG. 85B depicts in accordance with various embodiments of the invention, DSC trace of ethylene/methyl acrylate copolymer obtained from the reaction of (FIG. 85A) Ni1+2Li⁺, (FIG. 85B) Ni1+2Na⁺ in toluene/ether (toluene:ether=48:2) with 0.05 M MA at 30° C. for 0.5 h.

FIG. 86A-FIG. 86B depicts in accordance with various embodiments of the invention, DSC trace of ethylene/methyl acrylate copolymer obtained from the reaction of (FIG. 86A) Ni1+2K⁺, (FIG. 86B) Ni1+2Cs⁺ in toluene/ether (toluene:ether=48:2) with 0.05 M MA at 30° C. for 0.5 h.

FIG. 87A-FIG. 87B depicts in accordance with various embodiments of the invention, DSC trace of ethylene/tert-butyl acrylate copolymer obtained from the reaction of (FIG. 87A) Ni1+2Li⁺, (FIG. 87B) Ni1+2Na⁺ in toluene/ether (toluene:ether=48:2) with 0.05 M BA at 30° C. for 0.5 h.

FIG. 88A-FIG. 88B depicts in accordance with various embodiments of the invention, DSC trace of ethylene/tert-butyl acrylate copolymer obtained from the reaction of (FIG. 88A) Ni1+2K⁺, (FIG. 88B) Ni1+2Cs⁺ in toluene/ether (toluene:ether=48:2) with 0.05 M BA at 30° C. for 0.5 h.

FIG. 89 depicts in accordance with various embodiments of the invention, DSC trace of ethylene/ethyl acrylate copolymer obtained from the reaction of Ni1+2Li⁺ in toluene/ether (toluene:ether=48:2) with 0.05 M EA at 30° C. for 0.5 h.

FIG. 90A-FIG. 90B depicts in accordance with various embodiments of the invention, DSC trace of ethylene/methyl acrylate copolymer obtained from the reaction of (FIG. 90A) Ni1+Li⁺/Na⁺ (Li⁺:Na⁺=1.5:0.5), (FIG. 90B) Ni1+Li⁺/Na⁺ (Li⁺:Na⁺=1:1) in toluene/ether (toluene:ether=48:2) with 0.05 M MA at 30° C. for 0.5 h.

FIG. 91A-FIG. 91B depicts in accordance with various embodiments of the invention, DSC trace of ethylene/methyl acrylate copolymer obtained from the reaction of (FIG. 91A) Ni1+Cs⁺/Na⁺ (Cs⁺:Na⁺=1.5:0.5), (FIG. 91B) Ni1+Cs⁺/Na⁺ (Cs⁺:Na⁺=1:1) (toluene:ether=47:3) with 0.05 M MA at 30° C. for 0.5 h.

FIG. 92A-FIG. 92B depicts in accordance with various embodiments of the invention, DSC trace of ethylene/methyl acrylate copolymer obtained from the reaction of (FIG. 92A) Ni1+Li⁺/Cs⁺ (Li⁺:Cs⁺=1.67:0.33), (FIG. 92B) Ni1+Li⁺/Cs⁺ (Li⁺:Cs⁺=1.5:0.5) (toluene:ether=47:3) with 0.05 M MA at 30° C. for 0.5 h.

FIG. 93 depicts in accordance with various embodiments of the invention, DSC trace of ethylene/methyl acrylate copolymer obtained from the reaction of Ni1+2Cs⁺ in toluene/ether (toluene:ether=47:3) with 0.025 M MA at 30° C. for 0.5 h.

FIG. 94 depicts in accordance with various embodiments of the invention, thermogravimetric analysis data of ethylene/methyl acrylate copolymer obtained from the reaction of Ni1 with varying equivalents of Li⁺/Na⁺ in toluene/ether (48:2) in the presence of 0.05 M MA at 30° C. for 0.5 h (Table 13A and Table 14A).

FIG. 95 depicts in accordance with various embodiments of the invention, thermogravimetric analysis data of ethylene/methyl acrylate copolymer obtained from the reaction of Ni1 with varying equivalents of Cs⁺/Na⁺ in toluene/ether (47:3) in the presence of 0.05 M MA at 30° C. for 0.5 h (Table 15A and Table 16A).

FIG. 96 depicts in accordance with various embodiments of the invention, thermogravimetric analysis data of ethylene/methyl acrylate copolymer obtained from the reaction of Ni1 with varying equiv. of Li⁺/Cs⁺ in toluene/ether (47:3) in the presence of 0.05 M. MA at 30° C. for 0.5 h (Table 17A and Table 18A).

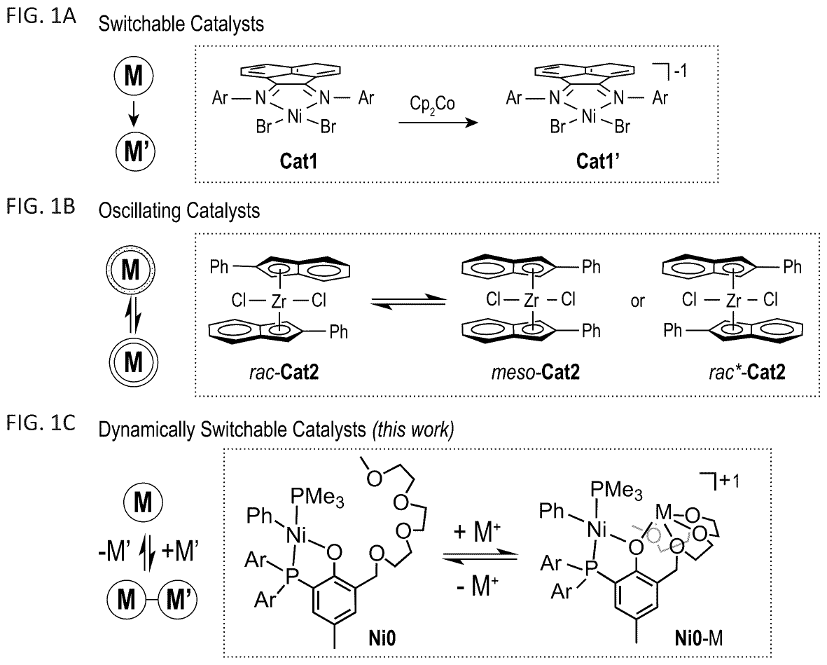

### DETAILED DESCRIPTION OF THE INVENTION

All references cited herein are incorporated by reference in their entirety as though fully set forth. Unless defined otherwise, technical and scientific terms used herein have the same meaning as commonly understood by one of ordinary skill in the art to which this invention belongs.

One skilled in the art will recognize many methods and materials similar or equivalent to those described herein, which could be used in the practice of the present invention. Other features and advantages of the invention will become apparent from the following detailed description, taken in conjunction with the accompanying drawings, which illustrate, by way of example, various features of embodiments of the invention. Indeed, the present invention is in no way limited to the methods and materials described. For convenience, certain terms employed herein, in the specification, examples and appended claims are collected here.

Unless stated otherwise, or implicit from context, the following terms and phrases include the meanings provided below. Unless explicitly stated otherwise, or apparent from context, the terms and phrases below do not exclude the meaning that the term or phrase has acquired in the art to which it pertains. Unless otherwise defined, all technical and scientific terms used herein have the same meaning as commonly understood by one of ordinary skill in the art to which this invention belongs. It should be understood that this invention is not limited to the particular methodology, protocols, and reagents, etc., described herein and as such can vary. The definitions and terminology used herein are provided to aid in describing particular embodiments, and are not intended to limit the claimed invention, because the scope of the invention is limited only by the claims.

As used herein the term “comprising” or “comprises” is used in reference to compositions, methods, systems, articles of manufacture, apparatus, and respective component(s) thereof, that are useful to an embodiment, yet open to the inclusion of unspecified elements, whether useful or not. It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). Although the open-ended term “comprising,” as a synonym of terms such as including, containing, or having, is used herein to describe and claim the invention, the present invention, or embodiments thereof, may alternatively be described using alternative terms such as “consisting of” or “consisting essentially of.”

Unless stated otherwise, the terms “a” and “an” and “the” and similar references used in the context of describing a particular embodiment of the application (especially in the context of claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. The abbreviation, “e.g.” is derived from the Latin exempli gratia, and is used herein to indicate a non-limiting example. Thus, the abbreviation “e.g.” is synonymous with the term “for example.” No language in the specification should be construed as indicating any non-claimed element essential to the practice of the application.

“Optional” or “optionally” means that the subsequently described circumstance may or may not occur, so that the description includes instances where the circumstance occurs and instances where it does not.

In some embodiments, the numbers expressing quantities of reagents, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

As used herein the term “monomodal” is well-known in the art and generally refers to a polymer distribution having a single relative maximum as determined analytically using instruments such as gel permeation chromatography.

As used herein the term “bimodal” is well-known in the art and generally refers to a polymer distribution having two relative maxima or evidencing two normal distributions as determined analytically using instruments such as gel permeation chromatography.

As used herein the term “copolymer” is well-known in the art and generally refers to polymers comprising repeat units from two or more monomers. For example, in some embodiments, the copolymers disclosed herein are copolymers of ethylene and at least one other optionally substituted olefin.

As used herein the term “copolymerization” is well-known in the art and generally refers to a type of polymerization which forms a copolymer.

As used herein the term “random copolymer” is well-known in the art and refers to a copolymer with no preferred ordering of the repeat units from the two or more monomers.

As used herein the term “block copolymer” is well-known in the art and refers to a copolymer comprising two or more homopolymer units linked by covalent bonds.

As used herein the term “gradient copolymer” is well-known in the art and refers to a copolymer in which the change in monomer composition is gradual from predominantly one monomer species to predominantly the other monomer species.

As used herein the term “homopolymer” is well-known the art and generally refers to polymers composed of repeat units from a single monomer. For example, in some embodiments, the homopolymer is polyethylene.

As used herein the term “homopolymerization” is well-known in the art and generally refers to a type of polymerization which forms a homopolymer.

As used herein the term “weakly coordinating anion” is well-known in the art and generally refers to a large bulky anion capable of delocalization of the negative charge of the anion. Suitable weakly coordinating anions include, but are not limited to, tetrakis(3,5-trifluoromethylsulfonate, hexafluorophosphate, hexafluoroantimonate, or tetrafluoroborate. The coordinating ability of such anions is known and described in the literature (Strauss. S. et al., Chem. Rev. 1993, 93, 927).

As used herein the term “electron donating group” is well-known in the art and generally refers to a functional group or atom that pushes electron density away from itself, towards other portions of the molecule, e.g., through resonance and/or inductive effects.

As used herein the term “electron withdrawing group” is well-known in the art and generally refers to a functional group or atom that pulls electron density towards itself, away from other portions of the molecule, e.g., through resonance and/or inductive effects.

As used herein, the term “alkyl” means a straight or branched, saturated aliphatic radical having a chain of carbon atoms. Cₓ alkyl and Cₓ-C_{y}alkyl are typically used where X and Y indicate the number of carbon atoms in the chain. For example, C₁-C₆alkyl includes alkyls that have a chain of between 1 and 6 carbons (e.g., methyl, ethyl, propyl, isopropyl, butyl, sec-butyl, isobutyl, tert-butyl, pentyl, neopentyl, hexyl, and the like). Alkyl represented along with another radical (e.g., as in arylalkyl) means a straight or branched, saturated alkyl divalent radical having the number of atoms indicated or when no atoms are indicated means a bond, e.g., (C₆-C₁₀)aryl(C₀-C₃)alkyl includes phenyl, benzyl, phenethyl, 1-phenylethyl 3-phenylpropyl, and the like. Backbone of the alkyl can be optionally inserted with one or more heteroatoms, such as N, O, or S.

In preferred embodiments, a straight chain or branched chain alkyl has 30 or fewer carbon atoms in its backbone (e.g., C1-C30 for straight chains, C3-C30 for branched chains), and more preferably 20 or fewer. Likewise, preferred cycloalkyls have from 3-10 carbon atoms in their ring structure, and more preferably have 5, 6 or 7 carbons in the ring structure. The term “alkyl” (or “lower alkyl”) as used throughout the specification, examples, and claims is intended to include both “unsubstituted alkyls” and “substituted alkyls”, the latter of which refers to alkyl moieties having one or more substituents replacing a hydrogen on one or more carbons of the hydrocarbon backbone.

Unless the number of carbons is otherwise specified, “lower alkyl” as used herein means an alkyl group, as defined above, but having from one to ten carbons, more preferably from one to six carbon atoms in its backbone structure. Likewise, “lower alkenyl” and “lower alkynyl” have similar chain lengths. Throughout the application, preferred alkyl groups are lower alkyls. In preferred embodiments, a substituent designated herein as alkyl is a lower alkyl.

Non-limiting examples of substituents of a substituted alkyl can include halogen, hydroxy, nitro, thiols, amino, azido, imino, amido, phosphoryl (including phosphonate and phosphinate), sulfonyl (including sulfate, sulfonamido, sulfamoyl and sulfonate), and silyl groups, as well as ethers, alkylthios, carbonyls (including ketones, aldehydes, carboxylates, and esters), —CF₃, —CN and the like.

As used herein, the term “alkenyl” refers to unsaturated straight-chain, branched-chain or cyclic hydrocarbon radicals having at least one carbon-carbon double bond. Cₓ alkenyl and Cₓ-C_{y}alkenyl are typically used where X and Y indicate the number of carbon atoms in the chain. For example, C₂-C₆alkenyl includes alkenyls that have a chain of between 2 and 6 carbons and at least one double bond, e.g., vinyl, allyl, propenyl, isopropenyl, 1-butenyl, 2-butenyl, 3-butenyl, 2-methylallyl, 1-hexenyl, 2-hexenyl, 3-hexenyl, and the like). Alkenyl represented along with another radical (e.g., as in arylalkenyl) means a straight or branched, alkenyl divalent radical having the number of atoms indicated. Backbone of the alkenyl can be optionally inserted with one or more heteroatoms, such as N, O, or S.

As used herein, the term “alkynyl” refers to unsaturated hydrocarbon radicals having at least one carbon-carbon triple bond. Cₓ alkynyl and Cₓ-C_{y}alkynyl are typically used where X and Y indicate the number of carbon atoms in the chain. For example, C₂-C₆alkynyl includes alkynls that have a chain of between 2 and 6 carbons and at least one triple bond, e.g., ethynyl, 1-propynyl, 2-propynyl, 1-butynyl, isopentynyl, 1,3-hexa-diyn-yl, n-hexynyl, 3-pentynyl, 1-hexen-3-ynyl and the like. Alkynyl represented along with another radical (e.g., as in arylalkynyl) means a straight or branched, alkynyl divalent radical having the number of atoms indicated. Backbone of the alkynyl can be optionally inserted with one or more heteroatoms, such as N, O, or S.

The terms “alkylene,” “alkenylene,” and “alkynylene” refer to divalent alkyl, alkelyne, and alkynylene” radicals. Prefixes Cₓ and Cₓ-C_{y} are typically used where X and Y indicate the number of carbon atoms in the chain. For example, C₁-C₆alkylene includes methylene, (—CH₂—), ethylene (—CH₂CH₂—), trimethylene (—CH₂CH₂CH₂—), tetramethylene (—CH₂CH₂CH₂CH₂═), 2-methyltetramethylene (CH₂CH(CH₃) CH₂CH₂—), pentamethylene (—CH₂CH₂CH₂CH₂CH₂—) and the like).

As used herein, the term “alkylidene” means a straight or branched unsaturated, aliphatic, divalent radical having a general formula ═CR^{a}R^{b}. Non-limiting examples of R^{a} and R^{b} are each independently hydrogen, alkyl, substituted alkyl, alkenyl, or substituted alkenyl. Cₓ alkylidene and Cₓ-C_{y}alkylidene are typically used where X and Y indicate the number of carbon atoms in the chain. For example, C₂-C₆alkylidene includes methylidene (═CH₂), ethylidene (═CHCH₃), isopropylidene (═C(CH₃)₂), propylidene (═CHCH₂CH₃), allylidene (═CH—CH═CH₂), and the like).

The term “heteroalkyl”, as used herein, refers to straight or branched chain, or cyclic carbon-containing radicals, or combinations thereof, containing at least one heteroatom. Suitable heteroatoms include, but are not limited to, O, N, Si, P, Se, B, and S, wherein the phosphorous and sulfur atoms are optionally oxidized, and the nitrogen heteroatom is optionally quaternized. Heteroalkyls can be substituted as defined above for alkyl groups.

As used herein, the term “halogen” or “halo” refers to an atom selected from fluorine, chlorine, bromine and iodine. The term “halogen radioisotope” or “halo isotope” refers to a radionuclide of an atom selected from fluorine, chlorine, bromine and iodine.

A “halogen-substituted moiety” or “halo-substituted moiety”, as an isolated group or part of a larger group, means an aliphatic, alicyclic, or aromatic moiety, as described herein, substituted by one or more “halo” atoms, as such terms are defined in this application. For example, halo-substituted alkyl includes haloalkyl, dihaloalkyl, trihaloalkyl, perhaloalkyl and the like (e.g. halosubstituted (C₁-C₃)alkyl includes chloromethyl, dichloromethyl, difluoromethyl, trifluoromethyl (—CF₃), 2,2,2-trifluoroethyl, perfluoroethyl, 2,2,2-trifluoro-1,1-dichloroethyl, and the like).

The term “aryl” refers to monocyclic, bicyclic, or tricyclic fused aromatic ring system. Cₓ aryl and Cₓ-C_{y}aryl are typically used where X and Y indicate the number of carbon atoms in the ring system. For example, C₆-C₁₂ aryl includes aryls that have 6 to 12 carbon atoms in the ring system. Exemplary aryl groups include, but are not limited to, pyridinyl, pyrimidinyl, furanyl, thienyl, imidazolyl, thiazolyl, pyrazolyl, pyridazinyl, pyrazinyl, triazinyl, tetrazolyl, indolyl, benzyl, phenyl, naphthyl, anthracenyl, azulenyl, fluorenyl, indanyl, indenyl, naphthyl, phenyl, tetrahydronaphthyl, benzimidazolyl, benzofuranyl, benzothiofuranyl, benzothiophenyl, benzoxazolyl, benzoxazolinyl, benzthiazolyl, benztriazolyl, benztetrazolyl, benzisoxazolyl, benzisothiazolyl, benzimidazolinyl, carbazolyl, 4aH carbazolyl, carbolinyl, chromanyl, chromenyl, cinnolinyl, decahydroquinolinyl, 2H,6H-1,5,2-dithiazinyl, dihydrofuro[2,3 b]tetrahydrofuran, furanyl, furazanyl, imidazolidinyl, imidazolinyl, imidazolyl, 1H-indazolyl, indolenyl, indolinyl, indolizinyl, indolyl, 3H-indolyl, isatinoyl, isobenzofuranyl, isochromanyl, isoindazolyl, isoindolinyl, isoindolyl, isoquinolinyl, isothiazolyl, isoxazolyl, methylenedioxyphenyl, morpholinyl, naphthyridinyl, octahydroisoquinolinyl, oxadiazolyl, 1,2,3-oxadiazolyl, 1,2,4-oxadiazolyl, 1,2,5-oxadiazolyl, 1,3,4-oxadiazolyl, oxazolidinyl, oxazolyl, oxindolyl, pyrimidinyl, phenanthridinyl, phenanthrolinyl, phenazinyl, phenothiazinyl, phenoxathinyl, phenoxazinyl, phthalazinyl, piperazinyl, piperidinyl, piperidonyl, 4-piperidonyl, piperonyl, pteridinyl, purinyl, pyranyl, pyrazinyl, pyrazolidinyl, pyrazolinyl, pyrazolyl, pyridazinyl, pyridooxazole, pyridoimidazole, pyridothiazole, pyridinyl, pyridyl, pyrimidinyl, pyrrolidinyl, pyrrolinyl, 2H-pyrrolyl, pyrrolyl, quinazolinyl, quinolinyl, 4H-quinolizinyl, quinoxalinyl, quinuclidinyl, tetrahydrofuranyl, tetrahydroisoquinolinyl, tetrahydroquinolinyl, tetrazolyl, 6H-1,2,5-thiadiazinyl, 1,2,3-thiadiazolyl, 1,2,4-thiadiazolyl, 1,2,5-thiadiazolyl, 1,3,4-thiadiazolyl, thianthrenyl, thiazolyl, thienyl, thienothiazolyl, thienooxazolyl, thienoimidazolyl, thiophenyl and xanthenyl, and the like. In some embodiments, 1, 2, 3, or 4 hydrogen atoms of each ring can be substituted by a substituent.

The term “heteroaryl” refers to an aromatic 5-8 membered monocyclic, 8-12 membered fused bicyclic, or 11-14 membered fused tricyclic ring system having 1-3 heteroatoms if monocyclic, 1-6 heteroatoms if bicyclic, or 1-9 heteroatoms if tricyclic, said heteroatoms selected from O, N, or S (e.g., carbon atoms and 1-3, 1-6, or 1-9 heteroatoms of N, O, or S if monocyclic, bicyclic, or tricyclic, respectively. Cₓ heteroaryl and Cₓ-C_{y}heteroaryl are typically used where X and Y indicate the number of carbon atoms in the ring system. For example, C₄-C₉ heteroaryl includes heteroaryls that have 4 to 9 carbon atoms in the ring system. Heteroaryls include, but are not limited to, those derived from benzo[b]furan, benzo[b]thiophene, benzimidazole, imidazo[4,5-c]pyridine, quinazoline, thieno[2,3-c]pyridine, thieno[3,2-b]pyridine, thieno[2, 3˜ b]pyridine, indolizine, imidazo[1,2a]pyridine, quinoline, isoquinoline, phthalazine, quinoxaline, naphthyridine, quinolizine, indole, isoindole, indazole, indoline, benzoxazole, benzopyrazole, benzothiazole, imidazo[1,5-a]pyridine, imidazo[1,2-a]pyrimidine, imidazo[1,2-c]pyrimidine, imidazo[1,5-a]pyrimidine, imidazo[1,5-c]pyrimidine, pyrrolo[2,3-b]pyridine, pyrrolo[2,3c]pyridine, pyrrolo[3,2-c]pyridine, pyrrolo[3,2-b]pyridine, pyrrolo[2,3-d]pyrimidine, pyrrolo[3,2-d]pyrimidine, pyrrolo[2,3-b]pyrazine, pyrazolo[1,5-a]pyridine, pyrrolo[1,2-b]pyridazine, pyrrolo[1,2-c]pyrimidine, pyrrolo[1,2-a]pyrimidine, pyrrolo[1,2-a]pyrazine, triazo[1,5-a]pyridine, pteridine, purine, carbazole, acridine, phenazine, phenothiazene, phenoxazine, 1,2-dihydropyrrolo[3,2,1-hi]indole, indolizine, pyrido[1,2-a]indole, 2 (1H)-pyridinone, benzimidazolyl, benzofuranyl, benzothiofuranyl, benzothiophenyl, benzoxazolyl, benzoxazolinyl, benzthiazolyl, benztriazolyl, benztetrazolyl, benzisoxazolyl, benzisothiazolyl, benzimidazolinyl, carbazolyl, 4aH-carbazolyl, carbolinyl, chromanyl, chromenyl, cinnolinyl, decahydroquinolinyl, 2H,6H-1,5,2-dithiazinyl, dihydrofuro[2,3-b]tetrahydrofuran, furanyl, furazanyl, imidazolidinyl, imidazolinyl, imidazolyl, 1H-indazolyl, indolenyl, indolinyl, indolizinyl, indolyl, 3H-indolyl, isatinoyl, isobenzofuranyl, isochromanyl, isoindazolyl, isoindolinyl, isoindolyl, isoquinolinyl, isothiazolyl, isoxazolyl, methylenedioxyphenyl, morpholinyl, naphthyridinyl, octahydroisoquinolinyl, oxadiazolyl, 1,2,3-oxadiazolyl, 1,2,4-oxadiazolyl, 1,2,5-oxadiazolyl, 1,3,4-oxadiazolyl, oxazolidinyl, oxazolyl, oxepanyl, oxetanyl, oxindolyl, pyrimidinyl, phenanthridinyl, phenanthrolinyl, phenazinyl, phenothiazinyl, phenoxathinyl, phenoxazinyl, phthalazinyl, piperazinyl, piperidinyl, piperidonyl, 4-piperidonyl, piperonyl, pteridinyl, purinyl, pyranyl, pyrazinyl, pyrazolidinyl, pyrazolinyl, pyrazolyl, pyridazinyl, pyridooxazole, pyridoimidazole, pyridothiazole, pyridinyl, pyridyl, pyrimidinyl, pyrrolidinyl, pyrrolinyl, 2H-pyrrolyl, pyrrolyl, quinazolinyl, quinolinyl, 4H-quinolizinyl, quinoxalinyl, quinuclidinyl, tetrahydrofuranyl, tetrahydroisoquinolinyl, tetrahydropyranyl, tetrahydroquinolinyl, tetrazolyl, 6H-1,2,5-thiadiazinyl, 1,2,3-thiadiazolyl, 1,2,4-thiadiazolyl, 1,2,5-thiadiazolyl, 1,3,4-thiadiazolyl, thianthrenyl, thiazolyl, thienyl, thienothiazolyl, thienooxazolyl, thienoimidazolyl, thiophenyl and xanthenyl. Some exemplary heteroaryl groups include, but are not limited to, pyridyl, furyl or furanyl, imidazolyl, benzimidazolyl, pyrimidinyl, thiophenyl or thienyl, pyridazinyl, pyrazinyl, quinolinyl, indolyl, thiazolyl, naphthyridinyl, 2-amino-4-oxo-3,4-dihydropteridin-6-yl, tetrahydroisoquinolinyl, and the like. In some embodiments, 1, 2, 3, or 4 hydrogen atoms of each ring may be substituted by a substituent.

The term “cyclyl” or “cycloalkyl” refers to saturated and partially unsaturated cyclic hydrocarbon groups having 3 to 12 carbons, for example, 3 to 8 carbons, and, for example, 3 to 6 carbons. Cₓcyclyl and Cₓ-C_{y}cycyl are typically used where X and Y indicate the number of carbon atoms in the ring system. For example, C₃-C₈ cyclyl includes cyclyls that have 3 to 8 carbon atoms in the ring system. The cycloalkyl group additionally can be optionally substituted, e.g., with 1, 2, 3, or 4 substituents. C₃-C₁₀cyclyl includes cyclopropyl, cyclobutyl, cyclopentyl, cyclohexyl, cyclohexenyl, 2,5-cyclohexadienyl, cycloheptyl, cyclooctyl, bicyclo[2.2.2]octyl, adamantan-1-yl, decahydronaphthyl, oxocyclohexyl, dioxocyclohexyl, thiocyclohexyl, 2-oxobicyclo[2.2.1]hept-|-yl, and the like.

Aryl and heteroaryls can be optionally substituted with one or more substituents at one or more positions, for example, halogen, alkyl, aralkyl, alkenyl, alkynyl, cycloalkyl, hydroxyl, amino, nitro, sulfhydryl, imino, amido, phosphate, phosphonate, phosphinate, carbonyl, carboxyl, silyl, ether, alkylthio, sulfonyl, ketone, aldehyde, ester, a heterocyclyl, an aromatic or heteroaromatic moiety, —CF₃, —CN, or the like.

The term “heterocyclyl” refers to a nonaromatic 4-8 membered monocyclic, 8-12 membered bicyclic, or 11-14 membered tricyclic ring system having 1-3 heteroatoms if monocyclic, 1-6 heteroatoms if bicyclic, or 1-9 heteroatoms if tricyclic, said heteroatoms selected from O, N, or S (e.g., carbon atoms and 1-3, 1-6, or 1-9 heteroatoms of N, O, or S if monocyclic, bicyclic, or tricyclic, respectively). Cₓheterocyclyl and Cₓ-C_{y}heterocyclyl are typically used where X and Y indicate the number of carbon atoms in the ring system. For example, C₄-C₉ heterocyclyl includes heterocyclyls that have 4-9 carbon atoms in the ring system. In some embodiments, 1, 2 or 3 hydrogen atoms of each ring can be substituted by a substituent. Exemplary heterocyclyl groups include, but are not limited to piperazinyl, pyrrolidinyl, dioxanyl, morpholinyl, tetrahydrofuranyl, piperidyl, 4-morpholyl, 4-piperazinyl, pyrrolidinyl, perhydropyrrolizinyl, 1,4-diazaperhydroepinyl, 1,3-dioxanyl, 1,4-dioxanyl and the like.

The terms “bicyclic” and “tricyclic” refers to fused, bridged, or joined by a single bond polycyclic ring assemblies.

The term “cyclylalkylene” means a divalent aryl, heteroaryl, cyclyl, or heterocyclyl.

As used herein, the term “fused ring” refers to a ring that is bonded to another ring to form a compound having a bicyclic structure when the ring atoms that are common to both rings are directly bound to each other. Non-exclusive examples of common fused rings include decalin, naphthalene, anthracene, phenanthrene, indole, furan, benzofuran, quinoline, and the like. Compounds having fused ring systems can be saturated, partially saturated, cyclyl, heterocyclyl, aromatics, heteroaromatics, and the like.

As used herein, the term “carbonyl” means the radical —C(O)—. It is noted that the carbonyl radical can be further substituted with a variety of substituents to form different carbonyl groups including acids, acid halides, amides, esters, ketones, and the like.

The term “carboxy” means the radical —C(O)O—. It is noted that compounds described herein containing carboxy moieties can include protected derivatives thereof, i.e., where the oxygen is substituted with a protecting group. Suitable protecting groups for carboxy moieties include benzyl, tert-butyl, and the like. The term “carboxyl” means —COOH.

The term “cyano” means the radical —CN.

The term, “heteroatom” refers to an atom that is not a carbon atom. Particular examples of heteroatoms include, but are not limited to nitrogen, oxygen, sulfur and halogens. A “heteroatom moiety” includes a moiety where the atom by which the moiety is attached is not a carbon. Examples of heteroatom moieties include —N═, —NR—, —N⁺(O⁻)═, —O—, —S— or —S(O)—, —OS(O)₂—, and —SS—, wherein R^{N} is H or a further substituent.

The term “hydroxy” means the radical —OH.

The term “imine derivative” means a derivative comprising the moiety —C(NR)—, wherein R comprises a hydrogen or carbon atom alpha to the nitrogen.

The term “nitro” means the radical —NO₂.

An “oxaaliphatic,” “oxaalicyclic”, or “oxaaromatic” mean an aliphatic, alicyclic, or aromatic, as defined herein, except where one or more oxygen atoms (—O—) are positioned between carbon atoms of the aliphatic, alicyclic, or aromatic respectively.

An “oxoaliphatic,” “oxoalicyclic”, or “oxoaromatic” means an aliphatic, alicyclic, or aromatic, as defined herein, substituted with a carbonyl group. The carbonyl group can be an aldehyde, ketone, ester, amide, acid, or acid halide.

As used herein, the term, “aromatic” means a moiety wherein the constituent atoms make up an unsaturated ring system, all atoms in the ring system are sp² hybridized and the total number of pi electrons is equal to 4n+2. An aromatic ring can be such that the ring atoms are only carbon atoms (e.g., aryl) or can include carbon and non-carbon atoms (e.g., heteroaryl).

The terms “alkoxyl” or “alkoxy” as used herein refers to an alkyl group, as defined above, having an oxygen radical attached thereto. Representative alkoxyl groups include methoxy, ethoxy, propyloxy, tert-butoxy, n-propyloxy, iso-propyloxy, n-butyloxy, iso-butyloxy, and the like. An “ether” is two hydrocarbons covalently linked by an oxygen. Accordingly, the substituent of an alkyl that renders that alkyl an ether is or resembles an alkoxyl, such as can be represented by one of —O-alkyl, —O-alkenyl, and —O-alkynyl. Aroxy can be represented by —O-aryl or O-heteroaryl, wherein aryl and heteroaryl are as defined below. The alkoxy and aroxy groups can be substituted as described above for alkyl.

The term “aralkyl”, as used herein, refers to an alkyl group substituted with an aryl group (e.g., an aromatic or heteroaromatic group).

The term “alkylthio” refers to an alkyl group, as defined above, having a sulfur radical attached thereto. In preferred embodiments, the “alkylthio” moiety is represented by one of —S-alkyl, —S-alkenyl, and —S-alkynyl. Representative alkylthio groups include methylthio, ethylthio, and the like. The term “alkylthio” also encompasses cycloalkyl groups, alkene and cycloalkene groups, and alkyne groups. “Arylthio” refers to aryl or heteroaryl groups.

The term “sulfinyl” means the radical —SO—. It is noted that the sulfinyl radical can be further substituted with a variety of substituents to form different sulfinyl groups including sulfinic acids, sulfinamides, sulfinyl esters, sulfoxides, and the like.

The term “sulfonyl” means the radical —SO₂—. It is noted that the sulfonyl radical can be further substituted with a variety of substituents to form different sulfonyl groups including sulfonic acids (—SO₃H), sulfonamides, sulfonate esters, sulfones, and the like.

The term “thiocarbonyl” means the radical —C(S)—. It is noted that the thiocarbonyl radical can be further substituted with a variety of substituents to form different thiocarbonyl groups including thioacids, thioamides, thioesters, thioketones, and the like.

As used herein, the term “amino” means —NH₂. The term “alkylamino” means a nitrogen moiety having at least one straight or branched unsaturated aliphatic, cyclyl, or heterocyclyl radicals attached to the nitrogen. For example, representative amino groups include —NH₂, —NHCH₃, —N(CH₃)₂, —NH(C₁-C₁₀alkyl), —N(C₁-C₁₀alkyl)₂, and the like. The term “alkylamino” includes “alkenylamino,” “alkynylamino,” “cyclylamino,” and “heterocyclylamino.” The term “arylamino” means a nitrogen moiety having at least one aryl radical attached to the nitrogen. For example —NHaryl, and —N(aryl)₂. The term “heteroarylamino” means a nitrogen moiety having at least one heteroaryl radical attached to the nitrogen. For example —NHheteroaryl, and —N(heteroaryl)₂. Optionally, two substituents together with the nitrogen can also form a ring. Unless indicated otherwise, the compounds described herein containing amino moieties can include protected derivatives thereof. Suitable protecting groups for amino moieties include acetyl, tertbutoxycarbonyl, benzyloxycarbonyl, and the like.

The term “aminoalkyl” means an alkyl, alkenyl, and alkynyl as defined above, except where one or more substituted or unsubstituted nitrogen atoms (—N—) are positioned between carbon atoms of the alkyl, alkenyl, or alkynyl. For example, an (C₂-C₆)aminoalkyl refers to a chain comprising between 2 and 6 carbons and one or more nitrogen atoms positioned between the carbon atoms.

The term “alkoxyalkoxy” means —O)-(alkyl)-O-(alkyl), such as —OCH₂CH₂OCH₃, and the like.

The term “alkoxycarbonyl” means —C(O)O-(alkyl), such as —C(═O)OCH₃, —C(═O)OCH₂CH₃, and the like.

The term “alkoxyalkyl” means -(alkyl)-O-(alkyl), such as —CH₂OCH₃, —CH₂OCH₂CH₃, and the like.

The term “aryloxy” means —O-(aryl), such as —O-phenyl, —O-pyridinyl, and the like.

The term “arylalkyl” means -(alkyl)-(aryl), such as benzyl (i.e., —CH₂phenyl), —CH₂-pyrindinyl, and the like.

The term “arylalkyloxy” means —O-(alkyl)-(aryl), such as —O-benzyl, —O—CH₂-pyridinyl, and the like.

The term “cycloalkyloxy” means —O-(cycloalkyl), such as —O-cyclohexyl, and the like.

The term “cycloalkylalkyloxy” means —O-(alkyl)-(cycloalkyl), such as —-OCH₂cyclohexyl, and the like.

The term “aminoalkoxy” means —O-(alkyl)-NH₂, such as —OCH₂NH₂, —OCH₂CH₂NH₂, and the like.

The term “mono- or di-alkylamino” means —NH (alkyl) or —N(alkyl)(alkyl), respectively, such as —NHCH₃, —N(CH₃)₂, and the like.

The term “mono- or di-alkylaminoalkoxy” means —O-(alkyl)-NH (alkyl) or —O-(alkyl)-N(alkyl)(alkyl), respectively, such as —OCH₂NHCH₃, —OCH₂CH₂N(CH₃)₂, and the like.

The term “arylamino” means —NH (aryl), such as —NH-phenyl, —NH-pyridinyl, and the like.

The term “arylalkylamino” means —NH-(alkyl)-(aryl), such as —NH-benzyl, —NHCH₂-pyridinyl, and the like.

The term “alkylamino” means —NH (alkyl), such as —NHCH₃, —NHCH₂CH₃, and the like.

The term “cycloalkylamino” means —NH-(cycloalkyl), such as —NH-cyclohexyl, and the like.

The term “cycloalkylalkylamino” —NH-(alkyl)-(cycloalkyl), such as —NHCH₂-cyclohexyl, and the like.

It is noted in regard to all of the definitions provided herein that the definitions should be interpreted as being open ended in the sense that further substituents beyond those specified may be included. Hence, a C₁ alkyl indicates that there is one carbon atom but does not indicate what are the substituents on the carbon atom. Hence, a C₁ alkyl comprises methyl (i.e., —CH₃) as well as —CRₐR_{b}R_{c} where Rₐ, R_{b}, and R_{c} can each independently be hydrogen or any other substituent where the atom alpha to the carbon is a heteroatom or cyano. Hence, CF₃, CH₂OH and CH₂CN are all C₁ alkyls.

Unless otherwise stated, structures depicted herein are meant to include compounds which differ only in the presence of one or more isotopically enriched atoms. For example, compounds having the present structure except for the replacement of a hydrogen atom by a deuterium or tritium, or the replacement of a carbon atom by a ¹³C- or ¹⁴C-enriched carbon are within the scope of the invention.

In various embodiments, compounds of the present invention as disclosed herein may be synthesized using any synthetic method available to one of skill in the art. Non-limiting examples of synthetic methods used to prepare various embodiments of compounds of the present invention are disclosed in the Examples section herein.

As used herein, the term “substituted” refers to independent replacement of one or more (typically 1, 2, 3, 4, or 5) of the hydrogen atoms on the substituted moiety with substituents independently selected from the group of substituents listed below in the definition for “substituent” or otherwise specified.

As used herein, the terms “substituent” and “substituents” refers to groups that are typically added to other groups or parent compounds to enhance desired properties or give desired effects. Substituents can be protected or unprotected and can be added to one available site or to many available sites in a parent compound. Substituents may also be further substituted with other substituents and may be attached directly or via a linking group such as an alkyl or hydrocarbyl group to a parent compound. In general, a non-hydrogen substituent can be any substituent that can be bound to an atom of the given moiety that is specified to be substituted. Examples of substituents include, but are not limited to, acyl, acylamino, acyloxy, aldehyde, alicyclic, aliphatic, alkanesulfonamido, alkanesulfonyl, alkaryl, alkenyl, alkoxy, alkoxycarbonyl, alkyl, alkylamino, alkylcarbanoyl, alkylene, alkylidene, alkylthios, alkynyl, amide, amido, amino, aminoalkyl, aralkyl, aralkylsulfonamido, arenesulfonamido, arenesulfonyl, aromatic, aryl, arylamino, arylcarbanoyl, aryloxy, azido, carbamoyl, carbonyl, carbonyls including ketones, carboxy, carboxylates, CF₃, cyano (CN), cycloalkyl, cycloalkylene, ester, ether, haloalkyl, halogen, halogen, heteroaryl, heterocyclyl, hydroxy, hydroxyalkyl, imino, iminoketone, ketone, mercapto, nitro, oxaalkyl, oxo, oxoalkyl, phosphoryl (including phosphonate and phosphinate), silyl groups, sulfonamido, sulfonyl (including sulfate, sulfamoyl and sulfonate), thiols, and ureido moieties, each of which may optionally also be substituted or unsubstituted. In some cases, two substituents, together with the carbon(s) to which they are attached to, can form a ring. Additional, non-limiting examples of substituents include halogen, hydroxyl, alkyl, alkenyl, alkynyl, acyl (—C(O)Raa), carboxyl (—C(O)O—Raa), aliphatic groups, alicyclic groups, alkoxy, substituted oxo (—O—Raa), aryl, aralkyl, heterocyclic, heteroaryl, heteroarylalkyl, amino (—NRbbRcc), imino (=NRbb), amido (—C(O)N—RbbRcc or —N(Rbb)C(O)Raa), azido (—N3), nitro (—NO₂), cyano (—CN), carbamido (—OC(O)NRbbRcc or —N(Rbb)C(O)ORaa), ureido (—N(Rbb)C(O)NRbbRcc), thioureido (—N(Rbb)C(S)NRbbRcc), guanidinyl N(Rbb)C(═NRbb) NRbbRcc), amidinyl (—C(═NRbb)-NRbbRcc or —N(Rbb)C(NRbb) Raa), thiol (—SRbb), sulfinyl (—S(O) Rbb), sulfonyl (—S(O)2Rbb), sulfonamidyl (—S(O)2NRbbRcc or —N(Rbb)S(O)2Rbb) and conjugate groups. Wherein each Raa, Rbb and Rcc is, independently, H, an optionally linked chemical functional group or a further substituent group with a preferred list including without limitation H, alkyl, alkenyl, alkynyl, aliphatic, alkoxy, acyl, aryl, aralkyl, heteroaryl, alicyclic, heterocyclic and heteroarylalkyl.

### Synthesis and Characterization of Ni Complexes

Controlling the chain growth process in non-living polymerization reactions is difficult because chain termination typically occurs faster than the time it takes to apply an external trigger. To overcome this limitation, we developed a strategy to regulate non-living polymerizations by exploiting the chemical equilibria between a metal catalyst and secondary metal cations. We prepared two nickel phenoxyphosphine-polyethylene glycol variants, one with 2-methoxyphenyl (Ni1) and another with 2,6-dimethoxyphenyl (Ni2) phosphine substituents. Ethylene polymerization studies using these complexes in the presence of alkali salts revealed that chain growth is strongly dependent on electronic effects whereas chain termination is dependent on both steric and electronic effects. Surprisingly, by adjusting the solvent polarity, we can favor polymerizations via non-switching or dynamic switching modes. For example, in a 100:0.2 mixture of toluene/diethyl ether, reactions of Ni1 and both Li⁺ and Na⁺ cations in the presence of ethylene yielded bimodal polymers with different relative fractions depending on the Li⁺/Na⁺ ratio used. Surprisingly, in a 98:2 mixture of toluene/diethyl ether, reactions of Ni2 and Cs⁺ in the presence of ethylene generated monomodal polyethylene with dispersity (Ð)<2.0 and increasing molecular weight as the amount of Cs⁺ added increased. Solution studies by NMR spectroscopy showed that cation exchange between the nickel complexes and alkali cations in 98:2 toluene/diethyl ether is fast on the NMR timescale, which without being bound by theory, supports our proposed dynamic switching mechanism.

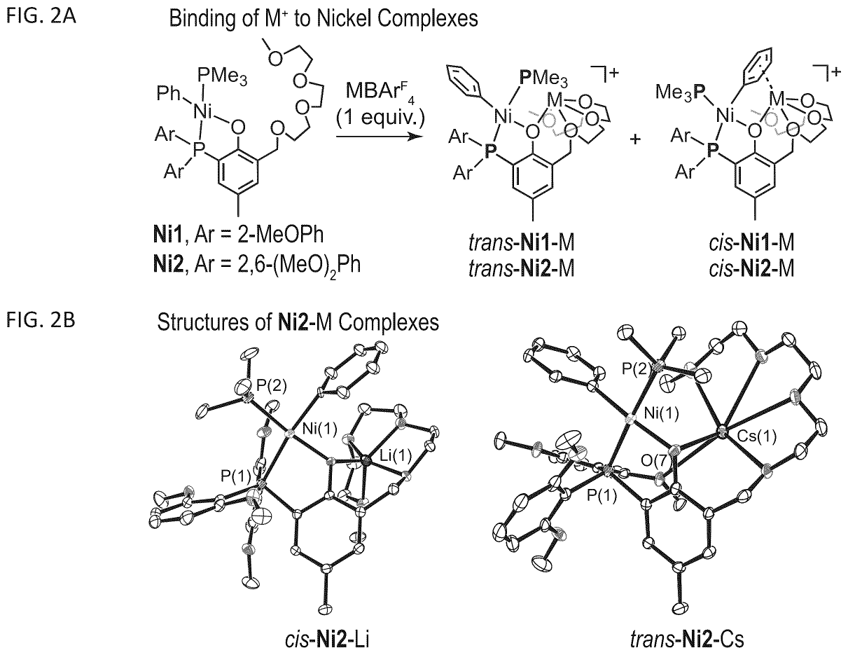

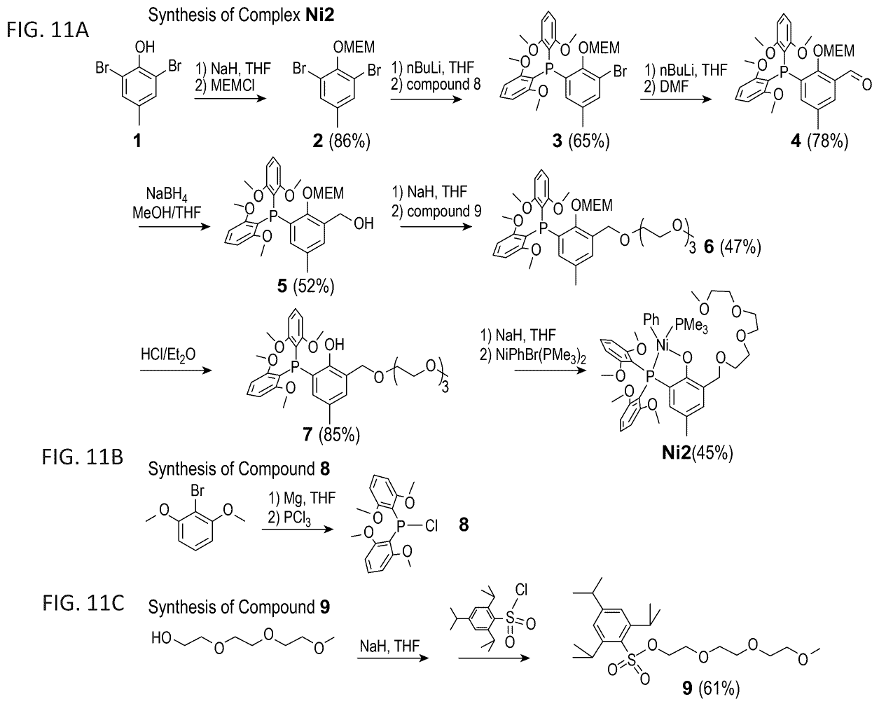

Our first-generation Ni1 complex (Tran, T. V.; Nguyen, Y. H.; Do, L. H. Development of Highly Productive Nickel-Sodium Phenoxyphosphine Ethylene Polymerization Catalysts and their Reaction Temperature Profiles. Polym. Chem. 2019, 10, 3718-3721; Tran, T. V.; Karas, L. J.; Wu, J. I.; Do, L. H. Elucidating Secondary Metal Cation Effects on Nickel Olefin Polymerization Catalysts. ACS Catal. 2020, 10, 10760-10772) which contains 2-methoxyphenyl phosphine substituents, in combination with alkali ions gave olefin polymerization catalysts that were among some of the most productive late transition metal catalysts reported to date (FIG. 2A). Encouraged by these results, we prepared a new Ni2 complex that features more sterically bulky 2,6-dimethoxyphenyl phosphine substituents. First, the ligand derivative 7 was synthesized using a procedure outlined in FIG. 11A-FIG. 11C. Metalation of 7 was readily accomplished by treating the compound with sodium hydride, followed by mixing with [NiPhBr(PMe₃)₂] to give [Ni(Ph)(PMe₃)(7)](Ni2) in 45% yield. This Ni2 complex was fully characterized by NMR spectroscopy and elemental analysis as provided herein.

### Alkali Cation Binding

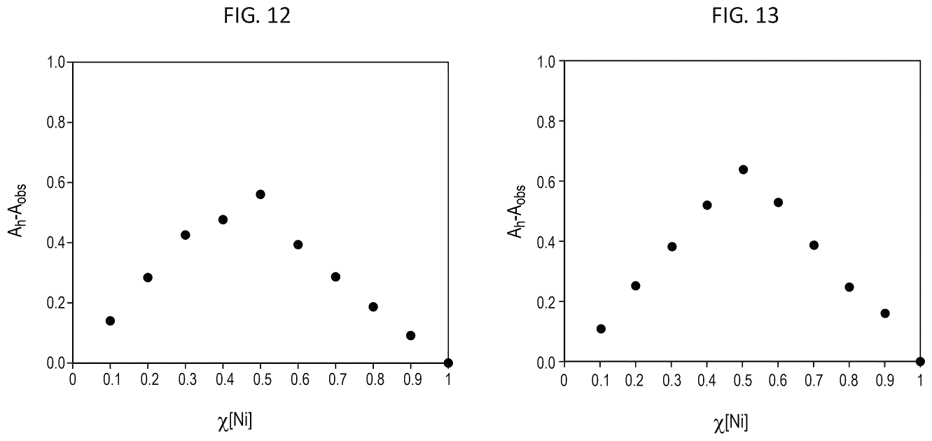

To study the coordination chemistry of Ni2 with alkali ions, we used UV-vis absorption spectroscopy. When Cs was added to Ni2 in diethyl ether, the band at ˜370 nm decreased with formation of clear isosbestic points, suggesting that it had converted to new Ni2-Cs species. Based on the method of continuous variation (FIG. 12-FIG. 15), (Renny, J. S., Tomasevich, L. L.; Tallmadge, E. H.; Collum, D. B. Method of Continuous Variations: Applications of Job Plots to the Study of Molecular Associations in Organometallic Chemistry. Angew. Chem., Int. Ed. 2013, 52, 11998-12013) the results showed that Ni2 formed 1:1 complexes with M⁺ (where M=Li⁺, Na⁺, K⁺, or Cs⁺). Although our polymerization reactions below were conducted in solvent mixtures containing only small percentages of Et₂O, it was necessary to use neat diethyl ether to fully solubilize excess M⁺ salts in these experiments.

TABLE 1
Comparison of Select Ni2-M Atomic Distancesª

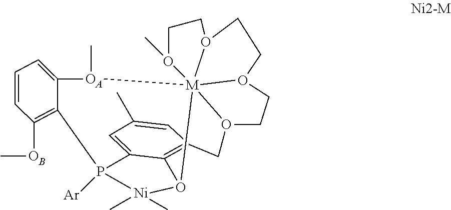

| Distance (Å) | Ni2-Li | Ni2-Na | Ni2-K | Ni2-Cs |
|---|---|---|---|---|
| Ni-M | 3.56 (4.86) | 3.59 (5.00) | 3.59 (5.25) | 3.75 (5.53) |
| OA-M | 4.22 (4.34) | 3.07 (4.48) | 2.94 (4.73) | 3.16 5.01) |

ªDistances in parentheses are the sum of the Van der Waals radii between two atoms (Batsanov, S. S. Van der Waals Radii of Elements. Inorg. Mater. 2001, 37, 871-885). The PMe₃ and Ph ligands coordinated to Ni were omitted for clarity.

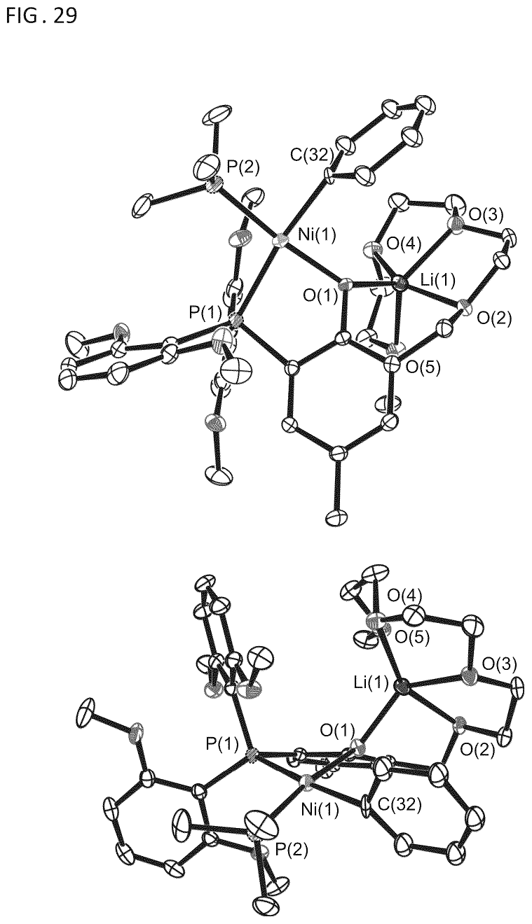

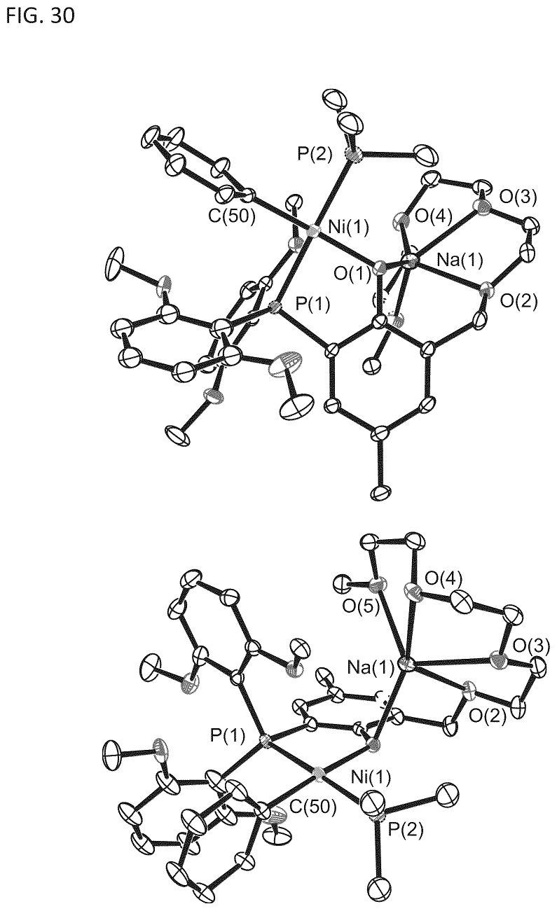

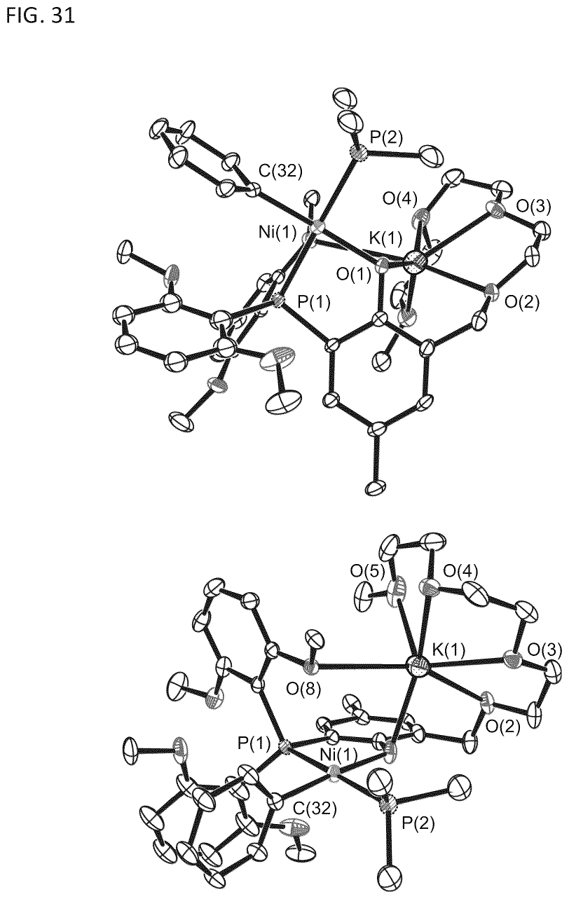

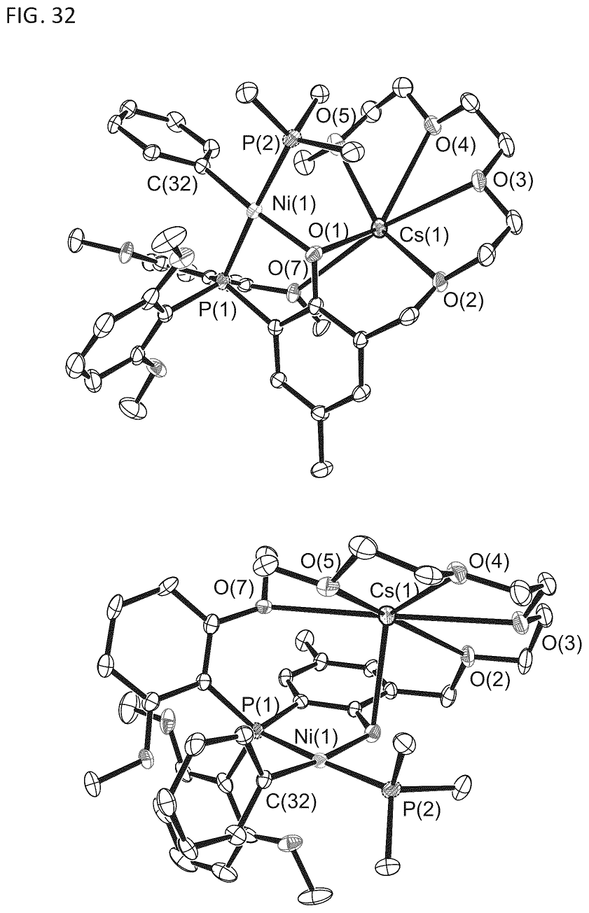

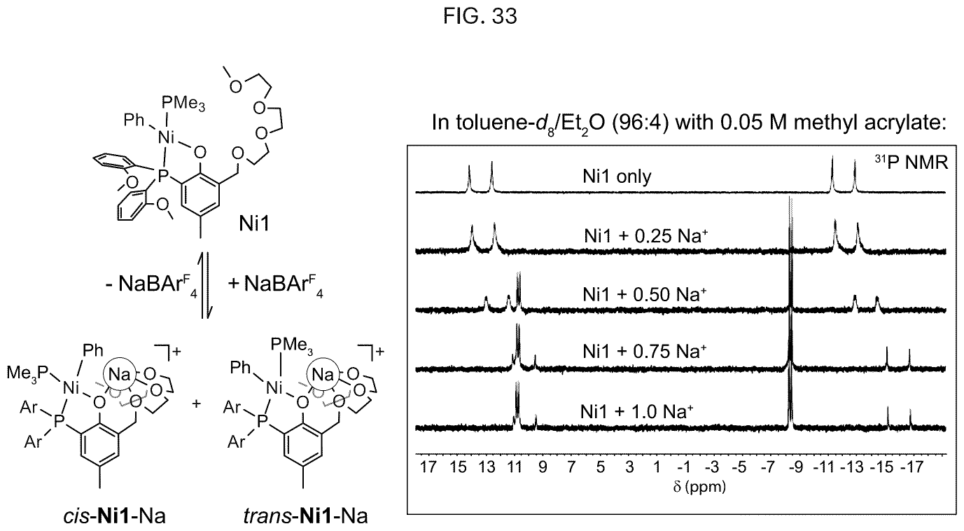

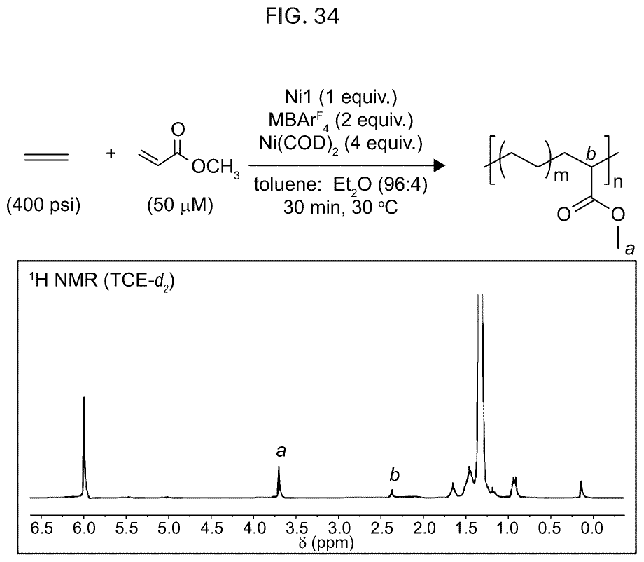

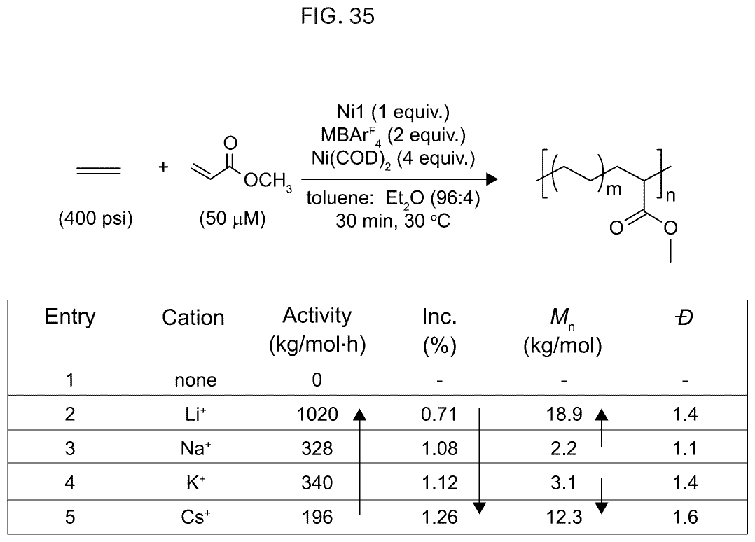

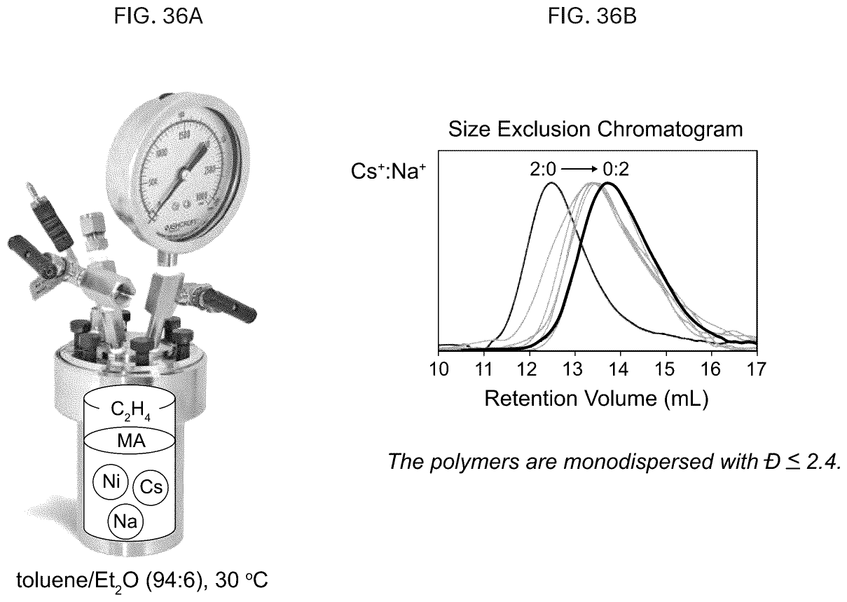

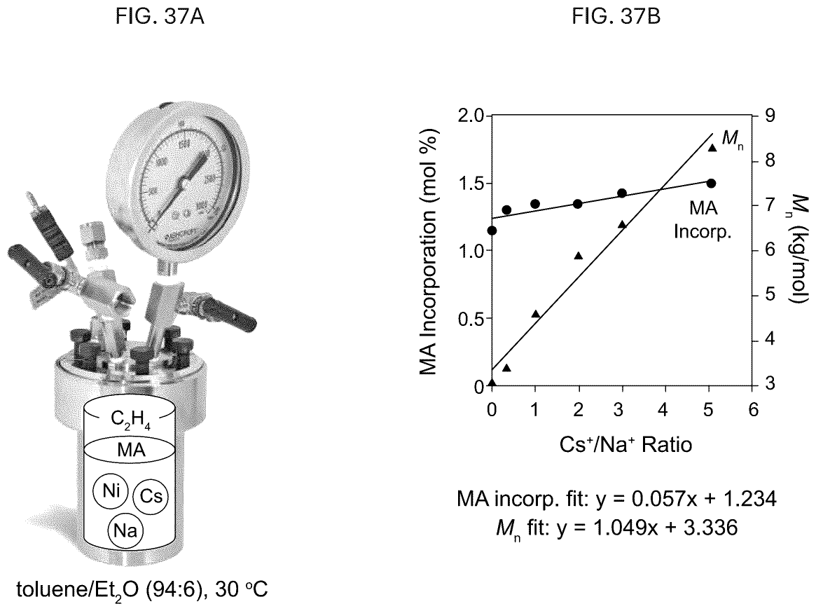

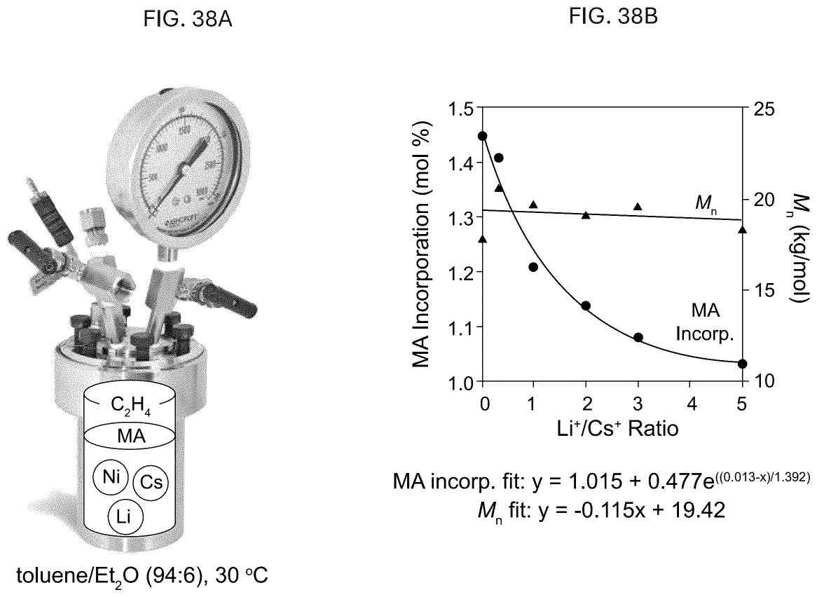

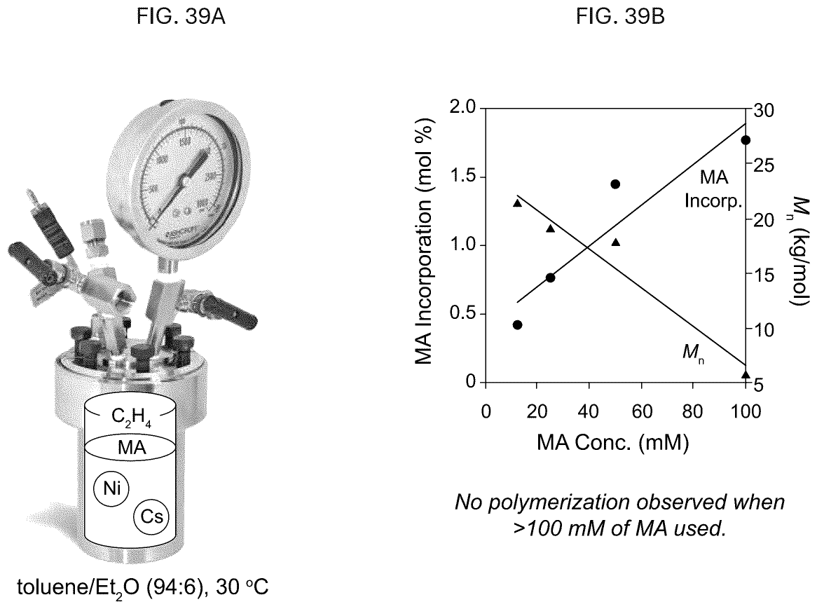

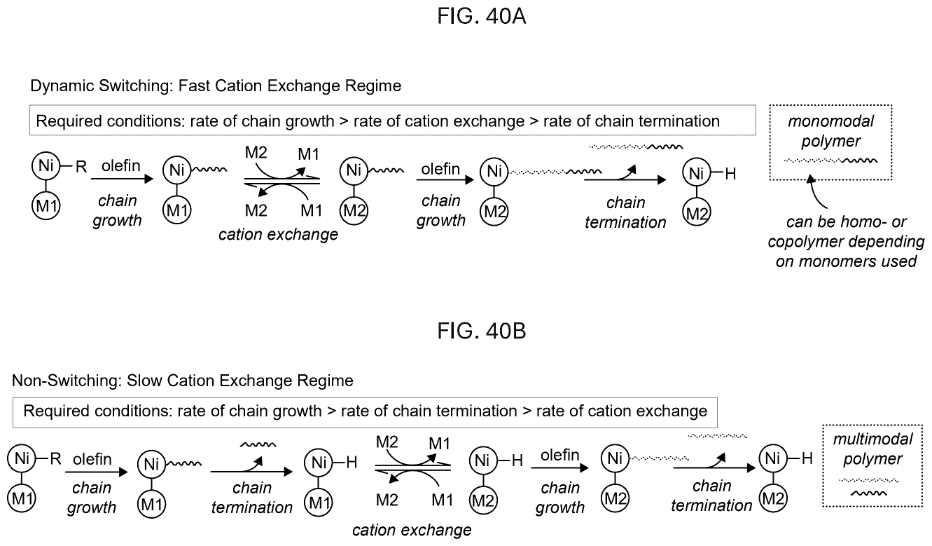

To obtain structural characterization of the heterobimetallic complexes, we grew single crystals by combining Ni2 with 1 equiv. of MBAr^{F}₄ (BAr^{F}₄⁻=tetrakis(3,5-bis(trifluoromethyl)phenyl)borate) in toluene/Et₂O or benzene/Et₂O and then layering with pentane. The crystals of the Ni2-M series were successfully analyzed by X-ray crystallography, showing that the complexes have the formula [NiM(Ph)(PMe₃)(7)](BAr^{F}₄) (i.e., [NiM(Ph)(PMe₃)(phenoxyphosphine-PEG)](BAr^{F}₄) (FIG. 29-FIG. 32). As shown in FIG. 29-FIG. 32, the nickel centers have square planar geometries, and the alkali ions are ligated by four oxygen donors from PEG and one oxygen donor from the phenolate group. The Ni2-Li complex is in the cis form (FIG. 2B and FIG. 29), in which its phosphine ligands are adjacent to each other in the nickel square plane, whereas Ni2-Na(FIG. 30), Ni2-K (FIG. 31), and Ni2-Cs (FIG. 2B and FIG. 32) are in the trans form, in which their phosphine ligands are opposite one another. The cis and trans isomer distributions in solution were quantified by ³¹P NMR spectroscopy (Table 10). Surprisingly, the complexes display Ni-M distances of 3.56, 3.59, 3.59, and 3.75 Å for Ni2-Li, Ni2-Na, Ni2-K, and Ni2-Cs, respectively, which are shorter than the sum of their Van der Waals radii (Table 1) (Batsanov, S. S. Van der Waals Radii of Elements. Inorg. Mater. 2001, 37, 871-885). In some complexes, there appears to be coordination by a methoxy substituent to the alkali metal, which forms a steric shield surrounding the top hemisphere of the nickel coordination sphere. Based on the short O_{A}(methoxy)-M distances of 3.07, 2.94, and 3.16 Å for Ni2-Na, Ni2-K, and Ni2-Cs, respectively, these interactions appear to be relatively strong. In contrast, the O_{A}-M separation is only about 4.22 Å in Ni2-Li, which is close to the Van der Waals sum of 4.34 Å.

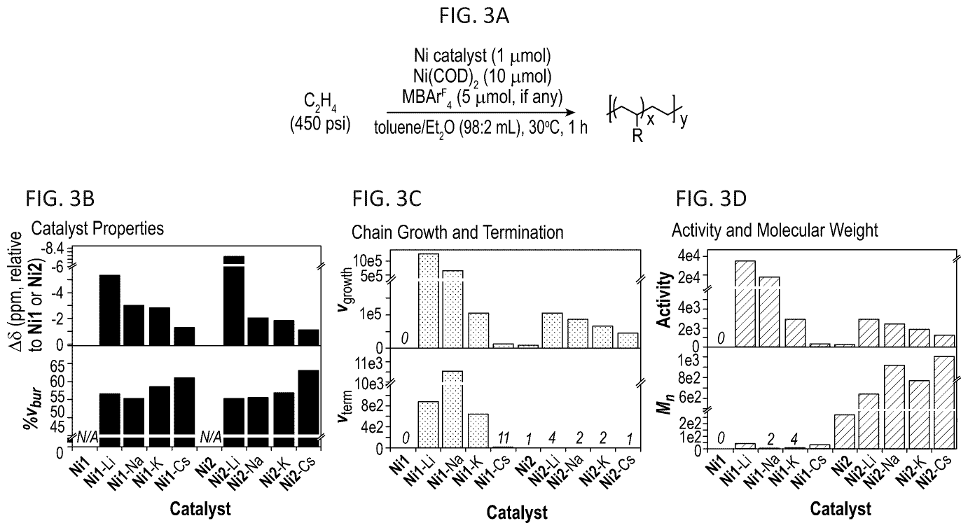

Next, we calculated the percent buried volume (% V_{bur}) of the Ni2-M complexes, which is a measure of the three-dimensional space occupied by the supporting ligand in the primary coordination sphere (Falivene, L.; Credendino, R.; Poater, A.; Petta, A.; Serra, L.; Oliva, R.; Scarano, V.; Cavallo, L. SambVca 2. A Web Tool for Analyzing Catalytic Pockets with Topographic Steric Maps. Organometallics 2016, 35, 2286-2293; Falivene, L.; Cao, Z.; Petta, A.; Serra, L.; Poater, A.; Oliva, R.; Scarano, V.; Cavallo, L. Towards the Online Computer-Aided Design of Catalytic Pockets. Nat. Chem. 2019, 11, 872-879). Our analysis showed that Ni2-Li, Ni2-Na, Ni2-K, and Ni2-Cs have % V_{bur} of 50.6, 51.3, 53.7, and 66.2%, respectively (FIG. 3B, Table 9). The parent Ni2 complex is a viscous oil so it could not be crystallized for structural analysis. These results are consistent with our previous studies of the Ni1-M complexes, in which we showed that % V_{bur} tracked with both the Ni-M(PEG) distance and the size of M⁺. For Ni1-M, the steric volume trend was in the order Ni1-Cs>Ni1-K>Ni1-Li>Ni1-Na, whereas that for Ni2-M was Ni2-Cs>Ni1-K>Ni1-Na>Ni1-Li. Although % V_{bur} is a convenient metric for comparing the steric bulk between different complexes, it does not consider structural rigidity or conformational changes during catalysis. Because Ni2 contains more sterically bulky aryl substituents than Ni1 (i.e., 2,6-dimethoxyphenyl rather than 2-methoxyphenyl), we hoped that the Ni2 would have more restricted molecular motion than the Ni1 in solution. As we discuss herein below, the structural differences between Ni1 and Ni2 surprisingly have profound impacts on their catalytic performance.

We found that complexation of alkali ions to Ni1 reduced the electron density at the nickel center to different extents, depending on the relative Lewis acidity of M⁺ (i.e., Li⁺>Na⁺>K⁺>Cs⁺). When the ³¹P NMR spectra of various Ni1-M species were measured, it was observed that their chemical shifts reflected their electronic nature. For example, the differences in δ relative to that in Ni1 (48=& (Ni1-M)-8 (Ni1, 13.3 ppm)) were-5.4, −3.0, −2.8, and −1.3 ppm for Ni1-Li, Ni1-Na, Ni1-K, and Ni1-Cs, respectively, (FIG. 3B, Table 7). When we applied a similar analysis to the ³¹P NMR spectra of Ni2-M, we obtained Δδ values of −7.9, −2.0, −1.8, and −1.1 ppm for Ni2-Li, Ni2-Na, Ni2-K, and Ni2-Cs, respectively (Δδ=δ(Ni2-M)−δ(Ni2, −3.48 ppm)). Without being bound by theory, these results suggest that the nickel-alkali complexes are electronically tuned in accordance with the Lewis acidity of M⁺. Qualitatively, Na⁺ and K⁺ have similar electron-withdrawing effects whereas Li⁺ is the most and Cs⁺ is the least electron-withdrawing. Without being bound by theory the NMR spectra of Ni1 and Ni2 suggest that they are electronically different.

### Ethylene Polymerization

Our ethylene polymerization studies using Ni1 with and without M′ were reported previously and are summarized in FIG. 3A-FIG. 3D, Table 11) (Tran, T. V.; Nguyen, Y. H.; Do, L. H. Development of Highly Productive Nickel-Sodium Phenoxyphosphine Ethylene Polymerization Catalysts and their Reaction Temperature Profiles. Polym. Chem. 2019, 10, 3718-3721; Tran, T. V.; Karas, L. J.; Wu, J. I.; Do, L. H. Elucidating Secondary Metal Cation Effects on Nickel Olefin Polymerization Catalysts. ACS Catal. 2020, 10, 10760-10772). With the Ni2 complexes in hand, we proceeded to evaluate its reactivity with ethylene. Inside the glovebox, the nickel complex, MBAr^{F}₄ (if any), and the activator Ni(COD)₂ (COD=1,5-cyclooctadiene) were combined in toluene/Et₂O and loaded into a syringe. This solution was injected into an autoclave containing ethylene-saturated solvent to give a final mixture containing toluene/Et₂O in 98:2 ratio. The reactor was then pressurized to 450 psi of ethylene and allowed to stir at 30° C. for 1 h (Table 12). In the absence of M⁺, Ni2 showed moderate activity (2.79×10² kg/mol·h) and produced linear polyethylene (PE) with moderate molecular weight (Mₙ=2.71×10² kg/mol). The activity increased by 10.5×, 8.6×, 6.7×, and 4.5× when Li⁺, Na⁺, K⁺, and Cs⁺ were added, respectively (FIG. 3D). The Ni2-M catalysts also afforded linear polyethylene (PE) but with significantly higher molecular weights than that of the parent Ni2 catalyst alone. In fact, the polymers obtained from Ni2-Na and Ni2-Cs were within the ultra-high molecular weight range (1.23×10³ kg/mol and 1.42×10³ kg/mol, respectively). In most cases, their polyethylene (PE) dispersities (Ð=M_{w}/Mₙ) were below 2.0, suggesting, without being bound by theory, that the Ni2-M species are single site catalysts.

TABLE 2
Polymerizations Performed at 90° C.

| Entry | Cat. | Salt | Act.^{f} | Mₙ^{g} | Ð | Chains/Ni |
|---|---|---|---|---|---|---|
| 1^{a} | Ni1 | none | 0 | — | — | — |
| 2^{b} | Ni1 | Li⁺ | 13000 | 2.1 | 2.2 | 6238 |
| 3^{a} | Ni1 | Na⁺ | 4800 | 0.9 | 1.5 | 5356 |
| 4^{c} | Ni1 | K⁺ | 10000 | 1.1 | 1.6 | 4527 |
| 5^{c} | Ni1 | Cs⁺ | 23000 | 15.7 | 1.4 | 730 |
| 6^{d} | Ni2 | none | 23000 | 40.6 | 2.0 | 567 |
| 7^{d} | Ni2 | Li⁺ | 49500 | 15.2 | 2.6 | 3257 |
| 8^{d} | Ni2 | Na⁺ | 58500 | 30.7 | 1.8 | 1906 |
| 9^{d} | Ni2 | K⁺ | 18500 | 49.8 | 1.6 | 371 |
| 10^{d} | Ni2 | Cs⁺ | 23500 | 117.3 | 1.7 | 200 |
| 11^{e} | Ni2 | Cs⁺ | 33000 | 185.2 | 1.5 | 178 |

^{a}Polymerization conditions: Ni1 (0.5 μmol), MBAr^{F}₄ (1 μmol, if any), Ni(COD)₂ (4 μmol), ethylene (450 psi), 100 mL toluene, 1 h.
^{b}Ni1 (0.1 μmol), LiBAr^{F}₄ (0.2 μmol), Ni(COD)₂ (0.8 μmol).
^{c}Same as condition a, except the reaction was performed for 30 min.
^{d} Ni2 (1.0 μmol), MBAr^{F}₄ (5.0 μmol, if any), Ni(COD)₂ (10 μmol), ethylene (450 psi), 98 mL toluene/2 mL Et₂O, 1 h.
^{e}Ni2 (0.1 μmol), MBAr^{F}₄ (0.5 μmol), Ni(COD)₂ (1 μmol).
^{f}Activity = kg/mol · h.
^{g}Mₙ = kg/mol.

When the reaction temperature was increased, our Ni2-M complexes showed excellent catalytic performance (Table 2 and Table 12). For example, the activity of Ni2-Li increased 16.8× going from 30° C. to 90° C. (i.e., from 2.94×10³ to 4.95×10⁴ kg/mol Ni·h). However, its polyethylene (PE) molecular weight dropped from 6.85×10² to 1.52×10¹ kg/mol. Without being bound by theory, this inverse effect of temperature on catalyst activity and polymer molecular weight (MW) is commonly observed and may be due to partial catalyst degradation at elevated temperatures or the rate of chain termination increasing faster than the rate of chain growth (Rhinehart, J. L.; Brown, L. A.; Long, B. K. A Robust Ni(II) α-Diimine Catalyst for High Temperature Ethylene Polymerization. J. Am. Chem. Soc. 2013, 135, 16316-16319; Takeuchi, D.; Takano, S.; Takeuchi, Y.; Osakada, K. Ethylene Polymerization at High Temperatures Catalyzed by Double-Decker-Type Dinuclear Iron and Cobalt Complexes: Dimer Effect on Stability of the Catalyst and Polydispersity of the Product. Organometallics 2014, 33, 5316-5323). Under all temperature regimes, except for Ni2-Cs at 30° C. (Table 12, entry 5), greater than 1 polymer chains were produced per nickel indicating, without being bound by theory, that our catalysts are non-living. At 90° C., about 200-6000 polymers per nickel were obtained using Ni1-M and Ni2-M (Table 2).

Surprisingly, in comparison to other thermally stable nickel catalysts reported in the literature (e.g., Cat3 (Wang, X.-l.; Zhang, Y.-p.; Wang, F.; Pan, L.; Wang, B.; Li, Y.-s. Robust and Reactive Neutral Nickel Catalysts for Ethylene Polymerization and Copolymerization with a Challenging 1,1-Disubstituted Difunctional Polar Monomer. ACS Catal. 2021, 11, 2902-2911), Cat4 (Rhinehart, J. L.; Brown, L. A., Long, B. K. A Robust Ni(II) α-Diimine Catalyst for High Temperature Ethylene Polymerization. J. Am. Chem. Soc. 2013, 135, 16316-16319), and Cat5 (Zhang, Y.; Mu, H.; Pan, L.; Wang, X.; Li, Y. Robust Bulky [P,O] Neutral Nickel Catalysts for Copolymerization of Ethylene with Polar Vinyl Monomers. ACS Catal. 2018, 8, 5963-5976) in Table 18), our Ni2-Cs complex is a novel and unexpected improvement and stands out due to its ability to achieve high activity (3.30×10⁴ kg/mol Ni·h) while maintaining moderate polymer molecular weight (Mₙ=1.85×10² kg/mol, Ð=1.5) at 90° C. Without being bound by theory, these results suggest that steric blocking using pendant cations may be as effective as using sandwich ligand motifs. Catalysts that are thermally stable and exhibit high performance at elevated temperatures are particularly attractive in industrial applications.

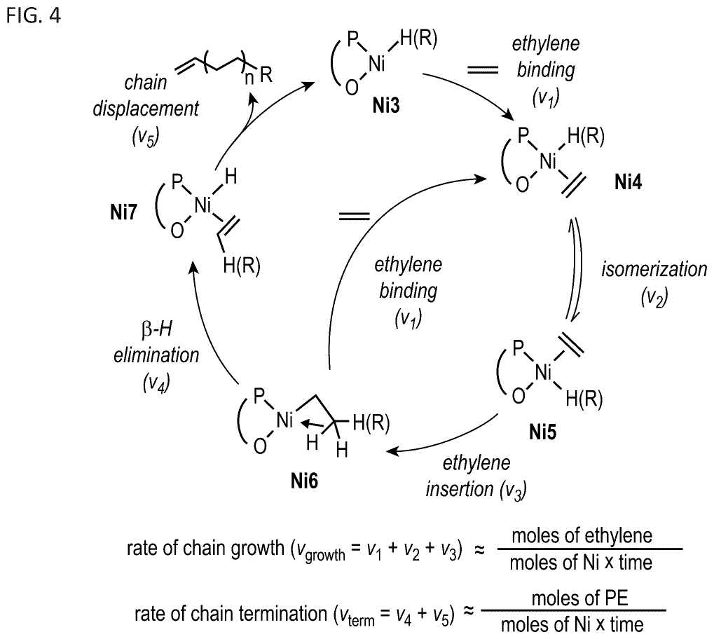

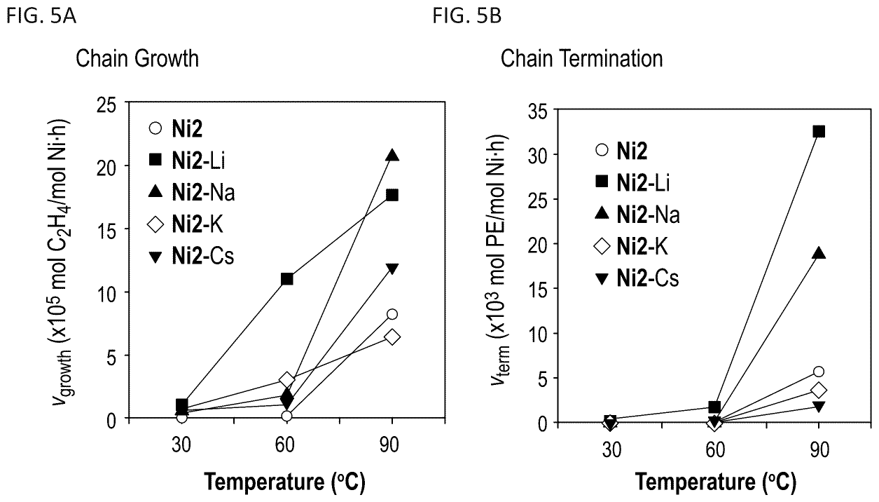

As depicted in FIG. 4, without being bound by theory the mechanism of coordination-insertion polymerization is proposed to involve ethylene binding to the vacant site of Ni3 to form Ni4, isomerization from Ni4 to Ni5, and then monomer insertion to yield Ni6. Chain propagation can continue from Ni6 to extend the polymer chain or chain termination can occur via β-hydride elimination to Ni7 and subsequent chain displacement. To extract information about the chain growth and chain termination rates in our reactions, we calculated ν_{growth} and νₜₑᵣₘ, respectively, using the equations shown in FIG. 4. (Nakano, R.; Chung, L. W.; Watanabe, Y.; Okuno, Y.; Okumura, Y.; Ito, S.; Morokuma, K., Nozaki, K. Elucidating the Key Role of Phosphine-Sulfonate Ligands in Palladium-Catalyzed Ethylene Polymerization: Effect of Ligand Structure on the Molecular Weight and Linearity of Polyethylene. ACS Catal. 2016, 6, 6101-6113; Chan, M. S. W.; Deng, L.; Ziegler, T. Density Functional Study of Neutral Salicylaldiminato Nickel (II) Complexes as Olefin Polymerization Catalysts. Organometallics 2000, 19, 2741-2750). Comparison of these rates revealed several interesting trends. First, chain growth is strongly dependent on electronic effects. Both Ni1 and Ni2 showed significant ν_{growth} enhancement in the presence of M′ in the order Li⁺>Na⁺>K⁺>Cs⁺ (FIG. 3C), which follows their Lewis acidity trend. Without being bound by theory, this observation suggests that more electron-poor Ni complexes undergo monomer propagation faster than their electron-rich counterparts. If olefin insertion (ν₃) is the rate limiting step in polymerization, the overall catalyst activity is thus greatly influenced by the electronic nature of the catalyst (FIG. 3D).

Second, without being bound by theory, chain termination is most likely dependent on both electronic and steric factors since Vier does not track with any single parameter alone (cf. FIG. 3B vs. FIG. 3C). At 30° C., νₜₑᵣₘ for Ni1-M ranged from 1.06×10¹ to 1.05×10⁴ mol PE/mol Ni·h (Δνₜₑᵣₘ=1.0×10⁴), whereas νₜₑᵣₘ for Ni2-M ranged from 0.9 to 4.3 mol PE/mol Ni·h (Δνₜₑᵣₘ=3.4). The significantly lower Vier values for Ni2-M relative to those for Ni1-M surprisingly indicate the Ni2-M is much less prone to chain termination than the Ni1-M. It has been proposed that both electronic and steric effects can impact a catalyst's tendency to undergo chain termination. For example, electron-poor complexes are more likely to form stronger 6-agostic interactions between the metal center and the C—H bond of a coordinated alky chain, which would lead to more facile β-hydride elimination. However, steric effects could also influence chain termination because bulky substituents protect the metal center from undergoing polymer chain displacement, which would decrease νₜₑᵣₘ. The dramatic differences in Vier for Ni1-M vs. Ni2-M could be rationalized in terms of both factors. First, Ni2-M is more electron-rich than Ni1-M so the former may engage in weaker C—H interactions and exhibit reduced propensity towards 8-hydride elimination compared to the latter. Second, complex Ni2-M is more structurally shielded than Ni1-M due to coordination of one of its methoxy groups to the alkali metal (Table 1) (Batsanov, S. S. Van der Waals Radii of Elements. Inorg. Mater. 2001, 37, 871-885). This rigidified framework blocks off the apical nickel site from incoming monomer, which would prevent ethylene associative chain transfer. Thus, for Ni2-M, both electronic and steric factors reinforce each other, leading to smaller νₜₑᵣₘ values in comparison to those for Ni1-M. Because polymer molecular weight is proportional to ν_{growth}/νₜₑᵣₘ and Vier is influenced by both electronic and steric factors, the chain length of a growing polymer must, therefore, be controlled by both electronic and steric factors.

Third, our polymerization results indicated that temperature has a more dramatic effect on chain termination than chain growth rates (Table 12). For example, ν_{growth} for the various nickel complexes increased by 2-10× from 30° C. to 60° C. and 10-82× from 30° C. to 90° C. (FIG. 5A). In comparison, νₜₑᵣₘ was enhanced by 4-40× from 30 to 60° C. and 40-950× from 30 to 90° C. (FIG. 5B). Without being bound by theory, these changes most likely reflect the relative energies of the activation barriers for chain growth vs. chain termination.

### Secondary Cation Exchange

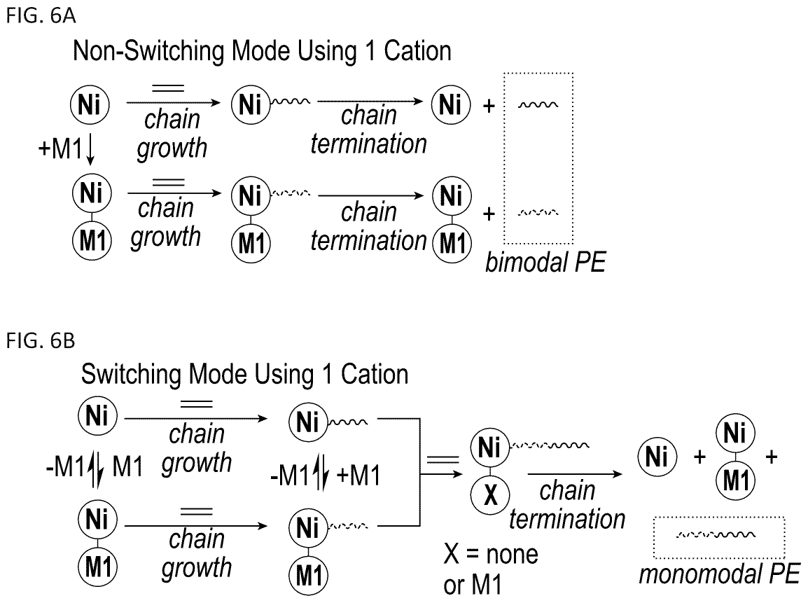

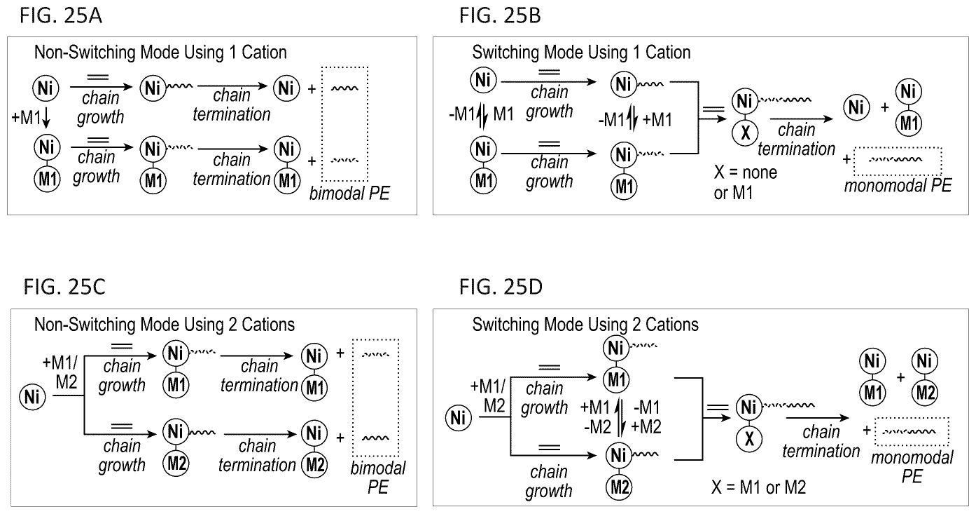

We also investigated whether we could manipulate the cation exchange equilibria of our nickel complexes to control polymerization. Without being bound by theory, in the non-switching regime (FIG. 6A), we hypothesized that combining a Ni catalyst with substoichiometric amounts of M1 (any secondary cation) would yield a mixture of Ni and Ni-M1 species. Reaction of these complexes with ethylene would afford a bimodal polymer distribution, in which one polymer is generated entirely by Ni and the other by Ni-M1. We also hypothesized that non-switching polymerization could also be accomplished using Ni with two or more different cations (FIG. 25C). Without being bound by theory, in the dynamic switching regime (FIG. 6B), we hypothesized that secondary cations can exchange between different Ni species faster than the rate of chain termination. When only one cation is used (i.e., M1), chain growth occurs from a catalyst that continuously cycles between Ni and Ni-M1 before chain terminating. Similarly, when two different cations are used (i.e., M1 and M2), each polymer chain would grow from catalysts that interconvert rapidly between Ni-M1 and Ni-M2 (FIG. 25D). Thus, dynamic switching would afford polymer with monomodal distributions and tunable microstructures.

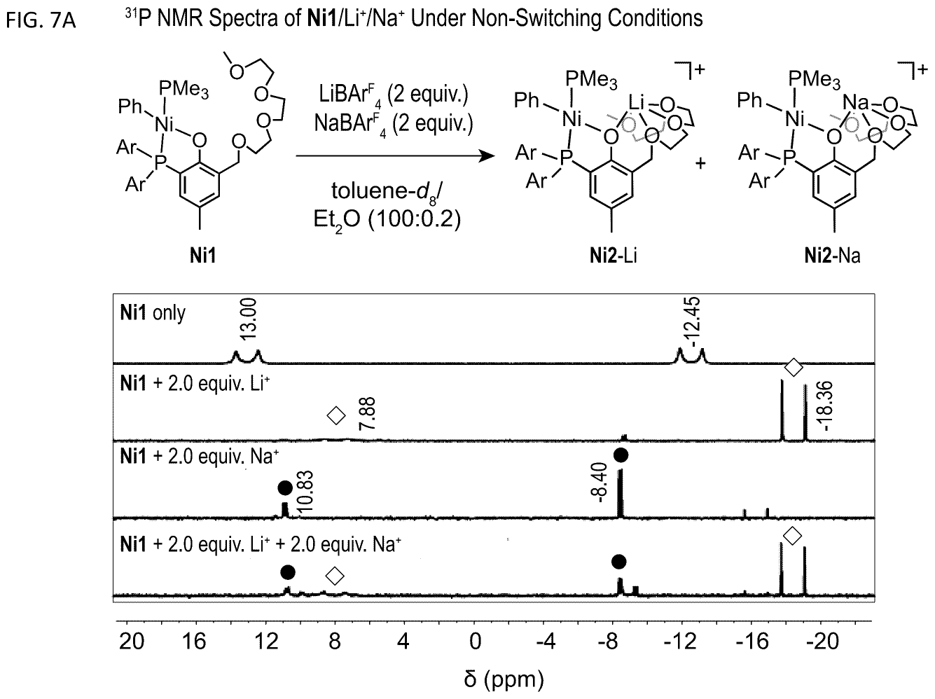

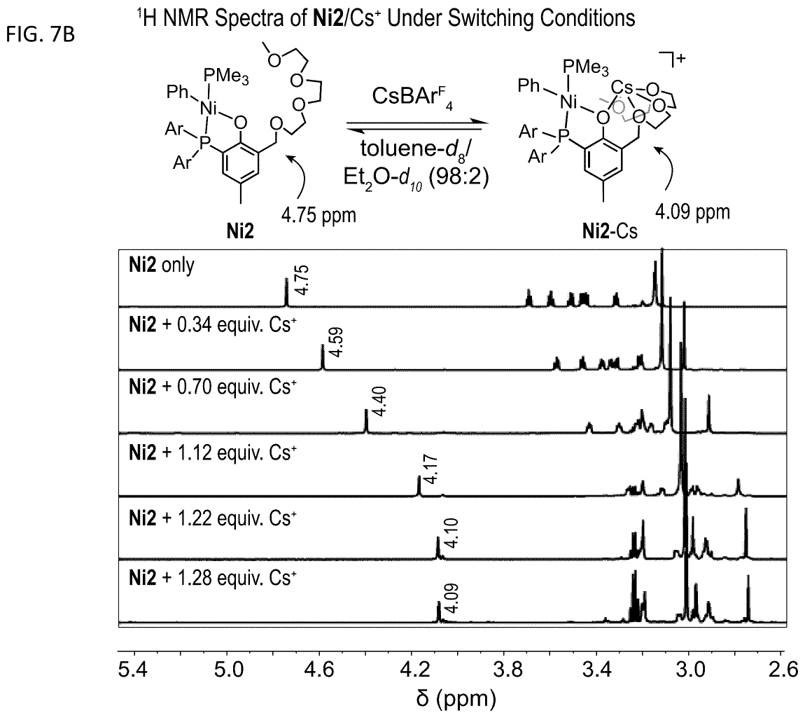

In our metal binding studies, we unexpectedly found that exchange between our Ni complexes and M⁺ was favored in polar solvents but disfavored in non-polar solvents. For example, when Ni1 was combined with 2 equiv. of both LiBAr^{F}₄ and NaBAr^{F}₄ in toluene-d₈/Et₂O (100:0.2), which is a low polarity mixture, its ³¹P NMR spectrum clearly shows resonances corresponding to both Ni1-Li (8=−18.36 and 7.88 ppm) and Ni1-Na (8=−8.40 and 10.83 ppm) species (FIG. 7A). Without being bound by theory, these results suggest that interconversion between Ni1-Li and Ni1-Na must occur slower than the NMR timescale, which is on the order of milliseconds. For the Ni2 complexes, a non-polar solvent mixture of toluene/hexane (1:3) provided the most ideal conditions for non-switching reactions.

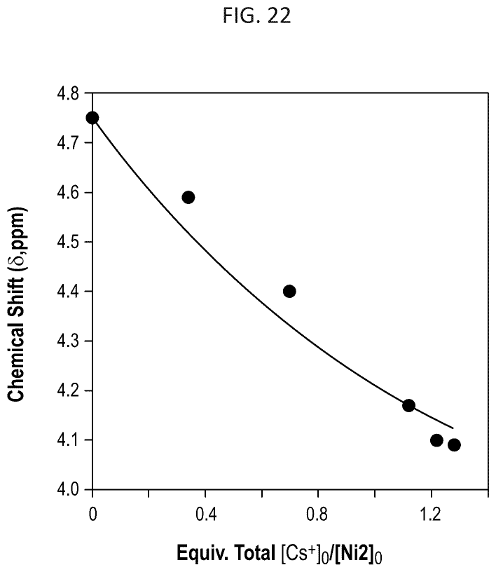

To promote cation exchange, we increased the solvent polarity by changing the toluene/Et₂O ratio from 100:0.2 to 98:2. Because Et₂O is a Lewis base, it can displace a coordinated M⁺ from the PEG chelator and help shuttle it to another mononickel complex. We discovered that too much ether, however, lowers the nickel-alkali binding affinity so the amount of Et₂O used must be precisely controlled. As shown in FIG. 7B, when various equiv. of CsBAr^{F}₄ was added to a solution containing Ni2, the ¹H NMR resonances gradually shifted upfield. For example, the benzylic signal of Ni2 at 4.75 ppm appeared at 4.09 ppm when 1.28 equiv. of Cs⁺ was introduced. Without being bound by theory, these results suggest that the Ni2 and Ni2-Cs species formed in solution are rapidly interconverting and their resonances are averaged out in their NMR spectra. Attempts were made to determine the binding constant between Ni2 and Cs⁺ based on their NMR chemical shifts (FIG. 22). Unfortunately, we were unable to obtain satisfactory fit of the binding curve because there were insufficient data points in the saturated region of the isotherm due to the limited solubility of Cs⁺ in toluene/Et₂O (98:2). Studies using competition experiments may be more suitable for determining Kₐ values under our experimental conditions. For reference, the complexation of Cs⁺ with a 15-crown-5 ether macrocycle, which contains five oxygen ether donors, has Kₐ=˜1000 M⁻¹ in acetonitrile at 25° C. (values in toluene/Et₂O were not reported). It has generally been found that acyclic ethers exhibit lower alkali ion affinities than that of analogous cyclic ethers so our PEGylated catalysts may be able to bind Cs⁺ with Kₐ<1000 M⁻¹ in acetonitrile. Without being bound by theory, we also found that increasing the reaction temperature could also increase the cation exchange rates.

### Non-Switching Polymerization

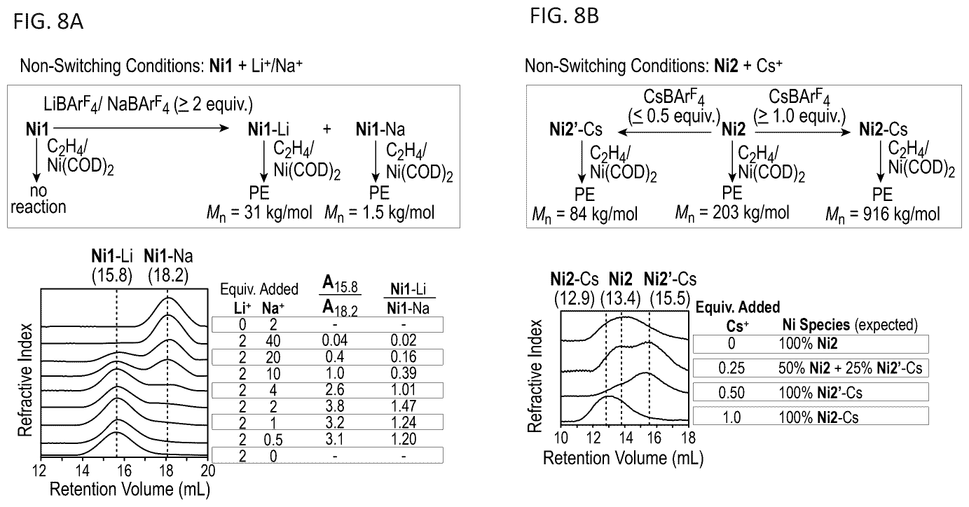

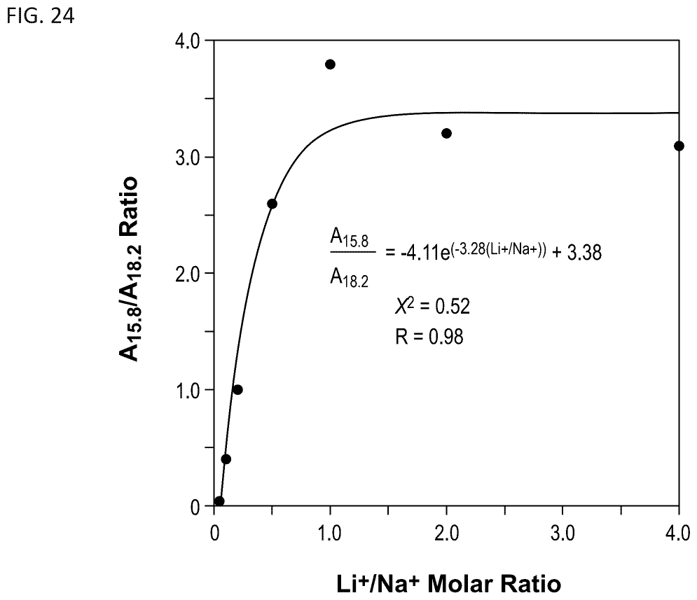

After identifying the solvent combinations needed to control secondary metal exchange rates, we next determined whether our cation-switching strategy could be used to regulate polymerization. We tested two different scenarios under non-switching conditions. In one set of experiments, Ni1 was mixed with different ratios of Li⁺:Na⁺ in toluene/Et₂O (100:0.2), keeping the total amount of salt used to ≥4.0 equiv. relative to Ni to favor the formation of Ni1-Li and Ni1-Na species. The quantity of Li⁺ was held constant but the amount of Na⁺ added was varied. This mixture was treated with Ni(COD)₂ to activate the nickel catalyst, pressurized with ethylene to 450 psi, and then stirred at 30° C. for 0.5 h (Table 13). Analysis of the polymer products obtained by gel permeation chromatography (GPC) showed that reactions containing both Li⁺ and Na⁺ afforded polyethylene (PE) with bimodal distributions. The peaks at 15.8 and 18.2 mL retention volume were similar to those obtained from samples produced from Ni1-Li (Mₙ=3.1×10¹ kg/mol) and Ni1-Na (Mₙ=1.5 kg/mol), respectively (FIG. 8A). Without being bound by theory, these results suggest that both nickel species were active during polymerization and did not interconvert between each other. The relative amounts of each polymer fraction generated were quantified by integrating their peak areas (i.e., A_{15.8} and A_{18.2}). The A_{15.8}/A_{18.2} ratio reflects the distribution of Ni1-Li:Ni1-Na in the reaction and the polymerization activities of the corresponding complexes. Our results showed that equal quantities of both polymers were obtained (i.e., A_{15.8}/A_{18.2}=1.0) when the Ni1-Li:Ni1-Na ratio was 0.39, which was achieved by adding 2 equiv. of Li⁺ and 10 equiv. of Na⁺ to a solution of Ni1. Because the solubility of the salts and binding affinity of Ni1 for Li⁺ vs. Na⁺ are different, the exact amount of MBAr^{F}₄ needed to obtain a specific bimodal polymer distribution must be determined empirically. Based on data fitting, we obtained the relationship A_{15.8}/A_{18.2}=−4.11e^{(-3.28(Li+/Na+))}+3.38 (Eq. 1, FIG. 24). Using this equation, it is possible to calculate the amounts of Li⁺ and Na⁺ salts needed with Ni1 to prepare specific polymer blends.

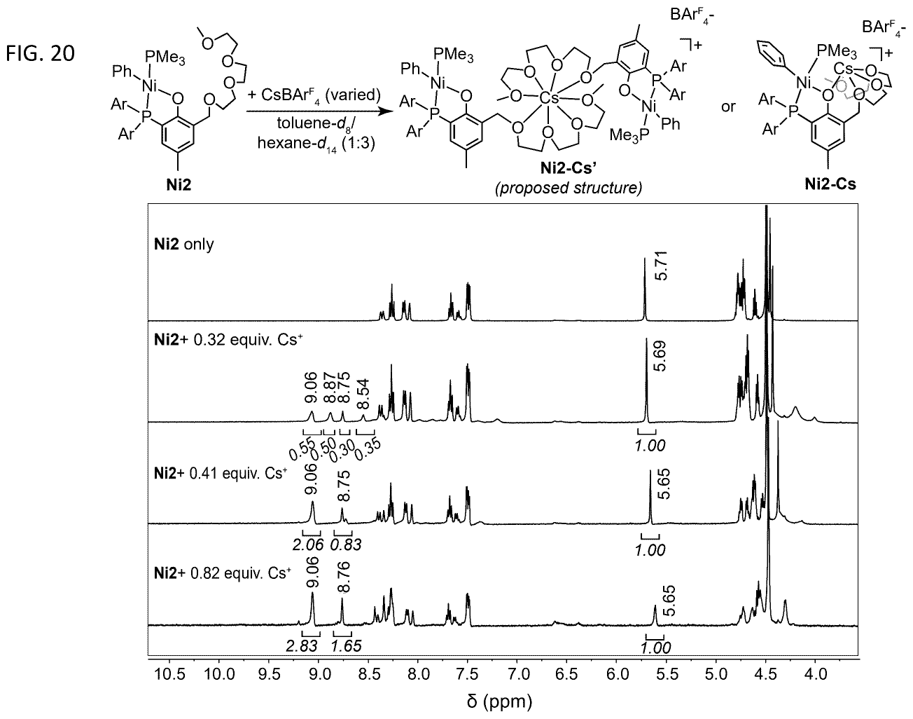

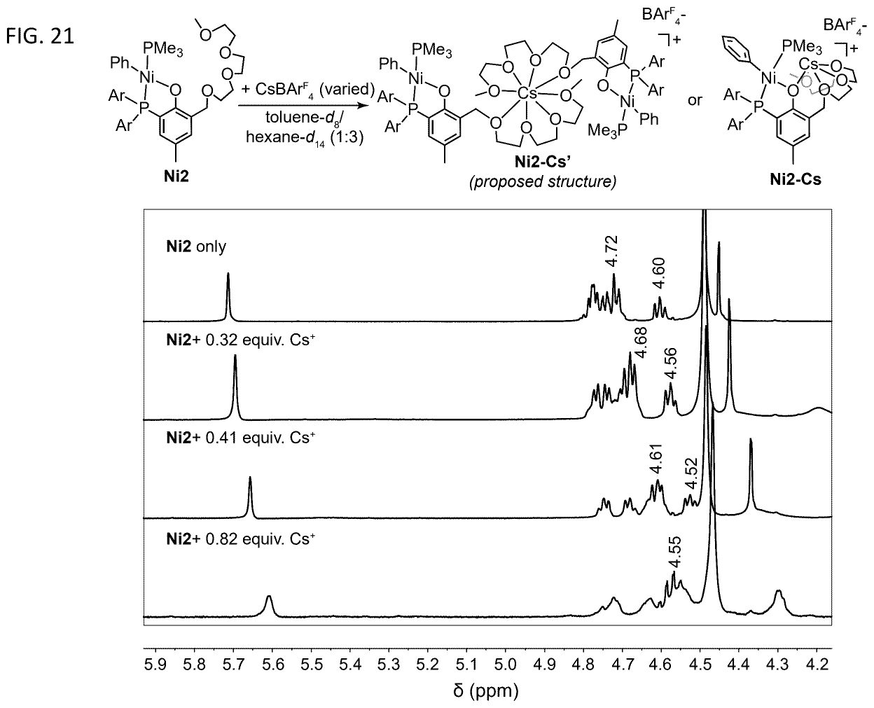

In a second set of experiments, we performed ethylene polymerization studies using Ni2 with varying amounts of CsBAr^{F}₄ in the non-polar mixture toluene/hexane (1:3). When 0.25 equiv. of Cs⁺ was used, a bimodal polymer was obtained showing GPC peaks at 13.4 and 15.5 mL (FIG. 8B, Table 14). The product at 13.4 mL matched that generated by Ni2 in the absence of alkali ions⁺ (Mₙ=2.03×10² kg/mol). Without being bound by theory, the peak at 15.5 mL (Mₙ=8.40×10¹ kg/mol) suggests that a new unidentified nickel-cesium species (Ni2′-Cs) was involved in polymerization since the 1:1 nickel:cesium Ni2-Cs gave monodispersed polymers with a GPC retention volume of 12.9 mL (Mₙ=9.16×10² kg/mol). We hypothesize that the composition of Ni2′-Cs, in one possibility is that it is a 2:1 nickel; cesium species based on results from our titration studies. As shown in FIG. 20 and FIG. 21, when up to ˜0.5 equiv. of CsBAr^{F}₄ was added to Ni2 in toluene-d₈/hexane-d₁₄ (1:3) at RT, the benzylic peak shifted from 5.71 to 5.65 ppm, suggesting that a new nickel species had formed.

When 0.5 equiv. of Cs⁺ was combined with Ni2 in polymerization, the GPC trace of the polyethylene (PE) isolated showed a major peak at 15.5 mL retention volume (FIG. 8B). Based on stoichiometry, addition of 0.5 equiv. of Cs⁺ to Ni2 is expected to yield 100% of a 2:1 nickel:cesium species. Our observation that this reaction provided nearly monodispersed polyethylene (PE) is consistent with there being only one major active species during polymerization.

Our polymerization results above demonstrate that under non-switching conditions, we can readily access multi-modal polymers with exquisite control over the relative distribution of the different fractions. This method is complementary to those such as melt blending, multi-site polymerization, or multi-zone cascades to generate all-polyolefin composites. Our approach is advantageous because it does not require high temperature (e.g., >150° C.) or special equipment to prepare different polyolefin blends.

### Dynamic Switching Polymerization

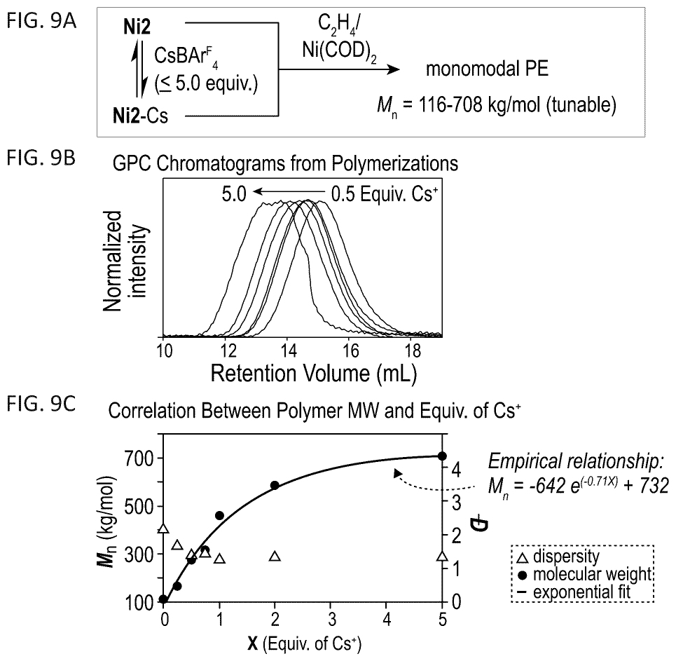

To demonstrate dynamic switching polymerization, we carried out reactions in toluene/Et₂O (98:2), which was the solvent mixture found in our metal binding investigations to favor cation exchange (FIG. 7B). In one study, we combined Ni2/Ni(COD)₂ with various equiv. of CsBAr^{F}₄ in toluene/Et₂O (98:2) and then pressurized the reactor with 450 psi of ethylene at 60° C. for 1 h (FIG. 9A-FIG. 9C Table 16). When we analyzed the polyethylene (PE) products, we observed that their molecular weights increased when larger amounts of Cs⁺ were present (Mₙ=1.16×10² to 7.08×10² kg/mol). Importantly, the dispersity (Ð) values of all polymers obtained from the Ni2+Cs⁺ reactions were <2.0, which suggests, without being bound by theory, that the active species responsible for polymerization are non-living single site catalysts. Similar results were obtained when the reactions were performed at 30° C. (Table 15). Without being bound by theory, these observations strongly support our proposed mechanism for dynamic switching (FIG. 6B), in which individual polyethylene (PE) chains grow from the same nickel centers as they continuously interconvert between Ni2 and Ni2-Cs states before chain termination. A plot of the equiv. of Cs⁺ added (x) vs. Mₙ of the polymer showed saturation behavior (FIG. 9B), indicating that the catalyst exists predominantly in the Ni2-Cs form when >1.0 equiv. of Cs⁺ was added. An excellent fit of the data was achieved using an exponential mathematical function (R=0.99), which revealed the relationship Mₙ=−642e^{(-0.71χ)}+732 (Eq. 2). Using this empirically derived formula, it is possible to calculate the appropriate amount of Cs⁺ needed to synthesize monodispersed polyethylene (PE) with molecular weights between 1.16×10² and 7.08×10² kg/mol. This high level of control is generally difficult to achieve in non-living polymerization.

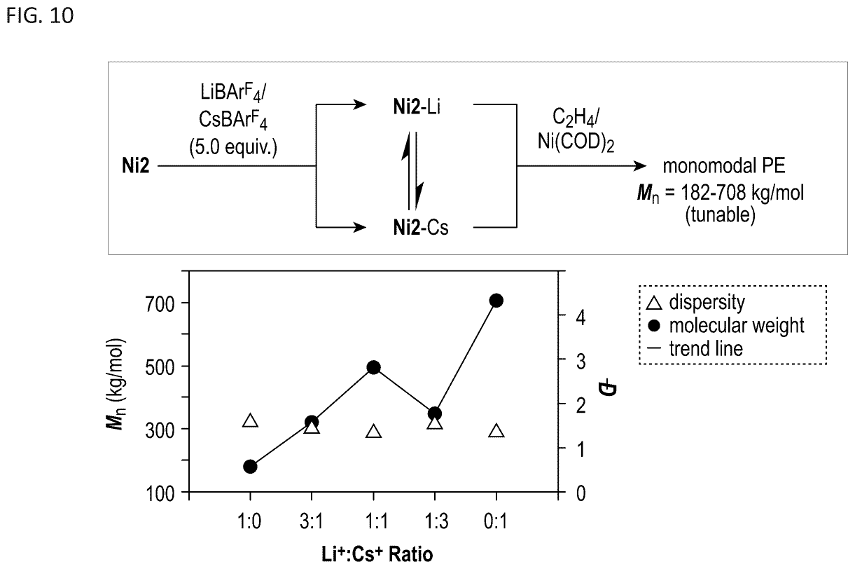

Next, we explored whether dynamic switching polymerization could be induced using two different M⁺ ions (FIG. 25D). In these reactions, we added both LiBAr^{F}₄ and CsBAr^{F}₄ (5.0 equiv. of salt total relative to nickel) to toluene/Et₂O (98:2) solutions containing Ni2/Ni(COD)₂ and then stirred the reactions under 450 psi of ethylene at 60° C. for 1 h (Table 17). The Li⁺ and Cs⁺ salts were selected for this experiment because Ni2-Li and Ni2-Cs produce the shortest and longest polymer chains in this nickel series, respectively. We performed reactions using Li⁺:Cs⁺ ratios of 1:0, 3:1, 1:1, 1:3, and 0:1 and obtained polymers with dispersity/<2.0 in all cases (FIG. 10), again showing that polymerization is occurring from discrete catalytically active species. The polymer Mₙ increased with less Li⁺ relative to Cs⁺, except in the 1:3 reaction in which the polyethylene (PE) molecular weight decreased. The lack of a clear trend in Mₙ as a function of the Li⁺:Cs⁺ ratio suggests that perhaps dynamic switching is occurring not only between Ni2-Li and Ni2-Cs active sites. Without being bound by theory, is it possible that other unidentified nickel-alkali complexes could form under certain Li⁺:Cs⁺ ratios. Regardless of the exact identities of the catalytically active species, these results are consistent with a dynamic switching mechanism because the polyethylene (PE) molecular weight changed with different Li⁺:Cs⁺ ratios while the polymer dispersities remained constant.

To the best of our knowledge, the examples above are the first demonstrations of using cations to dynamically regulate non-living polymerization processes. This tunability could be extremely versatile because it affords a high level of control that was not possible previously.

### Conclusions

Herein, we have significantly expanded our understanding of cation-tunable catalysts and their applications in polymer synthesis. We prepared a nickel phenoxyphosphine-PEG catalyst (Ni2) featuring 2,6-dimethoxyphenyl. The addition of alkali ions to Ni2 afforded the corresponding Ni2-M species that surprisingly resulted in different ethylene polymerization behavior depending on the identity of M. In general, Ni2-M showed lower activity but gave polyethylene (PE) with higher molecular weight than that of the corresponding Ni1-M species. Complex Ni2-Cs is notable for its ability to generate ultra-high molecular weight polyethylene (e.g., Mₙ>103 kg/mol) and operate at high catalytic efficiency under elevated temperatures. Our polymerization results revealed that electronic effects strongly influence the chain growth rates of our nickel catalysts, whereas both steric and electronic effects influence their chain termination rates. Without being bound by theory, with hypothesize that because Ni2-M has greater steric protection of its axial sites than Ni1-M, the Ni2-M is less susceptible to chain displacement by incoming monomer than the Ni1-M. This structural effect is further reinforced by electronic effects, in which the more electron-rich Ni2-M forms weaker C—H agostic interactions with its coordinated polymer chain and thus, has reduced propensity to undergo chain termination compared to that by its more electron-poor Ni1-M counterpart.

An unexpected result of our cation-tunable catalysts is that we can manipulate their secondary metal exchange equilibria to regulate non-living polymerization. It was discovered that in low polarity solvent mixtures, such as toluene/Et₂O (100:0.2) or toluene/hexane (1:3), M⁺ does not switch between nickel complexes. Therefore, by adjusting the ratio of Ni:M1:M2 (if using two different cations), the amounts of Ni, Ni-M1, and Ni-M2 species present in solution could be carefully controlled, which ultimately determines the fractional composition of the polymer distribution. Our method used to prepare polyolefin blends does not require high temperature or special apparatus. Surprisingly, we found that when ethylene polymerizations were carried out in slightly more polar solvent mixtures, specifically toluene/Et₂O (98:2), exchange of M⁺ between two nickel complexes is faster than the NMR timescale (˜10⁻³ s). Polymerizations under dynamic switching conditions gave monodispersed polyethylene (PE) (Ð<2.0) with varying molecular weights depending on the Ni:Ni-M1 or Ni-M1:Ni-M2 ratios. Without being bound by theory our results support a dynamic switching mechanism, in which a polymer chain extends from the same nickel center throughout the chain growth process while the catalyst cycles between two different states (e.g., Ni2 and Ni2-Cs in FIG. 9A-FIG. 9B) before chain termination. Because the various nickel species have different ν_{growth} and νₜₑᵣₘ rates, the molecular weights of the polymer products are determined by the different contributions of the relevant actives species during catalysis. Importantly, we have unexpectedly shown that cation-based dynamic switching is fast enough to impact the microstructure of polymers obtained from non-living polymerization reactions, which has not yet been demonstrated using other switching modalities (e.g., using photo, redox, or thermal triggers).

The work described herein as provided in various embodiments of the invention bridges the gap between living and non-living polymerization reactions by enabling the generation of many polymers per catalyst while allowing for chain growth control. As described herein, using the same catalyst, we can access a wide range of polymers with different molecular weights and molecular weight distributions, which may be useful for studying structure-function relationships or developing new polymer applications. For example, dynamic switching may be used to access block copolymers from a pool of different polar olefins and for investigating the cation exchange behavior of our nickel complexes with higher valent metal ions (e.g., M²⁺, M³⁺, etc.). Additionally, dynamic switching may be applied to other polymerization processes, such as CO₂ and epoxide copolymerization, or even small-molecule synthesis. Furthermore, dynamic switching may be used to promote different steps in cascade processes. The significance of the work described herein is that it provides a new strategy to increase the control and complexity of catalytic reactions.

### VARIOUS EMBODIMENTS OF THE INVENTION

### Catalysts of Formula (1), Formula (2), Formula (1-A), Formula (2-A), Formula (1-B), Formula (2-B).

In various embodiments, the present invention provides a catalyst having a structure selected from Formula (1) and Formula (2):

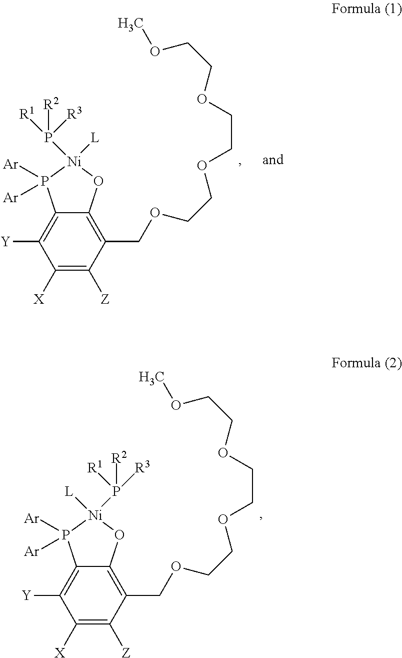

wherein in Formula (1) and Formula (2):
Ar is 2,6-dimethoxyphenyl;
L is an optionally substituted phenyl group;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl.

In various embodiments, the present invention provides a catalyst having a structure of Formula (1):

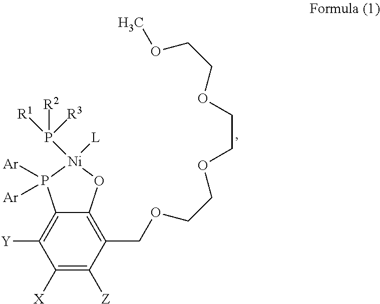

wherein,
Ar is 2,6-dimethoxyphenyl;
L is an optionally substituted phenyl group;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl.

In various embodiments, the present invention provides a catalyst having a structure of Formula (2):

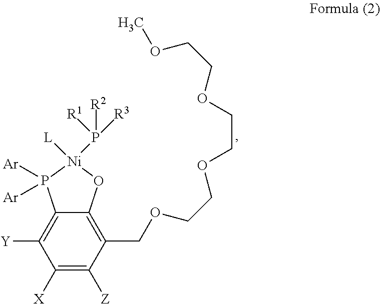

wherein,
Ar is 2,6-dimethoxyphenyl;
L is an optionally substituted phenyl group;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl.

In various embodiments, the present invention provides a catalyst having a structure selected from Formula (1-A) and Formula (2-A):

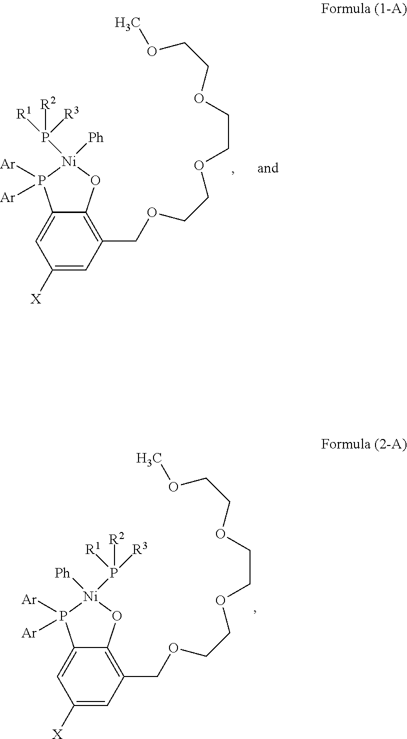

wherein in Formula (1-A) and Formula (2-A):
Ar is 2,6-dimethoxyphenyl;
Ph is a phenyl group;
X is hydrogen, an electron donating group, or an electron withdrawing group; and
R¹, R², and R³ are each independently selected from optionally substituted aryl, optionally substituted alkyl, and optionally substituted cycloalkyl.

In various embodiments, the present invention provides a catalyst having a structure of Formula (1-A):

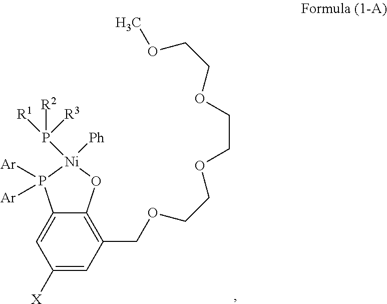

wherein,
Ar is 2,6-dimethoxyphenyl;
Ph is a phenyl group;
X is hydrogen, an electron donating group, or an electron withdrawing group; and
R¹, R², and R³ are each independently selected from optionally substituted aryl, optionally substituted alkyl, and optionally substituted cycloalkyl.

In various embodiments, the present invention provides a catalyst having a structure of Formula (2-A):

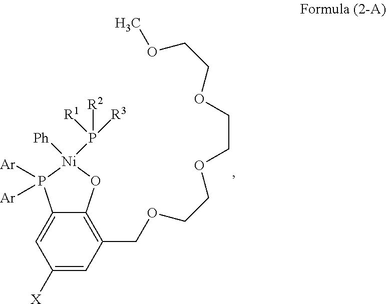

wherein,
Ar is 2,6-dimethoxyphenyl;
Ph is a phenyl group;
X is hydrogen, an electron donating group, or an electron withdrawing group; and
R¹, R², and R³ are each independently selected from optionally substituted aryl, optionally substituted alkyl, and optionally substituted cycloalkyl.

In various embodiments, the present invention provides a catalyst having a structure selected from Formula (1-B) and Formula (2-B):

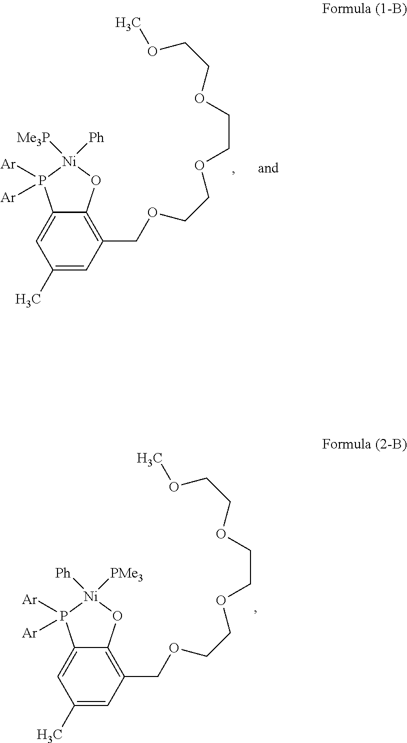

wherein in Formula (1-B) and Formula (2-B):
Ar is 2,6-dimethoxyphenyl;
Ph is a phenyl group; and
PMe₃ is trimethylphosphine.

In various embodiments, the present invention provides a catalyst having a structure of Formula (1-B):

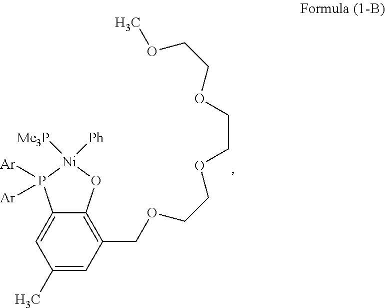

wherein,
Ar is 2,6-dimethoxyphenyl;
Ph is a phenyl group; and
PMe₃ is trimethylphosphine.

In various embodiments, the present invention provides a catalyst having a structure of Formula (2-B):

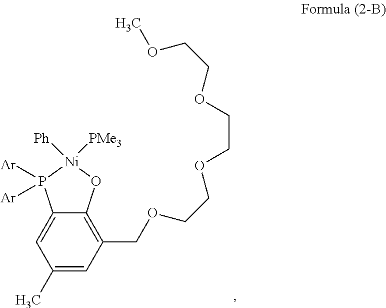

wherein,
Ar is 2,6-dimethoxyphenyl;
Ph is a phenyl group; and
PMe₃ is trimethylphosphine.

In some embodiments, the catalyst of Formula (1-A) is a catalyst of Formula (1). In some embodiments, the catalyst of Formula (1-B) is a catalyst of Formula (1). In some embodiments, the catalyst of Formula (2-A) is a catalyst of Formula (2). In some embodiments, the catalyst of Formula (2-B) is a catalyst of Formula (2).

In some embodiments, the electron donating group is selected from the group consisting of: alkoxy, amino, hydroxy, and alkyl, and cycloalkyl. In some embodiments, the electron donating group is selected from the group consisting of: alkoxy, phenoxy, amino, alkylamino, dialkylamino, hydroxy, alkyl, and cycloalkyl. In some embodiments, alkyl is selected from the group consisting of: —CH₃, —CH₂CH₃, —CH₂CH₂CH₃, and —CH(CH₃)₂. In some embodiments, the electron withdrawing group is selected from the group consisting of: NO₂, —CN, —C(O)-alkyl, and halo. In some embodiments, the electron withdrawing group is selected from the group consisting of: NO₂, —CN, —C(O)-alkyl, C(O)Oalkyl, C(O)Nalkyl, —SO₃H, —SO₂R, —PO₃H, —POR, —CF₃, and halo. In some embodiments, the electron withdrawing group is selected from the group consisting of: NO₂, —CN, —C(O)-alkyl, C(O)Oalkyl, C(O)Nalkyl, —SO₃H, —SO₂alkyl, —PO₃H, —PO₃alkyl, —CF₃, and halo.

In some embodiments, the phenyl group is

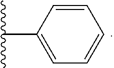 [SMILES: *c1ccccc1]

In some embodiments, L is an optionally substituted phenyl group. In some embodiments, the optionally substituted phenyl group is selected from the group consisting of phenyl, 2-methoxyphenyl, 4-methoxyphenyl, 2-acetylphenyl, or 2-(N-acetylamino)phenyl). In some embodiments, L is a phenyl group.

In some embodiments, R¹, R², and R³ are each independently selected from optionally substituted aryl, optionally substituted alkyl, and optionally substituted cycloalkyl. In some embodiments, optionally substituted aryl is selected from the group consisting of phenyl, pentafluorophenyl, 2-methoxyphenyl, 2-methylphenyl, and 4-trifluoromethylphenyl. In some embodiments, optionally substituted alkyl is selected from the group consisting of methyl, ethyl, propyl, isopropyl, or tert-butyl. In some embodiments, optionally substituted cycloalkyl is cyclohexyl or adamantyl.

### Methods for Catalyzing Homopolymerization of an Optionally Substituted Olefin

In various embodiments, the present invention provides a method for catalyzing homopolymerization of an optionally substituted olefin, comprising: combining or contacting an optionally substituted olefin with the catalyst of Formula (1), Formula (2), Formula (1-A), Formula (2-A), Formula (1-B), or Formula (2-B), or combinations thereof, whereby the optionally substituted olefin undergoes homopolymerization.

In various embodiments, the present invention provides a method for catalyzing homopolymerization of an optionally substituted olefin, comprising: combining or contacting an optionally substituted olefin with the catalyst of Formula (1), or Formula (2), or combinations thereof, whereby the optionally substituted olefin undergoes homopolymerization.

In various embodiments, the present invention provides a method for catalyzing homopolymerization of an optionally substituted olefin, comprising: combining or contacting an optionally substituted olefin with the catalyst of Formula (1-A), or Formula (2-A), or combinations thereof, whereby the optionally substituted olefin undergoes homopolymerization.

In various embodiments, the present invention provides a method for catalyzing homopolymerization of an optionally substituted olefin, comprising: combining or contacting an optionally substituted olefin with the catalyst of Formula (1-B), or Formula (2-B), or combinations thereof, whereby the optionally substituted olefin undergoes homopolymerization.

In some embodiments, the step of combining or contacting the optionally substituted olefin with the catalyst is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof. In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the method for catalyzing homopolymerization of an optionally substituted olefin further comprises combining or contacting at least one activator with the catalyst and the optionally substituted olefin. In some embodiments, the at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the optionally substituted olefin is an optionally substituted terminal olefin or an optionally substituted internal olefin. In some embodiments, the optionally substituted olefin is selected from the group consisting of ethylene, an optionally substituted terminal olefin, and an optionally substituted internal olefin. In some embodiments, the optionally substituted terminal olefin is selected from the group consisting of propene, butene, 1-hexene, 1-heptene, 1-octene, styrene, acrylamide, acrylic acid, acrylic ester, vinyl halide, vinyl alcohol, allyl alcohol, and allylbenzene. In some embodiments, the optionally substituted internal olefin is selected from the group consisting of 2-hexene, 3-hexene, 2-heptene, 3-heptene, 2-octene, 3-octene, and 4-octene. In some embodiments, the optionally substituted olefin is ethylene. In some embodiments, the optionally substituted olefin is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene.

In various embodiments, the present invention provides a polymer formed by the method for catalyzing homopolymerization of an optionally substituted olefin as provided herein. In various embodiments, the present invention provides a homopolymer formed by the method for catalyzing homopolymerization of an optionally substituted olefin as provided herein. In some embodiments, the polymer is monomodal or bimodal. In some embodiments, the polymer is monomodal. In some embodiments, the polymer is bimodal. In some embodiments, the polymer is monomodal, or bimodal, or combination thereof. In some embodiments, the polymer is a homopolymer. In some embodiments, the homopolymer is monomodal or bimodal. In some embodiments, the homopolymer is monomodal. In some embodiments, the homopolymer is bimodal. In some embodiments, the homopolymer is monomodal, or bimodal, or combination thereof.

### Methods for Polymerizing an Optionally Substituted Olefin

In various embodiments, the present invention provides a method for polymerizing an optionally substituted olefin, the method comprising contacting an optionally substituted olefin with the catalyst of Formula (1), Formula (2), Formula (1-A), Formula (2-A), Formula (1-B), or Formula (2-B), or combinations thereof, and at least one activator under conditions effective to polymerize the optionally substituted olefin.

In various embodiments, the present invention provides a method for polymerizing an optionally substituted olefin, the method comprising contacting an optionally substituted olefin with the catalyst of Formula (1), or Formula (2), or combinations thereof, and at least one activator under conditions effective to polymerize the optionally substituted olefin.

In various embodiments, the present invention provides a method for polymerizing an optionally substituted olefin, the method comprising contacting an optionally substituted olefin with the catalyst of Formula (1-A), or Formula (2-A), or combinations thereof, and at least one activator under conditions effective to polymerize the optionally substituted olefin.

In various embodiments, the present invention provides a method for polymerizing an optionally substituted olefin, the method comprising contacting an optionally substituted olefin with the catalyst of Formula (1-B), or Formula (2-B), or combinations thereof, and at least one activator under conditions effective to polymerize the optionally substituted olefin.

In some embodiments, the at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the step of contacting the optionally substituted olefin with the catalyst and the at least one activator is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof. In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from tetrahydrofuran, diethyl ether, dichloromethane, chloroform, N,N-dimethylforamide, dimethylsulfoxide, ethyl acetate, acetone, and water, and any combinations thereof.

In some embodiments, the optionally substituted olefin is an optionally substituted terminal olefin or an optionally substituted internal olefin. In some embodiments, the optionally substituted olefin is selected from the group consisting of ethylene, an optionally substituted terminal olefin, and an optionally substituted internal olefin. In some embodiments, the optionally substituted terminal olefin is selected from the group consisting of propene, butene, 1-hexene, 1-heptene, 1-octene, styrene, acrylamide, acrylic acid, acrylic ester, vinyl halide, vinyl alcohol, allyl alcohol, and allylbenzene. In some embodiments, the optionally substituted internal olefin is selected from the group consisting of 2-hexene, 3-hexene, 2-heptene, 3-heptene, 2-octene, 3-octene, and 4-octene. In some embodiments, the optionally substituted olefin is ethylene. In some embodiments, the optionally substituted olefin is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene.

In various embodiments, the present invention provides a polymer formed by the method for polymerizing an optionally substituted olefin as provided herein. In some embodiments, the polymer is monomodal or bimodal. In some embodiments, the polymer is monomodal. In some embodiments, the polymer is bimodal. In some embodiments, the polymer is monomodal, or bimodal, or combination thereof.

### Methods for Catalyzing Copolymerization of a First Olefin and at Least One Other Olefin

In various embodiments, the present invention provides method for catalyzing copolymerization of a first olefin and at least one other olefin, comprising: combining or contacting a first olefin and at least one other olefin with the catalyst of Formula (1), Formula (2), Formula (1-A), Formula (2-A), Formula (1-B), or Formula (2-B), or combinations thereof, whereby the first olefin and the at least one other olefin undergoes copolymerization, and wherein the first olefin and the at least one other olefin are different from one another.

In various embodiments, the present invention provides method for catalyzing copolymerization of a first olefin and at least one other olefin, comprising: combining or contacting a first olefin and at least one other olefin with the catalyst of Formula (1), or Formula (2), or combinations thereof, whereby the first olefin and the at least one other olefin undergoes copolymerization, and wherein the first olefin and the at least one other olefin are different from one another.

In various embodiments, the present invention provides method for catalyzing copolymerization of a first olefin and at least one other olefin, comprising: combining or contacting a first olefin and at least one other olefin with the catalyst of Formula (1-A), or Formula (2-A), or combinations thereof, whereby the first olefin and the at least one other olefin undergoes copolymerization, and wherein the first olefin and the at least one other olefin are different from one another.

In various embodiments, the present invention provides method for catalyzing copolymerization of a first olefin and at least one other olefin, comprising: combining or contacting a first olefin and at least one other olefin with the catalyst of Formula (1-B), or Formula (2-B), or combinations thereof, whereby the first olefin and the at least one other olefin undergoes copolymerization, and wherein the first olefin and the at least one other olefin are different from one another.

In some embodiments, the first olefin and the at least one other olefin are different from one another. In some embodiments, the at least one other olefin is at least one second olefin. In some embodiments, the first olefin and the at least one second olefin are different from one another. In some embodiments, the step of combining or contacting the first olefin and the at least one other olefine with the catalyst is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof.

In some embodiments, the first olefin is selected from the group consisting of ethylene, propene, and styrene. In some embodiments the at least one other olefin is selected from the group consisting of 1-hexene, 1-octene, allyl benzene, acrylamide, acrylic acid, acrylic ester, vinyl halide, vinyl alcohol, and allyl alcohol. In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the method for catalyzing copolymerization of a first olefin and at least one other olefin further comprises combining or contacting at least one activator with the catalyst, the first olefin, and the at least one other olefin. In some embodiments, the at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the first olefin and the at least one other olefin are each independently an optionally substituted olefin. In some embodiments, the optionally substituted olefin is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene. In some embodiments, the first olefin and the at least one other olefin are each independently an optionally substituted terminal olefin or an optionally substituted internal olefin. In some embodiments, the first olefin and the at least one other olefin are each independently ethylene, an optionally substituted terminal olefin, or an optionally substituted internal olefin. In some embodiments, the optionally substituted terminal olefin is selected from the group consisting of propene, butene, 1-hexene, 1-heptene, 1-octene, styrene, acrylamide, acrylic acid, acrylic ester, vinyl halide, vinyl alcohol, allyl alcohol, and allylbenzene. In some embodiments, the optionally substituted internal olefin is selected from the group consisting of 2-hexene, 3-hexene, 2-heptene, 3-heptene, 2-octene, 3-octene, and 4-octene. In some embodiments, the first olefin is ethylene.

In various embodiments, the present invention provides a copolymer formed by the method for catalyzing copolymerization of a first olefin and at least one other olefin.

In various embodiments, the present invention provides a polymer formed by the method for catalyzing copolymerization of a first olefin and at least one other olefin. In some embodiments, the polymer is a copolymer. In some embodiments, the copolymer is selected from the group consisting of a random copolymer, block copolymer, and gradient copolymer. In some embodiments, the copolymer is a random copolymer. In some embodiments, the copolymer is a block copolymer. In some embodiments, the copolymer is a gradient copolymer. In some embodiments, the polymer is monomodal or bimodal. In some embodiments, the polymer is monomodal. In some embodiments, the polymer is bimodal. In some embodiments, the polymer is monomodal, or bimodal, or combination thereof. In some embodiments, the copolymer is monomodal or bimodal. In some embodiments, the copolymer is monomodal. In some embodiments, the copolymer is bimodal. In some embodiments, the copolymer is monomodal, or bimodal, or combination thereof.

### Methods for Copolymerizing a First Olefin and at Least One Other Olefin

In various embodiments, the present invention provides a method for copolymerizing a first olefin and at least one other olefin, the method comprising contacting the first olefin and the at least one other olefin with the catalyst of Formula (1), Formula (2), Formula (1-A), Formula (2-A), Formula (1-B), or Formula (2-B), or combinations thereof; and at least one activator under conditions effective to copolymerize the first olefin and the at least one other olefin, wherein the first olefin and the at least one other olefin are different from one another.

In various embodiments, the present invention provides a method for copolymerizing a first olefin and at least one other olefin, the method comprising contacting the first olefin and the at least one other olefin with the catalyst of Formula (1), or Formula (2), or combinations thereof; and at least one activator under conditions effective to copolymerize the first olefin and the at least one other olefin, wherein the first olefin and the at least one other olefin are different from one another.

In various embodiments, the present invention provides a method for copolymerizing a first olefin and at least one other olefin, the method comprising contacting the first olefin and the at least one other olefin with the catalyst of Formula (1-A), or Formula (2-A), or combinations thereof, and at least one activator under conditions effective to copolymerize the first olefin and the at least one other olefin, wherein the first olefin and the at least one other olefin are different from one another.

In various embodiments, the present invention provides a method for copolymerizing a first olefin and at least one other olefin, the method comprising contacting the first olefin and the at least one other olefin with the catalyst of Formula (1-B), or Formula (2-B), or combinations thereof, and at least one activator under conditions effective to copolymerize the first olefin and the at least one other olefin, wherein the first olefin and the at least one other olefin are different from one another.

In some embodiments, the first olefin and the at least one other olefin are different from one another. In some embodiments, the at least one other olefin is at least one second olefin. In some embodiments, the first olefin and the at least one second olefin are different from one another.

In some embodiments, the at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the step of contacting the first olefin and the at least one other olefin with the catalyst and the at least one activator is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof. In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the first olefin and the at least one other olefin are each independently an optionally substituted olefin. In some embodiments, the optionally substituted olefin is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene. In some embodiments, the first olefin and the at least one other olefin are each independently an optionally substituted terminal olefin or an optionally substituted internal olefin. In some embodiments, the first olefin and the at least one other olefin are each independently ethylene, an optionally substituted terminal olefin, or an optionally substituted internal olefin. In some embodiments, the optionally substituted terminal olefin is selected from the group consisting of propene, butene, 1-hexene, 1-heptene, 1-octene, styrene, acrylamide, acrylic acid, acrylic ester, vinyl halide, vinyl alcohol, allyl alcohol, and allylbenzene. In some embodiments, the optionally substituted internal olefin is selected from the group consisting of 2-hexene, 3-hexene, 2-heptene, 3-heptene, 2-octene, 3-octene, and 4-octene. In some embodiments, the first olefin is ethylene.

In various embodiments, the present invention provides a copolymer formed by the method for copolymerizing a first olefin and at least one other olefin as provided herein. In various embodiments, the present invention provides a polymer formed by the method for copolymerizing a first olefin and at least one other olefin as provided herein. In some embodiments, the polymer is a copolymer. In some embodiments, the copolymer is selected from the group consisting of a random copolymer, block copolymer, and gradient copolymer. In some embodiments, the copolymer is a random copolymer. In some embodiments, the copolymer is a block copolymer. In some embodiments, the copolymer is a gradient copolymer. In some embodiments, the polymer is monomodal or bimodal. In some embodiments, the polymer is monomodal. In some embodiments, the polymer is bimodal. In some embodiments, the polymer is monomodal, or bimodal, or combination thereof. In some embodiments, the copolymer is monomodal or bimodal. In some embodiments, the copolymer is monomodal. In some embodiments, the copolymer is bimodal. In some embodiments, the copolymer is monomodal, or bimodal, or combination thereof.

### Methods for Making a Compound

In various embodiments, the present invention provides a method for making a compound, the method comprising contacting a reactant with a catalyst of Formula (1), Formula (2), Formula (1-A), Formula (2-A), Formula (1-B), or Formula (2-B), or combinations thereof, under conditions effective to make the compound. In some embodiments the reactant is methylaluminoxane, trialkylaluminium, alkyllithium, alkyl magnesium halide, or dialklylzinc.

In some embodiments, the step of contacting the reactant with the catalyst is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof. In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the method for making a compound further comprises contacting at least one activator with the catalyst and the reactant. In some embodiments, at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the compound is a small molecule. In some embodiments, the method for making a compound is a cascade method.

### Method for Making a Compound

In various embodiments, the present invention provides a method for making a compound, the method comprising contacting a first reactant and at least one other reactant with a catalyst of Formula (1), Formula (2), Formula (1-A), Formula (2-A), Formula (1-B), or Formula (2-B), or combinations thereof, under conditions effective to make the compound.

In some embodiments, the step of contacting the first reactant and the at least one other reactant with the catalyst is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof.

In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, a method for making a compound further comprises contacting at least one activator with the catalyst, the first reactant, and the at least one other reactant. In some embodiments, the at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the compound is a small molecule. In some embodiments, the method is a cascade method. In some embodiments, the first reactant and the at least one other reactant are different from one another.

### Method of Making a Polymer

In various embodiments, the present invention provides a method of making a polymer, comprising contacting a monomer with a catalyst of Formula (1), Formula (2), Formula (1-A), Formula (2-A), Formula (1-B), or Formula (2-B), or combinations thereof.

In some embodiments, the monomer is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene.

In some embodiments, the step of contacting the monomer with the catalyst is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof. In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, method of making a polymer further comprises contacting at least one activator with the catalyst and the monomer. In some embodiments, the at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the monomer is an optionally substituted olefin. In some embodiments, the optionally substituted olefin is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene. In some embodiments, the monomer is an optionally substituted terminal olefin or an optionally substituted internal olefin. In some embodiments, the monomer is selected from the group consisting of ethylene, an optionally substituted terminal olefin, and an optionally substituted internal olefin. In some embodiments, the monomer is ethylene.

In various embodiments, the present invention provides a polymer made by the method of making a polymer as provided herein. In some embodiments, the polymer is bimodal or monomodal. In some embodiments, the polymer is bimodal. In some embodiments, the polymer is monomodal. In some embodiments, the polymer is monomodal, or bimodal, or combination thereof.

### Method of Making a Copolymer

In various embodiments, the present invention provides a method of making a copolymer, comprising contacting a first monomer and at least one other monomer with a catalyst of Formula (1), Formula (2), Formula (1-A), Formula (2-A), Formula (1-B), or Formula (2-B), or combinations thereof, wherein the first monomer and the at least one other monomer are different from one another.

In some embodiments, the first monomer and the at least one other monomer are different from one another. In some embodiments, the at least one other monomer is at least one second monomer. In some embodiments, the first monomer and the at least one second monomer are different from one another. In some embodiments, the step of contacting the first monomer and the at least one other monomer with the catalyst is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof. In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the method of making a copolymer further comprises contacting at least one activator with the catalyst, the first monomer, and the at least one other monomer. In some embodiments, the first monomer is ethylene, propene, 1-butene, 1-hexene, 1-octene, styrene, or allyl benzene. In some embodiments, the at least one other monomer is acrylamide, acrylic acid, acrylic ester, vinyl halide, vinyl alcohol, or allyl alcohol).

In some embodiments, the at least one activator is Ni(COD), or triarylborane. In some embodiments, the at least one activator is selected from the group consisting of Ni(COD)₂, triarylborane, methylaluminoxane, and trialkylaluminum.

In some embodiments, the first monomer and the at least one other monomer are each independently an optionally substituted olefin. In some embodiments, the optionally substituted olefin is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene.

In some embodiments, the first monomer and the at least one other monomer are each independently an optionally substituted terminal olefin or an optionally substituted internal olefin. In some embodiments, the first monomer and the at least one other monomer are each independently ethylene, an optionally substituted terminal olefin, or an optionally substituted internal olefin. In some embodiments, the optionally substituted terminal olefin is selected from the group consisting of propene, butene, 1-hexene, 1-heptene, 1-octene, styrene, acrylamide, acrylic acid, acrylic ester, vinyl halide, vinyl alcohol, allyl alcohol, and allylbenzene. In some embodiments, the optionally substituted internal olefin is selected from the group consisting of 2-hexene, 3-hexene, 2-heptene, 3-heptene, 2-octene, 3-octene, and 4-octene. In some embodiments, the first monomer is ethylene.

In various embodiments, the present invention provides a copolymer made by a method of making a copolymer as provided herein. In various embodiments, the present invention provides a polymer made by a method of making a copolymer as provided herein. In some embodiments, the polymer is a copolymer. In some embodiments, the copolymer is selected from the group consisting of a random copolymer, block copolymer, and gradient copolymer. In some embodiments, the copolymer is a random copolymer. In some embodiments, the copolymer is a block copolymer. In some embodiments, the copolymer is a gradient copolymer. In some embodiments, the polymer is monomodal or bimodal. In some embodiments, the polymer is monomodal. In some embodiments, the polymer is bimodal. In some embodiments, the polymer is monomodal, or bimodal, or combination thereof. In some embodiments, the copolymer is monomodal or bimodal. In some embodiments, the copolymer is monomodal. In some embodiments, the copolymer is bimodal. In some embodiments, the copolymer is monomodal, or bimodal, or combination thereof. In some embodiments, the first monomer is CO₂; and the at least one other monomer is an epoxide.

### Heterobimetallic Catalysts of Formula (3), Formula (4), Formula (3-A), Formula (4-A), Formula (3-B), or Formula (4-B).

In various embodiments, the present invention provides a heterobimetallic catalyst having a structure selected from Formula (3) and Formula (4):

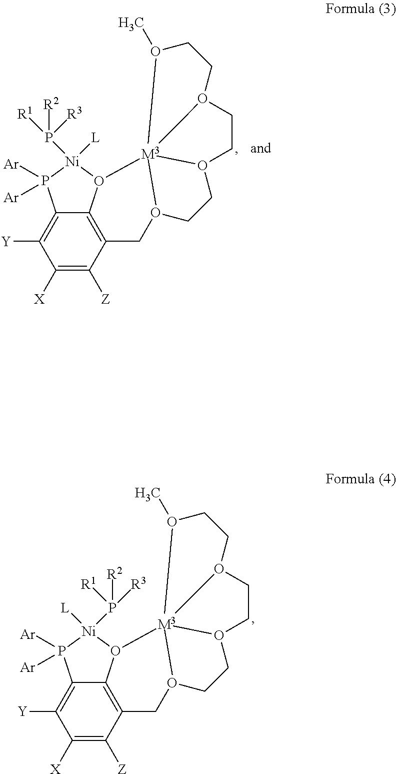

wherein in Formula (3) and Formula (4):
Ar is 2,6-dimethoxyphenyl;
L is an optionally substituted phenyl group;
M is Li, Na, K, or Cs;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl.

In various embodiments, the present invention provides a heterobimetallic catalyst having a structure of Formula (3):

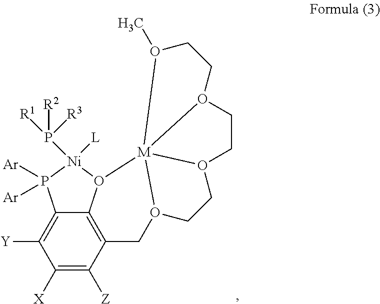

wherein,
Ar is 2,6-dimethoxyphenyl;
L is an optionally substituted phenyl group;
M is Li, Na, K, or Cs;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl.

In various embodiments, the present invention provides a heterobimetallic catalyst having a structure of Formula (4):

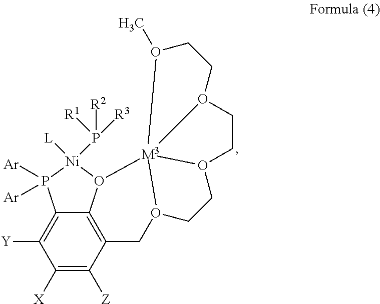

wherein,
Ar is 2,6-dimethoxyphenyl;
L is an optionally substituted phenyl group;
M is Li, Na, K, or Cs;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl.

In various embodiments, the present invention provides a heterobimetallic catalyst having a structure selected from Formula (3-A) and Formula (4-A):

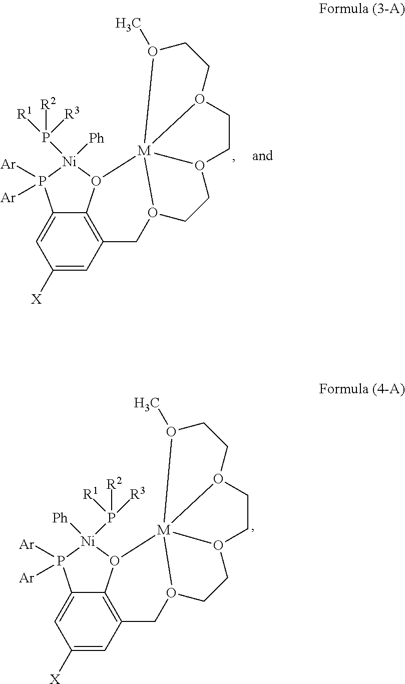

wherein in Formula (3-A) and Formula (4-A):
Ar is 2,6-dimethoxyphenyl;
Ph is a phenyl group;
M is Li, Na, K, or Cs;
X is hydrogen, an electron donating group, or an electron withdrawing group; and
R¹, R², and R³ are each independently selected from optionally substituted aryl, optionally substituted alkyl, and optionally substituted cycloalkyl.

In various embodiments, the present invention provides a heterobimetallic catalyst having a structure of Formula (3-A):

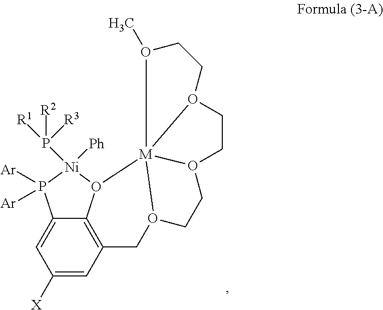

wherein,
Ar is 2,6-dimethoxyphenyl;
Ph is a phenyl group;
M is Li, Na, K, or Cs; X is hydrogen, an electron donating group, or an electron withdrawing group; and
R¹, R², and R³ are each independently selected from optionally substituted aryl, optionally substituted alkyl, and optionally substituted cycloalkyl.

In various embodiments, the present invention provides a heterobimetallic catalyst having a structure of Formula (4-A):

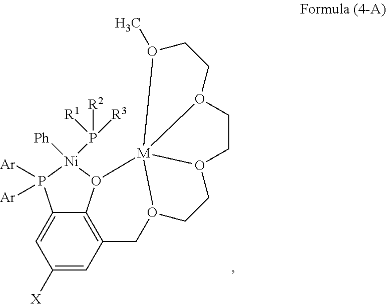

wherein,
Ar is 2,6-dimethoxyphenyl;
L is an optionally substituted phenyl group;
M is Li, Na, K, or Cs;
X is hydrogen, an electron donating group, or an electron withdrawing group; and
R¹, R², and R³ are each independently selected from optionally substituted aryl, optionally substituted alkyl, and optionally substituted cycloalkyl.

In various embodiments, the present invention provides a heterobimetallic catalyst having a structure selected from Formula (3-B) and Formula (4-B):

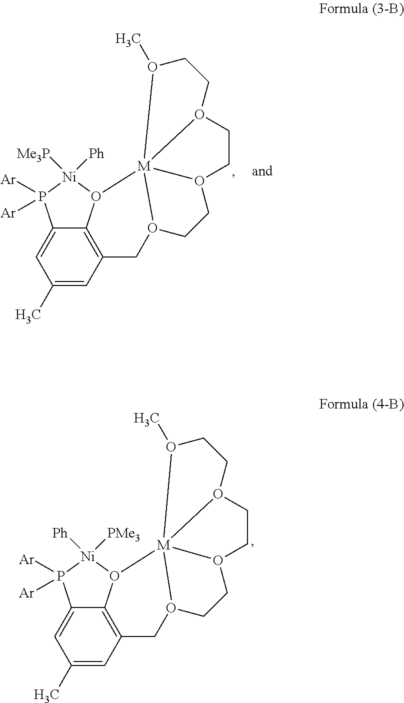

wherein in Formula (3-B) and Formula (4-B):
Ar is 2,6-dimethoxyphenyl;
Ph is a phenyl group;
M is Li, Na, K, or Cs; and
PMe₃ is trimethylphosphine.

In various embodiments, the present invention provides a heterobimetallic catalyst having a structure of Formula (3-B):

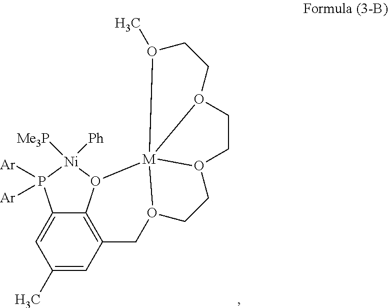

wherein,
Ar is 2,6-dimethoxyphenyl;
Ph is a phenyl group;
M is Li, Na, K, or Cs; and
PMe₃ is trimethylphosphine.

In various embodiments, the present invention provides a heterobimetallic catalyst having a structure of Formula (4-B):

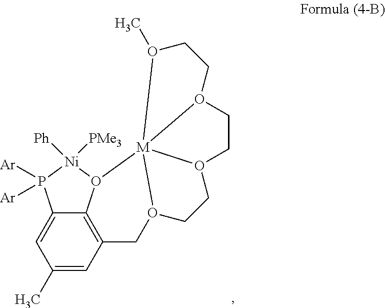

wherein,
Ar is 2,6-dimethoxyphenyl;
Ph is a phenyl group;
M is Li, Na, K, or Cs; and
PMe₃ is trimethylphosphine.

In some embodiments, the heterobimetallic catalyst of Formula (3-A) is a heterobimetallic catalyst of Formula (3). In some embodiments, the heterobimetallic catalyst of Formula (3-B) is a heterobimetallic catalyst of Formula (3). In some embodiments, the heterobimetallic catalyst of Formula (4-A) is a heterobimetallic catalyst of Formula (4). In some embodiments, the heterobimetallic catalyst of Formula (4-B) is a heterobimetallic catalyst of Formula (4).

In some embodiments M is Li, Na, K, or Cs. In some embodiments, M is Li. In some embodiments, M is Na. In some embodiments, M is K. In some embodiments, M is Cs.

In some embodiments, the electron donating group is selected from the group consisting of: alkoxy, amino, hydroxy, and alkyl. In some embodiments, the electron donating group is selected from the group consisting of: alkoxy, phenoxy, amino, alkylamino, dialkylamino, hydroxy, alkyl, and cycloalkyl. In some embodiments, alkyl is selected from the group consisting of: —CH₃, —CH₂CH₃, —CH₂CH₂CH₃, and —CH(CH₃)₂. In some embodiments, the electron withdrawing group is selected from the group consisting of: NO₂, —CN, —C(O)-alkyl, and halo. In some embodiments, the electron withdrawing group is selected from the group consisting of: NO₂, —CN, —C(O)-alkyl, C(O)Oalkyl, C(O)Nalkyl, —SO₃H, —SO₂R, —PO₃H, —PO₃R, —CF₃, and halo. In some embodiments, the electron withdrawing group is selected from the group consisting of: NO₂, —CN, —C(O)-alkyl, C(O)Oalkyl, C(O)Nalkyl, —SO₃H, —SO₂alkyl, —PO₃H, —PO₃alkyl, —CF₃, and halo.

In some embodiments, the phenyl group is

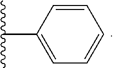 [SMILES: *c1ccccc1]

In some embodiments, L is an optionally substituted phenyl group. In some embodiments, the optionally substituted phenyl group is selected from the group consisting of phenyl, 2-methoxyphenyl, 4-methoxyphenyl, 2-acetylphenyl, or 2-(N-acetylamino)phenyl). In some embodiments, L is a phenyl group.

In some embodiments, R¹, R², and R³ are each independently selected from optionally substituted aryl, optionally substituted alkyl, and optionally substituted cycloalkyl. In some embodiments, optionally substituted aryl is selected from the group consisting of phenyl, pentafluorophenyl, 2-methoxyphenyl, 2-methylphenyl, and 4-trifluoromethylphenyl. In some embodiments, optionally substituted alkyl is selected from the group consisting of methyl, ethyl, propyl, isopropyl, or tert-butyl. In some embodiments, optionally substituted cycloalkyl is cyclohexyl or adamantyl.

### Methods for Catalyzing Homopolymerization of an Optionally Substituted Olefin

In various embodiments, the present invention provides a method for catalyzing homopolymerization of an optionally substituted olefin, comprising: combining or contacting an optionally substituted olefin with a heterobimetallic catalyst of Formula (3), Formula (4), Formula (3-A), Formula (4-A), Formula (3-B), or Formula (4-B), or combinations thereof, whereby the optionally substituted olefin undergoes homopolymerization.

In various embodiments, the present invention provides a method for catalyzing homopolymerization of an optionally substituted olefin, comprising: combining or contacting an optionally substituted olefin with a heterobimetallic catalyst of Formula (3), or Formula (4), or combinations thereof, whereby the optionally substituted olefin undergoes homopolymerization.

In various embodiments, the present invention provides a method for catalyzing homopolymerization of an optionally substituted olefin, comprising: combining or contacting an optionally substituted olefin with a heterobimetallic catalyst of Formula (3-A), or Formula (4-A), or combinations thereof, whereby the optionally substituted olefin undergoes homopolymerization.

In various embodiments, the present invention provides a method for catalyzing homopolymerization of an optionally substituted olefin, comprising: combining or contacting an optionally substituted olefin with a heterobimetallic catalyst of Formula (3-B), or Formula (4-B), or combinations thereof, whereby the optionally substituted olefin undergoes homopolymerization.

In some embodiments, the step of combining or contacting the optionally substituted olefin with the heterobimetallic catalyst is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof. In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the method for catalyzing homopolymerization of an optionally substituted olefin further comprises combining or contacting at least one activator with the heterobimetallic catalyst and the optionally substituted olefin. In some embodiments, the at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the optionally substituted olefin is an optionally substituted terminal olefin or an optionally substituted internal olefin. In some embodiments, the optionally substituted olefin is selected from the group consisting of ethylene, an optionally substituted terminal olefin, and an optionally substituted internal olefin. In some embodiments, the optionally substituted terminal olefin is selected from the group consisting of propene, butene, 1-hexene, 1-heptene, 1-octene, styrene, acrylamide, acrylic acid, acrylic ester, vinyl halide, vinyl alcohol, allyl alcohol, and allylbenzene. In some embodiments, the optionally substituted internal olefin is selected from the group consisting of 2-hexene, 3-hexene, 2-heptene, 3-heptene, 2-octene, 3-octene, and 4-octene. In some embodiments, the optionally substituted olefin is ethylene. In some embodiments, the optionally substituted olefin is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene.

In various embodiments, the present invention provides a polymer formed by the method for catalyzing homopolymerization of an optionally substituted olefin as provided herein. In various embodiments, the present invention provides a homopolymer formed by the method for catalyzing homopolymerization of an optionally substituted olefin as provided herein. In some embodiments, the polymer is monomodal or bimodal. In some embodiments, the polymer is monomodal. In some embodiments, the polymer is bimodal. In some embodiments, the polymer is monomodal, or bimodal, or combination thereof. In some embodiments, the polymer is a homopolymer. In some embodiments, the homopolymer is monomodal or bimodal. In some embodiments, the homopolymer is monomodal. In some embodiments, the homopolymer is bimodal. In some embodiments, the homopolymer is monomodal, or bimodal, or combination

### Methods for Polymerizing an Optionally Substituted Olefin

In various embodiments, the present invention provides method for polymerizing an optionally substituted olefin, the method comprising contacting an optionally substituted olefin with a heterobimetallic catalyst of Formula (3), Formula (4), Formula (3-A), Formula (4-A), Formula (3-B), or Formula (4-B), or combinations thereof, and at least one activator under conditions effective to polymerize the optionally substituted olefin.

In various embodiments, the present invention provides method for polymerizing an optionally substituted olefin, the method comprising contacting an optionally substituted olefin with a heterobimetallic catalyst of Formula (3), or Formula (4), or combinations thereof; and at least one activator under conditions effective to polymerize the optionally substituted olefin.

In various embodiments, the present invention provides method for polymerizing an optionally substituted olefin, the method comprising contacting an optionally substituted olefin with a heterobimetallic catalyst of Formula (3-A), or Formula (4-A), or combinations thereof; and at least one activator under conditions effective to polymerize the optionally substituted olefin.

In various embodiments, the present invention provides method for polymerizing an optionally substituted olefin, the method comprising contacting an optionally substituted olefin with a heterobimetallic catalyst of Formula (3-B), or Formula (4-B), or combinations thereof, and at least one activator under conditions effective to polymerize the optionally substituted olefin.

In some embodiments, the at least one activator is Ni(COD)₂ is triarylborane. In some embodiments, the at least one activator is selected from the group consisting of Ni(COD)₂, triarylborane, methylaluminoxane, and trialkylaluminum.

In some embodiments, the step of contacting the optionally substituted olefin with the heterobimetallic catalyst and the at least one activator is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof. In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from tetrahydrofuran, diethyl ether, dichloromethane, chloroform, N,N-dimethylforamide, dimethylsulfoxide, ethyl acetate, acetone, and water, and any combinations thereof.

In some embodiments, the optionally substituted olefin is an optionally substituted terminal olefin or an optionally substituted internal olefin. In some embodiments, the optionally substituted olefin is selected from the group consisting of ethylene, an optionally substituted terminal olefin, and an optionally substituted internal olefin. In some embodiments, the optionally substituted terminal olefin is selected from the group consisting of propene, butene, 1-hexene, 1-heptene, 1-octene, styrene, acrylamide, acrylic acid, acrylic ester, vinyl halide, vinyl alcohol, allyl alcohol, and allylbenzene. In some embodiments, the optionally substituted internal olefin is selected from the group consisting of 2-hexene, 3-hexene, 2-heptene, 3-heptene, 2-octene, 3-octene, and 4-octene. In some embodiments, the optionally substituted olefin is ethylene. In some embodiments, the optionally substituted olefin is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene.

In various embodiments, the present invention provides a polymer formed by the method for polymerizing an optionally substituted olefin as provided herein. In some embodiments, the polymer is monomodal or bimodal. In some embodiments, the polymer is monomodal. In some embodiments, the polymer is bimodal. In some embodiments, the polymer is monomodal, or bimodal, or combination thereof.

### Methods for Catalyzing Copolymerization of a First Olefin and at Least One Other Olefin

In various embodiments, the present invention provides a method for catalyzing copolymerization of a first olefin and at least one other olefin, comprising: combining or contacting a first olefin and at least one other olefin with a heterobimetallic catalyst of Formula (3), Formula (4), Formula (3-A), Formula (4-A), Formula (3-B), or Formula (4-B), or combinations thereof, whereby the first olefin and the at least one other olefin undergoes copolymerization, and wherein the first olefin and the at least one other olefin are different from one another.

In various embodiments, the present invention provides a method for catalyzing copolymerization of a first olefin and at least one other olefin, comprising: combining or contacting a first olefin and at least one other olefin with a heterobimetallic catalyst of Formula (3), or Formula (4), or combinations thereof, whereby the first olefin and the at least one other olefin undergoes copolymerization, and wherein the first olefin and the at least one other olefin are different from one another.

In various embodiments, the present invention provides a method for catalyzing copolymerization of a first olefin and at least one other olefin, comprising: combining or contacting a first olefin and at least one other olefin with a heterobimetallic catalyst of Formula (3-A), or Formula (4-A), or combinations thereof, whereby the first olefin and the at least one other olefin undergoes copolymerization, and wherein the first olefin and the at least one other olefin are different from one another.

In various embodiments, the present invention provides a method for catalyzing copolymerization of a first olefin and at least one other olefin, comprising: combining or contacting a first olefin and at least one other olefin with a heterobimetallic catalyst of Formula (3-B), or Formula (4-B), or combinations thereof, whereby the first olefin and the at least one other olefin undergoes copolymerization, and wherein the first olefin and the at least one other olefin are different from one another.

In some embodiments, the first olefin and the at least one other olefin are different from one another. In some embodiments, the at least one other olefin is at least one second olefin. In some embodiments, the first olefin and the at least one second olefin are different from one another.

In some embodiments, the step of combining or contacting the first olefin and the at least one other olefin with the heterobimetallic catalyst is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof. In some embodiments, the first olefin is selected from the group consisting of ethylene, propene, and styrene. In some embodiments the at least one other olefin is selected from the group consisting of 1-hexene, 1-octene, allyl benzene, acrylamide, acrylic acid, acrylic ester, vinyl halide, vinyl alcohol, and allyl alcohol. In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the method for catalyzing copolymerization of a first olefin and at least one other olefin further comprises combining or contacting at least one activator with the heterobimetallic catalyst, the first olefin, and the at least one other olefin. In some embodiments, the at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the first olefin and the at least one other olefin are each independently an optionally substituted olefin. In some embodiments, the optionally substituted olefin is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene. In some embodiments, the first olefin and the at least one other olefin are each independently an optionally substituted terminal olefin or an optionally substituted internal olefin. In some embodiments, the first olefin and the at least one other olefin are each independently ethylene, an optionally substituted terminal olefin, or an optionally substituted internal olefin. In some embodiments, the optionally substituted terminal olefin is selected from the group consisting of propene, butene, 1-hexene, 1-heptene, 1-octene, styrene, acrylamide, acrylic acid, acrylic ester, vinyl halide, vinyl alcohol, allyl alcohol, and allylbenzene. In some embodiments, the optionally substituted internal olefin is selected from the group consisting of 2-hexene, 3-hexene, 2-heptene, 3-heptene, 2-octene, 3-octene, and 4-octene. In some embodiments, the first olefin is ethylene.

In various embodiments, the present invention provides a polymer formed by the method for catalyzing copolymerization of a first olefin and at least one other olefin as provided herein. In some embodiments, the polymer is a copolymer. In some embodiments, the copolymer is selected from the group consisting of a random copolymer, block copolymer, and gradient copolymer. In some embodiments, the copolymer is a random copolymer. In some embodiments, the copolymer is a block copolymer. In some embodiments, the copolymer is a gradient copolymer. In some embodiments, the polymer is monomodal or bimodal. In some embodiments, the polymer is monomodal. In some embodiments, the polymer is bimodal. In some embodiments, the polymer is monomodal, bimodal, or combination thereof. In some embodiments, the copolymer is monomodal or bimodal. In some embodiments, the copolymer is monomodal. In some embodiments, the copolymer is bimodal. In some embodiments, the copolymer is monomodal, or bimodal, or combination thereof.

### Methods for Copolymerizing a First Olefin and at Least One Other Olefin

In various embodiments, the present invention provides a method for copolymerizing a first olefin and at least one other olefin, the method comprising contacting the first olefin and the at least one other olefin with the heterobimetallic catalyst of Formula (3), Formula (4), Formula (3-A), Formula (4-A), Formula (3-B), or Formula (4-B), or combinations thereof; and at least one activator under conditions effective to copolymerize the first olefin and the at least one other olefin, wherein the first olefin and the at least one other olefin are different from one another.

In various embodiments, the present invention provides a method for copolymerizing a first olefin and at least one other olefin, the method comprising contacting the first olefin and the at least one other olefin with the heterobimetallic catalyst of Formula (3), or Formula (4), or combinations thereof; and at least one activator under conditions effective to copolymerize the first olefin and the at least one other olefin, wherein the first olefin and the at least one other olefin are different from one another.

In various embodiments, the present invention provides a method for copolymerizing a first olefin and at least one other olefin, the method comprising contacting the first olefin and the at least one other olefin with the heterobimetallic catalyst of Formula (3-A), or Formula (4-A), or combinations thereof; and at least one activator under conditions effective to copolymerize the first olefin and the at least one other olefin, wherein the first olefin and the at least one other olefin are different from one another.

In various embodiments, the present invention provides a method for copolymerizing a first olefin and at least one other olefin, the method comprising contacting the first olefin and the at least one other olefin with the heterobimetallic catalyst of Formula (3-B), or Formula (4-B), or combinations thereof, and at least one activator under conditions effective to copolymerize the first olefin and the at least one other olefin, wherein the first olefin and the at least one other olefin are different from one another.

In some embodiments, the first olefin and the at least one other olefin are different from one another. In some embodiments, the at least one other olefin is at least one second olefin. In some embodiments, the first olefin and the at least one second olefin are different from one another.

In some embodiments, the at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the step of contacting the first olefin and the at least one other olefin with the heterobimetallic catalyst and the at least one activator is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof. In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the first olefin and the at least one other olefin are each independently an optionally substituted olefin. In some embodiments, the optionally substituted olefin is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene. In some embodiments, the first olefin and the at least one other olefin are each independently an optionally substituted terminal olefin or an optionally substituted internal olefin. In some embodiments, the first olefin and the at least one other olefin are each independently ethylene, an optionally substituted terminal olefin, or an optionally substituted internal olefin. In some embodiments, the first olefin is ethylene.

In various embodiments, the present invention provides a polymer formed by the method for copolymerizing a first olefin and at least one other olefin as provided herein. In various embodiments, the present invention provides a polymer formed by the method for copolymerizing a first olefin and at least one other olefin as provided herein. In some embodiments, the polymer is a copolymer. In some embodiments, the copolymer is selected from the group consisting of a random copolymer, block copolymer, and gradient copolymer. In some embodiments, the copolymer is a random copolymer. In some embodiments, the copolymer is a block copolymer. In some embodiments, the copolymer is a gradient copolymer. In some embodiments, the polymer is monomodal or bimodal. In some embodiments, the polymer is monomodal. In some embodiments, the polymer is bimodal. In some embodiments, the polymer is monomodal, bimodal, or combination thereof. In some embodiments, the copolymer is monomodal or bimodal. In some embodiments, the copolymer is monomodal. In some embodiments, the copolymer is bimodal. In some embodiments, the copolymer is monomodal, or bimodal, or combination thereof.

### Method of Making a Compound

In various embodiments, the present invention provides a method for making a compound, the method comprising contacting a reactant with a catalyst of Formula (3), Formula (4), Formula (3-A), Formula (4-A), Formula (3-B), or Formula (4-B), or combinations thereof, under conditions effective to make the compound.

In some embodiments the reactant is methylaluminoxane, trialkylaluminium, alkyllithium, alkyl magnesium halide, or dialklylzinc.

In some embodiments, the step of contacting the reactant with the catalyst is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof. In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the method for making a compound further comprises contacting at least one activator with the catalyst and the reactant. In some embodiments, at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the compound is a small molecule. In some embodiments, the method for making a compound is a cascade method.

### Method for Making a Compound

In various embodiments, the present invention provides a method for making a compound, the method comprising contacting a first reactant and at least one other reactant with a heterobimetallic catalyst of Formula (3), Formula (4), Formula (3-A), Formula (4-A), Formula (3-B), or Formula (4-B), or combinations thereof under conditions effective to make the compound.

In some embodiments, the step of contacting the first reactant and the at least one other reactant with the heterobimetallic catalyst is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof. In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, method for making a compound further comprises contacting at least one activator with the catalyst, the first reactant, and the at least one other reactant. In some embodiments, the at least one activator is Ni(COD), or triarylborane. In some embodiments, the at least one activator is selected from the group consisting of Ni(COD)₂, triarylborane, methylaluminoxane, and trialkylaluminum.

In some embodiments, the compound is a small molecule. In some embodiments, the method for making a compound is a cascade method. In some embodiments, the first reactant and the at least one other reactant are different from one another.

### Methods of Making a Polymer

In various embodiments, the present invention provides method of making a polymer, comprising contacting a monomer with the heterobimetallic catalyst of Formula (3), Formula (4), Formula (3-A), Formula (4-A), Formula (3-B), or Formula (4-B), or combinations thereof.

In various embodiments, the present invention provides method of making a polymer, comprising contacting a monomer with the heterobimetallic catalyst of Formula (3), or Formula (4), or combinations thereof.

In various embodiments, the present invention provides method of making a polymer, comprising contacting a monomer with the heterobimetallic catalyst of Formula (3-A), or Formula (4-A), or combinations thereof.

In various embodiments, the present invention provides method of making a polymer, comprising contacting a monomer with the heterobimetallic catalyst of Formula (3-B), or Formula (4-B), or combinations thereof.

In some embodiments, the monomer is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene.

In some embodiments, the step of contacting the monomer with the heterobimetallic catalyst is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof. In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the method of making a polymer further comprises contacting at least one activator with the heterobimetallic catalyst and the monomer. In some embodiments, the at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the monomer is an optionally substituted olefin. In some embodiments, the optionally substituted olefin is selected from the group consisting of ethylene, propene, butene, 1-hexene, 1-heptene, 1-octene, styrene, acrylamide, acrylic acid, acrylic ester, 2-octene, 3-octene, and 4-octene. In some embodiments, the monomer is an optionally substituted terminal olefin or an optionally substituted internal olefin. In some embodiments, the monomer is selected from the group consisting of ethylene, an optionally substituted terminal olefin, and an optionally substituted internal olefin. In some embodiments, the monomer is ethylene.

In some embodiments, the polymer is bimodal or monomodal. In some embodiments, the polymer is bimodal. In some embodiments, the polymer is monomodal. In some embodiments, the polymer is monomodal, or bimodal, or combination thereof. In various embodiments, the present invention provides a polymer made by the method of making a polymer as provided herein. In some embodiments, the polymer is monomodal or bimodal. In some embodiments, the polymer is monomodal. In some embodiments, the polymer is bimodal. In some embodiments, the polymer is monomodal, bimodal, or combination thereof.

### Methods of Making a Copolymer

In various embodiments, the present invention provides a method of making a copolymer, comprising contacting a first monomer and at least one other monomer with a heterobimetallic catalyst of Formula (3), Formula (4), Formula (3-A), Formula (4-A), Formula (3-B), or Formula (4-B), or combinations thereof, wherein the first monomer and the at least one other monomer are different from one another.

In various embodiments, the present invention provides a method of making a copolymer, comprising contacting a first monomer and at least one other monomer with a heterobimetallic catalyst of Formula (3), or Formula (4), or combinations thereof, wherein the first monomer and the at least one other monomer are different from one another.

In various embodiments, the present invention provides a method of making a copolymer, comprising contacting a first monomer and at least one other monomer with a heterobimetallic catalyst of Formula (3-A), or Formula (4-A), or combinations thereof, wherein the first monomer and the at least one other monomer are different from one another.

In various embodiments, the present invention provides a method of making a copolymer, comprising contacting a first monomer and at least one other monomer with a heterobimetallic catalyst of Formula (3-B), or Formula (4-B), or combinations thereof, wherein the first monomer and the at least one other monomer are different from one another.

In some embodiments, the first monomer and the at least one other monomer are different from one another. In some embodiments, the at least one other monomer is at least one second monomer. In some embodiments, the first monomer and the at least one second monomer are different from one another.

In some embodiments, the step of contacting the first monomer and the at least one other monomer with the heterobimetallic catalyst is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof. In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the method of making a copolymer further comprises contacting at least one activator with the heterobimetallic catalyst, the first monomer, and the at least one other monomer. In some embodiments, the first monomer is ethylene, propene, 1-butene, 1-hexene, 1-octene, styrene, or allyl benzene. In some embodiments, the at least one other monomer is acrylamide, acrylic acid, acrylic ester, vinyl halide, vinyl alcohol, or allyl alcohol).

In some embodiments, the at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the first monomer and the at least one other monomer are each independently an optionally substituted olefin. In some embodiments, the optionally substituted olefin is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene.

In some embodiments, the first monomer and the at least one other monomer are each independently an optionally substituted terminal olefin or an optionally substituted internal olefin. In some embodiments, the first monomer and the at least one other monomer are each independently ethylene, an optionally substituted terminal olefin, or an optionally substituted internal olefin. In some embodiments, the optionally substituted terminal olefin is selected from the group consisting of propene, butene, 1-hexene, 1-heptene, 1-octene, styrene, acrylamide, acrylic acid, acrylic ester, vinyl halide, vinyl alcohol, allyl alcohol, and allylbenzene. In some embodiments, the optionally substituted internal olefin is selected from the group consisting of 2-hexene, 3-hexene, 2-heptene, 3-heptene, 2-octene, 3-octene, and 4-octene. In some embodiments, the first monomer is ethylene.

In various embodiments, the present invention provides a polymer formed by the method for catalyzing copolymerization of a first monomer and at least one other monomer. In some embodiments, the polymer is a copolymer. In some embodiments, the copolymer is selected from the group consisting of a random copolymer, block copolymer, and gradient copolymer. In some embodiments, the copolymer is a random copolymer. In some embodiments, the copolymer is a block copolymer. In some embodiments, the copolymer is a gradient copolymer.

In various embodiments, the present invention provides a copolymer made by a method of making a copolymer as provided herein. In various embodiments, the present invention provides a polymer made by a method of making a copolymer as provided herein. In some embodiments, the polymer is a copolymer. In some embodiments, the copolymer is selected from the group consisting of a random copolymer, block copolymer, and gradient copolymer. In some embodiments, the polymer is monomodal or bimodal. In some embodiments, the polymer is monomodal. In some embodiments, the polymer is bimodal. In some embodiments, the polymer is monomodal, or bimodal, or combination thereof. In some embodiments, the copolymer is monomodal or bimodal. In some embodiments, the copolymer is monomodal. In some embodiments, the copolymer is bimodal. In some embodiments, the copolymer is monomodal, bimodal, or combination thereof. In some embodiments, the first monomer is CO₂; and the at least one other monomer is an epoxide.

### Bimetallic Catalyst Complexes of Formula (5), Formula (6), Formula (5-A), Formula (6-A), Formula (5-B), or Formula (6-B).

In various embodiments, the present invention provides a bimetallic catalyst complex having a structure selected from Formula (5) and Formula (6):

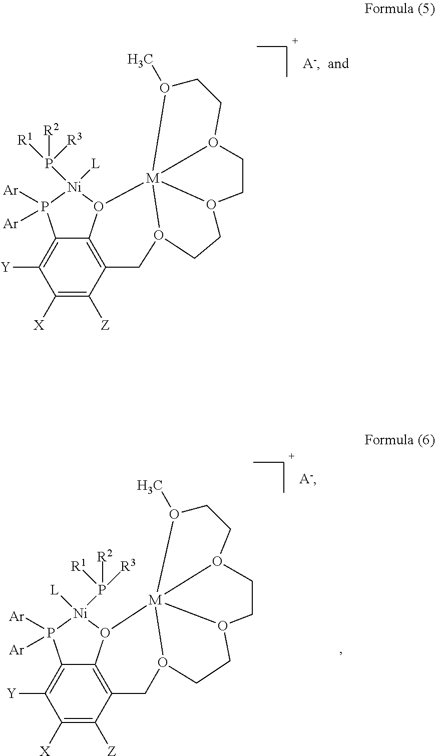

wherein in Formula (5) and Formula (6):
Ar is 2,6-dimethoxyphenyl;
L is an optionally substituted phenyl group;
M is Li, Na, K, or Cs;
A⁻ is a weakly coordinating anion;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl.

In various embodiments, the present invention provides a bimetallic catalyst complex having a structure of Formula (5):

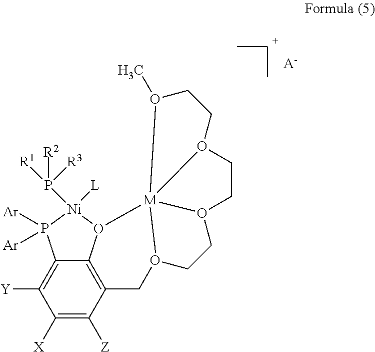

wherein,
Ar is 2,6-dimethoxyphenyl;
L is an optionally substituted phenyl group;
M is Li, Na, K, or Cs;
A⁻ is a weakly coordinating anion;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl.

In various embodiments, the present invention provides a bimetallic catalyst complex having a structure of Formula (6):

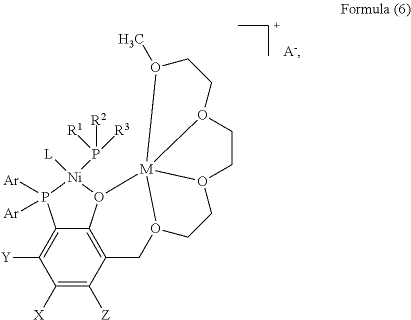

wherein,
Ar is 2,6-dimethoxyphenyl;
L is an optionally substituted phenyl group;
M is Li, Na, K, or Cs;
A⁻ is a weakly coordinating anion;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl.

In various embodiments, the present invention provides a bimetallic catalyst complex having a structure selected from Formula (5-A) and Formula (6-A):

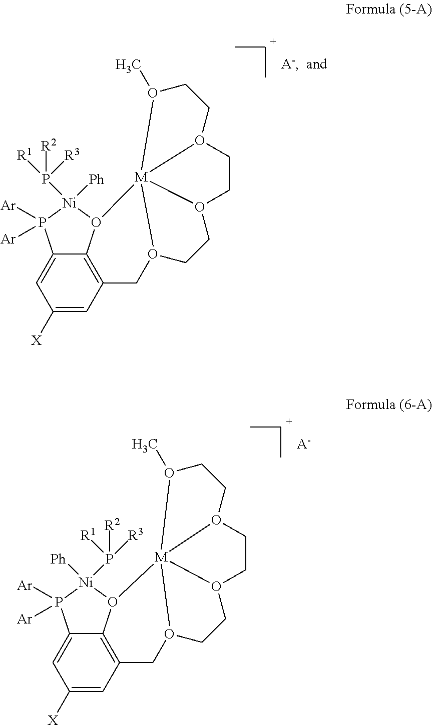

wherein Formula (5-A) and Formula (6-A):
Ar is 2,6-dimethoxyphenyl;
Ph is a phenyl group;
M is Li, Na, K, or Cs;
A⁻ is a weakly coordinating anion;
X is hydrogen, an electron donating group, or an electron withdrawing group; and
R¹, R², and R³ are each independently selected from optionally substituted aryl, optionally substituted alkyl, and optionally substituted cycloalkyl.

In various embodiments, the present invention provides a bimetallic catalyst complex having a structure of Formula (5-A):

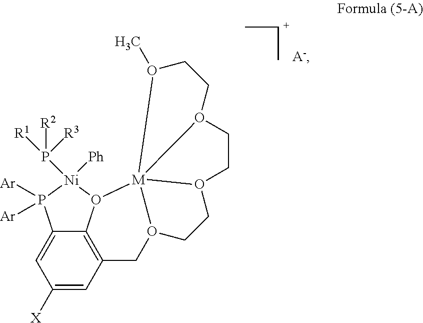

wherein,
Ar is 2,6-dimethoxyphenyl;
Ph is a phenyl group;
M is Li, Na, K, or Cs;
A⁻ is a weakly coordinating anion;
X is hydrogen, an electron donating group, or an electron withdrawing group; and
R¹, R², and R³ are each independently selected from optionally substituted aryl, optionally substituted alkyl, and optionally substituted cycloalkyl.

In various embodiments, the present invention provides a bimetallic catalyst complex having a structure of Formula (6-A):

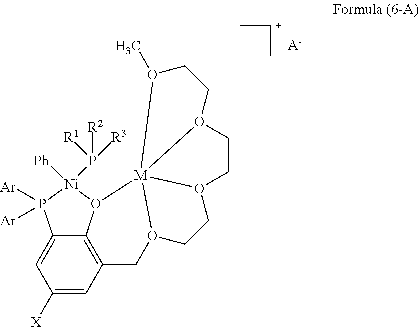

wherein,
   Ar is 2,6-dimethoxyphenyl;
   Ph is a phenyl group;
   M is Li, Na, K, or Cs;
   A⁻ is a weakly coordinating anion;
   X is hydrogen, an electron donating group, or an electron withdrawing group; and
   R¹, R², and R³ are each independently selected from optionally substituted aryl, optionally substituted alkyl, and optionally substituted cycloalkyl.

In various embodiments, the present invention provides a bimetallic catalyst complex having a structure selected from Formula (5-B) and Formula (6-B):

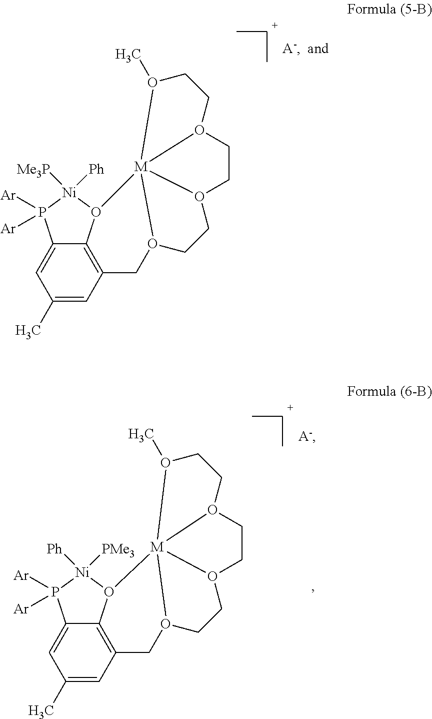

wherein Formula (5-B) and Formula (6-B):
   Ar is 2,6-dimethoxyphenyl;
   Ph is a phenyl group,
   M is Li, Na, K, or Cs;
   A⁻ is [(3,5-(CF₃)₂C₆H₃)₄B]⁻; and
   PMe₃ is trimethylphosphine.

In various embodiments, the present invention provides a bimetallic catalyst complex having a structure of Formula (5-B) is:

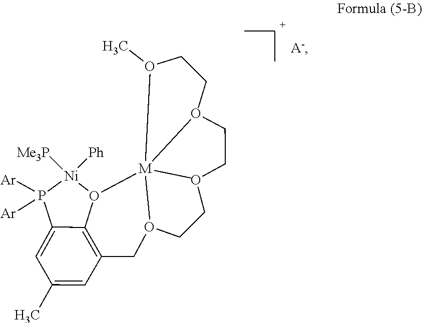

wherein,
   Ar is 2,6-dimethoxyphenyl;
   Ph is a phenyl group,
   M is Li, Na, K, or Cs;
   A⁻ is [(3,5-(CF₃)₂C₆H₃)₄B]⁻; and
   PMe₃ is trimethylphosphine.

In various embodiments, the present invention provides a bimetallic catalyst complex having a structure of Formula (6-B):

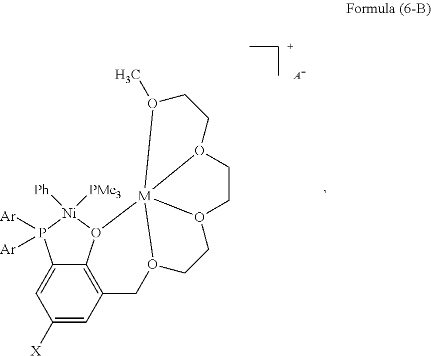

wherein,
   Ar is 2,6-dimethoxyphenyl;
   Ph is a phenyl group;
   M is Li, Na, K, or Cs;
   A⁻ is [(3,5-(CF₃)₂C₆H₃)₄B]⁻; and
   PMe₃ is trimethylphosphine.

In some embodiments, the bimetallic catalyst complex of Formula (5-A) is a bimetallic catalyst complex of Formula (5). In some embodiments, the bimetallic catalyst complex of Formula (5-B) is a bimetallic catalyst complex of Formula (5). In some embodiments, the bimetallic catalyst complex of Formula (6-A) is a bimetallic catalyst complex of Formula (6). In some embodiments, the bimetallic catalyst complex of Formula (6-B) is a bimetallic catalyst complex of Formula (6).

In some embodiments, Ar is 2,6-dimethoxyphenyl; L is a phenyl group; M is Li, Na, K, or Cs; A⁻ is [(3,5-(CF₃)₂C₆H₃)₄B]⁻; X is methyl; Y is hydrogen; Z is hydrogen; and R¹, R², and R³ are each methyl.

In some embodiments, A⁻ is a weakly coordinating anion. In some embodiments, the weakly coordinating anion is selected from the group consisting of tetrakis(3,5-bis(trifluoromethyl)phenylborate, tetrakis(pentafluorophenyl)borate, tetraphenylborate, trifluoromethylsulfonate, hexafluorophosphate, hexafluoroantimonate, and tetrafluoroborate. In some embodiments, tetrakis(3,5-bis(trifluoromethyl)phenylborate is represented as [(3,5-(CF₃)₂C₆H₃)₄B]⁻. In some embodiments, tetrakis(3,5-bis(trifluoromethyl)phenylborate is represented as BAr^{F}₄.

In some embodiments M is Li, Na, K, or Cs. In some embodiments, M is Li. In some embodiments, M is Na. In some embodiments, M is K. In some embodiments, M is Cs.

In some embodiments, the electron donating group is selected from the group consisting of: alkoxy, amino, hydroxy, and alkyl. In some embodiments, the electron donating group is selected from the group consisting of: alkoxy, phenoxy, amino, alkylamino, dialkylamino, hydroxy, alkyl, and cycloalkyl. In some embodiments, alkyl is selected from the group consisting of: —CH₃, —CH₂CH₃, —CH₂CH₂CH₃, and —CH(CH₃)₂. In some embodiments, the electron withdrawing group is selected from the group consisting of: NO₂, —CN, —C(O)-alkyl, and halo. In some embodiments, the electron withdrawing group is selected from the group consisting of: NO₂, —CN, —C(O)-alkyl, C(O)Oalkyl, C(O)Nalkyl, —SO₃H, —SO₂R, —PO₃H, —PO₃R, —CF₃, and halo. In some embodiments, the electron withdrawing group is selected from the group consisting of: NO₂, —CN, —C(O)-alkyl, C(O)Oalkyl, C(O)Nalkyl, —SO₃H, —SO₂alkyl, —PO₃H, —PO₃alkyl, —CF₃, and halo.

In some embodiments, the phenyl group is

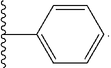 [SMILES: *c1ccccc1]

In some embodiments, L is an optionally substituted phenyl group. In some embodiments, the optionally substituted phenyl group is selected from the group consisting of phenyl, 2-methoxyphenyl, 4-methoxyphenyl, 2-acetylphenyl, or 2-(N-acetylamino)phenyl). In some embodiments, L is a phenyl group.

In some embodiments, R¹, R², and R³ are each independently selected from optionally substituted aryl, optionally substituted alkyl, and optionally substituted cycloalkyl. In some embodiments, optionally substituted aryl is selected from the group consisting of phenyl, pentafluorophenyl, 2-methoxyphenyl, 2-methylphenyl, and 4-trifluoromethylphenyl. In some embodiments, optionally substituted alkyl is selected from the group consisting of methyl, ethyl, propyl, isopropyl, or tert-butyl. In some embodiments, optionally substituted cycloalkyl is cyclohexyl or adamantyl.

### Method for Catalyzing Homopolymerization of an Optionally Substituted Olefin

In various embodiments, the present invention provides a method for catalyzing homopolymerization of an optionally substituted olefin, comprising: combining or contacting an optionally substituted olefin with the bimetallic catalyst complex of Formula (5), Formula (6), Formula (5-A), Formula (6-A), Formula (5-B), or Formula (6-B), or combinations thereof, whereby the optionally substituted olefin undergoes homopolymerization.

In various embodiments, the present invention provides a method for catalyzing homopolymerization of an optionally substituted olefin, comprising: combining or contacting an optionally substituted olefin with the bimetallic catalyst complex of Formula (5), or Formula (6), or combinations thereof, whereby the optionally substituted olefin undergoes homopolymerization.

In various embodiments, the present invention provides a method for catalyzing homopolymerization of an optionally substituted olefin, comprising: combining or contacting an optionally substituted olefin with the bimetallic catalyst complex of Formula (5-A), or Formula (6-A), or combinations thereof, whereby the optionally substituted olefin undergoes homopolymerization.

In various embodiments, the present invention provides a method for catalyzing homopolymerization of an optionally substituted olefin, comprising: combining or contacting an optionally substituted olefin with the bimetallic catalyst complex of Formula (5-B), or Formula (6-B), or combinations thereof, whereby the optionally substituted olefin undergoes homopolymerization.

In some embodiments, the step of combining or contacting the optionally substituted olefin with the bimetallic catalyst complex is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof. In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, method for catalyzing homopolymerization of an optionally substituted olefin further comprises combining or contacting at least one activator with the bimetallic catalyst complex and the optionally substituted olefin. In some embodiments, the at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the optionally substituted olefin is an optionally substituted terminal olefin or an optionally substituted internal olefin. In some embodiments, the optionally substituted olefin is selected from the group consisting of ethylene, an optionally substituted terminal olefin, and an optionally substituted internal olefin. In some embodiments, the optionally substituted terminal olefin is selected from the group consisting of propene, butene, 1-hexene, 1-heptene, 1-octene, styrene, acrylamide, acrylic acid, acrylic ester, vinyl halide, vinyl alcohol, allyl alcohol, and allylbenzene. In some embodiments, the optionally substituted internal olefin is selected from the group consisting of 2-hexene, 3-hexene, 2-heptene, 3-heptene, 2-octene, 3-octene, and 4-octene. In some embodiments, the optionally substituted olefin is ethylene. In some embodiments, the optionally substituted olefin is selected from the group consisting of ethylene, propene, butene, 1-hexene, 1-heptene, 1-octene, styrene, acrylamide, acrylic acid, acrylic ester, 2-octene, 3-octene, and 4-octene.

In various embodiments, the present invention provides a polymer formed by a method for catalyzing homopolymerization of an optionally substituted olefin. In various embodiments, the present invention provides a homopolymer formed by the method for catalyzing homopolymerization of an optionally substituted olefin as provided herein. In some embodiments, the polymer is monomodal or bimodal. In some embodiments, the polymer is monomodal. In some embodiments, the polymer is bimodal. In some embodiments, the polymer is monomdal, or bimodal, or combination thereof. In some embodiments, the polymer is a homopolymer. In some embodiments, the homopolymer is monomodal or bimodal. In some embodiments, the homopolymer is monomodal. In some embodiments, the homopolymer is bimodal. In some embodiments, the homopolymer is monomodal, or bimodal, or combination thereof.

### Methods for Polymerizing an Optionally Substituted Olefin

In various embodiments, the present invention provides a method for polymerizing an optionally substituted olefin, the method comprising contacting an optionally substituted olefin with the bimetallic catalyst complex of Formula (5), Formula (6), Formula (5-A), Formula (6-A), Formula (5-B), or Formula (6-B), or combinations thereof, and at least one activator under conditions effective to polymerize the optionally substituted olefin.

In various embodiments, the present invention provides a method for polymerizing an optionally substituted olefin, the method comprising contacting an optionally substituted olefin with the bimetallic catalyst complex of Formula (5), or Formula (6), or combinations thereof, and at least one activator under conditions effective to polymerize the optionally substituted olefin.

In various embodiments, the present invention provides a method for polymerizing an optionally substituted olefin, the method comprising contacting an optionally substituted olefin with the bimetallic catalyst complex of Formula (5-A), or Formula (6-A), or combinations thereof, and at least one activator under conditions effective to polymerize the optionally substituted olefin.

In various embodiments, the present invention provides a method for polymerizing an optionally substituted olefin, the method comprising contacting an optionally substituted olefin with the bimetallic catalyst complex of Formula (5-B), or Formula (6-B), or combinations thereof, and at least one activator under conditions effective to polymerize the optionally substituted olefin.

In some embodiments, the at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the step of contacting the optionally substituted olefin with the bimetallic catalyst complex and the at least one activator is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof. In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from tetrahydrofuran, diethyl ether, dichloromethane, chloroform, N,N-dimethylforamide, dimethylsulfoxide, ethyl acetate, acetone, and water, and any combinations thereof.

In some embodiments, the optionally substituted olefin is an optionally substituted terminal olefin or an optionally substituted internal olefin. In some embodiments, the optionally substituted olefin is selected from the group consisting of ethylene, an optionally substituted terminal olefin, and an optionally substituted internal olefin. In some embodiments, the optionally substituted terminal olefin is selected from the group consisting of propene, butene, 1-hexene, 1-heptene, 1-octene, styrene, acrylamide, acrylic acid, acrylic ester, vinyl halide, vinyl alcohol, allyl alcohol, and allylbenzene. In some embodiments, the optionally substituted internal olefin is selected from the group consisting of 2-hexene, 3-hexene, 2-heptene, 3-heptene, 2-octene, 3-octene, and 4-octene. In some embodiments, the optionally substituted olefin is ethylene. In some embodiments, the optionally substituted olefin is selected from the group consisting of ethylene, propene, butene, 1-hexene, 1-heptene, 1-octene, styrene, acrylamide, acrylic acid, acrylic ester, 2-octene, 3-octene, and 4-octene.

In various embodiments, the present invention provides a polymer formed by a method for polymerizing an optionally substituted olefin as provided herein. In some embodiments, the polymer is monomodal or bimodal. In some embodiments, the polymer is monomodal. In some embodiments, the polymer is bimodal. In some embodiments, the polymer is monomodal, bimodal, or combination thereof.

### Method for Catalyzing Copolymerization of a First Olefin and at Least One Other Olefin

In various embodiments, the present invention provides a method for catalyzing copolymerization of a first olefin and at least one other olefin, comprising: combining or contacting a first olefin and at least one other olefin with the bimetallic catalyst complex of Formula (5), Formula (6), Formula (5-A), Formula (6-A), Formula (5-B), or Formula (6-B), or combinations thereof, whereby the first olefin and the at least one other olefin undergoes copolymerization, and wherein the first olefin and the at least one other olefin are different from one another.

In various embodiments, the present invention provides a method for catalyzing copolymerization of a first olefin and at least one other olefin, comprising: combining or contacting a first olefin and at least one other olefin with the bimetallic catalyst complex of Formula (5), or Formula (6), or combinations thereof, whereby the first olefin and the at least one other olefin undergoes copolymerization, and wherein the first olefin and the at least one other olefin are different from one another.

In various embodiments, the present invention provides a method for catalyzing copolymerization of a first olefin and at least one other olefin, comprising: combining or contacting a first olefin and at least one other olefin with the bimetallic catalyst complex of Formula (5-A), Formula (6-A), or combinations thereof, whereby the first olefin and the at least one other olefin undergoes copolymerization, and wherein the first olefin and the at least one other olefin are different from one another.

In various embodiments, the present invention provides a method for catalyzing copolymerization of a first olefin and at least one other olefin, comprising: combining or contacting a first olefin and at least one other olefin with the bimetallic catalyst complex of Formula (5-B), or Formula (6-B), or combinations thereof, whereby the first olefin and the at least one other olefin undergoes copolymerization, and wherein the first olefin and the at least one other olefin are different from one another.

In some embodiments, the first olefin and the at least one other olefin are different from one another. In some embodiments, the at least one other olefin is at least one second olefin. In some embodiments, the first olefin and the at least one second olefin are different from one another.

In some embodiments, the step of combining or contacting the first olefin and the at least one other olefin with the bimetallic catalyst complex is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof. In some embodiments, the first olefin is selected from the group consisting of ethylene, propene, and styrene. In some embodiments the at least one other olefin is selected from the group consisting of 1-hexene, 1-octene, allyl benzene, acrylamide, acrylic acid, acrylic ester, vinyl halide, vinyl alcohol, and allyl alcohol. In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the method for catalyzing copolymerization of a first olefin and at least one other olefin further comprises combining or contacting at least one activator with the bimetallic catalyst complex, the first olefin, and the at least one other olefin. In some embodiments, the at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the first olefin and the at least one other olefin are each independently an optionally substituted olefin. In some embodiments, the optionally substituted olefin is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene. In some embodiments, the first olefin and the at least one other olefin are each independently an optionally substituted terminal olefin or an optionally substituted internal olefin. In some embodiments, the first olefin and the at least one other olefin are each independently ethylene, an optionally substituted terminal olefin, or an optionally substituted internal olefin. In some embodiments, the optionally substituted terminal olefin is selected from the group consisting of propene, butene, 1-hexene, 1-heptene, 1-octene, styrene, acrylamide, acrylic acid, acrylic ester, vinyl halide, vinyl alcohol, allyl alcohol, and allylbenzene. In some embodiments, the optionally substituted internal olefin is selected from the group consisting of 2-hexene, 3-hexene, 2-heptene, 3-heptene, 2-octene, 3-octene, and 4-octene. In some embodiments, the first olefin is ethylene.

In various embodiments, the present invention provides a polymer formed by a method for catalyzing copolymerization of a first olefin and at least one other olefin as provided herein. In some embodiments, the polymer is a copolymer. In some embodiments, the copolymer is selected from the group consisting of a random copolymer, block copolymer, and gradient copolymer. In some embodiments, the copolymer is a random copolymer. In some embodiments, the copolymer is a block copolymer. In some embodiments, the copolymer is a gradient copolymer. In some embodiments, the polymer is monomodal or bimodal. In some embodiments, the polymer is monomodal. In some embodiments, the polymer is bimodal. In some embodiments, the polymer is monomodal, bimodal, or combination thereof. In some embodiments, the copolymer is monomodal or bimodal. In some embodiments, the copolymer is monomodal. In some embodiments, the copolymer is bimodal. In some embodiments, the copolymer is monomodal, or bimodal, or combination thereof.

### Methods for Copolymerizing a First Olefin and at Least One Other Olefin

In various embodiments, the present invention provides a method for copolymerizing a first olefin and at least one other olefin, the method comprising contacting the first olefin and the at least one other olefin with the bimetallic catalyst complex of Formula (5), Formula (6), Formula (5-A), Formula (6-A), Formula (5-B), or Formula (6-B), or combinations thereof; and at least one activator under conditions effective to copolymerize the first olefin and the at least one other olefin, wherein the first olefin and the at least one other olefin are different from one another.

In various embodiments, the present invention provides a method for copolymerizing a first olefin and at least one other olefin, the method comprising contacting the first olefin and the at least one other olefin with the bimetallic catalyst complex of Formula (5), or Formula (6), or combinations thereof, and at least one activator under conditions effective to copolymerize the first olefin and the at least one other olefin, wherein the first olefin and the at least one other olefin are different from one another.

In various embodiments, the present invention provides a method for copolymerizing a first olefin and at least one other olefin, the method comprising contacting the first olefin and the at least one other olefin with the bimetallic catalyst complex of Formula (5-A), or Formula (6-A), or combinations thereof, and at least one activator under conditions effective to copolymerize the first olefin and the at least one other olefin, wherein the first olefin and the at least one other olefin are different from one another.

In various embodiments, the present invention provides a method for copolymerizing a first olefin and at least one other olefin, the method comprising contacting the first olefin and the at least one other olefin with the bimetallic catalyst complex of Formula (5-B), or Formula (6-B), or combinations thereof; and at least one activator under conditions effective to copolymerize the first olefin and the at least one other olefin, wherein the first olefin and the at least one other olefin are different from one another.

In some embodiments, the first olefin and the at least one other olefin are different from one another. In some embodiments, the at least one other olefin is at least one second olefin. In some embodiments, the first olefin and the at least one second olefin are different from one another.

In some embodiments, the at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the step of contacting the first olefin and the at least one other olefin with the bimetallic catalyst complex and the at least one activator is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof. In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the first olefin and the at least one other olefin are each independently an optionally substituted olefin. In some embodiments, the optionally substituted olefin is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene. In some embodiments, the first olefin and the at least one other olefin are each independently an optionally substituted terminal olefin or an optionally substituted internal olefin. In some embodiments, the first olefin and the at least one other olefin are each independently ethylene, an optionally substituted terminal olefin, or an optionally substituted internal olefin. In some embodiments, the first olefin is ethylene.

In various embodiments, the present invention provides a polymer formed by a method for copolymerizing a first olefin and at least one other olefin as provided herein. In various embodiments, the present invention provides a polymer formed by the method for copolymerizing a first olefin and at least one other olefin as provided herein. In some embodiments, the polymer is a copolymer. In some embodiments, the copolymer is selected from the group consisting of a random copolymer, block copolymer, and gradient copolymer. In some embodiments, the copolymer is a random copolymer. In some embodiments, the copolymer is a block copolymer. In some embodiments, the copolymer is a gradient copolymer. In some embodiments, the polymer is monomodal or bimodal. In some embodiments, the polymer is monomodal. In some embodiments, the polymer is bimodal. In some embodiments, the polymer is monomodal, or bimodal, or combination thereof. In some embodiments, the copolymer is monomodal or bimodal. In some embodiments, the copolymer is monomodal. In some embodiments, the copolymer is bimodal. In some embodiments, the copolymer is monomodal, or bimodal, or combination thereof.

### Method for Making a Compound

In various embodiments, the present invention provides a method for making a compound, the method comprising contacting a reactant with a bimetallic catalyst complex of Formula (5), Formula (6), Formula (5-A), Formula (6-A), Formula (5-B), or Formula (6-B), or combinations thereof, under conditions effective to make the compound.

In some embodiments the reactant is methylaluminoxane, trialkylaluminium, alkyllithium, alkyl magnesium halide, or dialklylzinc.

In some embodiments, the step of contacting the reactant with the bimetallic catalyst complex is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof. In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the method for making a compound further comprises contacting at least one activator with the bimetallic catalyst complex and the reactant. In some embodiments, the at least one activator is Ni(COD)₂ or triarylborane. In some embodiments, the at least one activator is selected from the group consisting of Ni(COD)₂, triarylborane, methylaluminoxane, and trialkylaluminum. In some embodiments, the compound is a small molecule. In some embodiments, the method for making a compound a cascade method.

### Method for Making a Compound

In various embodiments, the present invention provides a method for making a compound, the method comprising contacting a first reactant and at least one other reactant with a bimetallic catalyst complex of Formula (5), Formula (6), Formula (5-A), Formula (6-A), Formula (5-B), or Formula (6-B), or combinations thereof, under conditions effective to make the compound.

In some embodiments, the step of contacting the first reactant and the at least one other reactant with the bimetallic catalyst complex is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof. In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the method for making the compound further comprises contacting at least one activator with the bimetallic catalyst complex, the first reactant, and the at least one other reactant. In some embodiments, the at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the compound is a small molecule. In some embodiments, the method for making a compound is a cascade method. In some embodiments, the first reactant and the at least one other reactant are different from one another.

### Method of Making a Polymer

In various embodiments, the present invention provides a method of making a polymer, comprising contacting a monomer with the bimetallic catalyst complex of Formula (5), Formula (6), Formula (S-A), Formula (6-A), Formula (5-B), or Formula (6-B), or combinations thereof.

In various embodiments, the present invention provides a method of making a polymer, comprising contacting a monomer with the bimetallic catalyst complex of Formula (5), or Formula (6), or combinations thereof.

In various embodiments, the present invention provides a method of making a polymer, comprising contacting a monomer with the bimetallic catalyst complex of Formula (5-A), Formula (6-A), or combinations thereof.

In various embodiments, the present invention provides a method of making a polymer, comprising contacting a monomer with the bimetallic catalyst complex of Formula (5-B), or Formula (6-B), or combinations thereof.

In some embodiments, the monomer is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene.

In some embodiments, the step of contacting the monomer with the bimetallic catalyst complex is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof. In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the method of making a polymer further comprises contacting at least one activator with the bimetallic catalyst complex and the monomer.

In some embodiments, the at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the monomer is an optionally substituted olefin. In some embodiments, the optionally substituted olefin is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene. In some embodiments, the monomer is an optionally substituted terminal olefin or an optionally substituted internal olefin. In some embodiments, the monomer is selected from the group consisting of ethylene, an optionally substituted terminal olefin, and an optionally substituted internal olefin. In some embodiments, the monomer is ethylene.

In various embodiments, the present invention provides a polymer made by a method of making a polymer as provided herein. In various embodiments, the polymer is bimodal or monomodal. In some embodiments, the polymer is bimodal. In some embodiments, the polymer is monomodal. In some embodiments, the polymer is monomodal, or bimodal, or combination

### Method of Making a Copolymer

In various embodiments, the present invention provides a method of making a copolymer, comprising contacting a first monomer and at least one other monomer with a bimetallic catalyst complex of Formula (5), Formula (6), Formula (5-A), Formula (6-A), Formula (5-B), or Formula (6-B), or combinations thereof, wherein the first monomer and the at least one other monomer are different from one another.

In various embodiments, the present invention provides a method of making a copolymer, comprising contacting a first monomer and at least one other monomer with a bimetallic catalyst complex of Formula (5), or Formula (6), or combinations thereof, wherein the first monomer and the at least one other monomer are different from one another.

In various embodiments, the present invention provides a method of making a copolymer, comprising contacting a first monomer and at least one other monomer with a bimetallic catalyst complex of Formula (5-A), or Formula (6-A), or combinations thereof, wherein the first monomer and the at least one other monomer are different from one another.

In various embodiments, the present invention provides a method of making a copolymer, comprising contacting a first monomer and at least one other monomer with a bimetallic catalyst complex of Formula (5-B), or Formula (6-B), or combinations thereof, wherein the first monomer and the at least one other monomer are different from one another.

In some embodiments, the first monomer and the at least one other monomer are different from one another. In some embodiments, the at least one other monomer is at least one second monomer. In some embodiments, the first monomer and the at least one second monomer are different from one another.

In some embodiments, the step of contacting the first monomer and the at least one other monomer with the bimetallic catalyst complex is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof. In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the method of making a copolymer further comprises contacting at least one activator with the bimetallic catalyst complex, the first monomer, and the at least one other monomer. In some embodiments, the first monomer is ethylene, propene, 1-butene, 1-hexene, 1-octene, styrene, or allyl benzene. In some embodiments, the at least one other monomer is acrylamide, acrylic acid, acrylic ester, vinyl halide, vinyl alcohol, or allyl alcohol.

In some embodiments, the at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the first monomer and the at least one other monomer are each independently an optionally substituted olefin. In some embodiments, the optionally substituted olefin is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene. In some embodiments, the first monomer and the at least one other monomer are each independently an optionally substituted terminal olefin or an optionally substituted internal olefin. In some embodiments, the first monomer and the at least one other monomer are each independently ethylene, an optionally substituted terminal olefin, or an optionally substituted internal olefin. In some embodiments, the optionally substituted terminal olefin is selected from the group consisting of propene, butene, 1-hexene, 1-heptene, 1-octene, styrene, acrylamide, acrylic acid, acrylic ester, vinyl halide, vinyl alcohol, allyl alcohol, and allylbenzene. In some embodiments, the optionally substituted internal olefin is selected from the group consisting of 2-hexene, 3-hexene, 2-heptene, 3-heptene, 2-octene, 3-octene, and 4-octene. In some embodiments, the first monomer is ethylene.

In various embodiments, the present invention provides a polymer formed by the method for catalyzing copolymerization of a first monomer and at least one other monomer. In some embodiments, the polymer is a copolymer. In some embodiments, the copolymer is selected from the group consisting of a random copolymer, block copolymer, and gradient copolymer. In some embodiments, the copolymer is a random copolymer. In some embodiments, the copolymer is a block copolymer. In some embodiments, the copolymer is a gradient copolymer.

In various embodiments, the present invention provides a copolymer made by a method of making a copolymer as provided herein. In various embodiments, the present invention provides a polymer made by a method of making a copolymer as provided herein. In some embodiments, the polymer is a copolymer. In some embodiments, the copolymer is selected from the group consisting of a random copolymer, block copolymer, and gradient copolymer. In some embodiments, the polymer is monomodal or bimodal. In some embodiments, the polymer is monomodal. In some embodiments, the polymer is bimodal. In some embodiments, the polymer is monomodal, or bimodal, or combination thereof. In some embodiments, the copolymer is monomodal or bimodal. In some embodiments, the copolymer is bimodal. In some embodiments, the copolymer is monomodal. In some embodiments, the copolymer is monomodal, or bimodal, or combination thereof. In some embodiments, the first monomer is CO₂; and the at least one other monomer is an epoxide.

Catalyst Composition Comprising at Least Four Bimetallic Catalyst Complexes: a Bimetallic Catalyst Complex of Formula (7), a Bimetallic Catalyst Complex of Formula (8), a Bimetallic catalyst complex of Formula (9), and a Bimetallic Catalyst Complex of Formula (10).

In various embodiments, the present invention provides a catalyst composition, comprising at least four bimetallic catalyst complexes, wherein the at least four bimetallic catalyst complexes are selected from: a bimetallic catalyst complex of Formula (7), a bimetallic catalyst complex of Formula (8), a bimetallic catalyst complex of Formula (9), and a bimetallic catalyst complex of Formula (10): wherein the bimetallic catalyst complex of Formula (7) has the structure:

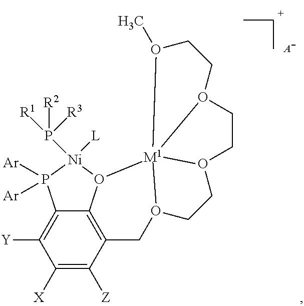

wherein the bimetallic catalyst complex of Formula (8) has the structure:

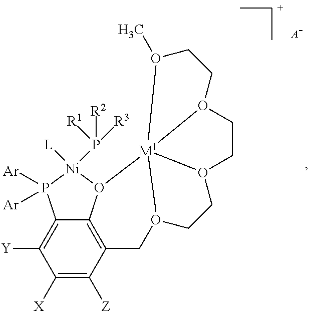

wherein the bimetallic catalyst complex of Formula (9) has the structure:

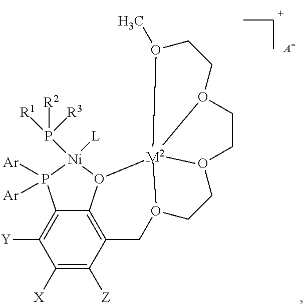

wherein the bimetallic catalyst complex of Formula (10) has the structure:

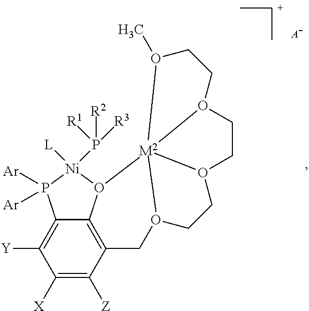

wherein in Formula (7), Formula (8), Formula (9) and Formula (10): Ar is 2,6-dimethoxyphenyl; L is an optionally substituted phenyl group; M¹ is Li, Na, K, or Cs; M² is Li, Na, K, or Cs; A is a weakly coordinating anion; X, Y, and Z are each independently selected from hydrogen, an electron donating group, and an electron withdrawing group; and R¹, R², and R³ are each independently selected from optionally substituted aryl, optionally substituted alkyl, and optionally substituted cycloalkyl; wherein A is the same in the bimetallic catalyst complex of Formula (7), Formula (8), Formula (9), and Formula (10); wherein Ar is the same in the bimetallic catalyst complex of Formula (7), Formula (8), Formula (9), and Formula (10); wherein L is the same in the bimetallic catalyst complex of Formula (7), Formula (8), Formula (9), and Formula (10); wherein X is the same in the bimetallic catalyst complex of Formula (7), Formula (8), Formula (9), and Formula (10); wherein Y is the same in the bimetallic catalyst complex of Formula (7), Formula (8), Formula (9), and Formula (10); wherein Z is the same in the bimetallic catalyst complex of Formula (7), Formula (8), Formula (9), and Formula (10); wherein R¹ is the same in the bimetallic catalyst complex of Formula (7), Formula (8), Formula (9), and Formula (10); wherein R² is the same in the bimetallic catalyst complex of Formula (7), Formula (8), Formula (9), and Formula (10); wherein R³ is the same in the bimetallic catalyst complex of Formula (7), Formula (8), Formula (9), and Formula (10); wherein M¹ is the same in the bimetallic catalyst complex of Formula (7) and Formula (8); wherein M² is the same in the bimetallic catalyst complex of Formula (9) and Formula (10); and wherein M¹ and M² are different from one another.

In various embodiments, the present invention provides a catalyst composition, comprising at least four bimetallic catalyst complexes, wherein the at least four bimetallic catalyst complexes are selected from: a bimetallic catalyst complex of Formula (7-A), a bimetallic catalyst complex of Formula (8-A), a bimetallic catalyst complex of Formula (9-A), and a bimetallic catalyst complex of Formula (10-A):
wherein the bimetallic catalyst complex of Formula (7-A) has the structure:

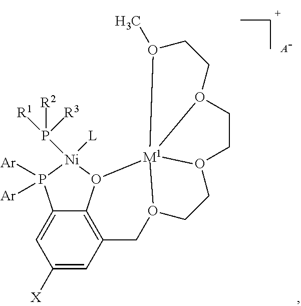

wherein the bimetallic catalyst complex of Formula (8-A) has the structure:

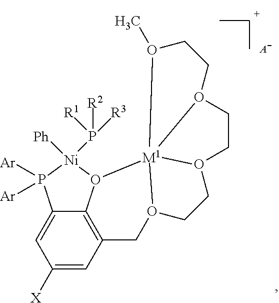

wherein the bimetallic catalyst complex of Formula (9-A) has the structure:

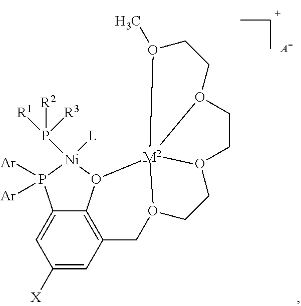

wherein the bimetallic catalyst complex of Formula (10-A) has the structure:

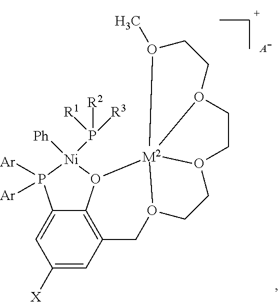

wherein in Formula (7-A), Formula (8-A), Formula (9-A) and Formula (10-A):
M¹ is Li, Na, K, or Cs;
M² is Li, Na, K, or Cs;
A⁻ is a weakly coordinating anion;
X is hydrogen, an electron donating group, or an electron withdrawing group; and
R¹, R², and R³ are each independently selected from optionally substituted aryl, optionally substituted alkyl, and optionally substituted cycloalkyl;
wherein A is the same in the bimetallic catalyst complex of Formula (7-A), Formula (8-A), Formula (9-A), and Formula (10-A);
wherein Ar is the same in the bimetallic catalyst complex of Formula (7-A), Formula (8-A), Formula (9-A), and Formula (10-A);
wherein Ph is the same in the bimetallic catalyst complex of Formula (7-A), Formula (8-A), Formula (9-A), and Formula (10-A);
wherein X is the same in the bimetallic catalyst complex of Formula (7-A), Formula (8-A), Formula (9-A), and Formula (10-A);
wherein R¹ is the same in the bimetallic catalyst complex of Formula (7-A), Formula (8-A), Formula (9-A), and Formula (10-A);
wherein R² is the same in the bimetallic catalyst complex of Formula (7-A), Formula (8-A), Formula (9-A), and Formula (10-A);
wherein R³ is the same in the bimetallic catalyst complex of Formula (7-A), Formula (8-A), Formula (9-A), and Formula (10-A);
wherein M¹ is the same in the bimetallic catalyst complex of Formula (7-A) and Formula (8-A);
wherein M² is the same in the bimetallic catalyst complex of Formula (9-A) and Formula (10-A);
and wherein M¹ and M² are different from one another.

In various embodiments, the present invention provides a catalyst composition, comprising at least four bimetallic catalyst complexes, wherein the at least four bimetallic catalyst complexes are selected from: a bimetallic catalyst complex of Formula (7-B), a bimetallic catalyst complex of Formula (8-B), a bimetallic catalyst complex of Formula (9-B), and a bimetallic catalyst complex of Formula (10-B): wherein the bimetallic catalyst complex of Formula (7-B) has the structure:

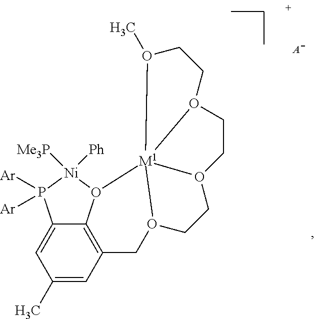

wherein the bimetallic catalyst complex of Formula (8-B) has the structure:

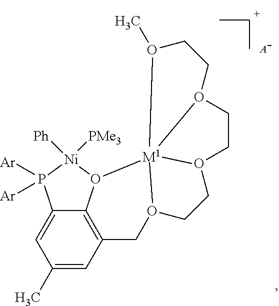

wherein the bimetallic catalyst complex of Formula (9-B) has the structure:

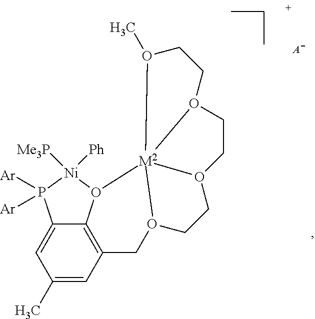

wherein the bimetallic catalyst complex of Formula (10-B) has the structure:

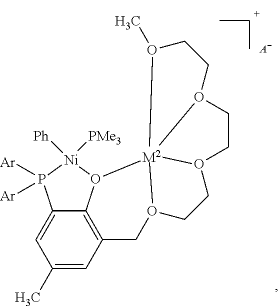

wherein in Formula (7-B), Formula (8-B), Formula (9-B) and Formula (10-B):
Ar is 2,6-dimethoxyphenyl;
Ph is a phenyl group;
M¹ is Li, Na, K, or Cs;
M² is Li, Na, K, or Cs;
A⁻ is [(3,5-(CF₃)₂C₆H₃)₄B]⁻; and
PMe₃ is trimethylphosphine;
wherein A is the same in the bimetallic catalyst complex of Formula (7-B), Formula (8-B), Formula (9-B), and Formula (10-B);
wherein Ar is the same in the bimetallic catalyst complex of Formula (7-B), Formula (8-B), Formula (9-B), and Formula (10-B);
wherein Ph is the same in the bimetallic catalyst complex of Formula (7-B), Formula (8-B), Formula (9-B), and Formula (10-B);
wherein PMe₃ is the same in the bimetallic catalyst complex of Formula (7-B), Formula (8-B), Formula (9-B), and Formula (10-B);
wherein M¹ is the same in the bimetallic catalyst complex of Formula (7-B) and Formula (8-B);
wherein M² is the same in the bimetallic catalyst complex of Formula (9-B) and Formula (10-B);
and wherein M¹ and M² are different from one another.

In some embodiments, in Formula (7), Formula (8), Formula (9) and Formula (10): Ar is 2,6-dimethoxyphenyl; L is a phenyl group; M¹ is Li, Na, K, or Cs; M² is Li, Na, K, or Cs; A is [(3,5-(CF₃)₂C₆H₃)₄B]⁻; X is methyl; Y is hydrogen; Z is hydrogen, and R¹, R², and R³ are each methyl; wherein A is the same in the bimetallic catalyst complex of Formula (7), Formula (8), Formula (9), and Formula (10); wherein Ar is the same in the bimetallic catalyst complex of Formula (7), Formula (8), Formula (9), and Formula (10); wherein L is the same in the bimetallic catalyst complex of Formula (7), Formula (8), Formula (9), and Formula (10); wherein X is the same in the bimetallic catalyst complex of Formula (7), Formula (8), Formula (9), and Formula (10); wherein Y is the same in the bimetallic catalyst complex of Formula (7), Formula (8), Formula (9), and Formula (10); wherein Z is the same in the bimetallic catalyst complex of Formula (7), Formula (8), Formula (9), and Formula (10); wherein R¹ is the same in the bimetallic catalyst complex of Formula (7), Formula (8), Formula (9), and Formula (10); wherein R² is the same in the bimetallic catalyst complex of Formula (7), Formula (8), Formula (9), and Formula (10); wherein R³ is the same in the bimetallic catalyst complex of Formula (7), Formula (8), Formula (9), and Formula (10); wherein M¹ is the same in the bimetallic catalyst complex of Formula (7) and Formula (8); wherein M² is the same in the bimetallic catalyst complex of Formula (9) and Formula (10); and wherein M¹ and M² are different from one another.

In some embodiments, the bimetallic catalyst complex of Formula (7-A) is a bimetallic catalyst complex of Formula (7). In some embodiments, the bimetallic catalyst complex of Formula (7-B) is a bimetallic catalyst complex of Formula (7). In some embodiments, the bimetallic catalyst complex of Formula (8-A) is a bimetallic catalyst complex of Formula (8). In some embodiments, the bimetallic catalyst complex of Formula (8-B) is a bimetallic catalyst complex of Formula (8). In some embodiments, the bimetallic catalyst complex of Formula (9-A) is a bimetallic catalyst complex of Formula (9). In some embodiments, the bimetallic catalyst complex of Formula (9-B) is a bimetallic catalyst complex of Formula (9). In some embodiments, the bimetallic catalyst complex of Formula (10-A) is a bimetallic catalyst complex of Formula (10). In some embodiments, the bimetallic catalyst complex of Formula (10-B) is a bimetallic catalyst complex of Formula (10).

In some embodiments, A⁻ is a weakly coordinating anion. In some embodiments, the weakly coordinating anion is selected from the group consisting of tetrakis(3,5-bis(trifluoromethyl)phenylborate, tetrakis(pentafluorophenyl)borate, tetraphenylborate, trifluoromethylsulfonate, hexafluorophosphate, hexafluoroantimonate, and tetrafluoroborate. In some embodiments, tetrakis(3,5-bis(trifluoromethyl)phenylborate is represented as [(3,5-(CF₃)₂C₆H₃)₄B]⁻. In some embodiments, tetrakis(3,5-bis(trifluoromethyl)phenylborate is represented as BAr^{F}₄⁻.

In some embodiments M¹ is Li, Na, K, or Cs. In some embodiments, M⁺ is Li. In some embodiments, M¹ is Na. In some embodiments, M¹ is K. In some embodiments, M′ is Cs. In some embodiments M² is Li, Na, K, or Cs. In some embodiments, M² is Li. In some embodiments, M² is Na. In some embodiments, M² is K. In some embodiments, M² is Cs.

In some embodiments, the electron donating group is selected from the group consisting of: alkoxy, amino, hydroxy, and alkyl. In some embodiments, the electron donating group is selected from the group consisting of: alkoxy, phenoxy, amino, alkylamino, dialkylamino, hydroxy, alkyl, and cycloalkyl. In some embodiments, alkyl is selected from the group consisting of: —CH₃, —CH₂CH₃, —CH₂CH₂CH₃, and —CH(CH₃)₂. In some embodiments, the electron withdrawing group is selected from the group consisting of: NO₂, —CN, —C(O)-alkyl, and halo. In some embodiments, the electron withdrawing group is selected from the group consisting of: NO₂, —CN, —C(O)-alkyl, C(O)Oalkyl, C(O)Nalkyl, —SO₃H, —SO₂R, —PO₃H, —POR, —CF₃, and halo. In some embodiments, the electron withdrawing group is selected from the group consisting of: NO₂, —CN, —C(O)-alkyl, C(O)Oalkyl, C(O)Nalkyl, —SO₃H, —SO₂alkyl, —PO₃H, —PO₃alkyl, —CF₃, and halo.

In some embodiments, the phenyl group is

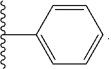 [SMILES: *c1ccccc1]

In some embodiments, L is an optionally substituted phenyl group. In some embodiments, the optionally substituted phenyl group is selected from the group consisting of phenyl, 2-methoxyphenyl, 4-methoxyphenyl, 2-acetylphenyl, or 2-(N-acetylamino)phenyl). In some embodiments, L is a phenyl group.

In some embodiments, R¹, R², and R³ are each independently selected from optionally substituted aryl, optionally substituted alkyl, and optionally substituted cycloalkyl. In some embodiments, optionally substituted aryl is selected from the group consisting of phenyl, pentafluorophenyl, 2-methoxyphenyl, 2-methylphenyl, and 4-trifluoromethylphenyl. In some embodiments, optionally substituted alkyl is selected from the group consisting of methyl, ethyl, propyl, isopropyl, or tert-butyl. In some embodiments, optionally substituted cycloalkyl is cyclohexyl or adamantyl.

### Method for Catalyzing Homopolymerization of an Optionally Substituted Olefin

In various embodiments, the present invention provides a method for catalyzing homopolymerization of an optionally substituted olefin, comprising: combining or contacting an optionally substituted olefin with the catalyst composition, whereby the optionally substituted olefin undergoes homopolymerization, and wherein the catalyst composition comprises at least four bimetallic catalyst complexes, wherein the at least four bimetallic catalyst complexes are selected from: a bimetallic catalyst complex of Formula (7), a bimetallic catalyst complex of Formula (8), a bimetallic catalyst complex of Formula (9), and a bimetallic catalyst complex of Formula (10).

In various embodiments, the present invention provides a method for catalyzing homopolymerization of an optionally substituted olefin, comprising: combining or contacting an optionally substituted olefin with the catalyst composition, whereby the optionally substituted olefin undergoes homopolymerization, and wherein the catalyst composition comprises at least four bimetallic catalyst complexes, wherein the at least four bimetallic catalyst complexes are selected from: a bimetallic catalyst complex of Formula (7A), a bimetallic catalyst complex of Formula (8A), a bimetallic catalyst complex of Formula (9A), and a bimetallic catalyst complex of Formula (10A).

In various embodiments, the present invention provides a method for catalyzing homopolymerization of an optionally substituted olefin, comprising: combining or contacting an optionally substituted olefin with the catalyst composition, whereby the optionally substituted olefin undergoes homopolymerization, and wherein the catalyst composition comprises at least four bimetallic catalyst complexes, wherein the at least four bimetallic catalyst complexes are selected from: a bimetallic catalyst complex of Formula (7B), a bimetallic catalyst complex of Formula (8B), a bimetallic catalyst complex of Formula (9B), and a bimetallic catalyst complex of Formula (10B).

In some embodiments, the step of combining or contacting the optionally substituted olefin with the catalyst is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof. In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the method for catalyzing homopolymerization of an optionally substituted olefin further comprises combining or contacting at least one activator with the catalyst and the optionally substituted olefin. In some embodiments, the at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the optionally substituted olefin is an optionally substituted terminal olefin or an optionally substituted internal olefin. In some embodiments, the optionally substituted olefin is selected from the group consisting of ethylene, an optionally substituted terminal olefin, and an optionally substituted internal olefin. In some embodiments, the optionally substituted terminal olefin is selected from the group consisting of propene, butene, 1-hexene, 1-heptene, 1-octene, styrene, acrylamide, acrylic acid, acrylic ester, vinyl halide, vinyl alcohol, allyl alcohol, and allylbenzene. In some embodiments, the optionally substituted internal olefin is selected from the group consisting of 2-hexene, 3-hexene, 2-heptene, 3-heptene, 2-octene, 3-octene, and 4-octene. In some embodiments, the optionally substituted olefin is ethylene. In some embodiments, the optionally substituted olefin is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene.

In various embodiments, the present invention provides a polymer formed by a method for catalyzing homopolymerization of an optionally substituted olefin as provided herein. In various embodiments, the present invention provides a homopolymer formed by the method for catalyzing homopolymerization of an optionally substituted olefin as provided herein. In some embodiments, the polymer is monomodal or bimodal. In some embodiments, the polymer is monomodal. In some embodiments, the polymer is bimodal. In some embodiments, the polymer is monomodal, or bimodal, or combination thereof. In some embodiments, the polymer is a homopolymer. In some embodiments, the homopolymer is monomodal or bimodal. In some embodiments, the homopolymer is monomodal. In some embodiments, the homopolymer is bimodal. In some embodiments, the homopolymer is monomodal, or bimodal, or combination

### Method for Polymerizing an Optionally Substituted Olefin

In various embodiments, the present invention provides a method for polymerizing an optionally substituted olefin, the method comprising contacting an optionally substituted olefin with a catalyst composition, and at least one activator under conditions effective to polymerize the optionally substituted olefin, wherein the catalyst composition comprises at least four bimetallic catalyst complexes, wherein the at least four bimetallic catalyst complexes are selected from: a bimetallic catalyst complex of Formula (7), a bimetallic catalyst complex of Formula (8), a bimetallic catalyst complex of Formula (9), and a bimetallic catalyst complex of Formula (10).

In various embodiments, the present invention provides a method for polymerizing an optionally substituted olefin, the method comprising contacting an optionally substituted olefin with a catalyst composition, and at least one activator under conditions effective to polymerize the optionally substituted olefin, wherein the catalyst composition comprises at least four bimetallic catalyst complexes, wherein the at least four bimetallic catalyst complexes are selected from: a bimetallic catalyst complex of Formula (7A), a bimetallic catalyst complex of Formula (8A), a bimetallic catalyst complex of Formula (9A), and a bimetallic catalyst complex of Formula (10A).

In various embodiments, the present invention provides a method for polymerizing an optionally substituted olefin, the method comprising contacting an optionally substituted olefin with a catalyst composition, and at least one activator under conditions effective to polymerize the optionally substituted olefin, wherein the catalyst composition comprises at least four bimetallic catalyst complexes, wherein the at least four bimetallic catalyst complexes are selected from: a bimetallic catalyst complex of Formula (7B), a bimetallic catalyst complex of Formula (8B), a bimetallic catalyst complex of Formula (9B), and a bimetallic catalyst complex of Formula (10B).

In some embodiments, the at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the step of contacting the optionally substituted olefin with the catalyst composition and the at least one activator is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof. In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from tetrahydrofuran, diethyl ether, dichloromethane, chloroform, N,N-dimethylforamide, dimethylsulfoxide, ethyl acetate, acetone, and water, and any combinations thereof. In some embodiments, the optionally substituted olefin is an optionally substituted terminal olefin or an optionally substituted internal olefin. In some embodiments, the optionally substituted olefin is selected from the group consisting of ethylene, an optionally substituted terminal olefin, and an optionally substituted internal olefin. In some embodiments, the optionally substituted terminal olefin is selected from the group consisting of propene, butene, 1-hexene, 1-heptene, 1-octene, styrene, acrylamide, acrylic acid, acrylic ester, vinyl halide, vinyl alcohol, allyl alcohol, and allylbenzene. In some embodiments, the optionally substituted internal olefin is selected from the group consisting of 2-hexene, 3-hexene, 2-heptene, 3-heptene, 2-octene, 3-octene, and 4-octene. In some embodiments, the optionally substituted olefin is ethylene. In some embodiments, the optionally substituted olefin is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene.

In various embodiments, the present invention provides a polymer formed by a method for polymerizing an optionally substituted olefin as provided herein. In some embodiments, the polymer is monomodal or bimodal. In some embodiments, the polymer is monomodal. In some embodiments, the polymer is bimodal. In some embodiments, the polymer is monmodal, or bimodal, or combination thereof.

### Method for Catalyzing Copolymerization of a First Olefin and at Least One Other Olefin

In various embodiments, the present invention provides a method for catalyzing copolymerization of a first olefin and at least one other olefin, comprising: combining or contacting a first olefin and at least one other olefin with a catalyst composition, whereby the first olefin and the at least one other olefin undergoes copolymerization, and wherein the first olefin and the at least one other olefin are different from one another, and wherein the catalyst composition comprises at least four bimetallic catalyst complexes, wherein the at least four bimetallic catalyst complexes are selected from: a bimetallic catalyst complex of Formula (7), a bimetallic catalyst complex of Formula (8), a bimetallic catalyst complex of Formula (9), and a bimetallic catalyst complex of Formula (10).

In various embodiments, the present invention provides a method for catalyzing copolymerization of a first olefin and at least one other olefin, comprising: combining or contacting a first olefin and at least one other olefin with a catalyst composition, whereby the first olefin and the at least one other olefin undergoes copolymerization, and wherein the first olefin and the at least one other olefin are different from one another, and wherein the catalyst composition comprises at least four bimetallic catalyst complexes, wherein the at least four bimetallic catalyst complexes are selected from: a bimetallic catalyst complex of Formula (7A), a bimetallic catalyst complex of Formula (8A), a bimetallic catalyst complex of Formula (9A), and a bimetallic catalyst complex of Formula (10A).

In various embodiments, the present invention provides a method for catalyzing copolymerization of a first olefin and at least one other olefin, comprising: combining or contacting a first olefin and at least one other olefin with a catalyst composition, whereby the first olefin and the at least one other olefin undergoes copolymerization, and wherein the first olefin and the at least one other olefin are different from one another, and wherein the catalyst composition comprises at least four bimetallic catalyst complexes, wherein the at least four bimetallic catalyst complexes are selected from: a bimetallic catalyst complex of Formula (7B), a bimetallic catalyst complex of Formula (8B), a bimetallic catalyst complex of Formula (9B), and a bimetallic catalyst complex of Formula (10B).

In some embodiments, the first olefin and the at least one other olefin are different from one another. In some embodiments, the at least one other olefin is at least one second olefin. In some embodiments, the first olefin and the at least one second olefin are different from one another.

In some embodiments, the step of combining or contacting the first olefin and the at least one other olefin with the catalyst composition is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof. In some embodiments, the first olefin is selected from the group consisting of ethylene, propene, and styrene. In some embodiments the at least one other olefin is selected from the group consisting of 1-hexene, 1-octene, allyl benzene, acrylamide, acrylic acid, acrylic ester, vinyl halide, vinyl alcohol, and allyl alcohol. In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the method for catalyzing copolymerization of a first olefin and at least one other olefin further comprises combining or contacting at least one activator with the catalyst composition, the first olefin, and the at least one other olefin. In some embodiments, the at least one activator is Ni(COD), or triarylborane. In some embodiments, the at least one activator is selected from the group consisting of Ni(COD)₂, triarylborane, methylaluminoxane, and trialkylaluminum.

In some embodiments, the first olefin and the at least one other olefin are each independently an optionally substituted olefin. In some embodiments, the optionally substituted olefin is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene. In some embodiments, the first olefin and the at least one other olefin are each independently an optionally substituted terminal olefin or an optionally substituted internal olefin. In some embodiments, the first olefin and the at least one other olefin are each independently ethylene, an optionally substituted terminal olefin, or an optionally substituted internal olefin. In some embodiments, the optionally substituted terminal olefin is selected from the group consisting of propene, butene, 1-hexene, 1-heptene, 1-octene, styrene, acrylamide, acrylic acid, acrylic ester, vinyl halide, vinyl alcohol, allyl alcohol, and allylbenzene. In some embodiments, the optionally substituted internal olefin is selected from the group consisting of 2-hexene, 3-hexene, 2-heptene, 3-heptene, 2-octene, 3-octene, and 4-octene. In some embodiments, the first olefin is ethylene.

In various embodiments, the present invention provides a polymer formed by a method for catalyzing copolymerization of a first olefin and at least one other olefin as provided herein. In some embodiments, the polymer is a copolymer. In some embodiments, the copolymer is selected from the group consisting of a random copolymer, block copolymer, and gradient copolymer. In some embodiments, the copolymer is a random copolymer. In some embodiments, the copolymer is a block copolymer. In some embodiments, the copolymer is a gradient copolymer. In some embodiments, the polymer is monomodal or bimodal. In some embodiments, the polymer is monomodal. In some embodiments, the polymer is bimodal. In some embodiments, the polymer is monomodal, or bimodal, or combination thereof. In some embodiments, the copolymer is monomodal or bimodal. In some embodiments, the copolymer is monomodal. In some embodiments, the copolymer is bimodal. In some embodiments, the copolymer is monomodal, or bimodal, or combination thereof.

### Method for Copolymerizing a First Olefin and at Least One Other Olefin

In various embodiments, the present invention provides a method for copolymerizing a first olefin and at least one other olefin, the method comprising contacting the first olefin and the at least one other olefin with a catalyst composition, and at least one activator under conditions effective to copolymerize the first olefin and the at least one other olefin, wherein the first olefin and the at least one other olefin are different from one another, and wherein the catalyst composition comprises at least four bimetallic catalyst complexes, wherein the at least four bimetallic catalyst complexes are selected from: a bimetallic catalyst complex of Formula (7), a bimetallic catalyst complex of Formula (8), a bimetallic catalyst complex of Formula (9), and a bimetallic catalyst complex of Formula (10).

In various embodiments, the present invention provides a method for copolymerizing a first olefin and at least one other olefin, the method comprising contacting the first olefin and the at least one other olefin with a catalyst composition, and at least one activator under conditions effective to copolymerize the first olefin and the at least one other olefin, wherein the first olefin and the at least one other olefin are different from one another, and wherein the catalyst composition comprises at least four bimetallic catalyst complexes, wherein the at least four bimetallic catalyst complexes are selected from: a bimetallic catalyst complex of Formula (7A), a bimetallic catalyst complex of Formula (8A), a bimetallic catalyst complex of Formula (9A), and a bimetallic catalyst complex of Formula (10A).

In various embodiments, the present invention provides a method for copolymerizing a first olefin and at least one other olefin, the method comprising contacting the first olefin and the at least one other olefin with a catalyst composition, and at least one activator under conditions effective to copolymerize the first olefin and the at least one other olefin, wherein the first olefin and the at least one other olefin are different from one another, and wherein the catalyst composition comprises at least four bimetallic catalyst complexes, wherein the at least four bimetallic catalyst complexes are selected from: a bimetallic catalyst complex of Formula (7B), a bimetallic catalyst complex of Formula (8B), a bimetallic catalyst complex of Formula (9B), and a bimetallic catalyst complex of Formula (10B).

In some embodiments, the first olefin and the at least one other olefin are different from one another. In some embodiments, the at least one other olefin is at least one second olefin. In some embodiments, the first olefin and the at least one second olefin are different from one another.

In some embodiments, the at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the step of contacting the first olefin and the at least one other olefin with the catalyst composition and the at least one activator is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof. In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof. In some embodiments, the first olefin and the at least one other olefin are each independently an optionally substituted olefin. In some embodiments, the optionally substituted olefin is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene.

In some embodiments, the first olefin and the at least one other olefin are each independently an optionally substituted terminal olefin or an optionally substituted internal olefin. In some embodiments, the first olefin and the at least one other olefin are each independently ethylene, an optionally substituted terminal olefin, or an optionally substituted internal olefin. In some embodiments, the first olefin is ethylene.

In various embodiments, the present invention provides a polymer formed by the method for copolymerizing a first olefin and at least one other olefin as provided herein.

In various embodiments, the present invention provides a polymer formed by the method for copolymerizing a first olefin and at least one other olefin as provided herein. In some embodiments, the polymer is a copolymer. In some embodiments, the copolymer is selected from the group consisting of a random copolymer, block copolymer, and gradient copolymer. In some embodiments, the copolymer is a random copolymer. In some embodiments, the copolymer is a block copolymer. In some embodiments, the copolymer is a gradient copolymer. In some embodiments, the polymer is monomodal or bimodal. In some embodiments, the polymer is monomodal. In some embodiments, the polymer is bimodal. In some embodiments, the polymer is monomodal, or bimodal, or combination thereof. In some embodiments, the copolymer is monomodal or bimodal. In some embodiments, the copolymer is monomodal. In some embodiments, the copolymer is bimodal. In some embodiments, the copolymer is monomodal, or bimodal, or combination thereof.

### Method for Making a Compound

In various embodiments, the present invention provides a method for making a compound, the method comprising contacting a reactant with a catalyst composition under conditions effective to make the compound, wherein the catalyst composition comprises at least four bimetallic catalyst complexes, wherein the at least four bimetallic catalyst complexes are selected from: a bimetallic catalyst complex of Formula (7), a bimetallic catalyst complex of Formula (8), a bimetallic catalyst complex of Formula (9), and a bimetallic catalyst complex of Formula (10).

In various embodiments, the present invention provides a method for making a compound, the method comprising contacting a reactant with a catalyst composition under conditions effective to make the compound, wherein the catalyst composition comprises at least four bimetallic catalyst complexes, wherein the at least four bimetallic catalyst complexes are selected from: a bimetallic catalyst complex of Formula (7A), a bimetallic catalyst complex of Formula (8A), a bimetallic catalyst complex of Formula (9A), and a bimetallic catalyst complex of Formula (10A).

In various embodiments, the present invention provides a method for making a compound, the method comprising contacting a reactant with a catalyst composition under conditions effective to make the compound, wherein the catalyst composition comprises at least four bimetallic catalyst complexes, wherein the at least four bimetallic catalyst complexes are selected from: a bimetallic catalyst complex of Formula (7B), a bimetallic catalyst complex of Formula (8B), a bimetallic catalyst complex of Formula (9B), and a bimetallic catalyst complex of Formula (10B).

In some embodiments the reactant is methylaluminoxane, trialkylaluminium, alkyllithium, alkyl magnesium halide, or dialklylzinc.

In some embodiments, the step of contacting the reactant with the catalyst composition is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof. In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the method for making a compound further comprises contacting at least one activator with the catalyst composition and the reactant. In some embodiments, the at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the compound is a small molecule. In some embodiments, the method for making a compound is a cascade method.

### Method for Making a Compound

In various embodiments, the present invention provides a method for making a compound, the method comprising contacting a first reactant and at least one other reactant with a catalyst composition under conditions effective to make the compound, wherein the catalyst composition comprises at least four bimetallic catalyst complexes, wherein the at least four bimetallic catalyst complexes are selected from: a bimetallic catalyst complex of Formula (7), a bimetallic catalyst complex of Formula (8), a bimetallic catalyst complex of Formula (9), and a bimetallic catalyst complex of Formula (10).

In various embodiments, the present invention provides a method for making a compound, the method comprising contacting a first reactant and at least one other reactant with a catalyst composition under conditions effective to make the compound, wherein the catalyst composition comprises at least four bimetallic catalyst complexes, wherein the at least four bimetallic catalyst complexes are selected from: a bimetallic catalyst complex of Formula (7A), a bimetallic catalyst complex of Formula (8A), a bimetallic catalyst complex of Formula (9A), and a bimetallic catalyst complex of Formula (10A).

In various embodiments, the present invention provides a method for making a compound, the method comprising contacting a first reactant and at least one other reactant with a catalyst composition under conditions effective to make the compound, wherein the catalyst composition comprises at least four bimetallic catalyst complexes, wherein the at least four bimetallic catalyst complexes are selected from: a bimetallic catalyst complex of Formula (7B), a bimetallic catalyst complex of Formula (8B), a bimetallic catalyst complex of Formula (9B), and a bimetallic catalyst complex of Formula (10B).

In some embodiments, the step of contacting the first reactant and the at least one other reactant with the catalyst composition is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof. In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the method for making a compound further comprises contacting at least one activator with the catalyst composition, the first reactant, and the at least one other reactant. In some embodiments, the at least one activator is Ni(COD)₂ and triarylborane. In some embodiments, the at least one activator is selected from the group consisting of Ni(COD)₂, triarylborane, methylaluminoxane, and trialkylaluminum.

In some embodiments, the compound is a small molecule. In some embodiments, the method of making a compound is a cascade method. In some embodiments, the first reactant and the at least one other reactant are different from one another.

### Methods of Making a Polymer

In various embodiments, the present invention provides a method of making a polymer, comprising contacting a monomer with a catalyst composition, wherein the catalyst composition comprises at least four bimetallic catalyst complexes, wherein the at least four bimetallic catalyst complexes are selected from: a bimetallic catalyst complex of Formula (7), a bimetallic catalyst complex of Formula (8), a bimetallic catalyst complex of Formula (9), and a bimetallic catalyst complex of Formula (10).

In various embodiments, the present invention provides a method of making a polymer, comprising contacting a monomer with a catalyst composition, wherein the catalyst composition comprises at least four bimetallic catalyst complexes, wherein the at least four bimetallic catalyst complexes are selected from: a bimetallic catalyst complex of Formula (7A), a bimetallic catalyst complex of Formula (8A), a bimetallic catalyst complex of Formula (9A), and a bimetallic catalyst complex of Formula (10A).

In various embodiments, the present invention provides a method of making a polymer, comprising contacting a monomer with a catalyst composition, wherein the catalyst composition comprises at least four bimetallic catalyst complexes, wherein the at least four bimetallic catalyst complexes are selected from: a bimetallic catalyst complex of Formula (7B), a bimetallic catalyst complex of Formula (8B), a bimetallic catalyst complex of Formula (9B), and a bimetallic catalyst complex of Formula (10B).

In some embodiments, the monomer is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene.

In some embodiments, the step of contacting the monomer with the catalyst composition is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof. In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the method of making a polymer further comprises contacting at least one activator with the catalyst composition and the monomer. In some embodiments, the at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the monomer is an optionally substituted olefin. In some embodiments, the optionally substituted olefin is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene. In some embodiments, the monomer is an optionally substituted terminal olefin or an optionally substituted internal olefin. In some embodiments, the monomer is selected from the group consisting of ethylene, an optionally substituted terminal olefin, and an optionally substituted internal olefin. In some embodiments, the monomer is ethylene.

In various embodiments, the present invention provides a polymer made by a method of making a polymer as provided herein. In some embodiments, the polymer is bimodal or monomodal. In some embodiments, the polymer is monomodal. In some embodiments the polymer is bimodal. In some embodiments, the polymer is monomodal, or bimodal, or combination thereof.

### Methods of Making a Copolymer

In various embodiments, the present invention provides a method of making a copolymer, comprising contacting a first monomer and at least one other monomer with a catalyst composition, wherein the first monomer and the at least one other monomer are different from one another, and wherein the catalyst composition comprises at least four bimetallic catalyst complexes, wherein the at least four bimetallic catalyst complexes are selected from: a bimetallic catalyst complex of Formula (7), a bimetallic catalyst complex of Formula (8), a bimetallic catalyst complex of Formula (9), and a bimetallic catalyst complex of Formula (10).

In various embodiments, the present invention provides a method of making a copolymer, comprising contacting a first monomer and at least one other monomer with a catalyst composition, wherein the first monomer and the at least one other monomer are different from one another, and wherein the catalyst composition comprises at least four bimetallic catalyst complexes, wherein the at least four bimetallic catalyst complexes are selected from: a bimetallic catalyst complex of Formula (7A), a bimetallic catalyst complex of Formula (8A), a bimetallic catalyst complex of Formula (9A), and a bimetallic catalyst complex of Formula (10A).

In various embodiments, the present invention provides a method of making a copolymer, comprising contacting a first monomer and at least one other monomer with a catalyst composition, wherein the first monomer and the at least one other monomer are different from one another, and wherein the catalyst composition comprises at least four bimetallic catalyst complexes, wherein the at least four bimetallic catalyst complexes are selected from: a bimetallic catalyst complex of Formula (7B), a bimetallic catalyst complex of Formula (8B), a bimetallic catalyst complex of Formula (9B), and a bimetallic catalyst complex of Formula (10B).

In some embodiments, the first monomer and the at least one other monomer are different from one another. In some embodiments, the at least one other monomer is at least one second monomer. In some embodiments, the first monomer and the at least one second monomer are different from one another.

In some embodiments, the step of contacting the first monomer and the at least one other monomer with the catalyst composition is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof. In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the method of making a copolymer further comprises contacting at least one activator with the catalyst composition, the first monomer, and the at least one other monomer. In some embodiments, the first monomer is ethylene, propene, 1-butene, 1-hexene, 1-octene, styrene, or allyl benzene. In some embodiments, the at least one other monomer is acrylamide, acrylic acid, acrylic ester, vinyl halide, vinyl alcohol, or allyl alcohol. In some embodiments, the at least one activator is Ni(COD); or triarylborane. In some embodiments, the at least one activator is selected from the group consisting of Ni(COD)₂, triarylborane, methylaluminoxane, and trialkylaluminum.

In some embodiments, the first monomer and the at least one other monomer are each independently an optionally substituted olefin. In some embodiments, the optionally substituted olefin is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene. In some embodiments, the first monomer and the at least one other monomer are each independently an optionally substituted terminal olefin or an optionally substituted internal olefin. In some embodiments, the first monomer and the at least one other monomer are each independently ethylene, an optionally substituted terminal olefin, or an optionally substituted internal olefin. In some embodiments, the optionally substituted terminal olefin is selected from the group consisting of propene, butene, 1-hexene, 1-heptene, 1-octene, styrene, acrylamide, acrylic acid, acrylic ester, vinyl halide, vinyl alcohol, allyl alcohol, and allylbenzene. In some embodiments, the optionally substituted internal olefin is selected from the group consisting of 2-hexene, 3-hexene, 2-heptene, 3-heptene, 2-octene, 3-octene, and 4-octene. In some embodiments, the first monomer is ethylene.

In various embodiments, the present invention provides a polymer formed by the method for catalyzing copolymerization of a first monomer and at least one other monomer. In some embodiments, the polymer is a copolymer. In some embodiments, the copolymer is selected from the group consisting of a random copolymer, block copolymer, and gradient copolymer. In some embodiments, the copolymer is a random copolymer. In some embodiments, the copolymer is a block copolymer. In some embodiments, the copolymer is a gradient copolymer.

In various embodiments, the present invention provides a copolymer made by a method of making a copolymer as provided herein. In various embodiments, the present invention provides a polymer made by a method of making a copolymer as provided herein. In some embodiments, the polymer is a copolymer. In some embodiments, the copolymer is selected from the group consisting of a random copolymer, block copolymer, and gradient copolymer. In some embodiments, the polymer is monomodal or bimodal. In some embodiments, the polymer is monomodal. In some embodiments, the polymer is bimodal. In some embodiments, the polymer is monomodal, or bimodal, or combination thereof. In some embodiments, the copolymer is bimodal or monomodal. In some embodiments, the copolymer is bimodal. In some embodiments, the copolymer is monomodal. In some embodiments, the copolymer is monomodal, or bimodal, or combination thereof. In some embodiments, the first monomer is CO₂; and the at least one other monomer is an epoxide.

### Heterobimetallic Catalysts of Formula (11), Formula (12), Formula (11-A), Formula (12-A), Formula (11-B), Formula (12-B).

In some embodiments, the present invention provides a heterobimetallic catalyst having a structure selected from Formula (11) and Formula (12):

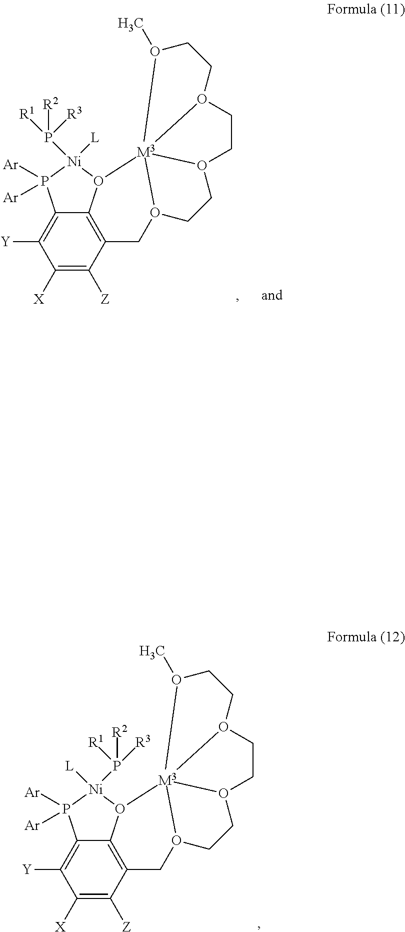

wherein in Formula (11) and Formula (12):
Ar is 2,6-dimethoxyphenyl;
L is an optionally substituted phenyl group;
M³ is a 2+ cation, 3+ cation, 4+ cation, or 5+ cation;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl.

In some embodiments, the present invention provides a heterobimetallic catalyst having a structure of Formula (11):

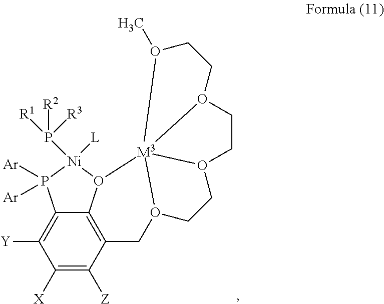

wherein,
Ar is 2,6-dimethoxyphenyl;
L is an optionally substituted phenyl group;
M³ is a 2+ cation, 3+ cation, 4+ cation, or 5+ cation;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl.

In various embodiments, the present invention provides a heterobimetallic catalyst having a structure of Formula (12):

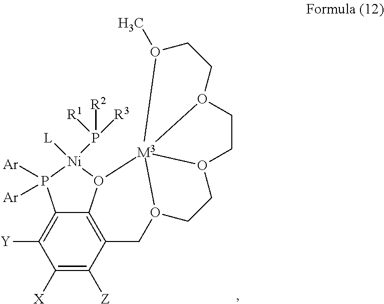

wherein,
Ar is 2,6-dimethoxyphenyl;
L is an optionally substituted phenyl group;
M³ is a 2+ cation, 3+ cation, 4+ cation, or 5+ cation;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl.

In various embodiments, the present invention provides a heterobimetallic catalyst having a structure selected from Formula (11-A) and Formula (12-A):

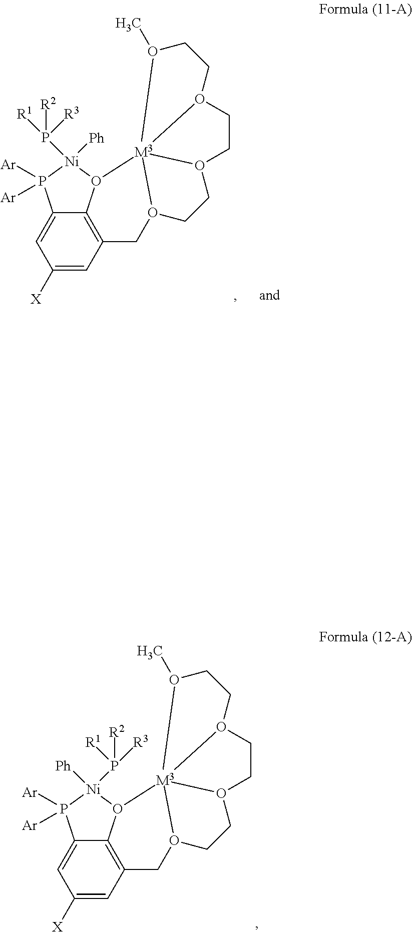

wherein in Formula (11-A) and Formula (12-A):
Ar is 2,6-dimethoxyphenyl;
Ph is a phenyl group;
M³ is a 2+ cation, 3+ cation, 4+ cation, or 5+ cation;
X is hydrogen, an electron donating group, or an electron withdrawing group; and
R¹, R², and R³ are each independently selected from optionally substituted aryl, optionally substituted alkyl, and optionally substituted cycloalkyl.

In various embodiments, the present invention provides a heterobimetallic catalyst having a structure of Formula (11-A):

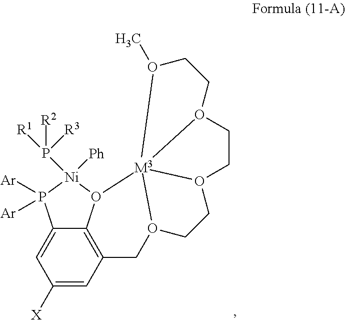

wherein,
Ar is 2,6-dimethoxyphenyl;
Ph is a phenyl group;
M³ is a 2+ cation, 3+ cation, 4+ cation, or 5+ cation;
X is hydrogen, an electron donating group, or an electron withdrawing group; and
R¹, R², and R³ are each independently selected from optionally substituted aryl, optionally substituted alkyl, and optionally substituted cycloalkyl.

In various embodiments, the present invention provides a heterobimetallic catalyst having a structure of Formula (12-A):

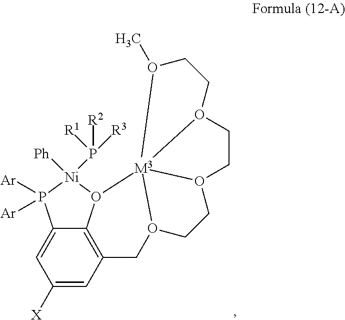

wherein,
Ar is 2,6-dimethoxyphenyl;
Ph is a phenyl group;
M³ is a 2+ cation, 3+ cation, 4+ cation, or 5+ cation;
X is hydrogen, an electron donating group, or an electron withdrawing group; and
R¹, R², and R³ are each independently selected from optionally substituted aryl, optionally substituted alkyl, and optionally substituted cycloalkyl.

In various embodiments, the present invention provides a heterobimetallic catalyst having a structure selected from Formula (11-B) and Formula (12-B):

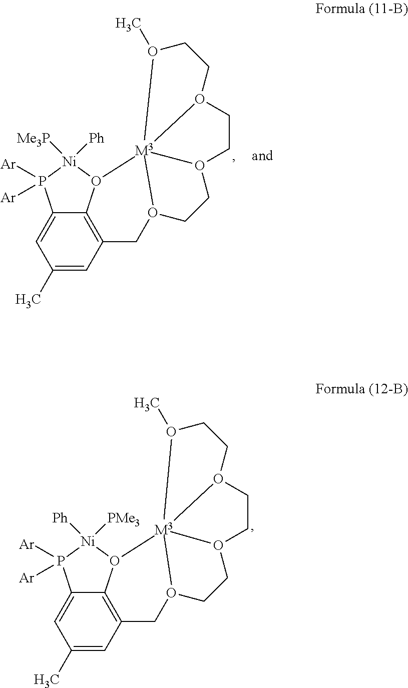

wherein in Formula (11-B) and Formula (12-B):
Ar is 2,6-dimethoxyphenyl;
Ph is a phenyl group;
M³ is a 2+ cation, 3+ cation, 4+ cation, or 5+ cation; and
PMe₃ is trimethylphosphine.

In various embodiments, the present invention provides a heterobimetallic catalyst having a structure of Formula (11-B):

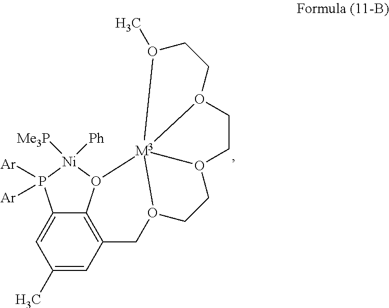

wherein,
Ar is 2,6-dimethoxyphenyl;
Ph is a phenyl group;
M³ is a 2+ cation, 3+ cation, 4+ cation, or 5+ cation; and
PMe₃ is trimethylphosphine.

In various embodiments, the present invention provides a heterobimetallic catalyst having a structure of Formula (12-B):

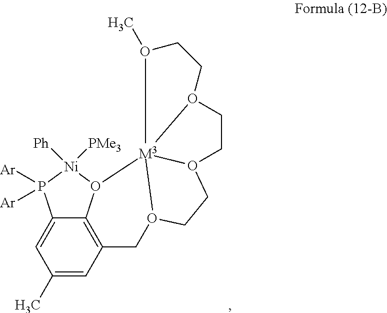

wherein,
Ar is 2,6-dimethoxyphenyl;
Ph is a phenyl group;
M³ is a 2+ cation, 3+ cation, 4+ cation, or 5+ cation; and
PMe₃ is trimethylphosphine.

In some embodiments, the heterobimetallic catalyst of Formula (11-A) is a heterobimetallic catalyst of Formula (11). In some embodiments, the heterobimetallic catalyst of Formula (11-B) is a heterobimetallic catalyst of Formula (11). In some embodiments, the heterobimetallic catalyst of Formula (12-A) is a heterobimetallic catalyst of Formula (12). In some embodiments, the heterobimetallic catalyst of Formula (12-B) is a heterobimetallic catalyst of Formula (12).

In some embodiments, the electron donating group is selected from the group consisting of: alkoxy, amino, hydroxy, and alkyl. In some embodiments, the electron donating group is selected from the group consisting of: alkoxy, phenoxy, amino, alkylamino, dialkylamino, hydroxy, alkyl, and cycloalkyl. In some embodiments, alkyl is selected from the group consisting of: —CH₃, —CH₂CH₃, —CH₂CH₂CH₃, and —CH(CH₃)₂. In some embodiments, the electron withdrawing group is selected from the group consisting of: NO₂, —CN, —C(O)-alkyl, and halo. In some embodiments, the electron withdrawing group is selected from the group consisting of: NO₂, —CN, —C(O)-alkyl, and halo.

In some embodiments, the phenyl group is

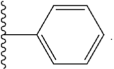 [SMILES: *c1ccccc1]

In some embodiments, L is an optionally substituted phenyl group. In some embodiments, the optionally substituted phenyl group is selected from the group consisting of phenyl, 2-methoxyphenyl, 4-methoxyphenyl, 2-acetylphenyl, or 2-(N-acetylamino)phenyl).

In some embodiments, R¹, R², and R³ are each independently selected from optionally substituted aryl, optionally substituted alkyl, and optionally substituted cycloalkyl. In some embodiments, optionally substituted aryl is selected from the group consisting of phenyl, pentafluorophenyl, 2-methoxyphenyl, 2-methylphenyl, and 4-trifluoromethylphenyl. In some embodiments, optionally substituted alkyl is selected from the group consisting of methyl, ethyl, propyl, isopropyl, or tert-butyl. In some embodiments, optionally substituted cycloalkyl is cyclohexyl or adamantyl.

In some embodiments, M³ is a 2+ cation. In some embodiments, M³ is a 3+ cation. In some embodiments, M³ is a 4+ cation. In some embodiments, M³ is a 5+ cation. In some embodiments, the 2+ cation is Mg²⁺, Ca²⁺, Sr²⁺, Ba²⁺, Fe²⁺, Co²⁺, Ni²⁺, Cu²⁺, Zn²⁺, Ru24, PÅ²⁺. Os²⁺, or Pt²⁺. In some embodiments, the 3+ cation is Sc³⁺, Mn³⁺, Fe³⁺, Co³⁺, Ga³⁺, Y³⁺, Os³⁺, Rh³⁺, Ir³⁺, or La³⁺. In some embodiments, the 4+ cation is Ti⁴⁺, Zr⁴⁺, Hf⁴⁺, or Ce⁴⁺. In some embodiments, the 5+ cation is V⁵⁺, Mn⁵⁺, Nb⁵⁺, or Ta⁵⁺.

### Method for Catalyzing Homopolymerization of an Optionally Substituted Olefin

In various embodiments, the present invention provides a method for catalyzing homopolymerization of an optionally substituted olefin, comprising: combining or contacting an optionally substituted olefin with a heterobimetallic catalyst of Formula (11), Formula (12), Formula (11-A), Formula (12-A), Formula (11-B), or Formula (12-B), or combinations thereof, whereby the optionally substituted olefin undergoes homopolymerization.

In some embodiments, the step of combining or contacting the optionally substituted olefin with the heterobimetallic catalyst is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof.

In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the method for catalyzing homopolymerization further comprises combining or contacting at least one activator with the heterobimetallic catalyst and the optionally substituted olefin. In some embodiments, the at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the optionally substituted olefin is an optionally substituted terminal olefin or an optionally substituted internal olefin. In some embodiments, the optionally substituted olefin is selected from the group consisting of ethylene, an optionally substituted terminal olefin, and an optionally substituted internal olefin. In some embodiments, the optionally substituted terminal olefin is selected from the group consisting of propene, butene, 1-hexene, 1-heptene, 1-octene, styrene, acrylamide, acrylic acid, acrylic ester, vinyl halide, vinyl alcohol, allyl alcohol, and allylbenzene. In some embodiments, the optionally substituted internal olefin is selected from the group consisting of 2-hexene, 3-hexene, 2-heptene, 3-heptene, 2-octene, 3-octene, and 4-octene. In some embodiments, the optionally substituted olefin is ethylene. In some embodiments, the optionally substituted olefin is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene.

In various embodiments, the present invention provides a polymer formed by a method for catalyzing homopolymerization of an optionally substituted olefin as provided herein. In various embodiments, the present invention provides a homopolymer formed by the method for catalyzing homopolymerization of an optionally substituted olefin as provided herein. In some embodiments, the polymer is monomodal or bimodal. In some embodiments the polymer is monomodal. In some embodiments, the polymer is bimodal. In some embodiments, the polymer is monomodal, or bimodal, or combination thereof. In some embodiments, the polymer is a homopolymer. In some embodiments, the homopolymer is monomodal or bimodal. In some embodiments, the homopolymer is monomodal. In some embodiments, the homopolymer is bimodal. In some embodiments, the homopolymer is monomodal, or bimodal, or combination thereof

### Methods for Polymerizing an Optionally Substituted Olefin

In various embodiments, the present invention provides a method for polymerizing an optionally substituted olefin, the method comprising contacting an optionally substituted olefin with a heterobimetallic catalyst of Formula (11), Formula (12), Formula (11-A), Formula (12-A), Formula (11-B), or Formula (12-B), or combinations thereof, and at least one activator under conditions effective to polymerize the optionally substituted olefin.

In some embodiments, the at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the step of contacting the optionally substituted olefin with the heterobimetallic catalyst and the at least one activator is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof. In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from tetrahydrofuran, diethyl ether, dichloromethane, chloroform, N,N-dimethylforamide, dimethylsulfoxide, ethyl acetate, acetone, and water, and any combinations thereof.

In some embodiments, the optionally substituted olefin is an optionally substituted terminal olefin or an optionally substituted internal olefin. In some embodiments, the optionally substituted olefin is selected from the group consisting of ethylene, an optionally substituted terminal olefin, and an optionally substituted internal olefin. In some embodiments, the optionally substituted terminal olefin is selected from the group consisting of propene, butene, 1-hexene, 1-heptene, 1-octene, styrene, acrylamide, acrylic acid, acrylic ester, vinyl halide, vinyl alcohol, allyl alcohol, and allylbenzene. In some embodiments, the optionally substituted internal olefin is selected from the group consisting of 2-hexene, 3-hexene, 2-heptene, 3-heptene, 2-octene, 3-octene, and 4-octene. In some embodiments, the optionally substituted olefin is ethylene. In some embodiments, the optionally substituted olefin is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene.

In various embodiments, the present invention provides a polymer formed by a method for polymerizing an optionally substituted olefin as provided herein. In some embodiments, the polymer is monomodal or bimodal. In some embodiments, the polymer is monomodal. In some embodiments, the polymer is bimodal. In some embodiments, the polymer is monomodal, bimodal, or combination thereof.

### Methods for Catalyzing Copolymerization of a First Olefin and at Least One Other Olefin

In various embodiments, the present invention provides a method for catalyzing copolymerization of a first olefin and at least one other olefin, comprising: combining or contacting a first olefin and at least one other olefin with a heterobimetallic catalyst of Formula (11), Formula (12), Formula (11-A), Formula (12-A), Formula (11-B), or Formula (12-B), or combinations thereof, whereby the first olefin and the at least one other olefin undergoes copolymerization, and wherein the first olefin and the at least one other olefin are different from one another.

In some embodiments, the first olefin and the at least one other olefin are different from one another. In some embodiments, the at least one other olefin is at least one second olefin. In some embodiments, the first olefin and the at least one second olefin are different from one another.

In some embodiments, the step of combining or contacting the first olefin and the at least one other olefin with the heterobimetallic catalyst is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof. In some embodiments, the first olefin is selected from the group consisting of ethylene, propene, and styrene. In some embodiments the at least one other olefin is selected from the group consisting of 1-hexene, 1-octene, allyl benzene, acrylamide, acrylic acid, acrylic ester, vinyl halide, vinyl alcohol, and allyl alcohol.

In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the method for catalyzing copolymerization of a first olefin and at least one other olefin further comprises combining or contacting at least one activator with the heterobimetallic catalyst, the first olefin, and the at least one other olefin. In some embodiments, the at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the first olefin and the at least one other olefin are each independently an optionally substituted olefin. In some embodiments, the optionally substituted olefin is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene.

In some embodiments, the first olefin and the at least one other olefin are each independently an optionally substituted terminal olefin or an optionally substituted internal olefin. In some embodiments, the first olefin and the at least one other olefin are each independently ethylene, an optionally substituted terminal olefin, or an optionally substituted internal olefin. In some embodiments, the optionally substituted terminal olefin is selected from the group consisting of propene, butene, 1-hexene, 1-heptene, 1-octene, styrene, acrylamide, acrylic acid, acrylic ester, vinyl halide, vinyl alcohol, allyl alcohol, and allylbenzene. In some embodiments, the optionally substituted internal olefin is selected from the group consisting of 2-hexene, 3-hexene, 2-heptene, 3-heptene, 2-octene, 3-octene, and 4-octene. In some embodiments, the first olefin is ethylene.

In various embodiments, the present invention provides a polymer formed by a method for catalyzing copolymerization of a first olefin and at least one other olefin as provided herein. In some embodiments, the polymer is a copolymer. In some embodiments, the copolymer is selected from the group consisting of a random copolymer, block copolymer, and gradient copolymer. In some embodiments, the copolymer is a random copolymer. In some embodiments, the copolymer is a block copolymer. In some embodiments, the copolymer is a gradient copolymer.

In some embodiments, the polymer is monomodal or bimodal. In some embodiments, the polymer is monomodal. In some embodiments, the polymer is bimodal. In some embodiments, the polymer is monomodal, bimodal, or combination thereof. In some embodiments, the copolymer is monomodal or bimodal. In some embodiments, the copolymer is monomodal. In some embodiments, the copolymer is bimodal. In some embodiments, the copolymer is monomodal, or bimodal, or combination thereof.

### Methods for Copolymerizing a First Olefin and at Least One Other Olefin

In various embodiments, the present invention provides a method for copolymerizing a first olefin and at least one other olefin, the method comprising contacting the first olefin and the at least one other olefin with a heterobimetallic catalyst of Formula (11), Formula (12), Formula (11-A), Formula (12-A), Formula (11-B), or Formula (12-B), or combinations thereof, and at least one activator under conditions effective to copolymerize the first olefin and the at least one other olefin, wherein the first olefin and the at least one other olefin are different from one another.

In some embodiments, the first olefin and the at least one other olefin are different from one another. In some embodiments, the at least one other olefin is at least one second olefin. In some embodiments, the first olefin and the at least one second olefin are different from one another.

In some embodiments, the at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the step of contacting the first olefin and the at least one other olefin with the heterobimetallic catalyst and the at least one activator is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof.

In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the first olefin and the at least one other olefin are each independently an optionally substituted olefin. In some embodiments, the optionally substituted olefin is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene. In some embodiments, the first olefin and the at least one other olefin are each independently an optionally substituted terminal olefin or an optionally substituted internal olefin. In some embodiments, the first olefin and the at least one other olefin are each independently ethylene, an optionally substituted terminal olefin, or an optionally substituted internal olefin. In some embodiments, the first olefin is ethylene.

In various embodiments, the present invention provides a polymer formed by a method for copolymerizing a first olefin and at least one other olefin as provided herein. In various embodiments, the present invention provides a polymer formed by the method for copolymerizing a first olefin and at least one other olefin as provided herein. In some embodiments, the polymer is a copolymer. In some embodiments, the copolymer is selected from the group consisting of a random copolymer, block copolymer, and gradient copolymer. In some embodiments, the copolymer is a random copolymer. In some embodiments, the copolymer is a block copolymer. In some embodiments, the copolymer is a gradient copolymer.

In some embodiments, the polymer is monomodal or bimodal. In some embodiments, the polymer is monomodal. In some embodiments, the polymer is bimodal. In some embodiments, the polymer is monomodal, or bimodal, or combination thereof. In some embodiments, the copolymer is monomodal or bimodal. In some embodiments, the copolymer is monomodal. In some embodiments, the copolymer is bimodal. In some embodiments, the copolymer is monomodal, or bimodal, or combination thereof.

### Methods for Making a Compound

In various embodiments, the present invention provides a method for making a compound, the method comprising contacting a reactant with a heterobimetallic catalyst of Formula (11), Formula (12), Formula (11-A), Formula (12-A), Formula (11-B), or Formula (12-B), or combinations thereof under conditions effective to make the compound.

In some embodiments the reactant is methylaluminoxane, trialkylaluminium, alkyllithium, alkyl magnesium halide, or dialklylzinc.

In some embodiments, the step of contacting the reactant with the heterobimetallic catalyst is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof.

In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the method for making a compound further comprises contacting at least one activator with the heterobimetallic catalyst and the reactant. In some embodiments, the at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the compound is a small molecule. In some embodiments, the method for making a compound is a cascade method.

### Methods for Making a Compound

In various embodiments, the present invention provides a method for making a compound, the method comprising contacting a first reactant and at least one other reactant with a heterobimetallic catalyst of Formula (11), Formula (12), Formula (11-A), Formula (12-A), Formula (11-B), or Formula (12-B), or combinations thereof under conditions effective to make the compound.

In some embodiments, the step of contacting the first reactant and the at least one other reactant with the heterobimetallic catalyst is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof.

In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the method for making a compound further comprises contacting at least one activator with the catalyst, the first reactant, and the at least one other reactant. In some embodiments, the at least one activator is Ni(COD), or triarylborane. In some embodiments, the at least one activator is selected from the group consisting of Ni(COD)₂, triarylborane, methylaluminoxane, and trialkylaluminum.

In some embodiments, the compound is a small molecule. In some embodiments, the method for making a compound is a cascade method. In some embodiments, the first reactant and the at least one other reactant are different from one another.

### Methods of Making a Polymer

In various embodiments, the present invention provides a method of making a polymer, comprising contacting a monomer with a heterobimetallic catalyst of Formula (11), Formula (12), Formula (11-A), Formula (12-A), Formula (11-B), or Formula (12-B), or combinations thereof.

In some embodiments, the monomer is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene.

In some embodiments, the step of contacting the monomer with the heterobimetallic catalyst is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof.

In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the method of making a polymer further comprises contacting at least one activator with the heterobimetallic catalyst and the monomer. In some embodiments, the at least one activator is selected from the group consisting of Ni(COD)₂, triarylborane, methylaluminoxane, and trialkylaluminum.

In some embodiments, the monomer is an optionally substituted olefin. In some embodiments, the optionally substituted olefin is selected from the group consisting of ethylene, propene, butene, 1-hexene, 1-heptene, 1-octene, styrene, acrylamide, acrylic acid, acrylic ester, 2-octene, 3-octene, and 4-octene.

In some embodiments, the monomer is an optionally substituted terminal olefin or an optionally substituted internal olefin. In some embodiments, the monomer is selected from the group consisting of ethylene, an optionally substituted terminal olefin, and an optionally substituted internal olefin. In some embodiments, the monomer is ethylene.

In various embodiments, the present invention provides a polymer made by a method of making a polymer as provided herein. In some embodiments, the polymer is bimodal or monomodal. In some embodiments, the polymer is monomodal. In some embodiments, the polymer is bimodal. In some embodiments, the polymer is monomodal, bimodal, or combination thereof.

### Method of Making a Copolymer

In various embodiments, the present invention provides a method of making a copolymer, comprising contacting a first monomer and at least one other monomer with a heterobimetallic catalyst of Formula (11), Formula (12), Formula (11-A), Formula (12-A), Formula (11-B), or Formula (12-B), or combinations thereof, wherein the first monomer and the at least one other monomer are different from one another.

In some embodiments, the first monomer and the at least one other monomer are different from one another. In some embodiments, the at least one other monomer is at least one second monomer. In some embodiments, the first monomer and the at least one second monomer are different from one another.

In various embodiments, the step of contacting the first monomer and the at least one other monomer with the heterobimetallic catalyst is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof.

In various embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In various embodiments, the method of making a copolymer further comprises contacting at least one activator with the heterobimetallic catalyst, the first monomer, and the at least one other monomer. In some embodiments, the first monomer is ethylene, propene, 1-butene, 1-hexene, 1-octene, styrene, or allyl benzene. In some embodiments, the at least one other monomer is acrylamide, acrylic acid, acrylic ester, vinyl halide, vinyl alcohol, or allyl alcohol.

In some embodiments, the at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the first monomer and the at least one other monomer are each independently an optionally substituted olefin. In some embodiments, the optionally substituted olefin is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene.

In some embodiments, the first monomer and the at least one other monomer are each independently an optionally substituted terminal olefin or an optionally substituted internal olefin. In some embodiments, the first monomer and the at least one other monomer are each independently ethylene, an optionally substituted terminal olefin, or an optionally substituted internal olefin. In some embodiments, the optionally substituted terminal olefin is selected from the group consisting of propene, butene, 1-hexene, 1-heptene, 1-octene, styrene, acrylamide, acrylic acid, acrylic ester, vinyl halide, vinyl alcohol, allyl alcohol, and allylbenzene. In some embodiments, the optionally substituted internal olefin is selected from the group consisting of 2-hexene, 3-hexene, 2-heptene, 3-heptene, 2-octene, 3-octene, and 4-octene. In some embodiments, the first monomer is ethylene. In various embodiments, the present invention provides a polymer formed by the method for catalyzing copolymerization of a first monomer and at least one other monomer. In some embodiments, the polymer is a copolymer. In some embodiments, the copolymer is selected from the group consisting of a random copolymer, block copolymer, and gradient copolymer. In some embodiments, the copolymer is a random copolymer. In some embodiments, the copolymer is a block copolymer. In some embodiments, the copolymer is a gradient copolymer.

In various embodiments, the present invention provides a copolymer made by a method of making a copolymer as provided herein. In various embodiments, the present invention provides a polymer made by a method of making a copolymer as provided herein. In some embodiments, the polymer is a copolymer. In some embodiments, the copolymer is selected from the group consisting of a random copolymer, block copolymer, and gradient copolymer. In some embodiments, the polymer is monomodal or bimodal. In some embodiments, the polymer is monomodal. In some embodiments, the polymer is bimodal. In some embodiments, the polymer is monomodal, or bimodal, or combination thereof. In some embodiments, the copolymer is monomodal or bimodal. In some embodiments, the copolymer is monomodal. In some embodiments, the copolymer is bimodal. In some embodiments, the copolymer is monomodal, bimodal, or combination thereof. In some embodiments, the first monomer is CO₂; and the at least one other monomer is an epoxide.

### Bimetallic Catalyst Complex of Formula (13), Formula (14), Formula (13-A), Formula (14-A), Formula (13-B), Formula (14-B).

In various embodiments, the present invention provides a bimetallic catalyst complex having a structure selected from Formula (13) and Formula (14):

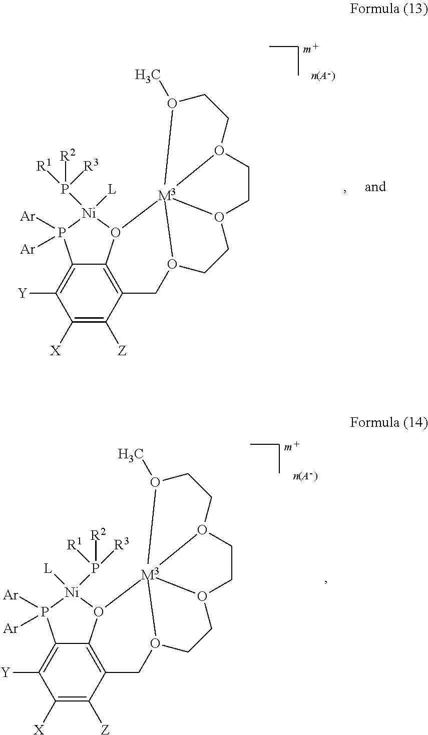

wherein in Formula (13) and Formula (14):
m is 2, 3, 4, or 5;
n is 1, 2, 3, 4, or 5;
Ar is 2,6-dimethoxyphenyl;
L is an optionally substituted phenyl group;
M³ is a 2+ cation, 3+ cation, 4+ cation, or 5+ cation;
A⁻ is a weakly coordinating anion;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl.

In various embodiments, the present invention provides a bimetallic catalyst complex having a structure of Formula (13):

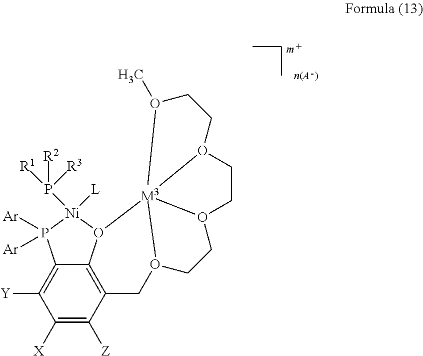

wherein,
m is 2, 3, 4, or 5;
n is 1, 2, 3, 4, or 5;
Ar is 2,6-dimethoxyphenyl;
L is an optionally substituted phenyl group;
M³ is a 2+ cation, 3+ cation, 4+ cation, or 5+ cation;
A⁻ is a weakly coordinating anion;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl.

In various embodiments, the present invention provides a bimetallic catalyst complex having a structure of Formula (14):

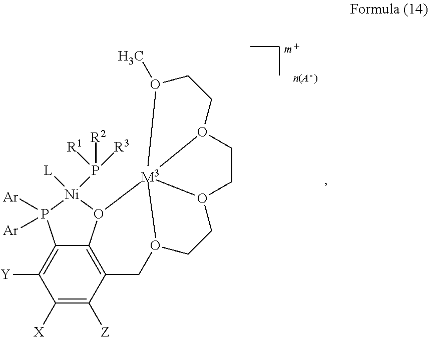

wherein,
m is 2, 3, 4, or 5;
n is 1, 2, 3, 4, or 5;
Ar is 2,6-dimethoxyphenyl;
L is an optionally substituted phenyl group;
M³ is a 2+ cation, 3+ cation, 4+ cation, or 5+ cation;
A⁻ is a weakly coordinating anion;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl.

In various embodiments, the present invention provides a bimetallic catalyst complex having a structure selected from Formula (13-A) and Formula (14-A):

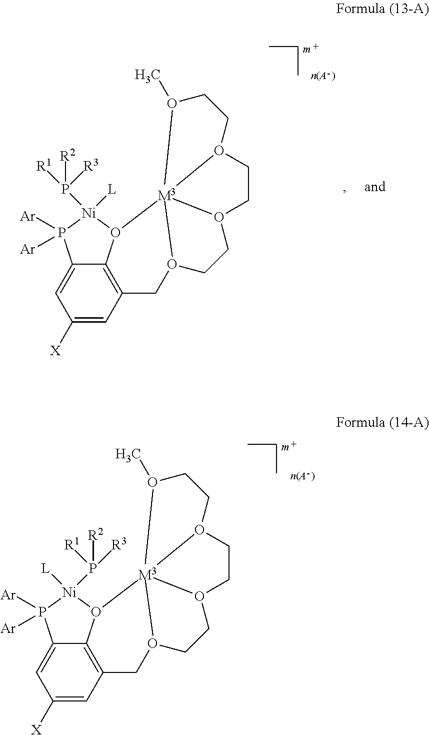

wherein Formula (13-A) and Formula (14-A):
m is 2, 3, 4, or 5;
n is 1, 2, 3, 4, or 5;
Ar is 2,6-dimethoxyphenyl;
Ph is a phenyl group;
M³ is a 2+ cation, 3+ cation, 4+ cation, or 5+ cation;
A⁻ is a weakly coordinating anion;
X is hydrogen, an electron donating group, or an electron withdrawing group; and
R¹, R², and R³ are each independently selected from optionally substituted aryl, optionally substituted alkyl, and optionally substituted cycloalkyl.

In various embodiments, the present invention provides a bimetallic catalyst complex having a structure of Formula (13-A):

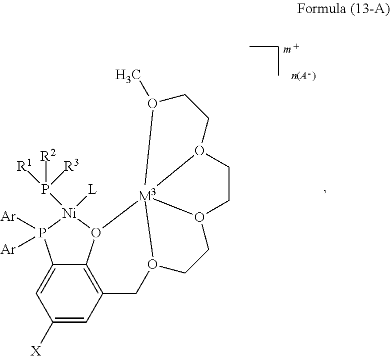

wherein,
m is 2, 3, 4, or 5;
n is 1, 2, 3, 4, or 5;
Ar is 2,6-dimethoxyphenyl;
Ph is a phenyl group;
M³ is a 2+ cation, 3+ cation, 4+ cation, or 5+ cation,
A⁻ is a weakly coordinating anion;
X is hydrogen, an electron donating group, or an electron withdrawing group; and
R¹, R², and R³ are each independently selected from optionally substituted aryl, optionally substituted alkyl, and optionally substituted cycloalkyl.

In various embodiments, the present invention provides a bimetallic catalyst complex having a structure of Formula (14-A):

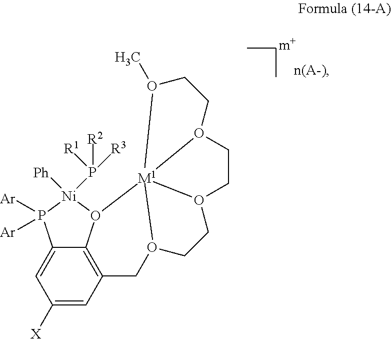

wherein,
m is 2, 3, 4, or 5;
n is 1, 2, 3, 4, or 5;
Ar is 2,6-dimethoxyphenyl;
Ph is a phenyl group;
M³ is a 2+ cation, 3+ cation, 4+ cation, or 5+ cation;
A⁻ is a weakly coordinating anion;
X is hydrogen, an electron donating group, or an electron withdrawing group; and
R¹, R², and R³ are each independently selected from optionally substituted aryl, optionally substituted alkyl, and optionally substituted cycloalkyl.

In various embodiments, the present invention provides a bimetallic catalyst complex having a structure selected from Formula (13-B) and Formula (14-B):

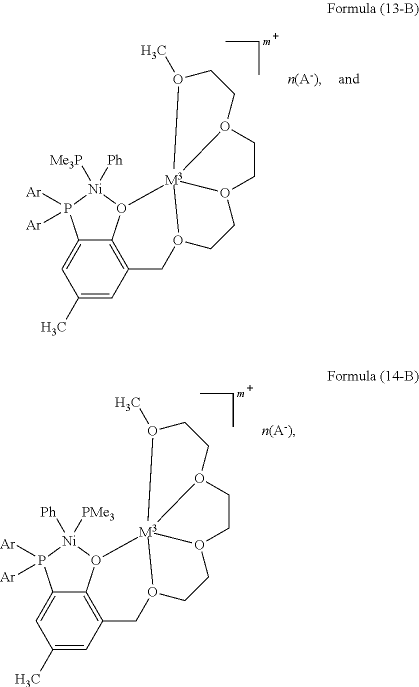

wherein Formula (13-B) and Formula (14-B):
m is 2, 3, 4, or 5;
n is 1, 2, 3, 4, or 5;
Ar is 2,6-dimethoxyphenyl;
Ph is a phenyl group;
M³ is a 2+ cation, 3+ cation, 4+ cation, or 5+ cation;
A⁻ is [(3,5-(CF₃)₂C₆H₃)₄B]⁻; and
PMe₃ is trimethylphosphine.

In various embodiments, the present invention provides a bimetallic catalyst complex having a structure of Formula (13-B) is:

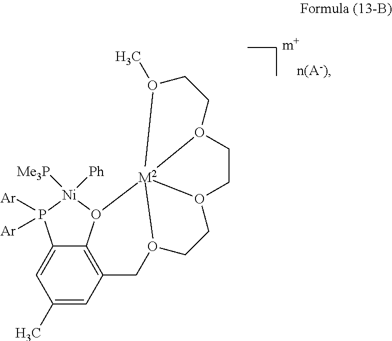

wherein
m is 2, 3, 4, or 5;
n is 1, 2, 3, 4, or 5;
Ar is 2,6-dimethoxyphenyl;
Ph is a phenyl group;
M³ is a 2+ cation, 3+ cation, 4+ cation, or 5+ cation,
A⁻ is [(3,5-(CF₃)₂C₆H₃)₄B]⁻; and
PMe₃ is trimethylphosphine.

In various embodiments, the present invention provides a bimetallic catalyst complex having a structure of Formula (14-B):

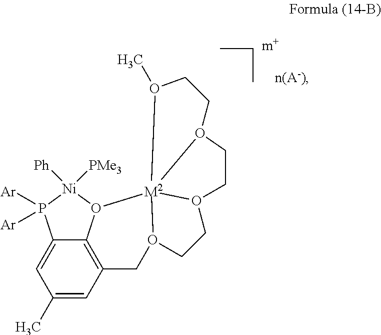

wherein
m is 2, 3, 4, or 5;
n is 1, 2, 3, 4, or 5;
Ar is 2,6-dimethoxyphenyl;
Ph is a phenyl group;
M³ is a 2+ cation, 3+ cation, 4+ cation, or 5+ cation;
A⁻ is [(3,5-(CF₃)₂C₆H₃)₄B]⁻; and
PMe₃ is trimethylphosphine.

In some embodiments, the bimetallic catalyst complex of Formula (13-A) is a bimetallic catalyst complex of Formula (13). In some embodiments, the bimetallic catalyst complex of Formula (13-B) is a bimetallic catalyst complex of Formula (13). In some embodiments, the bimetallic catalyst complex of Formula (14-A) is a bimetallic catalyst complex of Formula (14). In some embodiments, the bimetallic catalyst complex of Formula (14-B) is a bimetallic catalyst complex of Formula (14).

In some embodiments, in the bimetallic catalyst complex of Formula (13) and Formula (14), m is 2, 3, 4, or 5; n is 2, 3, 4, or 5; Ar is 2,6-dimethoxyphenyl; L is a phenyl group; M³ is a 2+ cation, 3+ cation, 4+ cation, or 5+ cation; A⁻ is [(3,5-(CF₃)₂C₆H₃)₄B]⁻; X is methyl; Y is hydrogen; Z is hydrogen; and R¹, R², and R³ are each methyl.

In some embodiments, A⁻ is a weakly coordinating anion. In some embodiments, the weakly coordinating anion is selected from the group consisting of tetrakis(3,5-bis(trifluoromethyl)phenylborate, tetrakis(pentafluorophenyl)borate, tetraphenylborate, trifluoromethylsulfonate, hexafluorophosphate, hexafluoroantimonate, and tetrafluoroborate. In some embodiments, tetrakis(3,5-bis(trifluoromethyl)phenylborate is represented as [(3,5-(CF₃)₂C₆H₃)₄B]⁻. In some embodiments, tetrakis(3,5-bis(trifluoromethyl)phenylborate is represented as BAr^{F}₄⁻.

In some embodiments, the electron donating group is selected from the group consisting of: alkoxy, amino, hydroxy, and alkyl. In some embodiments, the electron donating group is selected from the group consisting of: alkoxy, phenoxy, amino, alkylamino, dialkylamino, hydroxy, alkyl, and cycloalkyl. In some embodiments, alkyl is selected from the group consisting of: —CH₃, —CH₂CH₃, —CH₂CH₂CH₃, and ˜CH(CH₃)₂. In some embodiments, the electron withdrawing group is selected from the group consisting of: NO₂, —CN, —C(O)-alkyl, and halo. In some embodiments, the electron withdrawing group is selected from the group consisting of: NO₂, —CN, —C(O)-alkyl, C(O)Oalkyl, C(O)Nalkyl, —SO₃H, —SO₂R, —PO₃H, —PO₃R, —CF₃, and halo. In some embodiments, the electron withdrawing group is selected from the group consisting of: NO₂, —CN, —C(O)-alkyl, C(O)Oalkyl, C(O)Nalkyl, —SO₃H, —SO₂alkyl, —PO₃H, —PO₃alkyl, —CF₃, and halo.

In some embodiments, the phenyl group is

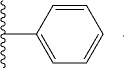 [SMILES: *c1ccccc1]

In some embodiments, M³ is a 2+ cation. In some embodiments, M³ is a 3+ cation. In some embodiments, M³ is a 4+ cation. In some embodiments, M³ is a 5+ cation. In some embodiments, M³ is a 2+ cation. In some embodiments, M³ is a 3+ cation. In some embodiments, M³ is a 4+ cation. In some embodiments, M³ is a 5+ cation. In some embodiments, the 2+ cation is Mg²⁺, Ca²⁺, Sr²⁺, Ba²⁺, Fe²⁺, Co²⁺, Ni²⁺, Cu²⁺, Zn²⁺, Ru²⁺, Pd²⁺, Os²⁺, or Pt²⁺. In some embodiments, the 3+ cation is Sc³⁺, Mn³⁺, Fe³⁺, Co³⁺, Ga³⁺, Y³⁺, Os³⁺, Rh³⁺, Ir³⁺, or La³⁺. In some embodiments, the 4+ cation is Ti⁴⁺, Zr⁴⁺, Hf⁴⁺, or Ce⁴⁺. In some embodiments, the 5+ cation is V⁵⁺, Mn⁵⁺, Nb⁵⁺, or Ta⁵⁺.

In some embodiments, L is an optionally substituted phenyl group. In some embodiments, the optionally substituted phenyl group is selected from the group consisting of phenyl, 2-methoxyphenyl, 4-methoxyphenyl, 2-acetylphenyl, or 2-(N-acetylamino)phenyl). In some embodiments, L is a phenyl group.

In some embodiments, R¹, R², and R³ are each independently selected from optionally substituted aryl, optionally substituted alkyl, and optionally substituted cycloalkyl. In some embodiments, optionally substituted aryl is selected from the group consisting of phenyl, pentafluorophenyl, 2-methoxyphenyl, 2-methylphenyl, and 4-trifluoromethylphenyl. In some embodiments, optionally substituted alkyl is selected from the group consisting of methyl, ethyl, propyl, isopropyl, or tert-butyl. In some embodiments, optionally substituted cycloalkyl is cyclohexyl or adamantyl.

### Methods for Catalyzing Homopolymerization of an Optionally Substituted Olefin

In various embodiments, the present invention provides a method for catalyzing homopolymerization of an optionally substituted olefin, comprising: combining or contacting an optionally substituted olefin with a bimetallic catalyst complex of Formula (13), Formula (14), Formula (13-A), Formula (14-A), Formula (13-B), or Formula (14-B), or combinations thereof, whereby the optionally substituted olefin undergoes homopolymerization.

In some embodiments, the step of combining or contacting the optionally substituted olefin with the bimetallic catalyst complex is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof. In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the method for catalyzing homopolymerization of an optionally substituted olefin further comprises combining or contacting at least one activator with the bimetallic catalyst complex and the optionally substituted olefin.

In some embodiments, the at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the optionally substituted olefin is an optionally substituted terminal olefin or an optionally substituted internal olefin. In some embodiments, the optionally substituted olefin is selected from the group consisting of ethylene, an optionally substituted terminal olefin, and an optionally substituted internal olefin. In some embodiments, the optionally substituted terminal olefin is selected from the group consisting of propene, butene, 1-hexene, 1-heptene, 1-octene, styrene, acrylamide, acrylic acid, acrylic ester, vinyl halide, vinyl alcohol, allyl alcohol, and allylbenzene. In some embodiments, the optionally substituted internal olefin is selected from the group consisting of 2-hexene, 3-hexene, 2-heptene, 3-heptene, 2-octene, 3-octene, and 4-octene. In some embodiments, the optionally substituted olefin is ethylene. In some embodiments, the optionally substituted olefin is selected from the group consisting of ethylene, propene, butene, 1-hexene, 1-heptene, 1-octene, styrene, acrylamide, acrylic acid, acrylic ester, 2-octene, 3-octene, and 4-octene.

In various embodiments, the present invention provides a polymer formed by a method for catalyzing homopolymerization of an optionally substituted olefin as provided herein. In various embodiments, the present invention provides a homopolymer formed by the method for catalyzing homopolymerization of an optionally substituted olefin as provided herein. In some embodiments, the polymer is monomodal or bimodal. In some embodiments, the polymer is monomodal. In some embodiments, the polymer is bimodal. In some embodiments, the polymer is monomodal, or bimodal, or combination thereof. In some embodiments, the polymer is a homopolymer. In some embodiments, the homopolymer is monomodal or bimodal. In some embodiments, the homopolymer is monomodal. In some embodiments, the homopolymer is bimodal. In some embodiments, the homopolymer is monomodal, or bimodal, or combination thereof.

### Method for Polymerizing an Optionally Substituted Olefin

In various embodiments, the present invention provides a method for polymerizing an optionally substituted olefin, the method comprising contacting an optionally substituted olefin with a bimetallic catalyst complex of Formula (13), Formula (14), Formula (13-A), Formula (14-A), Formula (13-B), or Formula (14-B), or combinations thereof, and at least one activator under conditions effective to polymerize the optionally substituted olefin.

In some embodiments, the at least one activator is Ni(COD)₂ or triarylborane. In some embodiments, the at least one activator is selected from the group consisting of Ni(COD)₂, triarylborane, methylaluminoxane, and trialkylaluminum

In some embodiments, the step of contacting the optionally substituted olefin with the bimetallic catalyst complex and the at least one activator is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof.

In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from tetrahydrofuran, diethyl ether, dichloromethane, chloroform, N,N-dimethylforamide, dimethylsulfoxide, ethyl acetate, acetone, and water, and any combinations thereof.

In some embodiments, the optionally substituted olefin is an optionally substituted terminal olefin or an optionally substituted internal olefin. In some embodiments, the optionally substituted olefin is selected from the group consisting of ethylene, an optionally substituted terminal olefin, and an optionally substituted internal olefin. In some embodiments, the optionally substituted terminal olefin is selected from the group consisting of propene, butene, 1-hexene, 1-heptene, 1-octene, styrene, acrylamide, acrylic acid, acrylic ester, vinyl halide, vinyl alcohol, allyl alcohol, and allylbenzene. In some embodiments, the optionally substituted internal olefin is selected from the group consisting of 2-hexene, 3-hexene, 2-heptene, 3-heptene, 2-octene, 3-octene, and 4-octene. In some embodiments, the optionally substituted olefin is ethylene. In some embodiments, the optionally substituted olefin is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene.

In various embodiments, the present invention provides a polymer formed by a method for polymerizing an optionally substituted olefin as provided herein. In some embodiments, the polymer is monomodal or bimodal. In some embodiments, the polymer is monomodal. In some embodiments, the polymer is bimodal. In some embodiments, the polymer is monomodal, or bimodal, or combination thereof.

### Methods for Catalyzing Copolymerization of a First Olefin and at Least One Other Olefin

In various embodiments, the present invention provides a method for catalyzing copolymerization of a first olefin and at least one other olefin, comprising: combining or contacting a first olefin and at least one other olefin with a bimetallic catalyst complex of Formula (13), Formula (14), Formula (13-A), Formula (14-A), Formula (13-B), or Formula (14-B), or combinations thereof, whereby the first olefin and the at least one other olefin undergoes copolymerization, and wherein the first olefin and the at least one other olefin are different from one another.

In some embodiments, the first olefin and the at least one other olefin are different from one another. In some embodiments, the at least one other olefin is at least one second olefin. In some embodiments, the first olefin and the at least one second olefin are different from one another.

In some embodiments, the step of combining or contacting the first olefin and the at least one other olefin with the bimetallic catalyst complex is performed in the presence of at least one solvent.

In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof. In some embodiments, the first olefin is selected from the group consisting of ethylene, propene, and styrene. In some embodiments the at least one other olefin is selected from the group consisting of 1-hexene, 1-octene, allyl benzene, acrylamide, acrylic acid, acrylic ester, vinyl halide, vinyl alcohol, and allyl alcohol.

In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the method for catalyzing copolymerization of a first olefin and at least one other olefin further comprises combining or contacting at least one activator with the bimetallic catalyst complex, the first olefin, and the at least one other olefin. In some embodiments, the at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the first olefin and the at least one other olefin are each independently an optionally substituted olefin. In some embodiments, the optionally substituted olefin is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene.

In some embodiments, the first olefin and the at least one other olefin are each independently an optionally substituted terminal olefin or an optionally substituted internal olefin. In some embodiments, the first olefin and the at least one other olefin are each independently ethylene, an optionally substituted terminal olefin, or an optionally substituted internal olefin. In some embodiments, the optionally substituted terminal olefin is selected from the group consisting of propene, butene, 1-hexene, 1-heptene, 1-octene, styrene, acrylamide, acrylic acid, acrylic ester, vinyl halide, vinyl alcohol, allyl alcohol, and allylbenzene. In some embodiments, the optionally substituted internal olefin is selected from the group consisting of 2-hexene, 3-hexene, 2-heptene, 3-heptene, 2-octene, 3-octene, and 4-octene. In some embodiments, the first olefin is ethylene.

In various embodiments, the present invention provides a polymer formed by a method for catalyzing copolymerization of a first olefin and at least one other olefin as provided herein. In some embodiments, the polymer is a copolymer. In some embodiments, the copolymer is selected from the group consisting of a random copolymer, block copolymer, and gradient copolymer. In some embodiments, the copolymer is a random copolymer. In some embodiments, the copolymer is a block copolymer. In some embodiments, the copolymer is a gradient copolymer. In some embodiments, the copolymer is monomodal or bimodal. In some embodiments, the copolymer is monomodal. In some embodiments, the copolymer is bimodal. In some embodiments, the copolymer is monomodal, or bimodal, or combination thereof. In some embodiments, the copolymer is monomodal or bimodal. In some embodiments, the copolymer is monomodal. In some embodiments, the copolymer is bimodal. In some embodiments, the copolymer is monomodal, or bimodal, or combination thereof.

### Methods for Copolymerizing a First Olefin and at Least One Other Olefin

In various embodiments, the present invention provides a method for copolymerizing a first olefin and at least one other olefin, the method comprising contacting the first olefin and the at least one other olefin with a bimetallic catalyst complex of Formula (13), Formula (14), Formula (13-A), Formula (14-A), Formula (13-B), or Formula (14-B), or combinations thereof, and at least one activator under conditions effective to copolymerize the first olefin and the at least one other olefin, wherein the first olefin and the at least one other olefin are different from one another.

In some embodiments, the first olefin and the at least one other olefin are different from one another. In some embodiments, the at least one other olefin is at least one second olefin. In some embodiments, the first olefin and the at least one second olefin are different from one another.

In some embodiments, the at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the step of contacting the first olefin and the at least one other olefin with the bimetallic catalyst complex and the at least one activator is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof.

In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the first olefin and the at least one other olefin are each independently an optionally substituted olefin. In some embodiments, the optionally substituted olefin is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene.

In some embodiments, the first olefin and the at least one other olefin are each independently an optionally substituted terminal olefin or an optionally substituted internal olefin. In some embodiments, the first olefin and the at least one other olefin are each independently ethylene, an optionally substituted terminal olefin, or an optionally substituted internal olefin. In some embodiments, the first olefin is ethylene.

In various embodiments, the present invention provides a polymer formed by a method for copolymerizing a first olefin and at least one other olefin as provided herein. In various embodiments, the present invention provides a polymer formed by the method for copolymerizing a first olefin and at least one other olefin as provided herein. In some embodiments, the polymer is a copolymer. In some embodiments, the copolymer is selected from the group consisting of a random copolymer, block copolymer, and gradient copolymer. In some embodiments, the copolymer is a random copolymer. In some embodiments, the copolymer is a block copolymer. In some embodiments, the copolymer is a gradient copolymer. In some embodiments, the copolymer is monomodal or bimodal. In some embodiments, the copolymer is monomodal. In some embodiments, the copolymer is bimodal. In some embodiments, the copolymer is monomodal, or bimodal, or combination thereof. In some embodiments, the copolymer is monomodal or bimodal. In some embodiments, the copolymer is monomodal. In some embodiments, the copolymer is bimodal. In some embodiments, the copolymer is monomodal, or bimodal, or combination thereof.

### Methods for Making a Compound

In various embodiments, the present invention provides a method for making a compound, the method comprising contacting a reactant with a bimetallic catalyst complex of Formula (13), Formula (14), Formula (13-A), Formula (14-A), Formula (13-B), or Formula (14-B), or combinations thereof under conditions effective to make the compound.

In some embodiments the reactant is methylaluminoxane, trialkylaluminium, alkyllithium, alkyl magnesium halide, or dialklylzinc.

In some embodiments, the step of contacting the reactant with the bimetallic catalyst complex is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof.

In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the method of making a compound further comprises contacting at least one activator with the bimetallic catalyst complex and the reactant. In some embodiments, the at least one activator is Ni(COD)₂. In some embodiments, the at least one activator is selected from the group consisting of Ni(COD)₂, triarylborane, methylaluminoxane, and trialkylaluminum.

In some embodiments, the compound is a small molecule. In some embodiments, the method for making a compound is a cascade method.

### Methods for Making a Compound

In various embodiments, the present invention provides a method for making a compound, the method comprising contacting a first reactant and at least one other reactant with a bimetallic catalyst complex of Formula (13), Formula (14), Formula (13-A), Formula (14-A), Formula (13-B), or Formula (14-B), or combinations thereof under conditions effective to make the compound.

In some embodiments, the step of contacting the first reactant and the at least one other reactant with the bimetallic catalyst complex is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof.

In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the method for making a compound further comprises contacting at least one activator with the bimetallic catalyst complex, the first reactant, and the at least one other reactant. In some embodiments, the at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the compound is a small molecule. In some embodiments, the method for making a compound is a cascade method. In some embodiments, the first reactant and the at least one other reactant are different from one another.

### Method of Making a Polymer

In various embodiments, the present invention provides a method of making a polymer, comprising contacting a monomer with a bimetallic catalyst complex of Formula (13), Formula (14), Formula (13-A), Formula (14-A), Formula (13-B), or Formula (14-B), or combinations thereof.

In some embodiments, the monomer is selected from the group consisting of ethylene, propene, butene, 1-hexene, 1-heptene, 1-octene, styrene, acrylamide, acrylic acid, acrylic ester, 2-octene, 3-octene, and 4-octene.

In some embodiments, the step of contacting the monomer with the bimetallic catalyst complex is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof.

In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the further comprising contacting at least one activator with the bimetallic catalyst complex and the monomer.

In some embodiments, the at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the monomer is an optionally substituted olefin. In some embodiments, the optionally substituted olefin is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene.

In some embodiments, the monomer is an optionally substituted terminal olefin or an optionally substituted internal olefin. In some embodiments, the monomer is selected from the group consisting of ethylene, an optionally substituted terminal olefin, and an optionally substituted internal olefin. In some embodiments, the monomer is ethylene.

In various embodiments, the present invention provides a polymer made by a method of making a polymer as provided herein. In some embodiments, the polymer is bimodal or monomodal. In some embodiments, the polymer is bimodal. In some embodiments, the polymer is monomodal. In some embodiments, the polymer is monomodal, or bimodal, or combination thereof.

### Methods of Making a Copolymer

In various embodiments, the present invention provides a method of making a copolymer, comprising contacting a first monomer and at least one other monomer with a bimetallic catalyst complex of Formula (13), Formula (14), Formula (13-A), Formula (14-A), Formula (13-B), or Formula (14-B), or combinations thereof, wherein the first monomer and the at least one other monomer are different from one another.

In some embodiments, the first monomer and the at least one other monomer are different from one another. In some embodiments, the at least one other monomer is at least one second monomer. In some embodiments, the first monomer and the at least one second monomer are different from one another.

In some embodiments, the step of contacting the first monomer and the at least one other monomer with the bimetallic catalyst complex is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof.

In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the method of making a copolymer further comprises contacting at least one activator with the bimetallic catalyst complex, the first monomer, and the at least one other monomer. In some embodiments, the first monomer is ethylene, propene, 1-butene, 1-hexene, 1-octene, styrene, or allyl benzene. In some embodiments, the at least one other monomer is acrylamide, acrylic acid, acrylic ester, vinyl halide, vinyl alcohol, or allyl alcohol.

In some embodiments, the at least one activator is Ni(COD)₂. In some embodiments, the at least one activator is selected from the group consisting of Ni(COD)₂, triarylborane, methylaluminoxane, and trialkylaluminum.

In some embodiments, the first monomer and the at least one other monomer are each independently an optionally substituted olefin. In some embodiments, the optionally substituted olefin is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene.

In some embodiments, the first monomer and the at least one other monomer are each independently an optionally substituted terminal olefin or an optionally substituted internal olefin. In some embodiments, the first monomer and the at least one other monomer are each independently ethylene, an optionally substituted terminal olefin, or an optionally substituted internal olefin. In some embodiments, the optionally substituted terminal olefin is selected from the group consisting of propene, butene, 1-hexene, 1-heptene, 1-octene, styrene, acrylamide, acrylic acid, acrylic ester, vinyl halide, vinyl alcohol, allyl alcohol, and allylbenzene. In some embodiments, the optionally substituted internal olefin is selected from the group consisting of 2-hexene, 3-hexene, 2-heptene, 3-heptene, 2-octene, 3-octene, and 4-octene. In some embodiments, the first monomer is ethylene.

In various embodiments, the present invention provides a polymer formed by the method for catalyzing copolymerization of a first monomer and at least one other monomer. In some embodiments, the polymer is a copolymer. In some embodiments, the copolymer is selected from the group consisting of a random copolymer, block copolymer, and gradient copolymer. In some embodiments, the copolymer is a random copolymer. In some embodiments, the copolymer is a block copolymer. In some embodiments, the copolymer is a gradient copolymer. In various embodiments, the present invention provides a copolymer made by a method of making a copolymer as provided herein. In various embodiments, the present invention provides a polymer made by a method of making a copolymer as provided herein. In some embodiments, the polymer is a copolymer. In some embodiments, the copolymer is selected from the group consisting of a random copolymer, block copolymer, and gradient copolymer. In some embodiments, the polymer is monomodal or bimodal. In some embodiments, the polymer is monomodal. In some embodiments, the polymer is bimodal. In some embodiments, the polymer is monomodal, or bimodal, or combination thereof. In some embodiments, the copolymer is monomodal or bimodal. In some embodiments, the copolymer is bimodal. In some embodiments, the copolymer is monomodal. In some embodiments, the copolymer is monomodal, or bimodal, or combination thereof. In some embodiments, the first monomer is CO₂; and the at least one other monomer is an epoxide.

Catalyst Composition Comprising at Least Four Bimetallic Catalyst Complexes: a Bimetallic Catalyst Complex of Formula (15), a Bimetallic Catalyst Complex of Formula (16), a Bimetallic catalyst complex of Formula (17), and a Bimetallic Catalyst Complex of Formula (18).

In various embodiments, the present invention provides a catalyst composition, comprising at least four bimetallic catalyst complexes, wherein the at least four bimetallic catalyst complexes are selected from: a bimetallic catalyst complex of Formula (15), a bimetallic catalyst complex of Formula (16), a bimetallic catalyst complex of Formula (17), and a bimetallic catalyst complex of Formula (18): wherein the bimetallic catalyst complex of Formula (15) has the structure:

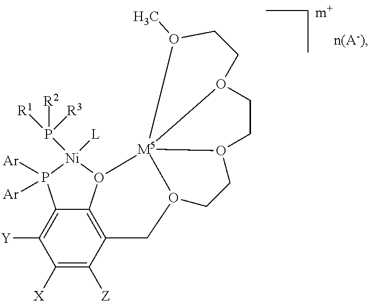

wherein the bimetallic catalyst complex of Formula (16) has the structure:

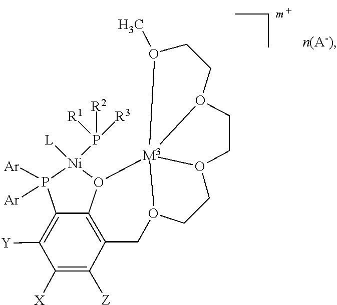

wherein the bimetallic catalyst complex of Formula (17) has the structure:

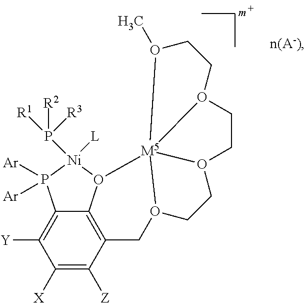

wherein the bimetallic catalyst complex of Formula (18) has the structure:

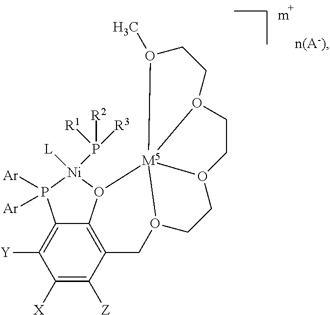

wherein in Formula (15), Formula (16), Formula (17) and Formula (18):
m is 2, 3, 4, or 5;
n is 1, 2, 3, 4, or 5;
Ar is 2,6-dimethoxyphenyl;
Lis an optionally substituted phenyl group;
M⁴ is a 2+ cation, 3+ cation, 4+ cation, or 5+ cation;
M⁵ is a 2+ cation, 3+ cation, 4+ cation, or 5+ cation;
A⁻ is a weakly coordinating anion;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl;
wherein m is the same in the bimetallic catalyst complex of Formula (15), Formula (16), Formula (17), and Formula (18);
wherein n is the same in the bimetallic catalyst complex of Formula (15), Formula (16), Formula (17), and Formula (18);
wherein A is the same in the bimetallic catalyst complex of Formula (15), Formula (16), Formula (17), and Formula (18);
wherein Ar is the same in the bimetallic catalyst complex of Formula (15), Formula (16), Formula (17), and Formula (18);
wherein L is the same in the bimetallic catalyst complex of Formula (15), Formula (16), Formula (17), and Formula (18);
wherein X is the same in the bimetallic catalyst complex of Formula (15), Formula (16), Formula (17), and Formula (18);
wherein Y is the same in the bimetallic catalyst complex of Formula (15), Formula (16), Formula (17), and Formula (18);
wherein Z is the same in the bimetallic catalyst complex of Formula (15), Formula (16), Formula (17), and Formula (18);
wherein R¹ is the same in the bimetallic catalyst complex of Formula (15), Formula (16), Formula (17), and Formula (18);
wherein R² is the same in the bimetallic catalyst complex of Formula (15), Formula (16), Formula (17), and Formula (18);
wherein R³ is the same in the bimetallic catalyst complex of Formula (15), Formula (16), Formula (17), and Formula (18);
wherein M⁺ is the same in the bimetallic catalyst complex of Formula (15) and Formula (16);
wherein M⁵ is the same in the bimetallic catalyst complex of Formula (17) and Formula (18);
and wherein M⁴ and M⁵ are different from one another.

In various embodiments, the present invention provides a catalyst composition, comprising at least four bimetallic catalyst complexes, wherein the at least four bimetallic catalyst complexes are selected from: a bimetallic catalyst complex of Formula (15-A), a bimetallic catalyst complex of Formula (16-A), a bimetallic catalyst complex of Formula (17-A), and a bimetallic catalyst complex of Formula (18-A): wherein the bimetallic catalyst complex of Formula (15-A) has the structure:

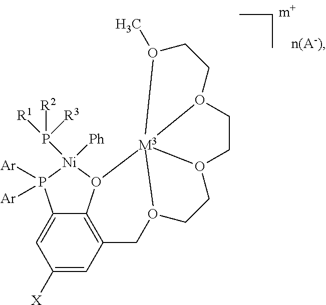

wherein the bimetallic catalyst complex of Formula (16-A) has the structure:

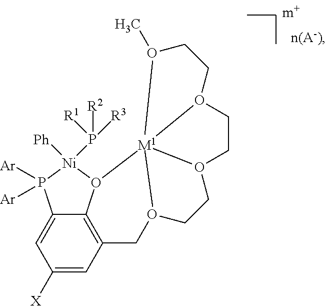

wherein the bimetallic catalyst complex of Formula (17-A) has the structure:

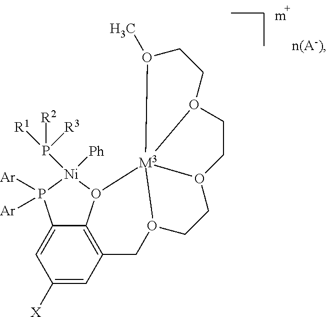

wherein the bimetallic catalyst complex of Formula (18-A) has the structure:

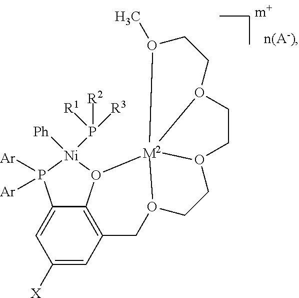

wherein in Formula (15-A), Formula (16-A), Formula (17-A) and Formula (18-A):
m is 2, 3, 4, or 5;
n is 1, 2, 3, 4, or 5;
Ar is 2,6-dimethoxyphenyl;
Ph is a phenyl group;
M⁴ is a 2+ cation, 3+ cation, 4+ cation, or 5+ cation;
M⁵ is a 2+ cation, 3+ cation, 4+ cation, or 5+ cation;
A⁻ is a weakly coordinating anion;
X is hydrogen, an electron donating group, or an electron withdrawing group; and
R¹, R², and R³ are each independently selected from optionally substituted aryl, optionally substituted alkyl, and optionally substituted cycloalkyl;
wherein m is the same in the bimetallic catalyst complex of Formula (15-A), Formula (16-A), Formula (17-A), and Formula (18-A);
wherein n is the same in the bimetallic catalyst complex of Formula (15-A), Formula (16-A), Formula (17-A), and Formula (18-A);
wherein A is the same in the bimetallic catalyst complex of Formula (15-A), Formula (16-A), Formula (17-A), and Formula (18-A);
wherein Ar is the same in the bimetallic catalyst complex of Formula (15-A), Formula (16-A), Formula (17-A), and Formula (18-A);
wherein Ph is the same in the bimetallic catalyst complex of Formula (15-A), Formula (16-A), Formula (17-A), and Formula (18-A);
wherein X is the same in the bimetallic catalyst complex of Formula (15-A), Formula (16-A), Formula (17-A), and Formula (18-A);
wherein R¹ is the same in the bimetallic catalyst complex of Formula (15-A), Formula (16-A), Formula (17-A), and Formula (18-A);
wherein R² is the same in the bimetallic catalyst complex of Formula (15-A), Formula (16-A), Formula (17-A), and Formula (18-A);
wherein R³ is the same in the bimetallic catalyst complex of Formula (15-A), Formula (16-A), Formula (17-A), and Formula (18-A);
wherein M⁴ is the same in the bimetallic catalyst complex of Formula (15-A) and Formula (16-A);
wherein M⁵ is the same in the bimetallic catalyst complex of Formula (17-A) and Formula (18-A);
and wherein M⁴ and M⁵ are different from one another.

In various embodiments, the present invention provides a catalyst composition, comprising at least four bimetallic catalyst complexes, wherein the at least four bimetallic catalyst complexes are selected from: a bimetallic catalyst complex of Formula (15-B), a bimetallic catalyst complex of Formula (16-B), a bimetallic catalyst complex of Formula (17-B), and a bimetallic catalyst complex of Formula (18-B): wherein the bimetallic catalyst complex of Formula (15-B) has the structure:

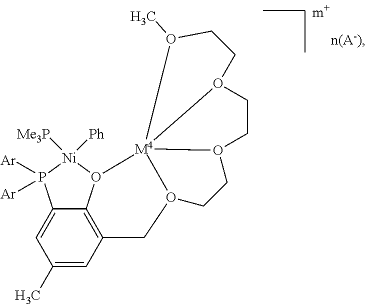

wherein the bimetallic catalyst complex of Formula (16-B) has the structure:

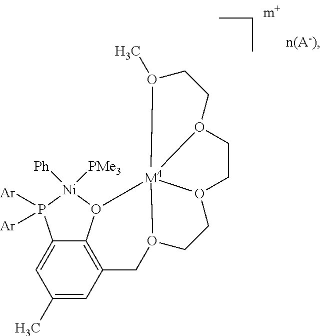

wherein the bimetallic catalyst complex of Formula (17-B) has the structure:

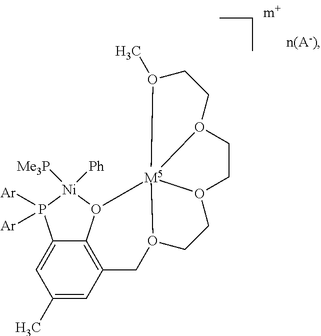

wherein the bimetallic catalyst complex of Formula (18-B) has the structure:

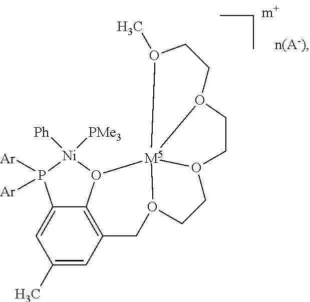

wherein in Formula (15-B), Formula (16-B), Formula (17-B) and Formula (18-B):
m is 2, 3, 4, or 5;
n is 1, 2, 3, 4, or 5;
Ar is 2,6-dimethoxyphenyl;
Ph is a phenyl group;
M⁴ is a 2+ cation, 3+ cation, 4+ cation, or 5+ cation;
M⁵ is a 2+ cation, 3+ cation, 4+ cation, or 5+ cation;
A⁻ is [(3,5-(CF₃)₂C₆H₃)₄B]⁻; and
PMe₃ is trimethylphosphine;
wherein m is the same in the bimetallic catalyst complex of Formula (15-B), Formula (16-B), Formula (17-B), and Formula (18-B);
wherein n is the same in the bimetallic catalyst complex of Formula (15-B), Formula (16-B), Formula (17-B), and Formula (18-B);
wherein A is the same in the bimetallic catalyst complex of Formula (15-B), Formula (16-B), Formula (17-B), and Formula (18-B);
wherein Ar is the same in the bimetallic catalyst complex of Formula (15-B), Formula (16-B), Formula (17-B), and Formula (18-B);
wherein Ph is the same in the bimetallic catalyst complex of Formula (15-B), Formula (16-B), Formula (17-B), and Formula (18-B);
wherein PMe₃ is the same in the bimetallic catalyst complex of Formula (15-B), Formula (16-B), Formula (17-B), and Formula (18-B);
wherein M⁴ is the same in the bimetallic catalyst complex of Formula (15-B) and Formula (16-B);
wherein M⁵ is the same in the bimetallic catalyst complex of Formula (17-B) and Formula (18-B);
and wherein M⁴ and M⁵ are different from one another.

In some embodiments, the bimetallic catalyst complex of Formula (15-A) is a bimetallic catalyst complex of Formula (15). In some embodiments, the bimetallic catalyst complex of Formula (15-B) is a bimetallic catalyst complex of Formula (15). In some embodiments, the bimetallic catalyst complex of Formula (16-A) is a bimetallic catalyst complex of Formula (16). In some embodiments, the bimetallic catalyst complex of Formula (16-B) is a bimetallic catalyst complex of Formula (16). In some embodiments, the bimetallic catalyst complex of Formula (17-A) is a bimetallic catalyst complex of Formula (17). In some embodiments, the bimetallic catalyst complex of Formula (17-B) is a bimetallic catalyst complex of Formula (17). In some embodiments, the bimetallic catalyst complex of Formula (18-A) is a bimetallic catalyst complex of Formula (18). In some embodiments, the bimetallic catalyst complex of Formula (18-B) is a bimetallic catalyst complex of Formula (18).

In some embodiments, in Formula (15), Formula (16), Formula (17) and Formula (18): m is 2, 3, 4, or 5; n is 2, 3, 4, or 5; Ar is 2,6-dimethoxyphenyl; L is a phenyl group; M⁴ is a 2+ cation, 3+ cation, 4+ cation, or 5+ cation; M⁵ is a 2+ cation, 3+ cation, 4+ cation, or 5+ cation; A⁻ is [(3,5-(CF₃)₂C₆H₃)₄B]⁻; X is methyl; Y is hydrogen; Z is hydrogen; and R¹, R², and R³ are each methyl; wherein m is the same in the bimetallic catalyst complex of Formula (15), Formula (16), Formula (17), and Formula (18); wherein n is the same in the bimetallic catalyst complex of Formula (15), Formula (16), Formula (17), and Formula (18); wherein A⁻ is the same in the bimetallic catalyst complex of Formula (15), Formula (16), Formula (17), and Formula (18); wherein Ar is the same in the bimetallic catalyst complex of Formula (15), Formula (16), Formula (17), and Formula (18); wherein L is the same in the bimetallic catalyst complex of Formula (15), Formula (16), Formula (17), and Formula (18); wherein X is the same in the bimetallic catalyst complex of Formula (15), Formula (16), Formula (17), and Formula (18); wherein Y is the same in the bimetallic catalyst complex of Formula (15), Formula (16), Formula (17), and Formula (18); wherein Z is the same in the bimetallic catalyst complex of Formula (15), Formula (16), Formula (17), and Formula (18); wherein R¹ is the same in the bimetallic catalyst complex of Formula (15), Formula (16), Formula (17), and Formula (18); wherein R² is the same in the bimetallic catalyst complex of Formula (15), Formula (16), Formula (17), and Formula (18); wherein R³ is the same in the bimetallic catalyst complex of Formula (15), Formula (16), Formula (17), and Formula (18); wherein M⁴ is the same in the bimetallic catalyst complex of Formula (15) and Formula (16); wherein M⁵ is the same in the bimetallic catalyst complex of Formula (17) and Formula (18); and wherein M⁴ and M⁵ are different from one another.

In some embodiments, A⁻ is a weakly coordinating anion. In some embodiments, the weakly coordinating anion is selected from the group consisting of tetrakis(3,5-bis(trifluoromethyl)phenylborate, tetrakis(pentafluorophenyl)borate, tetraphenylborate, trifluoromethylsulfonate, hexafluorophosphate, hexafluoroantimonate, and tetrafluoroborate. In some embodiments, tetrakis(3,5-bis(trifluoromethyl)phenylborate is represented as [(3,5-(CF₃)₂C₆H₃)₄B]⁻. In some embodiments, tetrakis(3,5-bis(trifluoromethyl)phenylborate is represented as BAr^{F}₄⁻.

In some embodiments, the electron donating group is selected from the group consisting of: alkoxy, amino, hydroxy, and alkyl. In some embodiments, the electron donating group is selected from the group consisting of: alkoxy, phenoxy, amino, alkylamino, dialkylamino, hydroxy, alkyl, and cycloalkyl.

In some embodiments, alkyl is selected from the group consisting of: —CH₃, —CH₂CH₃, —CH₂CH₂CH₃, and —CH(CH₃)₂.

In some embodiments, the electron withdrawing group is selected from the group consisting of: NO₂, —CN, —C(O)-alkyl, and halo. In some embodiments, the electron withdrawing group is selected from the group consisting of: NO₂, —CN, —C(O)-alkyl, C(O)Oalkyl, C(O)Nalkyl, ˜SO₃H, —SO₂R, —PO₃H, —PO₃R, —CF₃, and halo. In some embodiments, the electron withdrawing group is selected from the group consisting of: NO₂, —CN, —C(O)-alkyl, C(O)Oalkyl, C(O)Nalkyl, —SO₃H, —SO₂alkyl, —PO₃H, —PO₃alkyl, —CF₃, and halo.

In some embodiments, the phenyl group is

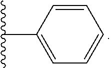 [SMILES: *c1ccccc1]

In some embodiments, L is an optionally substituted phenyl group. In some embodiments, the optionally substituted phenyl group is selected from the group consisting of phenyl, 2-methoxyphenyl, 4-methoxyphenyl, 2-acetylphenyl, or 2-(N-acetylamino)phenyl). In some embodiments, L is a phenyl group.

In some embodiments, R¹, R², and R³ are each independently selected from optionally substituted aryl, optionally substituted alkyl, and optionally substituted cycloalkyl. In some embodiments, optionally substituted aryl is selected from the group consisting of phenyl, pentafluorophenyl, 2-methoxyphenyl, 2-methylphenyl, and 4-trifluoromethylphenyl. In some embodiments, optionally substituted alkyl is selected from the group consisting of methyl, ethyl, propyl, isopropyl, or tert-butyl. In some embodiments, optionally substituted cycloalkyl is cyclohexyl or adamantyl.

In some embodiments, m is 2, 3, 4, or 5. In some embodiments, m is 2. In some embodiments, m is 3. In some embodiments, m is 4. In some embodiments, m is 5.

In some embodiments, n is 2, 3, 4, or 5. In some embodiments, n is 2. In some embodiments, n is 3. In some embodiments, n is 4. In some embodiments, n is 5.

In some embodiments, M⁺ is a 2+ cation. In some embodiments, M⁴ is a 3+ cation. In some embodiments, M⁴ is a 4+ cation. In some embodiments, M⁴ is a 5+ cation. In some embodiments, M⁵ is a 2+ cation. In some embodiments, M⁵ is a 3+ cation. In some embodiments, M⁵ is a 4+ cation. In some embodiments, M⁵ is a 5+ cation. In some embodiments, the 2+ cation is Mg²⁺, Ca²⁺, Sr²⁺, Ba²⁺, Fe²⁺, Co²⁺, Ni²⁺, Cu²⁺, Zn²⁺, Ru²⁺, Pd²⁺, Os²⁺, or Pt²⁺. In some embodiments, the 3+ cation is Sc³⁺, Mn³⁺, Fe³⁺, Co³⁺, Ga³⁺, Y³⁺, Os³⁺, Rh³⁺, Ir³⁺, or La³⁺. In some embodiments, the 4+ cation is Ti⁴⁺, Zr⁴⁺, Hf⁴⁺, or Ce⁴⁺. In some embodiments, the 5+ cation is V⁵⁺, Mn⁵⁺, Nb⁵⁺, or Ta⁵⁺.

### Method for Catalyzing Homopolymerization of an Optionally Substituted Olefin

In various embodiments, the present invention provides a method for catalyzing homopolymerization of an optionally substituted olefin, comprising: combining or contacting an optionally substituted olefin with a catalyst composition, whereby the optionally substituted olefin undergoes homopolymerization, and wherein the catalyst composition comprises at least four bimetallic catalyst complexes, wherein the at least four bimetallic catalyst complexes are selected from: a bimetallic catalyst complex of Formula (15), a bimetallic catalyst complex of Formula (16), a bimetallic catalyst complex of Formula (17), and a bimetallic catalyst complex of Formula (18).

In various embodiments, the present invention provides a method for catalyzing homopolymerization of an optionally substituted olefin, comprising: combining or contacting an optionally substituted olefin with a catalyst composition, whereby the optionally substituted olefin undergoes homopolymerization, and wherein the catalyst composition comprises at least four bimetallic catalyst complexes, wherein the at least four bimetallic catalyst complexes are selected from: a bimetallic catalyst complex of Formula (15A), a bimetallic catalyst complex of Formula (16A), a bimetallic catalyst complex of Formula (17A), and a bimetallic catalyst complex of Formula (18A).

In various embodiments, the present invention provides a method for catalyzing homopolymerization of an optionally substituted olefin, comprising: combining or contacting an optionally substituted olefin with a catalyst composition, whereby the optionally substituted olefin undergoes homopolymerization, and wherein the catalyst composition comprises at least four bimetallic catalyst complexes, wherein the at least four bimetallic catalyst complexes are selected from: a bimetallic catalyst complex of Formula (15B), a bimetallic catalyst complex of Formula (16B), a bimetallic catalyst complex of Formula (17B), and a bimetallic catalyst complex of Formula (18B).

In some embodiments, the step of combining or contacting the optionally substituted olefin with the catalyst is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof. In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the method for catalyzing homopolymerizaton of an optionally substituted olefin further comprises combining or contacting at least one activator with the catalyst and the optionally substituted olefin.

In some embodiments, the at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the optionally substituted olefin is an optionally substituted terminal olefin or an optionally substituted internal olefin. In some embodiments, the optionally substituted olefin is selected from the group consisting of ethylene, an optionally substituted terminal olefin, and an optionally substituted internal olefin. In some embodiments, the optionally substituted terminal olefin is selected from the group consisting of propene, butene, 1-hexene, 1-heptene, 1-octene, styrene, acrylamide, acrylic acid, acrylic ester, vinyl halide, vinyl alcohol, allyl alcohol, and allylbenzene. In some embodiments, the optionally substituted internal olefin is selected from the group consisting of 2-hexene, 3-hexene, 2-heptene, 3-heptene, 2-octene, 3-octene, and 4-octene. In some embodiments, the optionally substituted olefin is ethylene. In some embodiments, the optionally substituted olefin is selected from the group consisting of ethylene, propene, butene, 1-hexene, 1-heptene, 1-octene, styrene, acrylamide, acrylic acid, acrylic ester, 2-octene, 3-octene, and 4-octene.

In various embodiments, the present invention provides a polymer formed by a method for catalyzing homopolymerizaton of an optionally substituted olefin as provided herein. In various embodiments, the present invention provides a homopolymer formed by the method for catalyzing homopolymerization of an optionally substituted olefin as provided herein. In some embodiments, the polymer is monomodal or bimodal. In some embodiments, the polymer is monomodal. In some embodiments, the polymer is bimodal. In some embodiments, the polymer is monomodal, or bimodal, or combination thereof. In some embodiments, the polymer is a homopolymer. In some embodiments, the homopolymer is monomodal or bimodal. In some embodiments, the homopolymer is monomodal. In some embodiments, the homopolymer is bimodal. In some embodiments, the homopolymer is monomodal, or bimodal, or combination thereof.

### Methods for Polymerizing an Optionally Substituted Olefin

In various embodiments, the present invention provides a method for polymerizing an optionally substituted olefin, the method comprising contacting an optionally substituted olefin with a catalyst composition and at least one activator under conditions effective to polymerize the optionally substituted olefin, wherein the catalyst composition comprises at least four bimetallic catalyst complexes, wherein the at least four bimetallic catalyst complexes are selected from: a bimetallic catalyst complex of Formula (15), a bimetallic catalyst complex of Formula (16), a bimetallic catalyst complex of Formula (17), and a bimetallic catalyst complex of Formula (18).

In various embodiments, the present invention provides a method for polymerizing an optionally substituted olefin, the method comprising contacting an optionally substituted olefin with a catalyst composition and at least one activator under conditions effective to polymerize the optionally substituted olefin, wherein the catalyst composition comprises at least four bimetallic catalyst complexes, wherein the at least four bimetallic catalyst complexes are selected from: a bimetallic catalyst complex of Formula (15A), a bimetallic catalyst complex of Formula (16A), a bimetallic catalyst complex of Formula (17A), and a bimetallic catalyst complex of Formula (18A).

In various embodiments, the present invention provides a method for polymerizing an optionally substituted olefin, the method comprising contacting an optionally substituted olefin with a catalyst composition and at least one activator under conditions effective to polymerize the optionally substituted olefin, wherein the catalyst composition comprises at least four bimetallic catalyst complexes, wherein the at least four bimetallic catalyst complexes are selected from: a bimetallic catalyst complex of Formula (15B), a bimetallic catalyst complex of Formula (16B), a bimetallic catalyst complex of Formula (17B), and a bimetallic catalyst complex of Formula (18B).

In some embodiments, the at least one activator is Ni(COD)₂ and triarylborane. In some embodiments, the at least one activator is selected from the group consisting of Ni(COD)₂, triarylborane, methylaluminoxane, and trialkylaluminum.

In some embodiments, the step of contacting the optionally substituted olefin with the catalyst composition and the at least one activator is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof. In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from tetrahydrofuran, diethyl ether, dichloromethane, chloroform, N,N-dimethylforamide, dimethylsulfoxide, ethyl acetate, acetone, and water, and any combinations thereof.

In some embodiments, the optionally substituted olefin is an optionally substituted terminal olefin or an optionally substituted internal olefin. In some embodiments, the optionally substituted olefin is selected from the group consisting of ethylene, an optionally substituted terminal olefin, and an optionally substituted internal olefin. In some embodiments, the optionally substituted terminal olefin is selected from the group consisting of propene, butene, 1-hexene, 1-heptene, 1-octene, styrene, acrylamide, acrylic acid, acrylic ester, vinyl halide, vinyl alcohol, allyl alcohol, and allylbenzene. In some embodiments, the optionally substituted internal olefin is selected from the group consisting of 2-hexene, 3-hexene, 2-heptene, 3-heptene, 2-octene, 3-octene, and 4-octene. In some embodiments, the optionally substituted olefin is ethylene. In some embodiments, the optionally substituted olefin is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene.

In various embodiments, the present invention provides a polymer formed by a method for polymerizing an optionally substituted olefin as provided herein. In some embodiments, the polymer is monomodal or bimodal. In some embodiments, the polymer is monomodal. In some embodiments, the polymer is bimodal. In some embodiments, the polymer is monomodal, or bimodal, or combination thereof.

### Methods for Catalyzing Copolymerization of a First Olefin and at Least One Other Olefin

In various embodiments, the present invention provides a method for catalyzing copolymerization of a first olefin and at least one other olefin, comprising: combining or contacting a first olefin and at least one other olefin with a catalyst composition, whereby the first olefin and the at least one other olefin undergoes copolymerization, and wherein the first olefin and the at least one other olefin are different from one another, and wherein the catalyst composition comprises at least four bimetallic catalyst complexes, wherein the at least four bimetallic catalyst complexes are selected from: a bimetallic catalyst complex of Formula (15), a bimetallic catalyst complex of Formula (16), a bimetallic catalyst complex of Formula (17), and a bimetallic catalyst complex of Formula (18).

In various embodiments, the present invention provides a method for catalyzing copolymerization of a first olefin and at least one other olefin, comprising: combining or contacting a first olefin and at least one other olefin with a catalyst composition, whereby the first olefin and the at least one other olefin undergoes copolymerization, and wherein the first olefin and the at least one other olefin are different from one another, and wherein the catalyst composition comprises at least four bimetallic catalyst complexes, wherein the at least four bimetallic catalyst complexes are selected from: a bimetallic catalyst complex of Formula (15A), a bimetallic catalyst complex of Formula (16A), a bimetallic catalyst complex of Formula (17A), and a bimetallic catalyst complex of Formula (18A).

In various embodiments, the present invention provides a method for catalyzing copolymerization of a first olefin and at least one other olefin, comprising: combining or contacting a first olefin and at least one other olefin with a catalyst composition, whereby the first olefin and the at least one other olefin undergoes copolymerization, and wherein the first olefin and the at least one other olefin are different from one another, and wherein the catalyst composition comprises at least four bimetallic catalyst complexes, wherein the at least four bimetallic catalyst complexes are selected from: a bimetallic catalyst complex of Formula (15B), a bimetallic catalyst complex of Formula (16B), a bimetallic catalyst complex of Formula (17B), and a bimetallic catalyst complex of Formula (18B).

In some embodiments, the first olefin and the at least one other olefin are different from one another. In some embodiments, the at least one other olefin is at least one second olefin. In some embodiments, the first olefin and the at least one second olefin are different from one another.

In some embodiments, the step of combining or contacting the first olefin and the at least one other olefin with the catalyst composition is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof. In some embodiments, the first olefin is selected from the group consisting of ethylene, propene, and styrene. In some embodiments the at least one other olefin is selected from the group consisting of 1-hexene, 1-octene, allyl benzene, acrylamide, acrylic acid, acrylic ester, vinyl halide, vinyl alcohol, and allyl alcohol.

In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the method for catalyzing copolymerization of a first olefin and at least one other olefin further comprises combining or contacting at least one activator with the catalyst composition, the first olefin, and the at least one other olefin.

In some embodiments, the at least one activator is Ni(COD)₂ and triarylborane. In some embodiments, the at least one activator is selected from the group consisting of Ni(COD)₂, triarylborane, methylaluminoxane, and trialkylaluminum.

In some embodiments, the first olefin and the at least one other olefin are each independently an optionally substituted olefin. In some embodiments, the optionally substituted olefin is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene.

In some embodiments, the first olefin and the at least one other olefin are each independently an optionally substituted terminal olefin or an optionally substituted internal olefin. In some embodiments, the first olefin and the at least one other olefin are each independently ethylene, an optionally substituted terminal olefin, or an optionally substituted internal olefin. In some embodiments, the optionally substituted terminal olefin is selected from the group consisting of propene, butene, 1-hexene, 1-heptene, 1-octene, styrene, acrylamide, acrylic acid, acrylic ester, vinyl halide, vinyl alcohol, allyl alcohol, and allylbenzene. In some embodiments, the optionally substituted internal olefin is selected from the group consisting of 2-hexene, 3-hexene, 2-heptene, 3-heptene, 2-octene, 3-octene, and 4-octene. In some embodiments, the first olefin is ethylene.

In various embodiments, the present invention provides a polymer formed by a method for catalyzing copolymerization of a first olefin and at least one other olefin as provided herein. In some embodiments, the polymer is a copolymer. In some embodiments, the copolymer is selected from the group consisting of a random copolymer, block copolymer, and gradient copolymer. In some embodiments, the copolymer is a random copolymer. In some embodiments, the copolymer is a block copolymer. In some embodiments, the copolymer is a gradient copolymer. In some embodiments, the polymer is monomodal or bimodal. In some embodiments, the polymer is monomodal. In some embodiments, the polymer is bimodal. In some embodiments, the polymer is monomodal, or bimodal, or combination thereof. In some embodiments, the copolymer is monomodal or bimodal. In some embodiments, the copolymer is monomodal. In some embodiments, the copolymer is bimodal. In some embodiments, the copolymer is monomodal, or bimodal, or combination thereof.

### Method for Copolymerizing a First Olefin and at Least One Other Olefin

In various embodiments, the present invention provides a method for copolymerizing a first olefin and at least one other olefin, the method comprising contacting the first olefin and the at least one other olefin with a catalyst composition, and at least one activator under conditions effective to copolymerize the first olefin and the at least one other olefin, wherein the first olefin and the at least one other olefin are different from one another, and wherein the catalyst composition comprises at least four bimetallic catalyst complexes, and wherein the at least four bimetallic catalyst complexes are selected from: a bimetallic catalyst complex of Formula (15), a bimetallic catalyst complex of Formula (16), a bimetallic catalyst complex of Formula (17), and a bimetallic catalyst complex of Formula (18).

In various embodiments, the present invention provides a method for copolymerizing a first olefin and at least one other olefin, the method comprising contacting the first olefin and the at least one other olefin with a catalyst composition, and at least one activator under conditions effective to copolymerize the first olefin and the at least one other olefin, wherein the first olefin and the at least one other olefin are different from one another, and wherein the catalyst composition comprises at least four bimetallic catalyst complexes, and wherein the at least four bimetallic catalyst complexes are selected from: a bimetallic catalyst complex of Formula (15A), a bimetallic catalyst complex of Formula (16A), a bimetallic catalyst complex of Formula (17A), and a bimetallic catalyst complex of Formula (18A).

In various embodiments, the present invention provides a method for copolymerizing a first olefin and at least one other olefin, the method comprising contacting the first olefin and the at least one other olefin with a catalyst composition, and at least one activator under conditions effective to copolymerize the first olefin and the at least one other olefin, wherein the first olefin and the at least one other olefin are different from one another, and wherein the catalyst composition comprises at least four bimetallic catalyst complexes, and wherein the at least four bimetallic catalyst complexes are selected from: a bimetallic catalyst complex of Formula (15B), a bimetallic catalyst complex of Formula (16B), a bimetallic catalyst complex of Formula (17B), and a bimetallic catalyst complex of Formula (18B).

In some embodiments, the first olefin and the at least one other olefin are different from one another. In some embodiments, the at least one other olefin is at least one second olefin. In some embodiments, the first olefin and the at least one second olefin are different from one another.

In some embodiments, the at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the step of contacting the first olefin and the at least one other olefin with the catalyst composition and the at least one activator is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof.

In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the first olefin and the at least one other olefin are each independently an optionally substituted olefin. In some embodiments, the optionally substituted olefin is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene.

In some embodiments, the first olefin and the at least one other olefin are each independently an optionally substituted terminal olefin or an optionally substituted internal olefin. In some embodiments, the first olefin and the at least one other olefin are each independently ethylene, an optionally substituted terminal olefin, or an optionally substituted internal olefin. In some embodiments, the first olefin is ethylene.

In various embodiments, the present invention provides a polymer formed by a method for copolymerizing a first olefin and at least one other olefin as provided herein. In various embodiments, the present invention provides a polymer formed by the method for copolymerizing a first olefin and at least one other olefin as provided herein. In some embodiments, the polymer is a copolymer. In some embodiments, the copolymer is selected from the group consisting of a random copolymer, block copolymer, and gradient copolymer. In some embodiments, the copolymer is a random copolymer. In some embodiments, the copolymer is a block copolymer. In some embodiments, the copolymer is a gradient copolymer. In some embodiments, the polymer is monomodal or bimodal. In some embodiments, the polymer is monomodal. In some embodiments, the polymer is bimodal. In some embodiments, the polymer is monomodal, or bimodal, or combination thereof. In some embodiments, the copolymer is monomodal or bimodal. In some embodiments, the copolymer is monomodal. In some embodiments, the copolymer is bimodal. In some embodiments, the copolymer is monomodal, or bimodal, or combination thereof.

### Method of Making a Compound

In various embodiments, the present invention provides a method for making a compound, the method comprising contacting a reactant with a catalyst composition under conditions effective to make the compound, wherein the catalyst composition comprises at least four bimetallic catalyst complexes, and wherein the at least four bimetallic catalyst complexes are selected from: a bimetallic catalyst complex of Formula (15), a bimetallic catalyst complex of Formula (16), a bimetallic catalyst complex of Formula (17), and a bimetallic catalyst complex of Formula (18).

In various embodiments, the present invention provides a method for making a compound, the method comprising contacting a reactant with a catalyst composition under conditions effective to make the compound, wherein the catalyst composition comprises at least four bimetallic catalyst complexes, and wherein the at least four bimetallic catalyst complexes are selected from: a bimetallic catalyst complex of Formula (15A), a bimetallic catalyst complex of Formula (16A), a bimetallic catalyst complex of Formula (17A), and a bimetallic catalyst complex of Formula (18A).

In various embodiments, the present invention provides a method for making a compound, the method comprising contacting a reactant with a catalyst composition under conditions effective to make the compound, wherein the catalyst composition comprises at least four bimetallic catalyst complexes, and wherein the at least four bimetallic catalyst complexes are selected from: a bimetallic catalyst complex of Formula (15B), a bimetallic catalyst complex of Formula (16B), a bimetallic catalyst complex of Formula (17B), and a bimetallic catalyst complex of Formula (18B).

In some embodiments the reactant is methylaluminoxane, trialkylaluminium, alkyllithium, alkyl magnesium halide, or dialklylzinc.

In some embodiments, the step of contacting the reactant with the catalyst composition is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof.

In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the method for making a compound further comprises contacting at least one activator with the catalyst composition and the reactant. In some embodiments, the at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the compound is a small molecule. In some embodiments, the method for making a compound is a cascade method.

### Methods for Making a Compound

In various embodiments, the present invention provides a method for making a compound, the method comprising contacting a first reactant and at least one other reactant with a catalyst composition under conditions effective to make the compound, wherein the catalyst composition comprises at least four bimetallic catalyst complexes, and wherein the at least four bimetallic catalyst complexes are selected from: a bimetallic catalyst complex of Formula (15), a bimetallic catalyst complex of Formula (16), a bimetallic catalyst complex of Formula (17), and a bimetallic catalyst complex of Formula (18).

In various embodiments, the present invention provides a method for making a compound, the method comprising contacting a first reactant and at least one other reactant with a catalyst composition under conditions effective to make the compound, wherein the catalyst composition comprises at least four bimetallic catalyst complexes, and wherein the at least four bimetallic catalyst complexes are selected from: a bimetallic catalyst complex of Formula (15A), a bimetallic catalyst complex of Formula (16A), a bimetallic catalyst complex of Formula (17A), and a bimetallic catalyst complex of Formula (18A).

In various embodiments, the present invention provides a method for making a compound, the method comprising contacting a first reactant and at least one other reactant with a catalyst composition under conditions effective to make the compound, wherein the catalyst composition comprises at least four bimetallic catalyst complexes, and wherein the at least four bimetallic catalyst complexes are selected from: a bimetallic catalyst complex of Formula (15B), a bimetallic catalyst complex of Formula (16B), a bimetallic catalyst complex of Formula (17B), and a bimetallic catalyst complex of Formula (18B).

In some embodiments, the step of contacting the first reactant and the at least one other reactant with the catalyst composition is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof.

In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the method for making a compound further comprises contacting at least one activator with the catalyst composition, the first reactant, and the at least one other reactant.

In some embodiments, the at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the compound is a small molecule. In some embodiments, the method of making a compound is a cascade method. In some embodiments, the first reactant and the at least one other reactant are different from one another.

### Method of Making a Polymer

In various embodiments, the present invention provides a method of making a polymer, comprising contacting a monomer with the catalyst composition, wherein the catalyst composition comprises at least four bimetallic catalyst complexes, and wherein the at least four bimetallic catalyst complexes are selected from: a bimetallic catalyst complex of Formula (15), a bimetallic catalyst complex of Formula (16), a bimetallic catalyst complex of Formula (17), and a bimetallic catalyst complex of Formula (18).

In various embodiments, the present invention provides a method of making a polymer, comprising contacting a monomer with the catalyst composition, wherein the catalyst composition comprises at least four bimetallic catalyst complexes, and wherein the at least four bimetallic catalyst complexes are selected from: a bimetallic catalyst complex of Formula (15A), a bimetallic catalyst complex of Formula (16A), a bimetallic catalyst complex of Formula (17A), and a bimetallic catalyst complex of Formula (18A).

In various embodiments, the present invention provides a method of making a polymer, comprising contacting a monomer with the catalyst composition, wherein the catalyst composition comprises at least four bimetallic catalyst complexes, and wherein the at least four bimetallic catalyst complexes are selected from: a bimetallic catalyst complex of Formula (15B), a bimetallic catalyst complex of Formula (16B), a bimetallic catalyst complex of Formula (17B), and a bimetallic catalyst complex of Formula (18B).

In some embodiments, the monomer is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene.

In some embodiments, the step of contacting the monomer with the catalyst composition is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof. In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the method of making a polymer further comprising contacting at least one activator with the catalyst composition and the monomer. In some embodiments, the at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the monomer is an optionally substituted olefin. In some embodiments, the optionally substituted olefin is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene. In some embodiments, the monomer is an optionally substituted terminal olefin or an optionally substituted internal olefin. In some embodiments, the monomer is selected from the group consisting of ethylene, an optionally substituted terminal olefin, and an optionally substituted internal olefin. In some embodiments, the monomer is ethylene.

In various embodiments, the present invention provides a polymer made by a method of making a polymer as provided herein. In some embodiments, the polymer is bimodal or monomodal. In some embodiments, the polymer is monomodal. In some embodiments, the polymer is bimodal. In some embodiments, the polymer is monomodal, or bimodal, or combination thereof.

### Method of Making a Copolymer

In various embodiments, the present invention provides a method of making a copolymer, comprising contacting a first monomer and at least one other monomer with a catalyst composition, wherein the first monomer and the at least one other monomer are different from one another, wherein the catalyst composition comprises at least four bimetallic catalyst complexes, and wherein the at least four bimetallic catalyst complexes are selected from: a bimetallic catalyst complex of Formula (15), a bimetallic catalyst complex of Formula (16), a bimetallic catalyst complex of Formula (17), and a bimetallic catalyst complex of Formula (18).

In various embodiments, the present invention provides a method of making a copolymer, comprising contacting a first monomer and at least one other monomer with a catalyst composition, wherein the first monomer and the at least one other monomer are different from one another, wherein the catalyst composition comprises at least four bimetallic catalyst complexes, and wherein the at least four bimetallic catalyst complexes are selected from: a bimetallic catalyst complex of Formula (15A), a bimetallic catalyst complex of Formula (16A), a bimetallic catalyst complex of Formula (17A), and a bimetallic catalyst complex of Formula (18A).

In various embodiments, the present invention provides a method of making a copolymer, comprising contacting a first monomer and at least one other monomer with a catalyst composition, wherein the first monomer and the at least one other monomer are different from one another, wherein the catalyst composition comprises at least four bimetallic catalyst complexes, and wherein the at least four bimetallic catalyst complexes are selected from: a bimetallic catalyst complex of Formula (15B), a bimetallic catalyst complex of Formula (16B), a bimetallic catalyst complex of Formula (17B), and a bimetallic catalyst complex of Formula (18B).

In some embodiments, the first monomer and the at least one other monomer are different from one another. In some embodiments, the at least one other monomer is at least one second monomer. In some embodiments, the first monomer and the at least one second monomer are different from one another.

In some embodiments, the step of contacting the first monomer and the at least one other monomer with the catalyst composition is performed in the presence of at least one solvent. In some embodiments, the at least one solvent is selected from the group consisting of toluene, benzene, xylene, hexanes, heptane, octane, decane, tetrahydrofuran, diethyl ether, dichloromethane, chloroform, N,N-dimethylforamide, dimethylsulfoxide, ethyl acetate, acetone, and water, and any combinations thereof.

In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylforamide, dimethylsulfoxide, ethyl acetate, acetone, and water, and any combinations thereof.

In some embodiments, the method of making a copolymer further comprises contacting at least one activator with the catalyst composition, the first monomer, and the at least one other monomer. In some embodiments, the first monomer is ethylene, propene, 1-butene, 1-hexene, 1-octene, styrene, or allyl benzene. In some embodiments, the at least one other monomer is acrylamide, acrylic acid, acrylic ester, vinyl halide, vinyl alcohol, or allyl alcohol.

In some embodiments, the at least one activator is Ni(COD)₂ or triarylborane. In some embodiments, the at least one activator is selected from the group consisting of Ni(COD)₂, triarylborane, methylaluminoxane, and trialkylaluminum.

In some embodiments, the first monomer and the at least one other monomer are each independently an optionally substituted olefin. In some embodiments, the optionally substituted olefin is selected from the group consisting of ethylene, propene, butene, 1-hexene, 1-heptene, 1-octene, styrene, acrylamide, acrylic acid, acrylic ester, vinyl halide, vinyl alcohol, allyl alcohol, allylbenzene, 2-hexene, 3-hexene, 2-heptene, 3-heptene, 2-octene, 3-octene, and 4-octene.

In some embodiments, the first monomer and the at least one other monomer are each independently an optionally substituted terminal olefin or an optionally substituted internal olefin. In some embodiments, the first monomer and the at least one other monomer are each independently ethylene, an optionally substituted terminal olefin, or an optionally substituted internal olefin. In some embodiments, the optionally substituted terminal olefin is selected from the group consisting of propene, butene, 1-hexene, 1-heptene, 1-octene, styrene, acrylamide, acrylic acid, acrylic ester, vinyl halide, vinyl alcohol, allyl alcohol, and allylbenzene. In some embodiments, the optionally substituted internal olefin is selected from the group consisting of 2-hexene, 3-hexene, 2-heptene, 3-heptene, 2-octene, 3-octene, and 4-octene. In some embodiments, the first monomer is ethylene.

In various embodiments, the present invention provides a polymer formed by the method for catalyzing copolymerization of a first monomer and at least one other monomer. In some embodiments, the polymer is a copolymer. In some embodiments, the copolymer is selected from the group consisting of a random copolymer, block copolymer, and gradient copolymer. In some embodiments, the copolymer is a random copolymer. In some embodiments, the copolymer is a block copolymer. In some embodiments, the copolymer is a gradient copolymer.

In various embodiments, the present invention provides a copolymer made by a method of making a copolymer as provided herein. In various embodiments, the present invention provides a polymer made by a method of making a copolymer as provided herein. In some embodiments, the polymer is a copolymer. In some embodiments, the copolymer is selected from the group consisting of a random copolymer, block copolymer, and gradient copolymer. In some embodiments, the polymer is monomodal or bimodal. In some embodiments, the polymer is monomodal. In some embodiments, the polymer is bimodal. In some embodiments, the polymer is monomodal, or bimodal, or combination thereof. In some embodiments, the copolymer is monomodal or bimodal. In some embodiments, the copolymer is monomodal. In some embodiments, the copolymer is bimodal. In some embodiments, the copolymer is monomodal, or bimodal, or combination thereof. In some embodiments, the first monomer is CO₂; and the at least one other monomer is an epoxide.

In some embodiments, the optionally substituted olefin is a polar olefin.

Some embodiments of the present invention can be defined as any of the following numbered paragraphs:
1. A catalyst having a structure selected from:

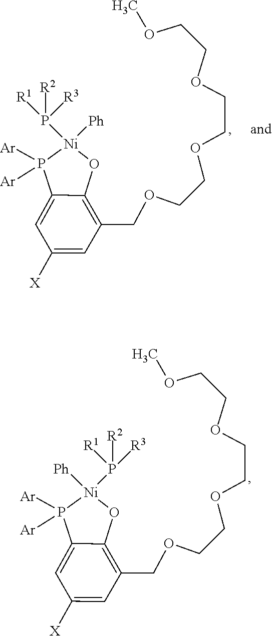

wherein, Ar is 2,6-dimethoxyphenyl; Ph is a phenyl group; X is an electron donating group, or an electron withdrawing group; and R¹, R², and R³ are each independently selected from optionally substituted aryl, optionally substituted alkyl, and optionally substituted cycloalkyl.
2. The catalyst of claim 1, wherein the catalyst is:

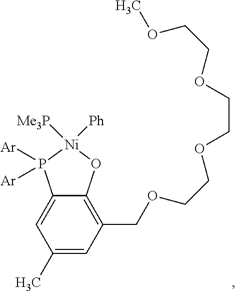

wherein, Ar is 2,6-dimethoxyphenyl; Ph is a phenyl group; and PMe₃ is trimethylphosphine.
3. The catalyst of claim 1, wherein the catalyst is:

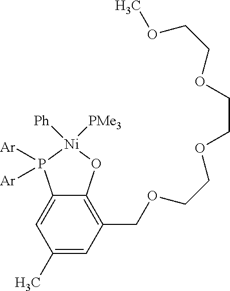

wherein, Ar is 2,6-dimethoxyphenyl; Ph is a phenyl group; and PMe₃ is trimethylphosphine.
4. A method for catalyzing homopolymerization of ethylene, comprising: combining ethylene with the catalyst of any one of claims 1-3, whereby the ethylene undergoes homopolymerization.
5. The method of claim 4, wherein the step of combining ethylene with the catalyst is performed in the presence of at least one solvent.
6. The method of claim 5, wherein the at least one solvent is a non-polar solvent, a polar solvent, or combination thereof.
7. A polymer formed by the method of any one of claims 4-6.
8. The polymer of claim 7, wherein the polymer is monomodal or bimodal.
9. A method for catalyzing copolymerization of ethylene and at least one other olefin, comprising: combining ethylene and the at least one other olefin with the catalyst of any one of claims 1-3, whereby the ethylene and the at least one other olefin undergo copolymerization, and wherein the at least one other olefin is optionally substituted.
10. The method of claim 9, wherein the step of combining ethylene and the at least one other olefin with the catalyst is performed in the presence of at least one solvent.
11. The method of claim 10, wherein the at least one solvent is a non-polar solvent, a polar solvent, or combination thereof.
12. A copolymer formed by the method of any one of claims 9-11.
13. The copolymer of claim 12, wherein the copolymer is monomodal or bimodal.
14. A heterobimetallic catalyst having a structure selected from:

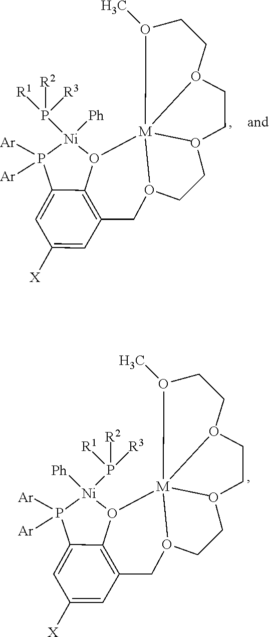

wherein, Ar is 2,6-dimethoxyphenyl; Ph is a phenyl group; M is Li, Na, K, or Cs; X is an electron donating group, or an electron withdrawing group; and R¹, R², and R³ are each independently selected from optionally substituted aryl, optionally substituted alkyl, and optionally substituted cycloalkyl.
15. The heterobimetallic catalyst of claim 14, wherein the heterobimetallic catalyst is:

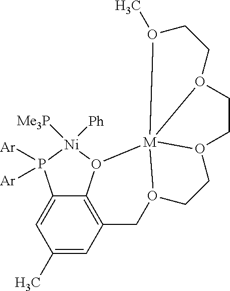

wherein, Ar is 2,6-dimethoxyphenyl; Ph is a phenyl group; M is Li, Na, K, or Cs; and PMe₃ is trimethylphosphine.
16. The heterobimetallic catalyst of claim 14, wherein the heterobimetallic catalyst is:

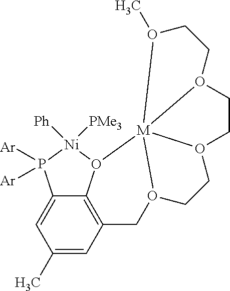

wherein, Ar is 2,6-dimethoxyphenyl; Ph is a phenyl group; M is Li, Na, K, or Cs; and PMe₃ is trimethylphosphine.
17. A method for catalyzing homopolymerization of ethylene, comprising: combining ethylene with the heterobimetallic catalyst of any one of claims 14-16, whereby the ethylene undergoes homopolymerization.
18. The method of claim 17, wherein the step of combining ethylene with the heterobimetallic catalyst is performed in the presence of at least one solvent.
19. The method of claim 18, wherein the at least one solvent is a non-polar solvent, a polar solvent, or combination thereof.
20. A polymer formed by the method of any one of claims 17-19.
21. The polymer of claim 20, wherein the polymer is monomodal or bimodal.
22. A method for catalyzing copolymerization of ethylene and at least one other olefin, comprising: combining ethylene and the at least one other olefin with the heterobimetallic catalyst of any one of claims 14-16, whereby the ethylene and the at least one other olefin undergo copolymerization, and wherein the at least one other olefin is optionally substituted.
23. The method of claim 22, wherein the step of combining ethylene and the at least one other olefin with the heterobimetallic catalyst is performed in the presence of at least one solvent.
24. The method of claim 23, wherein the at least one solvent is a non-polar solvent, a polar solvent, or combination thereof.
25. A polymer formed by the method of any one of claims 22-24.
26. The polymer of claim 25, wherein the polymer is monomodal or bimodal.
27. A bimetallic complex selected from Formula Ia and Formula Ib:

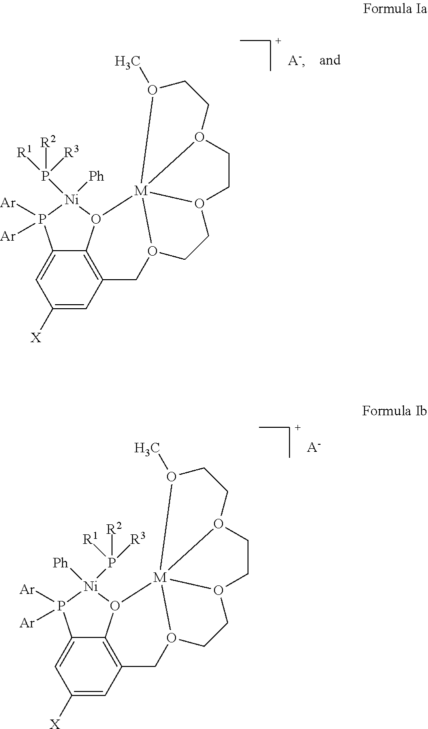

wherein, Ar is 2,6-dimethoxyphenyl; Ph is a phenyl group; M is Li, Na, K, or Cs; A is a weakly coordinating anion; X is an electron donating group, or an electron withdrawing group; and R¹, R², and R³ are each independently selected from optionally substituted aryl, optionally substituted alkyl, and optionally substituted cycloalkyl.
28. The bimetallic complex of claim 27, wherein the bimetallic complex of Formula 1a is:

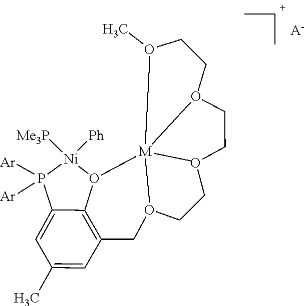

wherein, Ar is 2,6-dimethoxyphenyl; Ph is a phenyl group; M is Li, Na, K, or Cs; A⁻ is [(3,5-(CF₃)₂C₆H₃)₄B]⁻; and PMe₃ is trimethylphosphine.
29. The bimetallic complex of claim 27, wherein the bimetallic complex of Formula Ib is:

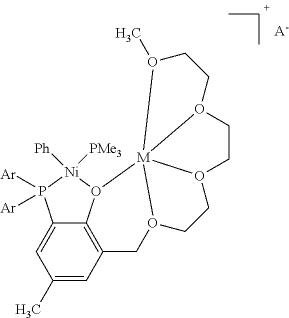

wherein, Ar is 2,6-dimethoxyphenyl; Ph is a phenyl group; M is Li, Na, K, or Cs; A⁻ is [(3,5-(CF₃)₂C₆H₃)₄B]⁻; and PMe₃ is trimethylphosphine.
30. A method for catalyzing homopolymerization of ethylene, comprising: combining ethylene with the bimetallic complex of any one of claims 27-29, whereby the ethylene undergoes homopolymerization.
31. The method of claim 30, wherein the step of combining ethylene with the bimetallic complex is performed in the presence of at least one solvent.
32. The method of claim 31, wherein the at least one solvent is a non-polar solvent, a polar solvent, or combination thereof.
33. A polymer formed by the method of any one of claims 30-32.
34. The polymer of claim 33, wherein the polymer is monomodal or bimodal.
35. A method for catalyzing copolymerization of ethylene and at least one other olefin, comprising: combining ethylene and the at least one other olefin with the bimetallic complex of any one of claims 27-29, whereby the ethylene and the at least one other olefin undergo copolymerization, and wherein the at least one other olefin is optionally substituted.
36. The method of claim 35, wherein the step of combining ethylene and the at least one other olefin with the bimetallic complex is performed in the presence of at least one solvent.
37. The method of claim 36, wherein the at least one solvent is a non-polar solvent, a polar solvent, or combination thereof.
38. A polymer formed by the method of any one of claims 35-37.
39. The polymer of claim 38, wherein the polymer is monomodal or bimodal.

Some embodiments of the present invention can be defined as any of the following numbered paragraphs:
1. A catalyst having a structure selected from Formula (1) and Formula (2):

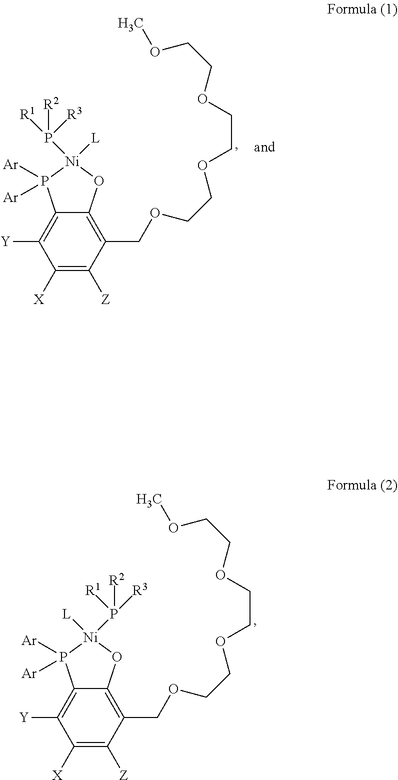

wherein in Formula (1) and Formula (2): Ar is 2,6-dimethoxyphenyl; L is an optionally substituted phenyl group; X, Y, and Z are each independently selected from hydrogen, an electron donating group, and an electron withdrawing group; and R¹, R², and R³ are each independently selected from optionally substituted aryl, optionally substituted alkyl, and optionally substituted cycloalkyl.
2. A catalyst having a structure of Formula (1):

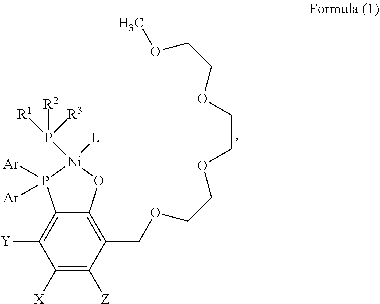

wherein, Ar is 2,6-dimethoxyphenyl; L is an optionally substituted phenyl group; X, Y, and Z are each independently selected from hydrogen, an electron donating group, and an electron withdrawing group; and R¹, R², and R³ are each independently selected from optionally substituted aryl, optionally substituted alkyl, and optionally substituted cycloalkyl.
3. A catalyst having a structure of Formula (2):

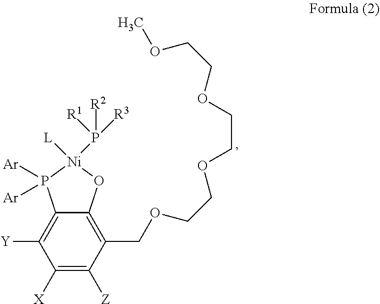

wherein, Ar is 2,6-dimethoxyphenyl; L is an optionally substituted phenyl group; X, Y, and Z are each independently selected from hydrogen, an electron donating group, and an electron withdrawing group; and R¹, R², and R³ are each independently selected from optionally substituted aryl, optionally substituted alkyl, and optionally substituted cycloalkyl.
4. A catalyst having a structure selected from Formula (1-A) and Formula (2-A):

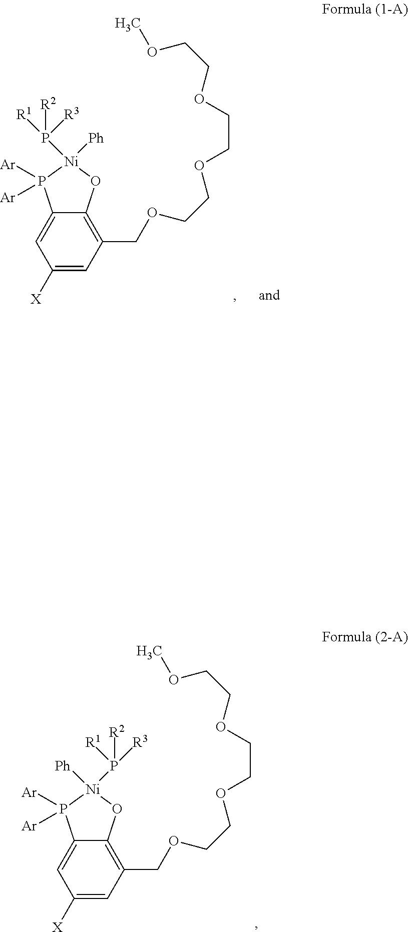

wherein in Formula (1-A) and Formula (2-A): Ar is 2,6-dimethoxyphenyl; Ph is a phenyl group; X is hydrogen, an electron donating group, or an electron withdrawing group; and R¹, R², and R³ are each independently selected from optionally substituted aryl, optionally substituted alkyl, and optionally substituted cycloalkyl.

S. A catalyst having a structure of Formula (1-A):

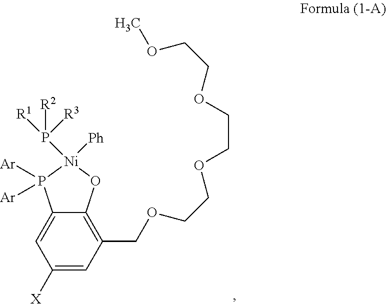

wherein, Ar is 2,6-dimethoxyphenyl; Ph is a phenyl group; X is hydrogen, an electron donating group, or an electron withdrawing group; and R¹, R², and R³ are each independently selected from optionally substituted aryl, optionally substituted alkyl, and optionally substituted cycloalkyl.
6. A catalyst having a structure of Formula (2-A):

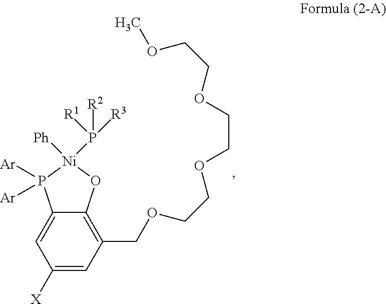

wherein, Ar is 2,6-dimethoxyphenyl; Ph is a phenyl group; X is hydrogen, an electron donating group, or an electron withdrawing group; and R¹, R², and R³ are each independently selected from optionally substituted aryl, optionally substituted alkyl, and optionally substituted cycloalkyl.
7. A catalyst having a structure selected from Formula (1-B) and Formula (2-B):

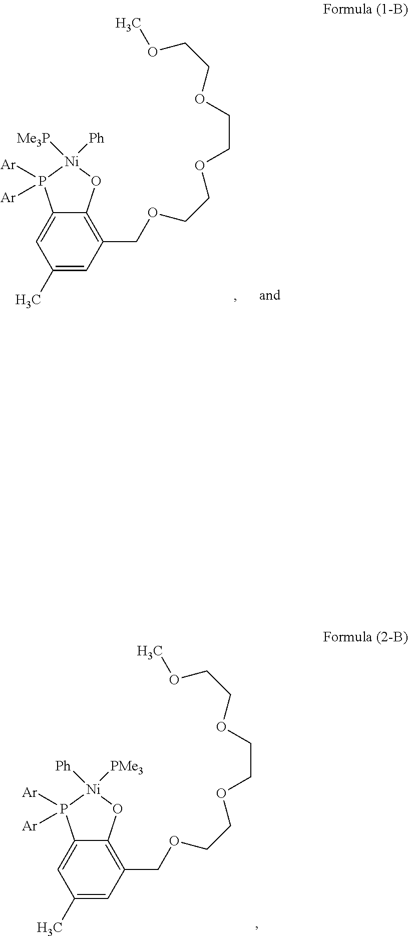

wherein in Formula (1-B) and Formula (2-B): Ar is 2,6-dimethoxyphenyl; Ph is a phenyl group; and PMe₃ is trimethylphosphine.
8. A catalyst having a structure of Formula (1-B):

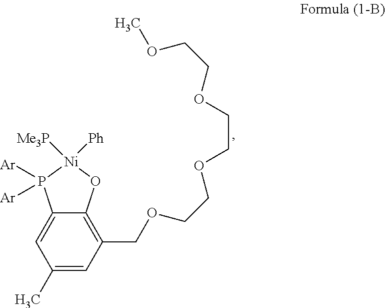

wherein, Ar is 2,6-dimethoxyphenyl; Ph is a phenyl group; and PMe₃ is trimethylphosphine.
9. A catalyst having a structure of Formula (2-B):

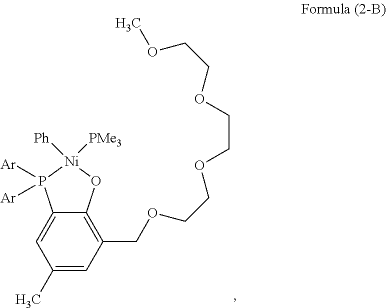

wherein, Ar is 2,6-dimethoxyphenyl; Ph is a phenyl group; and PMe₃ is trimethylphosphine.
10. The catalyst of any one of paragraphs 1-6, wherein the electron donating group is selected from the group consisting of: alkoxy, amino, hydroxy, and alkyl.
11. The catalyst of paragraph 10, wherein alkyl is selected from the group consisting of: —CH₃, —CH₂CH₃, —CH₂CH₂CH₃, and —CH(CH₃)₂.
12. The catalyst of any one of paragraphs 1-6, wherein the electron withdrawing group is selected from the group consisting of: NO₂, —CN, —C(O)-alkyl, and halo.
13. The catalyst of any one of paragraphs 1-12, wherein the phenyl group is

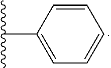 [SMILES: *c1ccccc1]

14. A method for catalyzing homopolymerization of an optionally substituted olefin, comprising: combining or contacting an optionally substituted olefin with the catalyst of any one of paragraphs 1-13, whereby the optionally substituted olefin undergoes homopolymerization.
15. The method of paragraph 14, wherein the step of combining or contacting the optionally substituted olefin with the catalyst is performed in the presence of at least one solvent.
16. The method of paragraph 15, wherein the at least one solvent is a non-polar solvent, a polar solvent, or combination thereof.
17. The method of any one of paragraphs 14-16, further comprising combining or contacting at least one activator with the catalyst and the optionally substituted olefin.
18. The method of paragraph 17, wherein the at least one activator is Ni(COD)₂ or triarylborane.
19. The method of any one of paragraphs 14-18, wherein the optionally substituted olefin is an optionally substituted terminal olefin or an optionally substituted internal olefin.
20. The method of any one of paragraphs 14-18, wherein the optionally substituted olefin is ethylene.
21. A polymer formed by the method of any one of paragraphs 14-20.
22. The polymer of paragraph 21, wherein the polymer is monomodal or bimodal.
23. A method for polymerizing an optionally substituted olefin, the method comprising contacting an optionally substituted olefin with the catalyst of any one of paragraphs 1-13 and at least one activator under conditions effective to polymerize the optionally substituted olefin.
24. The method of paragraph 23, wherein the at least one activator is Ni(COD)₂ or triarylborane.
25. The method of paragraph 23 or 24, wherein the step of contacting the optionally substituted olefin with the catalyst and the at least one activator is performed in the presence of at least one solvent.
26. The method of paragraph 25, wherein the at least one solvent is a non-polar solvent, a polar solvent, or combination thereof.
27. The method of any one of paragraphs 23-26, wherein the optionally substituted olefin is an optionally substituted terminal olefin or an optionally substituted internal olefin.
28. The method of any one of paragraphs 23-26, wherein the optionally substituted olefin is ethylene.
29. A polymer formed by the method of any one of paragraphs 23-28.
30. The polymer of paragraph 29, wherein the polymer is monomodal or bimodal.
31. A method for catalyzing copolymerization of a first olefin and at least one other olefin, comprising: combining or contacting a first olefin and at least one other olefin with the catalyst of any one of paragraphs 1-13, whereby the first olefin and the at least one other olefin undergoes copolymerization, and wherein the first olefin and the at least one other olefin are different from one another.
32. The method of paragraph 31, wherein the step of combining or contacting the first olefin and the at least one other olefin with the catalyst is performed in the presence of at least one solvent.
33. The method of paragraph 32, wherein the at least one solvent is a non-polar solvent, a polar solvent, or combination thereof.
34. The method of any one of paragraphs 31-33, further comprising combining or contacting at least one activator with the catalyst, the first olefin, and the at least one other olefin.
35. The method of paragraph 34, wherein the at least one activator is Ni(COD)₂ or triarylborane.
36. The method of any one of paragraphs 31-35, wherein the first olefin and the at least one other olefin are each independently an optionally substituted olefin.
37. The method of any one of paragraphs 31-35, wherein the first olefin and the at least one other olefin are each independently an optionally substituted terminal olefin or an optionally substituted internal olefin.
38. The method of any one of paragraphs 31-37, wherein the first olefin is ethylene.
39. A polymer formed by the method of any one of paragraphs 31-38.
40. The polymer of paragraph 39, wherein the polymer is monomodal or bimodal.
41. A method for copolymerizing a first olefin and at least one other olefin, the method comprising contacting the first olefin and the at least one other olefin with the catalyst of any one of paragraphs 1-13 and at least one activator under conditions effective to copolymerize the first olefin and the at least one other olefin, wherein the first olefin and the at least one other olefin are different from one another.
42. The method of paragraph 41, wherein the at least one activator is Ni(COD), or triarylborane.
43. The method of paragraph 41 or 42, wherein the step of contacting the first olefin and the at least one other olefin with the catalyst and the at least one activator is performed in the presence of at least one solvent.
44. The method of paragraph 43, wherein the at least one solvent is a non-polar solvent, a polar solvent, or combination thereof.
45. The method of any one of paragraphs 41-44, wherein the first olefin and the at least one other olefin are each independently an optionally substituted olefin.
46. The method of any one of paragraphs 41-44, wherein the first olefin and the at least one other olefin are each independently an optionally substituted terminal olefin or an optionally substituted internal olefin.
47. The method of any one of paragraphs 41-46, wherein the first olefin is ethylene.
48. A polymer formed by the method of any one of paragraphs 41-47.
49. The polymer of paragraph 48, wherein the polymer is monomodal or bimodal.
50. A method for making a compound, the method comprising contacting a reactant with a catalyst of any one of paragraphs 1-13 under conditions effective to make the compound.
51. The method of paragraph 50, wherein the step of contacting the reactant with the catalyst is performed in the presence of at least one solvent.
52. The method of paragraph 51, wherein the at least one solvent is a non-polar solvent, a polar solvent, or combination thereof.
53. The method of any one of paragraphs 50-52, further comprising contacting at least one activator with the catalyst and the reactant.
54. The method of paragraph 53, wherein the at least one activator is Ni(COD), or triarylborane.
55. The method of any one of paragraphs 50-54, wherein the compound is a small molecule.
56. The method of any one of paragraphs 50-55, wherein the method is a cascade method.
57. A method for making a compound, the method comprising contacting a first reactant and at least one other reactant with a catalyst of any one of paragraphs 1-13 under conditions effective to make the compound.
58. The method of paragraph 57, wherein the step of contacting the first reactant and the at least one other reactant with the catalyst is performed in the presence of at least one solvent.
59. The method of paragraph 58, wherein the at least one solvent is a non-polar solvent, a polar solvent, or combination thereof.
60. The method of any one of paragraphs 57-59, further comprising contacting at least one activator with the catalyst, the first reactant, and the at least one other reactant.
61. The method of paragraph 60, wherein the at least one activator is Ni(COD)₂ or triarylborane.
62. The method of any one of paragraphs 57-61, wherein the compound is a small molecule.
63. The method of any one of paragraphs 57-62, wherein the method is a cascade method.
64. The method of any one of paragraphs 57-63, wherein the first reactant and the at least one other reactant are different from one another.
65. A method of making a polymer, comprising contacting a monomer with the catalyst of any one of paragraphs 1-13.
66. The method of paragraph 65, wherein the step of contacting the monomer with the catalyst is performed in the presence of at least one solvent.
67. The method of paragraph 66, wherein the at least one solvent is a non-polar solvent, a polar solvent, or combination thereof.
68. The method of any one of paragraphs 65-67, further comprising contacting at least one activator with the catalyst and the monomer.
69. The method of paragraph 68, wherein the at least one activator is Ni(COD)₂ or triarylborane.
70. The method of any one of paragraphs 65-69, wherein the monomer is an optionally substituted olefin.
71. The method of any one of paragraphs 65-69, wherein the monomer is an optionally substituted terminal olefin or an optionally substituted internal olefin.
72. The method of any one of paragraphs 65-71, wherein the monomer is ethylene.
73. The method of any one of paragraphs 65-72, wherein the polymer is bimodal or monomodal.
74. A polymer made by the method of any one of paragraphs 65-72.
75. The polymer of paragraph 74, wherein the polymer is bimodal or monomodal.
76. A method of making a copolymer, comprising contacting a first monomer and at least one other monomer with a catalyst of any one of paragraphs 1-13, wherein the first monomer and the at least one other monomer are different from one another.
77. The method of paragraph 76, wherein the step of contacting the first monomer and the at least one other monomer with the catalyst is performed in the presence of at least one solvent.
78. The method of paragraph 77, wherein the at least one solvent is a non-polar solvent, a polar solvent, or combination thereof.
79. The method of any one of paragraphs 76-78, further comprising contacting at least one activator with the catalyst, the first monomer, and the at least one other monomer.
80. The method of paragraph 79, wherein the at least one activator is Ni(COD)₂ or triarylborane.
82. The method of any one of paragraphs 76-80, wherein the first monomer and the at least one other monomer are each independently an optionally substituted olefin.
83. The method of any one of paragraphs 76-80, wherein the first monomer and the at least one other monomer are each independently an optionally substituted terminal olefin or an optionally substituted internal olefin.
84. The method of any one of paragraphs 76-83, wherein the first monomer is ethylene.
85. The method of any one of paragraphs of 76-84, wherein the copolymer is bimodal or monomodal.
86. A copolymer made by the method of any one of paragraphs 76-84.
87. The copolymer of paragraph 86, wherein the copolymer is monomodal or bimodal.
88. The method of any one of paragraphs 76-80, wherein the first monomer is CO₂; and the at least one other monomer is an epoxide.
89. A heterobimetallic catalyst having a structure selected from Formula (3) and Formula (4):

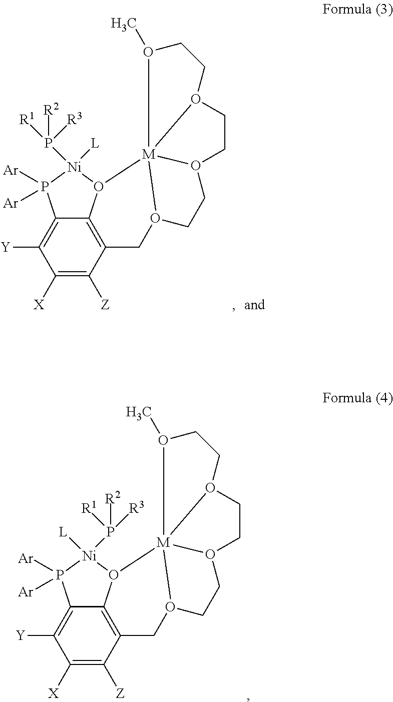

wherein in Formula (3) and Formula (4): Ar is 2,6-dimethoxyphenyl; L is an optionally substituted phenyl group; M is Li, Na, K, or Cs; X, Y, and Z are each independently selected from hydrogen, an electron donating group, and an electron withdrawing group; and R¹, R², and R³ are each independently selected from optionally substituted aryl, optionally substituted alkyl, and optionally substituted cycloalkyl.
90. A heterobimetallic catalyst having a structure of Formula (3):

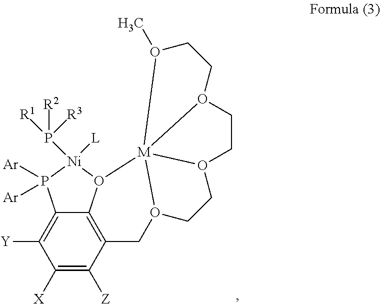

wherein, Ar is 2,6-dimethoxyphenyl; L is an optionally substituted phenyl group; M is Li, Na, K, or Cs; X, Y, and Z are each independently selected from hydrogen, an electron donating group, and an electron withdrawing group; and R¹, R², and R³ are each independently selected from optionally substituted aryl, optionally substituted alkyl, and optionally substituted cycloalkyl.
91. A heterobimetallic catalyst having a structure of Formula (4):

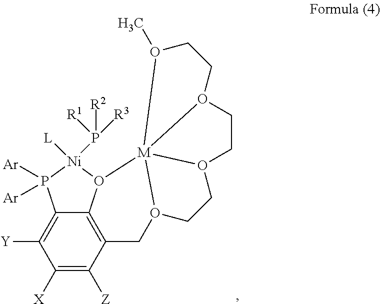

wherein, Ar is 2,6-dimethoxyphenyl; L is an optionally substituted phenyl group; M is Li, Na, K, or Cs; X, Y, and Z are each independently selected from hydrogen, an electron donating group, and an electron withdrawing group; and R¹, R², and R³ are each independently selected from optionally substituted aryl, optionally substituted alkyl, and optionally substituted cycloalkyl.
92. A heterobimetallic catalyst having a structure selected from Formula (3-A) and Formula (4-A):

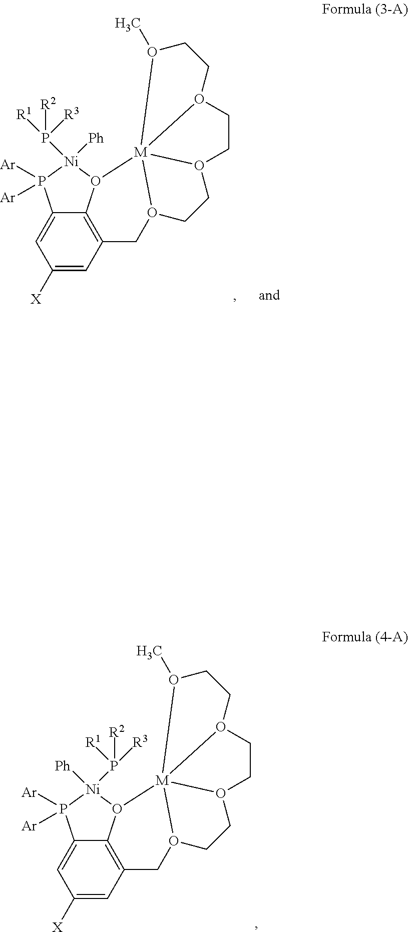

wherein in Formula (3-A) and Formula (4-A): Ar is 2,6-dimethoxyphenyl; Ph is a phenyl group; M is Li, Na, K, or Cs; X is hydrogen, an electron donating group, or an electron withdrawing group; and R¹, R², and R³ are each independently selected from optionally substituted aryl, optionally substituted alkyl, and optionally substituted cycloalkyl.
93. A heterobimetallic catalyst having a structure of Formula (3-A):

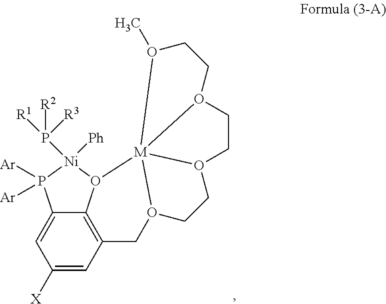

wherein, Ar is 2,6-dimethoxyphenyl; Ph is a phenyl group; M is Li, Na, K, or Cs; X is hydrogen, an electron donating group, or an electron withdrawing group; and R¹, R², and R³ are each independently selected from optionally substituted aryl, optionally substituted alkyl, and optionally substituted cycloalkyl.
94. A heterobimetallic catalyst having a structure of Formula (4-A):

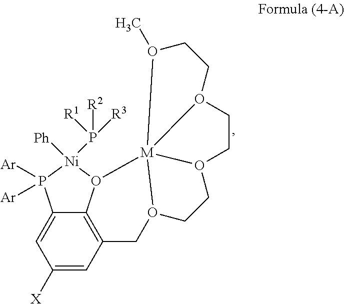

wherein, Ar is 2,6-dimethoxyphenyl; Ph is a phenyl group; M is Li, Na, K, or Cs; X is hydrogen, an electron donating group, or an electron withdrawing group; and R¹, R², and R³ are each independently selected from optionally substituted aryl, optionally substituted alkyl, and optionally substituted cycloalkyl.
95. A heterobimetallic catalyst having a structure selected from Formula (3-B) and Formula (4-B):

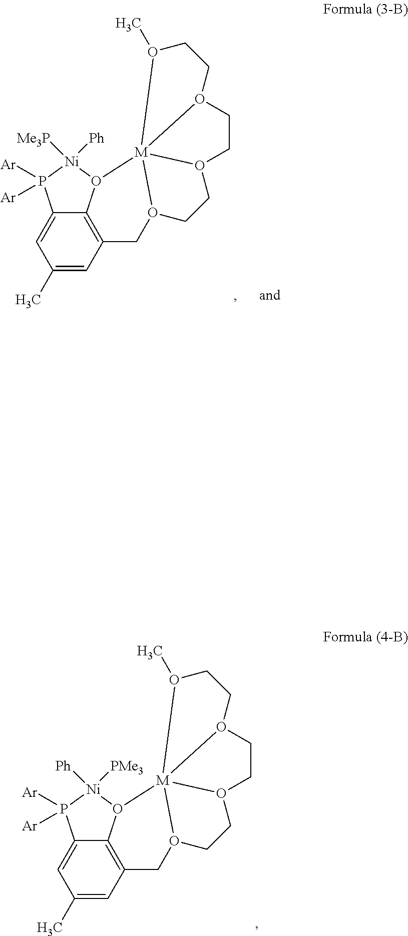

wherein in Formula (3-B) and Formula (4-B): Ar is 2,6-dimethoxyphenyl; Ph is a phenyl group; M is Li, Na, K, or Cs; and PMe₃ is trimethylphosphine. 96. A heterobimetallic catalyst having a structure of Formula (3-B):

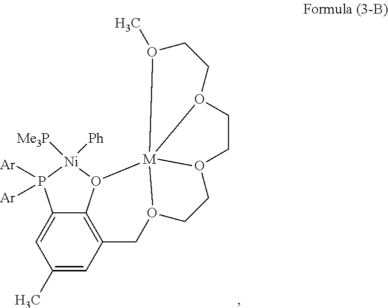

wherein, Ar is 2,6-dimethoxyphenyl; Ph is a phenyl group; M is Li, Na, K, or Cs, and PMe; is trimethylphosphine.
97. A heterobimetallic catalyst having a structure of Formula (4-B):

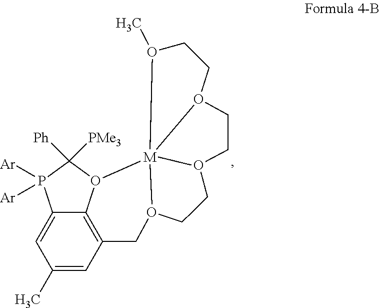

wherein, Ar is 2,6-dimethoxyphenyl; Ph is a phenyl group; M is Li, Na, K, or Cs; and PMe₃ is trimethylphosphine.
98. The catalyst of any one of paragraphs 89-94, wherein the electron donating group is selected from the group consisting of: alkoxy, amino, hydroxy, and alkyl.
99. The catalyst of paragraph 98, wherein alkyl is selected from the group consisting of: —CH₃, —CH₂CH₃, —CH₂CH₂CH₃, and —CH(CH₃)₂.
100. The catalyst of any one of paragraphs 89-94, wherein the electron withdrawing group is selected from the group consisting of: NO₂, —CN, —C(O)-alkyl, and halo.
101. The catalyst of any one of paragraphs 89-100, wherein the phenyl group is

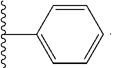 [SMILES: *c1ccccc1]

102. A method for catalyzing homopolymerization of an optionally substituted olefin, comprising: combining or contacting an optionally substituted olefin with the heterobimetallic catalyst of any one of paragraphs 89-101, whereby the optionally substituted olefin undergoes homopolymerization.
103. The method of paragraph 102, wherein the step of combining or contacting the optionally substituted olefin with the heterobimetallic catalyst is performed in the presence of at least one solvent.
104. The method of paragraph 103, wherein the at least one solvent is a non-polar solvent, a polar solvent, or combination thereof.
105. The method of any one of paragraphs 102-104, further comprising combining or contacting at least one activator with the heterobimetallic catalyst and the optionally substituted olefin.
106. The method of paragraph 105, wherein the at least one activator is Ni(COD)₂ or triarylborane.
107. The method of any one of paragraphs 102-106, wherein the optionally substituted olefin is an optionally substituted terminal olefin or an optionally substituted internal olefin.
108. The method of any one of paragraphs 102-106, wherein the optionally substituted olefin is ethylene.
109. A polymer formed by the method of any one of paragraphs 102-108.
110. The polymer of paragraph 109, wherein the polymer is monomodal or bimodal.
111. A method for polymerizing an optionally substituted olefin, the method comprising contacting an optionally substituted olefin with the heterobimetallic catalyst of any one of paragraphs 89-101 and at least one activator under conditions effective to polymerize the optionally substituted olefin.
112. The method of paragraph 111, wherein the at least one activator is Ni(COD)₂ or triarylborane.
113. The method of paragraph 111 or 112, wherein the step of contacting the optionally substituted olefin with the heterobimetallic catalyst and the at least one activator is performed in the presence of at least one solvent.
114. The method of paragraph 113, wherein the at least one solvent is a non-polar solvent, a polar solvent, or combination thereof.
115. The method of any one of paragraphs 111-114, wherein the optionally substituted olefin is an optionally substituted terminal olefin or an optionally substituted internal olefin.
116. The method of any one of paragraphs 111-114, wherein the optionally substituted olefin is ethylene.
117. A polymer formed by the method of any one of paragraphs 111-116.
118. The polymer of paragraph 117, wherein the polymer is monomodal or bimodal
119. A method for catalyzing copolymerization of a first olefin and at least one other olefin, comprising: combining or contacting a first olefin and at least one other olefin with the heterobimetallic catalyst of any one of paragraphs 89-101, whereby the first olefin and the at least one other olefin undergoes copolymerization, and wherein the first olefin and the at least one other olefin are different from one another.
120. The method of paragraph 119, wherein the step of combining or contacting the first olefin and the at least one other olefin with the heterobimetallic catalyst is performed in the presence of at least one solvent.
121. The method of paragraph 120, wherein the at least one solvent is a non-polar solvent, a polar solvent, or combination thereof.
122. The method of any one of paragraphs 119-121, further comprising combining or contacting at least one activator with the heterobimetallic catalyst, the first olefin, and the at least one other olefin.
123. The method of paragraph 122, wherein the at least one activator is Ni(COD)₂ or triarylborane.
124. The method of any one of paragraphs 119-123, wherein the first olefin and the at least one other olefin are each independently an optionally substituted olefin.
125. The method of any one of paragraphs 119-123, wherein the first olefin and the at least one other olefin are each independently an optionally substituted terminal olefin or an optionally substituted internal olefin.
126. The method of any one of paragraphs 119-125, wherein the first olefin is ethylene.
127. A polymer formed by the method of any one of paragraphs 119-126.
128. The polymer of paragraph 127, wherein the polymer is monomodal or bimodal.
129. A method for copolymerizing a first olefin and at least one other olefin, the method comprising contacting the first olefin and the at least one other olefin with the heterobimetallic catalyst of any one of paragraphs 89-101 and at least one activator under conditions effective to copolymerize the first olefin and the at least one other olefin, wherein the first olefin and the at least one other olefin are different from one another.
130. The method of paragraph 129, wherein the at least one activator is Ni(COD)₂.
131. The method of paragraph 129 or 130, wherein the step of contacting the first olefin and the at least one other olefin with the heterobimetallic catalyst and the at least one activator is performed in the presence of at least one solvent.
132. The method of paragraph 131, wherein the at least one solvent is a non-polar solvent, a polar solvent, or combination thereof.
133. The method of any one of paragraphs 129-132, wherein the first olefin and the at least one other olefin are each independently an optionally substituted olefin.
134. The method of any one of paragraphs 129-132, wherein the first olefin and the at least one other olefin are each independently an optionally substituted terminal olefin or an optionally substituted internal olefin.
135. The method of any one of paragraphs 129-134, wherein the first olefin is ethylene.
136. A polymer formed by the method of any one of paragraphs 129-135.
137. The polymer of paragraph 136, wherein the polymer is monomodal or bimodal.
138. A method for making a compound, the method comprising contacting a reactant with a heterobimetallic catalyst of any one of paragraphs 89-101 under conditions effective to make the compound.
139. The method of paragraph 138, wherein the step of contacting the reactant with the heterobimetallic catalyst is performed in the presence of at least one solvent.
140. The method of paragraph 139, wherein the at least one solvent is a non-polar solvent, a polar solvent, or combination thereof.
141. The method of any one of paragraphs 138-140, further comprising contacting at least one activator with the heterobimetallic catalyst and the reactant.
142. The method of paragraph 141, wherein the at least one activator is Ni(COD)₂.
143. The method of any one of paragraphs 138-142, wherein the compound is a small molecule.
144. The method of any one of paragraphs 138-143, wherein the method is a cascade method.
145. A method for making a compound, the method comprising contacting a first reactant and at least one other reactant with a heterobimetallic catalyst of any one of paragraphs 89-101 under conditions effective to make the compound.
146. The method of paragraph 145, wherein the step of contacting the first reactant and the at least one other reactant with the heterobimetallic catalyst is performed in the presence of at least one solvent.
147. The method of paragraph 146, wherein the at least one solvent is a non-polar solvent, a polar solvent, or combination thereof.
148. The method of any one of paragraphs 145-147, further comprising contacting at least one activator with the catalyst, the first reactant, and the at least one other reactant.
149. The method of paragraph 148, wherein the at least one activator is Ni(COD)₂.
150. The method of any one of paragraphs 145-149, wherein the compound is a small molecule.
151. The method of any one of paragraphs 145-150, wherein the method is a cascade method.
152. The method of any one of paragraphs 145-151, wherein the first reactant and the at least one other reactant are different from one another.
153. A method of making a polymer, comprising contacting a monomer with the heterobimetallic catalyst of any one of paragraphs 89-101.
154. The method of paragraph 153, wherein the step of contacting the monomer with the heterobimetallic catalyst is performed in the presence of at least one solvent.
155. The method of paragraph 154, wherein the at least one solvent is a non-polar solvent, a polar solvent, or combination thereof.
156. The method of any one of paragraphs 153-155, further comprising contacting at least one activator with the heterobimetallic catalyst and the monomer.
157. The method of paragraph 156, wherein the at least one activator is Ni(COD)₂.
158. The method of any one of paragraphs 153-157, wherein the monomer is an optionally substituted olefin.
159. The method of any one of paragraphs 153-158, wherein the monomer is an optionally substituted terminal olefin or an optionally substituted internal olefin.
160. The method of any one of paragraphs 153-159, wherein the monomer is ethylene.
161. The method of any one of paragraphs 153-160, wherein the polymer is bimodal or monomodal.
162. A polymer made by the method of any one of paragraphs 153-160.
163. The polymer of paragraph 162, wherein the polymer is bimodal or monomodal.
164. A method of making a copolymer, comprising contacting a first monomer and at least one other monomer with a heterobimetallic catalyst of any one of paragraphs 89-101, wherein the first monomer and the at least one other monomer are different from one another.
165. The method of paragraph 164, wherein the step of contacting the first monomer and the at least one other monomer with the heterobimetallic catalyst is performed in the presence of at least
166. The method of paragraph 165, wherein the at least one solvent is a non-polar solvent, a polar solvent, or combination thereof.
167. The method of any one of paragraphs 164-166, further comprising contacting at least one activator with the heterobimetallic catalyst, the first monomer, and the at least one other monomer.
168. The method of paragraph 167, wherein the at least one activator is Ni(COD)₂.
169. The method of any one of paragraphs 164-168, wherein the first monomer and the at least one other monomer are each independently an optionally substituted olefin.
170. The method of any one of paragraphs 164-168 wherein the first monomer and the at least one other monomer are each independently an optionally substituted terminal olefin or an optionally substituted internal olefin.
171. The method of any one of paragraphs 164-170, wherein the first monomer is ethylene.
172. The method of any one of paragraphs of 164-171, wherein the copolymer is bimodal or monomodal.
173. A copolymer made by the method of any one of paragraphs 164-172.
174. The copolymer of paragraph 173, wherein the copolymer is monomodal or bimodal.
175. The method of any one of paragraphs 164-168, wherein the first monomer is CO₂; and the at least one other monomer is an epoxide.
176. A bimetallic catalyst complex having a structure selected from Formula (5) and Formula (6):

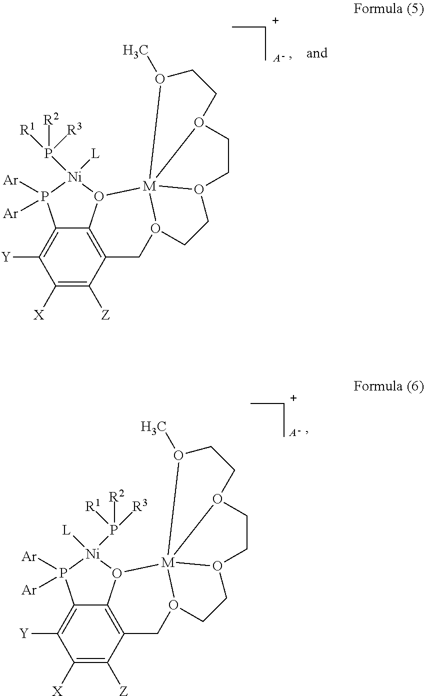

wherein in Formula (5) and Formula (6): Aris 2,6-dimethoxyphenyl; L is an optionally substituted phenyl group; M is Li, Na, K, or Cs; A⁻ is a weakly coordinating anion; X, Y, and Z are each independently selected from hydrogen, an electron donating group, and an electron withdrawing group; and R¹, R², and R³ are each independently selected from optionally substituted aryl, optionally substituted alkyl, and optionally substituted cycloalkyl.
177. A bimetallic catalyst complex having a structure of Formula(S):

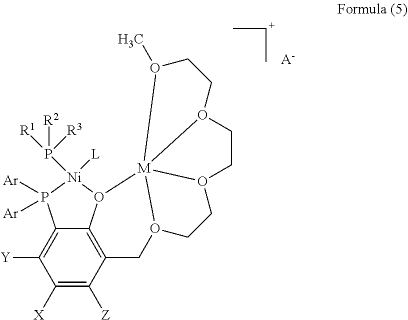

wherein, Ar is 2,6-dimethoxyphenyl; L is an optionally substituted phenyl group; M is Li, Na, K, or Cs; A⁻ is a weakly coordinating anion; X, Y, and Z are each independently selected from hydrogen, an electron donating group, and an electron withdrawing group; and R¹, R², and R³ are each independently selected from optionally substituted aryl, optionally substituted alkyl, and optionally substituted cycloalkyl.
178. A bimetallic catalyst complex having a structure of Formula (6):

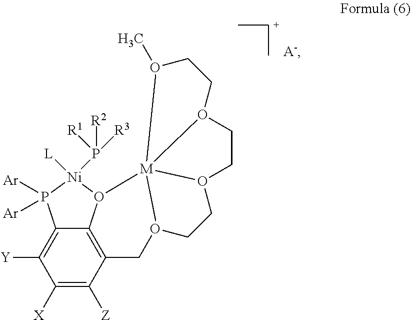

wherein, Ar is 2,6-dimethoxyphenyl; L is an optionally substituted phenyl group; M is Li, Na, K, or Cs; A⁻ is a weakly coordinating anion; X, Y, and Z are each independently selected from hydrogen, an electron donating group, and an electron withdrawing group; and R¹, R², and R³ are each independently selected from optionally substituted aryl, optionally substituted alkyl, and optionally substituted cycloalkyl.
179. A bimetallic catalyst complex having a structure selected from Formula (5-A) and Formula (6-A):

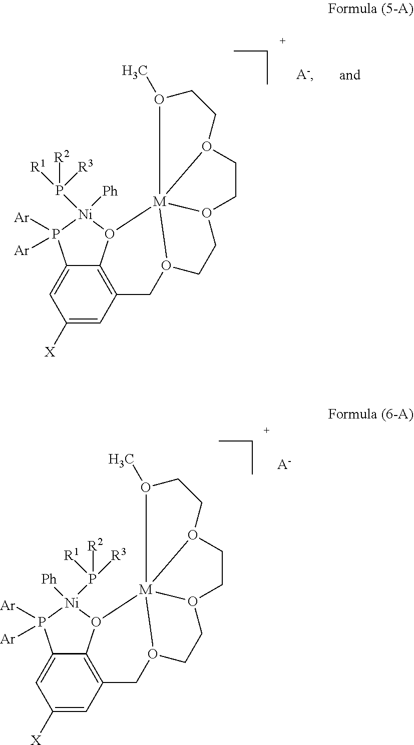

wherein Formula (5-A) and Formula (6-A): Ar is 2,6-dimethoxyphenyl; Ph is a phenyl group; M is Li, Na, K, or Cs; A⁻ is a weakly coordinating anion; X is hydrogen, an electron donating group, or an electron withdrawing group; and R¹, R², and R³ are each independently selected from optionally substituted aryl, optionally substituted alkyl, and optionally substituted cycloalkyl.
180. A bimetallic catalyst complex having a structure of Formula (5-A):

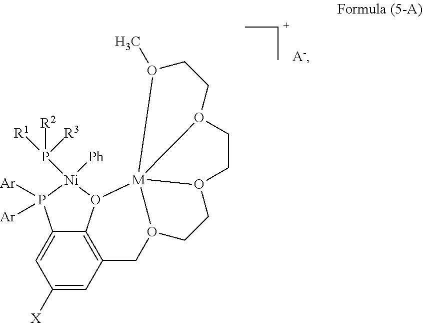

wherein, Ar is 2,6-dimethoxyphenyl; Ph is a phenyl group; M is Li, Na, K, or Cs; A is a weakly coordinating anion; X is hydrogen, an electron donating group, or an electron withdrawing group;
and R¹, R², and R³ are each independently selected from optionally substituted aryl, optionally substituted alkyl, and optionally substituted cycloalkyl.
181. A bimetallic catalyst complex having a structure of Formula (6-A):

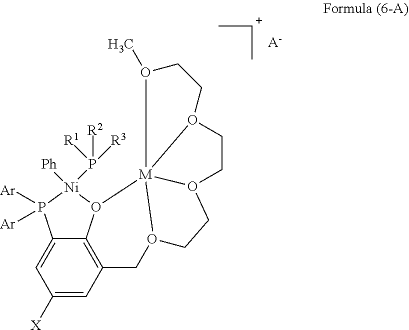

wherein, Ar is 2,6-dimethoxyphenyl; Ph is a phenyl group; M is Li, Na, K, or Cs; A is a weakly coordinating anion; X is hydrogen, an electron donating group, or an electron withdrawing group;
and R¹, R², and R³ are each independently selected from optionally substituted aryl, optionally substituted alkyl, and optionally substituted cycloalkyl.
182. A bimetallic catalyst complex having a structure selected from Formula (5-B) and Formula (6-B):

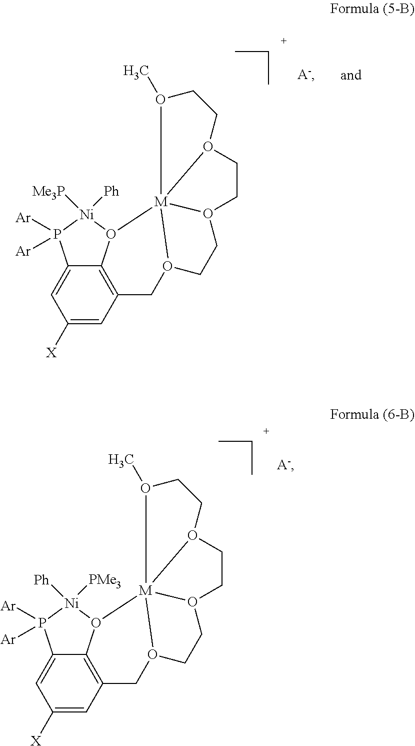

wherein Formula (5-B) and Formula (6-B): Ar is 2,6-dimethoxyphenyl; Ph is a phenyl group; M is Li, Na, K, or Cs; A⁻ is [(3,5-(CF₃)₂C₆H₃)₄B]⁻; and PMe₃ is trimethylphosphine.
183. A bimetallic catalyst complex having a structure of Formula (5-B) is:

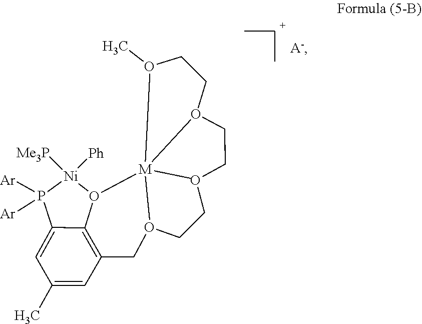

wherein, Ar is 2,6-dimethoxyphenyl; Ph is a phenyl group; M is Li, Na, K, or Cs; A⁻ is [(3,5-(CF₃)₂C₆H₃)₄B]⁻; and PMe₃ is trimethylphosphine.
184. A bimetallic catalyst complex having a structure of Formula (6-B):

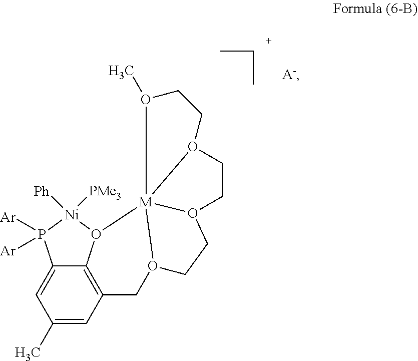

wherein, Ar is 2,6-dimethoxyphenyl; Ph is a phenyl group; M is Li, Na, K, or Cs, A⁻ is [(3,5-(CF₃)₂C₆H₃)₄B]⁻; and PMe₃ is trimethylphosphine.
185. The catalyst of any one of paragraphs 176-181, wherein the electron donating group is selected from the group consisting of: alkoxy, amino, hydroxy, and alkyl.
186. The catalyst of paragraph 185, wherein alkyl is selected from the group consisting of: —CH₃, —CH₂CH₃, —CH₂CH₂CH₃, and —CH(CH₃)₂.
187. The catalyst of any one of paragraphs 176-181, wherein the electron withdrawing group is selected from the group consisting of: NO₂, —CN, —C(O)-alkyl, and halo.
188. The catalyst of any one of paragraphs 176-187, wherein the phenyl group is

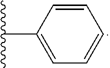 [SMILES: *c1ccccc1]

189. A method for catalyzing homopolymerization of an optionally substituted olefin, comprising: combining or contacting an optionally substituted olefin with the bimetallic catalyst complex of any one of paragraphs 176-188, whereby the optionally substituted olefin undergoes homopolymerization.
190. The method of paragraph 189, wherein the step of combining or contacting the optionally substituted olefin with the bimetallic catalyst complex is performed in the presence of at least one solvent.
191. The method of paragraph 190, wherein the at least one solvent is a non-polar solvent, a polar solvent, or combination thereof.
192. The method of any one of paragraphs 189-191, further comprising combining or contacting at least one activator with the bimetallic catalyst complex and the optionally substituted olefin.
193. The method of paragraph 192, wherein the at least one activator is Ni(COD)₂.
194. The method of any one of paragraphs 189-193, wherein the optionally substituted olefin is an optionally substituted terminal olefin or an optionally substituted internal olefin.
195. The method of any one of paragraphs 189-193, wherein the optionally substituted olefin is ethylene.
196. A polymer formed by the method of any one of paragraphs 189-195.
197. The polymer of paragraph 196, wherein the polymer is monomodal or bimodal.
198. A method for polymerizing an optionally substituted olefin, the method comprising contacting an optionally substituted olefin with the bimetallic catalyst complex of any one of paragraphs 176-188 and at least one activator under conditions effective to polymerize the optionally substituted olefin.
199. The method of paragraph 198, wherein the at least one activator is Ni(COD)₂.
200. The method of paragraph 198 or 199, wherein the step of contacting the optionally substituted olefin with the bimetallic catalyst complex and the at least one activator is performed in the presence of at least one solvent.
201. The method of paragraph 200, wherein the at least one solvent is a non-polar solvent, a polar solvent, or combination thereof.
202. The method of any one of paragraphs 198-201, wherein the optionally substituted olefin is an optionally substituted terminal olefin or an optionally substituted internal olefin.
203. The method of any one of paragraphs 198-202, wherein the optionally substituted olefin is ethylene.
204. A polymer formed by the method of any one of paragraphs 198-203.
205. The polymer of paragraph 204, wherein the polymer is monomodal or bimodal.
206. A method for catalyzing copolymerization of a first olefin and at least one other olefin, comprising: combining or contacting a first olefin and at least one other olefin with the bimetallic catalyst complex of any one of paragraphs 176-188, whereby the first olefin and the at least one other olefin undergoes copolymerization, and wherein the first olefin and the at least one other olefin are different from one another.
207. The method of paragraph 206, wherein the step of combining or contacting the first olefin and the at least one other olefin with the bimetallic catalyst complex is performed in the presence of at least one solvent.
208. The method of paragraph 207, wherein the at least one solvent is a non-polar solvent, a polar solvent, or combination thereof.
209. The method of any one of paragraphs 206-208, further comprising combining or contacting at least one activator with the bimetallic catalyst complex, the first olefin, and the at least one other olefin.
210. The method of paragraph 209, wherein the at least one activator is Ni(COD)₂.
211. The method of any one of paragraphs 206-210 wherein the first olefin and the at least one other olefin are each independently an optionally substituted olefin.
212. The method of any one of paragraphs 206-210, wherein the first olefin and the at least one other olefin are each independently an optionally substituted terminal olefin or an optionally substituted internal olefin.
213. The method of any one of paragraphs 206-212, wherein the first olefin is ethylene.
214. A polymer formed by the method of any one of paragraphs 206-213.
215. The polymer of paragraph 214, wherein the polymer is monomodal or bimodal.
216. A method for copolymerizing a first olefin and at least one other olefin, the method comprising contacting the first olefin and the at least one other olefin with the bimetallic catalyst complex of any one of paragraphs 176-188 and at least one activator under conditions effective to copolymerize the first olefin and the at least one other olefin, wherein the first olefin and the at least one other olefin are different from one another.
217. The method of paragraph 216, wherein the at least one activator is Ni(COD)₂.
218. The method of paragraph 216 or 217, wherein the step of contacting the first olefin and the at least one other olefin with the bimetallic catalyst complex and the at least one activator is performed in the presence of at least one solvent.
219. The method of paragraph 218, wherein the at least one solvent is a non-polar solvent, a polar solvent, or combination thereof.
220. The method of any one of paragraphs 216-219, wherein the first olefin and the at least one other olefin are each independently an optionally substituted olefin.
221. The method of any one of paragraphs 216-219, wherein the first olefin and the at least one other olefin are each independently an optionally substituted terminal olefin or an optionally substituted internal olefin.
222. The method of any one of paragraphs 216-221, wherein the first olefin is ethylene.
223. A polymer formed by the method of any one of paragraphs 216-222.
224. The polymer of paragraph 223, wherein the polymer is monomodal or bimodal.
225. A method for making a compound, the method comprising contacting a reactant with a bimetallic catalyst complex of any one of paragraphs 176-188 under conditions effective to make the compound.
226. The method of paragraph 225, wherein the step of contacting the reactant with the bimetallic catalyst complex is performed in the presence of at least one solvent.
227. The method of paragraph 226, wherein the at least one solvent is a non-polar solvent, a polar solvent, or combination thereof.
228. The method of any one of paragraphs 225-227, further comprising contacting at least one activator with the bimetallic catalyst complex and the reactant.
229. The method of paragraph 228, wherein the at least one activator is Ni(COD)₂.
230. The method of any one of paragraphs 225-229, wherein the compound is a small molecule.
231. The method of any one of paragraphs 225-230, wherein the method is a cascade method.
232. A method for making a compound, the method comprising contacting a first reactant and at least one other reactant with a bimetallic catalyst complex of any one of paragraphs 176-188 under conditions effective to make the compound.
233. The method of paragraph 232, wherein the step of contacting the first reactant and the at least one other reactant with the bimetallic catalyst complex is performed in the presence of at least one solvent.
234. The method of paragraph 233, wherein the at least one solvent is a non-polar solvent, a polar solvent, or combination thereof.
235. The method of any one of paragraphs 232-234, further comprising contacting at least one activator with the bimetallic catalyst complex, the first reactant, and the at least one other reactant.
236. The method of paragraph 235, wherein the at least one activator is Ni(COD)₂.
237. The method of any one of paragraphs 232-236, wherein the compound is a small molecule.
238. The method of any one of paragraphs 232-237, wherein the method is a cascade method.
239. The method of any one of paragraphs 232-238, wherein the first reactant and the at least one other reactant are different from one another.
240. A method of making a polymer, comprising contacting a monomer with the bimetallic catalyst complex of any one of paragraphs 176-188.
241. The method of paragraph 240, wherein the step of contacting the monomer with the bimetallic catalyst complex is performed in the presence of at least one solvent.
242. The method of paragraph 241, wherein the at least one solvent is a non-polar solvent, a polar solvent, or combination thereof.
243. The method of any one of paragraphs 240-242, further comprising contacting at least one activator with the bimetallic catalyst complex and the monomer.
244. The method of paragraph 243, wherein the at least one activator is Ni(COD)₂.
245. The method of any one of paragraphs 240-244, wherein the monomer is an optionally substituted olefin.
246. The method of any one of paragraphs 240-244, wherein the monomer is an optionally substituted terminal olefin or an optionally substituted internal olefin.
247. The method of any one of paragraphs 240-246, wherein the monomer is ethylene.
248. The method of any one of paragraphs 240-247, wherein the polymer is bimodal or monomodal.
249. A polymer made by the method of any one of paragraphs 240-248
250. The polymer of paragraph 249, wherein the polymer is bimodal or monomodal.
251. A method of making a copolymer, comprising contacting a first monomer and at least one other monomer with a bimetallic catalyst complex of any one of paragraphs 176-188, wherein the first monomer and the at least one other monomer are different from one another.
252. The method of paragraph 251, wherein the step of contacting the first monomer and the at least one other monomer with the bimetallic catalyst complex is performed in the presence of at least one solvent.
253. The method of paragraph 252, wherein the at least one solvent is a non-polar solvent, a polar solvent, or combination thereof.
254. The method of any one of paragraphs 251-253, further comprising contacting at least one activator with the bimetallic catalyst complex, the first monomer, and the at least one other monomer.
255. The method of paragraph 254, wherein the at least one activator is Ni(COD)₂.
256. The method of any one of paragraphs 251-255, wherein the first monomer and the at least one other monomer are each independently an optionally substituted olefin.
257. The method of any one of paragraphs 251-255, wherein the first monomer and the at least one other monomer are each independently an optionally substituted terminal olefin or an optionally substituted internal olefin.
258. The method of any one of paragraphs 251-257, wherein the first monomer is ethylene.
259. The method of any one of paragraphs of 251-258, wherein the copolymer is bimodal or monomodal.
260. A copolymer made by the method of any one of paragraphs 251-258.
261. The copolymer of paragraph 260, wherein the copolymer is monomodal or bimodal.
262. The method of any one of paragraphs 251-255, wherein the first monomer is CO₂; and the at least one other monomer is an epoxide.
263. A catalyst composition, comprising at least four bimetallic catalyst complexes, wherein the at least four bimetallic catalyst complexes are selected from: a bimetallic catalyst complex of Formula (7), a bimetallic catalyst complex of Formula (8), a bimetallic catalyst complex of Formula (9), and a bimetallic catalyst complex of Formula (10): wherein the bimetallic catalyst complex of Formula (7) has the structure:

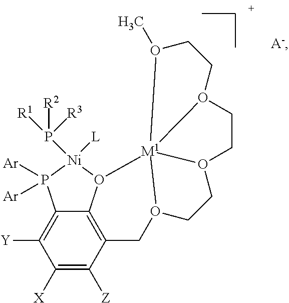

wherein the bimetallic catalyst complex of Formula (8) has the structure:

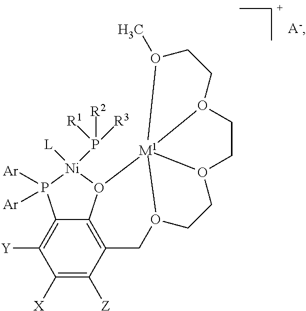

wherein the bimetallic catalyst complex of Formula (9) has the structure:

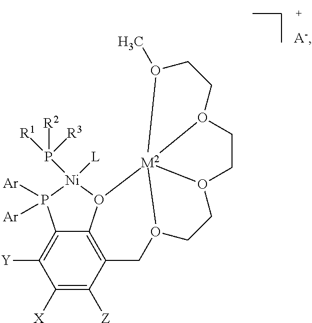

wherein the bimetallic catalyst complex of Formula (10) has the structure:

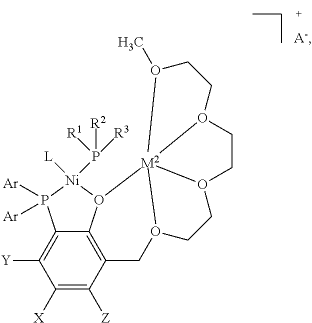

wherein in Formula (7), Formula (8), Formula (9) and Formula (10): Ar is 2,6-dimethoxyphenyl; L is an optionally substituted phenyl group; M¹ is Li, Na, K, or Cs; M² is Li, Na, K, or Cs; A is a weakly coordinating anion; X, Y, and Z are each independently selected from hydrogen, an electron donating group, and an electron withdrawing group; and R¹, R², and R³ are each independently selected from optionally substituted aryl, optionally substituted alkyl, and optionally substituted cycloalkyl; wherein A is the same in the bimetallic catalyst complex of Formula (7), Formula (8), Formula (9), and Formula (10); wherein Ar is the same in the bimetallic catalyst complex of Formula (7), Formula (8), Formula (9), and Formula (10); wherein L is the same in the bimetallic catalyst complex of Formula (7), Formula (8), Formula (9), and Formula (10); wherein X is the same in the bimetallic catalyst complex of Formula (7), Formula (8), Formula (9), and Formula (10); wherein Y is the same in the bimetallic catalyst complex of Formula (7), Formula (8), Formula (9), and Formula (10), wherein Z is the same in the bimetallic catalyst complex of Formula (7), Formula (8), Formula (9), and Formula (10); wherein R¹ is the same in the bimetallic catalyst complex of Formula (7), Formula (8), Formula (9), and Formula (10); wherein R² is the same in the bimetallic catalyst complex of Formula (7), Formula (8), Formula (9), and Formula (10); wherein R³ is the same in the bimetallic catalyst complex of Formula (7), Formula (8), Formula (9), and Formula (10); wherein M¹ is the same in the bimetallic catalyst complex of Formula (7) and Formula (8); wherein M² is the same in the bimetallic catalyst complex of Formula (9) and Formula (10); and wherein M¹ and M² are different from one another.
264. A catalyst composition, comprising at least four bimetallic catalyst complexes, wherein the at least four bimetallic catalyst complexes are selected from: a bimetallic catalyst complex of Formula (7-A), a bimetallic catalyst complex of Formula (8-A), a bimetallic catalyst complex of Formula (9-A), and a bimetallic catalyst complex of Formula (10-A): wherein the bimetallic catalyst complex of Formula (7-A) has the structure:

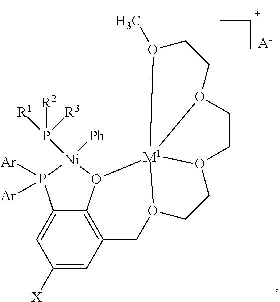

wherein the bimetallic catalyst complex of Formula (8-A) has the structure:

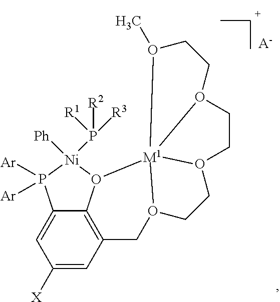

wherein the bimetallic catalyst complex of Formula (9-A) has the structure:

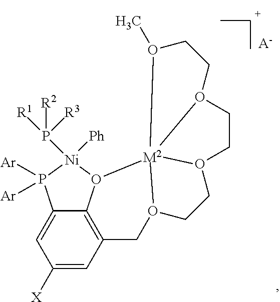

wherein the bimetallic catalyst complex of Formula (10-A) has the structure:

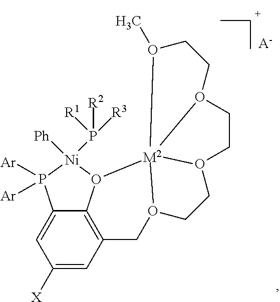

wherein in Formula (7-A), Formula (8-A), Formula (9-A) and Formula (10-A): Ar is 2,6-dimethoxyphenyl; Ph is a phenyl group; M¹ is Li, Na, K, or Cs; M² is Li, Na, K, or Cs; A is a weakly coordinating anion; X is hydrogen, an electron donating group, or an electron withdrawing group; and R¹, R², and R³ are each independently selected from optionally substituted aryl, optionally substituted alkyl, and optionally substituted cycloalkyl; wherein A is the same in the bimetallic catalyst complex of Formula (7-A), Formula (8-A), Formula (9-A), and Formula (10-A); wherein Ar is the same in the bimetallic catalyst complex of Formula (7-A), Formula (8-A), Formula (9-A), and Formula (10-A); wherein Ph is the same in the bimetallic catalyst complex of Formula (7-A), Formula (8-A), Formula (9-A), and Formula (10-A); wherein X is the same in the bimetallic catalyst complex of Formula (7-A), Formula (8-A), Formula (9-A), and Formula (10-A); wherein R¹ is the same in the bimetallic catalyst complex of Formula (7-A), Formula (8-A), Formula (9-A), and Formula (10-A); wherein R² is the same in the bimetallic catalyst complex of Formula (7-A), Formula (8-A), Formula (9-A), and Formula (10-A); wherein R³ is the same in the bimetallic catalyst complex of Formula (7-A), Formula (8-A), Formula (9-A), and Formula (10-A); wherein M¹ is the same in the bimetallic catalyst complex of Formula (7-A) and Formula (8-A); wherein M² is the same in the bimetallic catalyst complex of Formula (9-A) and Formula (10-A); and wherein M¹ and M² are different from one another.
265. A catalyst composition, comprising at least four bimetallic catalyst complexes, wherein the at least four bimetallic catalyst complexes are selected from: a bimetallic catalyst complex of Formula (7-B), a bimetallic catalyst complex of Formula (8-B), a bimetallic catalyst complex of Formula (9-B), and a bimetallic catalyst complex of Formula (10-B): wherein the bimetallic catalyst complex of Formula (7-B) has the structure:

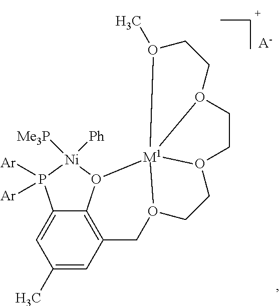

wherein the bimetallic catalyst complex of Formula (8-B) has the structure:

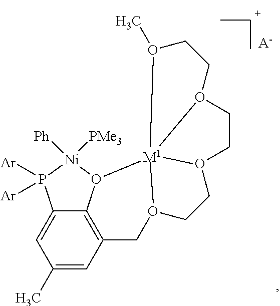

wherein the bimetallic catalyst complex of Formula (9-B) has the structure:

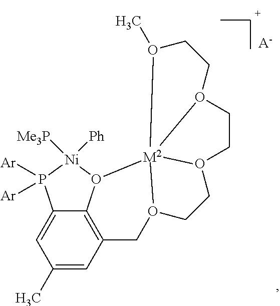

wherein the bimetallic catalyst complex of Formula (10-B) has the structure:

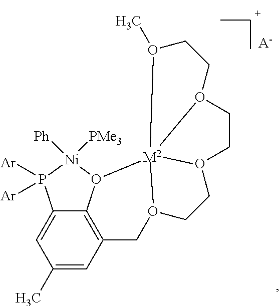

wherein in Formula (7-B), Formula (8-B), Formula (9-B) and Formula (10-B): Ar is 2,6-dimethoxyphenyl; Ph is a phenyl group; M¹ is Li, Na, K, or Cs; M² is Li, Na, K, or Cs; A⁻ is [(3,5-(CF₃)₂C₆H₃)₄B]⁻; and PMe₃ is trimethylphosphine; wherein A is the same in the bimetallic catalyst complex of Formula (7-B), Formula (8-B), Formula (9-B), and Formula (10-B); wherein Ar is the same in the bimetallic catalyst complex of Formula (7-B), Formula (8-B), Formula (9-B), and Formula (10-B); wherein Ph is the same in the bimetallic catalyst complex of Formula (7-B), Formula (8-B), Formula (9-B), and Formula (10-B); wherein PMe₃ is the same in the bimetallic catalyst complex of Formula (7-B), Formula (8-B), Formula (9-B), and Formula (10-B); wherein M¹ is the same in the bimetallic catalyst complex of Formula (7-B) and Formula (8-B); wherein M² is the same in the bimetallic catalyst complex of Formula (9-B) and Formula (10-B); and wherein M¹ and M² are different from one another.
266. The catalyst composition of paragraph 263 or 264, wherein the electron donating group is selected from the group consisting of: alkoxy, amino, hydroxy, and alkyl.
267. The catalyst composition of paragraph 266, wherein alkyl is selected from the group consisting of: —CH₃, —CH₂CH₃, —CH₂CH₂CH₃, and —CH(CH₃)₂.
268. The catalyst composition of paragraph 263 or 264, wherein the electron withdrawing group is selected from the group consisting of: NO₂, —CN, —C(O)-alkyl, and halo.
269. The catalyst composition of any one of paragraphs 263-265, wherein the phenyl group is

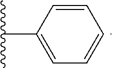 [SMILES: *c1ccccc1]

270. A method for catalyzing homopolymerization of an optionally substituted olefin, comprising: combining or contacting an optionally substituted olefin with the catalyst composition of any one of paragraphs 263-269, whereby the optionally substituted olefin undergoes homopolymerization.
271. The method of paragraph 270, wherein the step of combining or contacting the optionally substituted olefin with the catalyst is performed in the presence of at least one solvent.
272. The method of paragraph 271, wherein the at least one solvent is a non-polar solvent, a polar solvent, or combination thereof.
273. The method of any one of paragraphs 270-272 further comprising combining or contacting at least one activator with the catalyst and the optionally substituted olefin.
274. The method of paragraph 273, wherein the at least one activator is Ni(COD)₂.
275. The method of any one of paragraphs 270-274 wherein the optionally substituted olefin is an optionally substituted terminal olefin or an optionally substituted internal olefin.
276. The method of any one of paragraphs 270-275, wherein the optionally substituted olefin is ethylene.
277. A polymer formed by the method of any one of paragraphs 270-276.
278. The polymer of paragraph 277, wherein the polymer is monomodal or bimodal.
279. A method for polymerizing an optionally substituted olefin, the method comprising contacting an optionally substituted olefin with the catalyst composition of any one of paragraphs 263-269 and at least one activator under conditions effective to polymerize the optionally substituted olefin.
280. The method of paragraph 279, wherein the at least one activator is Ni(COD)₂.
281. The method of paragraph 279 or 280, wherein the step of contacting the optionally substituted olefin with the catalyst composition and the at least one activator is performed in the presence of at least one solvent.
282. The method of paragraph 281, wherein the at least one solvent is a non-polar solvent, a polar solvent, or combination thereof.
283. The method of any one of paragraphs 279-282, wherein the optionally substituted olefin is an optionally substituted terminal olefin or an optionally substituted internal olefin.
284. The method of any one of paragraphs 279-283, wherein the optionally substituted olefin is ethylene.
285. A polymer formed by the method of any one of paragraphs 279-284.
286. The polymer of paragraph 285, wherein the polymer is monomodal or bimodal.
287. A method for catalyzing copolymerization of a first olefin and at least one other olefin, comprising: combining or contacting a first olefin and at least one other olefin with the catalyst composition of any one of paragraphs 263-269, whereby the first olefin and the at least one other olefin undergoes copolymerization, and wherein the first olefin and the at least one other olefin are different from one another.
288. The method of paragraph 287, wherein the step of combining or contacting the first olefin and the at least one other olefin with the catalyst composition is performed in the presence of at least one solvent.
289. The method of paragraph 288, wherein the at least one solvent is a non-polar solvent, a polar solvent, or combination thereof.
290. The method of any one of paragraphs 287-289, further comprising combining or contacting at least one activator with the catalyst composition, the first olefin, and the at least one other olefin.
291. The method of paragraph 290, wherein the at least one activator is Ni(COD)₂.
292. The method of any one of paragraphs 287-291, wherein the first olefin and the at least one other olefin are each independently an optionally substituted olefin.
293. The method of any one of paragraphs 287-291, wherein the first olefin and the at least one other olefin are each independently an optionally substituted terminal olefin or an optionally substituted internal olefin.
294. The method of any one of paragraphs 287-293, wherein the first olefin is ethylene.
295. A polymer formed by the method of any one of paragraphs 287-294.
296. The polymer of paragraph 295, wherein the polymer is monomodal or bimodal.
297. A method for copolymerizing a first olefin and at least one other olefin, the method comprising contacting the first olefin and the at least one other olefin with the catalyst composition of any one of paragraphs 263-269 and at least one activator under conditions effective to copolymerize the first olefin and the at least one other olefin, wherein the first olefin and the at least one other olefin are different from one another.
298. The method of paragraph 297, wherein the at least one activator is Ni(COD)₂.
299. The method of paragraph 297 or 298, wherein the step of contacting the first olefin and the at least one other olefin with the catalyst composition and the at least one activator is performed in the presence of at least one solvent.
300. The method of paragraph 299, wherein the at least one solvent is a non-polar solvent, a polar solvent, or combination thereof.
301. The method of any one of paragraphs 297-300, wherein the first olefin and the at least one other olefin are each independently an optionally substituted olefin.
302. The method of any one of paragraphs 297-300, wherein the first olefin and the at least one other olefin are each independently an optionally substituted terminal olefin or an optionally substituted internal olefin.
303. The method of any one of paragraphs 297-302, wherein the first olefin is ethylene.
304. A polymer formed by the method of any one of paragraphs 297-303.
305. The polymer of paragraph 304, wherein the polymer is monomodal or bimodal.
306. A method for making a compound, the method comprising contacting a reactant with a catalyst composition of any one of paragraphs 263-269 under conditions effective to make the compound.
307. The method of paragraph 306, wherein the step of contacting the reactant with the catalyst composition is performed in the presence of at least one solvent.
308. The method of paragraph 307, wherein the at least one solvent is a non-polar solvent, a polar solvent, or combination thereof.
309. The method of any one of paragraphs 306-308, further comprising contacting at least one activator with the catalyst composition and the reactant.
310. The method of paragraph 309, wherein the at least one activator is Ni(COD)₂.
311. The method of any one of paragraphs 306-310, wherein the compound is a small molecule.
312. The method of any one of paragraphs 311, wherein the method is a cascade method.
313. A method for making a compound, the method comprising contacting a first reactant and at least one other reactant with a catalyst composition of any one of paragraphs 263-269 under conditions effective to make the compound.
314. The method of paragraph 313, wherein the step of contacting the first reactant and the at least one other reactant with the catalyst composition is performed in the presence of at least one solvent.
315. The method of paragraph 314, wherein the at least one solvent is a non-polar solvent, a polar solvent, or combination thereof.
316. The method of any one of paragraphs 313-315, further comprising contacting at least one activator with the catalyst composition, the first reactant, and the at least one other reactant.
317. The method of paragraph 316, wherein the at least one activator is Ni(COD)₂.
318. The method of any one of paragraphs 313-317, wherein the compound is a small molecule.
319. The method of any one of paragraphs 313-318, wherein the method is a cascade method.
320. The method of any one of paragraphs 313-319, wherein the first reactant and the at least one other reactant are different from one another.
321. A method of making a polymer, comprising contacting a monomer with the catalyst composition of any one of paragraphs 263-269.
322. The method of paragraph 321, wherein the step of contacting the monomer with the catalyst composition is performed in the presence of at least one solvent.
323. The method of paragraph 322, wherein the at least one solvent is a non-polar solvent, a polar solvent, or combination thereof.
324. The method of any one of paragraphs 321-323, further comprising contacting at least one activator with the catalyst composition and the monomer.
325. The method of paragraph 324, wherein the at least one activator is Ni(COD)₂.
326. The method of any one of paragraphs 321-325, wherein the monomer is an optionally substituted olefin.
327. The method of any one of paragraphs 321-325, wherein the monomer is an optionally substituted terminal olefin or an optionally substituted internal olefin.
328. The method of any one of paragraphs 321-327, wherein the monomer is ethylene.
329. The method of any one of paragraphs 321-328, wherein the polymer is bimodal or monomodal.
330. A polymer made by the method of any one of paragraphs 321-328.
331. The polymer of paragraph 330, wherein the polymer is bimodal or monomodal.
332. A method of making a copolymer, comprising contacting a first monomer and at least one other monomer with a catalyst composition of any one of paragraphs 263-269, wherein the first monomer and the at least one other monomer are different from one another.
334. The method of paragraph 332, wherein the step of contacting the first monomer and the at least one other monomer with the catalyst composition is performed in the presence of at least one solvent.
335. The method of paragraph 334, wherein the at least one solvent is a non-polar solvent, a polar solvent, or combination thereof.
336. The method of any one of paragraphs 332-335, further comprising contacting at least one activator with the catalyst composition, the first monomer, and the at least one other monomer.
337. The method of paragraph 336, wherein the at least one activator is Ni(COD)₂.
338. The method of any one of paragraphs 332-337, wherein the first monomer and the at least one other monomer are each independently an optionally substituted olefin.
339. The method of any one of paragraphs 332-337, wherein the first monomer and the at least one other monomer are each independently an optionally substituted terminal olefin or an optionally substituted internal olefin.
340. The method of any one of paragraphs 332-339, wherein the first monomer is ethylene.
341. The method of any one of paragraphs of 332-340, wherein the copolymer is bimodal or monomodal.
342. A copolymer made by the method of any one of paragraphs 332-341.
343. The copolymer of paragraph 342, wherein the copolymer is monomodal or bimodal.
344. The method of any one of paragraphs 332-337, wherein the first monomer is CO₂, and the at least one other monomer is an epoxide.
345. A heterobimetallic catalyst having a structure selected from Formula (11) and Formula (12):

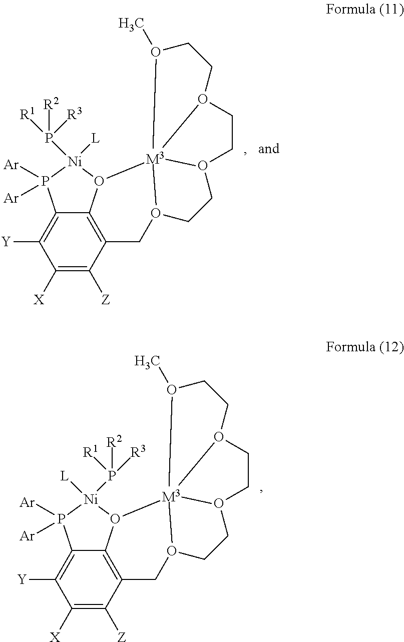

wherein in Formula (11) and Formula (12): Ar is 2,6-dimethoxyphenyl; L is an optionally substituted phenyl group; M³ is a 2+ cation, 3+ cation, 4+ cation, or 5+ cation; X, Y, and Z are each independently selected from hydrogen, an electron donating group, and an electron withdrawing group; and R¹, R², and R³ are each independently selected from optionally substituted aryl, optionally substituted alkyl, and optionally substituted cycloalkyl.
346. A heterobimetallic catalyst having a structure of Formula (11):

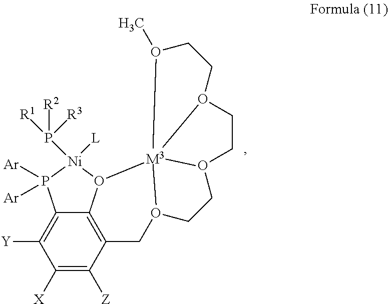

wherein, Ar is 2,6-dimethoxyphenyl; Lis an optionally substituted phenyl group; M³ is a 2+ cation, 3+ cation, 4+ cation, or 5+ cation; X, Y, and Z are each independently selected from hydrogen, an electron donating group, and an electron withdrawing group; and R¹, R², and R³ are each independently selected from optionally substituted aryl, optionally substituted alkyl, and optionally substituted cycloalkyl.
347. A heterobimetallic catalyst having a structure of Formula (12):

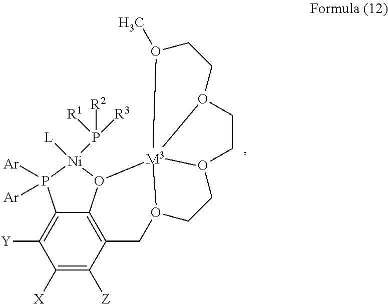

wherein, Ar is 2,6-dimethoxyphenyl; Lis an optionally substituted phenyl group; M³ is a 2+ cation, 3+ cation, 4+ cation, or 5+ cation; X, Y, and Z are each independently selected from hydrogen, an electron donating group, and an electron withdrawing group; and R¹, R², and R³ are each independently selected from optionally substituted aryl, optionally substituted alkyl, and optionally substituted cycloalkyl.
348. A heterobimetallic catalyst having a structure selected from Formula (11-A) and Formula (12-A):

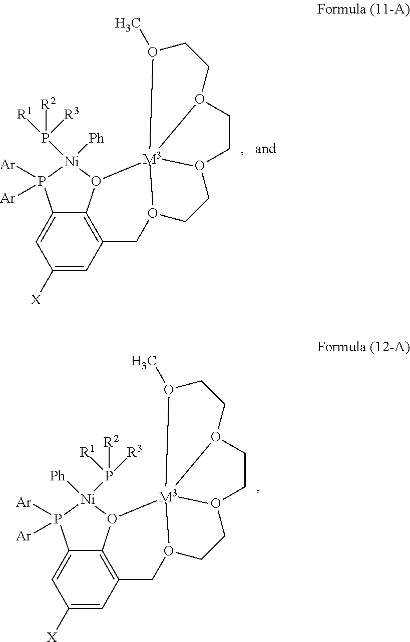

wherein in Formula (11-A) and Formula (12-A): Ar is 2,6-dimethoxyphenyl; Ph is a phenyl group; M³ is a 2+ cation, 3+ cation, 4+ cation, or 5+ cation; X is hydrogen, an electron donating group, or an electron withdrawing group; and R¹, R², and R³ are each independently selected from optionally substituted aryl, optionally substituted alkyl, and optionally substituted cycloalkyl.
349. A heterobimetallic catalyst having a structure of Formula (11-A):

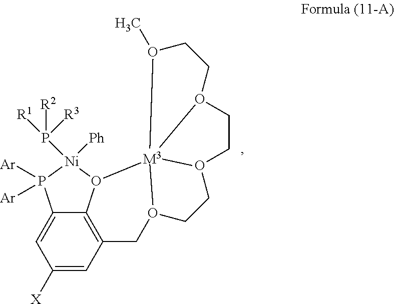

wherein, Ar is 2,6-dimethoxyphenyl; Ph is a phenyl group; M³ is a 2+ cation, 3+ cation, 4+ cation, or 5+ cation; X is hydrogen, an electron donating group, or an electron withdrawing group; and R¹, R², and R³ are each independently selected from optionally substituted aryl, optionally substituted alkyl, and optionally substituted cycloalkyl.
350. A heterobimetallic catalyst having a structure of Formula (12-A):

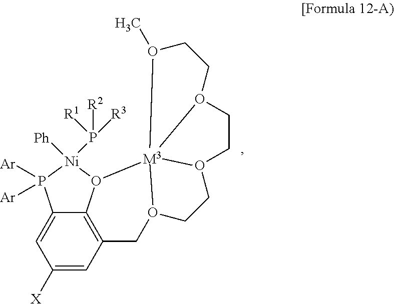

wherein, Ar is 2,6-dimethoxyphenyl; Ph is a phenyl group; M³ is a 2+ cation, 3+ cation, 4+ cation, or 5+ cation; X is hydrogen, an electron donating group, or an electron withdrawing group; and R¹, R², and R³ are each independently selected from optionally substituted aryl, optionally substituted alkyl, and optionally substituted cycloalkyl.
351. A heterobimetallic catalyst having a structure selected from Formula (11-B) and Formula (12-B):

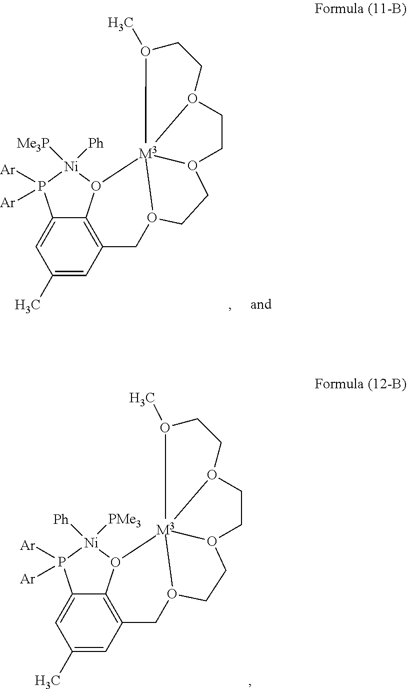

wherein in Formula (11-B) and Formula (12-B): Ar is 2,6-dimethoxyphenyl; Ph is a phenyl group; M³ is a 2+ cation, 3+ cation, 4+ cation, or 5+ cation; and PMe₃ is trimethylphosphine. 352. A heterobimetallic catalyst having a structure of Formula (11-B):

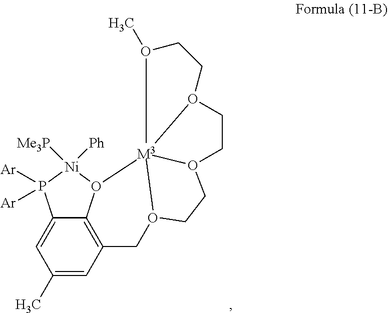

wherein, Ar is 2,6-dimethoxyphenyl; Ph is a phenyl group; M³ is a 2+ cation, 3+ cation, 4+ cation, or 5+ cation; and PMe₃ is trimethylphosphine.
353. A heterobimetallic catalyst having a structure of Formula (12-B):

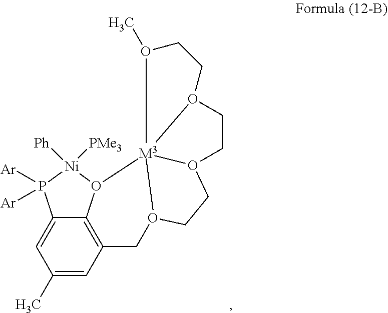

wherein, Ar is 2,6-dimethoxyphenyl; Ph is a phenyl group, M³ is a 2+ cation, 3+ cation, 4+ cation, or 5+ cation; and PMe₃ is trimethylphosphine.
354. The catalyst of any one of paragraphs 345-350, wherein the electron donating group is selected from the group consisting of: alkoxy, amino, hydroxy, and alkyl.
355. The catalyst of paragraph 354, wherein alkyl is selected from the group consisting of: —CH₃, —CH₂CH₃, —CH₂CH₂CH₃, and —CH(CH₃)₂.
356. The catalyst of any one of paragraphs 345-350, wherein the electron withdrawing group is selected from the group consisting of: NO₂, —CN, —C(O)-alkyl, and halo, 357. The catalyst of any one of paragraphs 345-353, wherein the phenyl group is

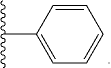 [SMILES: *c1ccccc1]

358. A method for catalyzing homopolymerization of an optionally substituted olefin, comprising: combining or contacting an optionally substituted olefin with the heterobimetallic catalyst of any one of paragraphs 345-353, whereby the optionally substituted olefin undergoes homopolymerization.
359. The method of paragraph 358, wherein the step of combining or contacting the optionally substituted olefin with the heterobimetallic catalyst is performed in the presence of at least one solvent.
360. The method of paragraph 359, wherein the at least one solvent is a non-polar solvent, a polar solvent, or combination thereof.
361. The method of any one of paragraphs 358-360, further comprising combining or contacting at least one activator with the heterobimetallic catalyst and the optionally substituted olefin.
362. The method of paragraph 361, wherein the at least one activator is Ni(COD)₂.
363. The method of any one of paragraphs 358-362, wherein the optionally substituted olefin is an optionally substituted terminal olefin or an optionally substituted internal olefin.
364. The method of any one of paragraphs 358-363, wherein the optionally substituted olefin is ethylene.
365. A polymer formed by the method of any one of paragraphs 358-364.
366. The polymer of paragraph 365, wherein the polymer is monomodal or bimodal.
367. A method for polymerizing an optionally substituted olefin, the method comprising contacting an optionally substituted olefin with the heterobimetallic catalyst of any one of paragraphs 345-353 and at least one activator under conditions effective to polymerize the optionally substituted olefin.
368. The method of paragraph 367, wherein the at least one activator is Ni(COD)₂.
369. The method of paragraph 367 or 368, wherein the step of contacting the optionally substituted olefin with the heterobimetallic catalyst and the at least one activator is performed in the presence of at least one solvent.
370. The method of paragraph 369, wherein the at least one solvent is a non-polar solvent, a polar solvent, or combination thereof.
371. The method of any one of paragraphs 367-370, wherein the optionally substituted olefin is an optionally substituted terminal olefin or an optionally substituted internal olefin.
372. The method of any one of paragraphs 367-371, wherein the optionally substituted olefin is ethylene.
373. A polymer formed by the method of any one of paragraphs 367-372.
374. The polymer of paragraph 373, wherein the polymer is monomodal or bimodal.
375. A method for catalyzing copolymerization of a first olefin and at least one other olefin, comprising: combining or contacting a first olefin and at least one other olefin with the heterobimetallic catalyst of any one of paragraphs 345-353, whereby the first olefin and the at least one other olefin undergoes copolymerization, and wherein the first olefin and the at least one other olefin are different from one another.
376. The method of paragraph 375, wherein the step of combining or contacting the first olefin and the at least one other olefin with the heterobimetallic catalyst is performed in the presence of at least one solvent.
377. The method of paragraph 376, wherein the at least one solvent is a non-polar solvent, a polar solvent, or combination thereof.
378. The method of any one of paragraphs 375-377, further comprising combining or contacting at least one activator with the heterobimetallic catalyst, the first olefin, and the at least one other olefin.
379. The method of paragraph 378, wherein the at least one activator is Ni(COD)₂.
380. The method of any one of paragraphs 375-379, wherein the first olefin and the at least one other olefin are each independently an optionally substituted olefin.
381. The method of any one of paragraphs 375-379, wherein the first olefin and the at least one other olefin are each independently an optionally substituted terminal olefin or an optionally substituted internal olefin.
382. The method of any one of paragraphs 375-381, wherein the first olefin is ethylene.
383. A polymer formed by the method of any one of paragraphs 375-382.
384. The polymer of paragraph 383, wherein the polymer is monomodal or bimodal.
385. A method for copolymerizing a first olefin and at least one other olefin, the method comprising contacting the first olefin and the at least one other olefin with the heterobimetallic catalyst of any one of paragraphs 345-353 and at least one activator under conditions effective to copolymerize the first olefin and the at least one other olefin, wherein the first olefin and the at least one other olefin are different from one another.
386. The method of paragraph 385, wherein the at least one activator is Ni(COD)₂.
387. The method of paragraph 385 or 386, wherein the step of contacting the first olefin and the at least one other olefin with the heterobimetallic catalyst and the at least one activator is performed in the presence of at least one solvent.
388. The method of paragraph 387, wherein the at least one solvent is a non-polar solvent, a polar solvent, or combination thereof.
389. The method of any one of paragraphs 385-388, wherein the first olefin and the at least one other olefin are each independently an optionally substituted olefin.
390. The method of any one of paragraphs 385-388, wherein the first olefin and the at least one other olefin are each independently an optionally substituted terminal olefin or an optionally substituted internal olefin.
391. The method of any one of paragraphs 385-390, wherein the first olefin is ethylene.
392. A polymer formed by the method of any one of paragraphs 385-391.
393. The polymer of paragraph 392, wherein the polymer is monomodal or bimodal.
394. A method for making a compound, the method comprising contacting a reactant with a heterobimetallic catalyst of any one of paragraphs 345-353 under conditions effective to make the compound.
395. The method of paragraph 394, wherein the step of contacting the reactant with the heterobimetallic catalyst is performed in the presence of at least one solvent.
396. The method of paragraph 395, wherein the at least one solvent is a non-polar solvent, a polar solvent, or combination thereof.
397. The method of any one of paragraphs 394-396, further comprising contacting at least one activator with the heterobimetallic catalyst and the reactant.
398. The method of paragraph 397, wherein the at least one activator is Ni(COD)₂.
399. The method of any one of paragraphs 394-398, wherein the compound is a small molecule.
400. The method of any one of paragraphs 394-399, wherein the method is a cascade method.
401. A method for making a compound, the method comprising contacting a first reactant and at least one other reactant with a heterobimetallic catalyst of any one of paragraphs 345-353 under conditions effective to make the compound.
402. The method of paragraph 401, wherein the step of contacting the first reactant and the at least one other reactant with the heterobimetallic catalyst is performed in the presence of at least one solvent.
403. The method of paragraph 402, wherein the at least one solvent is a non-polar solvent, a polar solvent, or combination thereof.
404. The method of any one of paragraphs 401-403, further comprising contacting at least one activator with the catalyst, the first reactant, and the at least one other reactant.
405. The method of paragraph 404, wherein the at least one activator is Ni(COD)₂.
406. The method of any one of paragraphs 401-405, wherein the compound is a small molecule.
407. The method of any one of paragraphs 401-406, wherein the method is a cascade method.
408. The method of any one of paragraphs 401-407, wherein the first reactant and the at least one other reactant are different from one another.
409. A method of making a polymer, comprising contacting a monomer with the heterobimetallic catalyst of any one of paragraphs 345-353.
410. The method of paragraph 409, wherein the step of contacting the monomer with the heterobimetallic catalyst is performed in the presence of at least one solvent.
411. The method of paragraph 410, wherein the at least one solvent is a non-polar solvent, a polar solvent, or combination thereof.
412. The method of any one of paragraphs 409-411, further comprising contacting at least one activator with the heterobimetallic catalyst and the monomer.
413. The method of paragraph 412, wherein the at least one activator is Ni(COD)₂.
414. The method of any one of paragraphs 409-413, wherein the monomer is an optionally substituted olefin.
415. The method of any one of paragraphs 409-414, wherein the monomer is an optionally substituted terminal olefin or an optionally substituted internal olefin.
416. The method of any one of paragraphs 409-415, wherein the monomer is ethylene.
417. The method of any one of paragraphs 409-416, wherein the polymer is bimodal or monomodal.
418. A polymer made by the method of any one of paragraphs 409-417.
419. The polymer of paragraph 418, wherein the polymer is bimodal or monomodal.
420. A method of making a copolymer, comprising contacting a first monomer and at least one other monomer with a heterobimetallic catalyst of any one of paragraphs 345-353, wherein the first monomer and the at least one other monomer are different from one another.
421. The method of paragraph 420, wherein the step of contacting the first monomer and the at least one other monomer with the heterobimetallic catalyst is performed in the presence of at least
422. The method of paragraph 421, wherein the at least one solvent is a non-polar solvent, a polar solvent, or combination thereof.
423. The method of any one of paragraphs 420-422, further comprising contacting at least one activator with the heterobimetallic catalyst, the first monomer, and the at least one other monomer.
424. The method of paragraph 423, wherein the at least one activator is Ni(COD)₂.
425. The method of any one of paragraphs 420-424, wherein the first monomer and the at least one other monomer are each independently an optionally substituted olefin.
426. The method of any one of paragraphs 420-424 wherein the first monomer and the at least one other monomer are each independently an optionally substituted terminal olefin or an optionally substituted internal olefin.
427. The method of any one of paragraphs 420-426, wherein the first monomer is ethylene.
428. The method of any one of paragraphs of 420-427, wherein the copolymer is bimodal or monomodal.
429. A copolymer made by the method of any one of paragraphs 420-428.
430. The copolymer of paragraph 429, wherein the copolymer is monomodal or bimodal.
431. The method of any one of paragraphs 420-424, wherein the first monomer is CO₂; and the at least one other monomer is an epoxide.
432. A bimetallic catalyst complex having a structure selected from Formula (13) and Formula (14):

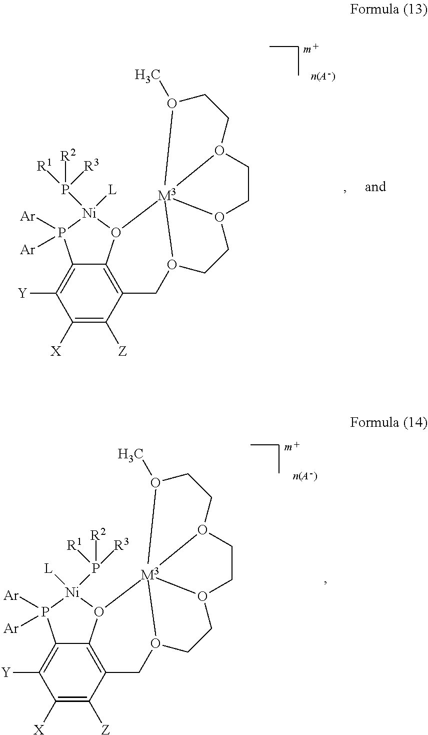

wherein in Formula (13) and Formula (14): m is 2, 3, 4, or 5; n is 1, 2, 3, 4, or 5; Ar is 2,6-dimethoxyphenyl; L is an optionally substituted phenyl group; M³ is a 2+ cation, 3+ cation, 4+ cation, or 5+ cation; A⁻ is a weakly coordinating anion; X, Y, and Z are each independently selected from hydrogen, an electron donating group, and an electron withdrawing group; and R¹, R², and R³ are each independently selected from optionally substituted aryl, optionally substituted alkyl, and optionally substituted cycloalkyl.
433. A bimetallic catalyst complex having a structure of Formula (13):

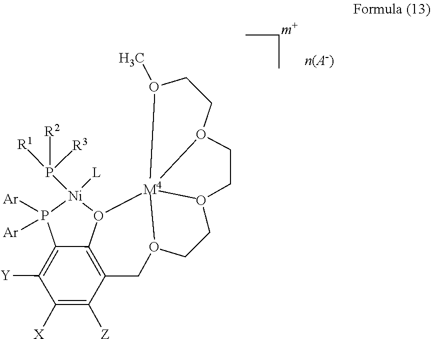

wherein, m is 2, 3, 4, or 5; n is 1, 2, 3, 4, or 5; Ar is 2,6-dimethoxyphenyl; L is an optionally substituted phenyl group; M³ is a 2+ cation, 3+ cation, 4+ cation, or 5+ cation; A is a weakly coordinating anion; X, Y, and Z are each independently selected from hydrogen, an electron donating group, and an electron withdrawing group; and R¹, R², and R³ are each independently selected from optionally substituted aryl, optionally substituted alkyl, and optionally substituted cycloalkyl.
434. A bimetallic catalyst complex having a structure of Formula (14):

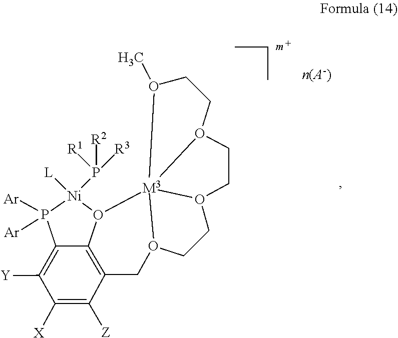

wherein, m is 2, 3, 4, or 5; n is 1, 2, 3, 4, or 5; Ar is 2,6-dimethoxyphenyl; L is an optionally substituted phenyl group; M³ is a 2+ cation, 3+ cation, 4+ cation, or 5+ cation; A is a weakly coordinating anion; X, Y, and Z are each independently selected from hydrogen, an electron donating group, and an electron withdrawing group; and R¹, R², and R³ are each independently selected from optionally substituted aryl, optionally substituted alkyl, and optionally substituted cycloalkyl.
435. A bimetallic catalyst complex having a structure selected from Formula (13-A) and Formula (14-A):

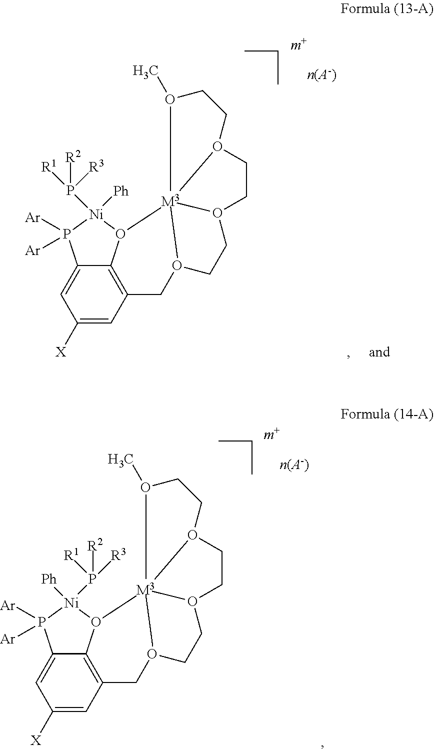

wherein Formula (13-A) and Formula (14-A): m is 2, 3, 4, or 5; n is 1, 2, 3, 4, or 5; Ar is 2,6-dimethoxyphenyl; Ph is a phenyl group; M³ is a 2+ cation, 3+ cation, 4+ cation, or 5+ cation; A is a weakly coordinating anion; X is hydrogen, an electron donating group, or an electron withdrawing group; and R¹, R², and R³ are each independently selected from optionally substituted aryl, optionally substituted alkyl, and optionally substituted cycloalkyl.
436. A bimetallic catalyst complex having a structure of Formula (13-A):

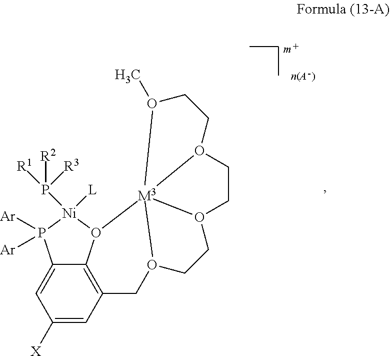

wherein, m is 2, 3, 4, or 5; n is 1, 2, 3, 4, or 5; Ar is 2,6-dimethoxyphenyl; Ph is a phenyl group; M³ is a 2+ cation, 3+ cation, 4+ cation, or 5+ cation; A⁻ is a weakly coordinating anion; X is hydrogen, an electron donating group, or an electron withdrawing group; and R¹, R², and R³ are each independently selected from optionally substituted aryl, optionally substituted alkyl, and optionally substituted cycloalkyl.
437. A bimetallic catalyst complex having a structure of Formula (14-A):

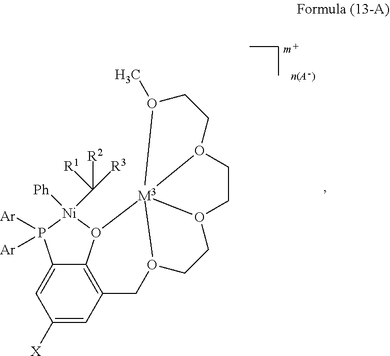

wherein, m is 2, 3, 4, or 5; n is 1, 2, 3, 4, or 5; Ar is 2,6-dimethoxyphenyl; Ph is a phenyl group; M³ is a 2+ cation, 3+ cation, 4+ cation, or 5+ cation; A⁻ is a weakly coordinating anion; X is hydrogen, an electron donating group, or an electron withdrawing group; and R¹, R², and R³ are each independently selected from optionally substituted aryl, optionally substituted alkyl, and optionally substituted cycloalkyl.
438. A bimetallic catalyst complex having a structure selected from Formula (13-B) and Formula (14-B):

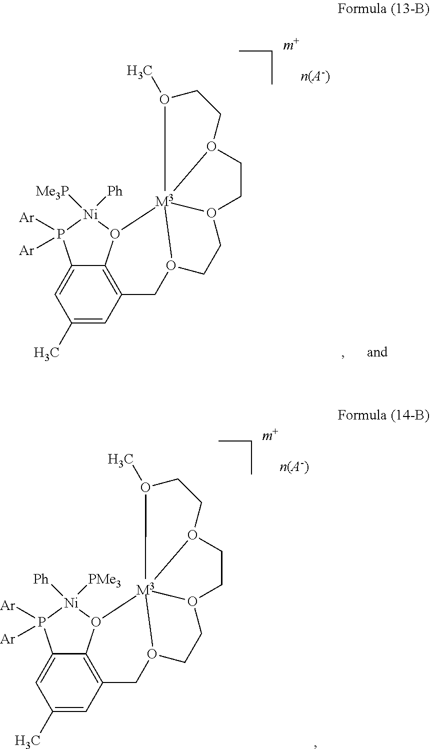

wherein Formula (13-B) and Formula (14-B): m is 2, 3, 4, or 5; n is 1, 2, 3, 4, or 5; Ar is 2,6-dimethoxyphenyl; Ph is a phenyl group; M³ is a 2+ cation, 3+ cation, 4+ cation, or 5+ cation; A⁻ is [(3,5-(CF₃)₂C₆H₃)₄B]⁻; and PMe₃ is trimethylphosphine.
439. A bimetallic catalyst complex having a structure of Formula (13-B) is:

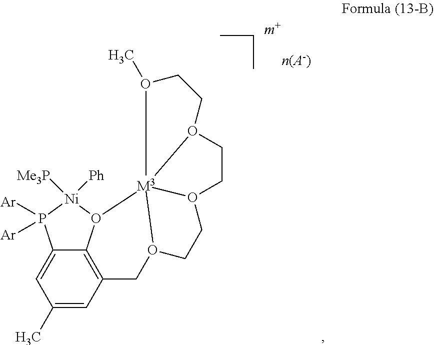

wherein, m is 2, 3, 4, or 5; n is 1, 2, 3, 4, or 5; Ar is 2,6-dimethoxyphenyl; Ph is a phenyl group; M³ is a 2+ cation, 3+ cation, 4+ cation, or 5+ cation; A⁻ is [(3,5-(CF₃)₂C₆H₃)₄B]⁻; and PMe₃ is trimethylphosphine.
440. A bimetallic catalyst complex having a structure of Formula (14-B):

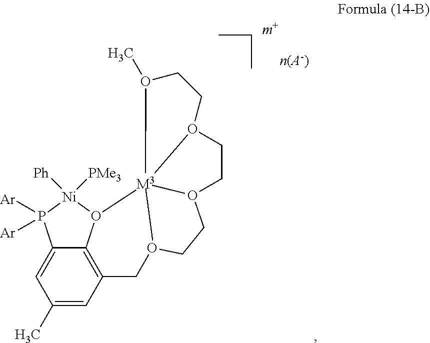

wherein, m is 2, 3, 4, or 5; n is 1, 2, 3, 4, or 5; Ar is 2,6-dimethoxyphenyl; Ph is a phenyl group; M³ is a 2+ cation, 3+ cation, 4+ cation, or 5+ cation; A⁻ is [(3,5-(CF₃)₂C₆H₃)₄B]⁻; and PMe₃ is trimethylphosphine.
441. The catalyst of any one of paragraphs 432-437, wherein the electron donating group is selected from the group consisting of: alkoxy, amino, hydroxy, and alkyl.
442. The catalyst of paragraph 441, wherein alkyl is selected from the group consisting of: —CH₃, —CH₂CH₃, —CH₂CH₂CH₃, and —CH(CH₃)₂.
443. The catalyst of any one of paragraphs 432-437, wherein the electron withdrawing group is selected from the group consisting of: NO₂, —CN, —C(O)-alkyl, and halo.
444. The catalyst of any one of paragraphs 432-443, wherein the phenyl group is

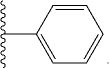 [SMILES: *c1ccccc1]

445. A method for catalyzing homopolymerization of an optionally substituted olefin, comprising: combining or contacting an optionally substituted olefin with the bimetallic catalyst complex of any one of paragraphs 432-444, whereby the optionally substituted olefin undergoes homopolymerization.
446. The method of paragraph 445, wherein the step of combining or contacting the optionally substituted olefin with the bimetallic catalyst complex is performed in the presence of at least one solvent.
447. The method of paragraph 446, wherein the at least one solvent is a non-polar solvent, a polar solvent, or combination thereof.
448. The method of any one of paragraphs 445-447, further comprising combining or contacting at least one activator with the bimetallic catalyst complex and the optionally substituted olefin.
449. The method of paragraph 448, wherein the at least one activator is Ni(COD)₂.
450. The method of any one of paragraphs 445-449, wherein the optionally substituted olefin is an optionally substituted terminal olefin or an optionally substituted internal olefin.
451. The method of any one of paragraphs 445-450, wherein the optionally substituted olefin is ethylene.
452. A polymer formed by the method of any one of paragraphs 445-451.
453. The polymer of paragraph 452, wherein the polymer is monomodal or bimodal.
454. A method for polymerizing an optionally substituted olefin, the method comprising contacting an optionally substituted olefin with the bimetallic catalyst complex of any one of paragraphs 432-444 and at least one activator under conditions effective to polymerize the optionally substituted olefin.
455. The method of paragraph 454, wherein the at least one activator is Ni(COD)₂.
456. The method of paragraph 454 or 455, wherein the step of contacting the optionally substituted olefin with the bimetallic catalyst complex and the at least one activator is performed in the presence of at least one solvent.
457. The method of paragraph 456, wherein the at least one solvent is a non-polar solvent, a polar solvent, or combination thereof.
458. The method of any one of paragraphs 454-457, wherein the optionally substituted olefin is an optionally substituted terminal olefin or an optionally substituted internal olefin.
459. The method of any one of paragraphs 454-458, wherein the optionally substituted olefin is ethylene.
460. A polymer formed by the method of any one of paragraphs 454-459.
461. The polymer of paragraph 460, wherein the polymer is monomodal or bimodal.
462. A method for catalyzing copolymerization of a first olefin and at least one other olefin, comprising: combining or contacting a first olefin and at least one other olefin with the bimetallic catalyst complex of any one of paragraphs 432-444, whereby the first olefin and the at least one other olefin undergoes copolymerization, and wherein the first olefin and the at least one other olefin are different from one another.
463. The method of paragraph 462, wherein the step of combining or contacting the first olefin and the at least one other olefin with the bimetallic catalyst complex is performed in the presence of at least one solvent.
464. The method of paragraph 463, wherein the at least one solvent is a non-polar solvent, a polar solvent, or combination thereof.
465. The method of any one of paragraphs 462-464, further comprising combining or contacting at least one activator with the bimetallic catalyst complex, the first olefin, and the at least one other olefin.
466. The method of paragraph 465, wherein the at least one activator is Ni(COD)₂.
467. The method of any one of paragraphs 462-466, wherein the first olefin and the at least one other olefin are each independently an optionally substituted olefin.
468. The method of any one of paragraphs 462-466, wherein the first olefin and the at least one other olefin are each independently an optionally substituted terminal olefin or an optionally substituted internal olefin.
469. The method of any one of paragraphs 462-468, wherein the first olefin is ethylene.
470. A polymer formed by the method of any one of paragraphs 462-469.
471. The polymer of paragraph 470, wherein the polymer is monomodal or bimodal.
472. A method for copolymerizing a first olefin and at least one other olefin, the method comprising contacting the first olefin and the at least one other olefin with the bimetallic catalyst complex of any one of paragraphs 432-444, and at least one activator under conditions effective to copolymerize the first olefin and the at least one other olefin, wherein the first olefin and the at least one other olefin are different from one another.
473. The method of paragraph 472, wherein the at least one activator is Ni(COD)₂.
474. The method of paragraph 472 or 473, wherein the step of contacting the first olefin and the at least one other olefin with the bimetallic catalyst complex and the at least one activator is performed in the presence of at least one solvent.
475. The method of paragraph 474, wherein the at least one solvent is a non-polar solvent, a polar solvent, or combination thereof.
476. The method of any one of paragraphs 472-475, wherein the first olefin and the at least one other olefin are each independently an optionally substituted olefin.
477. The method of any one of paragraphs 472-475, wherein the first olefin and the at least one other olefin are each independently an optionally substituted terminal olefin or an optionally substituted internal olefin.
478. The method of any one of paragraphs 472-477, wherein the first olefin is ethylene.
479. A polymer formed by the method of any one of paragraphs 472-478.
480. The polymer of paragraph 479, wherein the polymer is monomodal or bimodal.
481. A method for making a compound, the method comprising contacting a reactant with a bimetallic catalyst complex of any one of paragraphs 432-444 under conditions effective to make the compound.
482. The method of paragraph 481, wherein the step of contacting the reactant with the bimetallic catalyst complex is performed in the presence of at least one solvent.
483. The method of paragraph 482, wherein the at least one solvent is a non-polar solvent, a polar solvent, or combination thereof.
484. The method of any one of paragraphs 481-483, further comprising contacting at least one activator with the bimetallic catalyst complex and the reactant.
485. The method of paragraph 484, wherein the at least one activator is Ni(COD)₂.
486. The method of any one of paragraphs 481-485, wherein the compound is a small molecule.
487. The method of any one of paragraphs 481-486, wherein the method is a cascade method.
488. A method for making a compound, the method comprising contacting a first reactant and at least one other reactant with a bimetallic catalyst complex of any one of paragraphs 432-444 under conditions effective to make the compound.
489. The method of paragraph 488, wherein the step of contacting the first reactant and the at least one other reactant with the bimetallic catalyst complex is performed in the presence of at least one solvent.
490. The method of paragraph 489, wherein the at least one solvent is a non-polar solvent, a polar solvent, or combination thereof.
491. The method of any one of paragraphs 488-490, further comprising contacting at least one activator with the bimetallic catalyst complex, the first reactant, and the at least one other reactant.
492. The method of paragraph 491, wherein the at least one activator is Ni(COD)₂.
493. The method of any one of paragraphs 488-492, wherein the compound is a small molecule.
494. The method of any one of paragraphs 488-493, wherein the method is a cascade method.
495. The method of any one of paragraphs 488-494, wherein the first reactant and the at least one other reactant are different from one another.
496. A method of making a polymer, comprising contacting a monomer with the bimetallic catalyst complex of any one of paragraphs 432-444.
497. The method of paragraph 496, wherein the step of contacting the monomer with the bimetallic catalyst complex is performed in the presence of at least one solvent.
498. The method of paragraph 497, wherein the at least one solvent is a non-polar solvent, a polar solvent, or combination thereof.
499. The method of any one of paragraphs 496-498, further comprising contacting at least one activator with the bimetallic catalyst complex and the monomer.
500. The method of paragraph 499, wherein the at least one activator is Ni(COD)₂.
501. The method of any one of paragraphs 496-500, wherein the monomer is an optionally substituted olefin.
502. The method of any one of paragraphs 496-500, wherein the monomer is an optionally substituted terminal olefin or an optionally substituted internal olefin.
503. The method of any one of paragraphs 496-502, wherein the monomer is ethylene.
504. The method of any one of paragraphs 496-503, wherein the polymer is bimodal or monomodal.
505. A polymer made by the method of any one of paragraphs 496-503.
506. The polymer of paragraph 505, wherein the polymer is bimodal or monomodal.
507. A method of making a copolymer, comprising contacting a first monomer and at least one other monomer with a bimetallic catalyst complex of any one of paragraphs 432-444, wherein the first monomer and the at least one other monomer are different from one another.
508. The method of paragraph 507, wherein the step of contacting the first monomer and the at least one other monomer with the bimetallic catalyst complex is performed in the presence of at least one solvent.
509. The method of paragraph 508, wherein the at least one solvent is a non-polar solvent, a polar solvent, or combination thereof.
510. The method of any one of paragraphs 507-509, further comprising contacting at least one activator with the bimetallic catalyst complex, the first monomer, and the at least one other monomer.
511. The method of paragraph 510, wherein the at least one activator is Ni(COD)₂.
512. The method of any one of paragraphs 507-511, wherein the first monomer and the at least one other monomer are each independently an optionally substituted olefin.
513. The method of any one of paragraphs 507-511, wherein the first monomer and the at least one other monomer are each independently an optionally substituted terminal olefin or an optionally substituted internal olefin.
514. The method of any one of paragraphs 507-513, wherein the first monomer is ethylene.
515. The method of any one of paragraphs of 507-514, wherein the copolymer is bimodal or monomodal.
516. A copolymer made by the method of any one of paragraphs 507-514
517. The copolymer of paragraph 516, wherein the copolymer is monomodal or bimodal.
518. The method of any one of paragraphs 507-511, wherein the first monomer is CO₂; and the at least one other monomer is an epoxide.
519. A catalyst composition, comprising at least four bimetallic catalyst complexes, wherein the at least four bimetallic catalyst complexes are selected from: a bimetallic catalyst complex of Formula (15), a bimetallic catalyst complex of Formula (16), a bimetallic catalyst complex of Formula (17), and a bimetallic catalyst complex of Formula (18): wherein the bimetallic catalyst complex of Formula (15) has the structure:

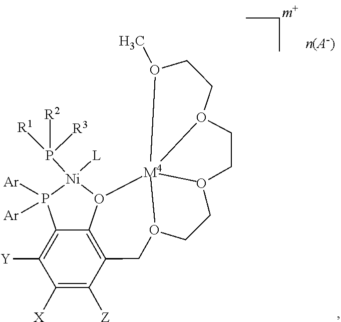

wherein the bimetallic catalyst complex of Formula (16) has the structure:

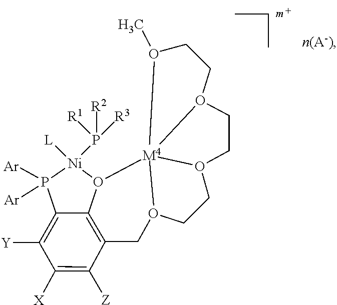

wherein the bimetallic catalyst complex of Formula (17) has the structure:

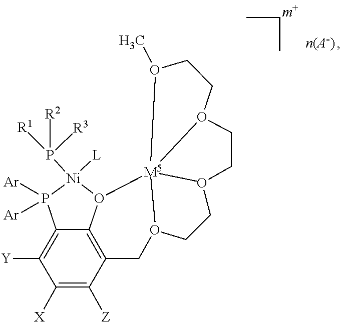

wherein the bimetallic catalyst complex of Formula (18) has the structure:

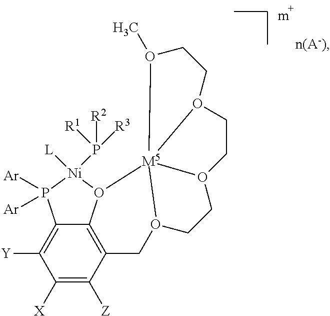

wherein in Formula (15), Formula (16), Formula (17) and Formula (18): m is 2, 3, 4, or 5; n is 1, 2, 3, 4, or 5; Ar is 2,6-dimethoxyphenyl; L is an optionally substituted phenyl group; M⁴ is a 2+ cation, 3+ cation, 4+ cation, or 5+ cation; M⁵ is a 2+ cation, 3+ cation, 4+ cation, or 5+ cation; A is a weakly coordinating anion; X, Y, and Z are each independently selected from hydrogen, an electron donating group, and an electron withdrawing group; and R¹, R², and R³ are each independently selected from optionally substituted aryl, optionally substituted alkyl, and optionally substituted cycloalkyl; wherein m is the same in the bimetallic catalyst complex of Formula (15), Formula (16), Formula (17), and Formula (18); wherein n is the same in the bimetallic catalyst complex of Formula (15), Formula (16), Formula (17), and Formula (18); wherein A is the same in the bimetallic catalyst complex of Formula (15), Formula (16), Formula (17), and Formula (18); wherein Ar is the same in the bimetallic catalyst complex of Formula (15), Formula (16), Formula (17), and Formula (18); wherein L is the same in the bimetallic catalyst complex of Formula (15), Formula (16), Formula (17), and Formula (18); wherein X is the same in the bimetallic catalyst complex of Formula (15), Formula (16), Formula (17), and Formula (18); wherein Y is the same in the bimetallic catalyst complex of Formula (15), Formula (16), Formula (17), and Formula (18); wherein Z is the same in the bimetallic catalyst complex of Formula (15), Formula (16), Formula (17), and Formula (18); wherein R¹ is the same in the bimetallic catalyst complex of Formula (15), Formula (16), Formula (17), and Formula (18); wherein R² is the same in the bimetallic catalyst complex of Formula (15), Formula (16), Formula (17), and Formula (18); wherein R³ is the same in the bimetallic catalyst complex of Formula (15), Formula (16), Formula (17), and Formula (18); wherein M⁴ is the same in the bimetallic catalyst complex of Formula (15) and Formula (16); wherein M⁵ is the same in the bimetallic catalyst complex of Formula (17) and Formula (18); and wherein M⁴ and M⁵ are different from one another.
520. A catalyst composition, comprising at least four bimetallic catalyst complexes, wherein the at least four bimetallic catalyst complexes are selected from: a bimetallic catalyst complex of Formula (15-A), a bimetallic catalyst complex of Formula (16-A), a bimetallic catalyst complex of Formula (17-A), and a bimetallic catalyst complex of Formula (18-A): wherein the bimetallic catalyst complex of Formula (15-A) has the structure:

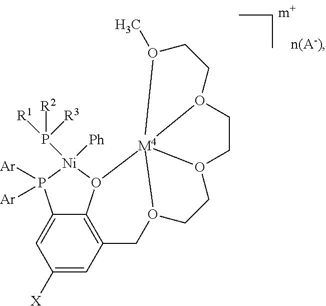

wherein the bimetallic catalyst complex of Formula (16-A) has the structure:

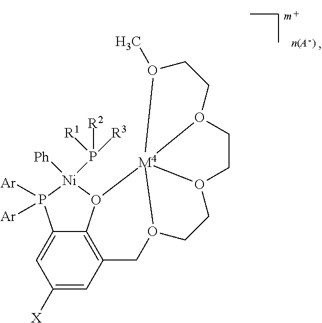

wherein the bimetallic catalyst complex of Formula (17-A) has the structure:

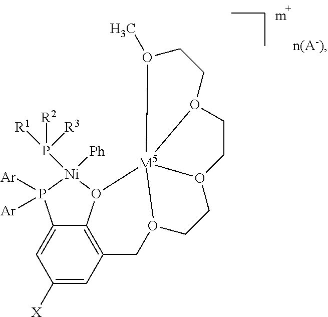

wherein the bimetallic catalyst complex of Formula (18-A) has the structure:

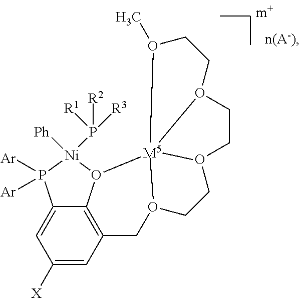

wherein in Formula (15-A), Formula (16-A), Formula (17-A) and Formula (18-A): m is 2, 3, 4, or 5; n is 1, 2, 3, 4, or 5; Ar is 2,6-dimethoxyphenyl; Ph is a phenyl group; M⁴ is a 2+ cation, 3+ cation, 4+ cation, or 5+ cation; M³ is a 2+ cation, 3+ cation, 4+ cation, or 5+ cation; A is a weakly coordinating anion; X is hydrogen, an electron donating group, or an electron withdrawing group; and R¹, R², and R³ are each independently selected from optionally substituted aryl, optionally substituted alkyl, and optionally substituted cycloalkyl; wherein m is the same in the bimetallic catalyst complex of Formula (15-A), Formula (16-A), Formula (17-A), and Formula (18-A); wherein n is the same in the bimetallic catalyst complex of Formula (15-A), Formula (16-A), Formula (17-A), and Formula (18-A); wherein A is the same in the bimetallic catalyst complex of Formula (15-A), Formula (16-A), Formula (17-A), and Formula (18-A); wherein Ar is the same in the bimetallic catalyst complex of Formula (15-A), Formula (16-A), Formula (17-A), and Formula (18-A); wherein Ph is the same in the bimetallic catalyst complex of Formula (15-A), Formula (16-A), Formula (17-A), and Formula (18-A); wherein X is the same in the bimetallic catalyst complex of Formula (15-A), Formula (16-A), Formula (17-A), and Formula (18-A); wherein R¹ is the same in the bimetallic catalyst complex of Formula (15-A), Formula (16-A), Formula (17-A), and Formula (18-A); wherein R² is the same in the bimetallic catalyst complex of Formula (15-A), Formula (16-A), Formula (17-A), and Formula (18-A); wherein R³ is the same in the bimetallic catalyst complex of Formula (15-A), Formula (16-A), Formula (17-A), and Formula (18-A); wherein M⁴ is the same in the bimetallic catalyst complex of Formula (15-A) and Formula (16-A); wherein M⁵ is the same in the bimetallic catalyst complex of Formula (17-A) and Formula (18-A); and wherein M⁴ and M⁵ are different from one another.
521. A catalyst composition, comprising at least four bimetallic catalyst complexes, wherein the at least four bimetallic catalyst complexes are selected from: a bimetallic catalyst complex of Formula (15-B), a bimetallic catalyst complex of Formula (16-B), a bimetallic catalyst complex of Formula (17-B), and a bimetallic catalyst complex of Formula (18-B): wherein the bimetallic catalyst complex of Formula (15-B) has the structure:

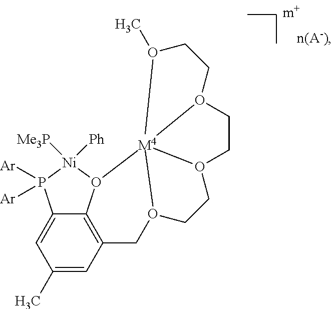

wherein the bimetallic catalyst complex of Formula (16-B) has the structure:

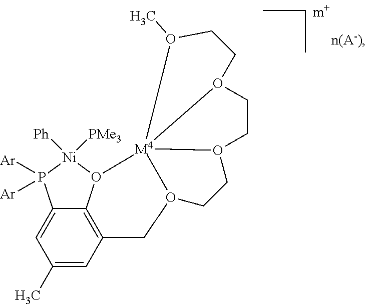

wherein the bimetallic catalyst complex of Formula (17-B) has the structure:

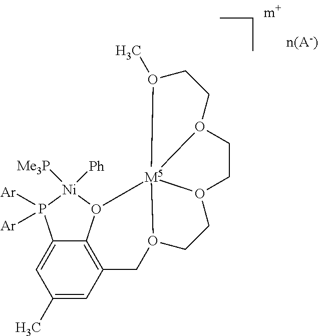

wherein the bimetallic catalyst complex of Formula (18-B) has the structure:

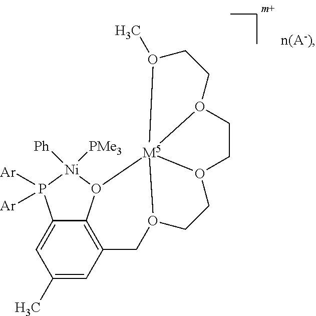

wherein in Formula (15-B), Formula (16-B), Formula (17-B) and Formula (18-B): m is 2, 3, 4, or 5; n is 1, 2, 3, 4, or 5; Ar is 2,6-dimethoxyphenyl; Ph is a phenyl group; M⁴ is a 2+ cation, 3+ cation, 4+ cation, or 5+ cation; M⁵ is a 2+ cation, 3+ cation, 4+ cation, or 5+ cation; A⁻ is [(3,5-(CF₃)₂C₆H₃)₄B]⁻; and PMe₃ is trimethylphosphine; wherein m is the same in the bimetallic catalyst complex of Formula (15-B), Formula (16-B), Formula (17-B), and Formula (18-B); wherein n is the same in the bimetallic catalyst complex of Formula (15-B), Formula (16-B), Formula (17-B), and Formula (18-B); wherein A is the same in the bimetallic catalyst complex of Formula (15-B), Formula (16-B), Formula (17-B), and Formula (18-B); wherein Ar is the same in the bimetallic catalyst complex of Formula (15-B), Formula (16-B), Formula (17-B), and Formula (18-B); wherein Ph is the same in the bimetallic catalyst complex of Formula (15-B), Formula (16-B), Formula (17-B), and Formula (18-B); wherein PMe₃ is the same in the bimetallic catalyst complex of Formula (15-B), Formula (16-B), Formula (17-B), and Formula (18-B); wherein M⁺ is the same in the bimetallic catalyst complex of Formula (15-B) and Formula (16-B); wherein M⁵ is the same in the bimetallic catalyst complex of Formula (17-B) and Formula (18-B); and wherein M⁴ and M³ are different from one another.
522. The catalyst composition of paragraph 519 or 520, wherein the electron donating group is selected from the group consisting of: alkoxy, amino, hydroxy, and alkyl.
523. The catalyst composition of paragraph 266, wherein alkyl is selected from the group consisting of: —CH₃, —CH₂CH₃, —CH₂CH₂CH₃, and —CH(CH₃)₂.
524. The catalyst composition of paragraph 263 or 264, wherein the electron withdrawing group is selected from the group consisting of: NO₂, —CN, —C(O)-alkyl, and halo.
525. The catalyst composition of any one of paragraphs 263-265, wherein the phenyl group is

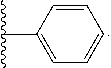 [SMILES: *c1ccccc1]

526. A method for catalyzing homopolymerization of an optionally substituted olefin, comprising: combining or contacting an optionally substituted olefin with the catalyst composition of any one of paragraphs 519-525, whereby the optionally substituted olefin undergoes homopolymerization.
527. The method of paragraph 526, wherein the step of combining or contacting the optionally substituted olefin with the catalyst is performed in the presence of at least one solvent.
528. The method of paragraph 527, wherein the at least one solvent is a non-polar solvent, a polar solvent, or combination thereof.
529. The method of any one of paragraphs 526-528 further comprising combining or contacting at least one activator with the catalyst and the optionally substituted olefin.
530. The method of paragraph 529, wherein the at least one activator is Ni(COD)₂.
531. The method of any one of paragraphs 526-530 wherein the optionally substituted olefin is an optionally substituted terminal olefin or an optionally substituted internal olefin.
532. The method of any one of paragraphs 526-531, wherein the optionally substituted olefin is ethylene.
533. A polymer formed by the method of any one of paragraphs 526-532.
534. The polymer of paragraph 533, wherein the polymer is monomodal or bimodal.
535. A method for polymerizing an optionally substituted olefin, the method comprising contacting an optionally substituted olefin with the catalyst composition of any one of paragraphs 519-525 and at least one activator under conditions effective to polymerize the optionally substituted olefin.
536. The method of paragraph 535, wherein the at least one activator is Ni(COD)₂.
537. The method of paragraph 535 or 536, wherein the step of contacting the optionally substituted olefin with the catalyst composition and the at least one activator is performed in the presence of at least one solvent.
538. The method of paragraph 537, wherein the at least one solvent is a non-polar solvent, a polar solvent, or combination thereof.
539. The method of any one of paragraphs 535-538, wherein the optionally substituted olefin is an optionally substituted terminal olefin or an optionally substituted internal olefin.
540. The method of any one of paragraphs 535-539, wherein the optionally substituted olefin is ethylene.
541. A polymer formed by the method of any one of paragraphs 535-540.
542. The polymer of paragraph 541, wherein the polymer is monomodal or bimodal.
543. A method for catalyzing copolymerization of a first olefin and at least one other olefin, comprising: combining or contacting a first olefin and at least one other olefin with the catalyst composition of any one of paragraphs 519-525, whereby the first olefin and the at least one other olefin undergoes copolymerization, and wherein the first olefin and the at least one other olefin are different from one another.
544. The method of paragraph 543, wherein the step of combining or contacting the first olefin and the at least one other olefin with the catalyst composition is performed in the presence of at least one solvent.
545. The method of paragraph 544, wherein the at least one solvent is a non-polar solvent, a polar solvent, or combination thereof.
546. The method of any one of paragraphs 543-545, further comprising combining or contacting at least one activator with the catalyst composition, the first olefin, and the at least one other olefin.
547. The method of paragraph 546, wherein the at least one activator is Ni(COD)₂.
548. The method of any one of paragraphs 543-547, wherein the first olefin and the at least one other olefin are each independently an optionally substituted olefin.
549. The method of any one of paragraphs 543-547, wherein the first olefin and the at least one other olefin are each independently an optionally substituted terminal olefin or an optionally substituted internal olefin.
550. The method of any one of paragraphs 543-549, wherein the first olefin is ethylene.
551. A polymer formed by the method of any one of paragraphs 543-550.
552. The polymer of paragraph 551, wherein the polymer is monomodal or bimodal.
553. A method for copolymerizing a first olefin and at least one other olefin, the method comprising contacting the first olefin and the at least one other olefin with the catalyst composition of any one of paragraphs 519-525, and at least one activator under conditions effective to copolymerize the first olefin and the at least one other olefin, wherein the first olefin and the at least one other olefin are different from one another.
554. The method of paragraph 553, wherein the at least one activator is Ni(COD)₂.
555. The method of paragraph 553 or 554, wherein the step of contacting the first olefin and the at least one other olefin with the catalyst composition and the at least one activator is performed in the presence of at least one solvent.
556. The method of paragraph 555, wherein the at least one solvent is a non-polar solvent, a polar solvent, or combination thereof.
557. The method of any one of paragraphs 553-556, wherein the first olefin and the at least one other olefin are each independently an optionally substituted olefin.
558. The method of any one of paragraphs 553-556, wherein the first olefin and the at least one other olefin are each independently an optionally substituted terminal olefin or an optionally substituted internal olefin.
559. The method of any one of paragraphs 553-558, wherein the first olefin is ethylene.
560. A polymer formed by the method of any one of paragraphs 553-559.
561. The polymer of paragraph 560, wherein the polymer is monomodal or bimodal.
562. A method for making a compound, the method comprising contacting a reactant with a catalyst composition of any one of paragraphs 519-525 under conditions effective to make the compound.
563. The method of paragraph 562, wherein the step of contacting the reactant with the catalyst composition is performed in the presence of at least one solvent.
564. The method of paragraph 563, wherein the at least one solvent is a non-polar solvent, a polar solvent, or combination thereof.
565. The method of any one of paragraphs 562-564, further comprising contacting at least one activator with the catalyst composition and the reactant.
566. The method of paragraph 565, wherein the at least one activator is Ni(COD)₂.
567. The method of any one of paragraphs 562-566, wherein the compound is a small molecule.
568. The method of any one of paragraphs 562-567, wherein the method is a cascade method.
569. A method for making a compound, the method comprising contacting a first reactant and at least one other reactant with a catalyst composition of any one of paragraphs 519-525 under conditions effective to make the compound.
570. The method of paragraph 569, wherein the step of contacting the first reactant and the at least one other reactant with the catalyst composition is performed in the presence of at least one solvent.
571. The method of paragraph 570, wherein the at least one solvent is a non-polar solvent, a polar solvent, or combination thereof.
572. The method of any one of paragraphs 569-571, further comprising contacting at least one activator with the catalyst composition, the first reactant, and the at least one other reactant.
573. The method of paragraph 572, wherein the at least one activator is Ni(COD)₂.
574. The method of any one of paragraphs 569-573, wherein the compound is a small molecule.
575. The method of any one of paragraphs 569-574, wherein the method is a cascade method.
576. The method of any one of paragraphs 569-576, wherein the first reactant and the at least one other reactant are different from one another.
577. A method of making a polymer, comprising contacting a monomer with the catalyst composition of any one of paragraphs 519-525.
578. The method of paragraph 577, wherein the step of contacting the monomer with the catalyst composition is performed in the presence of at least one solvent.
579. The method of paragraph 578, wherein the at least one solvent is a non-polar solvent, a polar solvent, or combination thereof.
580. The method of any one of paragraphs 577-579, further comprising contacting at least one activator with the catalyst composition and the monomer.
581. The method of paragraph 580, wherein the at least one activator is Ni(COD)₂.
582. The method of any one of paragraphs 577-581, wherein the monomer is an optionally substituted olefin.
583. The method of any one of paragraphs 577-581, wherein the monomer is an optionally substituted terminal olefin or an optionally substituted internal olefin.
584. The method of any one of paragraphs 577-583, wherein the monomer is ethylene.
585. The method of any one of paragraphs 577-584, wherein the polymer is bimodal or monomodal.
586. A polymer made by the method of any one of paragraphs 577-585.
587. The polymer of paragraph 586, wherein the polymer is bimodal or monomodal.
588. A method of making a copolymer, comprising contacting a first monomer and at least one other monomer with a catalyst composition of any one of paragraphs 519-525, wherein the first monomer and the at least one other monomer are different from one another.
589. The method of paragraph 588, wherein the step of contacting the first monomer and the at least one other monomer with the catalyst composition is performed in the presence of at least one solvent.
590. The method of paragraph 589, wherein the at least one solvent is a non-polar solvent, a polar solvent, or combination thereof.
591. The method of any one of paragraphs 588-590, further comprising contacting at least one activator with the catalyst composition, the first monomer, and the at least one other monomer.
592. The method of paragraph 591, wherein the at least one activator is Ni(COD)₂.
593. The method of any one of paragraphs 588-592, wherein the first monomer and the at least one other monomer are each independently an optionally substituted olefin.
594. The method of any one of paragraphs 588-592, wherein the first monomer and the at least one other monomer are each independently an optionally substituted terminal olefin or an optionally substituted internal olefin.
595. The method of any one of paragraphs 588-594, wherein the first monomer is ethylene.
596. The method of any one of paragraphs of 588-595, wherein the copolymer is bimodal or monomodal.
597. A copolymer made by the method of any one of paragraphs 588-595.
598. The copolymer of paragraph 597, wherein the copolymer is monomodal or bimodal.
599. The method of any one of paragraphs 588-598, wherein the first monomer is CO₂; and the at least one other monomer is an epoxide.
600. A method in any of the preceding paragraphs in which the optionally substituted olefin is a polar olefin.

Some embodiments of the present invention can be defined as any of the following numbered paragraphs:
1. A bimetallic catalyst complex having a structure selected from Formula (5) and Formula (6):

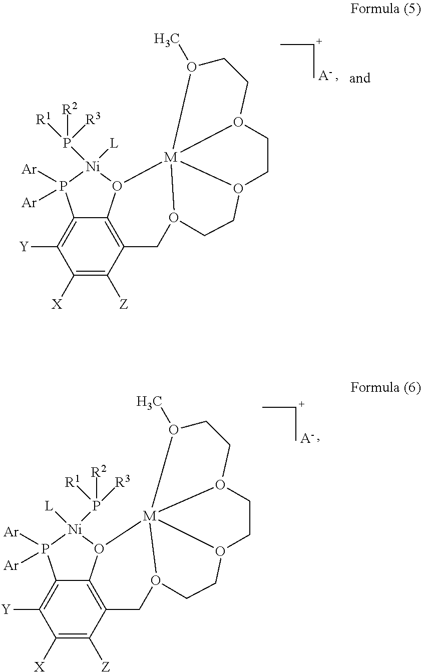

wherein in Formula (5) and Formula (6):
   Ar is 2,6-dimethoxyphenyl;
   L is an optionally substituted phenyl group;
   M is Li, Na, K, or Cs;
   A⁻ is a weakly coordinating anion;
   X, Y, and Z are each independently selected from hydrogen, an electron donating group, and an electron withdrawing group; and
   R¹, R², and R³ are each independently selected from optionally substituted aryl, optionally substituted alkyl, and optionally substituted cycloalkyl.
2. The bimetallic catalyst complex of paragraph 1, wherein the electron donating group is selected from the group consisting of: alkoxy, phenoxy, amino, alkylamino, dialkylamino, hydroxy, alkyl, and cycloalkyl; and the the electron withdrawing group is selected from the group consisting of: NO₂, —CN, —C(O)-alkyl, C(O)Oalkyl, C(O)Nalkyl, —SO₃H, —SO₂alkyl, —PO₃H, —PO₃alkyl, —CF₃, and halo.
3. The bimetallic catalyst complex of paragraph 1, wherein
   Ar is 2,6-dimethoxyphenyl;
   L is a phenyl group;
   M is Li, Na, K, or Cs;
   A⁻ is [(3,5-(CF₃)₂C₆H₃)₄B]⁻;
   X is methyl;
   Y is hydrogen;
   Z is hydrogen; and
   R¹, R², and R³ are each methyl.
4. A method for catalyzing homopolymerization of an optionally substituted olefin, comprising:
   contacting an optionally substituted olefin with the bimetallic catalyst complex of paragraph 1, whereby the optionally substituted olefin undergoes homopolymerization.
5. The method of paragraph 4, wherein the step of contacting the optionally substituted olefin with the bimetallic catalyst complex is performed in the presence of at least one solvent.
6. The method of paragraph 5, wherein the at least one solvent is a non-polar solvent, a polar solvent, or combination thereof.
7. The method of paragraph 4, further comprising contacting at least one activator with the bimetallic catalyst complex and the optionally substituted olefin.
8. The method of paragraph 7, wherein the at least one activator is selected from the group consisting of Ni(COD)₂, triarylborane, methylaluminoxane, and trialkylaluminum.
9. The method of paragraph 4, wherein the optionally substituted olefin is an optionally substituted terminal olefin or an optionally substituted internal olefin.
10. The method of paragraph 4, wherein the optionally substituted olefin is ethylene.
11. A polymer formed by the method of paragraph 4.
12. The polymer of paragraph 11, wherein the polymer is monomodal or bimodal.
13. A method for catalyzing copolymerization of a first optionally substituted olefin and at least one other optionally substituted olefin, comprising:
   contacting a first optionally substituted olefin and at least one other optionally substituted olefin with the bimetallic catalyst complex of paragraph 1, whereby the first optionally substituted olefin and the at least one other optionally substituted olefin undergoes copolymerization, and wherein the first optionally substituted olefin and the at least one other optionally substituted olefin are different from one another.
14. The method of paragraph 13, wherein the step of contacting the first optionally substituted olefin and the at least one other optionally substituted olefin with the bimetallic catalyst complex is performed in the presence of at least one solvent.
15. The method of paragraph 14, wherein the at least one solvent is a non-polar solvent, a polar solvent, or combination thereof.
16. The method of paragraph 13, further comprising contacting at least one activator with the bimetallic catalyst complex, the first optionally substituted olefin, and the at least one other optionally substituted olefin.
17. The method of paragraph 16, wherein the at least one activator is selected from the group consisting of Ni(COD)₂, triarylborane, methylaluminoxane, and trialkylaluminum.
18. The method of paragraph 13, wherein the first optionally substituted olefin and the at least one other optionally substituted olefin are each independently an optionally substituted terminal olefin or an optionally substituted internal olefin.
19. A copolymer formed by the method of paragraph 13.
20. The copolymer of paragraph 19, wherein the copolymer is monomodal or bimodal.

Cation Tunable Copolymerization of Ethylene and Alkyl Acrylate: Polyethylene is one of the most widely used synthetic polymers in the world due to its durability, light weight, and low cost (Hustad, P. D. Science 2009, 325 (5941), 704-707). Because polyethylene is derived from hydrocarbons, it is non-polar and hydrophobic. Introducing polar functional groups to its polymer chain can significantly enhance its wettability, adhesion, compatibility, and biodegradability. We recently developed a catalytic system based on a nickel phenoxyphosphine polyethylene glycol complex (Tran, T. V.; Nguyen, Y. H., Do, L. H. Polym. Chem. 2019, 10 (27), 3718-3721) that can copolymerize ethylene and polar monomers (e.g., methyl acrylate, tert-butyl acrylate, and ethyl acrylate) in the presence of alkali metal ions. The secondary metal cations can influence the catalyst activity, polymer molecular weight, and polar monomer incorporation. Remarkably, this polymerization method achieved one of the highest activity in ethylene and methyl acrylate copolymerization reported to date. Under non-switching conditions, it was possible to obtain bimodal polymers by varying the ratio of two different cations. Under dynamic switching conditions (Tran, T. V.; Lee, E.; Nguyen, Y. H.; Nguyen, H. D.; Do, L. H. J. Am. Chem. Soc. 2022, 144 (37), 17129-17139) we were able to prepare monomodal copolymers with systematically varied molecular weights and polar monomer incorporation, which, to the best of our knowledge, is unprecedented in literature. Introducing polar functional groups to its polymer chain can significantly enhance its degradability.

### VARIOUS EMBODIMENTS OF THE INVENTION

### Catalysts of Formula (1), Formula (2), Formula (1-A), Formula (2-A). Formula (1-B), Formula (2-B).

In various embodiments, the present invention provides a catalyst having a structure selected from Formula (1) and Formula (2):

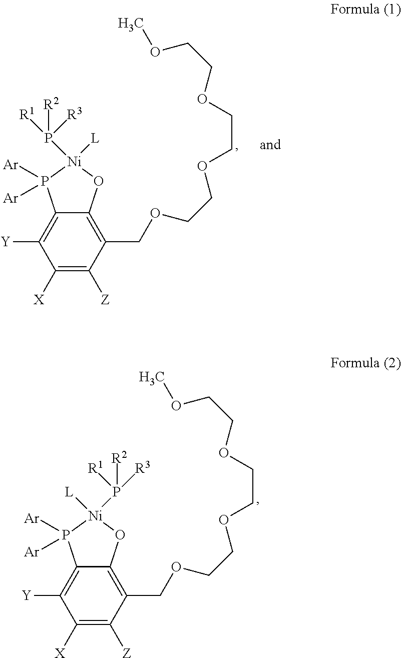

wherein in Formula (1) and Formula (2):
Ar is 2,6-dimethoxyphenyl, 2-methoxyphenyl, or phenyl;
L is an optionally substituted phenyl group;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl.

In various embodiments, the present invention provides a catalyst having a structure of Formula (1):

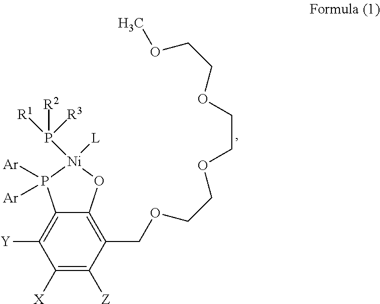

wherein,
Ar is 2,6-dimethoxyphenyl, 2-methoxyphenyl, or phenyl;
L is an optionally substituted phenyl group;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl.

In various embodiments, the present invention provides a catalyst having a structure of Formula (2):

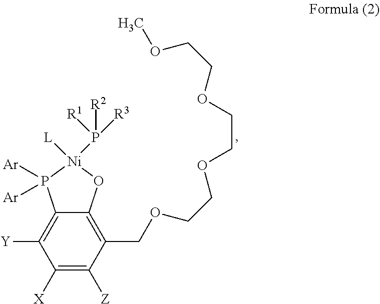

wherein,
Ar is 2,6-dimethoxyphenyl, 2-methoxyphenyl, or phenyl;
L is an optionally substituted phenyl group;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl.

In various embodiments, the present invention provides a catalyst having a structure selected from Formula (1-A) and Formula (2-A):

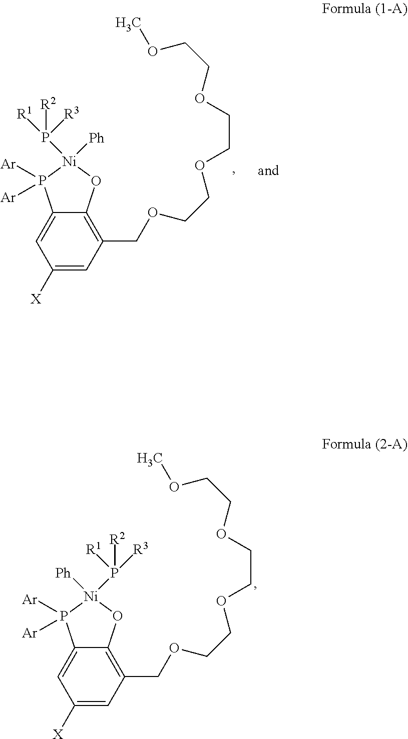

wherein in Formula (1-A) and Formula (2-A):
Ar is 2,6-dimethoxyphenyl, 2-methoxyphenyl, or phenyl;
Ph is a phenyl group;
X is hydrogen, an electron donating group, or an electron withdrawing group; and
R¹, R², and R³ are each independently selected from optionally substituted aryl, optionally substituted alkyl, and optionally substituted cycloalkyl.

In various embodiments, the present invention provides a catalyst having a structure of Formula (1-A):

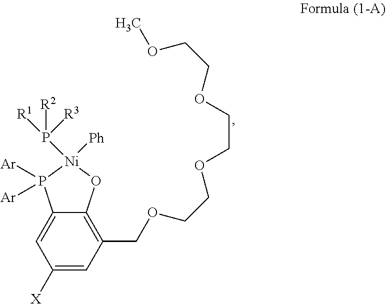

wherein,
Ar is 2,6-dimethoxyphenyl, 2-methoxyphenyl, or phenyl;
Ph is a phenyl group;
X is hydrogen, an electron donating group, or an electron withdrawing group; and
R¹, R², and R³ are each independently selected from optionally substituted aryl, optionally substituted alkyl, and optionally substituted cycloalkyl.

In various embodiments, the present invention provides a catalyst having a structure of Formula (2-A):

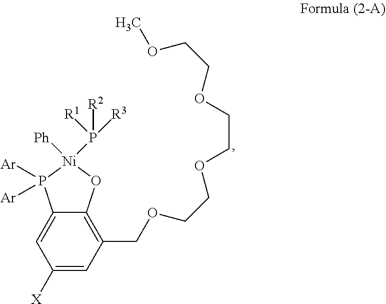

wherein,
Ar is 2,6-dimethoxyphenyl, 2-methoxyphenyl, or phenyl;
Ph is a phenyl group;
X is hydrogen, an electron donating group, or an electron withdrawing group; and
R¹, R², and R³ are each independently selected from optionally substituted aryl, optionally substituted alkyl, and optionally substituted cycloalkyl.

In various embodiments, the present invention provides a catalyst having a structure selected from Formula (1-B) and Formula (2-B):

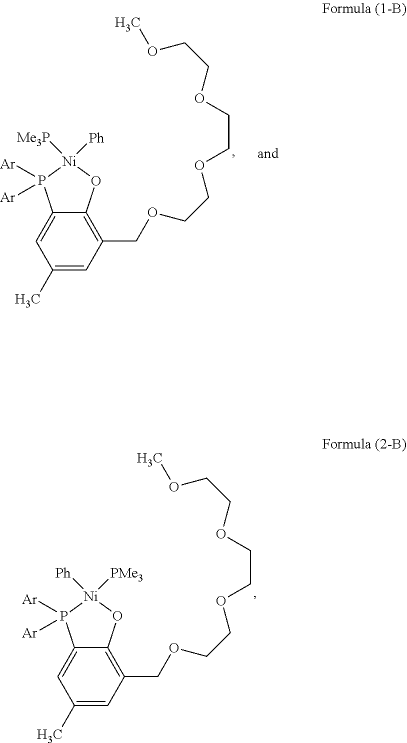

wherein in Formula (1-B) and Formula (2-B):
Ar is 2,6-dimethoxyphenyl, 2-methoxyphenyl, phenyl;
Ph is a phenyl group; and
PMe₃ is trimethylphosphine.

In various embodiments, the present invention provides a catalyst having a structure of Formula (1-B):

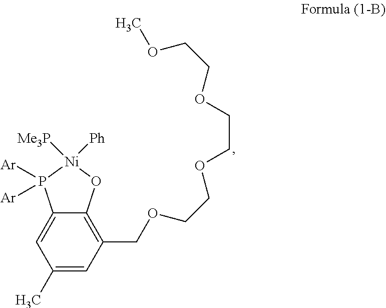

wherein,
Ar is 2,6-dimethoxyphenyl, 2-methoxyphenyl, phenyl;
Ph is a phenyl group; and
PMe₃ is trimethylphosphine.

In various embodiments, the present invention provides a catalyst having a structure of Formula (2-B):

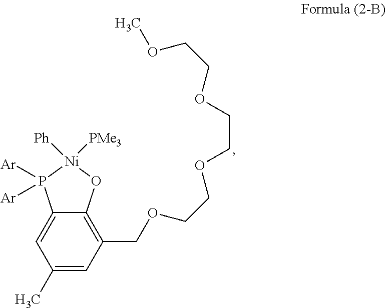

wherein,
Ar is 2,6-dimethoxyphenyl, 2-methoxyphenyl, phenyl;
Ph is a phenyl group; and
PMe₃ is trimethylphosphine.

In some embodiments, the catalyst of Formula (1-A) is a catalyst of Formula (1). In some embodiments, the catalyst of Formula (1-B) is a catalyst of Formula (1). In some embodiments, the catalyst of Formula (2-A) is a catalyst of Formula (2). In some embodiments, the catalyst of Formula (2-B) is a catalyst of Formula (2).

In some embodiments, X is selected from hydrogen, an electron donating group, and an electron withdrawing group; and Y and Z are each independently selected from hydrogen, an electron donating group, and an electron withdrawing group, provided that Y and Z are not both hydrogen.

In some embodiments, the electron donating group is selected from the group consisting of: alkoxy, amino, hydroxy, and alkyl, and cycloalkyl. In some embodiments, the electron donating group is selected from the group consisting of: alkoxy, phenoxy, amino, alkylamino, dialkylamino, hydroxy, alkyl, and cycloalkyl. In some embodiments, alkyl is selected from the group consisting of: —CH₃, —CH₂CH₃, —CH₂CH₂CH₃, and —CH(CH₃)₂. In some embodiments, the electron withdrawing group is selected from the group consisting of: NO₂, —CN, —C(O)-alkyl, and halo. In some embodiments, the electron withdrawing group is selected from the group consisting of: NO₂, —CN, —C(O)-alkyl, C(O)Oalkyl, C(O)Nalkyl, —SO₃H, —SO₂R, —PO₃H, —PO₃R, —CF₃, and halo. In some embodiments, the electron withdrawing group is selected from the group consisting of: NO₂, —CN, —C(O)-alkyl, C(O)Oalkyl, C(O)Nalkyl, —SO₃H, —SO₂alkyl, —PO₃H, —PO₃alkyl, —CF₃, and halo.

In some embodiments, the phenyl group is

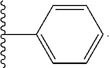 [SMILES: *c1ccccc1]

In some embodiments, L is an optionally substituted phenyl group. In some embodiments, the optionally substituted phenyl group is selected from the group consisting of phenyl, 2-methoxyphenyl, 4-methoxyphenyl, 2-acetylphenyl, or 2-(N-acetylamino)phenyl). In some embodiments, L is a phenyl group.

In some embodiments, R¹, R², and R³ are each independently selected from optionally substituted aryl, optionally substituted alkyl, and optionally substituted cycloalkyl. In some embodiments, optionally substituted aryl is selected from the group consisting of phenyl, pentafluorophenyl, 2-methoxyphenyl, 2-methylphenyl, and 4-trifluoromethylphenyl. In some embodiments, optionally substituted alkyl is selected from the group consisting of methyl, ethyl, propyl, isopropyl, or tert-butyl. In some embodiments, optionally substituted cycloalkyl is cyclohexyl or adamantyl.

### Heterobimetallic Catalysts of Formula (3), Formula (4), Formula (3-A), Formula (4-A), Formula (3-B), or Formula (4-B).

In various embodiments, the present invention provides a heterobimetallic catalyst having a structure selected from Formula (3) and Formula (4):

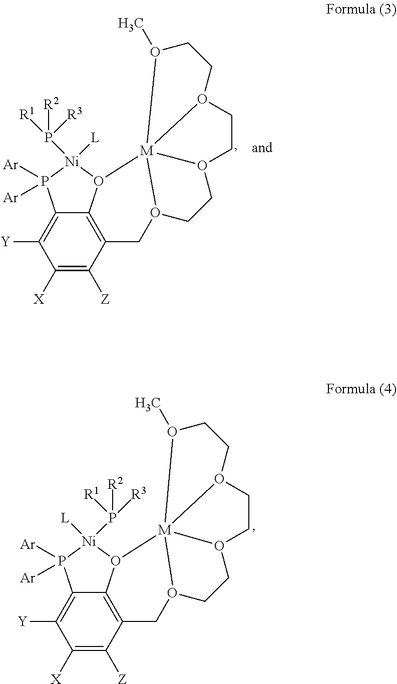

wherein in Formula (3) and Formula (4):
Ar is 2,6-dimethoxyphenyl, 2-methoxyphenyl, or phenyl;
L is an optionally substituted phenyl group;
M is Li, Na, K, or Cs;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl.

In various embodiments, the present invention provides a heterobimetallic catalyst having a structure of Formula (3):

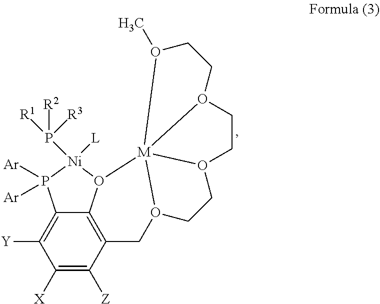

wherein,
Ar is 2,6-dimethoxyphenyl, 2-methoxyphenyl, or phenyl;
L is an optionally substituted phenyl group;
M is Li, Na, K, or Cs;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl.

In various embodiments, the present invention provides a heterobimetallic catalyst having a structure of Formula (4):

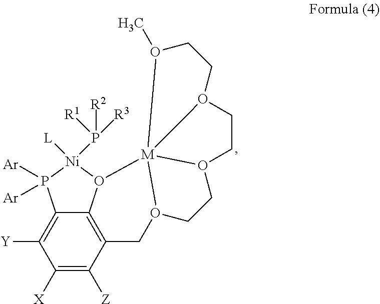

wherein,
Ar is 2,6-dimethoxyphenyl, 2-methoxyphenyl, or phenyl;
L is an optionally substituted phenyl group;
M is Li, Na, K, or Cs;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl.

In various embodiments, the present invention provides a heterobimetallic catalyst having a structure selected from Formula (3-A) and Formula (4-A):

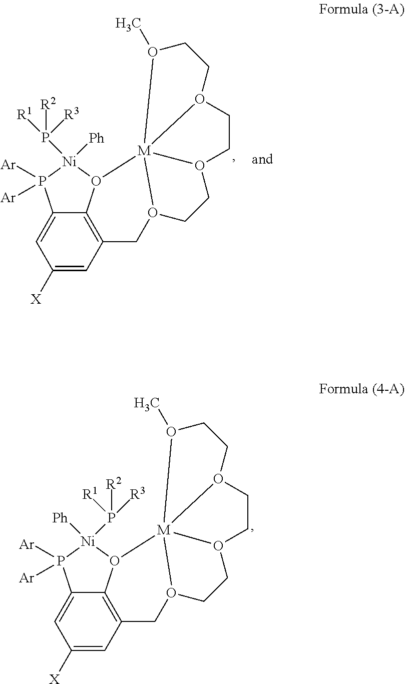

wherein in Formula (3-A) and Formula (4-A):
Ar is 2,6-dimethoxyphenyl, 2-methoxyphenyl, or phenyl;
Ph is a phenyl group;
M is Li, Na, K, or Cs;
X is hydrogen, an electron donating group, or an electron withdrawing group; and
R¹, R², and R³ are each independently selected from optionally substituted aryl, optionally substituted alkyl, and optionally substituted cycloalkyl.

In various embodiments, the present invention provides a heterobimetallic catalyst having a structure of Formula (3-A):

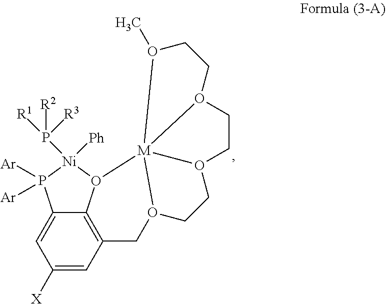

wherein,
Ar is 2,6-dimethoxyphenyl, 2-methoxyphenyl, or phenyl;
Ph is a phenyl group;
M is Li, Na, K, or Cs; X is hydrogen, an electron donating group, or an electron withdrawing group; and
R¹, R², and R³ are each independently selected from optionally substituted aryl, optionally substituted alkyl, and optionally substituted cycloalkyl.

In various embodiments, the present invention provides a heterobimetallic catalyst having a structure of Formula (4-A):

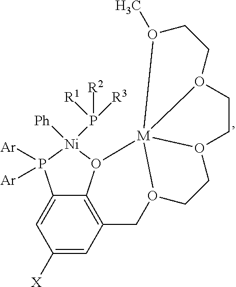

wherein,
Ar is 2,6-dimethoxyphenyl, 2-methoxyphenyl, or phenyl;
Ph is a phenyl group;
M is Li, Na, K, or Cs;
X is hydrogen, an electron donating group, or an electron withdrawing group; and
R¹, R², and R³ are each independently selected from optionally substituted aryl, optionally substituted alkyl, and optionally substituted cycloalkyl.

In various embodiments, the present invention provides a heterobimetallic catalyst having a structure selected from Formula (3-B) and Formula (4-B):

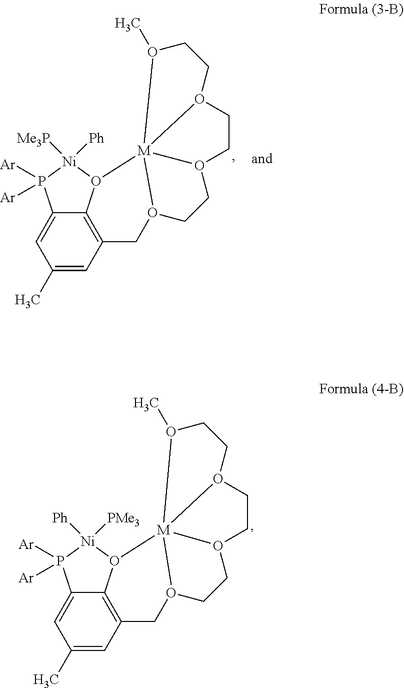

wherein in Formula (3-B) and Formula (4-B):
Ar is 2,6-dimethoxyphenyl, 2-methoxyphenyl, or phenyl;
Ph is a phenyl group;
M is Li, Na, K, or Cs; and
PMe₃ is trimethylphosphine.

In various embodiments, the present invention provides a heterobimetallic catalyst having a structure of Formula (3-B):

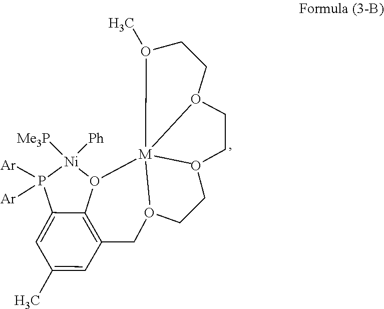

wherein,
Ar is 2,6-dimethoxyphenyl, 2-methoxyphenyl, or phenyl;
Ph is a phenyl group;
M is Li, Na, K, or Cs; and
PMe₃ is trimethylphosphine.

In various embodiments, the present invention provides a heterobimetallic catalyst having a structure of Formula (4-B):

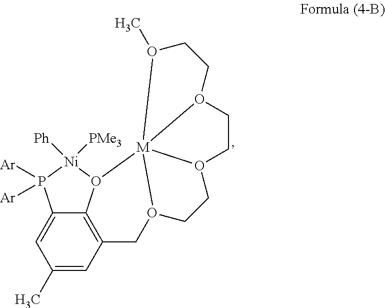

wherein,
Ar is 2,6-dimethoxyphenyl, 2-methoxyphenyl, or phenyl;
Ph is a phenyl group;
M is Li, Na, K, or Cs; and
PMe₃ is trimethylphosphine.

In some embodiments, the heterobimetallic catalyst of Formula (3-A) is a heterobimetallic catalyst of Formula (3). In some embodiments, the heterobimetallic catalyst of Formula (3-B) is a heterobimetallic catalyst of Formula (3). In some embodiments, the heterobimetallic catalyst of Formula (4-A) is a heterobimetallic catalyst of Formula (4). In some embodiments, the heterobimetallic catalyst of Formula (4-B) is a heterobimetallic catalyst of Formula (4).

In some embodiments M is Li, Na, K, or Cs. In some embodiments, M is Li. In some embodiments, M is Na. In some embodiments, M is K. In some embodiments, M is Cs.

In some embodiments, X is selected from hydrogen, an electron donating group, and an electron withdrawing group; and Y and Z are each independently selected from hydrogen, an electron donating group, and an electron withdrawing group, provided that Y and Z are not both hydrogen.

In some embodiments, the electron donating group is selected from the group consisting of: alkoxy, amino, hydroxy, and alkyl. In some embodiments, the electron donating group is selected from the group consisting of: alkoxy, phenoxy, amino, alkylamino, dialkylamino, hydroxy, alkyl, and cycloalkyl. In some embodiments, alkyl is selected from the group consisting of: —CH₃, —CH₂CH₃, —CH₂CH₂CH₃, and —CH(CH₃)₂. In some embodiments, the electron withdrawing group is selected from the group consisting of: NO₂, —CN, —C(O)-alkyl, and halo. In some embodiments, the electron withdrawing group is selected from the group consisting of: NO₂, —CN, —C(O)-alkyl, C(O)Oalkyl, C(O)Nalkyl, —SO₃H, —SO₂R, —PO₃H, —PO₃R, —CF₃, and halo. In some embodiments, the electron withdrawing group is selected from the group consisting of: NO₂, —CN, —C(O)-alkyl, C(O)Oalkyl, C(O)Nalkyl, —SO₃H, —SO₂alkyl, —PO₃H, —PO₃alkyl, —CF₃, and halo.

In some embodiments, the phenyl group is

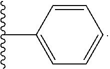 [SMILES: *c1ccccc1]

In some embodiments, L is an optionally substituted phenyl group. In some embodiments, the optionally substituted phenyl group is selected from the group consisting of phenyl, 2-methoxyphenyl, 4-methoxyphenyl, 2-acetylphenyl, or 2-(N-acetylamino)phenyl). In some embodiments, L is a phenyl group.

In some embodiments, R¹, R², and R³ are each independently selected from optionally substituted aryl, optionally substituted alkyl, and optionally substituted cycloalkyl. In some embodiments, optionally substituted aryl is selected from the group consisting of phenyl, pentafluorophenyl, 2-methoxyphenyl, 2-methylphenyl, and 4-trifluoromethylphenyl. In some embodiments, optionally substituted alkyl is selected from the group consisting of methyl, ethyl, propyl, isopropyl, or tert-butyl. In some embodiments, optionally substituted cycloalkyl is cyclohexyl or adamantyl.

### Bimetallic Catalyst Complexes of Formula (5), Formula (6), Formula (5-A). Formula (6-A), Formula (5-B), or Formula (6-B).

In various embodiments, the present invention provides a bimetallic catalyst complex having a structure selected from Formula (5) and Formula (6):

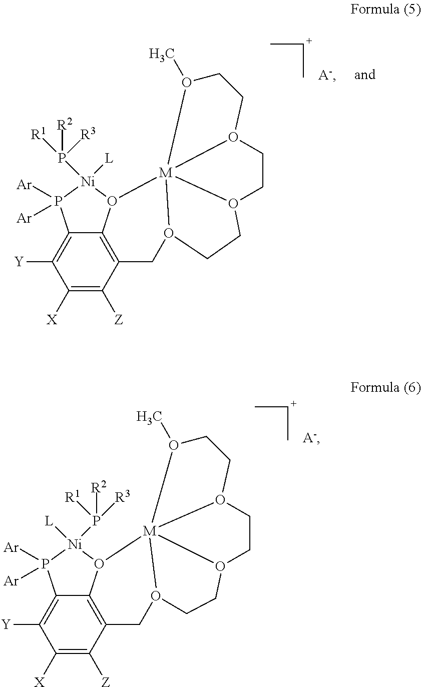

wherein in Formula (5) and Formula (6):
Ar is 2,6-dimethoxyphenyl, 2-methoxyphenyl, or phenyl;
L is an optionally substituted phenyl group;
M is Li, Na, K, or Cs;
A⁻ is a weakly coordinating anion;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl.

In various embodiments, the present invention provides a bimetallic catalyst complex having a structure of Formula (5):

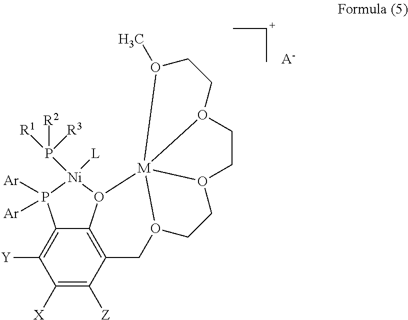

wherein,
Ar is 2,6-dimethoxyphenyl, 2-methoxyphenyl, or phenyl;
L is an optionally substituted phenyl group;
M is Li, Na, K, or Cs;
A⁻ is a weakly coordinating anion;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl.

In various embodiments, the present invention provides a bimetallic catalyst complex having a structure of Formula (6):

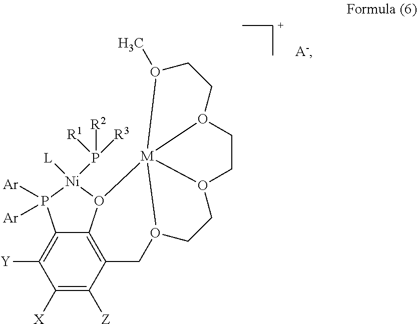

wherein,
Ar is 2,6-dimethoxyphenyl, 2-methoxyphenyl, or phenyl;
L is an optionally substituted phenyl group;
M is Li, Na, K, or Cs;
A⁻ is a weakly coordinating anion;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl.

In various embodiments, the present invention provides a bimetallic catalyst complex having a structure selected from Formula (5-A) and Formula (6-A):

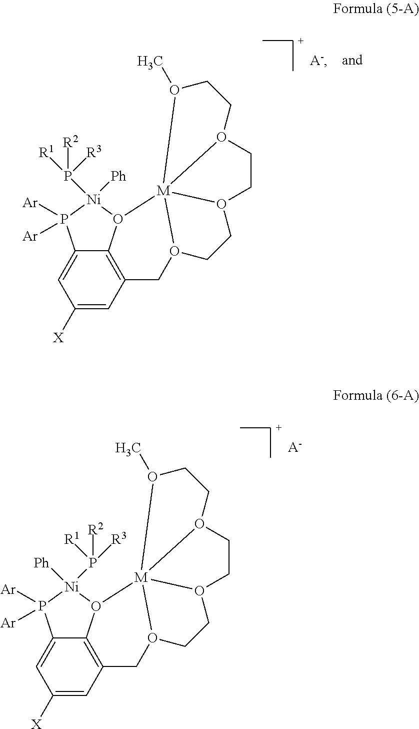

wherein Formula (5-A) and Formula (6-A):
Ar is 2,6-dimethoxyphenyl, 2-methoxyphenyl, or phenyl;
Ph is a phenyl group;
M is Li, Na, K, or Cs;
A⁻ is a weakly coordinating anion;
X is hydrogen, an electron donating group, or an electron withdrawing group; and
R¹, R², and R³ are each independently selected from optionally substituted aryl, optionally substituted alkyl, and optionally substituted cycloalkyl.

In various embodiments, the present invention provides a bimetallic catalyst complex having a structure of Formula (5-A):

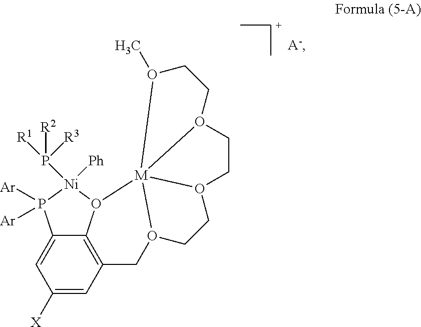

wherein,
Ar is 2,6-dimethoxyphenyl, 2-methoxyphenyl, or phenyl;
Ph is a phenyl group;
M is Li, Na, K, or Cs;
A⁻ is a weakly coordinating anion;
X is hydrogen, an electron donating group, or an electron withdrawing group; and
R¹, R², and R³ are each independently selected from optionally substituted aryl, optionally substituted alkyl, and optionally substituted cycloalkyl.

In various embodiments, the present invention provides a bimetallic catalyst complex having a structure of Formula (6-A):

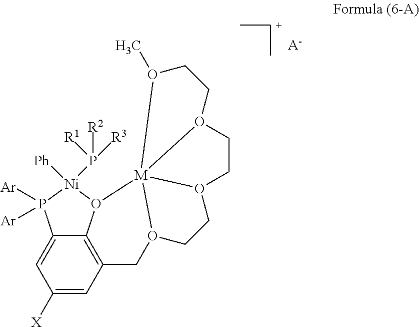

wherein,
   Ar is 2,6-dimethoxyphenyl, 2-methoxyphenyl, or phenyl;
   Ph is a phenyl group;
   M is Li, Na, K, or Cs;
   A⁻ is a weakly coordinating anion;
   X is hydrogen, an electron donating group, or an electron withdrawing group; and
   R¹, R², and R³ are each independently selected from optionally substituted aryl, optionally substituted alkyl, and optionally substituted cycloalkyl.

In various embodiments, the present invention provides a bimetallic catalyst complex having a structure selected from Formula (5-B) and Formula (6-B):

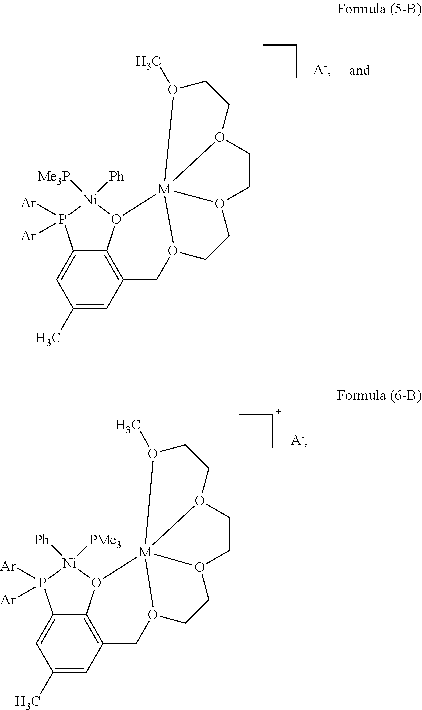

wherein Formula (5-B) and Formula (6-B):
   Ar is 2,6-dimethoxyphenyl, 2-methoxyphenyl, or phenyl;
   Ph is a phenyl group;
   M is Li, Na, K, or Cs;
   A⁻ is [(3,5-(CF₃)₂C₆H₃)₄B]⁻; and
   PMe₃ is trimethylphosphine.

In various embodiments, the present invention provides a bimetallic catalyst complex having a structure of Formula (5-B) is:

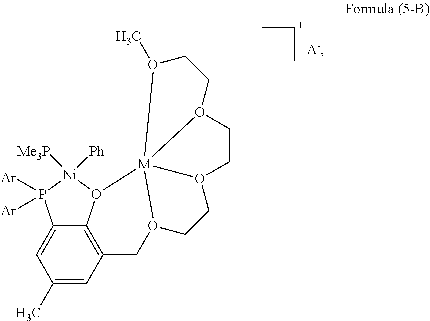

wherein,
   Ar is 2,6-dimethoxyphenyl, 2-methoxyphenyl, or phenyl;
   Ph is a phenyl group;
   M is Li, Na, K, or Cs;
   A⁻ is [(3,5-(CF₃)₂C₆H₃)₄B]⁻; and
   PMe₃ is trimethylphosphine.

In various embodiments, the present invention provides a bimetallic catalyst complex having a structure of Formula (6-B):

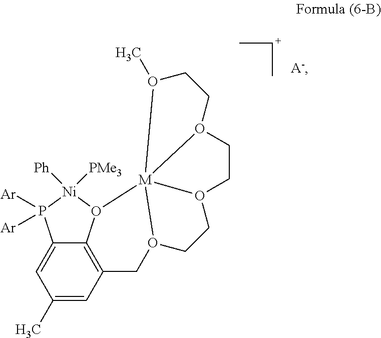

wherein,
   Ar is 2,6-dimethoxyphenyl, 2-methoxyphenyl, or phenyl;
   Ph is a phenyl group;
   M is Li, Na, K, or Cs;
   A⁻ is [(3,5-(CF₃)₂C₆H₃)₄B]⁻; and
   PMe₃ is trimethylphosphine.

In some embodiments, the bimetallic catalyst complex of Formula (5-A) is a bimetallic catalyst complex of Formula (5). In some embodiments, the bimetallic catalyst complex of Formula (5-B) is a bimetallic catalyst complex of Formula (5). In some embodiments, the bimetallic catalyst complex of Formula (6-A) is a bimetallic catalyst complex of Formula (6). In some embodiments, the bimetallic catalyst complex of Formula (6-B) is a bimetallic catalyst complex of Formula (6).

In some embodiments, Ar is 2,6-dimethoxyphenyl; L is a phenyl group; M is Li, Na, K, or Cs; A⁻ is [(3,5-(CF₃)₂C₆H₃)₄B]⁻; X is methyl; Y is hydrogen; Z is hydrogen; and R¹, R², and R³ are each methyl.

In some embodiments, A⁻ is a weakly coordinating anion. In some embodiments, the weakly coordinating anion is selected from the group consisting of tetrakis(3,5-trifluoromethylsulfonate, hexafluorophosphate, hexafluoroantimonate, and tetrafluoroborate. In some embodiments, tetrakis(3,5-bis(trifluoromethyl)phenylborate is represented as [(3,5-(CF₃)₂C₆H₃)₄B]⁻. In some embodiments, tetrakis(3,5-bis(trifluoromethyl)phenylborate is represented as BAr^{F}₄⁻.

In some embodiments M is Li, Na, K, or Cs. In some embodiments, M is Li. In some embodiments, M is Na. In some embodiments, M is K. In some embodiments, M is Cs.

In some embodiments, X is selected from hydrogen, an electron donating group, and an electron withdrawing group; and Y and Z are each independently selected from hydrogen, an electron donating group, and an electron withdrawing group, provided that Y and Z are not both hydrogen.

In some embodiments, the electron donating group is selected from the group consisting of: alkoxy, amino, hydroxy, and alkyl. In some embodiments, the electron donating group is selected from the group consisting of: alkoxy, phenoxy, amino, alkylamino, dialkylamino, hydroxy, alkyl, and cycloalkyl. In some embodiments, alkyl is selected from the group consisting of: —CH₃, —CH₂CH₃, —CH₂CH₂CH₃, and —CH(CH₃)₂. In some embodiments, the electron withdrawing group is selected from the group consisting of: NO₂, —CN, —C(O)-alkyl, and halo. In some embodiments, the electron withdrawing group is selected from the group consisting of: NO₂, —CN, —C(O)-alkyl, C(O)Oalkyl, C(O)Nalkyl, —SO₃H, —SO₂R, —PO₃H, —POR, —CF₃, and halo. In some embodiments, the electron withdrawing group is selected from the group consisting of: NO₂, —CN, —C(O)-alkyl, C(O)Oalkyl, C(O)Nalkyl, —SO₃H, —SO₂alkyl, —PO₃H, —PO₃alkyl, —CF₃, and halo.

In some embodiments, the phenyl group is

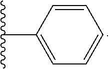 [SMILES: *c1ccccc1]

In some embodiments, L is an optionally substituted phenyl group. In some embodiments, the optionally substituted phenyl group is selected from the group consisting of phenyl, 2-methoxyphenyl, 4-methoxyphenyl, 2-acetylphenyl, or 2-(N-acetylamino)phenyl). In some embodiments, L is a phenyl group.

In some embodiments, R¹, R², and R³ are each independently selected from optionally substituted aryl, optionally substituted alkyl, and optionally substituted cycloalkyl. In some embodiments, optionally substituted aryl is selected from the group consisting of phenyl, pentafluorophenyl, 2-methoxyphenyl, 2-methylphenyl, and 4-trifluoromethylphenyl. In some embodiments, optionally substituted alkyl is selected from the group consisting of methyl, ethyl, propyl, isopropyl, or tert-butyl. In some embodiments, optionally substituted cycloalkyl is cyclohexyl or adamantyl.

In some embodiments, the at least one solvent is selected from the group consisting of toluene, benzene, xylene, hexanes, heptane, octane, decane, tetrahydrofuran, diethyl ether, dichloromethane, chloroform, N,N-dimethylformamide, dimethyl sulfoxide, ethyl acetate, acetone, and water, and any combinations thereof. In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylformamide, dimethyl sulfoxide, ethyl acetate, acetone, and water, and any combinations thereof.

In some embodiments, the first optionally substituted olefin is ethylene, propene, butene, 1-hexene, 1-heptene, 1-octene, styrene, allylbenzene, 2-hexene, 3-hexene, 2-heptene, 3-heptene, 2-octene, 3-octene, or 4-octene.

In some embodiments, the at least one other optionally substituted olefin is acrylamide, acrylic acid, acrylic ester, vinyl halide, vinyl alcohol, allyl alcohol, vinyl ether, or vinyl acetate, or any combination thereof.

In some embodiments, the polar olefin is acrylamide, acrylic acid, acrylic ester, vinyl halide, vinyl alcohol, allyl alcohol, vinyl ether, or vinyl acetate, or any combination thereof.

Additional embodiments include those listed below:

In various embodiments, the present invention provides a method for catalyzing copolymerization of a first optionally substituted olefin and at least one other optionally substituted olefin, comprising: combining or contacting a first optionally substituted olefin and at least one other optionally substituted olefin with at least one catalyst of Formula (1), Formula (2), Formula (1-A), Formula (2-A), Formula (1-B), or Formula (2-B), or any combination thereof, and at least one alkali metal salt, whereby the first optionally substituted olefin and the at least one other optionally substituted olefin undergoes copolymerization, and wherein the first optionally substituted olefin and the at least one other optionally substituted olefin are different from one another.

In various embodiments, the present invention provides a method for catalyzing copolymerization of a first optionally substituted olefin and at least one other optionally substituted olefin, comprising: combining or contacting a first optionally substituted olefin and at least one other optionally substituted olefin with at least one heterobimetallic catalyst of Formula (3), Formula (4), Formula (3-A), Formula (4-A), Formula (3-B), or Formula (4-B), or any combination thereof, whereby the first optionally substituted olefin and the at least one other optionally substituted olefin undergoes copolymerization, and wherein the first optionally substituted olefin and the at least one other optionally substituted olefin are different from one another.

In various embodiments, the present invention provides a method for catalyzing copolymerization of a first optionally substituted olefin and at least one other optionally substituted olefin, comprising: combining or contacting a first optionally substituted olefin and at least one other optionally substituted olefin with at least one bimetallic catalyst complex of Formula (5), Formula (6), Formula (5-A), Formula (6-A), Formula (5-B), or Formula (6-B), or any combination thereof, whereby the first optionally substituted olefin and the at least one other optionally substituted olefin undergoes copolymerization, and wherein the first optionally substituted olefin and the at least one other optionally substituted olefin are different from one another.

Additional embodiments include those listed below:

Embodiment 1A. A method for catalyzing copolymerization of a first optionally substituted olefin and at least one other optionally substituted olefin, comprising: contacting a first optionally substituted olefin and at least one other optionally substituted olefin with at least one catalyst and at least one alkali metal salt, whereby the first optionally substituted olefin and the at least one other optionally substituted olefin undergoes copolymerization, and wherein the first optionally substituted olefin and the at least one other optionally substituted olefin are different from one another.

Embodiment 2A. The method of embodiment 1A, wherein the at least one catalyst has a structure of Formula (1), Formula (2), Formula (1-A), Formula (2-A), Formula (1-B), or Formula (2-B).

Embodiment 3A. The method of embodiment 1A or embodiment 2A, wherein the at least one alkali metal salt has a structure of Formula (I): Mₓ⁺Aₓ⁺, wherein Mₓ⁺ is Li, Na, K, or Cs; and Aₓ⁺ is a weakly coordinating anion.

Embodiment 4A. The method of embodiment 3A, wherein the weakly coordinating anion is tetrakis(3,5-bis(trifluoromethyl)phenylborate, tetrakis(pentafluorophenyl)borate, tetraphenylborate, trifluoromethylsulfonate, hexafluorophosphate, hexafluoroantimonate, or tetrafluoroborate.

Embodiment 5A. The method of any one of embodiments 1A-4A, wherein the step of contacting the first optionally substituted olefin and the at least one other optionally substituted olefin with the at least one catalyst and the at least one alkali metal salt is performed in the presence of at least one solvent.

Embodiment 6A. The method of embodiment 5A, wherein the at least one solvent is a non-polar solvent, a polar solvent, or combination thereof.

Embodiment 7A: The method of any one of embodiments 1A-6A, further comprising contacting at least one activator with the at least one catalyst, the at least one alkali metal salt, the first optionally substituted olefin, and the at least one other optionally substituted olefin.

Embodiment 8A: The method of embodiment 7A, wherein the at least one activator is selected from the group consisting of Ni(COD)₂, triarylborane, methylaluminoxane, and trialkylaluminum.

Embodiment 9A: The method of any one of embodiments 1A-8A, wherein the first optionally substituted olefin and the at least one other optionally substituted olefin are each independently an optionally substituted terminal olefin or an optionally substituted internal olefin.

Embodiment 10A: The method of any one of embodiments 1A-8A, wherein the first optionally substituted olefin is ethylene.

Embodiment 11A: The method of any one of embodiments 1A-8A or embodiment 10A, wherein the at least one other optionally substituted olefin is methyl acrylate, ethyl acrylate, n-propyl acrylate, isopropyl acrylate, n-butyl acrylate, isobutyl acrylate, or tert-butyl acrylate, or any combination thereof.

Embodiment 12A. The method of any one of embodiments 1A-8A or embodiment 10A, wherein the at least one other optionally substituted olefin is a polar olefin.

Embodiment 13A. The method of embodiment 12A, wherein the polar olefin is a polar vinyl olefin.

Embodiment 14A. A copolymer formed by the method of any one of embodiments 1A-13A.

Embodiment 15A. The copolymer of embodiment 14A, wherein the copolymer is monomodal or bimodal.

Embodiment 16A. A method for catalyzing copolymerization of a first optionally substituted olefin and at least one other optionally substituted olefin, comprising: contacting a first optionally substituted olefin and at least one other optionally substituted olefin with at least one heterobimetallic catalyst, whereby the first optionally substituted olefin and the at least one other optionally substituted olefin undergoes copolymerization, and wherein the first optionally substituted olefin and the at least one other optionally substituted olefin are different from one another.

Embodiment 17A. The method of embodiment 16A, wherein the at least one heterobimetallic catalyst has a structure of Formula (3), Formula (4), Formula (3-A), Formula (4-A), Formula (3-B), or Formula (4-B).

Embodiment 18A. The method of embodiment 16A or embodiment 17A, wherein the step of contacting the first optionally substituted olefin and the at least one other optionally substituted olefin with the bimetallic catalyst complex is performed in the presence of at least one solvent.

Embodiment 19A. The method of embodiment 18A, wherein the at least one solvent is a non-polar solvent, a polar solvent, or combination thereof.

Embodiment 20A. The method of any one of embodiments 16A-19A, further comprising contacting at least one activator with the at least one heterobimetallic catalyst, the first optionally substituted olefin, and the at least one other optionally substituted olefin.

Embodiment 21A. The method of embodiment 20A, wherein the at least one activator is selected from the group consisting of Ni(COD)₂, triarylborane, methylaluminoxane, and trialkylaluminum.

Embodiment 22A. The method of any one of embodiments 16A-21A, wherein the first optionally substituted olefin and the at least one other optionally substituted olefin are each independently an optionally substituted terminal olefin or an optionally substituted internal olefin.

Embodiment 23A. The method of any one of embodiments 16A-21A, wherein the first optionally substituted olefin is ethylene.

Embodiment 24A. The method of any one of embodiments 16A-21A or embodiment 23A, wherein the at least one other optionally substituted olefin is methyl acrylate, ethyl acrylate, n-propyl acrylate, isopropyl acrylate, n-butyl acrylate, isobutyl acrylate, or tert-butyl acrylate, or any combination thereof.

Embodiment 25A. The method of any one of embodiments 16A-21A or embodiment 23A, wherein the at least one other optionally substituted olefin is a polar olefin.

Embodiment 26A. The method of embodiment 25A, wherein the polar olefin is a polar vinyl olefin.

Embodiment 27A. A copolymer formed by the method of any one of embodiments 16A-26A.

Embodiment 28A. The copolymer of embodiment 27A, wherein the copolymer is monomodal or bimodal.

Embodiment 29A. A method for catalyzing copolymerization of a first optionally substituted olefin and at least one other optionally substituted olefin, comprising: contacting a first optionally substituted olefin and at least one other optionally substituted olefin with at least one bimetallic catalyst complex, whereby the first optionally substituted olefin and the at least one other optionally substituted olefin undergoes copolymerization, and wherein the first optionally substituted olefin and the at least one other optionally substituted olefin are different from one another.

Embodiment 30A. The method of embodiment 29A, wherein the at least one bimetallic catalyst complex has a structure of Formula (5), Formula (6), Formula (5-A), Formula (6-A), Formula (5-B), or Formula (6-B).

Embodiment 31A. The method of embodiment 29A or embodiment 30A, wherein the step of contacting the first optionally substituted olefin and the at least one other optionally substituted olefin with the bimetallic catalyst complex is performed in the presence of at least one solvent.

Embodiment 32A. The method of embodiment 31A, wherein the at least one solvent is a non-polar solvent, a polar solvent, or combination thereof.

Embodiment 33A. The method of any one of embodiments 29A-32A, further comprising contacting at least one activator with the bimetallic catalyst complex, the first optionally substituted olefin, and the at least one other optionally substituted olefin.

Embodiment 34A. The method of embodiment 33A, wherein the at least one activator is selected from the group consisting of Ni(COD)₂, triarylborane, methylaluminoxane, and trialkylaluminum.

Embodiment 35A. The method of any one of embodiments 29A-34A, wherein the first optionally substituted olefin and the at least one other optionally substituted olefin are each independently an optionally substituted terminal olefin or an optionally substituted internal olefin.

Embodiment 36A. The method of any one of embodiments 29A-34A, wherein the first optionally substituted olefin is ethylene.

Embodiment 37A. The method of any one of embodiments 29A-34A or embodiment 36A, wherein the at least one other optionally substituted olefin is methyl acrylate, ethyl acrylate, n-propyl acrylate, isopropyl acrylate, n-butyl acrylate, isobutyl acrylate, or tert-butyl acrylate, or any combination thereof.

Embodiment 38A. The method of any one of embodiments 29A-34A or embodiment 36A, wherein the at least one other optionally substituted olefin is a polar olefin.

Embodiment 39A. The method of embodiment 38A, wherein the polar olefin is a polar vinyl olefin.

Embodiment 40A. A copolymer formed by the method of any one of embodiments 29A-39A.

Embodiment 41A. The copolymer of embodiment 40A, wherein the copolymer is monomodal or bimodal.

Embodiment 42A. The method of any one of embodiments 1A-8A or embodiment 10A, wherein the at least one other optionally substituted olefin is an alkyl acrylate.

Embodiment 43A. The method of any one of embodiments 16A-21A or embodiment 23A, wherein the at least one other optionally substituted olefin is an alkyl acrylate.

Embodiment 44A. The method of any one of embodiments 29A-34A or embodiment 36A, wherein the at least one other optionally substituted olefin is an alkyl acrylate.

Embodiment 45A. The method of any one of embodiments 1A-13A, wherein an amount of the at least one alkali metal salt is greater than zero equivalents relative to the at least one catalyst.

Additional embodiments include those listed below.

Nonlimiting examples of electron-donating groups include OR^{c}, NR^{c}R^{d}, alkyl groups, wherein Re and R^{d} are each independently H, optionally substituted alkyl, optionally substituted heteroalkyl, optionally substituted aryl, optionally substituted heteroaryl, optionally substituted cyclyl, or optionally substituted heterocyclyl.

Non-limiting examples of electron-withdrawing groups include NO₂, F, Cl, Br, I, CF₃, CN, CO₂R^{a}, C(═O)NR^{a}R^{b}, C(═O)R^{a}, SO₂R^{a}, SO₂OR^{a}, SO₂NR^{a}R^{b}, PO₃R^{a}R^{b}, or NO, wherein R^{a} and R^{b} are each independently H, optionally substituted alkyl, optionally substituted heteroalkyl, optionally substituted aryl, optionally substituted heteroaryl, optionally substituted cyclyl, or optionally substituted heterocyclyl.

Additional embodiments include those listed below.

In some embodiments, the term “halogen” or “halo” refers to an atom selected from fluorine (F), chlorine (Cl), bromine (Br) and iodine (I). The term “halogen radioisotope” or “halo radioisotope” refers to a radionuclide of an atom selected from fluorine (F), chlorine (Cl), bromine (Br) and iodine (I).

In some embodiments, “iodo” refers to the iodine atom (I) when it is used in the context of a halo functional group or halogen functional group or as a halo substituent or halogen substituent.

In some embodiments, “bromo” refers to the bromine atom (Br) when it is used in the context of a halo functional group or halogen functional group or as a halo substituent or halogen substituent.

In some embodiments, “chloro” refers to the chlorine atom (Cl) when it is used in the context of a halo functional group or halogen functional group or as a halo substituent or halogen substituent.

In some embodiments, “fluoro” refers to the fluorine atom (F) when it is used in the context of a halo functional group or halogen functional group or as a halo substituent or halogen substituent.

Substituents may be protected as necessary and any of the protecting groups commonly used in the art may be employed. Non-limiting examples of protecting groups may be found, for example, in Greene et al., Protective Groups in Organic Synthesis, 3rd Ed. (New York: Wiley, 1999).

In some embodiments, Ar is 2,6-dimethoxyphenyl, 2-methoxyphenyl, or phenyl. In some embodiments, Ar is 2,6-dimethoxyphenyl or 2-methoxyphenyl. In some embodiments Ar is 2,6-dimethoxyphenyl or phenyl. In some embodiments, Ar is 2-methoxyphenyl or phenyl. In some embodiments, Ar is 2,6-dimethoxyphenyl. In some embodiments, Ar is 2-methoxyphenyl. In some embodiments, Ar is phenyl.

### Catalysts of Formula (19), Formula (20), Formula (19-A), Formula (20-A), Formula (19-B), Formula (20-B).

In various embodiments, the present invention provides a catalyst having a structure selected from Formula (19) and Formula (20):

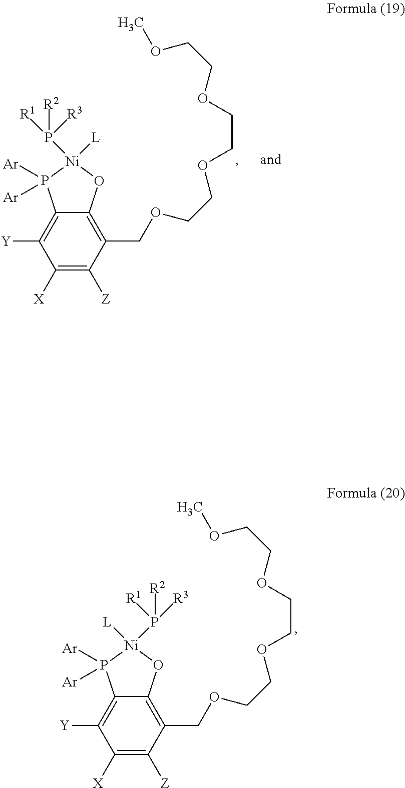

wherein in Formula (19) and Formula (20):
Ar is 2,6-dimethoxyphenyl, 2-methoxyphenyl, or phenyl;
L is an optionally substituted phenyl group;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl.

In various embodiments, the present invention provides a catalyst having a structure of Formula (19):

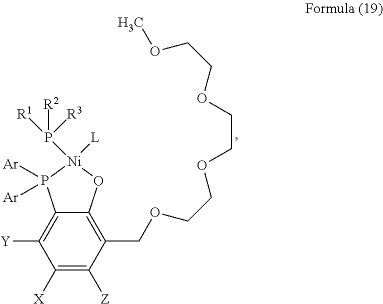

wherein,
Ar is 2,6-dimethoxyphenyl, 2-methoxyphenyl, or phenyl;
L is an optionally substituted phenyl group;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl.

In various embodiments, the present invention provides a catalyst having a structure of Formula (20):

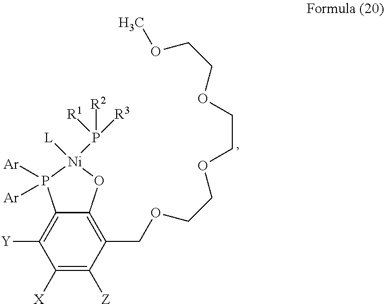

wherein,
Ar is 2,6-dimethoxyphenyl, 2-methoxyphenyl, or phenyl;
L is an optionally substituted phenyl group;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl.

In various embodiments, the present invention provides a catalyst having a structure selected from Formula (19-A) and Formula (20-A):

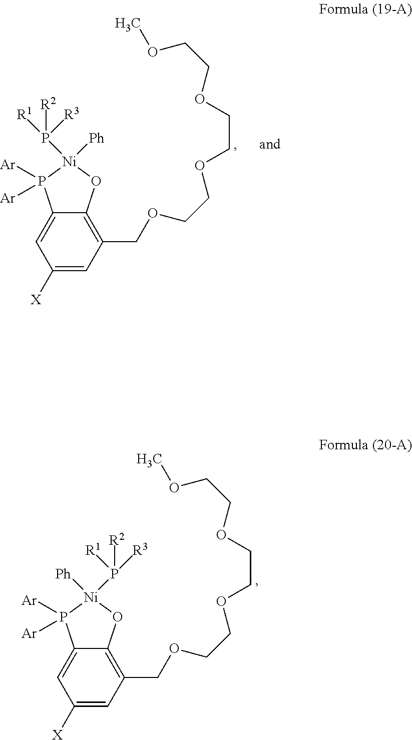

wherein in Formula (19-A) and Formula (20-A):
Ar is 2,6-dimethoxyphenyl, 2-methoxyphenyl, or phenyl;
Ph is a phenyl group;
X is hydrogen, an electron donating group, or an electron withdrawing group; and
R¹, R², and R³ are each independently selected from optionally substituted aryl, optionally substituted alkyl, and optionally substituted cycloalkyl.

In various embodiments, the present invention provides a catalyst having a structure of Formula (19-A):

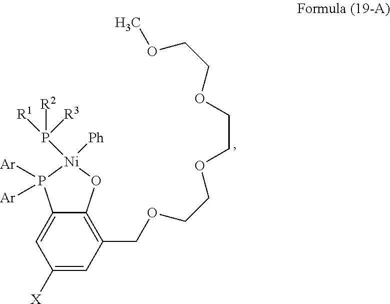

wherein,
Ar is 2,6-dimethoxyphenyl, 2-methoxyphenyl, or phenyl;
Ph is a phenyl group;
X is hydrogen, an electron donating group, or an electron withdrawing group; and
R¹, R², and R³ are each independently selected from optionally substituted aryl, optionally substituted alkyl, and optionally substituted cycloalkyl.

In various embodiments, the present invention provides a catalyst having a structure of Formula (20-A):

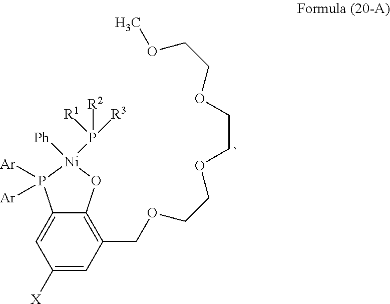

wherein,
Ar is 2,6-dimethoxyphenyl, 2-methoxyphenyl, or phenyl;
L is an optionally substituted phenyl group;
X is hydrogen, an electron donating group, or an electron withdrawing group; and
R¹, R², and R³ are each independently selected from optionally substituted aryl, optionally substituted alkyl, and optionally substituted cycloalkyl.

In various embodiments, the present invention provides a catalyst having a structure selected from Formula (19-B) and Formula (20-B):

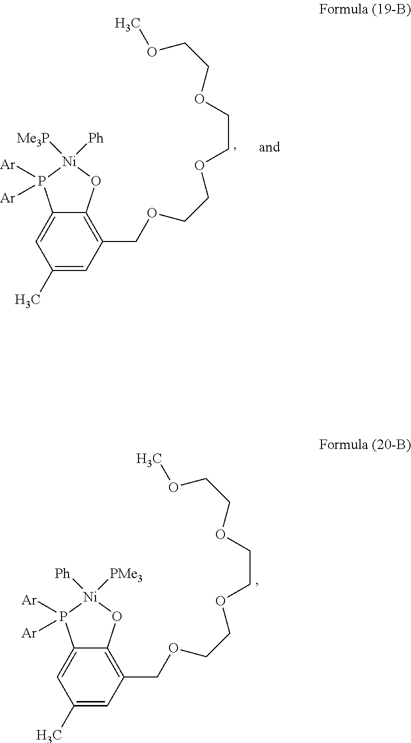

wherein in Formula (19-B) and Formula (20-B):
Ar is 2,6-dimethoxyphenyl, 2-methoxyphenyl, or phenyl;
Ph is a phenyl group; and
PMe₃ is trimethylphosphine.

In various embodiments, the present invention provides a catalyst having a structure of Formula (19-B):

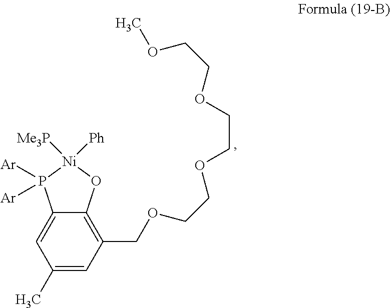

wherein,
Ar is 2,6-dimethoxyphenyl, 2-methoxyphenyl, or phenyl;
Ph is a phenyl group; and
PMe₃ is trimethylphosphine.

In various embodiments, the present invention provides a catalyst having a structure of Formula (20-B):

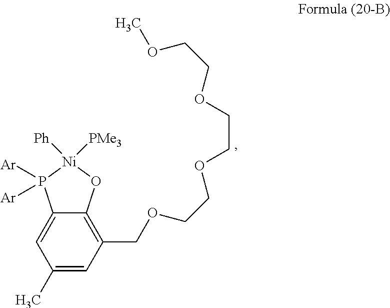

wherein,
Ar is 2,6-dimethoxyphenyl, 2-methoxyphenyl, or phenyl;
Ph is a phenyl group; and
PMe; is trimethylphosphine.

In some embodiments, the catalyst of Formula (19-A) is a catalyst of Formula (19). In some embodiments, the catalyst of Formula (19-B) is a catalyst of Formula (19). In some embodiments, the catalyst of Formula (20-A) is a catalyst of Formula (20). In some embodiments, the catalyst of Formula (20-B) is a catalyst of Formula (20).

In some embodiments, X is selected from hydrogen, an electron donating group, and an electron withdrawing group; and Y and Z are each independently selected from hydrogen, an electron donating group, and an electron withdrawing group, provided that Y and Z are not both hydrogen.

In some embodiments, the electron donating group is selected from the group consisting of: alkoxy, amino, hydroxy, and alkyl, and cycloalkyl. In some embodiments, the electron donating group is selected from the group consisting of: alkoxy, phenoxy, amino, alkylamino, dialkylamino, hydroxy, alkyl, and cycloalkyl. In some embodiments, alkyl is selected from the group consisting of: —CH₃, —CH₂CH₃, —CH₂CH₂CH₃, and —CH(CH₃)₂. In some embodiments, the electron withdrawing group is selected from the group consisting of: —NO₂, —CN, —C(O)-alkyl, and -halo. In some embodiments, the electron withdrawing group is selected from the group consisting of: —NO₂, —CN, —C(O)-alkyl, —C(O)Oalkyl, —C(O)Nalkyl, —SO₃H, —SO₂R, —PO₃H, —PO₃R, —CF₃, and -halo. In some embodiments, the electron withdrawing group is selected from the group consisting of: —NO₂, —CN, —C(O)-alkyl, —C(O)Oalkyl, —C(O)Nalkyl, —SO₃H, —SO₂alkyl, —PO₃H, —PO₃alkyl, —CF₃, and -halo.

In some embodiments, the phenyl group is

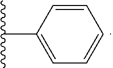 [SMILES: *c1ccccc1]

In some embodiments, L is an optionally substituted phenyl group. In some embodiments, the optionally substituted phenyl group is selected from the group consisting of phenyl, 2-methoxyphenyl, 4-methoxyphenyl, 2-acetylphenyl, or 2-(N-acetylamino)phenyl). In some embodiments, L is a phenyl group.

In some embodiments, R¹, R², and R³ are each independently selected from optionally substituted aryl, optionally substituted alkyl, and optionally substituted cycloalkyl. In some embodiments, optionally substituted aryl is selected from the group consisting of phenyl, pentafluorophenyl, 2-methoxyphenyl, 2-methylphenyl, and 4-trifluoromethylphenyl. In some embodiments, optionally substituted alkyl is selected from the group consisting of methyl, ethyl, propyl, isopropyl, or tert-butyl. In some embodiments, optionally substituted cycloalkyl is cyclohexyl or adamantyl.

In some embodiments, Ar is 2,6-dimethoxyphenyl, 2-methoxyphenyl, or phenyl. In some embodiments, Ar is 2,6-dimethoxyphenyl or 2-methoxyphenyl. In some embodiments Ar is 2,6-dimethoxyphenyl or phenyl. In some embodiments, Ar is 2-methoxyphenyl or phenyl. In some embodiments, Ar is 2,6-dimethoxyphenyl. In some embodiments, Ar is 2-methoxyphenyl. In some embodiments, Ar is phenyl.

### Heterobimetallic Catalysts of Formula (21), Formula (22), Formula (21-A), Formula (22-A), Formula (21-B), or Formula (22-B).

In various embodiments, the present invention provides a heterobimetallic catalyst having a structure selected from Formula (21) and Formula (22):

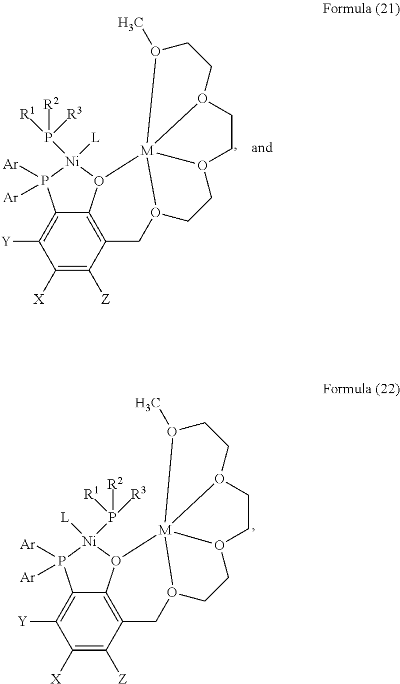

wherein in Formula (21) and Formula (22):
Ar is 2,6-dimethoxyphenyl, 2-methoxyphenyl, or phenyl;
L is an optionally substituted phenyl group;
M is Li, Na, K, or Cs;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl.

In various embodiments, the present invention provides a heterobimetallic catalyst having a structure of Formula (21):

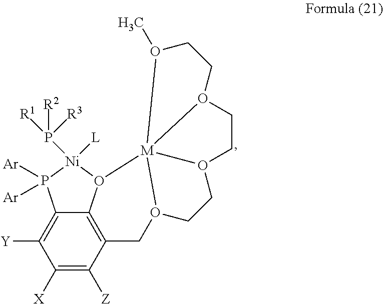

wherein,
Ar is 2,6-dimethoxyphenyl, 2-methoxyphenyl, or phenyl;
L is an optionally substituted phenyl group;
M is Li, Na, K, or Cs;
X, Y, and Z are each independently selected from hydrogen, an electron donating group, and an electron withdrawing group, and
R¹, R², and R³ are each independently selected from optionally substituted aryl, optionally substituted alkyl, and optionally substituted cycloalkyl.

In various embodiments, the present invention provides a heterobimetallic catalyst having a structure of Formula (22):

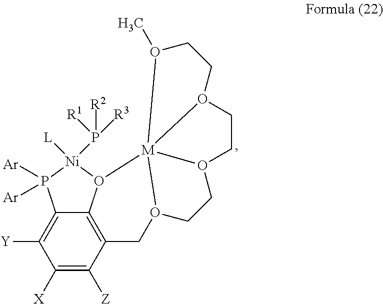

wherein,
Ar is 2,6-dimethoxyphenyl, 2-methoxyphenyl, or phenyl;
L is an optionally substituted phenyl group;
M is Li, Na, K, or Cs;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl.

In various embodiments, the present invention provides a heterobimetallic catalyst having a structure selected from Formula (21-A) and Formula (22-A):

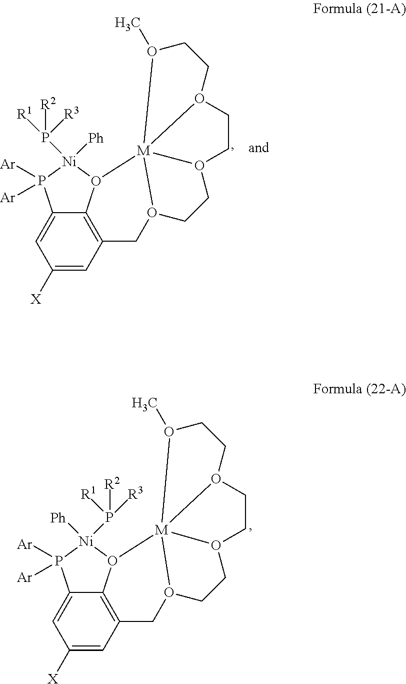

wherein in Formula (21-A) and Formula (22-A):
Ar is 2,6-dimethoxyphenyl, 2-methoxyphenyl, or phenyl;
Ph is a phenyl group;
M is Li, Na, K, or Cs;
X is hydrogen, an electron donating group, or an electron withdrawing group; and
R¹, R², and R³ are each independently selected from optionally substituted aryl, optionally substituted alkyl, and optionally substituted cycloalkyl.

In various embodiments, the present invention provides a heterobimetallic catalyst having a structure of Formula (21-A):

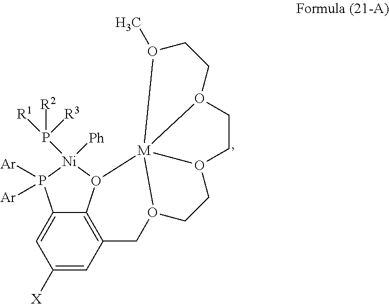

wherein,
Ar is 2,6-dimethoxyphenyl, 2-methoxyphenyl, or phenyl;
Ph is a phenyl group;
M is Li, Na, K, or Cs; X is hydrogen, an electron donating group, or an electron withdrawing group; and
R¹, R², and R³ are each independently selected from optionally substituted aryl, optionally substituted alkyl, and optionally substituted cycloalkyl.

In various embodiments, the present invention provides a heterobimetallic catalyst having a structure of Formula (22-A):

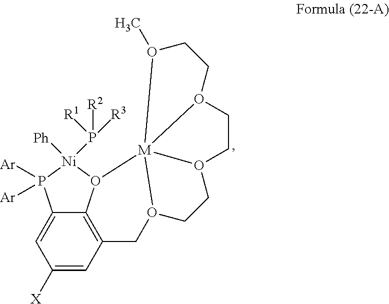

wherein,
Ar is 2,6-dimethoxyphenyl, 2-methoxyphenyl, or phenyl;
Ph is a phenyl group;
M is Li, Na, K, or Cs;
X is hydrogen, an electron donating group, or an electron withdrawing group; and
R¹, R², and R³ are each independently selected from optionally substituted aryl, optionally substituted alkyl, and optionally substituted cycloalkyl.

In various embodiments, the present invention provides a heterobimetallic catalyst having a structure selected from Formula (21-B) and Formula (22-B):

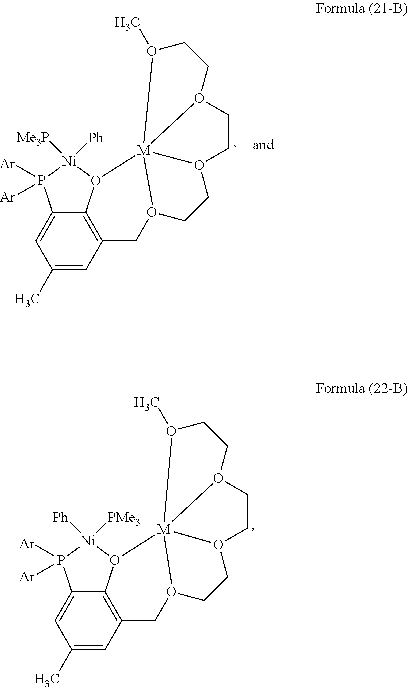

wherein in Formula (21-B) and Formula (22-B):
Ar is 2,6-dimethoxyphenyl, 2-methoxyphenyl, or phenyl;
Ph is a phenyl group;
M is Li, Na, K, or Cs; and
PMe₃ is trimethylphosphine.

In various embodiments, the present invention provides a heterobimetallic catalyst having a structure of Formula (21-B):

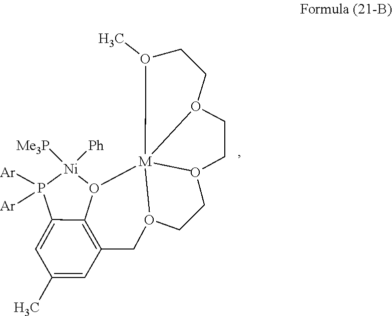

wherein,
Ar is 2,6-dimethoxyphenyl, 2-methoxyphenyl, or phenyl;
Ph is a phenyl group;
M is Li, Na, K, or Cs; and
PMe₃ is trimethylphosphine.

In various embodiments, the present invention provides a heterobimetallic catalyst having a structure of Formula (22-B):

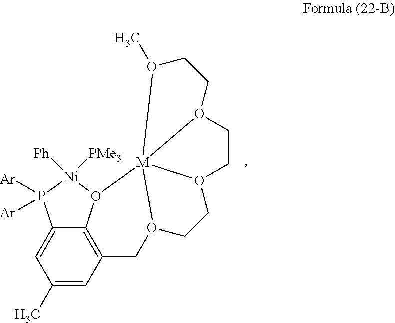

wherein,
Ar is 2,6-dimethoxyphenyl, 2-methoxyphenyl, or phenyl;
Ph is a phenyl group;
M is Li, Na, K, or Cs; and
PMe₃ is trimethylphosphine.

In some embodiments, the heterobimetallic catalyst of Formula (21-A) is a heterobimetallic catalyst of Formula (21). In some embodiments, the heterobimetallic catalyst of Formula (21-B) is a heterobimetallic catalyst of Formula (21). In some embodiments, the heterobimetallic catalyst of Formula (22-A) is a heterobimetallic catalyst of Formula (22). In some embodiments, the heterobimetallic catalyst of Formula (22-B) is a heterobimetallic catalyst of Formula (22).

In some embodiments M is Li, Na, K, or Cs. In some embodiments, M is Li. In some embodiments, M is Na. In some embodiments, M is K. In some embodiments, M is Cs.

In some embodiments, X is selected from hydrogen, an electron donating group, and an electron withdrawing group; and Y and Z are each independently selected from hydrogen, an electron donating group, and an electron withdrawing group, provided that Y and Z are not both hydrogen.

In some embodiments, the electron donating group is selected from the group consisting of: alkoxy, amino, hydroxy, and alkyl. In some embodiments, the electron donating group is selected from the group consisting of: alkoxy, phenoxy, amino, alkylamino, dialkylamino, hydroxy, alkyl, and cycloalkyl. In some embodiments, alkyl is selected from the group consisting of: —CH₃, —CH₂CH₃, —CH₂CH₂CH₃, and —CH(CH₃)₂. In some embodiments, the electron withdrawing group is selected from the group consisting of: NO₂, —CN, —C(O)-alkyl, and halo. In some embodiments, the electron withdrawing group is selected from the group consisting of: NO₂, —CN, —C(O)-alkyl, C(O)Oalkyl, C(O)Nalkyl, —SO₃H, —SO₂R, —PO₃H, —PO₃R, —CF₃, and halo. In some embodiments, the electron withdrawing group is selected from the group consisting of: NO₂, —CN, —C(O)-alkyl, C(O)Oalkyl, C(O)Nalkyl, —SO₃H, —SO₂alkyl, —PO₃H, —PO₃alkyl, —CF₃, and halo.

In some embodiments, the phenyl group is

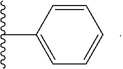 [SMILES: *c1ccccc1]

In some embodiments, L is an optionally substituted phenyl group. In some embodiments, the optionally substituted phenyl group is selected from the group consisting of phenyl, 2-methoxyphenyl, 4-methoxyphenyl, 2-acetylphenyl, or 2-(N-acetylamino)phenyl). In some embodiments, L is a phenyl group.

In some embodiments, R¹, R², and R³ are each independently selected from optionally substituted aryl, optionally substituted alkyl, and optionally substituted cycloalkyl. In some embodiments, optionally substituted aryl is selected from the group consisting of phenyl, pentafluorophenyl, 2-methoxyphenyl, 2-methylphenyl, and 4-trifluoromethylphenyl. In some embodiments, optionally substituted alkyl is selected from the group consisting of methyl, ethyl, propyl, isopropyl, or tert-butyl. In some embodiments, optionally substituted cycloalkyl is cyclohexyl or adamantyl.

In some embodiments, Ar is 2,6-dimethoxyphenyl, 2-methoxyphenyl, or phenyl. In some embodiments, Ar is 2,6-dimethoxyphenyl or 2-methoxyphenyl. In some embodiments Ar is 2,6-dimethoxyphenyl or phenyl. In some embodiments, Ar is 2-methoxyphenyl or phenyl. In some embodiments, Ar is 2,6-dimethoxyphenyl. In some embodiments, Ar is 2-methoxyphenyl. In some embodiments, Ar is phenyl.

### Bimetallic Catalyst Complexes of Formula (23), Formula (24), Formula (23-A), Formula (24-A), Formula (23-B), or Formula (24-B).

In various embodiments, the present invention provides a bimetallic catalyst complex having a structure selected from Formula (23) and Formula (24):

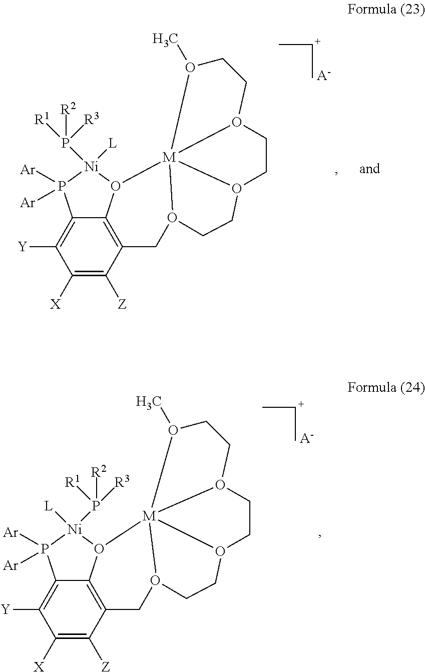

wherein in Formula (23) and Formula (24):
Ar is 2,6-dimethoxyphenyl, 2-methoxyphenyl, or phenyl;
L is an optionally substituted phenyl group;
M is Li, Na, K, or Cs;
A⁻ is a weakly coordinating anion;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl.

In various embodiments, the present invention provides a bimetallic catalyst complex having a structure of Formula (23):

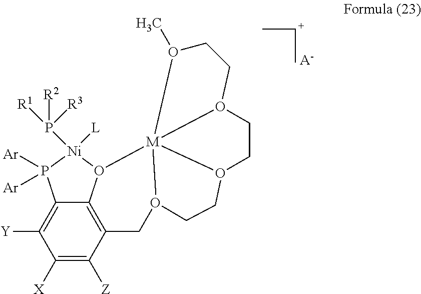

wherein,
Ar is 2,6-dimethoxyphenyl, 2-methoxyphenyl, or phenyl;
L is an optionally substituted phenyl group;
M is Li, Na, K, or Cs;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl.

In various embodiments, the present invention provides a bimetallic catalyst complex having a structure of Formula (24):

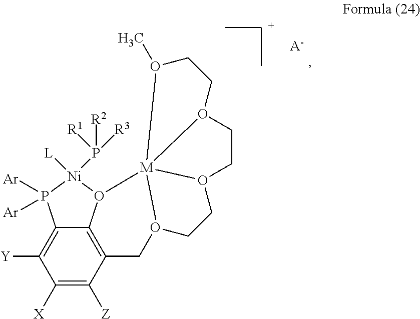

wherein,
Ar is 2,6-dimethoxyphenyl, 2-methoxyphenyl, or phenyl;
L is an optionally substituted phenyl group;
M is Li, Na, K, or Cs;
A⁻ is a weakly coordinating anion;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl.

In various embodiments, the present invention provides a bimetallic catalyst complex having a structure selected from Formula (23-A) and Formula (24-A):

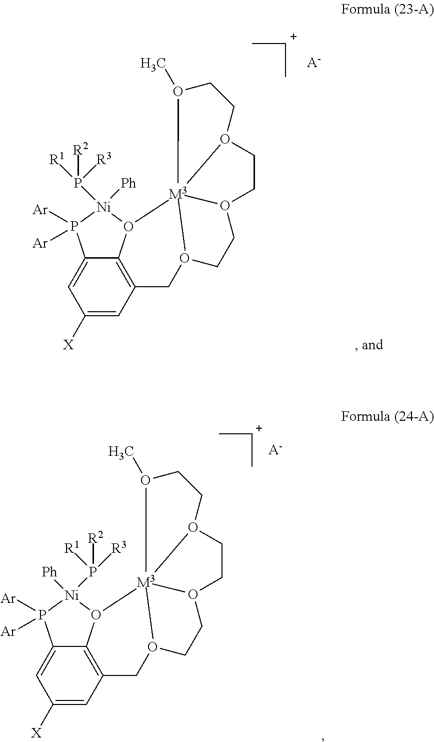

wherein Formula (23-A) and Formula (24-A):
Ar is 2,6-dimethoxyphenyl, 2-methoxyphenyl, or phenyl;
Ph is a phenyl group;
M is Li, Na, K, or Cs;
A⁻ is a weakly coordinating anion;
X is hydrogen, an electron donating group, or an electron withdrawing group; and
R¹, R², and R³ are each independently selected from optionally substituted aryl, optionally substituted alkyl, and optionally substituted cycloalkyl.

In various embodiments, the present invention provides a bimetallic catalyst complex having a structure of Formula (23-A):

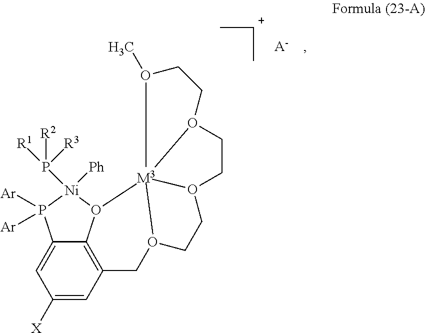

wherein,
Ar is 2,6-dimethoxyphenyl, 2-methoxyphenyl, or phenyl;
Ph is a phenyl group;
M is Li, Na, K, or Cs;
A⁻ is a weakly coordinating anion;
X is hydrogen, an electron donating group, or an electron withdrawing group; and
R¹, R², and R³ are each independently selected from optionally substituted aryl, optionally substituted alkyl, and optionally substituted cycloalkyl.

In various embodiments, the present invention provides a bimetallic catalyst complex having a structure of Formula (24-A):

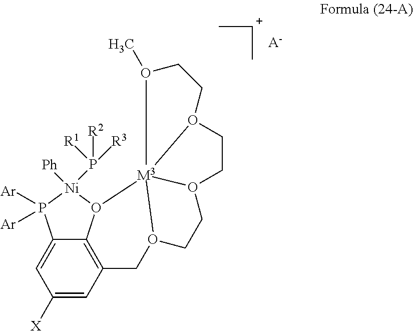

wherein,
   Ar is 2,6-dimethoxyphenyl, 2-methoxyphenyl, or phenyl;
   Ph is a phenyl group,
   M is Li, Na, K, or Cs;
   A⁻ is a weakly coordinating anion;
   X is hydrogen, an electron donating group, or an electron withdrawing group; and
   R¹, R², and R³ are each independently selected from optionally substituted aryl, optionally substituted alkyl, and optionally substituted cycloalkyl.

In various embodiments, the present invention provides a bimetallic catalyst complex having a structure selected from Formula (23-B) and Formula (24-B):

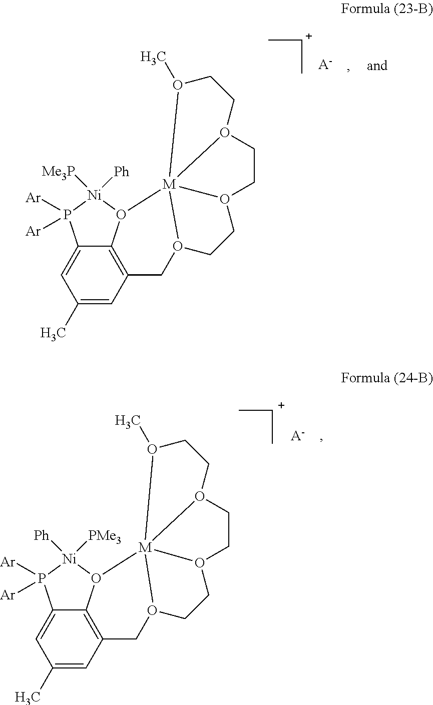

wherein Formula (23-B) and Formula (24-B);
   Ar is 2,6-dimethoxyphenyl, 2-methoxyphenyl, or phenyl;
   Ph is a phenyl group;
   M is Li, Na, K, or Cs;
   A⁻ is [(3,5-(CF₃)₂C₆H₃)₄B]⁻; and
   PMe₃ is trimethylphosphine.

In various embodiments, the present invention provides a bimetallic catalyst complex having a structure of Formula (23-B) is:

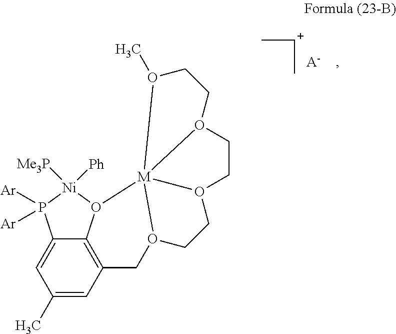

wherein,
   Ar is 2,6-dimethoxyphenyl, 2-methoxyphenyl, or phenyl;
   Ph is a phenyl group;
   M is Li, Na, K, or Cs;
   A⁻ is [(3,5-(CF₃)₂C₆H₃)₄B]⁻; and
   PMe₃ is trimethylphosphine.

In various embodiments, the present invention provides a bimetallic catalyst complex having a structure of Formula (24-B):

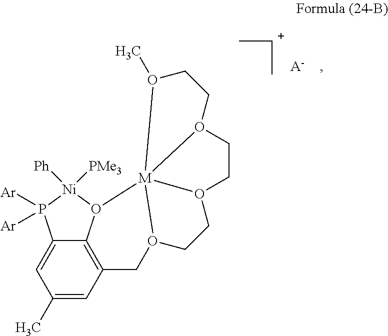

wherein,
   Ar is 2,6-dimethoxyphenyl, 2-methoxyphenyl, or phenyl;
   Ph is a phenyl group;
   M is Li, Na, K, or Cs;
   A⁻ is [(3,5-(CF₃)₂C₆H₃)₄B]⁻; and
   PMe₃ is trimethylphosphine.

In some embodiments, the bimetallic catalyst complex of Formula (23-A) is a bimetallic catalyst complex of Formula (23). In some embodiments, the bimetallic catalyst complex of Formula (23-B) is a bimetallic catalyst complex of Formula (23). In some embodiments, the bimetallic catalyst complex of Formula (24A) is a bimetallic catalyst complex of Formula (24). In some embodiments, the bimetallic catalyst complex of Formula (24-B) is a bimetallic catalyst complex of Formula (24).

In some embodiments, Ar is 2,6-dimethoxyphenyl; L is a phenyl group; M is Li, Na, K, or Cs; A⁻ is [(3,5-(CF₃)₂C₆H₃)₄B]⁻; X is methyl; Y is hydrogen; Z is hydrogen; and R¹, R², and R³ are each methyl.

In some embodiments, A⁻ is a weakly coordinating anion. In some embodiments, the weakly coordinating anion is selected from the group consisting of tetrakis(3,5-trifluoromethylsulfonate, hexafluorophosphate, hexafluoroantimonate, and tetrafluoroborate. In some embodiments, tetrakis(3,5-bis(trifluoromethyl)phenylborate is represented as [(3,5-(CF₃)₂C₆H₃)₄B]⁻. In some embodiments, tetrakis(3,5-bis(trifluoromethyl)phenylborate is represented as BAr^{F}₄⁻.

In some embodiments M is Li, Na, K, or Cs. In some embodiments, M is Li. In some embodiments, M is Na. In some embodiments, M is K. In some embodiments, M is Cs.

In some embodiments, X is selected from hydrogen, an electron donating group, and an electron withdrawing group; and Y and Z are each independently selected from hydrogen, an electron donating group, and an electron withdrawing group, provided that Y and Z are not both hydrogen.

In some embodiments, the electron donating group is selected from the group consisting of: alkoxy, amino, hydroxy, and alkyl. In some embodiments, the electron donating group is selected from the group consisting of: alkoxy, phenoxy, amino, alkylamino, dialkylamino, hydroxy, alkyl, and cycloalkyl. In some embodiments, alkyl is selected from the group consisting of: —CH₃, —CH₂CH₃, —CH₂CH₂CH₃, and —CH(CH₃)₂. In some embodiments, the electron withdrawing group is selected from the group consisting of: NO₂, —CN, —C(O)-alkyl, and halo. In some embodiments, the electron withdrawing group is selected from the group consisting of: NO₂, —CN, —C(O)-alkyl, C(O)Oalkyl, C(O)Nalkyl, —SO₃H, —SO₂R, —PO₃H, —PO₃R, —CF₃, and halo. In some embodiments, the electron withdrawing group is selected from the group consisting of: NO₂, —CN, —C(O)-alkyl, C(O)Oalkyl, C(O)Nalkyl, —SO₃H, —SO₂alkyl, —PO₃H, —PO₃alkyl, —CF₃, and halo.

In some embodiments, the phenyl group is

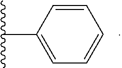 [SMILES: *c1ccccc1]

In some embodiments, L is an optionally substituted phenyl group. In some embodiments, the optionally substituted phenyl group is selected from the group consisting of phenyl, 2-methoxyphenyl, 4-methoxyphenyl, 2-acetylphenyl, or 2-(N-acetylamino)phenyl). In some embodiments, L is a phenyl group.

In some embodiments, R¹, R², and R³ are each independently selected from optionally substituted aryl, optionally substituted alkyl, and optionally substituted cycloalkyl. In some embodiments, optionally substituted aryl is selected from the group consisting of phenyl, pentafluorophenyl, 2-methoxyphenyl, 2-methylphenyl, and 4-trifluoromethylphenyl. In some embodiments, optionally substituted alkyl is selected from the group consisting of methyl, ethyl, propyl, isopropyl, or tert-butyl. In some embodiments, optionally substituted cycloalkyl is cyclohexyl or adamantyl.

In some embodiments, the at least one solvent is selected from the group consisting of toluene, benzene, xylene, hexanes, heptane, octane, decane, tetrahydrofuran, diethyl ether, dichloromethane, chloroform, N,N-dimethylformamide, dimethyl sulfoxide, ethyl acetate, acetone, and water, and any combinations thereof. In some embodiments, the at least one solvent is a non-polar solvent, a polar solvent, or combination thereof. In some embodiments, the at least one solvent is at least one non-polar solvent, at least one polar solvent, or combination thereof. In some embodiments, the non-polar solvent is selected from the group consisting of toluene, benzene, xylene, hexanes, heptane, octane, and decane, and any combinations thereof. In some embodiments, the polar solvent is selected from the group consisting of tetrahydrofuran, diethyl ether, dichloromethane, chloroform, N,N-dimethylformamide, dimethyl sulfoxide, ethyl acetate, acetone, and water, and any combinations thereof.

In some embodiments, the first optionally substituted olefin is ethylene, propene, butene, 1-hexene, 1-heptene, 1-octene, styrene, allylbenzene, 2-hexene, 3-hexene, 2-heptene, 3-heptene, 2-octene, 3-octene, or 4-octene.

In some embodiments, the at least one other optionally substituted olefin is acrylamide, acrylic acid, acrylic ester, vinyl halide, vinyl alcohol, allyl alcohol, vinyl ether, or vinyl acetate, or any combination thereof.

In some embodiments, the polar olefin is acrylamide, acrylic acid, acrylic ester, vinyl halide, vinyl alcohol, allyl alcohol, vinyl ether, or vinyl acetate, or any combination thereof.

In some embodiments, Ar is 2,6-dimethoxyphenyl or 2-methoxyphenyl. In some embodiments Ar is 2,6-dimethoxyphenyl or phenyl. In some embodiments, Ar is 2-methoxyphenyl or phenyl. In some embodiments, Ar is 2,6-dimethoxyphenyl. In some embodiments, Ar is 2-methoxyphenyl. In some embodiments, Ar is phenyl.

In various embodiments, the present invention provides ethylene and alkyl acrylate copolymers made-to-order using dynamic cation switching polymerization and evidence for improved polymer degradability with low polar group density.

The industrial synthesis of functional polyolefins relies on free radical polymerization, which requires high temperature and pressure and offers poor microstructure control. Herein, we report a cation-switching strategy to access ethylene and alkyl acrylate copolymers with made-to-order molecular weight, molecular weight distribution, and polar monomer density. This precision was achieved by exploiting the cation exchange dynamics between M⁺ and M′ (where M⁺, M′+=Li⁺, Na⁺, K⁺, or Cs⁺, and M≠M′) with our nickel phenoxyphosphine-polyethylene glycol catalyst. Under non-switching conditions, copolymerization of ethylene and methyl acrylate (MA) using our nickel catalyst in the presence of M′ and M′⁺ salts afforded ethylene-MA copolymers (EMA) with adjustable molecular weight distributions based on the ratio of M⁺:M′⁺ employed. Under dynamic cation switching conditions, this catalyst system yielded monodispersed EMA with molecular weight and MA incorporation that can be varied independently, which is not possible to accomplish using conventional polymerization methods. Studies of the EMA revealed that while they retain the thermal and mechanical properties of polyethylene having the same molecular weight, increasing the MA per chain by every 1-3 units leads to measurable increase in their wettability and susceptibility toward oxidative cleavage. This work offers practical routes to difficult-to-obtain functional polyolefins and suggests that ethylene-based materials can be made with improved degradability without compromising their performance.

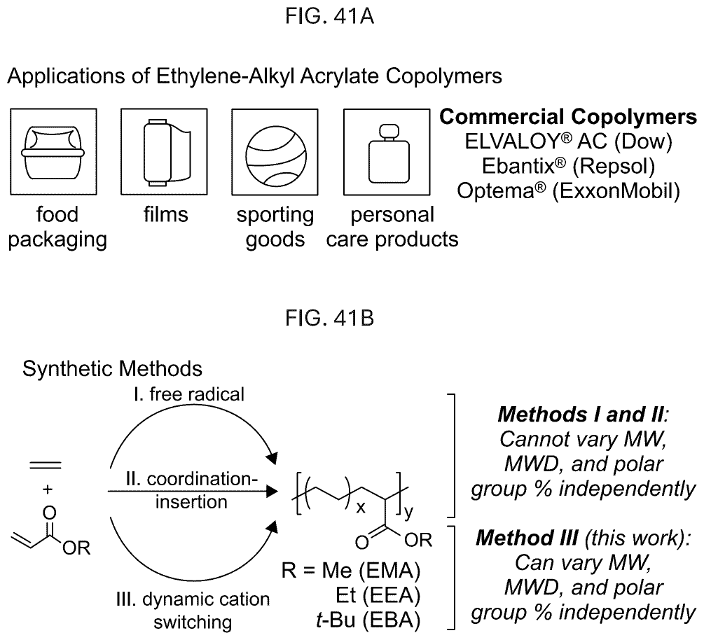

Research in polyolefin synthesis continues to thrive due to the high demand for durable, inexpensive, and high-performing plastic across many industrial sectors (Zanchin, G.; Leone, G. Polyolefin thermoplastic elastomers from polymerization catalysis: Advantages, pitfalls and future challenges. Prog. Polym. Sci. 2021, 113, 101342; Feldman, D. Polyolefin, olefin copolymers and polyolefin polyblend nanocomposites. J. Macromol. Sci. A 2016, 53, 651-658). Interests in functional polyolefins stem from their enhanced properties (e.g., increased flexibility, blending compatibility, adhesiveness, etc.) relative to that of polyethylene (PE) (Kruszynski, J.; Nowicka, W.; Pasha, F. A.; Yang, L.; Rozanski, A.; Bouyahyi, M.; Kleppinger, R.; Jasinska-Walc, L.; Duchateau, R. Tuning the Adhesive Strength of Functionalized Polyolefin-Based Hot Melt Adhesives: Unexpected Results Leading to New Opportunities. Macromolecules 2025, ASAP; Chung, T. C. M. Functional Polyolefins for Energy Applications. Macromolecules 2013, 46, 6671-6698; Jasinska-Walc, L., Bouyahyi, M., Duchateau, R. Potential of Functionalized Polyolefins in a Sustainable Polymer Economy: Synthetic Strategies and Applications. Acc. Chem. Res. 2022, 55, 1985-1996). A variety of ethylene-alkyl acrylate copolymers (EAA) have been used in applications such as food packaging, films, sporting goods, personal care products, and others (FIG. 41A). Some examples of commercial EAA include ELVALOY® AC from the Dow Chemical Company, Ebantix® from Repsol, and Optema® from ExxonMobil Chemical. These copolymers are synthesized using free radical polymerization (FIG. 41B, Method I), which must be performed at high pressure (˜150-350 MPa) and temperature (>160° C.) and requires sophisticated reaction engineering to obtain specific products. Because free radical processes are non-selective, this polymerization method is incapable of precise polymer synthesis.

Another approach to prepare EAA is through the coordination-insertion copolymerization of ethylene and alkyl acrylate using transition metal catalysts (FIG. 41B, Method II) (Chen, E. Y.-X. Coordination Polymerization of Polar Vinyl Monomers by Single-Site Metal Catalysts. Chem. Rev. 2009, 109, 5157-5214; Chen, Z.; Brookhart, M. Exploring Ethylene/Polar Vinyl Monomer Copolymerizations Using Ni and Pd x-Diimine Catalysts. Acc. Chem. Res. 2018, 57, 1831-1839; Keyes, A., Basbug Alhan, H. E.; Ordonez, E.; Ha, U., Beezer, D. B.; Dau, H.; Liu, Y.-S.; Tsogtgerel, E.; Jones, G. R.; Harth, E. Olefins and Vinyl Polar Monomers: Bridging the Gap for Next Generation Materials. Angew. Chem. Int. Ed. 2019, 58, 12370-12391; Chen, J.; Gao, Y.; Marks, T. J. Early Transition Metal Catalysis for Olefin-Polar Monomer Copolymerization. Angew. Chem. Int. Ed. 2020, 59, 14726-14735; Jiang, Y., Zhang, Z.; Jiang, H., Wang, Q.; Li, S.; Cui, D. Polar Group-Promoted Copolymerization of Ethylene with Polar Olefins. Macromolecules 2023, 56, 1547-1553; Wang, Q.; Chen, M.; Zou, C.; Chen, C. Direct Synthesis of Polar-Functionalized Polyolefin Elastomers. Angew. Chem. Int. Ed. 2025, e202423814; Zheng, H., Qiu, Z.; Li, D.; Pei, L.; Gao, H. Advance on nickel- and palladium-catalyzed insertion copolymerization of ethylene and acrylate monomers. J. Polym. Sci. 2023, 61, 2987-3021). This method can provide EAA with narrow dispersity (Ð<2), variable polar monomer content, and even ultra-high molecular weight (Mₙ>103 kg/mol) (Yang, Q.; Kang, X.; Liu, Y.; Mu, H.; Jian, Z. Ultrahigh Molecular Weight Ethylene-Acrylate Copolymers Synthesized with Highly Active Neutral Nickel Catalysts. Angew. Chem. Int. Ed. 2025, e202421904). Because conventional catalysts can furnish polymers with specific microstructures only under certain conditions, obtaining EAA with user-defined specifications is challenging. For example, increasing the alkyl acrylate concentration in the polymerization reaction can enhance the polar content in the EAA but the molecular weight typically decreases and vice versa (Xiong, S.; Shoshani, M. M.; Zhang, X.; Spinney, H. A.; Nett, A. J.; Henderson, B. S., Miller, T. F., III, Agapie, T. Efficient Copolymerization of Acrylate and Ethylene with Neutral P, O-Chelated Nickel Catalysts: Mechanistic Investigations of Monomer Insertion and Chelate Formation. J. Am. Chem. Soc. 2021, 143, 6516-6527; Sui, X.; Dai, S.; Chen, C. Ethylene Polymerization and Copolymerization with Polar Monomers by Cationic Phosphine Phosphonic Amide Palladium Complexes. ACS Catal. 2015, 5, 5932-5937; Contrella, N. D.; Sampson, J. R.; Jordan, R. F. Copolymerization of Ethylene and Methyl Acrylate by Cationic Palladium Catalysts That Contain Phosphine-Diethyl Phosphonate Ancillary Ligands. Organometallics 2014, 33, 3546-3555; Saki, Z.; D'Auria, I.; Dall'Anese, A.; Milani, B.; Pellecchia, C. Copolymerization of Ethylene and Methyl Acrylate by Pyridylimino Ni(II) Catalysts Affording Hyperbranched Poly(ethylene-co-methyl acrylate) s with Tunable Structures of the Ester Groups. Macromolecules 2020, 53, 9294-9305). Thus, adjusting a single parameter (e.g., MW, MW distribution (MWD), or polar group incorporation) without impacting others is not feasible in conventional coordination-insertion polymerization.

To overcome the limitations of a one catalyst-one polymer paradigm (Sita, L. R. Ex Uno Plures (“Out of One, Many”): New Paradigms for Expanding the Range of Polyolefins through Reversible Group Transfers. Angew. Chem. Int. Ed. 2009, 48, 2464-2472) our group has focused on the development of cation-tunable polymerization catalysts (Cai, Z.; Xiao, D.; Do, L. H. Fine-Tuning Nickel Phenoxyimine Olefin Polymerization Catalysts: Performance Boosting by Alkali Cations. J. Am. Chem. Soc. 2015, 137, 15501-15510; Cai, Z.; Do, L. H. Thermally Robust Heterobimetallic Palladium-Alkali Catalysts for Ethylene and Alkyl Acrylate Copolymerization. Organometallics 2018, 37, 3874-3882; Tran, T. V.; Nguyen, Y. H.; Do, L. H. Development of Highly Productive Nickel-Sodium Phenoxyphosphine Ethylene Polymerization Catalysts and their Reaction Temperature Profiles. Polym. Chem. 2019, 10, 3718-3721). Unlike other strategies that rely on light (Kaiser, J. M.; Anderson, W. C., Jr.; Long, B. K. Photochemical Regulation of a Redox-Active Olefin Polymerization Catalyst: Controlling Polyethylene Microstructure with Visible Light. Polym. Chem. 2018, 9, 1567-1570), redox agents (Yang, B.; Pang, W.; Chen, M. Redox Control in Olefin Polymerization Catalysis by Phosphine-Sulfonate Palladium and Nickel Complexes. Eur. J. Inorg. Chem. 2017, 2510-2514; Anderson, W. C., Jr.; Rhinehart, J. L., Tennyson, A. G.; Long, B. K. Redox-Active Ligands: An Advanced Tool To Modulate Polyethylene Microstructure. J. Am. Chem. Soc. 2016, 138, 774-777; Anderson, W. C., Jr.; Long, B. K. Modulating Polyolefin Copolymer Composition via Redox-Active Olefin Polymerization Catalysts. ACS Macro Lett. 2016, 5, 1029-1033; Kaiser, J. M., Long, B. K. Recent Developments in Redox-Active Olefin Polymerization Catalysts. Coord. Chem. Rev. 2018, 372, 141-152) or boranes (Cai, Z.; Shen, Z.; Zhou, X.; Jordan, R. F. Enhancement of Chain Growth and Chain Transfer Rates in Ethylene Polymerization by (Phosphine-sulfonate) PdMe Catalysts by Binding of B(C₆F₅)₃ to the Sulfonate Group. ACS Catal. 2012, 2, 1187-1195; Johnson, A. M.; Contrella, N. D.; Sampson, J. R.; Zheng, M., Jordan, R. F. Allosteric Effects in Ethylene Polymerization Catalysis. Enhancement of Performance of Phosphine-Phosphinate and Phosphine-Phosphonate Palladium Alkyl Catalysts by Remote Binding of B(CF₃)₃. Organometallics 2017, 36, 4990-5002) to switch catalysts between two different reactivity states, the pairing of various metal salts with polymerization catalysts can potentially access many more (Tran, T. V.; Do, L. H. Tunable Modalities in Polyolefin Synthesis via Coordination Insertion Catalysis. Eur. Polym. J. 2021, 142, 110100). For example, metal cations can differ in charge, Lewis acidity, and size, which can modulate a catalyst's steric and electronic properties to different extent. A variety of Ni/Pd catalyst platforms has been demonstrated to be cation-tunable, including those based on P,O—, (Cai, Z.; Do, L. H. Thermally Robust Heterobimetallic Palladium-Alkali Catalysts for Ethylene and Alkyl Acrylate Copolymerization. Organometallics 2018, 37, 3874-3882; Tran, T. V.; Nguyen, Y. H.; Do, L. H. Development of Highly Productive Nickel-Sodium Phenoxyphosphine Ethylene Polymerization Catalysts and their Reaction Temperature Profiles. Polym. Chem. 2019, 10, 3718-3721; Johnson, L., Wang, L.; McLain, S.; Bennett, A.; Dobbs, K.; Hauptman, E.; Ionkin, A.; Ittel, S.; Kunitsky, K.; Marshall, W., McCord, E.; Radzewich, C.; Rinehart, A.; Sweetman, K. J.; Wang, Y.; Yin, Z.; Brookhart, M. Copolymerization of Ethylene and Acrylates by Nickel Catalysts. In Beyond Metallocenes; American Chemical Society: 2003; Vol. 857, p 131-142; Xiong, S.; Spinney, H. A.; Bailey, B. C.; Henderson, B. S.; Tekpor, A. A.; Espinosa, M. R.; Saha, P.; Agapie, T. Switchable Synthesis of Ethylene/Acrylate Copolymers by a Dinickel Catalyst: Evidence for Chain Growth on Both Nickel Centers and Concepts of Cation Exchange Polymerization. ACS Catal. 2024, 14, 5260-5268; Xiong, S.; Shoshani, M. M.; Nett, A. J.; Spinney, H. A.; Henderson, B. S., Agapie, T. Nickel-Based Heterometallic Catalysts for Ethylene-Acrylate Copolymerization: Interrogating Effects of Secondary Metal Additives. Organometallics 2023, 42, 2849-2855), N,O-(Cai, Z.; Xiao, D.; Do, L. H. Fine-Tuning Nickel Phenoxyimine Olefin Polymerization Catalysts: Performance Boosting by Alkali Cations. J. Am. Chem. Soc. 2015, 137, 15501-15510; Chiu, H.-C.; Koley, A.; Dunn, P. L.; Hue, R. J.; Tonks, I. A. Ethylene Polymerization Catalyzed by Bridging Ni/Zn Heterobimetallics. Dalton Trans. 2017, 46, 5513-5517) and C,O-donors (Akita, S.; Nozaki, K. Copolymerization of Ethylene and Methyl Acrylate by Palladium Catalysts Bearing IzQO Ligands Containing Methoxyethyl Ether Moieties and Salt Effects for Polymerization. Polym. J. 2021, 53, 1057-1060). Our recent discovery that cation exchange equilibria could be manipulated to influence the coordination-insertion of non-living polymerization catalysts affords another level of control (Tran, T. V.; Lee, E., Nguyen, Y. H., Nguyen, H. D., Do, L. H. Customizing Polymers by Controlling Cation Switching Dynamics in Non-Living Polymerization. J. Am. Chem. Soc. 2022, 144, 17129-17139). Under non-switching conditions, the polymerization of ethylene using our nickel phenoxyphosphine-polyethylene glycol (PEG) catalysts with M′ and M′ (where M⁺, M′+=Li⁺, Na⁺, K⁺, or Cs⁺; and M⁺+M′) yielded bimodal PE with adjustable MWD depending on the M⁺:M′⁺ ratio employed. In contrast, under dynamic cation switching conditions, the same catalyst system generated monomodal PE with tunable MW as a function of the M⁺:M′⁺ ratio. However, these studies were performed in the presence of ethylene so it was unclear whether polar monomers would be compatible with this polymerization strategy.

In this work, we successfully expanded the application of dynamic cation switching to ethylene and alkyl acrylate copolymerization, enabling for the first time the production of functional polyolefins with high precision (FIG. 41B, Method III). We demonstrate that ethylene-methyl acrylate copolymers (EMA) can be made-to-order with specific MW, MWD, and polar group incorporation. Having access to a series of systematically varied EMA allowed us to interrogate their structure-function relationships, offering new insights into the properties of this important class of polymers. Our results revealed that the incorporation of small amounts of polar groups into PE increased its wettability and susceptibility to oxidative cleavage without impacting its mechanical strength. These findings could be useful for the development of advanced plastics that are durable yet degradable on demand.

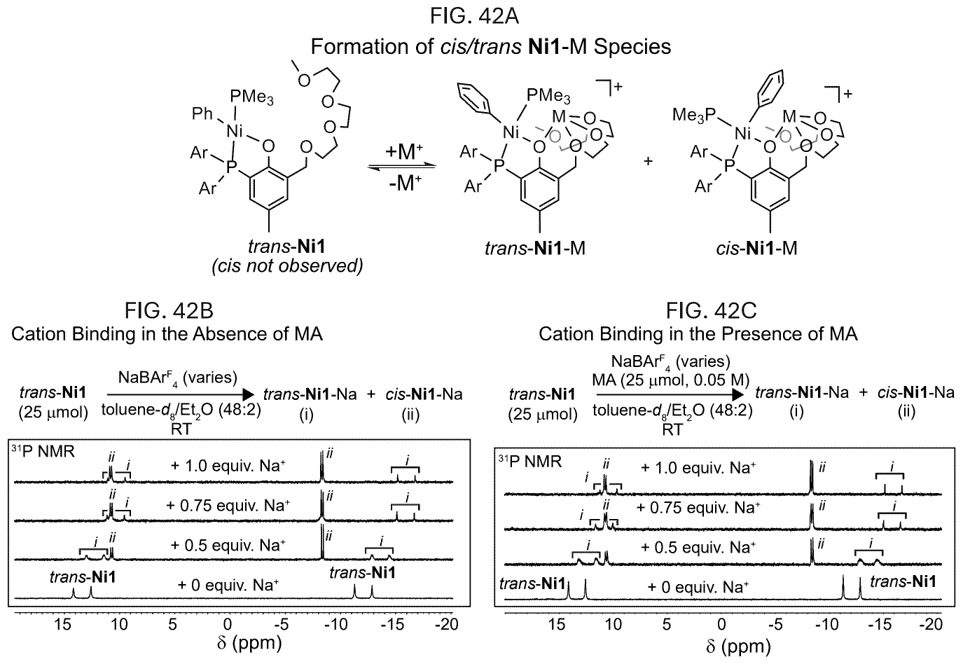

Catalyst Selection and Metal Cation Binding. Previously, we demonstrated that nickel phenoxyphosphine-PEG complexes readily formed adducts with alkali ions to generate highly active heterobimetallic species capable of polymerizing ethylene (Tran, T. V.; Nguyen, Y. H., Do, L. H. Development of Highly Productive Nickel-Sodium Phenoxyphosphine Ethylene Polymerization Catalysts and their Reaction Temperature Profiles. Polym. Chem. 2019, 10, 3718-3721; Tran, T. V., Lee, E.; Nguyen, Y. H.; Nguyen, H. D.; Do, L. H. Customizing Polymers by Controlling Cation Switching Dynamics in Non-Living Polymerization. J. Am. Chem. Soc. 2022, 144, 17129-17139; Tran, T. V.; Karas, L. J.; Wu, J. L; Do, L. H. Elucidating Secondary Metal Cation Effects on Nickel Olefin Polymerization Catalysts. ACS Catal. 2020, 10, 10760-10772). The catalyst activity and polymer MW and branching were dependent on the identity of M⁺ since differences in its Lewis acidity and size significantly impacted the catalyst's structure and electronic properties. The first-generation catalyst Ni1 contained bis(2-methoxyphenyl)phosphine moieties (FIG. 42A) (Tran, T. V.; Nguyen, Y. H.; Do, L. H. Development of Highly Productive Nickel-Sodium Phenoxyphosphine Ethylene Polymerization Catalysts and their Reaction Temperature Profiles. Polym. Chem. 2019, 10, 3718-3721; Tran, T. V.; Karas, L. J.; Wu, J. I.; Do, L. H. Elucidating Secondary Metal Cation Effects on Nickel Olefin Polymerization Catalysts. ACS Catal. 2020, 10, 10760-10772) whereas the second-generation catalyst Ni2 contained bis(2,6-dimethoxyphenyl)phosphine moieties (Tran, T. V.; Lee, E.; Nguyen, Y. H.; Nguyen, H. D.; Do, L. H. Customizing Polymers by Controlling Cation Switching Dynamics in Non-Living Polymerization. J. Am. Chem. Soc. 2022, 144, 17129-17139). Although Ni2 provided polymers with higher MW than Ni1, we chose the latter for this proof-of-concept study because it is less air-sensitive and can be obtained in greater overall yield. However, Ni1 and Ni2 are expected to exhibit similar behavior with regards to their coordination chemistry and reactions with olefins. Complex Ni1 was prepared as described in our earlier work (Tran, T. V.; Nguyen, Y. H.; Do, L. H. Development of Highly Productive Nickel-Sodium Phenoxyphosphine Ethylene Polymerization Catalysts and their Reaction Temperature Profiles. Polym. Chem. 2019, 10, 3718-3721) but with modifications to a few steps to improve the synthetic efficiency (see the Examples section herein for details). The nickel complexes were fully characterized and evaluated for purity prior to use.

Although we have shown that the cation exchange rates between our Ni complexes and M′ can be controlled by solvent polarity (i.e., polar mixtures facilitate fast exchange whereas non-polar mixtures facilitate slow exchange), (Tran, T. V.; Lee, E.; Nguyen, Y. H.; Nguyen, H. D.; Do, L. H. Customizing Polymers by Controlling Cation Switching Dynamics in Non-Living Polymerization. J. Am. Chem. Soc. 2022, 144, 17129-17139) we were unsure whether polar monomers would affect these rates. To interrogate this possibility, we conducted a series of cations binding studies. In these experiments, Ni1 was dissolved in toluene-d₈/Et₂O (48:2) and then various amounts of NaBAr^{F}₄ (where BAr^{F}₄⁻=tetrakis(3,5-bis(trifluoromethyl)phenyl)borate anion) were added. The mixtures were stirred for 10 min and then analyzed by ³¹P NMR spectroscopy. The starting Ni1 complex showed two doublets centered at −12.1 and 13.4 ppm (J=319 Hz), consistent with having a trans arrangement of the two phosphine donors around the nickel square plane (FIG. 42A, trans-Ni1) (Tran, T. V.; Karas, L. J.; Wu, J. I.; Do, L. H. Elucidating Secondary Metal Cation Effects on Nickel Olefin Polymerization Catalysts. ACS Catal. 2020, 10, 10760-10772; Ogilvie, F. B.; Jenkins, J. M.; Verkade, J. G. ³¹P-³¹P Spin-Spin Coupling in Complexes Containing Two Phosphorus Ligands. J. Am. Chem. Soc. 1970, 92, 1916-1923). The cis-Ni1 isomer, in which the phosphine ligands are adjacent to each other in the nickel center, was not observed. In the absence of methyl acrylate (MA), the addition of up to 1.0 equiv. of Na⁺ resulted in the appearance of two sets of signals (FIG. 42B). The first set of peaks shifted upfield as increasing quantities of Na⁺ were added, ultimately centering at −15.9 and 10.3 ppm (J=319 Hz). We propose that these peaks arise from the fast interconversion between trans-Ni1 and trans-Ni1-Na species on the NMR timescale, suggesting that cation exchange occurs readily in this solvent mixture. The second set of signals at −8.4 and 10.8 ppm grew in intensity but did not shift when greater amounts of Na⁺ were introduced. These resonances were assigned to the two phosphines in cis-Ni1-Na based on its J coupling constant of 34 Hz (Ogilvie, F. B., Jenkins, J. M.; Verkade, J. G. ³¹P-³¹P Spin-Spin Coupling in Complexes Containing Two Phosphorus Ligands. J. Am. Chem. Soc. 1970, 92, 1916-1923). Because the starting nickel species does not exist in the cis form, there is no possibility of cis-Ni1 and cis-Ni1-Na equilibration that would result in peak averaging. It should be noted that the PMe₃ ligand is removed from Ni1 upon catalyst activation with Ni(COD)₂ (COD=1,5-cyclooctadiene) during polymerization so its cation binding affinity may differ slightly in the active vs. precatalyst forms. However, these studies provide useful qualitative information about their interactions with cations.

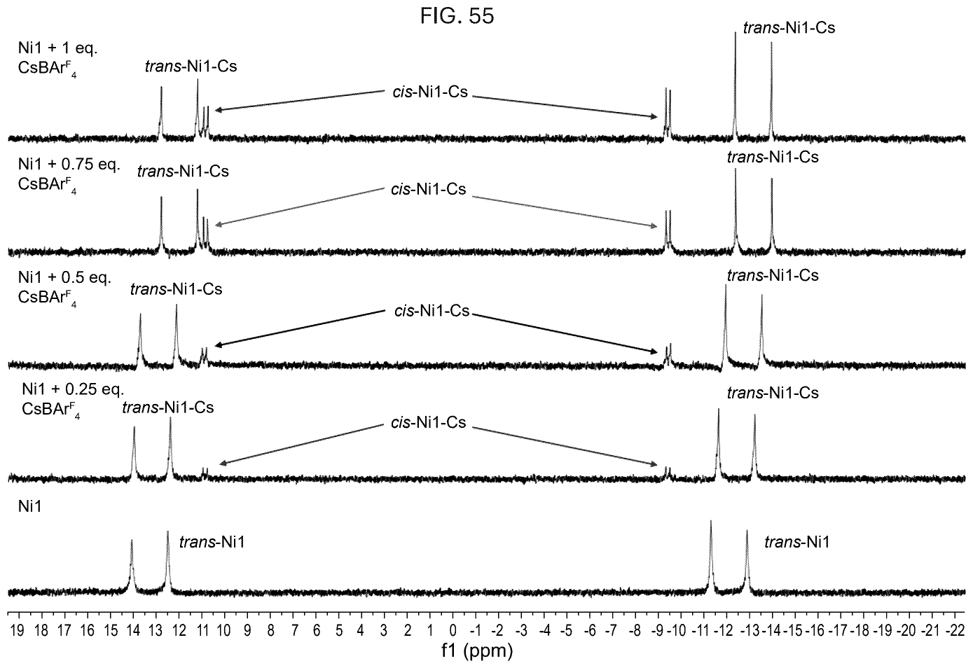

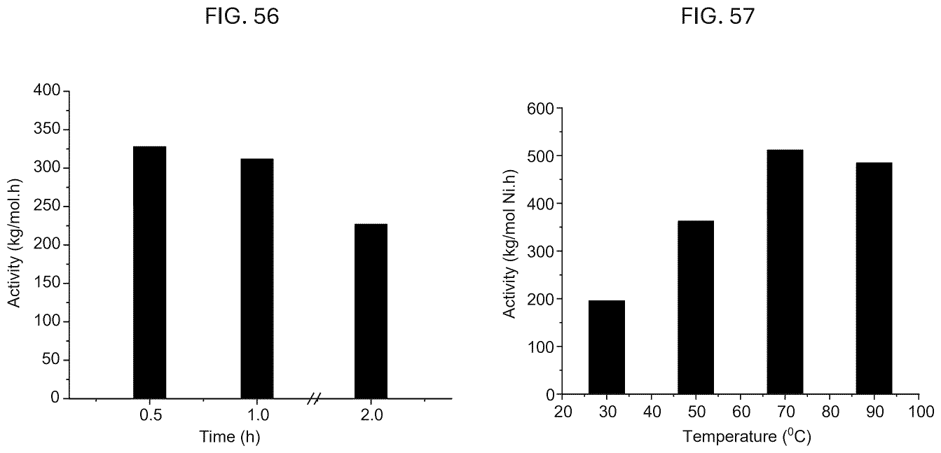

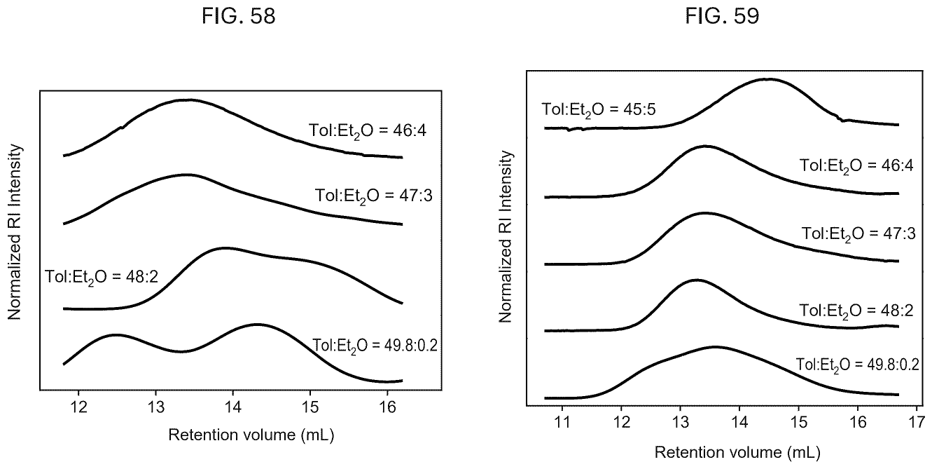

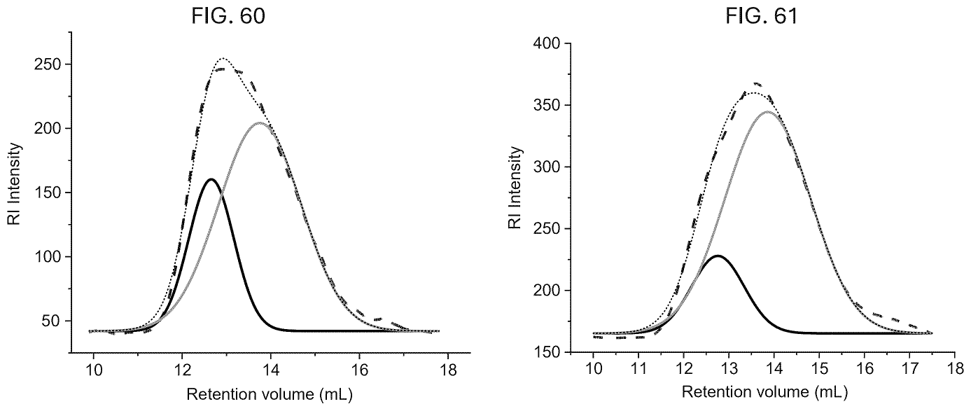

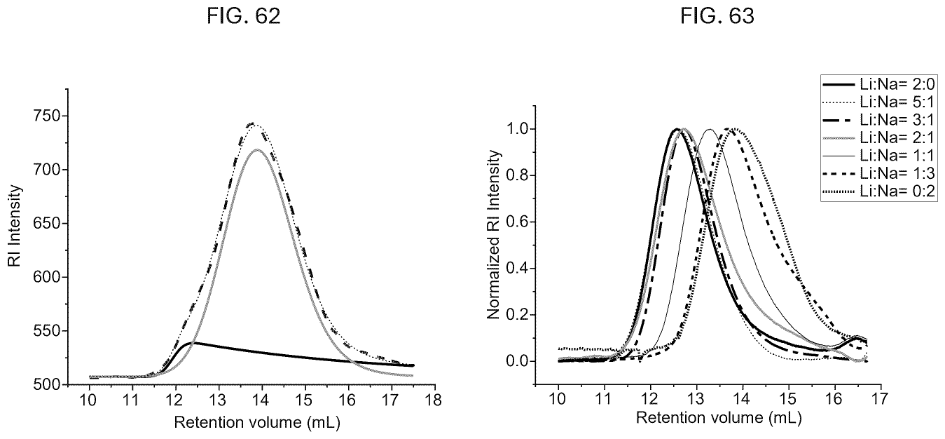

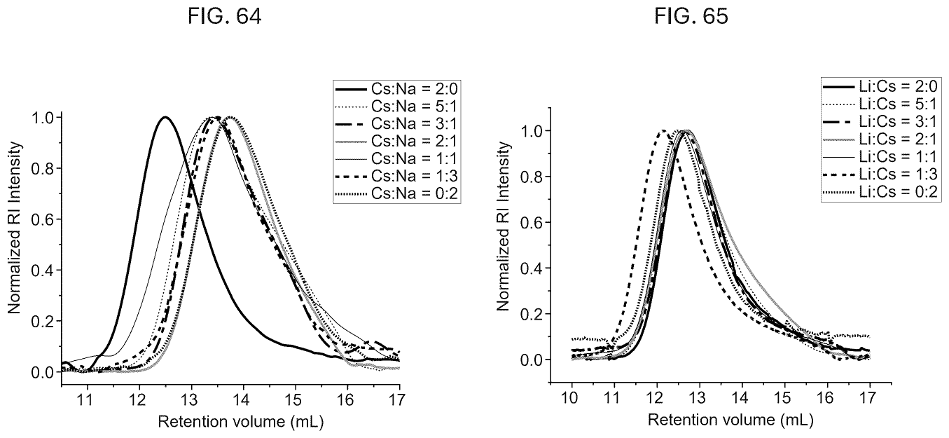

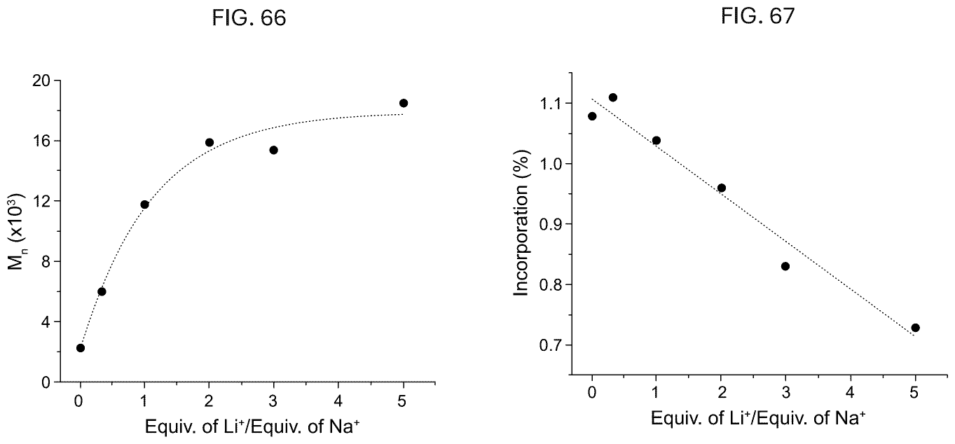

Next, the binding of Na⁺ to Ni1 was evaluated in the presence of 0.05 M methyl acrylate in toluene-d₈/Et₂O (48:2) (FIG. 42C). We observed that the ³¹P NMR spectra of the Ni1 and Na⁺ samples with and without MA additives were nearly identical, indicating that the presence of polar monomers at the concentration tested had minimal effects on the cation binding dynamics. In the absence of Ni(COD)₂, no insertion of MA into the nickel-phenyl bond of Ni1-Na occurred. Additional experiments conducted using Ni1 and CsBAr^{F}₄ in toluene-d₈/Et₂O (48:2) showed similar behavior (FIG. 55). Specifically, the treatment of Ni1 with Cs⁺ led to the formation of heterobimetallic trans-Ni1-Cs and cis-Ni1-Cs species. Once again, signal averaging between the trans-Ni1 and trans-Ni1-Cs peaks suggests that cation exchange is fast in this solvent mixture. However, under catalytic conditions, the MA:catalyst stoichiometry is typically 1250:1 rather than 1:1 so we expect that MA will have a more significant impact on the cation binding behavior in polymerization (vide infra).

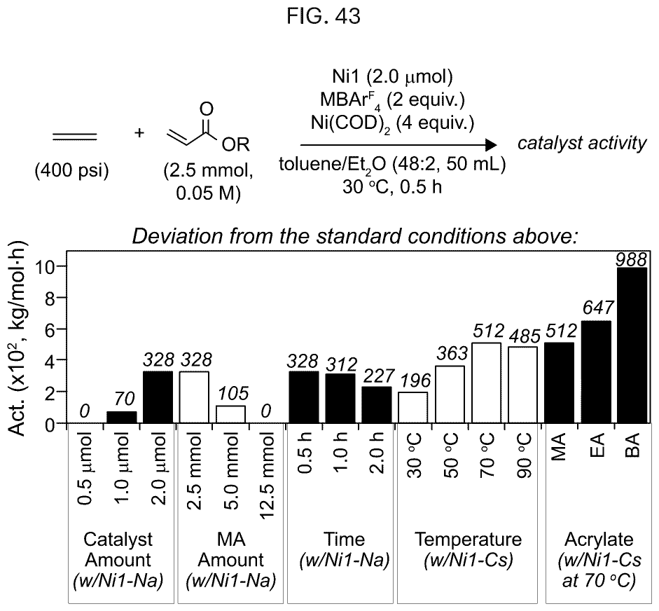

Ethylene and Alkyl Acrylate Copolymerization. The nickel phenoxyphosphine complexes are among the highest performing catalysts for ethylene and polar vinyl monomer copolymerization reported to date (Yang, Q.; Kang, X., Liu, Y.; Mu, H.; Jian, Z. Ultrahigh Molecular Weight Ethylene-Acrylate Copolymers Synthesized with Highly Active Neutral Nickel Catalysts. Angew. Chem. Int. Ed. 2025, e202421904; Xin, B. S.; Sato, N.; Tanna, A.; Oishi, Y.; Konishi, Y.; Shimizu, F. Nickel Catalyzed Copolymerization of Ethylene and Alkyl Acrylates. J. Am. Chem. Soc. 2017, 139, 3611-3614; Xiong, S.; Hong, A.; Ghana, P.; Bailey, B. C.; Spinney, H. A.; Bailey, H.; Henderson, B. S.; Marshall, S.; Agapie, T. Acrylate-Induced β-H Elimination in Coordination Insertion Copolymerizaton Catalyzed by Nickel. J. Am. Chem. Soc. 2023, 145, 26463-26471; Zhang, Y.; Mu, H.; Pan, L.; Wang, X.; Li, Y. Robust Bulky [P,O] Neutral Nickel Catalysts for Copolymerization of Ethylene with Polar Vinyl Monomers. ACS Catal. 2018, 8, 5963-5976; Zhang, Y.; Mu, H.; Wang, X.; Pan, L.; Li, Y. Elaborate Tuning in Ligand Makes a Big Difference in Catalytic Performance: Bulky Nickel Catalysts for (Co) polymerization of Ethylene with Promising Vinyl Polar Monomers. ChemCatChem 2019, 11, 2329-2340). Encouraged by these reports, we proceeded to evaluate the reactivity of Ni1-M (where M⁺=Li⁺, Na⁺, K⁺ or Cs⁺) toward ethylene and alkyl acrylates. In our initial studies, we combined Ni1 (2 μmol), NaBAr^{F}₄ (4 μmol), Ni(COD)₂ (8 μmol), and MA (2.5 mmol, 0.05 M) in toluene/Et₂O (48:2) under ethylene at 30° C. (FIG. 43; Table 4A, entry 3). After 0.5 h, the reaction was quenched with acid and the resulting white solid was characterized by ¹H NMR spectroscopy. The broad peaks at ˜2.5 and 3.7 ppm were assigned to methyl peaks of in-chain methyl ester groups (Zheng, H.; Qiu, Z.; Li, D.; Pei, L.; Gao, H. Advance on nickel- and palladium-catalyzed insertion copolymerization of ethylene and acrylate monomers. J. Polym. Sci. 2023, 67, 2987-3021; Zhang, Y.; Mu, H.; Pan, L.; Wang, X.; Li, Y. Robust Bulky [P,O] Neutral Nickel Catalysts for Copolymerization of Ethylene with Polar Vinyl Monomers. ACS Catal. 2018, 8, 5963-5976; Tahmouresilerd, B.; Xiao, D., Do, L. H. Rigidifying Cation-Tunable Nickel Catalysts Increases Activity and Polar Monomer Incorporation in Ethylene and Methyl Acrylate Copolymerization. Inorg. Chem. 2021, 60, 19035-19043) respectively, confirming that the desired EMA was obtained. Further characterization of the copolymer showed that it has an average molar mass (Mₙ) of 2.2 kg/mol with 1.08 mol % incorporation of MA and dispersity (Ð) of 1.1. We found that decreasing the Ni1 catalyst loading to 0.5 μmol (Table 4A) or increasing the MA concentration to 0.25 M (12.5 mmol, Table 5A) resulted in no product. Because MA can inhibit the nickel catalyst via coordination by its oxygen donor rather than C═C bond, increasing the MA:catalyst ratio often leads to lower catalyst activity (Sui, X.; Dai, S.; Chen, C. Ethylene Polymerization and Copolymerization with Polar Monomers by Cationic Phosphine Phosphonic Amide Palladium Complexes. ACS Catal. 2015, 5, 5932-5937; Saki, Z.; D'Auria, I.; Dall'Anese, A.; Milani, B.; Pellecchia, C. Copolymerization of Ethylene and Methyl Acrylate by Pyridylimino Ni(II) Catalysts Affording Hyperbranched Poly(ethylene-co-methyl acrylate) s with Tunable Structures of the Ester Groups. Macromolecules 2020, 53, 9294-9305; Zheng, H.; Qiu, Z.; Gao, H.; Li, D.; Cheng, Z.; Tu, G.; Gao, H. Noncovalent Ni-Phenyl Interactions Promoted α-Diimine Nickel-Catalyzed Copolymerization of Ethylene and Methyl Acrylate. Macromolecules 2024, 57, 5279-5288). Finally, extending the polymerization time from 0.5 to 2.0 h led to a reduction in catalyst activity from 328 to 227 kg/mol·h (Table 6A), presumably due to catalyst decomposition (Berkefeld, A.; Mecking, S. Deactivation Pathways of Neutral Ni(II) Polymerization Catalysts. J. Am. Chem. Soc. 2009, 137, 1565-1574).

TABLE 1A
Ethylene and Alkyl Acrylate Copolymerization Using Ni1/Cations^{a}

| | | | Act. | | Mₙ^{c} | | | |
|---|---|---|---|---|---|---|---|---|
| | | Acry- | (kg/ | Inc.^{b} | (10³ | | Acrylate/ | Tₘ |
| Entry | M⁺ | late | mol · h) | (mol %) | kg/mol) | Ð^{c} | Chain | (° C.) |
| 1 | none | MA | 0 | — | — | — | — | — |
| 2 | Li⁺ | MA | 1020 | 0.71 | 18.9 | 1.4 | 4.7 | 125 |
| 3 | Na⁺ | MA | 328 | 1.08 | 2.2 | 1.1 | 0.8 | 107 |
| 4 | K⁺ | MA | 340 | 1.12 | 3.1 | 1.4 | 1.2 | 115 |
| 5 | Cs⁺ | MA | 196 | 1.26 | 12.3 | 1.6 | 5.4 | 119 |
| 6 | Li⁺ | BA | 843 | 0.26 | 14.8 | 1.3 | 1.4 | 124 |
| 7 | Na⁺ | BA | 492 | 0.58 | 2.3 | 1.4 | 0.5 | 112 |
| 8 | K⁺ | BA | 467 | 0.76 | 3.7 | 1.8 | 1.0 | 121 |
| 9 | Cs⁺ | BA | 312 | 0.89 | 15.1 | 1.5 | 4.7 | 116 |
| 10 | Li⁺ | EA | 366 | 0.2 | 11.7 | 1.5 | 0.8 | 124 |

^{a}Polymerization conditions: Ni1 catalyst (2 μmol), MBAr^{F}₄ (4 μmol), Ni(COD)₂ (8 μmol), ethylene (400 psi), alkyl acrylate (2.5 mmol, 0.05M), 48 mL toluene/2 mL Et₂O, 30° C., 30 min. In the absence of cations, Ni1 is not active for polymerization. Temperature was controlled by manual external cooling when necessary to ensure that the reaction temperature did not exceed 5° C. from the starting temperature.
^{b}Determined by ¹H NMR spectroscopy.
^{c}Determined by GPC in trichlorobenzene at 160° C. Abbreviations: MA = methyl acrylate, EA = ethyl acrylate, BA = tert-butyl acrylate.

To study the effects of cations on Ni1, we performed ethylene and MA copolymerization studies in the presence of various alkali ions using our optimized conditions at 30° C. (Table 1A). Our data revealed that catalyst activity decreased from 1020 to 196 kg/mol·h whereas the MA incorporation increased from 0.71 to 1.26 mol % mostly according to the order Li⁺→Na⁺→K⁺→Cs⁺ (entries 2-5). In contrast, the polymer MW did not follow an obvious trend, with Ni1-Li (Mₙ=18.9 kg/mol) and Ni1-Na (Mₙ=2.2 kg/mol) giving the highest and lowest, respectively. As a control, reactions in the absence of M⁺ gave no products (entry 1). These results are qualitatively similar to those observed previously with Ni1-M in ethylene homopolymerization (Tran, T. V.; Nguyen, Y. H.; Do, L. H. Development of Highly Productive Nickel-Sodium Phenoxyphosphine Ethylene Polymerization Catalysts and their Reaction Temperature Profiles. Polym. Chem. 2019, 10, 3718-3721; Tran, T. V.; Karas, L. J.; Wu, J. I., Do, L. H. Elucidating Secondary Metal Cation Effects on Nickel Olefin Polymerization Catalysts. ACS Catal. 2020, 10, 10760-10772) except that the catalyst activities and polymer MWs are lower in the present study due to the inhibiting effects of MA. Based on computational investigations of this nickel system by Ratanasak, Parasuk, and coworkers, (Apilardmongkol, P.; Ratanasak, M.; Hasegawa, J.-y., Parasuk, V. Exploring the Reaction Mechanism of Heterobimetallic Nickel-Alkali Catalysts for Ethylene Polymerization: Secondary-Metal-Ligand Cooperative Catalysis. ChemCatChem 2022, 14, e202200028) it was proposed that the energy barriers associated with the elementary steps in coordination-insertion of ethylene (e.g., cis-trans nickel isomerization, olefin insertion, and olefin binding) are lowest in the presence of Li⁺ and highest in the presence of Cs⁺. Their density functional theory (DFT) results are consistent with our experimental observations that the catalyst activity follows the periodic trend from Li⁺→Na⁺→K⁺→Cs⁺. Our results showing that the more active Ni1-M catalysts yielded copolymers with lower MA mol % indicate that ethylene insertion is faster relative to MA insertion. However, further mechanistic studies of the copolymerization process are necessary to identify the rate-determining steps and evaluate whether there are cooperative interactions between MA and the metal centers in Ni1-M (Cai, Z.; Xiao, D.; Do, L. H. Cooperative Heterobimetallic Catalysts in Coordination Insertion Polymerization. Comments Inorg. Chem. 2019, 39, 27-50; McInnis, J. P.; Delferro, M.; Marks, T. J. Multinuclear Group 4 Catalysis: Olefin Polymerization Pathways Modified by Strong Metal-Metal Cooperative Effects. Acc. Chem. Res. 2014, 47, 2545-2557).

The Ni1-M catalysts were also capable of producing ethylene-ethyl acrylate (EEA) and ethylene-tert-butyl acrylate (EBA) copolymers from ethylene and the corresponding comonomer (Table 1A, entries 6-10). At 30° C., the trends were similar to that observed in ethylene and MA copolymerization. For example, Ni1-Li produced EBA with the highest activity (843 kg/mol·h) and lowest polar group incorporation (0.26 mol %) whereas Ni1-Cs showed the reverse (activity=312 kg/mol·h, polar group incorporation=0.89 mol %). The lower polar group density in EBA compared to that in EMA (0.89 vs. 1.26 mol % with Ni1-Cs, respectively) suggest that the bulkier R group in tert-butyl acrylate may binder its insertion.

Because Ni1-Cs has greater thermal stability than the other Ni1-M catalysts, we also evaluated its activity at different temperatures (FIG. 43, Table 7A). Our results indicated that Ni1-Cs has maximum activity at 70° C. (512 kg/mol·h) but still gave EMA with appreciable rates at 90° C. (485 kg/mol·h). At 70° C., the activity of Ni1-Cs was noticeably higher than at 30° C., with up to 988 kg/mol·h for the copolymerization of ethylene and tert-butyl acrylate.

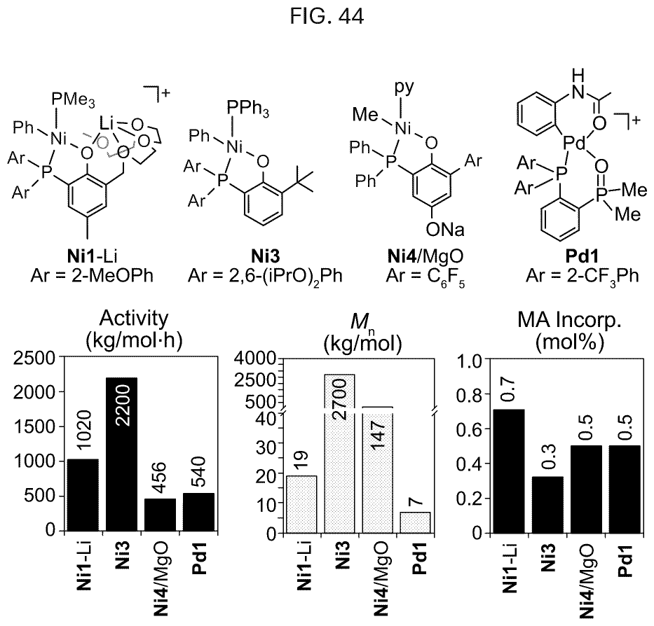

Compared to other metal catalysts that have been reported for ethylene and alkyl acrylate copolymerization, the Ni1-M complexes are among the top-performers (FIG. 44; Table 26A for more examples) (Mu, H.; Zhou, G.; Hu, X.; Jian, Z. Recent advances in nickel mediated copolymerization of olefin with polar monomers. Coord. Chem. Rev. 2021, 435, 213802; Mu, H.; Pan, L.; Song, D.; Li, Y. Neutral Nickel Catalysts for Olefin Homo- and Copolymerization: Relationships between Catalyst Structures and Catalytic Properties. Chem. Rev. 2015, 115, 12091-12137). The most active nickel catalysts are all based on the phenoxyphosphine ligand platform (Xiong, S.; Shoshani, M. M.; Zhang, X.; Spinney, H. A.; Nett, A. J.; Henderson, B. S.; Miller, T. F., III; Agapie, T. Efficient Copolymerization of Acrylate and Ethylene with Neutral P, O-Chelated Nickel Catalysts: Mechanistic Investigations of Monomer Insertion and Chelate Formation. J. Am. Chem. Soc. 2021, 143, 6516-6527; Xin, B. S.; Sato, N.; Tanna, A.; Oishi, Y.; Konishi, Y.; Shimizu, F. Nickel Catalyzed Copolymerization of Ethylene and Alkyl Acrylates. J. Am. Chem. Soc. 2017, 139, 3611-3614; Zhang, Y.; Mu, H.; Pan, L.; Wang, X.; Li, Y. Robust Bulky [P,O] Neutral Nickel Catalysts for Copolymerization of Ethylene with Polar Vinyl Monomers. ACS Catal. 2018, 8, 5963-5976). This catalyst family includes Ni3 with 2,6-diisopropyloxyphenyl phosphine substituents (Yang, Q.; Kang, X.; Liu, Y.; Mu, H., Jian, Z. Ultrahigh Molecular Weight Ethylene-Acrylate Copolymers Synthesized with Highly Active Neutral Nickel Catalysts. Angew. Chem. Int. Ed. 2025, e202421904) and Ni4 that is immobilized on magnesium oxide support (Zou, C.; Si, G.; Chen, C. A general strategy for heterogenizing olefin polymerization catalysts and the synthesis of polyolefins and composites. Nat. Commun. 2022, 13, 1954). For comparison purposes we will use Ni1-Li as a representative example of our cation-tunable catalysts. Based on the copolymerization data, the rankings are as follows: Ni3>Ni1-Li>Ni4/MgO for activity and Ni3>Ni4/MgO>Ni1-Li for polymer molecular weight. All three nickel catalysts gave EMA with <1.0 mol % of MA incorporation. One of the most active palladium catalysts reported for ethylene and MA copolymerization is Pd1, (Mitsushige, Y.; Carrow, B. P.; Ito, S.; Nozaki, K. Ligand-controlled insertion regioselectivity accelerates copolymerisation of ethylene with methyl acrylate by cationic bisphosphine monoxide-palladium catalysts. Chem. Sci. 2016, 7, 737-744) which features a phosphine-phosphine oxide ligand. This palladium catalyst compares favorably with the nickel catalysts but it provided EMA with a molecular weight of only 7 kg/mol. It is generally desirable to have catalysts that are fast and efficient, but the ideal polymer MW and polar monomer incorporation is dependent on the material's intended application.

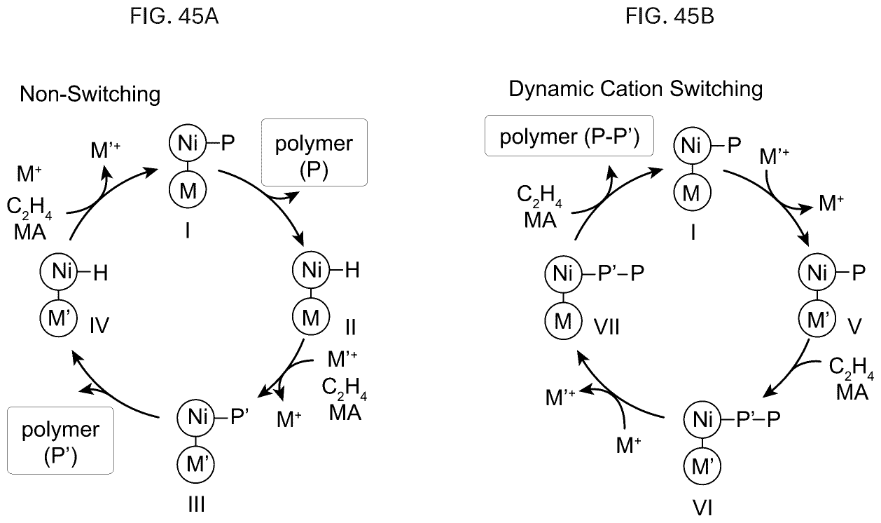

Dynamic Cation Switching Polymerization. A general feature of non-living polymerization catalysts is that each complex produces a specific, unique polymer regardless of the reaction time (Matyjaszewski, K. Introduction to living polymerization. Living and/or controlled polymerization. J. Phys. Org. Chem. 1995, 8, 197-207; Webster, O. W. Living Polymerization Methods. Science 1991, 257, 887-893). Sometimes it is possible to alter the polymer products by varying the experimental conditions but this strategy is unreliable because changing one characteristic often inadvertently changes another (e.g., increasing MW can lead to lowering of MA incorporation) (Tran, T. V.; Do, L. H. Tunable Modalities in Polyolefin Synthesis via Coordination Insertion Catalysis. Eur. Polym. J. 2021, 142, 110100). In contrast, our method using dynamic cation switching allows regulation of non-living polymerizations without external control (Tran, T. V.; Lee, E.; Nguyen, Y. H.; Nguyen, H. D.; Do, L. H. Customizing Polymers by Controlling Cation Switching Dynamics in Non-Living Polymerization. J. Am. Chem. Soc. 2022, 144, 17129-17139). This strategy is distinct from those that rely on static switching (Yang, B., Pang, W.; Chen, M. Redox Control in Olefin Polymerization Catalysis by Phosphine-Sulfonate Palladium and Nickel Complexes. Eur. J. Inorg. Chem. 2017, 2510-2514; Anderson, W. C., Jr.; Rhinehart, J. L.; Tennyson, A. G.; Long, B. K. Redox-Active Ligands: An Advanced Tool To Modulate Polyethylene Microstructure. J. Am. Chem. Soc. 2016, 138, 774-777; Anderson, W. C., Jr.; Long, B. K. Modulating Polyolefin Copolymer Composition via Redox-Active Olefin Polymerization Catalysts. ACS Macro Lett. 2016, 5, 1029-1033; Kaiser, J. M.; Long, B. K. Recent Developments in Redox-Active Olefin Polymerization Catalysts. Coord. Chem. Rev. 2018, 372, 141-152) or oscillating catalysis (Chien, J. C. W.; Llinas, G. H.; Rausch, M. D.; Lin, G.-Y.; Winter, H. H.; Atwood, J. L.; Bott, S. G. Two-State Propagation Mechanism for Propylene Polymerization Catalyzed by rac-[anti-Ethylidene (1-η⁵-tetramethylcyclopentadienyl) (1-η⁵-indenyl)]dimethyltitanium. J. Am. Chem. Soc. 1991, 113, 8569-8570; Llinas, G. H.; Dong, S. H.; Mallin, D. T.; Rausch, M. D.; Lin, Y.-G.; Winter, H. H.; Chien, J. C. W. Crystalline-Amorphous Block Polypropylene and Nonsymmetric ansa-Metallocene Catalyzed Polymerization. Macromolecules 1992, 25, 1242-1253; Coates, G. W.; Waymouth, R. M. Oscillating Stereocontrol: A Strategy for the Synthesis of Thermoplastic Elastomeric Polypropylene. Science 1995, 267, 217-219; Busico, V.; Cipullo, R.; Kretschmer, W. P.; Talarico, G.; Vacatello, M.; Van Axel Castelli, V. “Oscillating” Metallocene Catalysts: How Do They Oscillate? Angew. Chem. Int. Ed. 2002, 41, 505-508). Based on our success using this method for ethylene homopolymerization, we propose that dynamic cation switching can also be applied to ethylene and polar monomer copolymerization. In non-polar solvents, we expect that combining our nickel catalyst with M⁺ and M′ would generate Ni(P)-M and Ni(P′)-M′ species that do not undergo cation exchange (where P and P′=growing polymer chains, FIG. 45A-FIG. 45B), which means that two different active species will copolymerize ethylene and MA independently to yield bimodal polymers. In the simplified catalytic cycle shown in FIG. 45A, the heterobimetallic Ni(P)-M (I) with a growing polymer chain can undergo β-hydride elimination to yield intermediate Ni(H)-M (II) and polymer P. Species II can convert to Ni(P′)-M′ (III) due to cation swapping of M⁺ for M′⁺ and subsequent copolymerization. Chain termination from this intermediate would generate Ni(H)-M′ (IV) and polymer P′. Under a non-switching regime, the polymer produced will comprise P and P′ with different relative distributions depending on the M⁺:M′⁺ ratio used in the reaction.

In slightly polar solvents, we hypothesized that combining our nickel catalyst with M⁺ and M′⁺ would generate active nickel species that continuously cycle between Ni/M⁺ and Ni/M′⁺ states during chain propagation (i.e., if cation switching is faster than chain termination) (FIG. 45B). For example, starting from species I, exchange of M⁺ with M′⁺ will afford Ni(P)-M′ (V), which is capable of promoting further ethylene and MA insertions to VI. This propagating species can undergo cation exchange to VII as the reaction continues. Because each polymer chain is derived from a single active species that switches between two states, adjusting the M⁺:M′⁺ ratio determines the extent in which Ni/M⁺ and Ni/MH′⁺ controls the growth of individual polymer chains. This strategy would enable precise fine-tuning of the polymer microstructure, achieving a level of control beyond what is feasible through reaction engineering.

TABLE 2A
Dynamic Cation Switching Polymerization Data.

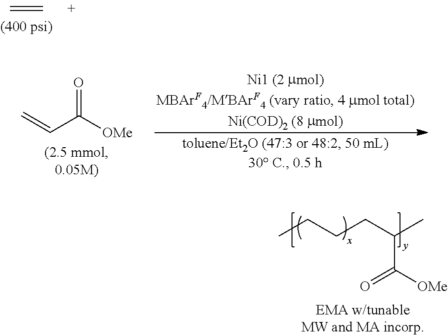

| | | | | Mₙ^{c} | | | |
|---|---|---|---|---|---|---|---|
| | M⁺:M′⁺ | Act. | Inc.^{b} | (×10³ | | MA/ | Tₘ^{d} |
| Entryª | Ratio | (kg/mol · h) | (mol%) | kg/mol) | Ð^{c} | Chain | (° C.) |
| 1 | Li⁺:Na⁺ | 1020 | 0.71 | 18.9 | 1.4 | 4.7 | 125 |
| | 2:0 | | | | | | |
| 2 | Li⁺:Na⁺ | 913 | 0.73 | 18.5 | 1.3 | 4.7 | 123 |
| | 5:1 | | | | | | |
| 3 | Li⁺:Na⁺ | 686 | 0.83 | 15.4 | 1.6 | 4.5 | 124 |
| | 3:1 | | | | | | |
| 4 | Li⁺:Na⁺ | 690 | 0.96 | 15.9 | 1.4 | 5.0 | 123 |
| | 2:1 | | | | | | |
| 5 | Li⁺:Na⁺ | 597 | 1.04 | 11.8 | 1.2 | 4.3 | 123 |
| | 1:1 | | | | | | |
| 6 | Li⁺:Na⁺ | 397 | 1.11 | 6.0 | 1.3 | 2.3 | 114 |
| | 1:3 | | | | | | |
| 7 | Li⁺:Na⁺ | 328 | 1.08 | 2.2 | 1.1 | 0.8 | 107 |
| | 0:2 | | | | | | |
| 8 | Cs⁺:Na⁺ | 102 | 1.45 | 17.8 | 1.3 | 8.9 | 117 |
| | 2:0 | | | | | | |
| 9 | Cs⁺:Na⁺ | 147 | 1.50 | 8.3 | 1.3 | 4.3 | 115 |
| | 5:1 | | | | | | |
| 10 | Cs⁺:Na⁺ | 154 | 1.43 | 6.6 | 1.7 | 3.2 | 117 |
| | 3:1 | | | | | | |
| 11 | Cs⁺:Na⁺ | 162 | 1.35 | 5.9 | 1.2 | 2.8 | 116 |
| | 2:1 | | | | | | |
| 12 | Cs⁺:Na⁺ | 144 | 1.34 | 4.6 | 1.4 | 2.1 | 113 |
| | 1:1 | | | | | | |
| 13 | Cs⁺:Na⁺ | 262 | 1.31 | 3.4 | 1.5 | 1.5 | 111 |
| | 1:3 | | | | | | |
| 14 | Cs⁺:Na⁺ | 266 | 1.15 | 3.1 | 2.3 | 1.2 | 107 |
| | 0:2 | | | | | | |
| 15 | Li⁺:Cs⁺ | 664 | 0.92 | 16.9 | 1.6 | 5.4 | 122 |
| | 2:0 | | | | | | |
| 16 | Li⁺:Cs⁺ | 636 | 1.03 | 18.4 | 1.3 | 6.6 | 123 |
| | 5:1 | | | | | | |
| 17 | Li⁺:Cs⁺ | 529 | 1.08 | 19.6 | 1.5 | 7.4 | 123 |
| | 3:1 | | | | | | |
| 18 | Li⁺:Cs⁺ | 522 | 1.14 | 19.1 | 1.3 | 7.6 | 120 |
| | 2:1 | | | | | | |
| 19 | Li⁺:Cs⁺ | 510 | 1.21 | 19.7 | 1.6 | 8.2 | 118 |
| | 1:1 | | | | | | |
| 20 | Li⁺:Cs⁺ | 161 | 1.41 | 20.6 | 1.6 | 10.1 | 118 |
| | 1:3 | | | | | | |
| 21 | Li⁺:Cs⁺ | 102 | 1.45 | 17.8 | 1.3 | 8.9 | 117 |
| | 0:2 | | | | | | |

^{a}The toluene:Et₂O ratio was 48:2 for Li⁺/Na⁺ and 47:3 for Cs⁺/Na⁺ and Li⁺/Cs⁺.
^{b}Determined by ¹H NMR spectroscopy.
^{c}Determined by GPC in trichlorobenzene at 160 ºC.
^{d}Measured using DSC.

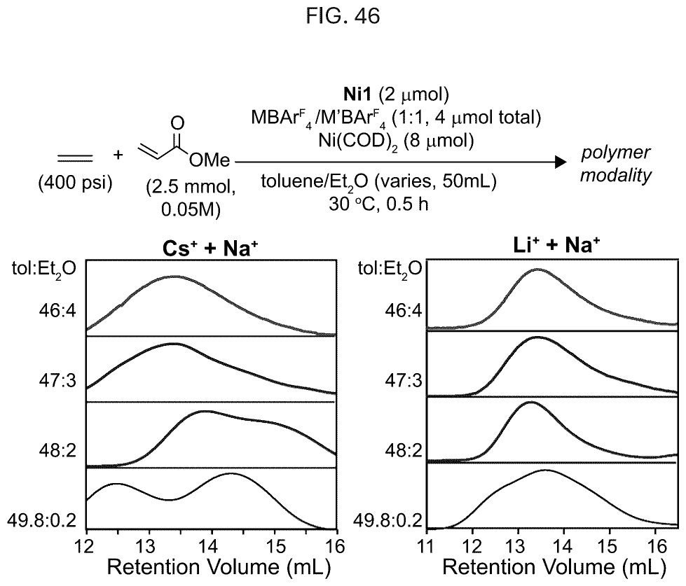

A possible complication with our approach is that polar monomers are also Lewis bases so they could potentially interfere with the coordination interactions that are crucial to cation-controlled polymerization. To determine if cation switching can occur in the presence of polar monomers, we performed ethylene and MA copolymerizations in different solvent mixtures (FIG. 46). When Ni1 was combined with CsBAr^{F}₄/NaBAr^{F}₄ (1:1 ratio, 1 equiv. each relative to Ni), Ni(COD)₂, ethylene, and MA under standard conditions, we obtained EMA with different MWD depending on the polarity of the solvent used. The gel permeation chromatograms (GPC) showed that the EMA obtained from reactions in 49.8:0.2 and 48:2 toluene/Et₂O mixtures were bimodal whereas those obtained from reactions in 47:3 and 46:4 toluene/Et₂O mixtures were monomodal (FIG. 46, bottom left). These results suggest that in non-polar solvents, cation exchange between Ni1-Cs and Ni1-Na is slow so polymer chain growth occurs from two distinct active species. As the solvent polarity is increased, each nickel catalyst switches continuously between two different states (Ni1/Cs⁺ and Ni1/Na⁺) during chain propagation so only a single polymer population is produced. When this study was conducted using Ni1 with LiBAr^{F}₄/NaBAr^{F}₄, similar results were obtained except that monomodal EMA was observed in the 48:2 toluene/Et₂O mixture (FIG. 46, bottom right). Because the minimum solvent polarity needed to achieve dynamic cation switching is dependent on the binding affinity of the specific cations to Ni1, different salt combinations will require different toluene/Et₂O mixtures. However, given that polar solvents (e.g., Et₂O) and polar monomers can serve as competing ligands, exceeding a certain concentration threshold will likely reduce the catalyst activity.

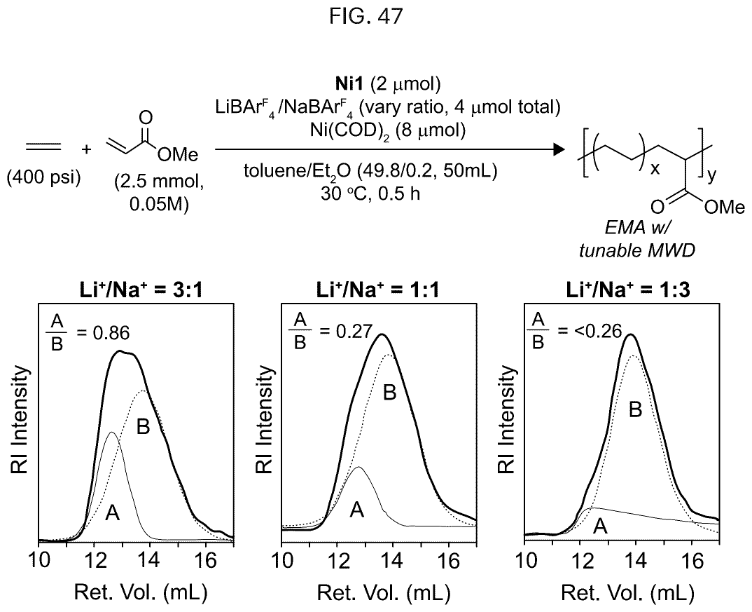

Precise Molecular Weight Distribution Tuning. Once we established that MA does not interfere with cation switching, we proceeded to demonstrate the utility of our method. To manipulate the copolymer MWD, we varied the Li⁺:Na⁺ ratio while keeping the Ni1, Ni(COD)₂, ethylene, and MA amounts constant in a 49.8:0.2 mixture of toluene/Et₂O (FIG. 47, Table 12A). Analysis of the resulting EMA revealed that in all cases, bimodal polymers were obtained, in which their MWD is skewed toward the higher molecular weight end if the ratio of Li⁺:Na⁺ was higher and vice versa. Deconvolution of the GPC obtained from the 3:1 Li⁺:Na⁺ reaction showed a higher molecular weight peak A and a lower molecular weight peak B with an integrated ratio A/B of 0.86. When the Li⁺:Na⁺ ratio was changed to 1:1 and 1:3, the A/B values dropped to 0.27 and <0.26, respectively. We were unable to fit the minor component (peak A) in the 1:3 Li⁺:Na⁺ data to a Gaussian distribution so the A/B value calculated is likely an upper limit. These results are consistent with our proposed mechanistic model (FIG. 45A) because using more Li⁺ relative to Na⁺ salt will favor the formation of higher MW producing Ni1-Li over the lower MW producing Ni1-Na(Table 1A).

Precise Molecular Weight and MA Incorporation Tuning. Monodispersed EMA can be tailored in several ways: 1) vary both the MW and MA incorporation; 2) vary the MW but keep the MA incorporation the same; or 3) vary the MA incorporation but keep the MW the same. A desired copolymer can be made-to-order as long as the target parameters fall within the ranges allowable by Ni1-M and Ni1-M′.

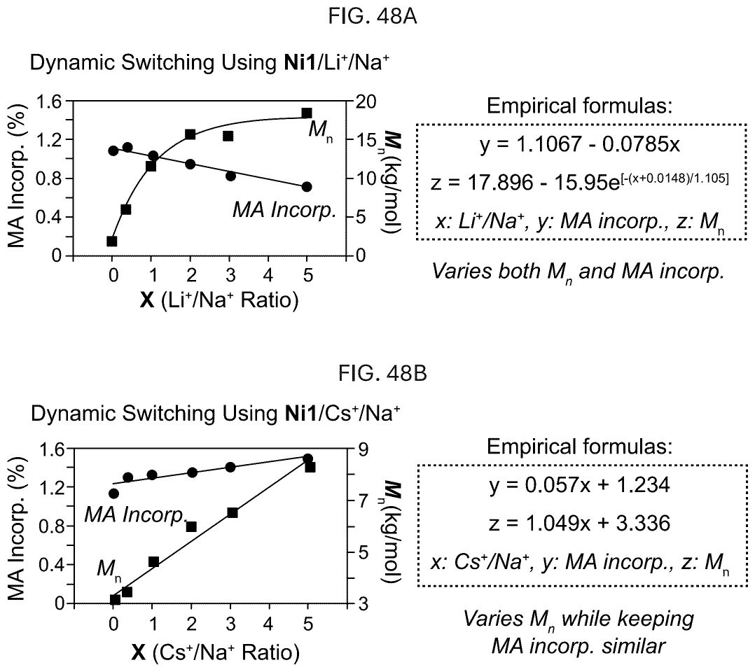

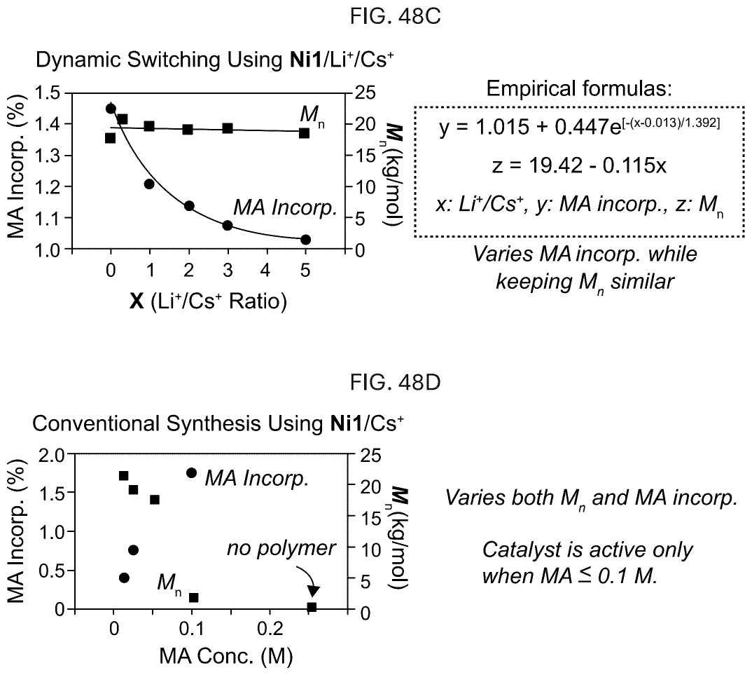

To achieve option 1, we used Li⁺ and Na⁺ salts with Ni1 because the corresponding Ni1-Li and Ni1-Na species afford EMA with different molecular weight and MA incorporation (Table 2A, entries 2-6). The copolymerizations were performed in 48:2 toluene:Et₂O to promote fast cation exchange. When greater amounts of Li⁺ were added relative to Na⁺, the EMA molecular weight increased gradually from ˜6 to 18 kg/mol whereas the MA incorporation decreased gradually from ˜1.1 to 0.7 mol % (FIG. 48A). The monomodal distributions (FIG. 63) and polymer dispersities of <2.0 strongly suggest that the products were generated by a single active species, which supports our dynamic cation switching polymerization mechanism (FIG. 45B). To achieve option 2, we paired Ni1 with Cs⁺ and Na⁺ salts (toluene/Et₂O=47:3) because the Ni1-Cs and Ni1-Na species formed will produce EMA with different MW but similar MA incorporation (Table 2A, entries 9-13). Our data showed that increasing the Cs:Na⁺ ratio increased the EMA molecular weight from ˜3 to 8 kg/mol while keeping the MA incorporation within a narrow range (Δ incorp.=0.2 mol % going from 1:3 to 5:1 Cs⁺:Na⁺) (FIG. 48B). Finally, to achieve option 3, a combination of Li⁺ and Cs⁺ cations were used with Ni1 (toluene/Et₂O)=47:3) because the resulting Ni1-Li and Ni1-Cs generated will yield EMA with similar MW but different MA incorporation. As shown in FIG. 48C, increasing Li⁺ relative to Cs⁺ generated copolymers featuring an average Mₙ of ˜19 kg/mol but decreasing MA incorporation from 1.4 to 1.0 mol % (Table 2A, entries 16-20).

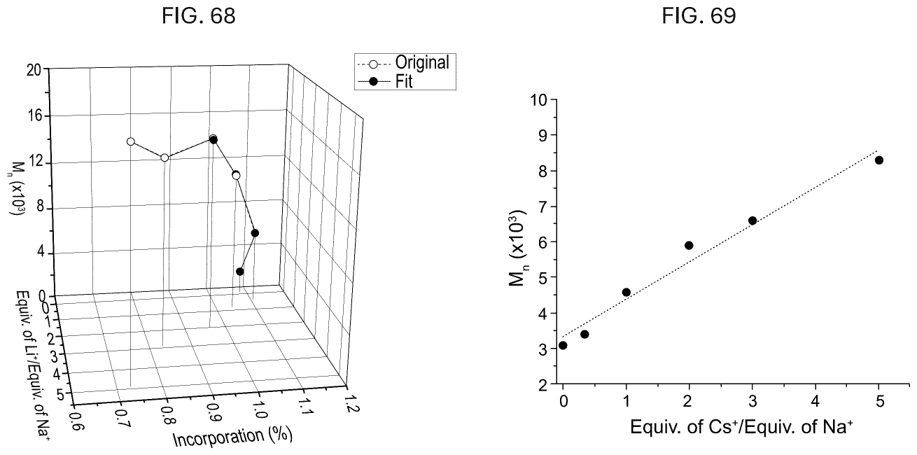

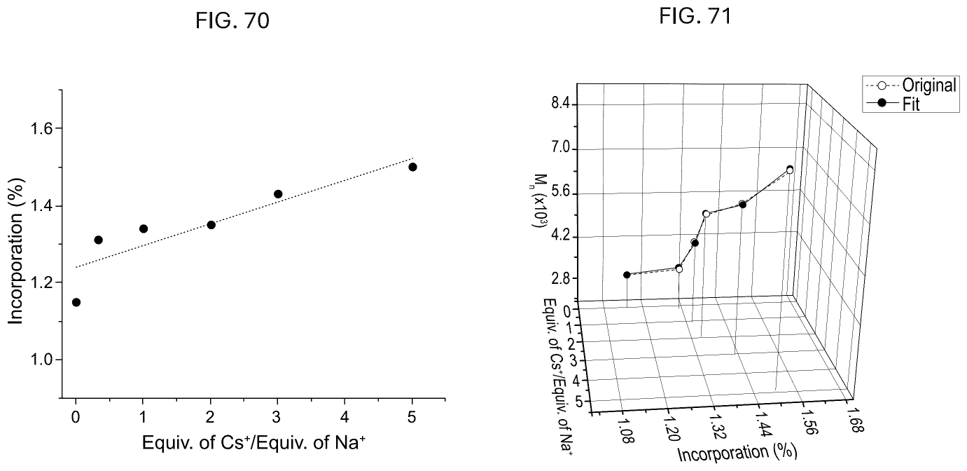

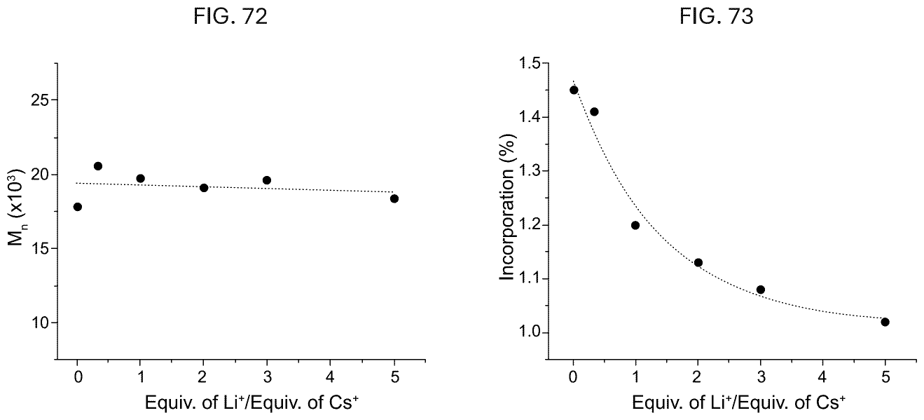

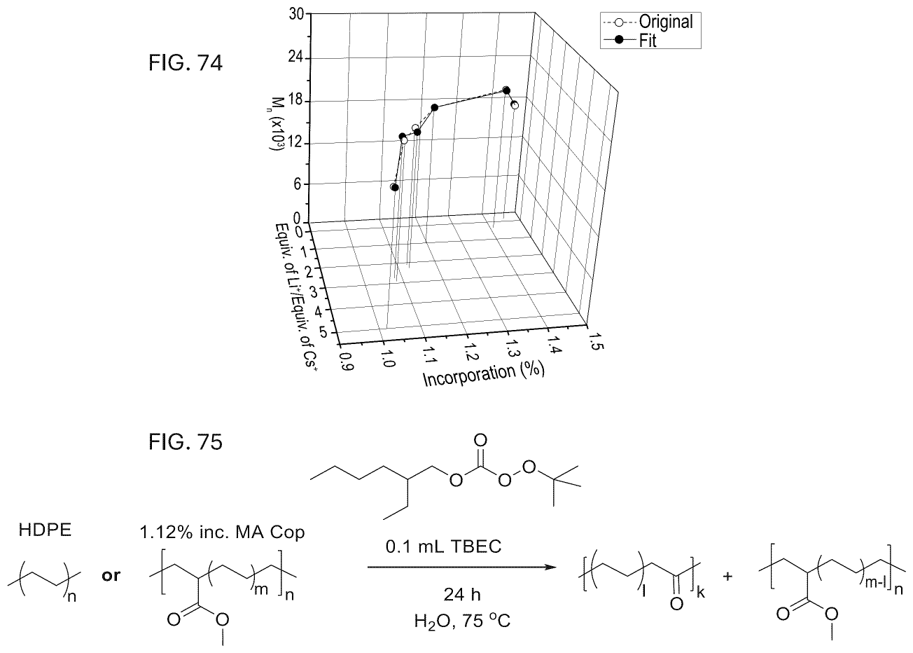

The data above were fit to mathematical functions, providing empirically derived formulas for calculating the amount of M⁺ and M′ salts needed to obtain copolymers with a specific set of characteristics (FIG. 48A-FIG. 48C) (Tran, T. V.; Lee, E.; Nguyen, Y. H.; Nguyen, H. D.; Do, L. H. Customizing Polymers by Controlling Cation Switching Dynamics in Non-Living Polymerization. J. Am. Chem. Soc. 2022, 144, 17129-17139). Equations correlating z (Mₙ) with x (M⁺/M′⁺ molar fraction) and y (MA incorporation) with x were determined for each Ni1/M⁺/M′⁺ combination. We found that it was possible to relate all three variables, x, y, and z, with three-dimensional exponential and/or polynomial equations. These fits are given in FIG. 68, FIG. 71, and FIG. 74. Although theoretical modeling of the experimental data may be possible, it would be difficult given that the rates of various elementary steps and cation association/dissociation processes are needed to fully describe the polymerization process. These empirical relationships are useful because they allow prediction of the polymer products attainable using any combination of Ni1/M⁺/M′⁺ that has been tested (Table 19A).

To compare the effectiveness of our strategy vs. that of a conventional approach to customize EMA, we carried out ethylene and MA copolymerization using Ni1-Cs under standard conditions but with varying concentrations of the polar monomer (FIG. 48D, Table 20A). We observed that increasing the MA concentration from 0.01 to 0.10 M afforded EMA with decreasing molecular weight (21 to 6 kg/mol) but increasing MA incorporation (0.42 to 1.77 mol %). The inverse relationship between polymer MW and MA incorporation is expected because the presence of greater amounts of acrylates induces faster chain termination (Xiong, S., Hong, A.; Ghana, P.; Bailey, B. C.; Spinney, H. A., Bailey, H.; Henderson, B. S.; Marshall, S.; Agapie, T. Acrylate-Induced β-H Elimination in Coordination Insertion Copolymerizaton Catalyzed by Nickel. J. Am. Chem. Soc. 2023, 145, 26463-26471). At higher MA concentration, the Ni1-Cs activity dropped significantly, from 532 to 46 kg/mol·h. When 0.25 M methyl acrylate was used, the catalyst was completely inactive. These results are consistent with previous studies showing that polar monomers can inhibit polymerization through engaging in σ interactions with the metal catalyst (Carrow, B. P.; Nozaki, K. Transition-Metal-Catalyzed Functional Polyolefin Synthesis: Effecting Control Through Chelating Ancillary Ligand Design and Mechanistic Insights. Macromolecules 2014, 47, 2541-2555). Because our strategy does not require changing the MA concentration to adjust the polymer composition, moderate to high activities (>100 kg/mol·h) were obtained in our copolymerizations (Table 2A).

Although the “tunable range” in these experiments is somewhat narrow (e.g., Mₙ between ˜3 to 8 kg/mol using Cs⁺/Na⁺ and MA incorporation between 1.0 to 1.4 mol % using Li⁺/Cs⁺), this restriction is due to limitations of the Ni1 catalyst itself rather than the polymerization method. We expect that Ni2, (Tran, T. V.; Lee, E.; Nguyen, Y. H.; Nguyen, H. D.; Do, L. H. Customizing Polymers by Controlling Cation Switching Dynamics in Non-Living Polymerization. J. Am. Chem. Soc. 2022, 144, 17129-17139) which can give polyethylene with Mₙ of >1000 kg/mol in the presence of Cs⁺, will likely enable access to EMA with a wider range of molecular weights compared to Ni1. However, such studies are beyond the scope of this work, which is focused on establishing proof-of-concept.

TABLE 3A
Polymer Characterization Data (Averaged)^{a}

| | | MA | | Elong. | Tensile | Contact | |
|---|---|---|---|---|---|---|---|
| | Inc. | per | Mₙ | at Break | Strength | Angle | |
| Polymer | (%) | chain | (kg/mol) | (%) | (MPa) | (°) | PI |
| PE-1 | 0 | 0 | 19 | 9.2 | 19.7 | 107.8 | 5 |
| EMA-1 | 0.8 | 6.6 | 23 | 10.4 | 23.2 | 99.6 | 7.9 |
| EMA-2 | 1.1 | 7.8 | 20 | 10.5 | 21.2 | 97.8 | 7.6 |
| EMA-3 | 1.4 | 10.5 | 21 | 8.4 | 20.1 | 94.0 | 16.4 |

^{a}Values shown are the average from two independently prepared samples with similar MA incorporation and Mₙ. The maximum standard deviations is ±0.1 mol % for MA incorporation and ±2 kg/mol for MW. See Table 24A for more details. PI = peroxide index.

Polymer Properties. Because we were able to synthesize EMA with controlled MW and MA incorporation, it allowed us to systematically study their structure-function relationships. To measure the melting (Tₘ) and 5% mass loss (Ts) temperatures, differential scanning calorimetry (DSC) and thermal gravimetric analysis (TGA) were used, respectively. Our data revealed that the polymer's thermal properties were more dependent on its chain length than polar group density (i.e., when the MA incorporation is low). For example, lowering the EMA molecular weight from 8 to 3 kg/mol while keeping MA density constant led to a maximum reduction in Tₘ by 6° C. and Ts by 48° C. (Table 15A and Table 16A). In contrast, increasing the MA incorporation from 1.0 to 1.4 mol % while maintaining a similar MW, resulted in small changes to the EMA's thermal parameters (max ΔTₘ=˜5° C. and ΔT₅=˜9° C.) (Table 17A and Table 18A).

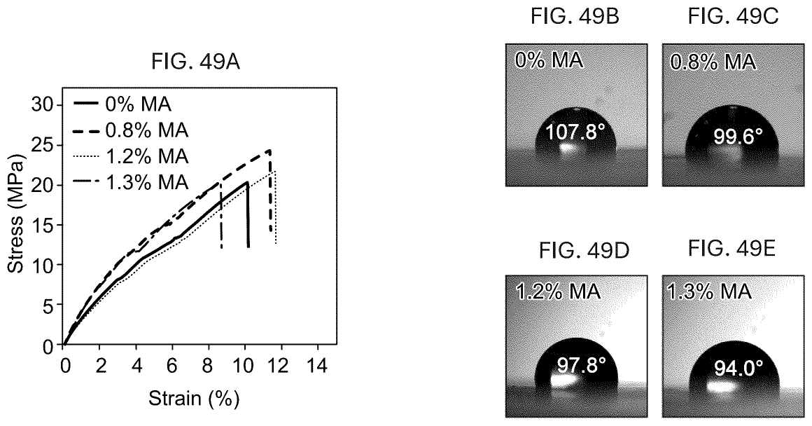

Next, we investigated the physical properties of the copolymers as a function of MA. All measurements were performed on polymers with an average molecular weight of ˜20 kg/mol and average MA incorporation of 0 (PE-1), 0.8 (EMA-1), 1.1 (EMA-2), and 1.4 mol % (EMA-3) (Table 3A). The polymer specimens were molded into a T-bone shape and then subjected to tensile testing. The stress vs. strain curves (FIG. 49A) showed that all of the materials evaluated have similar mechanical properties, with elongation at break ranging from 8-10% and tensile strength between 19-23 MPa. These values are typical for high-density polyethylene, which can range from 3-1900% and 3-60 MPa for elongation-at-break and tensile strength, respectively. Our results indicate that the presence of small amounts of MA in the polymer chain has negligible impact on its mechanical properties.

To determine the wettability of the polymer samples, their water contact angles were measured using a static drop method at 25° C. (FIG. 49B-FIG. 49E) (Huhtamaki, T.; Tian, X.; Korhonen, J. T.; Ras, R. H. A. Surface-wetting characterization using contact-angle measurements. Nat. Protoc. 2018, 13, 1521-1538; Hebbar, R. S.; Isloor, A. M.; Ismail, A. F. Chapter 12-Contact Angle Measurements. In Membrane Characterization; Hilal, N., Ismail, A. F., Matsuura, T., Oatley-Radcliffe, D., Eds.; Elsevier: 2017, p 219-255). We found that PE-1 had an average contact angle of 107.8°, which is within the range expected for polyethylene (Wang, W.; Nie, N.; Xu, M.; Zou, C. Lewis acid modulation in phosphorus phenol nickel catalyzed ethylene polymerization and copolymerization. Polym. Chem. 2023, 14, 4933-4939; Na, Y.; Chen, C. Catechol-Functionalized Polyolefins. Angew. Chem. Int. Ed. 2020, 59, 7953-7959). When the methyl acrylate content increased to 7 (EMA-1), 8 (EMA-2), and 10 (EMA-3) units per chain, the water contact angle decreased to 99.6, 97.8, and 94.0°, respectively (Table 3A), indicating that the EMA-coated surface became increasingly more polar. Having enhanced wettability is a desirable trait because it can improve a polymer's adhesiveness and compatibility with other materials (Kruszynski, J.; Nowicka, W.; Pasha, F. A., Yang, L., Rozanski, A.; Bouyahyi, M.; Kleppinger, R.; Jasinska-Walc, L., Duchateau, R. Tuning the Adhesive Strength of Functionalized Polyolefin-Based Hot Melt Adhesives: Unexpected Results Leading to New Opportunities. Macromolecules 2025, ASAP; Brewis, D. M.; Briggs, D. Adhesion to polyethylene and polypropylene. Polymer 1981, 22, 7-16; Shiraki, Y.; Saito, M.; Yamada, N. L.; Ito, K.; Yokoyama, H. Adhesion to Untreated Polyethylene and Polypropylene by Needle-like Polyolefin Crystals. Macromolecules 2023, 56, 2429-2436; Rusanova, S. N.; Sof'ina, S. Y.; Khuzakhanov, A. R.; Kolpakova, M. V.; Stoyanov, O. V. Adhesion Properties of Polyethylene and Ethylene-Vinyl Acetate Copolymer Blend with Acrylate Copolymers of Ethylene. Polym. Sci. Ser. D 2022, 15, 494-498).

Polymer Degradability. It has been shown that functional polyolefins can be degraded under oxidative conditions (Lu, B.; Takahashi, K.; Zhou, J.; Nakagawa, S.; Yamamoto, Y.; Katashima, T.; Yoshie, N.; Nozaki, K. Mild Catalytic Degradation of Crystalline Polyethylene Units in a Solid State Assisted by Carboxylic Acid Groups. J. Am. Chem. Soc. 2024, 146, 19599-19608) but quantitative correlations between the polar group density and polymer degradability have not yet been established. Studying such relationships requires access to copolymers with the same MW that vary only in their polar group content to prevent conflating other factors that may contribute to degradability. With our newly synthesized polymers in hand, we had the opportunity to investigate how the presence of functional groups in polyolefins influence their susceptibility toward oxidative degradation (Ballard, D. G. H.; Dawkins, J. V. Catalytic oxidative degradation of polyethylene crystals. Eur. Polym. J. 1974, 10, 829-835; Qin, H.; Zhao, C.; Zhang, S.; Chen, G.; Yang, M. Photo-oxidative degradation of polyethylene/montmorillonite nanocomposite. Polym. Degrad. Stabil. 2003, 81, 497-500; Hakkarainen, M.; Albertsson, A.-C. Environmental Degradation of Polyethylene. In Long Term Properties of Polyolefins; Albertsson, A.-C., Ed.; Springer Berlin Heidelberg: Berlin, Heidelberg, 2004, p 177-199). Although a variety of methods are available to cleave the inert C—C bonds in polyolefins, such as thermal cracking, (Ahmad, I.; Khan, M. L., Khan, H.; Ishaq, M.; Tariq, R.; Gul, K.; Ahmad, W. Pyrolysis Study of Polypropylene and Polyethylene Into Premium Oil Products. Int. J. Green Energy 2015, 12, 663-671; Miandad, R.; Barakat, M. A.; Aburiazaiza, A. S.; Rehan, M.; Ismail, I. M. I.; Nizami, A. S. Effect of plastic waste types on pyrolysis liquid oil. Int. Biodeter. Biodegr. 2017, 119, 239-252; Kosloski-Oh, S. C.; Wood, Z. A.; Manjarrez, Y.; de los Rios, J. P.; Fieser, M. E. Catalytic methods for chemical recycling or upcycling of commercial polymers. Mater. Horiz. 2021, 8, 1084-1129) dehydrogenation/metathesis, (Arroyave, A.; Cui, S.; Lopez, J. C.; Kocen, A. L.; LaPointe, A. M.; Delferro, M.; Coates, G. W. Catalytic Chemical Recycling of Post-Consumer Polyethylene. J. Am. Chem. Soc. 2022, 144, 23280-23285) or dehydrogenation/isomerization/enthenolysis, (Conk, R. J.; Hanna, S.; Shi, J. X., Yang, J.; Ciccia, N. R.; Qi, L.; Bloomer, B. J.; Heuvel, S.; Wills, T.; Su, J.; Bell, A. T.; Hartwig, J. F. Catalytic deconstruction of waste polyethylene with ethylene to form propylene. Science 2022, 377, 1561-1566; Wang, N. M.; Strong, G.; DaSilva, V.; Gao, L.; Huacuja, R.; Konstantinov, I. A.; Rosen, M. S.; Nett, A. J.; Ewart, S.; Geyer, R.; Scott, S. L.; Guironnet, D. Chemical Recycling of Polyethylene by Tandem Catalytic Conversion to Propylene. J. Am. Chem. Soc. 2022, 144, 18526-18531) they typically require high temperatures (>150° C.) and/or precious metal catalysts.

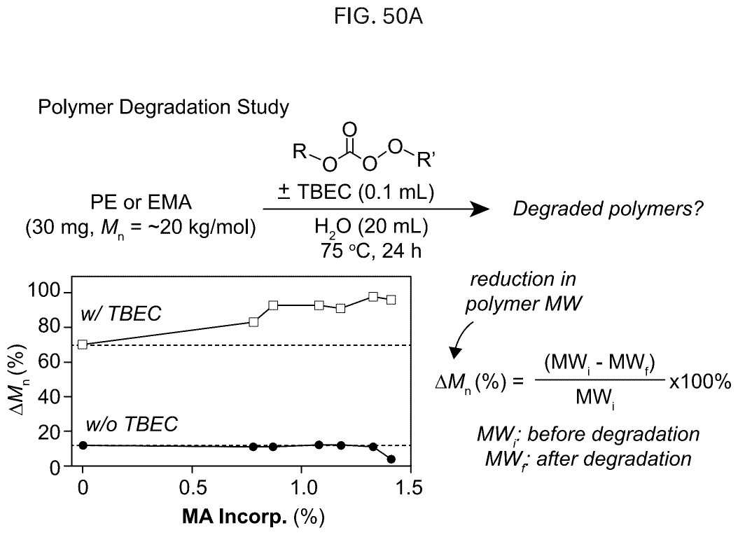

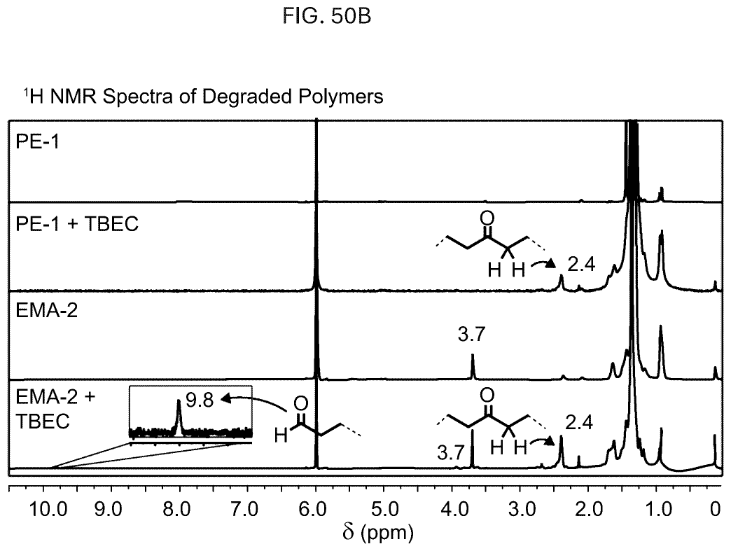

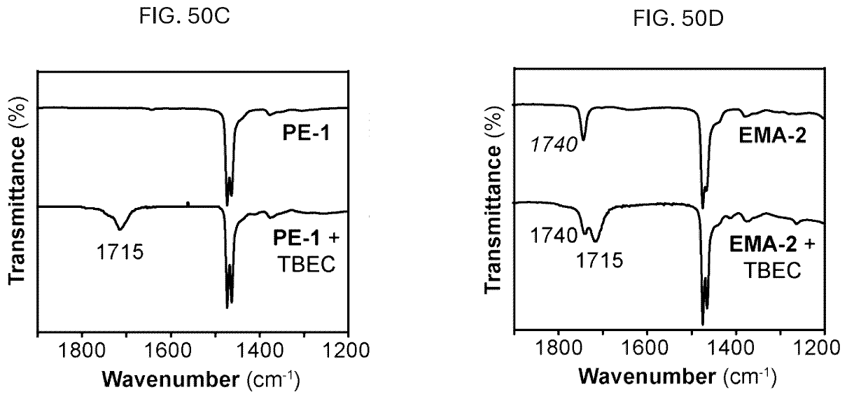

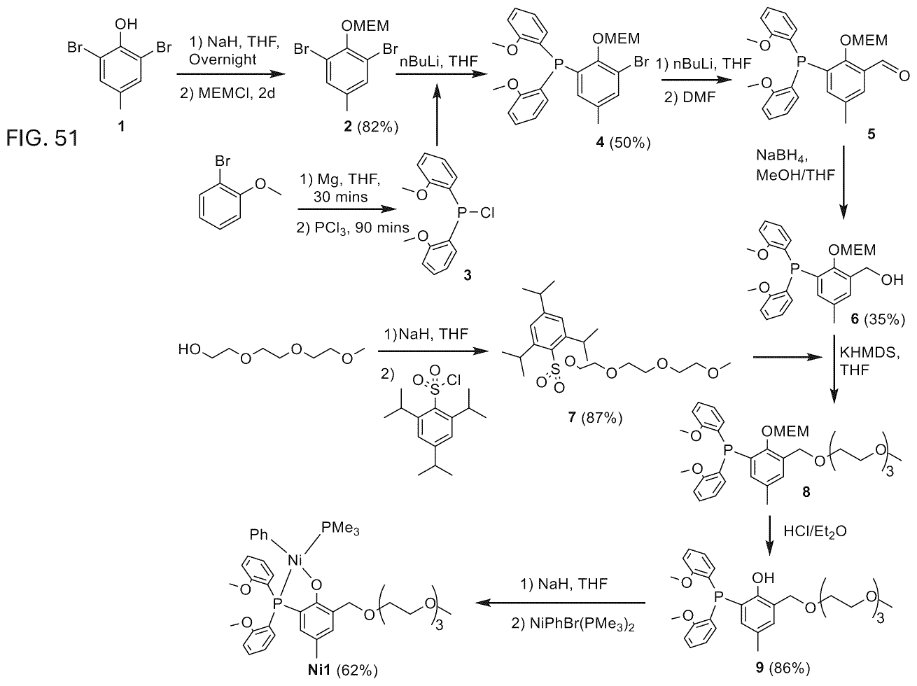

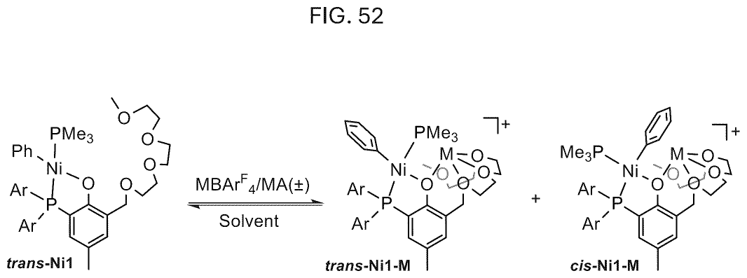

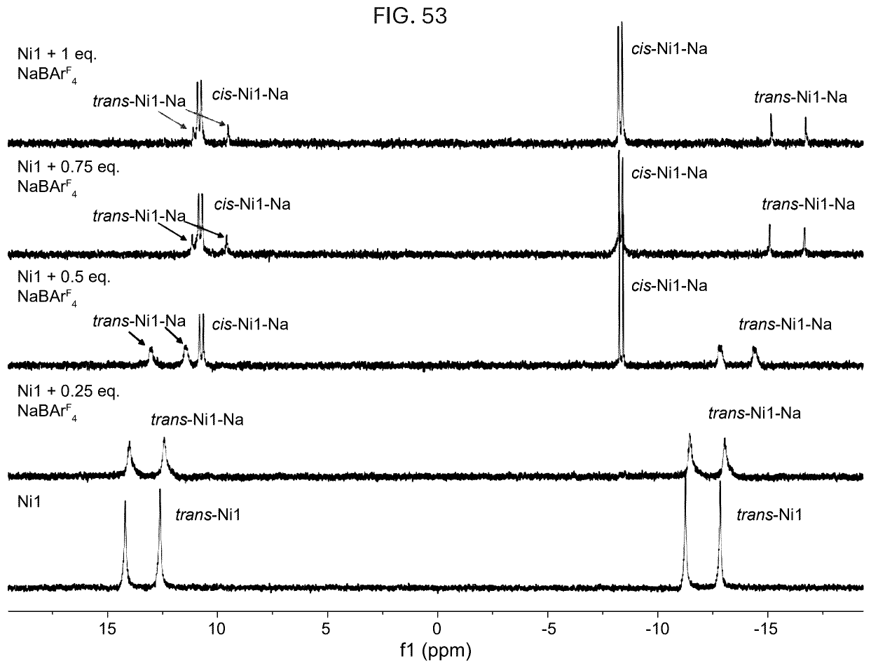

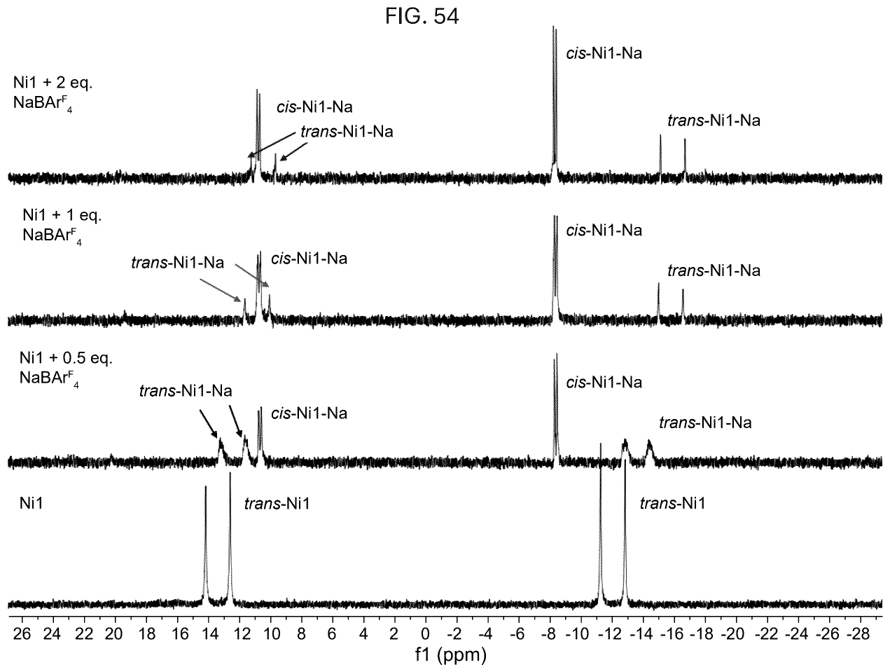

Inspired by reports on the reactions of chemical oxidants with polyethylene, (Garrett, G. E.; Mueller, E.; Pratt, D. A.; Parent, J. S. Reactivity of Polyolefins toward Cumyloxy Radical: Yields and Regioselectivity of Hydrogen Atom Transfer. Macromolecules 2014, 47, 544-551; Yolsal, U.; Neal, T. J.; Richards, J. A.; Royer, J. R.; Garden, J. A. A versatile modification strategy to enhance polyethylene properties through solution-state peroxide modifications. Polym. Chem. 2024, 15, 1399-1412; Bremner, T.; Rudin, A. Peroxide modification of linear low-density polyethylene: A comparison of dialkyl peroxides. J. App. Polym. Sci. 1993, 49, 785-798) we focused on developing polymer degradation methods that can be performed under mild conditions. We found that stirring PE-1, EMA-1, EMA-2, or EMA-3 in the presence of tert-butylperoxy 2-ethylhexyl carbonate (TBEC) in H₂O at 75° C. for 24 h was sufficient to promote polymer degradation (FIG. 50A). The solid products were isolated by filtration, washed with water and acetone, and then dried overnight. The recovered mass was up to ˜90% of the starting mass (Table 23A), suggesting that the material isolated represents the bulk of the TBEC-treated products. To determine the extent of degradation, we analyzed the products by GPC and calculated the reduction in molecular weight percentage (ΔMₙ) using the formula: (MWᵢ−MW_{f})/MWᵢ×100%, in which MWᵢ is the initial molecular weight and MW_{f} is the final molecular weight (Table 23A). In the absence of peroxide, the ΔMₙ did not exceed ˜15% regardless of whether the polymer contained MA (FIG. 50A). In contrast, the addition of TBEC to the reactions led to significant changes in polymer molecular weight. For example, PE-1 had an average ΔMₙ value of 74% and EMA-1, EMA-2, and EMA-3 had average ΔMₙ values of 88, 92, and 97%, respectively. The peroxide indices (PI), defined as ΔMₙ in the presence of peroxide divided by ΔMₙ in the absence of peroxide, were 5.0, 7.9, 7.6, and 12.9, respectively (Table 3A). These results indicated that: 1) appreciable polymer degradation occurred under oxidative conditions and 2) the polymer degradation efficiency was enhanced upon introducing more MA per chain, for example, requiring only 1-3 units to achieve measurable effects.

The TBEC-treated polymers were further characterized to determine their composition. ¹H NMR spectroscopic analysis of the degraded PE-1 product showed a new peak at ˜2.4 ppm that was assigned to α-keto hydrogens (˜0.75 mol %; FIG. 50B) (Lu, B.; Takahashi, K.; Zhou, J., Nakagawa, S.; Yamamoto, Y.; Katashima, T.; Yoshie, N., Nozaki, K. Mild Catalytic Degradation of Crystalline Polyethylene Units in a Solid State Assisted by Carboxylic Acid Groups. J. Am. Chem. Soc. 2024, 146, 19599-19608). The ¹H NMR spectrum of degraded EMA-2 exhibited new peaks at 2.4 and 9.8 ppm, which were attributed to α-keto (˜1.0 mol %) and aldehyde (<0.1 mol %) hydrogens, respectively (FIG. 50B). The MA content in degraded EMA-2 dropped to from ˜1.1 to 0.5 mol %. Signals corresponding to C—H hydrogens from alcohol moieties (˜3.6 ppm) were not detected in any of the samples. To support the NMR spectral assignments, we also measured the infrared (IR) spectra of the degraded polymers. Comparison of the vibrational data for PE-1 before and after treatment with TBEC, revealed a new peak at 1715 cm⁻¹ that corresponds to the C═O stretch of ketone groups (FIG. 50C). The IR spectrum of degraded EMA-2 also exhibited a ketone peak at 1715 cm⁻¹, along with an ester peak at 1740 cm⁻¹, suggesting that some of the methyl ester groups were intact (FIG. 50C) (Huang, N.; Wang, J. A TGA-FTIR study on the effect of CaCO₃ on the thermal degradation of EBA copolymer. J. Anal. Appl. Pyrol. 2009, 84, 124-130). Although the NMR data suggest that degraded EMA-2 may contain aldehyde groups, their low concentration within the polymer chain likely eluded their detection by IR spectroscopy. The presence of O—H stretches between ˜2500-3500 cm⁻¹ corresponding to alcohol or carboxylic acid moieties were not observed.

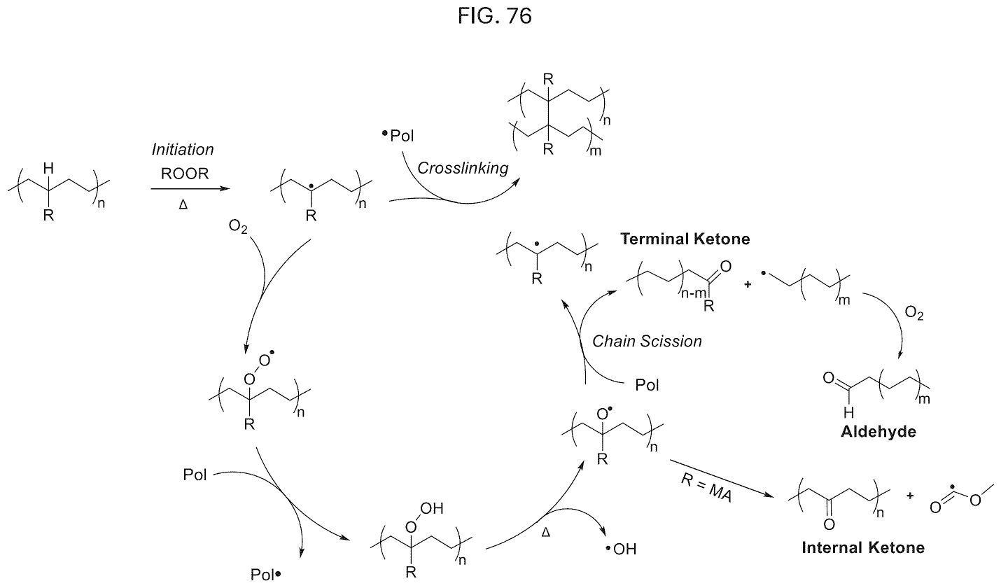

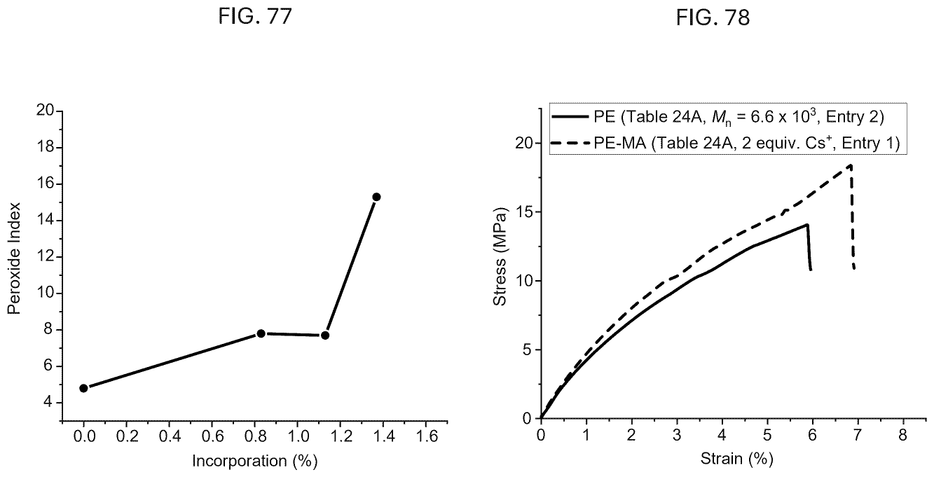

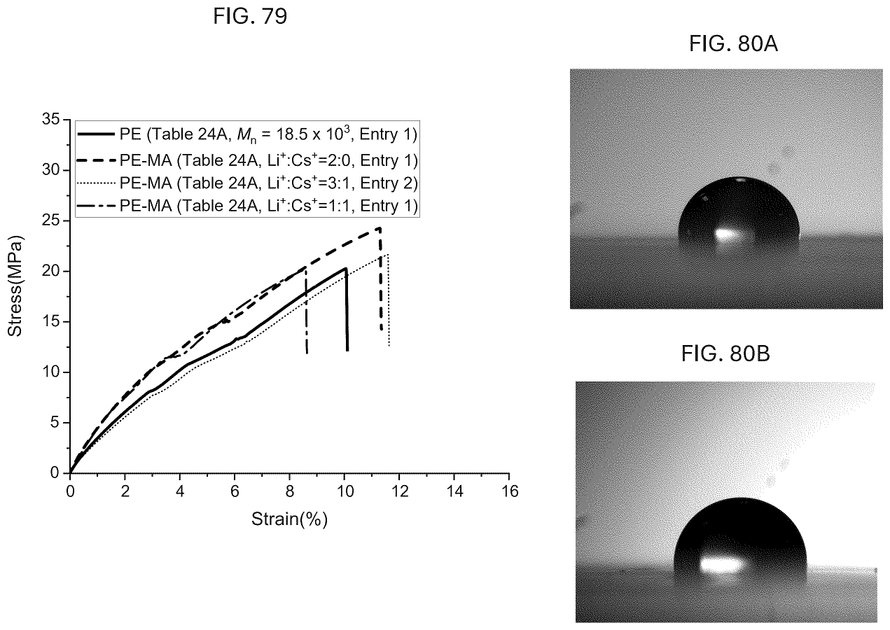

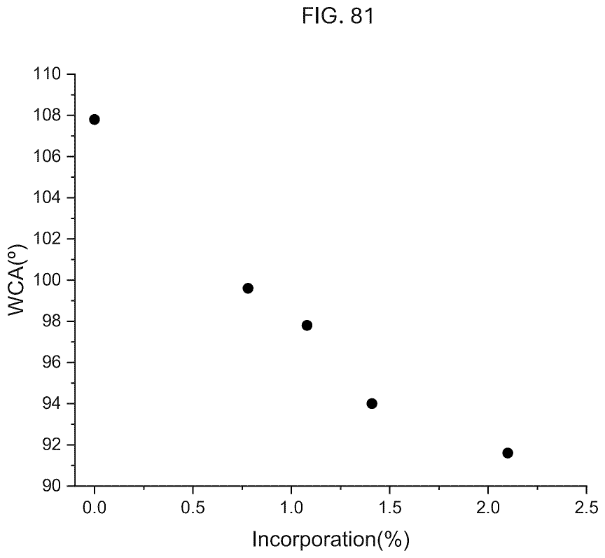

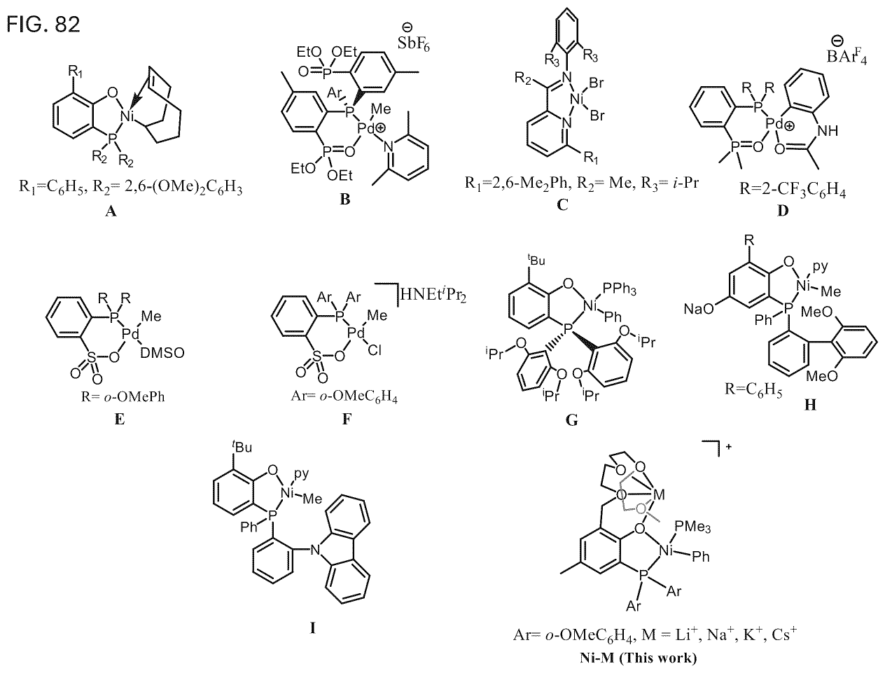

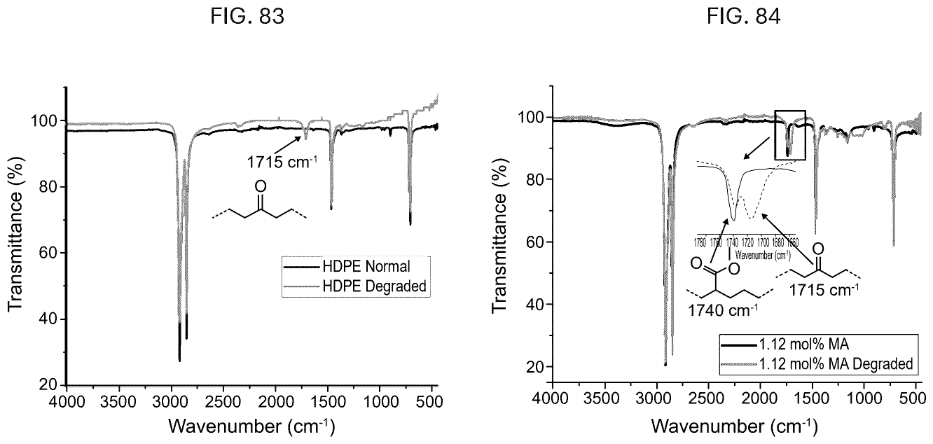

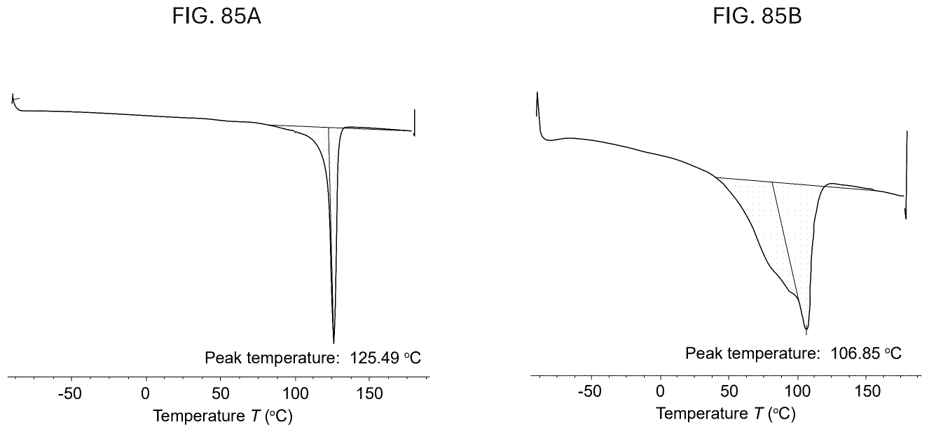

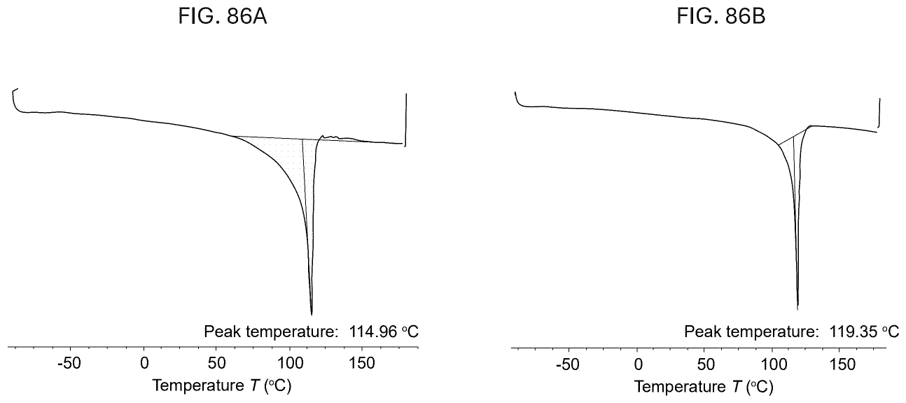

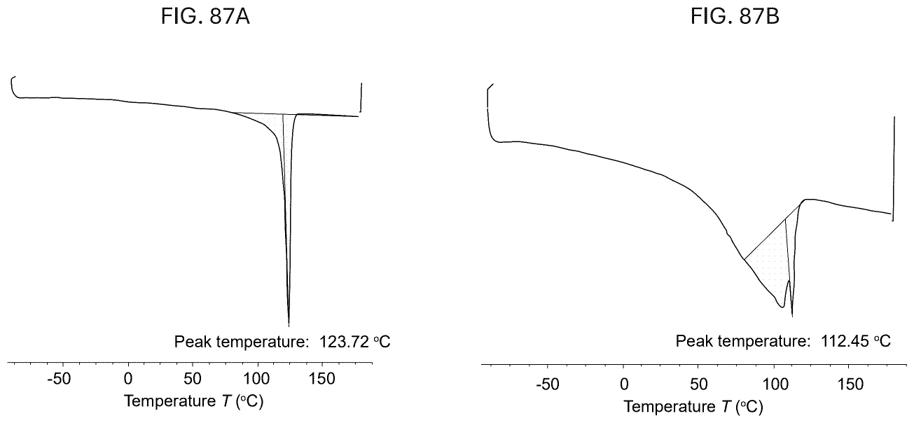

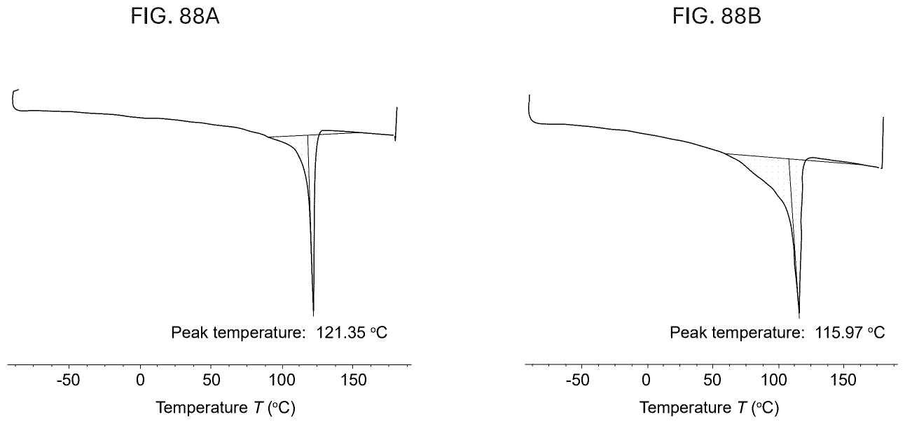

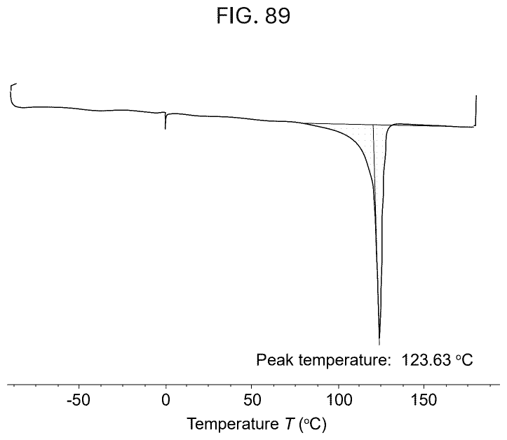

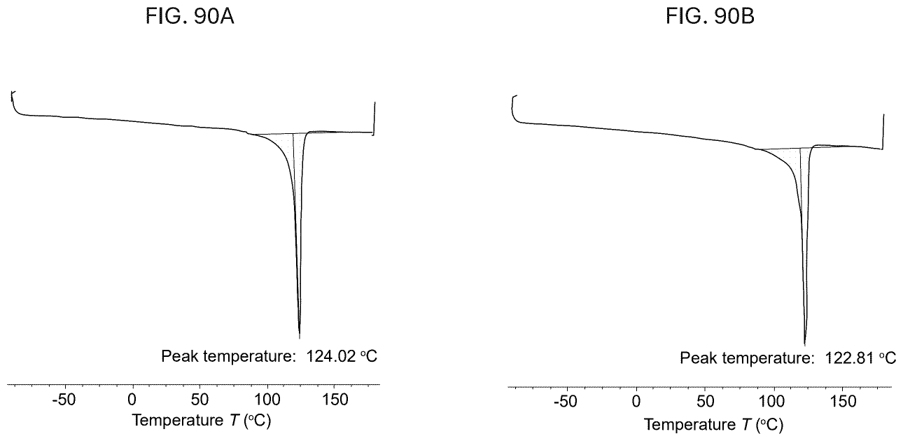

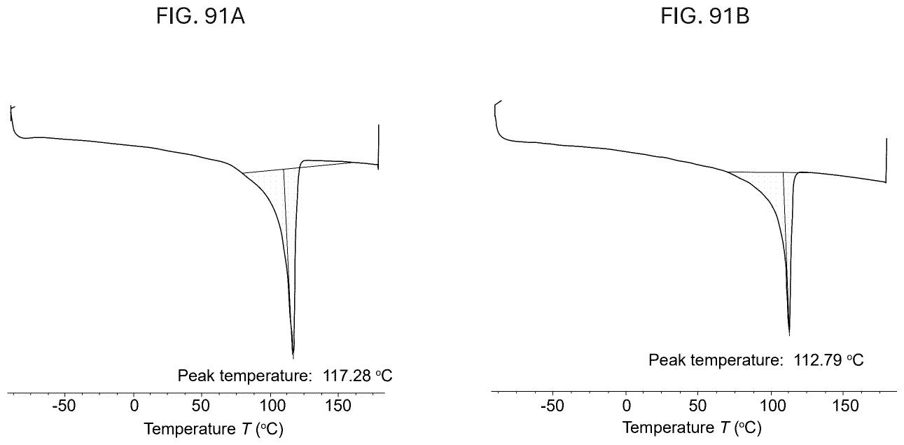

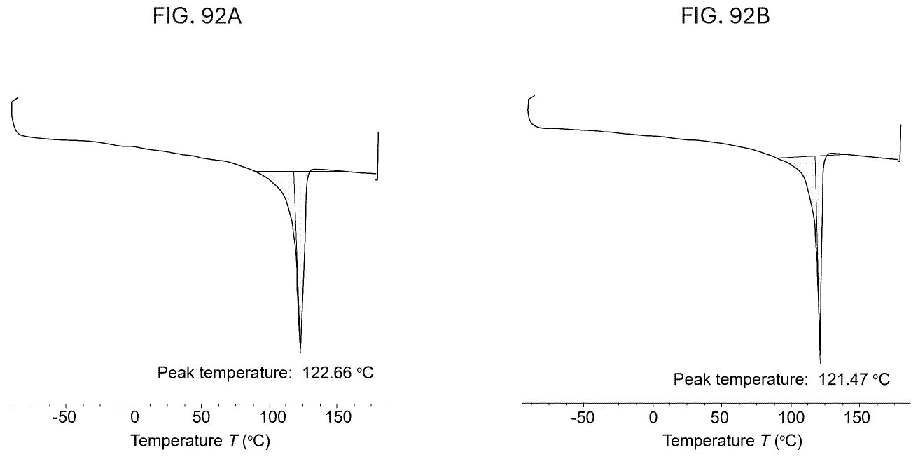

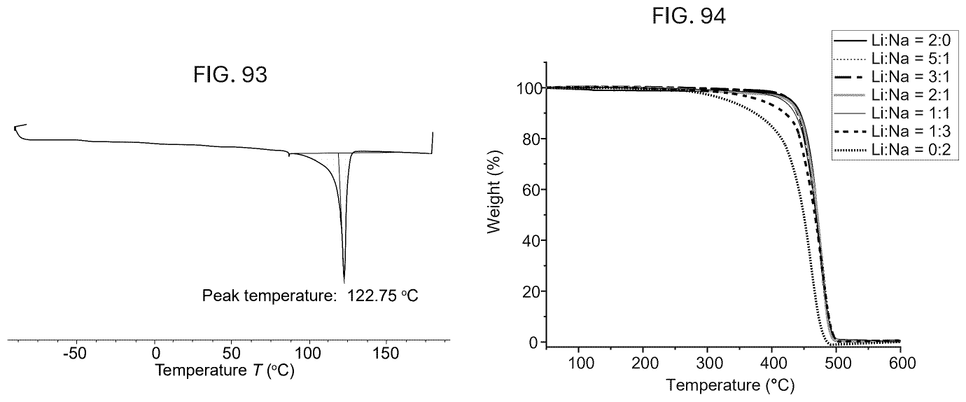

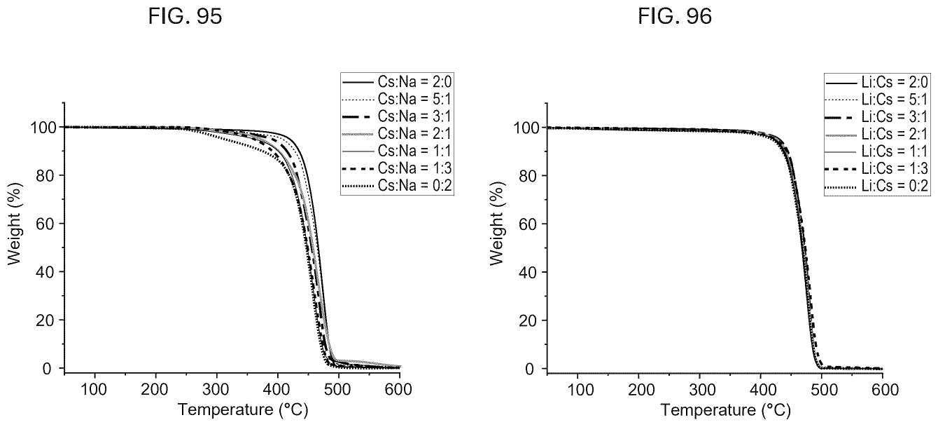

Based on other studies of polymer degradation, the products observed suggest that TBEC-induced chain scission likely proceeded through a radical oxidation mechanism (FIG. 76) (Gryn'ova, G., Hodgson, J. L., Coote, M. L. Revising the mechanism of polymer autooxidation. Org. Biomol. Chem. 2011, 9, 480-490; Bracco, P.; Costa, L.; Luda, M. P.; Billingham, N. A review of experimental studies of the role of free-radicals in polyethylene oxidation. Polym. Degrad. Stabil. 2018, 155, 67-83). Such sequences are typically initiated by H-atom abstraction by a reactive oxygen species, (Garrett, G. E.; Mueller, E.; Pratt, D. A.; Parent, J. S. Reactivity of Polyolefins toward Cumyloxy Radical: Yields and Regioselectivity of Hydrogen Atom Transfer. Macromolecules 2014, 47, 544-551) followed by propagation involving oxygenation and homolytic O—O or C—C bond scission. Because the polymer MW in our experiments do not increase, cross-linking through reaction of two radical chains does not appear to occur. Unlike work reported by Nozaki and coworkers on the use of dioxygen, a cerium catalyst, and visible light to degrade carboxylated polyethylene, which generated products with ketone, aldehyde, alcohol, and carboxylic acid groups, (Lu, B.; Takahashi, K., Zhou, J.; Nakagawa, S.; Yamamoto, Y.; Katashima, T.; Yoshie, N.; Nozaki, K. Mild Catalytic Degradation of Crystalline Polyethylene Units in a Solid State Assisted by Carboxylic Acid Groups. J. Am. Chem. Soc. 2024, 146, 19599-19608) our TBEC-based method afforded products with only ketone and minor amounts of aldehyde in EMA. We hypothesize that the enhanced degradability of EMA relative to that of PE is due to the weakening of the C—H and C—C bonds in close proximity to the polar group, which makes undergoing radical reactions more facile. The high mass recovery in our degradation studies suggests that overoxidation to CO₂ is suppressed. Further mechanistic studies are needed to obtain a deeper understanding of this peroxide facilitated cleavage process. To add value to the degraded PE and EMA products, it may be possible to convert them to paraffin waxes (C₂₀-C₃₀) (Speight, J. G. Chapter 3-Hydrocarbons from Petroleum. In Handbook of Industrial Hydrocarbon Processes; Speight, J. G., Ed.; Gulf Professional Publishing: Boston, 2011, p 85-126) or cross-link them with reversible linkers (e.g., by using α,ω-diaminoalkane to condense with the carbonyl groups in the degraded polymers) to construct chemically-recyclable materials (Fortman, D. J.; Brutman, J. P.; De Hoe, G. X.; Snyder, R. L.; Dichtel, W. R.; Hillmyer, M. A. Approaches to Sustainable and Continually Recyclable Cross-Linked Polymers. ACS Sustain. Chem. Eng. 2018, 6, 11145-11159; Hong, M.; Chen, E. Y. X. Chemically recyclable polymers: a circular economy approach to sustainability. Green Chem. 2017, 19, 3692-3706). Additionally, the ketone groups can be converted to esters through Baeyer-Villager oxidation or treated with hydroxylamine to form amides via Beckman rearrangement (Lemmens, R., Vercammen, J., Van Belleghem, L.; De Vos, D. Upcycling polyethylene into closed-loop recyclable polymers through titanosilicate catalyzed C—H oxidation and in-chain heteroatom insertion. Nat. Commun. 2024, 15, 9188).

### Conclusions

In summary, we have developed a method using dynamic cation switching polymerization to obtain ethylene and alkyl acrylate copolymers with exceptional precision. Our studies showed that the presence of up to 0.05 M methyl acrylate did not negatively impact cation exchange between alkali ions and Ni1, suggesting that this catalyst system is compatible with polar monomers. We demonstrated that the Ni1-M complexes are active for ethylene and alkyl acrylate (MA, EA, or BA) copolymerization, with Ni1-Li exhibiting high activity comparable to that of the best-performing catalysts reported in the literature. Using Ni1 and a mixture of M⁺ and M′ salts, we synthesized EMA with different MWD depending on the solvent polarity (e.g., 49.8:0.2 toluene/Et₂O gave bimodal EMA whereas 47:3 toluene/Et₂O gave monomodal EMA) and M⁺:M′⁺ ratio. To demonstrate the utility of our method, we successfully prepared three sets of monodispersed copolymers: 1) EMA with different MW and MA incorporation; 2) EMA with different MW but similar MA incorporation; and 3) EMA with different MA incorporation but similar MW. When we attempted to tune the polar group density by increasing the MA concentration rather than using cation switching, the resulting copolymer had higher MA incorporation but reduced MW. Using larger amounts of MA had detrimental effects on the catalyst activity because MA can inhibit the catalyst via σ-coordination. Thus, these studies suggest that dynamic cation switching polymerization affords a much higher level of control over the polymerization outcome compared to conventional approaches that rely on reaction optimization/engineering.

Studies of PE-1, EMA-1, EMA-2, and EMA-3 indicated that the copolymers with low polar group density have similar thermal and mechanical properties to those in polyethylene but exhibit greater wettability, which could enhance their adhesiveness and compatibility with other materials. Our observation that minor amounts of MA per chain are sufficient to increase their susceptibility toward oxidative chain scission is an important finding because it suggests that polyethylene can be made to be degradable on demand, offering a possible solution to the plastic pollution problem associated with PE (Millican, J. M., Agarwal, S. Plastic Pollution: A Material Problem? Macromolecules 2021, 54, 4455-4469; Rhodes, C. J. Plastic Pollution and Potential Solutions. Sci. Prog. 2018, 101, 207-260). This work illustrates how advances in polymer synthesis enable access to previously inaccessible materials for fundamental studies and discovery of unexpected polymer properties.

Additional embodiments include those listed below.

Embodiment 46A. A method for catalyzing copolymerization of a first optionally substituted olefin and at least one other optionally substituted olefin, comprising: providing at least one catalyst having a structure selected from Formula (1) and Formula (2):

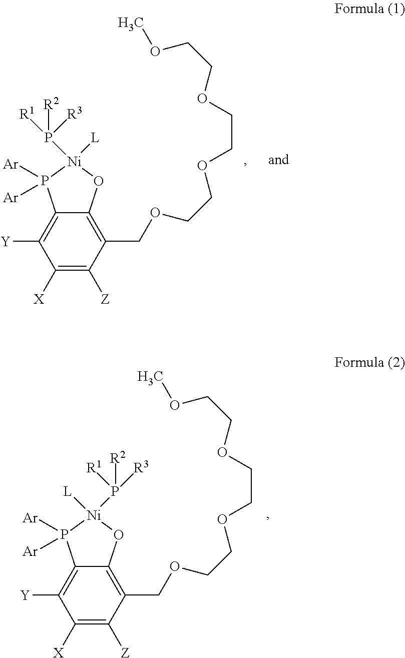

wherein in Formula (1) and Formula (2):
Ar is 2,6-dimethoxyphenyl, 2-methoxyphenyl, or phenyl;
L is an optionally substituted phenyl group;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl;
providing at least one alkali metal salt;
providing a first optionally substituted olefin;
providing at least one other optionally substituted olefin, wherein the at least one other optionally substituted olefin is an acrylamide, acrylic acid, acrylic ester, vinyl halide, vinyl alcohol, allyl alcohol, vinyl ether, or vinyl acetate, or any combination thereof; and contacting the first optionally substituted olefin and the at least one other optionally substituted olefin with the at least one catalyst and the at least one alkali metal salt, whereby the first optionally substituted olefin and the at least one other optionally substituted olefin undergoes copolymerization, and wherein the first optionally substituted olefin and the at least one other optionally substituted olefin are different from one another.

Embodiment 47A. The method of embodiment 46A, wherein X is selected from hydrogen, an electron donating group, and an electron withdrawing group; and Y and Z are each independently selected from hydrogen, an electron donating group, and an electron withdrawing group, provided that Y and Z are not both hydrogen.

Embodiment 48A. The method of embodiment 46A or embodiment 47A, wherein the at least one alkali metal salt has a structure of Formula (I): Mₓ⁺Aₓ⁺, wherein Mₓ⁺ is Li, Na, K, or Cs; and Aₓ⁺ is a weakly coordinating anion.

Embodiment 49A. The method of embodiment 48A, wherein the weakly coordinating anion is tetrakis(3,5-bis(trifluoromethyl)phenyl)borate, tetrakis(pentafluorophenyl)borate, tetraphenylborate, trifluoromethylsulfonate, hexafluorophosphate, hexafluoroantimonate, or tetrafluoroborate.

Embodiment 50A. The method of any one of embodiments 46A-49A, wherein the at least one alkali metal salt is lithium tetrakis(3,5-bis(trifluoromethyl)phenyl)borate, sodium tetrakis(3,5-bis(trifluoromethyl)phenyl)borate, potassium tetrakis(3,5-bis(trifluoromethyl)phenyl)borate, or cesium tetrakis(3,5-bis(trifluoromethyl)phenyl)borate, or any combination thereof.

Embodiment 51A. The method of any one of embodiments 46A-50A, wherein the first optionally substituted olefin is ethylene, propene, butene, 1-hexene, 1-heptene, 1-octene, styrene, allylbenzene, 2-hexene, 3-hexene, 2-heptene, 3-heptene, 2-octene, 3-octene, or 4-octene.

Embodiment 52A. The method of any one of embodiments 46A-51A, wherein the first optionally substituted olefin is ethylene.

Embodiment 53A. The method of any one of embodiments 46A-52A, wherein the at least one other optionally substituted olefin is an acrylic ester.

Embodiment 54A. The method of embodiment 53A, wherein the acrylic ester is methyl acrylate, ethyl acrylate, n-propyl acrylate, isopropyl acrylate, n-butyl acrylate, isobutyl acrylate, or tert-butyl acrylate, or any combination thereof.

Embodiment 55A. The method of any one of embodiments 46A-54A, wherein the step of contacting the first optionally substituted olefin and the at least one other optionally substituted olefin with the at least one catalyst and the at least one alkali metal salt is performed in the presence of at least one solvent.

Embodiment 56A. The method of embodiment 55A, wherein the at least one solvent is a non-polar solvent, a polar solvent, or combination thereof.

Embodiment 57A. The method of any one of embodiments 46A-56A, further comprising contacting at least one activator with the at least one catalyst, the at least one alkali metal salt, the first optionally substituted olefin, and the at least one other optionally substituted olefin.

Embodiment 58A. The method of embodiment 57A, wherein the at least one activator is selected from the group consisting of Ni(COD)₂, triarylborane, methylaluminoxane, and trialkylaluminum.

Embodiment 59A. A copolymer formed by the method of any one of embodiments 46A-58A.

Embodiment 60A. A method of forming a copolymer, the method comprising:
providing at least one catalyst having a structure selected from Formula (1) and Formula (2):

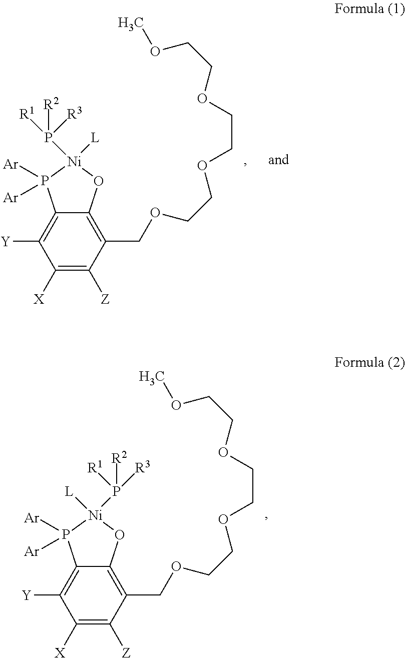

wherein in Formula (1) and Formula (2):
Ar is 2,6-dimethoxyphenyl, 2-methoxyphenyl, or phenyl;
L is an optionally substituted phenyl group;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl;
providing at least one alkali metal salt;
providing a first optionally substituted olefin;
providing at least one other optionally substituted olefin, wherein the at least one other optionally substituted olefin is an acrylamide, acrylic acid, acrylic ester, vinyl halide, vinyl alcohol, allyl alcohol, vinyl ether, or vinyl acetate, or any combination thereof; and contacting the first optionally substituted olefin and the at least one other optionally substituted olefin with the at least one catalyst and the at least one alkali metal salt, and wherein the first optionally substituted olefin and the at least one other optionally substituted olefin are different from one another.

Embodiment 61A. The method of embodiment 60A, wherein contacting the first optionally substituted olefin and the at least one other optionally substituted olefin with the at least one catalyst and the at least one alkali metal salt is performed under conditions effective to form the copolymer.

Embodiment 62A. The method of embodiment 60A or embodiment 61A, wherein X is selected from hydrogen, an electron donating group, and an electron withdrawing group; and Y and Z are each independently selected from hydrogen, an electron donating group, and an electron withdrawing group, provided that Y and Z are not both hydrogen.

Embodiment 63A. The method of any one of embodiments 60A-62A, wherein the at least one alkali metal salt has a structure of Formula (I): Mₓ⁺Aₓ⁺, wherein Mₓ⁺ is Li, Na, K, or Cs; and Aₓ⁺ is a weakly coordinating anion.

Embodiment 64A. The method of embodiment 63A, wherein the weakly coordinating anion is tetrakis(3,5-bis(trifluoromethyl)phenyl)borate, tetrakis(pentafluorophenyl)borate, tetraphenylborate, trifluoromethylsulfonate, hexafluorophosphate, hexafluoroantimonate, or tetrafluoroborate.

Embodiment 65A. The method of any one of embodiments 60A-64A, wherein the at least one alkali metal salt is lithium tetrakis(3,5-bis(trifluoromethyl)phenyl)borate, sodium tetrakis(3,5-bis(trifluoromethyl)phenyl)borate, potassium tetrakis(3,5-bis(trifluoromethyl)phenyl)borate, or cesium tetrakis(3,5-bis(trifluoromethyl)phenyl)borate, or any combination thereof.

Embodiment 66A. The method of any one of embodiments 60A-65A, wherein the first optionally substituted olefin is ethylene, propene, butene, 1-hexene, 1-heptene, 1-octene, styrene, allylbenzene, 2-hexene, 3-hexene, 2-heptene, 3-heptene, 2-octene, 3-octene, or 4-octene.

Embodiment 67A. The method of any one of embodiments 60A-66A, wherein the first optionally substituted olefin is ethylene.

Embodiment 68A. The method of any one of embodiments 60A-67A, wherein the at least one other optionally substituted olefin is an acrylic ester.

Embodiment 69A. The method of embodiment 68A, wherein the acrylic ester is methyl acrylate, ethyl acrylate, n-propyl acrylate, isopropyl acrylate, n-butyl acrylate, isobutyl acrylate, or tert-butyl acrylate, or any combination thereof.

Embodiment 70A. The method of any one of embodiments 60A-69A, wherein the step of contacting the first optionally substituted olefin and the at least one other optionally substituted olefin with the at least one catalyst and the at least one alkali metal salt is performed in the presence of at least one solvent.

Embodiment 71A. The method of embodiment 70A, wherein the at least one solvent is a non-polar solvent, a polar solvent, or combination thereof.

Embodiment 72A. The method of any one of embodiments 60A-71A, further comprising contacting at least one activator with the at least one catalyst, the at least one alkali metal salt, the first optionally substituted olefin, and the at least one other optionally substituted olefin.

Embodiment 73A. The method of embodiment 72A, wherein the at least one activator is selected from the group consisting of Ni(COD)₂, triarylborane, methylaluminoxane, and trialkylaluminum.

Embodiment 74A. The method of any one of embodiments 60A-73A, wherein the copolymer is a degradable copolymer.

Embodiment 75A. The method of any one of embodiments 60A-73A, wherein the copolymer is an oxidatively degradable copolymer.

Embodiment 76A. A method of degrading a copolymer, comprising: providing at least one catalyst having a structure selected from Formula (1) and Formula (2):

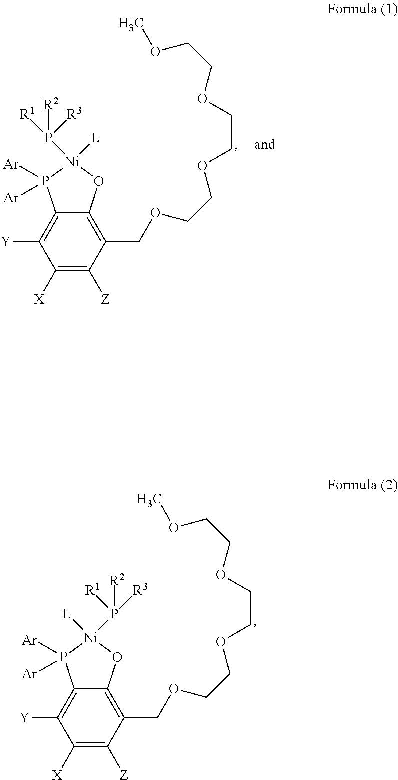

wherein in Formula (1) and Formula (2):
Ar is 2,6-dimethoxyphenyl, 2-methoxyphenyl, or phenyl;
L is an optionally substituted phenyl group;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl;
providing at least one alkali metal salt;
providing a first optionally substituted olefin;
providing at least one other optionally substituted olefin, wherein the at least one other optionally substituted olefin is an acrylamide, acrylic acid, acrylic ester, vinyl halide, vinyl alcohol, allyl alcohol, vinyl ether, or vinyl acetate, or any combination thereof; contacting the first optionally substituted olefin and the at least one other optionally substituted olefin with the at least one catalyst and the at least one alkali metal salt, whereby the first optionally substituted olefin and the at least one other optionally substituted olefin undergoes copolymerization to form a copolymer, wherein the first optionally substituted olefin and the at least one other optionally substituted olefin are different from one another; and contacting the copolymer with at least one peroxide under conditions effective to degrade the copolymer.

Embodiment 77A. The method of embodiment 76A, wherein X is selected from hydrogen, an electron donating group, and an electron withdrawing group; and Y and Z are each independently selected from hydrogen, an electron donating group, and an electron withdrawing group, provided that Y and Z are not both hydrogen.

Embodiment 78A. The method of embodiment 76A or embodiment 77A, wherein the at least one alkali metal salt has a structure of Formula (I): Mₓ⁺Aₓ⁺, wherein Mₓ⁺ is Li, Na, K, or Cs; and Aₓ⁺ is a weakly coordinating anion.

Embodiment 79A. The method of embodiment 78A, wherein the weakly coordinating anion is tetrakis(3,5-bis(trifluoromethyl)phenylborate, tetrakis(pentafluorophenyl)borate, tetraphenylborate, trifluoromethylsulfonate, hexafluorophosphate, hexafluoroantimonate, or tetrafluoroborate.

Embodiment 80A. The method of any one of embodiments 76A-79A, wherein the first optionally substituted olefin is ethylene, propene, butene, 1-hexene, 1-heptene, 1-octene, styrene, allylbenzene, 2-hexene, 3-hexene, 2-heptene, 3-heptene, 2-octene, 3-octene, or 4-octene.

Embodiment 81A. The method of any one of embodiments 76A-80A, wherein the first optionally substituted olefin is ethylene.

Embodiment 82A. The method of any one of embodiments 76A-81A, wherein the at least one other optionally substituted olefin is an acrylic ester.

Embodiment 83A. The method of embodiment 82A, wherein the acrylic ester is methyl acrylate, ethyl acrylate, n-propyl acrylate, isopropyl acrylate, n-butyl acrylate, isobutyl acrylate, or tert-butyl acrylate, or any combination thereof.

Embodiment 84A. The method of any one of embodiments 76A-83A, wherein the step of contacting the first optionally substituted olefin and the at least one other optionally substituted olefin with the at least one catalyst and the at least one alkali metal salt is performed in the presence of at least one solvent.

Embodiment 85A. The method of embodiment 84A, wherein the at least one solvent is a non-polar solvent, a polar solvent, or combination thereof.

Embodiment 86A. The method of any one of embodiments 76A-85A, further comprising contacting at least one activator with the at least one catalyst, the at least one alkali metal salt, the first optionally substituted olefin, and the at least one other optionally substituted olefin.

Embodiment 87A. The method of embodiment 86A, wherein the at least one activator is selected from the group consisting of Ni(COD)₂, triarylborane, methylaluminoxane, and trialkylaluminum.

Embodiment 88A. The method of any one of embodiments 76A-87A, wherein the at least one peroxide is at least one organic peroxide, at least one inorganic peroxide, or any combination thereof.

Embodiment 89A. The method of any one of embodiments 76A-87A, wherein the at least one peroxide is tert-butylperoxy 2-ethylhexyl carbonate (TBEC).

Embodiment 90A. A method for catalyzing copolymerization of a first optionally substituted olefin and at least one other optionally substituted olefin, comprising: providing at least one bimetallic catalyst complex having a structure selected from Formula (5) and Formula (6):

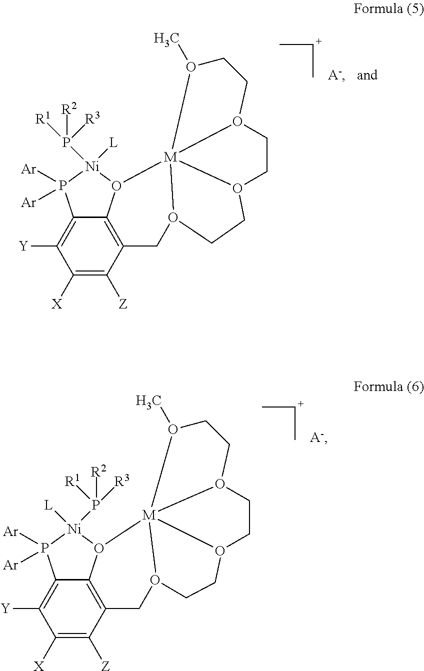

wherein in Formula (5) and Formula (6):
Ar is 2,6-dimethoxyphenyl, 2-methoxyphenyl, or phenyl;
L is an optionally substituted phenyl group;
M is Li, Na, K, or Cs;
A⁻ is a weakly coordinating anion;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl;
providing a first optionally substituted olefin;
providing at least one other optionally substituted olefin, wherein the at least one other optionally substituted olefin is an acrylamide, acrylic acid, acrylic ester, vinyl halide, vinyl alcohol, allyl alcohol, vinyl ether, or vinyl acetate, or any combination thereof; and contacting the first optionally substituted olefin and the at least one other optionally substituted olefin with the at least one bimetallic catalyst complex, whereby the first optionally substituted olefin and the at least one other optionally substituted olefin undergoes copolymerization, and wherein the first optionally substituted olefin and the at least one other optionally substituted olefin are different from one another.

Embodiment 91A. The method of embodiment 90A, wherein X is selected from hydrogen, an electron donating group, and an electron withdrawing group; and Y and Z are each independently selected from hydrogen, an electron donating group, and an electron withdrawing group, provided that Y and Z are not both hydrogen.

Embodiment 92A. The method of embodiment 90A or embodiment 91A, wherein the weakly coordinating anion is tetrakis(3,5-bis(trifluoromethyl)phenylborate, tetrakis(pentafluorophenyl)borate, tetraphenylborate, trifluoromethylsulfonate, hexafluorophosphate, hexafluoroantimonate, or tetrafluoroborate.

Embodiment 93A. The method of any one of embodiments 90A-92A, wherein the first optionally substituted olefin is ethylene, propene, butene, 1-hexene, 1-heptene, 1-octene, styrene, allylbenzene, 2-hexene, 3-hexene, 2-heptene, 3-heptene, 2-octene, 3-octene, or 4-octene.

Embodiment 94A. The method of any one of embodiments 90A-93A, wherein the first optionally substituted olefin is ethylene.

Embodiment 95A. The method of any one of embodiments 90A-94A, wherein the at least one other optionally substituted olefin is an acrylic ester.

Embodiment 96A. The method of embodiment 95A, wherein the acrylic ester is methyl acrylate, ethyl acrylate, n-propyl acrylate, isopropyl acrylate, n-butyl acrylate, isobutyl acrylate, or tert-butyl acrylate, or any combination thereof.

Embodiment 97A. The method of any one of embodiments 90A-96A, wherein the step of contacting the first optionally substituted olefin and the at least one other optionally substituted olefin with the at least one bimetallic catalyst complex is performed in the presence of at least one solvent.

Embodiment 98A. The method of embodiment 97A, wherein the at least one solvent is a non-polar solvent, a polar solvent, or combination thereof.

Embodiment 99A. The method of any one of embodiments 90A-98A, further comprising contacting at least one activator with the at least one bimetallic catalyst complex, the first optionally substituted olefin, and the at least one other optionally substituted olefin.

Embodiment 100A. The method of embodiment 99A, wherein the at least one activator is selected from the group consisting of Ni(COD)₂, triarylborane, methylaluminoxane, and trialkylaluminum.

Embodiment 101A. A copolymer formed by the method of any one of embodiments 90A-100A.

Embodiment 102A. A method of forming a copolymer, the method comprising:
providing at least one bimetallic catalyst complex having a structure selected from Formula (5) and Formula (6):

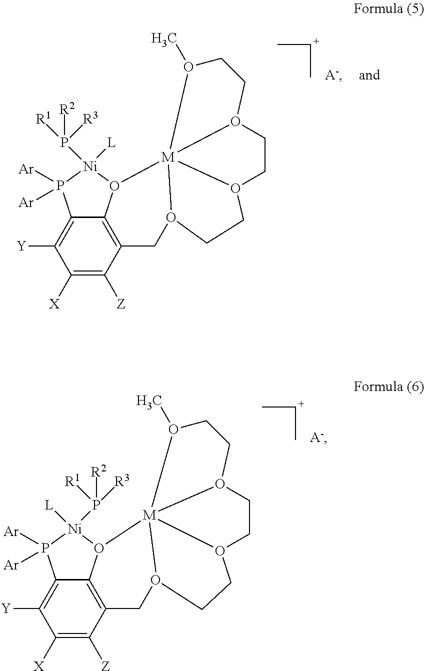

wherein in Formula (5) and Formula (6):
Ar is 2,6-dimethoxyphenyl, 2-methoxyphenyl, or phenyl;
L is an optionally substituted phenyl group;
M is Li, Na, K, or Cs;
A⁻ is a weakly coordinating anion;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl;
providing a first optionally substituted olefin;
providing at least one other optionally substituted olefin, wherein the at least one other optionally substituted olefin is an acrylamide, acrylic acid, acrylic ester, vinyl halide, vinyl alcohol, allyl alcohol, vinyl ether, or vinyl acetate, or any combination thereof; and contacting the first optionally substituted olefin and the at least one other optionally substituted olefin with the at least one bimetallic catalyst complex, and wherein the first optionally substituted olefin and the at least one other optionally substituted olefin are different from one another.

Embodiment 103A. The method of embodiment 102A, wherein contacting the first optionally substituted olefin and the at least one other optionally substituted olefin with at least one bimetallic catalyst complex is performed under conditions effective to form the copolymer.

Embodiment 104A. The method of embodiment 102A or embodiment 103A, wherein X is selected from hydrogen, an electron donating group, and an electron withdrawing group; and Y and Z are each independently selected from hydrogen, an electron donating group, and an electron withdrawing group, provided that Y and Z are not both hydrogen.

Embodiment 105A. The method of any one of embodiments 102A-104A, wherein the weakly coordinating anion is tetrakis(3,5-bis(trifluoromethyl)phenyl)borate, tetrakis(pentafluorophenyl)borate, tetraphenylborate, trifluoromethylsulfonate, hexafluorophosphate, hexafluoroantimonate, or tetrafluoroborate.

Embodiment 106A. The method of any one of embodiments 102A-105A, wherein the first optionally substituted olefin is ethylene, propene, butene, 1-hexene, 1-heptene, 1-octene, styrene, allylbenzene, 2-hexene, 3-hexene, 2-heptene, 3-heptene, 2-octene, 3-octene, or 4-octene.

Embodiment 107A. The method of any one of embodiments 102A-106A, wherein the first optionally substituted olefin is ethylene.

Embodiment 108A. The method of any one of embodiments 102A-107A, wherein the at least one other optionally substituted olefin is an acrylic ester.

Embodiment 109A. The method of embodiment 108A, wherein the acrylic ester is methyl acrylate, ethyl acrylate, n-propyl acrylate, isopropyl acrylate, n-butyl acrylate, isobutyl acrylate, or tert-butyl acrylate, or any combination thereof.

Embodiment 110A. The method of any one of embodiments 102A-109A, wherein the step of contacting the first optionally substituted olefin and the at least one other optionally substituted olefin with the at least one bimetallic catalyst complex is performed in the presence of at least one solvent.

Embodiment 111A. The method of embodiment 110A, wherein the at least one solvent is a non-polar solvent, a polar solvent, or combination thereof.

Embodiment 112A. The method of any one of embodiments 102A-111A, further comprising contacting at least one activator with the at least one bimetallic catalyst complex, the first optionally substituted olefin, and the at least one other optionally substituted olefin.

Embodiment 113A. The method of embodiment 112A, wherein the at least one activator is selected from the group consisting of Ni(COD)₂, triarylborane, methylaluminoxane, and trialkylaluminum.

Embodiment 114A. The method of any one of embodiments 102A-113A, wherein the copolymer is a degradable copolymer.

Embodiment 115A. The method of any one of embodiments 102A-113A, wherein the copolymer is an oxidatively degradable copolymer.

Embodiment 116A. A method of degrading a copolymer, comprising:
providing at least one bimetallic catalyst complex having a structure selected from Formula (5) and Formula (6):

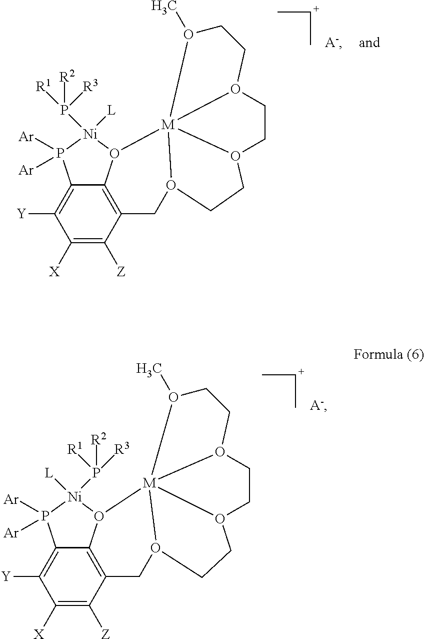

wherein in Formula (5) and Formula (6):
Ar is 2,6-dimethoxyphenyl, 2-methoxyphenyl, or phenyl;
L is an optionally substituted phenyl group;
M is Li, Na, K, or Cs;
A⁻ is a weakly coordinating anion;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl;
providing a first optionally substituted olefin;
providing at least one other optionally substituted olefin, wherein the at least one other optionally substituted olefin is an acrylamide, acrylic acid, acrylic ester, vinyl halide, vinyl alcohol, allyl alcohol, vinyl ether, or vinyl acetate, or any combination thereof; and contacting the first optionally substituted olefin and the at least one other optionally substituted olefin with the at least one bimetallic catalyst complex, whereby the first optionally substituted olefin and the at least one other optionally substituted olefin undergoes copolymerization to form a copolymer, and wherein the first optionally substituted olefin and the at least one other optionally substituted olefin are different from one another; and contacting the copolymer with at least one peroxide under conditions effective to degrade the copolymer.

Embodiment 117A. The method of embodiment 116A, wherein X is selected from hydrogen, an electron donating group, and an electron withdrawing group; and Y and Z are each independently selected from hydrogen, an electron donating group, and an electron withdrawing group, provided that Y and Z are not both hydrogen.

Embodiment 118A. The method of embodiment 116A or embodiment 117A, wherein the weakly coordinating anion is tetrakis(3,5-bis(trifluoromethyl)phenylborate, tetrakis(pentafluorophenyl)borate, tetraphenylborate, trifluoromethylsulfonate, hexafluorophosphate, hexafluoroantimonate, or tetrafluoroborate.

Embodiment 119A. The method of any one of embodiments 116A-118A, wherein the first optionally substituted olefin is ethylene, propene, butene, 1-hexene, 1-heptene, 1-octene, styrene, allylbenzene, 2-hexene, 3-hexene, 2-heptene, 3-heptene, 2-octene, 3-octene, or 4-octene.

Embodiment 120A. The method of any one of embodiments 116A-119A, wherein the first optionally substituted olefin is ethylene.

Embodiment 121A. The method of any one of embodiments 116A-120A, wherein the at least one other optionally substituted olefin is an acrylic ester.

Embodiment 122A. The method of embodiment 121A, wherein the acrylic ester is methyl acrylate, ethyl acrylate, n-propyl acrylate, isopropyl acrylate, n-butyl acrylate, isobutyl acrylate, or tert-butyl acrylate, or any combination thereof.

Embodiment 123A. The method of any one of embodiments 116A-122A, wherein the step of contacting the first optionally substituted olefin and the at least one other optionally substituted olefin with the at least one bimetallic catalyst complex is performed in the presence of at least one solvent.

Embodiment 124A. The method of embodiment 123A, wherein the at least one solvent is a non-polar solvent, a polar solvent, or combination thereof.

Embodiment 125A. The method of any one of embodiments 116A-124A, further comprising contacting at least one activator with the at least one bimetallic catalyst complex, the first optionally substituted olefin, and the at least one other optionally substituted olefin.

Embodiment 126A. The method of embodiment 125A, wherein the at least one activator is selected from the group consisting of Ni(COD)₂, triarylborane, methylaluminoxane, and trialkylaluminum.

Embodiment 127A. The method of any one of embodiments 116A-126A, wherein the at least one peroxide is at least one organic peroxide, at least one inorganic peroxide, or any combination thereof.

Embodiment 128A. The method of any one of embodiments 116A-126A, wherein the at least one peroxide is tert-butylperoxy 2-ethylhexyl carbonate.

Embodiment 129A. A method for catalyzing copolymerization of a first optionally substituted olefin and at least one other optionally substituted olefin, comprising: providing at least one heterobimetallic catalyst having a structure selected from Formula (3) and Formula (4):

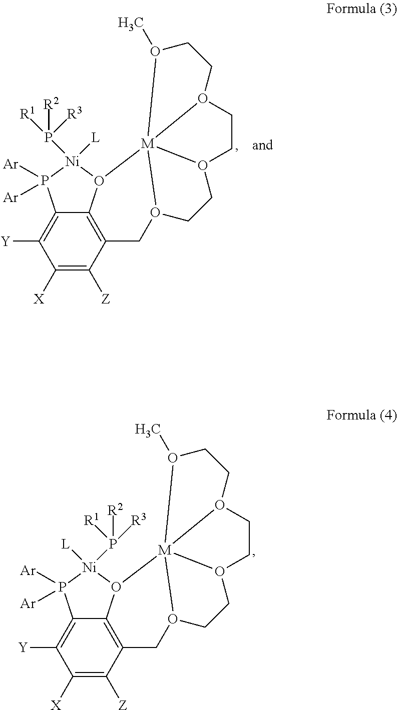

wherein in Formula (3) and Formula (4):
Ar is 2,6-dimethoxyphenyl, 2-methoxyphenyl, or phenyl;
L is an optionally substituted phenyl group;
M is Li, Na, K, or Cs;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl;
providing a first optionally substituted olefin;
providing at least one other optionally substituted olefin, wherein the at least one other optionally substituted olefin is an acrylamide, acrylic acid, acrylic ester, vinyl halide, vinyl alcohol, allyl alcohol, vinyl ether, or vinyl acetate, or any combination thereof; and contacting the first optionally substituted olefin and the at least one other optionally substituted olefin with the at least one heterobimetallic catalyst, whereby the first optionally substituted olefin and the at least one other optionally substituted olefin undergoes copolymerization, and wherein the first optionally substituted olefin and the at least one other optionally substituted olefin are different from one another.

Embodiment 130A. The method of embodiment 129A, wherein X is selected from hydrogen, an electron donating group, and an electron withdrawing group; and Y and Z are each independently selected from hydrogen, an electron donating group, and an electron withdrawing group, provided that Y and Z are not both hydrogen.

Embodiment 131A. The method of embodiment 129A or embodiment 130A, wherein the first optionally substituted olefin is ethylene, propene, butene, 1-hexene, 1-heptene, 1-octene, styrene, allylbenzene, 2-hexene, 3-hexene, 2-heptene, 3-heptene, 2-octene, 3-octene, or 4-octene.

Embodiment 132A. The method of any one of embodiments 129A-131A, wherein the first optionally substituted olefin is ethylene.

Embodiment 133A. The method of any one of embodiments 129A-132A, wherein the at least one other optionally substituted olefin is an acrylic ester.

Embodiment 134A. The method of embodiment 133A, wherein the acrylic ester is methyl acrylate, ethyl acrylate, n-propyl acrylate, isopropyl acrylate, n-butyl acrylate, isobutyl acrylate, or tert-butyl acrylate, or any combination thereof.

Embodiment 135A. The method of any one of embodiments 129A-134A, wherein the step of contacting the first optionally substituted olefin and the at least one other optionally substituted olefin with the at least one heterobimetallic catalyst is performed in the presence of at least one solvent.

Embodiment 136A. The method of embodiment 135A, wherein the at least one solvent is a non-polar solvent, a polar solvent, or combination thereof.

Embodiment 137A. The method of any one of embodiment 129A-136A, further comprising contacting at least one activator with the at least one heterobimetallic catalyst, the first optionally substituted olefin, and the at least one other optionally substituted olefin.

Embodiment 138A. The method of embodiment 137A, wherein the at least one activator is selected from the group consisting of Ni(COD)₂, triarylborane, methylaluminoxane, and trialkylaluminum.

Embodiment 139A. A copolymer formed by the method of any one of embodiments 116A-138A.

Embodiment 140A. A method of forming a copolymer, the method comprising:
providing at least one heterobimetallic catalyst having a structure selected from Formula (3) and Formula (4):

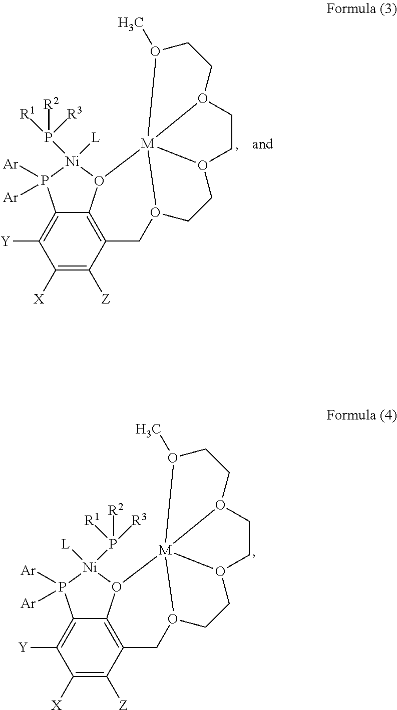

wherein in Formula (3) and Formula (4):
Ar is 2,6-dimethoxyphenyl, 2-methoxyphenyl, or phenyl;
L is an optionally substituted phenyl group;
M is Li, Na, K, or Cs;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl;
providing a first optionally substituted olefin;
providing at least one other optionally substituted olefin, wherein the at least one other optionally substituted olefin is an acrylamide, acrylic acid, acrylic ester, vinyl halide, vinyl alcohol, allyl alcohol, vinyl ether, or vinyl acetate, or any combination thereof; and contacting the first optionally substituted olefin and the at least one other optionally substituted olefin with the at least one heterobimetallic catalyst, and wherein the first optionally substituted olefin and the at least one other optionally substituted olefin are different from one another.

Embodiment 141A. The method of embodiment 140A, wherein contacting the first optionally substituted olefin and the at least one other optionally substituted olefin with the at least one heterobimetallic catalyst is performed under conditions effective to form the copolymer.

Embodiment 142A. The method of embodiment 140A or embodiment 141A, wherein X is selected from hydrogen, an electron donating group, and an electron withdrawing group; and Y and Z are each independently selected from hydrogen, an electron donating group, and an electron withdrawing group, provided that Y and Z are not both hydrogen.

Embodiment 143A. The method of any one of embodiments 140A-142A, wherein the first optionally substituted olefin is ethylene, propene, butene, 1-hexene, 1-heptene, 1-octene, styrene, allylbenzene, 2-hexene, 3-hexene, 2-heptene, 3-heptene, 2-octene, 3-octene, or 4-octene.

Embodiment 144A. The method of any one of embodiments 140A-143A, wherein the first optionally substituted olefin is ethylene.

Embodiment 145A. The method of any one of embodiments 140A-144A, wherein the at least one other optionally substituted olefin is an acrylic ester.

Embodiment 146A. The method of embodiment 145A, wherein the acrylic ester is methyl acrylate, ethyl acrylate, n-propyl acrylate, isopropyl acrylate, n-butyl acrylate, isobutyl acrylate, or tert-butyl acrylate, or any combination thereof.

Embodiment 147A. The method of any one of embodiments 140A-146A, wherein the step of contacting the first optionally substituted olefin and the at least one other optionally substituted olefin with the at least one heterobimetallic catalyst is performed in the presence of at least one solvent.

Embodiment 148A. The method of embodiment 147A, wherein the at least one solvent is a non-polar solvent, a polar solvent, or combination thereof.

Embodiment 149A. The method of any one of embodiments 140A-148A, further comprising contacting at least one activator with the at least one heterobimetallic catalyst, the first optionally substituted olefin, and the at least one other optionally substituted olefin.

Embodiment 150A. The method of embodiment 149A, wherein the at least one activator is selected from the group consisting of Ni(COD)₂, triarylborane, methylaluminoxane, and trialkylaluminum.

Embodiment 151A. The method of any one of embodiments 140A-150A, wherein the copolymer is a degradable copolymer.

Embodiment 152A. The method of any one of embodiments 140A-150A, wherein the copolymer is an oxidatively degradable copolymer.

Embodiment 153A. A method of degrading a copolymer, comprising:
providing at least one heterobimetallic catalyst having a structure selected from Formula (3) and Formula (4):

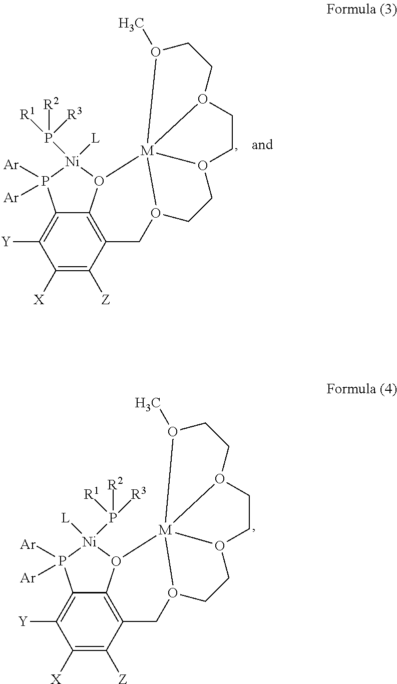

wherein in Formula (3) and Formula (4):
Ar is 2,6-dimethoxyphenyl, 2-methoxyphenyl, or phenyl;
L is an optionally substituted phenyl group;
M is Li, Na, K, or Cs;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl;
providing a first optionally substituted olefin;
providing at least one other optionally substituted olefin, wherein the at least one other optionally substituted olefin is an acrylamide, acrylic acid, acrylic ester, vinyl halide, vinyl alcohol, allyl alcohol, vinyl ether, or vinyl acetate, or any combination thereof; and contacting the first optionally substituted olefin and the at least one other optionally substituted olefin with the at least one heterobimetallic catalyst, whereby the first optionally substituted olefin and the at least one other optionally substituted olefin undergoes copolymerization to form a copolymer, and wherein the first optionally substituted olefin and the at least one other optionally substituted olefin are different from one another; and contacting the copolymer with at least one peroxide under conditions effective to degrade the copolymer.

Embodiment 154A. The method of embodiment 153A, wherein X is selected from hydrogen, an electron donating group, and an electron withdrawing group; and Y and Z are each independently selected from hydrogen, an electron donating group, and an electron withdrawing group, provided that Y and Z are not both hydrogen.

Embodiment 155A. The method of embodiment 153A or embodiment 154A, wherein the first optionally substituted olefin is ethylene, propene, butene, 1-hexene, 1-heptene, 1-octene, styrene, allylbenzene, 2-hexene, 3-hexene, 2-heptene, 3-heptene, 2-octene, 3-octene, or 4-octene.

Embodiment 156A. The method of any one of embodiments 153A-155A, wherein the first optionally substituted olefin is ethylene.

Embodiment 157A. The method of any one of embodiments 153A-156A, wherein the at least one other optionally substituted olefin is an acrylic ester.

Embodiment 158A. The method of embodiment 157A, wherein the acrylic ester is methyl acrylate, ethyl acrylate, n-propyl acrylate, isopropyl acrylate, n-butyl acrylate, isobutyl acrylate, or tert-butyl acrylate, or any combination thereof.

Embodiment 159A. The method of any one of embodiments 153A-158A, wherein the step of contacting the first optionally substituted olefin and the at least one other optionally substituted olefin with the at least one heterobimetallic catalyst is performed in the presence of at least one solvent.

Embodiment 160A. The method of embodiment 159A, wherein the at least one solvent is a non-polar solvent, a polar solvent, or combination thereof.

Embodiment 161A. The method of any one of embodiments 153A-160A, further comprising contacting at least one activator with the at least one heterobimetallic catalyst, the first optionally substituted olefin, and the at least one other optionally substituted olefin.

Embodiment 162A. The method of embodiment 161A, wherein the at least one activator is selected from the group consisting of Ni(COD)₂, triarylborane, methylaluminoxane, and trialkylaluminum.

Embodiment 163A. The method of any one of embodiments 153A-162A, wherein the at least one peroxide is at least one organic peroxide, at least one inorganic peroxide, or any combination thereof.

Embodiment 164A. The method of any one of embodiments 153A-162A, wherein the at least one peroxide is tert-butylperoxy 2-ethylhexyl carbonate.

Additional embodiments include those listed below.

In some embodiments, Ar is 2,6-dimethoxyphenyl; L is a phenyl group; X is methyl; Y is hydrogen; Z is hydrogen; and R¹, R², and R³ are each methyl.

In some embodiments, Ar is 2-methoxyphenyl; L is a phenyl group; X is methyl; Y is hydrogen; Z is hydrogen; and R¹, R², and R³ are each methyl.

In some embodiments, Ar is phenyl; L is a phenyl group; X is methyl; Y is hydrogen; Z is hydrogen; and R¹, R², and R³ are each methyl.

Additional embodiments include those listed below.

In some embodiments, Ar is 2,6-dimethoxyphenyl; L is a phenyl group; M is Li, Na, K, or Cs; X is methyl; Y is hydrogen; Z is hydrogen; and R¹, R², and R³ are each methyl.

In some embodiments, Ar is 2-methoxyphenyl; L is a phenyl group; M is Li, Na, K, or Cs; X is methyl; Y is hydrogen; Z is hydrogen; and R¹, R², and R³ are each methyl.

In some embodiments, Ar is phenyl; L is a phenyl group; M is Li, Na, K, or Cs; X is methyl; Y is hydrogen; Z is hydrogen; and R¹, R², and R³ are each methyl.

Additional embodiments include those listed below.

In some embodiments, Ar is 2,6-dimethoxyphenyl; L is a phenyl group; M is Li, Na, K, or Cs; A⁻ is [(3,5-(CF₃)₂C₆H₃)₄B]⁻; X is methyl; Y is hydrogen; Z is hydrogen; and R¹, R², and R³ are each methyl.

In some embodiments, Ar is 2-methoxyphenyl; L is a phenyl group; M is Li, Na, K, or Cs; A⁻ is [(3,5-(CF₃)₂C₆H₃)₄B]⁻; X is methyl; Y is hydrogen; Z is hydrogen; and R¹, R², and R³ are each methyl.

In some embodiments, Ar is phenyl; L is a phenyl group; M is Li, Na, K, or Cs; A is [(3,5-(CF₃)₂C₆H₃)₄B]⁻; X is methyl; Y is hydrogen; Z is hydrogen; and R¹, R², and R³ are each methyl.

Additional embodiments include those listed below.

In some embodiments, the electron donating group is selected from the group consisting of: alkoxy, amino, hydroxy, and alkyl. In some embodiments, the electron donating group is selected from the group consisting of: alkoxy, phenoxy, amino, alkylamino, dialkylamino, hydroxy, alkyl, and cycloalkyl. In some embodiments, alkyl is selected from the group consisting of: —CH₃, —CH₂CH₃, —CH₂CH₂CH₃, and —CH(CH₃)₂. In some embodiments, the electron withdrawing group is selected from the group consisting of: —NO₂, —CN, —C(O)-alkyl, and halo. In some embodiments, the electron withdrawing group is selected from the group consisting of: —NO₂, —CN, —C(O)-alkyl, —C(O)Oalkyl, —C(O)Nalkyl, —SO₃H, —SO₂R, —PO₃H, —PO₃R, —CF₃, and halo. In some embodiments, the electron withdrawing group is selected from the group consisting of: —NO₂, —CN, —C(O)-alkyl, —C(O)Oalkyl, —C(O)Nalkyl, —SO₃H, —SO₂alkyl, —PO₃H, —PO₃alkyl, —CF₃, and halo.

In some embodiments, the at least one alkali metal salt comprises an alkali cation and a weakly coordinating anion.

In some embodiments, the alkali cation is Li⁺, Na⁺, K⁺, or Cs⁺.

In some embodiments, the weakly coordinating anion is tetrakis(3,5-bis(trifluoromethyl)phenyl)borate, tetrakis(pentafluorophenyl)borate, tetraphenylborate, trifluoromethylsulfonate, hexafluorophosphate, hexafluoroantimonate, or tetrafluoroborate.

In some embodiments, the at least one alkali metal salt is lithium tetrakis(3,5-bis(trifluoromethyl)phenyl)borate, sodium tetrakis(3,5-bis(trifluoromethyl)phenyl)borate, potassium tetrakis(3,5-bis(trifluoromethyl)phenyl)borate, or cesium tetrakis(3,5-bis(trifluoromethyl)phenyl)borate, or any combination thereof.

In some embodiments, the at least one alkali metal salt is an alkali salt.

In some embodiments, the at least one alkali salt comprises an alkali cation and a weakly coordinating anion.

In some embodiments, the alkali cation is Li⁺, Na⁺, K⁺, or Cs⁺.

In some embodiments, the weakly coordinating anion is tetrakis(3,5-bis(trifluoromethyl)phenyl)borate, tetrakis(pentafluorophenyl)borate, tetraphenylborate, trifluoromethylsulfonate, hexafluorophosphate, hexafluoroantimonate, or tetrafluoroborate.

In some embodiments, the at least one alkali salt is lithium tetrakis(3,5-bis(trifluoromethyl)phenyl)borate, sodium tetrakis(3,5-bis(trifluoromethyl)phenyl)borate, potassium tetrakis(3,5-bis(trifluoromethyl)phenyl)borate, or cesium tetrakis(3,5-bis(trifluoromethyl)phenyl)borate, or any combination thereof.

In some embodiments, the at least one peroxide is hydrogen peroxide, peroxyacids, dialkyl peroxide, diacylperoxides, peroxydicarbonate, peroxyester, or cyclic peroxides.

In some embodiments, the at least one peroxide is tert-butylperoxy 2-ethylhexyl carbonate, dicumyl peroxide, polyether poly(t-butyl)-peroxycarbonate, or t-amyl peroxyacetate. In some embodiments, the at least one peroxide is tert-butylperoxy 2-ethylhexyl carbonate.

In some embodiments, Ar is 2,6-dimethoxyphenyl, 2-methoxyphenyl, or phenyl. In some embodiments, Ar is 2,6-dimethoxyphenyl or 2-methoxyphenyl. In some embodiments, Ar is 2,6-dimethoxyphenyl or phenyl. In some embodiments, Ar is 2-methoxyphenyl or phenyl. In some embodiments, Ar is 2,6-dimethoxyphenyl. In some embodiments, Ar is 2-methoxyphenyl. In some embodiments, Ar is phenyl.

In some embodiments, the acrylic ester is an alkyl acrylate. In some embodiments, the alkyl acrylate is methyl acrylate, ethyl acrylate, n-propyl acrylate, isopropyl acrylate, n-butyl acrylate, isobutyl acrylate, or tert-butyl acrylate, or any combination thereof.

In some embodiments, the acrylic ester is methyl acrylate, ethyl acrylate, n-propyl acrylate, isopropyl acrylate, n-butyl acrylate, isobutyl acrylate, or tert-butyl acrylate, or any combination thereof.

In some embodiments, the copolymer is a degradable copolymer. In some embodiments, the degradable copolymer is an oxidatively degradable polymer. In some embodiments, the copolymer is an oxidatively degradable copolymer.

In some embodiments, the at least one peroxide is hydrogen peroxide, peroxyacids, dialkyl peroxide, diacylperoxides, peroxydicarbonate, peroxyester, or cyclic peroxides, or any combination thereof. In some embodiments, the at least one peroxide is hydrogen peroxide, peroxyacid, dialkyl peroxide, diacylperoxide, peroxydicarbonate, peroxyester, or cyclic peroxide, or any combination thereof.

In some embodiments, the at least one peroxide is tert-butylperoxy 2-ethylhexyl carbonate, dicumyl peroxide, polyether poly(t-butyl)-peroxycarbonate, or t-amyl peroxyacetate, or any combination thereof.

Additional embodiments include those listed below.

In various embodiments, the present invention provides a method of degrading a copolymer, comprising: providing a copolymer, wherein the copolymer comprises repeat units derived from a first optionally substituted olefin and at least one other optionally substituted olefin, wherein the first optionally substituted olefin and the at least one other optionally substituted olefin are different from one another; and contacting the copolymer with at least one peroxide.

In various embodiments, the present invention provides a method of degrading a copolymer, comprising: providing a copolymer, wherein the copolymer comprises repeat units derived from a first optionally substituted olefin and at least one other optionally substituted olefin, wherein the first optionally substituted olefin and the at least one other optionally substituted olefin are different from one another; and contacting the copolymer with at least one peroxide to degrade the copolymer.

In various embodiments, the present invention provides a method of degrading a copolymer, comprising: providing a copolymer, wherein the copolymer comprises repeat units derived from a first optionally substituted olefin and at least one other optionally substituted olefin, wherein the first optionally substituted olefin and the at least one other optionally substituted olefin are different from one another; and contacting the copolymer with at least one peroxide under conditions effective to degrade the copolymer.

In various embodiments, the present invention provides a method of degrading a copolymer, comprising: providing a copolymer, wherein the copolymer comprises at least one repeat unit derived from a first optionally substituted olefin and at least one other optionally substituted olefin, wherein the first optionally substituted olefin and the at least one other optionally substituted olefin are different from one another; and contacting the copolymer with at least one peroxide.

In various embodiments, the present invention provides a method of degrading a copolymer, comprising: providing a copolymer, wherein the copolymer comprises at least one repeat unit derived from a first optionally substituted olefin and at least one other optionally substituted olefin, wherein the first optionally substituted olefin and the at least one other optionally substituted olefin are different from one another; and contacting the copolymer with at least one peroxide to degrade the copolymer.

In various embodiments, the present invention provides a method of degrading a copolymer, comprising: providing a copolymer, wherein the copolymer comprises at least one repeat unit derived from a first optionally substituted olefin and at least one other optionally substituted olefin, wherein the first optionally substituted olefin and the at least one other optionally substituted olefin are different from one another; and contacting the copolymer with at least one peroxide under conditions effective to degrade the copolymer.

In some embodiments, the first optionally substituted olefin is ethylene, propene, butene, 1-hexene, 1-heptene, 1-octene, styrene, allylbenzene, 2-hexene, 3-hexene, 2-heptene, 3-heptene, 2-octene, 3-octene, or 4-octene, or any combination thereof. In some embodiments, the first optionally substituted olefin is ethylene, propene, butene, 1-hexene, 1-heptene, 1-octene, styrene, allylbenzene, 2-hexene, 3-hexene, 2-heptene, 3-heptene, 2-octene, 3-octene, or 4-octene. In some embodiments, the first optionally substituted olefin is ethylene.

In some embodiments, the at least one other optionally substituted olefin is a polar olefin. In some embodiments, the polar olefin is a polar vinyl olefin. In some embodiments, the polar olefin is an acrylamide, acrylic acid, acrylic ester, vinyl halide, vinyl alcohol, allyl alcohol, or any combination thereof. In some embodiments, the polar olefin is an acrylic ester.

In some embodiments, the at least one other optionally substituted olefin is an acrylamide, acrylic acid, acrylic ester, vinyl halide, vinyl alcohol, allyl alcohol, or any combination thereof. In some embodiments, the at least one other optionally substituted olefin is an acrylic ester. In some embodiments, the acrylic ester is methyl acrylate, ethyl acrylate, n-propyl acrylate, isopropyl acrylate, n-butyl acrylate, isobutyl acrylate, or tert-butyl acrylate, or any combination thereof.

In some embodiments, the at least one peroxide is at least one organic peroxide, at least one inorganic peroxide, or any combination thereof.

In some embodiments, the at least one peroxide is tert-butylperoxy 2-ethylhexyl carbonate, dicumyl peroxide, polyether poly(t-butyl)-peroxycarbonate, or t-amyl peroxyacetate, or any combination thereof. In some embodiments, the at least one peroxide is tert-butylperoxy 2-ethylhexyl carbonate.

In some embodiments, the at least one peroxide is hydrogen peroxide, peroxyacid, dialkyl peroxide, diacylperoxide, peroxydicarbonate, peroxyester, or cyclic peroxide, or any combination thereof.

In some embodiments, the copolymer is a degradable copolymer. In some embodiments, the copolymer is an oxidatively degradable copolymer.

In some embodiments, the copolymer is an ethylene-alkyl acrylate copolymer.

In some embodiments, the polar olefin is an alkyl acrylate. In some embodiments, the alkyl acrylate is methyl acrylate, ethyl acrylate, n-propyl acrylate, isopropyl acrylate, n-butyl acrylate, isobutyl acrylate, or tert-butyl acrylate, or any combination thereof.

In some embodiments, the at least one other optionally substituted olefin is an alkyl acrylate. In some embodiments, the alkyl acrylate is methyl acrylate, ethyl acrylate, n-propyl acrylate, isopropyl acrylate, n-butyl acrylate, isobutyl acrylate, or tert-butyl acrylate, or any combination thereof.

Additional embodiments include those listed below.

Embodiment 1B. A method of degrading a copolymer, comprising: providing a copolymer, wherein the copolymer comprises repeat units derived from a first optionally substituted olefin and at least one other optionally substituted olefin, wherein the first optionally substituted olefin and the at least one other optionally substituted olefin are different from one another; and contacting the copolymer with at least one peroxide.

Embodiment 2B. The method of embodiment 1B, wherein the first optionally substituted olefin is ethylene, propene, butene, 1-hexene, 1-heptene, 1-octene, styrene, allylbenzene, 2-hexene, 3-hexene, 2-heptene, 3-heptene, 2-octene, 3-octene, or 4-octene, or any combination thereof.

Embodiment 3B. The method of embodiment 1B or embodiment 2B, wherein the first optionally substituted olefin is ethylene.

Embodiment 4B. The method of any one of embodiments 1B-3B, wherein the at least one other optionally substituted olefin is a polar olefin.

Embodiment 5B. The method of embodiment 4B, wherein the polar olefin is a polar vinyl olefin.

Embodiment 6B. The method of any one of embodiments 1B-3B, wherein the at least one other optionally substituted olefin is an acrylamide, acrylic acid, acrylic ester, vinyl halide, vinyl alcohol, allyl alcohol, or any combination thereof.

Embodiment 7B. The method of any one of embodiments 1B-3B, wherein the at least one other optionally substituted olefin is an acrylic ester.

Embodiment 8B. The method of embodiment 6B or embodiment 7B, wherein the acrylic ester is methyl acrylate, ethyl acrylate, n-propyl acrylate, isopropyl acrylate, n-butyl acrylate, isobutyl acrylate, or tert-butyl acrylate, or any combination thereof.

Embodiment 9B. The method of any one of embodiments 1B-3B, wherein the at least one other optionally substituted olefin is an alkyl acrylate.

Embodiment 10B. The method of embodiment 9B, wherein the alkyl acrylate is methyl acrylate, ethyl acrylate, n-propyl acrylate, isopropyl acrylate, n-butyl acrylate, isobutyl acrylate, or tert-butyl acrylate, or any combination thereof.

Embodiment 11B. The method of any one of embodiments 1B-10B, wherein the at least one peroxide is at least one organic peroxide, at least one inorganic peroxide, or any combination thereof.

Embodiment 12B. The method of any one of embodiments 1B-10B, the at least one peroxide is tert-butylperoxy 2-ethylhexyl carbonate, dicumyl peroxide, polyether poly(t-butyl)-peroxycarbonate, or t-amyl peroxyacetate, or any combination thereof.

Embodiment 13B. The method of any one of embodiments 1B-10B, wherein the at least one peroxide is tert-butylperoxy 2-ethylhexyl carbonate.

Embodiment 14B. The method of any one of embodiments 1B-10B, wherein the at least one peroxide is hydrogen peroxide, peroxyacid, dialkyl peroxide, diacylperoxide, peroxydicarbonate, peroxyester, or cyclic peroxide, or any combination thereof

Embodiment 15B. The method of any one of embodiments 1B-14B, wherein the copolymer is a degradable copolymer.

Embodiment 16B. The method of any one of embodiments 1B-14B, wherein the copolymer is an oxidatively degradable copolymer.

Additional embodiments include those listed below.

In various embodiments, the present invention provides a method of degrading a copolymer, comprising:
providing at least one catalyst having a structure selected from Formula (1) and Formula (2):

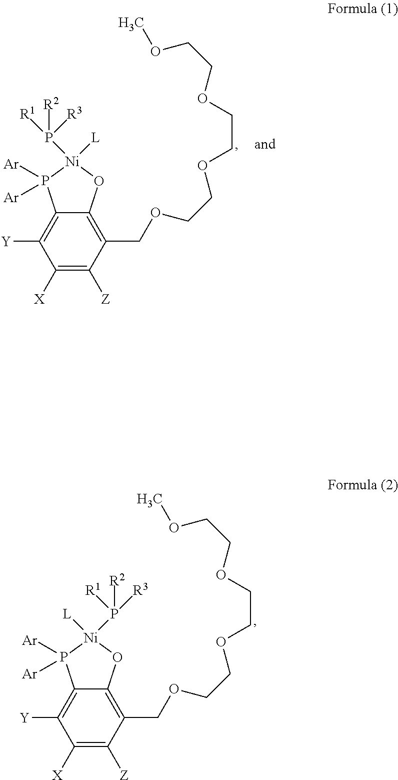

wherein in Formula (1) and Formula (2):
Ar is 2,6-dimethoxyphenyl or 2-methoxyphenyl;
L is an optionally substituted phenyl group;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl;
   providing at least one alkali salt;
   providing a first optionally substituted olefin;
   providing at least one other optionally substituted olefin, wherein the at least one other optionally substituted olefin is an acrylamide, acrylic acid, acrylic ester, vinyl halide, vinyl alcohol, allyl alcohol, or any combination thereof;
   contacting the first optionally substituted olefin and the at least one other optionally substituted olefin with the at least one catalyst and the at least one alkali salt, whereby the first optionally substituted olefin and the at least one other optionally substituted olefin undergoes copolymerization to form a copolymer, and wherein the first optionally substituted olefin and the at least one other optionally substituted olefin are different from one another; and contacting the copolymer with at least one peroxide.

In some embodiments, the contacting of the copolymer with the at least one peroxide is performed under conditions effective to degrade the copolymer.

In various embodiments, the present invention provides a method of degrading a copolymer, comprising: providing at least one heterobimetallic catalyst having a structure selected from Formula (3) and Formula (4):

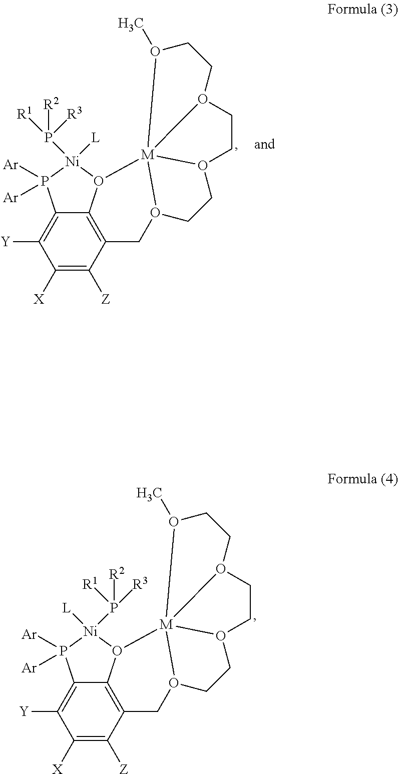

wherein in Formula (3) and Formula (4):
Ar is 2,6-dimethoxyphenyl, 2-methoxyphenyl, or phenyl;
L is an optionally substituted phenyl group;
M is Li, Na, K, or Cs;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl;
providing a first optionally substituted olefin;
providing at least one other optionally substituted olefin, wherein the at least one other optionally substituted olefin is an acrylamide, acrylic acid, acrylic ester, vinyl halide, vinyl alcohol, allyl alcohol, vinyl ether, or vinyl acetate, or any combination thereof, and contacting the first optionally substituted olefin and the at least one other optionally substituted olefin with the at least one heterobimetallic catalyst, whereby the first optionally substituted olefin and the at least one other optionally substituted olefin undergoes copolymerization to form a copolymer, and wherein the first optionally substituted olefin and the at least one other optionally substituted olefin are different from one another; and contacting the copolymer with at least one peroxide.

In some embodiments, the contacting of the copolymer with the at least one peroxide is performed under conditions effective to degrade the copolymer.

In various embodiments, the present invention provides a method of degrading a copolymer, comprising: providing at least one bimetallic catalyst complex having a structure selected from Formula (5) and Formula (6):

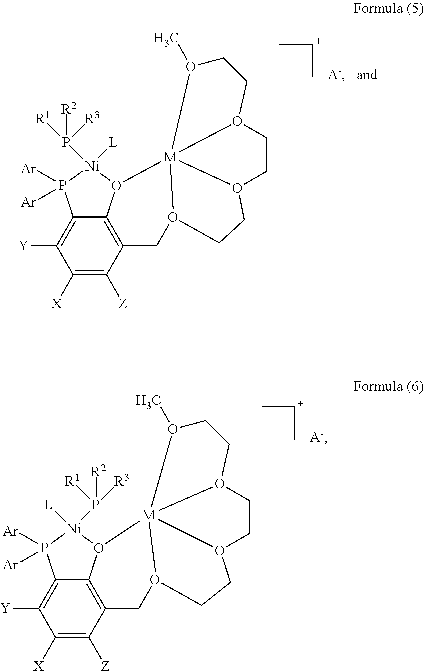

wherein in Formula (5) and Formula (6):
Ar is 2,6-dimethoxyphenyl, 2-methoxyphenyl, or phenyl;
L is an optionally substituted phenyl group;
M is Li, Na, K, or Cs;
A⁻ is a weakly coordinating anion;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl;
providing a first optionally substituted olefin;
providing at least one other optionally substituted olefin, wherein the at least one other optionally substituted olefin is an acrylamide, acrylic acid, acrylic ester, vinyl halide, vinyl alcohol, allyl alcohol, vinyl ether, or vinyl acetate, or any combination thereof; and contacting the first optionally substituted olefin and the at least one other optionally substituted olefin with the at least one bimetallic catalyst complex, whereby the first optionally substituted olefin and the at least one other optionally substituted olefin undergoes copolymerization to form a copolymer, and wherein the first optionally substituted olefin and the at least one other optionally substituted olefin are different from one another; and contacting the copolymer with at least one peroxide under conditions effective to degrade the copolymer.

In some embodiments, the contacting of the copolymer with the at least one peroxide is performed under conditions effective to degrade the copolymer.

Additional embodiments include those listed below.

Embodiment 1C. A method for catalyzing copolymerization of a first optionally substituted olefin and at least one other optionally substituted olefin, comprising: providing at least one catalyst having a structure selected from Formula (1) and Formula (2):

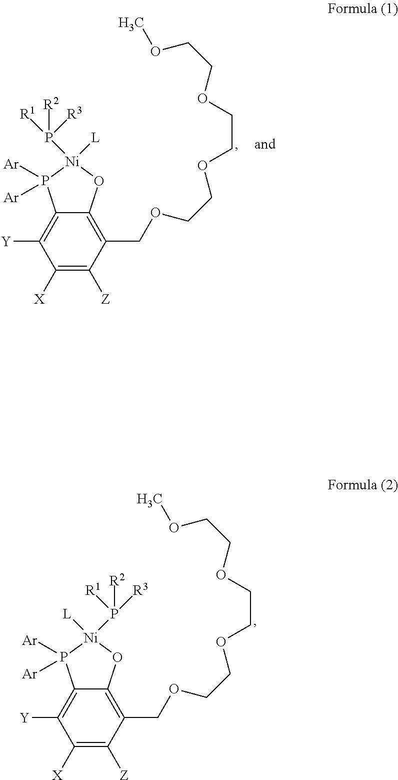

wherein in Formula (1) and Formula (2):
Ar is 2,6-dimethoxyphenyl or 2-methoxyphenyl;
L is an optionally substituted phenyl group;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl;
providing at least one alkali salt;
providing a first optionally substituted olefin;
providing at least one other optionally substituted olefin, wherein the at least one other optionally substituted olefin is an acrylamide, acrylic acid, acrylic ester, vinyl halide, vinyl alcohol, allyl alcohol, or any combination thereof; and contacting the first optionally substituted olefin and the at least one other optionally substituted olefin with the at least one catalyst and the at least one alkali salt, whereby the first optionally substituted olefin and the at least one other optionally substituted olefin undergoes copolymerization, and wherein the first optionally substituted olefin and the at least one other optionally substituted olefin are different from one another.

Embodiment 2C. The method of embodiment 1C, wherein X is selected from hydrogen, an electron donating group, and an electron withdrawing group; and Y and Z are each independently selected from hydrogen, an electron donating group, and an electron withdrawing group, provided that Y and Z are not both hydrogen.

Embodiment 3C. The method of embodiment 1C, wherein the first optionally substituted olefin is ethylene, propene, butene, 1-hexene, 1-heptene, 1-octene, styrene, allylbenzene, 2-hexene, 3-hexene, 2-heptene, 3-heptene, 2-octene, 3-octene, or 4-octene.

Embodiment 4C. The method of embodiment 3C, wherein the at least one other optionally substituted olefin is an acrylic ester.

Embodiment 5C. The method of embodiment 4C, wherein the acrylic ester is methyl acrylate, ethyl acrylate, n-propyl acrylate, isopropyl acrylate, n-butyl acrylate, isobutyl acrylate, or tert-butyl acrylate, or any combination thereof.

Embodiment 6C. The method of embodiment IC, wherein the step of contacting the first optionally substituted olefin and the at least one other optionally substituted olefin with the at least one catalyst and the at least one alkali salt is performed in the presence of at least one solvent.

Embodiment 7C. The method of embodiment 6C, wherein the at least one solvent is a non-polar solvent, a polar solvent, or combination thereof.

Embodiment 8C. The method of embodiment 1C, further comprising contacting at least one activator with the at least one catalyst, the at least one alkali salt, the first optionally substituted olefin, and the at least one other optionally substituted olefin.

Embodiment 9C. The method of embodiment 8C, wherein the at least one activator is selected from the group consisting of Ni(COD)₂, triarylborane, methylaluminoxane, and trialkylaluminum.

Embodiment 10C. A method of degrading a copolymer, comprising:
providing at least one catalyst having a structure selected from Formula (1) and Formula (2):

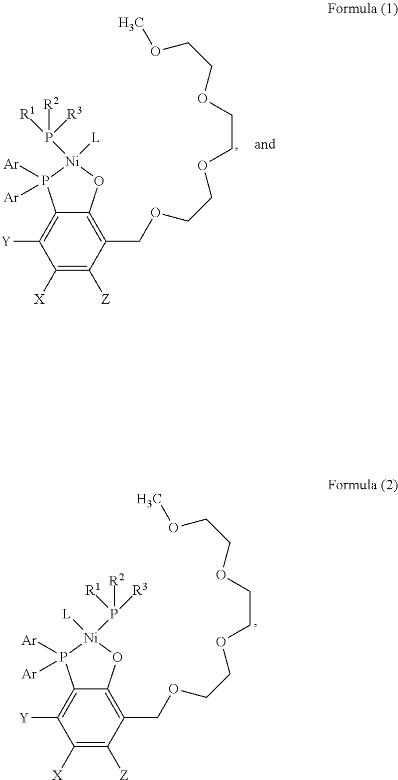

wherein in Formula (1) and Formula (2):
Ar is 2,6-dimethoxyphenyl or 2-methoxyphenyl;
L is an optionally substituted phenyl group;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl;
providing at least one alkali salt;
providing a first optionally substituted olefin,
providing at least one other optionally substituted olefin, wherein the at least one other optionally substituted olefin is an acrylamide, acrylic acid, acrylic ester, vinyl halide, vinyl alcohol, allyl alcohol, or any combination thereof;
contacting the first optionally substituted olefin and the at least one other optionally substituted olefin with the at least one catalyst and the at least one alkali salt, whereby the first optionally substituted olefin and the at least one other optionally substituted olefin undergoes copolymerization to form a copolymer, and wherein the first optionally substituted olefin and the at least one other optionally substituted olefin are different from one another; and
contacting the copolymer with at least one peroxide.

Embodiment 11C. The method of embodiment 10C, wherein X is selected from hydrogen, an electron donating group, and an electron withdrawing group; and Y and Z are each independently selected from hydrogen, an electron donating group, and an electron withdrawing group, provided that Y and Z are not both hydrogen.

Embodiment 12C. The method of claim 10C, wherein the first optionally substituted olefin is ethylene, propene, butene, 1-hexene, 1-heptene, 1-octene, styrene, allylbenzene, 2-hexene, 3-hexene, 2-heptene, 3-heptene, 2-octene, 3-octene, or 4-octene.

Embodiment 13C. The method of embodiment 12C, wherein the at least one other optionally substituted olefin is an acrylic ester.

Embodiment 14C. The method of embodiment 13C, wherein the acrylic ester is methyl acrylate, ethyl acrylate, n-propyl acrylate, isopropyl acrylate, n-butyl acrylate, isobutyl acrylate, or tert-butyl acrylate, or any combination thereof.

Embodiment 15C. The method of embodiment 10C, wherein the step of contacting the first optionally substituted olefin and the at least one other optionally substituted olefin with the at least one catalyst and the at least one alkali salt is performed in the presence of at least one solvent.

Embodiment 16C. The method of embodiment 15C, wherein the at least one solvent is a non-polar solvent, a polar solvent, or combination thereof.

Embodiment 17C. The method of embodiment 10C, further comprising contacting at least one activator with the at least one catalyst, the at least one alkali salt, the first optionally substituted olefin, and the at least one other optionally substituted olefin.

Embodiment 18C. The method of embodiment 17C, wherein the at least one activator is selected from the group consisting of Ni(COD)₂, triarylborane, methylaluminoxane, and trialkylaluminum.

Embodiment 19C. The method of embodiment 10C, wherein the at least one peroxide is at least one organic peroxide, at least one inorganic peroxide, or any combination thereof.

Embodiment 20C. The method of embodiment 10C, wherein the at least one peroxide is tert-butylperoxy 2-ethylhexyl carbonate (TBEC).

Additional embodiments include those listed below.

Embodiment ID. A method for catalyzing copolymerization of a first optionally substituted olefin and at least one other optionally substituted olefin, comprising: providing at least one catalyst having a structure selected from Formula (1) and Formula (2):

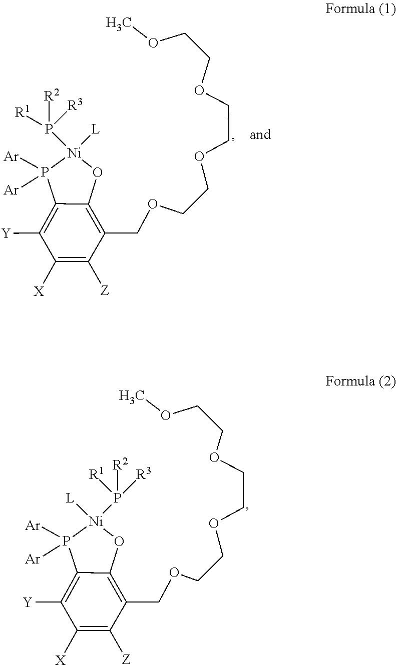

wherein in Formula (1) and Formula (2):
Ar is 2,6-dimethoxyphenyl or 2-methoxyphenyl;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl;
providing at least one alkali salt;
providing a first optionally substituted olefin;
providing at least one other optionally substituted olefin, wherein the at least one other optionally substituted olefin is an acrylamide, acrylic acid, acrylic ester, vinyl halide, vinyl alcohol, or allyl alcohol; and
contacting the first optionally substituted olefin and the at least one other optionally substituted olefin with the at least one catalyst and the at least one alkali salt, whereby the first optionally substituted olefin and the at least one other optionally substituted olefin undergoes copolymerization to form a copolymer, and wherein the first optionally substituted olefin and the at least one other optionally substituted olefin are different from one another.

Embodiment 2D. The method of embodiment 1D, wherein X is selected from hydrogen, an electron donating group, and an electron withdrawing group; and Y and Z are each independently selected from hydrogen, an electron donating group, and an electron withdrawing group, provided that Y and Z are not both hydrogen.

Embodiment 3D. The method of embodiment 1D, wherein the electron donating group is selected from the group consisting of: alkoxy, phenoxy, amino, alkylamino, dialkylamino, hydroxy, alkyl, and cycloalkyl; and the electron withdrawing group is selected from the group consisting of: —NO₂, —CN, —C(O)-alkyl, —C(O)Oalkyl, —C(O)Nalkyl, —SO₃H, —SO₂alkyl, —PO₃H, —PO₃alkyl, —CF₃, and -halo.

Embodiment 4D. The method of embodiment ID, wherein the at least one alkali salt comprises an alkali cation and a weakly coordinating anion.

Embodiment 5D. The method of embodiment 4D, wherein the alkali cation is Li⁺, Na⁺, K⁺, or Cs⁺.

Embodiment 6D. The method of embodiment 4D, wherein the weakly coordinating anion is tetrakis(3,5-bis(trifluoromethyl)phenyl)borate, tetrakis(pentafluorophenyl)borate, tetraphenylborate, trifluoromethylsulfonate, hexafluorophosphate, hexafluoroantimonate, or tetrafluoroborate.

Embodiment 7D. The method of embodiment ID, wherein the at least one alkali salt is lithium tetrakis(3,5-bis(trifluoromethyl)phenyl)borate, sodium tetrakis(3,5-bis(trifluoromethyl)phenyl)borate, potassium tetrakis(3,5-bis(trifluoromethyl)phenyl)borate, or cesium tetrakis(3,5-bis(trifluoromethyl)phenyl)borate, or any combination thereof.

Embodiment 8D. The method of embodiment ID, wherein the first optionally substituted olefin is ethylene, propene, butene, 1-hexene, 1-heptene, 1-octene, styrene, allylbenzene, 2-hexene, 3-hexene, 2-heptene, 3-heptene, 2-octene, 3-octene, or 4-octene.

Embodiment 9D. The method of embodiment 1D, wherein the first optionally substituted olefin is ethylene.

Embodiment 10D. The method of embodiment 8D, wherein the at least one other optionally substituted olefin is an acrylic ester.

Embodiment 11D. The method of embodiment 10D, wherein the acrylic ester is methyl acrylate, ethyl acrylate, n-propyl acrylate, isopropyl acrylate, n-butyl acrylate, isobutyl acrylate, or tert-butyl acrylate, or any combination thereof.

Embodiment 12D. The method of embodiment 9D, wherein the at least one other optionally substituted olefin is an acrylic ester.

Embodiment 13D. The method of embodiment 12D, wherein the acrylic ester is methyl acrylate, ethyl acrylate, n-propyl acrylate, isopropyl acrylate, n-butyl acrylate, isobutyl acrylate, or tert-butyl acrylate, or any combination thereof.

Embodiment 14D. The method of embodiment 1D, wherein the step of contacting the first optionally substituted olefin and the at least one other optionally substituted olefin with the at least one catalyst and the at least one alkali salt is performed in the presence of at least one solvent.

Embodiment 15D. The method of embodiment 14D, wherein the at least one solvent is a non-polar solvent, a polar solvent, or combination thereof.

Embodiment 16D. The method of embodiment ID, further comprising contacting at least one activator with the at least one catalyst, the at least one alkali salt, the first optionally substituted olefin, and the at least one other optionally substituted olefin.

Embodiment 17D. The method of embodiment 16D, wherein the at least one activator is selected from the group consisting of Ni(COD)₂, triarylborane, methylaluminoxane, and trialkylaluminum.

Embodiment 18D. The method of embodiment ID, further comprising contacting the copolymer with at least one peroxide.

Embodiment 19D. The method of embodiment 18D, wherein the at least one peroxide is at least one organic peroxide, at least one inorganic peroxide, or any combination thereof.

Embodiment 20D. The method of embodiment 18D, wherein the at least one peroxide is tert-butylperoxy 2-ethylhexyl carbonate, dicumyl peroxide, polyether poly(t-butyl)-peroxycarbonate, or t-amyl peroxyacetate.

### EXAMPLES

The invention is further illustrated by the following examples which are intended to be purely exemplary of the invention, and which should not be construed as limiting the invention in any way. The following examples are illustrative only, and are not intended to limit, in any manner, any of the aspects described herein. The following examples are provided to better illustrate the claimed invention and are not to be interpreted as limiting the scope of the invention. To the extent that specific materials are mentioned, it is merely for purposes of illustration and is not intended to limit the invention. One skilled in the art may develop equivalent means or reactants without the exercise of inventive capacity and without departing from the scope of the invention.

### General Procedures

Commercial reagents were used as received. All air- and water-sensitive manipulations were performed using standard Schlenk techniques or under a nitrogen atmosphere using a drybox. Anhydrous solvents were obtained from an Innovative Technology solvent drying system saturated with argon. High-purity polymer grade ethylene was obtained from Matheson TriGas without further purification. The LiBAr_{F}⁴, NaBAr^{F}₄, KBAr^{F}₄ and CsBAr^{F}₄ salts were prepared according to literature procedures (Brookhart, M.; Grant, B.; Volpe, A. F., Jr., [(3,5-(CF₃)₂C₆H₃)₄B]—[H(OEt₂)₂]⁺: A Convenient Reagent for Generation and Stabilization of Cationic, Highly Electrophilic Organometallic Complexes. Organometallics 1992, 17 (11), 3920-3922) (Carreras, L.; Rovira, L.; Vaquero, M.; Mon, L; Martin, E.; Benet-Buchholz, J.; Vidal-Ferran, A., Syntheses, characterisation and solid-state study of alkali and ammonium BArF salts. RSC Adv. 2017, 7 (52), 32833-32841).

NMR spectra were acquired using JEOL spectrometers (ECA-400, -500, and -600) and referenced using residual solvent peaks. All ¹³C NMR spectra were proton decoupled. ³¹P NMR spectra were referenced to phosphoric acid. ¹H NMR spectroscopic characterization of polymers: each NMR sample contained ˜20 mg of polymer in 0.5 mL of 1,1,2,2-tetrachloroethane-d₂ (TCE-d₂) and was recorded using a 500 MHz spectrometer with standard acquisition parameters at 120° C.

Gel permeation chromatography (GPC) data were obtained using a Malvern high temperature GPC instrument equipped with refractive index, viscometer, and light scattering detectors at 150° C. with 1,2,4-trichlorobenzene (stabilized with 125 ppm BHT) as the mobile phase. A calibration curve was established using polystyrene standards in triple detection mode. All molecular weights reported are based on the triple detection method.

### Synthesis and Characterization

### Example 1. Preparation of Compound 2

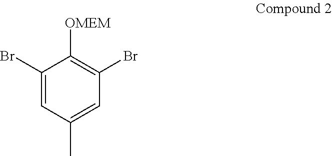

This compound was synthesized using a procedure modified from a literature report (Tran, T. V.; Nguyen, Y. H.; Do, L. H., Development of Highly Productive Nickel-Sodium Phenoxyphosphine Ethylene Polymerization Catalysts and their Reaction Temperature Profiles. Polym. Chem. 2019, 10 (27), 3718-3721). Solid 2,6-dibromo-4-methylphenol (13.3 g, 50 mmol, 1.0 equiv.) was dissolved in 300 mL of dry THF in a 500 mL round bottom flask under nitrogen and cooled to 0° C. Small aliquots of NaH (60%, 4 g, 100 mmol, 2.0 equiv.) were added and the mixture was stirred at room temperature for 2 h. The reagent 2-methoxyethoxymethyl chloride (MEMCl) was added and the resulting mixture was stirred for 2 d. The reaction was quenched by the slow addition of cold H₂O and the products were extracted into Et₂O (3×250 mL). The organic layers were combined, washed with H₂O (3×150 mL), dried over Na₂SO₄, filtered, and evaporated to dryness. The crude material was purified by silica gel column chromatography (4:1 hexane: ethyl acetate) to afford a light yellow oil (15.2 g, 42.9 mmol, 86%). Its 1H and ¹³C NMR spectra were consistent with those reported in the literature. (Tran, T. V.; Nguyen, Y. H.; Do, L. H., Development of Highly Productive Nickel-Sodium Phenoxyphosphine Ethylene Polymerization Catalysts and their Reaction Temperature Profiles. Polym. Chem. 2019, 10 (27), 3718-3721).

### Example 2. Preparation of Compound 3

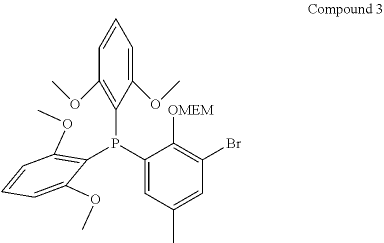

To a solution of 2 (7.08 g, 20 mmol, 1.0 equiv.) in 70 mL of dry THF in a Schlenk flask under nitrogen at −78° C., nBuLi (1.6 M in hexanes, 12.8 mL, 20.5 mmol, 1.02 equiv.) was added dropwise using a syringe pump. The reaction mixture was then stirred at −78° C. for 40 min. A solution containing 8 (6.13 g, 18 mmol, 0.9 equiv.) in 50 mL of dry THE was cannula transferred into the reaction mixture and stirred for another 40 min at −78° C. The mixture was then slowly warmed to RT and stirred overnight for 12 h. The reaction was quenched by the slow addition of H₂O and the products were extracted into Et₂O (3×75 mL). The organic layers were combined, washed with H₂O (2×50 mL), dried over Na₂SO₄, filtered, and evaporated to dryness. The crude material was purified by silica gel column chromatography (1:1 hexane:ethyl acetate) to afford a colorless oil (6.78 g, 11.7 mmol, 65%). ¹H NMR (CDCl₃, 400 MHZ) § 7.21 (b, 3H), 6.72 (b, 1H), 6.48 (b, 4H), 5.24 (s, 2H), 3.84 (b, 2H), 3.49 (b, 12H), 3.33 (s, 3H), 2.13 (b, 2H), 1.58 (b, 2H). ¹³C NMR (CDCl₃, 101 MHz) δ 162.7 (d, J=9.1 Hz), 152.7 (d, J=21.2 Hz), 136.0 (d, J=17.2 Hz), 134.0, 132.5, 132.4, 130.1, 115.8, 113.1, 104.6, 97.2 (d, J=8.1 Hz), 71.9, 69.0, 59.0, 56.0, 20.8. ³¹P NMR (CDCl₃, 162 MHZ) δ −50.0. Mp: 79.8-81.2° C. ESI-MS(+) calc. for C₂₇H₃₂BrO7_{P} [M-H]⁺=579.1142, found 579.1138.

### Example 3. Preparation of Compound 4

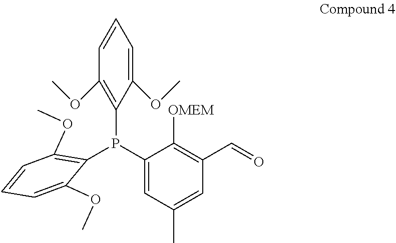

To a solution of 3 (6.78 g, 11.7 mmol, 1.0 equiv.) in 70 mL of dry THF in a Schlenk flask under nitrogen at −78° C., nBuLi (1.6 M in hexanes, 7.7 mL, 12.29 mmol, 1.05 equiv.) was added dropwise using a syringe pump. The reaction mixture was stirred at −78° C. for 40 min. Dry DMF (5 mL, 65 mmol, 5.6 equiv.) was added to the reaction mixture and the flask was stirred for 40 min at −78° C. and then warmed to RT and continued stirring overnight. The reaction was quenched by the slow addition of H₂O and the product was extracted into Et₂O (3×75 mL). The organic layers were combined, washed with H₂O (2×50 mL), dried over Na₂SO₄, filtered, and evaporated to dryness to afford a light yellow oil (4.83 g, 9.13 mmol, 78%). This compound was used directly in the next step without further purification.

### Example 4, Preparation of Compound 5

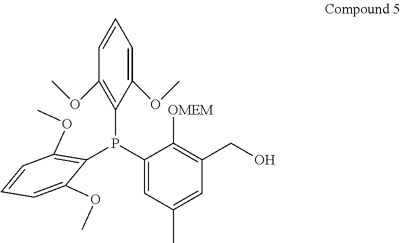

Compound 4 (4.83 g, 9.13 mmol, 1.0 equiv.) was dissolved in 400 mL of MeOH and 80 mL of THF. Small aliquots of NaBH₄ (1.04 g, 27.4 mmol, 3 equiv.) were added and the mixture was stirred at RT overnight. The reaction solvent was removed under vacuum and the residue was redissolved in Et₂O (100 mL). The ether layer was washed with H₂O (2×100 mL), dried over Na₂SO₄, filtered, and evaporated to dryness. The crude material was purified by silica gel column chromatography (2:3 hexane:ethyl acetate) to afford a white solid (2.52 g, 4.75 mmol, 52%). ¹H NMR (CDCl₃, 500 MHz) δ 7.21 (t, J=8.3 Hz, 2H), 7.01 (b, 1H), 6.83 (b, 1H), 6.47 (dd, J=8.2, 2.8 Hz, 4H), 5.16 (s, 2H), 4.55 (d, J=7.1 Hz, 2H), 3.86-3.80 (m, 2H), 3.72 (t, J=7.1 Hz, 1H), 3.58-3.53 (m, 2H), 3.46 (s, 12H), 3.35 (s, 3H), 2.15 (s, 3H). ¹³C NMR (CDCl₃, 126 MHz) δ 162.7 (d, J=8.8 Hz), 156.8 (d, J=22.7 Hz), 133.9, 133.1, 132.8, 132.7, 130.6, 130.0, 113.2, 104.5, 99.0 (d, J=13.3 Hz), 71.5, 68.8, 61.3, 59.1, 55.9, 21.0. ³¹P NMR (CDCl₃, 202 MHz) δ −52.6. Mp: 131.1-132.7° C. ESI-MS(+) calc. for C₂₈H₃₅O₂P [M-H]⁺=531.2142, found 531.2142.

### Example 5. Preparation of Compound 6

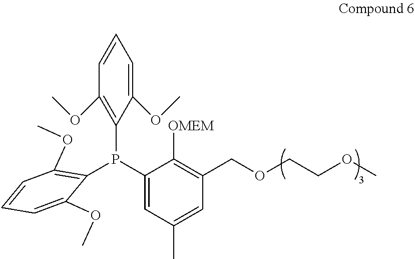

To a solution containing 5 (2.52 g, 4.75 mmol, 1 equiv.) in 100 mL of dry THF in a Schlenk flask under nitrogen at −0° C., small aliquots of NaH (60%, 0.76 g, 19 mmol, 4 equiv.) were added. The reaction mixture was stirred at RT for 1 h. A solution containing compound 9 (4.9 g, 11.4 mmol, 2.0 equiv.) in 50 mL of THF was cannula transferred into the reaction mixture and then stirred at RT for 2 d. The reaction was quenched by the slow addition of cold H₂O and the product was extracted into Et₂O (3×100 mL). The organic layers were combined, washed with H₂O (2×75 mL), dried over Na₂SO₄, filtered, and evaporated to dryness. The crude material was purified by silica gel column chromatography (1:4 hexane:ethyl acetate to 97:3 ethyl acetate: methanol) to afford a colorless oil (1.51 g, 2.23 mmol, 47%). This compound was used directly in the next step without further purification.

### Example 6. Preparation of Compound 7

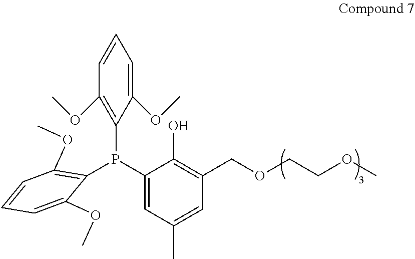

Compound 6 (1.51 g, 2.23 mmol, 1 equiv.) was dissolved in 100 mL of MeOH and then treated with 10 mL of 2 M HCl in Et₂O. The reaction mixture was stirred at RT overnight. The solvent was removed under vacuum and the product was dissolved in 200 mL of EtOAc. A 50 mL solution of 1 M NaHCO₃ in H₂O was then added. The mixture was stirred at RT for 30 min and the product was extracted into Et₂O (2×100 mL). The organic layers were combined, washed with H₂O (2×100 mL), dried over Na₂SO₄, filtered, and evaporated to dryness. The crude material was washed with hexane to afford a white waxy solid (1.12 g, 1.9 mmol, 85%). ¹H NMR (CDC), 400 MHZ) δ 7.20 (d, J=8.3 Hz, 2H), 7.17-7.15 (m, 1H), 7.10 (s, 1H), 6.98 (s, 1H), 6.47 (dd, J=8.3, 2.9 Hz, 4H), 4.57 (s, 2H), 3.68-3.59 (m, 10H), 3.52 (s, 14H), 3.36 (s, 3H), 2.18 (s, 3H). ¹³C NMR (CDCl₃, 101 MHz) δ 162.0 (d, J=9.1 Hz), 154.9 (d, J=8.1 Hz), 135.1, 134.8, 129.8, 127.4 (d, J=11.1 Hz), 123.1 (d, J=11.1 Hz), 122.5, 113.0, 112.8, 104.3, 77.3, 72.0, 70.7, 70.7, 70.6, 69.6, 59.1, 55.8, 20.7. ³¹P NMR (CDCl₃, 162 MHZ) δ −59.76. Mp: 113.9-115.1° C. ESI-MS(+) calc. for C31H41O9P [M-H]⁺=589.2561, found 531.2548.

### Example 7. Preparation of Complex Ni2

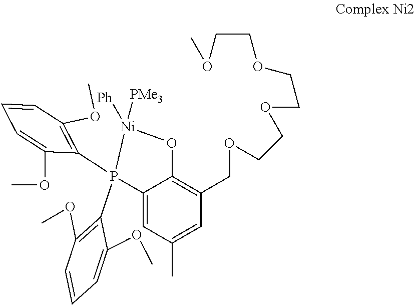

Inside the glovebox, ligand 7 (0.62 g, 1.05 mmol, 1.0 equiv.) was dissolved in 50 mL of dry THF. Small aliquots of NaH (60%, 0.08 g, 2.10 mmol, 2.0 equiv.) were added and the mixture was stirred at RT for 2 h. The mixture was filtered to remove excess NaH and then a solution of NiPhBr(PMe₃)₂ (0.3 g, 0.95 mmol, 0.9 equiv.) in 20 mL of benzene was added. The resulting mixture was stirred at RT overnight. The next day, the solution was filtered to remove the precipitate and the filtrate was dried completely under vacuum. The crude material was dissolved in a mixture of 10 mL of pentane and 5 mL of benzene. Another filtration was performed to remove the precipitate and the filtrate was dried once again. Finally, the resulting solid was washed with pentane (3×5 mL) and dried under vacuum to afford a yellow viscous material (0.35 g, 0.43 mmol, 45%). ¹H NMR (C₆D₆, 500 MHz) δ 7.60 (d, J=10.0 Hz, 1H), 7.36 (s, 1H), 7.26 (d, J=10.0 Hz, 2H), 7.03 (t, J=10.0 Hz, 2H), 6.79 (t, J=10.0 Hz, 2H), 6.67 (t, J=5.0 Hz, 1H), 6.21 (dd, J=10.7, 4.3 Hz, 4H), 4.96 (s, 2H), 3.83 (t, J=5.0 Hz, 2H), 3.68 (t, J=5.0 Hz, 2H), 3.59-3.49 (m, 6H), 3.36 (t, J=5.0 Hz, 3H), 3.13 (b, 14H), 2.21 (s, 3H), 0.92 (d, J=15.0 Hz, 9H) ppm. ¹³C NMR (CDCl₃, 500 MHz) δ 162.03, 161.95, 154.94, 154.86, 135.14, 134.82, 129.81, 127.52, 127.41, 123.20, 123.08, 122.54, 113.00, 112.82, 104.37, 77.36, 72.05, 70.76, 70.72, 70.65, 69.59, 59.18, 55.89, 20.76 ppm. ³¹P NMR (C₆D₆, 162 MHz) δ −4.27 (d, J=317.5 Hz), −15.54 (d, J=317.5 Hz). Mp (decomp.)=˜102° C., note: the phosphine moiety is readily oxidized in air. Anal. Calcd for C₄₀H₅₄NiO₉P₂: C, 60.02; H, 6.93. Found: C, 59.50; H, 6.77.

### Example 8. Preparation of Compound 8

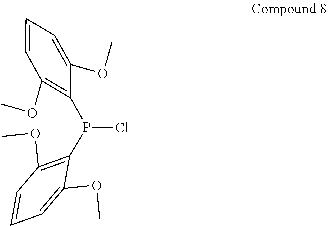 [SMILES: COc1cccc(OC)c1P(Cl)c1c(OC)cccc1OC]

This synthesis was modified from a reported procedure (Shimizu, F.; Xin, S.; Tanna, A., Goromaru, S.; Matsubara, K. Metal Complexes and Method for Producing α-Olefin/(Meth)Acrylate Copolymer Using the Same. U.S. Pat. No. 8,618,319 B2, 2013). A 200 mL Schlenk flask was charged with magnesium turnings (1.2 g, 50 mmol, 2.5 equiv.) under nitrogen in 50 mL of dry THE. The compound 2-bromo-3-methoxyanisole (8.68 g, 40 mmol, 2.0 equiv.) was added to the reaction mixture and then stirred at RT for 3 h until the solution turned dark gray. The resulting Grignard reagent was slowly cannula transferred over a period of 45 min to a solution containing PCl₃ (1.6 mL, 20 mmol, 1.0 equiv.) in 100 mL of dry THF at −78° C. After the addition was complete, the heterogeneous mixture was continued stirring at RT overnight. Finally, the solvent was removed under vacuum and the crude product was used in the next step without further purification.

### Example 9. Preparation of Compound 9

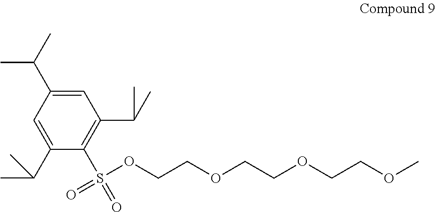 [SMILES: COCCOCCOCCOS(=O)(=O)c1c(C(C)C)cc(C(C)C)cc1C(C)C]

This synthesis was modified from a reported procedure (Tran, T. V.; Nguyen, Y. H.; Do, L. H., Development of Highly Productive Nickel-Sodium Phenoxyphosphine Ethylene Polymerization Catalysts and their Reaction Temperature Profiles. Polym. Chem. 2019, 10 (27), 3718-3721). Triethylene glycol monomethyl ether (4.93 g, 30 mmol, 1.0 equiv.) was dissolved in 300 mL of dry THF in a 500 mL round bottom flask under nitrogen and cooled to 0° C. Small aliquots of NaH (60%, 2.4 g, 60 mmol, 2 equiv.) were added and the mixture was stirred at RT for 2 h. The reagent 2,4,6-triisopropylbenzenesulfonyl chloride (13.6 g, 45 mmol, 1.5 equiv.) was added and the solution was stirred for 2 d. The reaction was quenched by the slow addition of cold H₂O and the product was extracted into Et₂O (2×250 mL). The organic layers were combined, washed with H₂O (2×200 mL), dried over Na₂SO₄, filtered, and evaporated to dryness. The crude material was purified by silica gel column chromatography (5:1 hexane:ethyl acetate to 1:3 hexane:ethyl acetate) to afford a colorless oil (7.9 g, 18.3 mmol, 61%). Its ¹H and ¹³C NMR spectra were consistent with those reported in previous literature. (Tran, T. V.; Nguyen, Y. H.; Do, L. H., Development of Highly Productive Nickel-Sodium Phenoxyphosphine Ethylene Polymerization Catalysts and their Reaction Temperature Profiles. Polym. Chem. 2019, 10 (27), 3718-3721).

### Example 10. Metal Binding Studies

Job Plot Studies: UV-Vis Absorption Spectroscopy. Stock solutions of Ni2 (500 μM) and MBAr^{F}₄ (500 μM) (M=Li, Na, K and Cs) in Et₂O were prepared in separate volumetric flasks inside the drybox. The stock solutions of Ni2 and MBAr^{F}₄ were combined in different ratios to give 10 different samples, each having a final volume of 3.0 mL. The samples were recorded by UV-vis absorption spectroscopy at RT.

The UV-vis spectral data were analyzed according to the method reported by Hirose (Hirose, K., A Practical Guide for the Determination of Binding Constants. J. Incl. Phenom. Macrocycl. 2001, 39 (3), 193-209). In our case, the host (H) is Ni2, the guest (g) is M⁺, and the complex (C) is Ni2-M. Since the alkali salt has no absorption in the 300-500 nm range, we used this simplified expression to analyze the data: A_{obs}−εₕ·[H]=(ε_{C}−a·εₕ)·[C], where A_{obs}=observed absorbance, a=constant, εₕ=molar absorptivity of host Ni2, ε_{C}=molar absorptivity of Ni2-M, [H]ₜ⁻ starting concentration of host Ni2, and [C]=observed concentration of Ni2-M. Since [C] is proportional to A_{obs}−εₕ·[H]ₜ, a Job Plot was constructed by plotting A_{obs}−εₕ·[H]ₜ vs. χ_{Ni} (the mole ratio of Ni2=[Ni2]/([Ni2]+[M])).

TABLE 3
Job Plot Data and Calculations for Ni2—Li^{a}

| | Volume | Amount of | Final | | | |
|---|---|---|---|---|---|---|
| | of H | H Added | Conc. of | Aₕ | A_{obs} | |
| χ^{Ni} | (mL) | (mol) | H (M) | (calculated) | (@379 nm) | Aₕ − A_{obs} |
| 1.0 | 3.000E−03 | 1.500E−06 | 5.000E−04 | 1.733E+00 | 1.733E+00 | 0.000E+00 |
| 0.9 | 2.700E−03 | 1.350E−06 | 4.500E−04 | 1.560E+00 | 1.469E+00 | 9.125E−02 |
| 0.8 | 2.400E−03 | 1.200E−06 | 4.000E−04 | 1.387E+00 | 1.200E+00 | 1.869E−01 |
| 0.7 | 2.100E−03 | 1.050E−06 | 3.500E−04 | 1.213E+00 | 9.267E−01 | 2.866E−01 |
| 0.6 | 1.800E−03 | 9.000E−07 | 3.000E−04 | 1.040E+00 | 6.466E−01 | 3.934E−01 |
| 0.5 | 1.500E−03 | 7.500E−07 | 2.500E−04 | 8.667E−01 | 3.901E−01 | 5.607E−01 |
| 0.4 | 1.200E−03 | 6.000E−07 | 2.000E−04 | 6.933E−01 | 1.326E−01 | 4.765E−01 |
| 0.3 | 9.000E−04 | 4.500E−07 | 1.500E−04 | 5.200E−01 | 9.452E−02 | 4.255E−01 |
| 0.2 | 6.000E−04 | 3.000E−07 | 1.000E−04 | 3.467E−01 | 6.246E−02 | 2.842E−01 |
| 0.1 | 3.000E−04 | 1.500E−07 | 5.000E−05 | 1.733E−01 | 3.313E−02 | 1.402E−01 |
| 0.0 | 0.000E+00 | 0.000E+00 | 0.000E+00 | 0.000E+00 | 4.206E−03 | -4.206E−03 |

^{a}The molar absorptivity of H (εₕ) at 379 nm = 3470 M⁻¹cm⁻¹. Stock solution of H is 500 μM.

FIG. 12. Job Plot showing the coordination interactions between complex Ni2 and LiBAr_{F}⁴. The peak maximum occurs at χ_{Ni}=0.5, which suggests that the optimal nickel:lithium binding stoichiometry is 1:1. The y-axis value (A_{obs}−εₕ*[H]ₜ) is proportional to the concentration of the nickel-sodium complex Ni2-Li. The x-axis is the molar ratio of nickel (χ_{Ni}=[Ni2]/([Ni2]+[Li⁺])).

TABLE 4
Job Plot Data and Calculations Used for Ni2—Na^{a}

| | Volume | Amount of | Final | | | |
|---|---|---|---|---|---|---|
| | of of H | H Added | Conc. of | Aₕ | A_{obs} | |
| χ^{Ni} | (mL) | (mol) | H (M) | (calculated) | (@330 nm) | A_{obs} − Aₕ |
| 1 | 3.000E−03 | 1.500E−06 | 5.000E−04 | 1.842E+00 | 1.842E+00 | 0.000E+00 |
| 0.9 | 2.700E−03 | 1.350E−06 | 4.500E−04 | 1.658E+00 | 1.493E+00 | 1.650E−01 |
| 0.8 | 2.400E−03 | 1.200E−06 | 4.000E−04 | 1.474E+00 | 1.222E+00 | 2.522E−01 |
| 0.7 | 2.100E−03 | 1.050E−06 | 3.500E−04 | 1.290E+00 | 8.973E−01 | 3.924E−01 |
| 0.6 | 1.800E−03 | 9.000E−07 | 3.000E−04 | 1.105E+00 | 5.726E−01 | 5.328E−01 |
| 0.5 | 1.500E−03 | 7.500E−07 | 2.500E−04 | 9.212E−01 | 2.783E−01 | 6.429E−01 |
| 0.4 | 1.200E−03 | 6.000E−07 | 2.000E−04 | 7.369E−01 | 2.128E−01 | 5.242E−01 |
| 0.3 | 9.000E−04 | 4.500E−07 | 1.500E−04 | 5.527E−01 | 1.669E−01 | 3.858E−01 |
| 0.2 | 6.000E−04 | 3.000E−07 | 1.000E−04 | 3.685E−01 | 1.126E−01 | 2.559E−01 |
| 0.1 | 3.000E−04 | 1.500E−07 | 5.000E−05 | 1.842E−01 | 7.146E−02 | 1.128E−01 |
| 0 | 0.000E+00 | 0.000E+00 | 0.000E+00 | 0.000E+00 | 1.965E−02 | −1.965E−02 |

^{a}The molar absorptivity of H (εₕ) at 379 nm = 3680 M⁻¹cm⁻¹. Stock solution of H is 500 μM.

FIG. 13. Job Plot showing the coordination interactions between complex Ni2 and NaBAr^{F}₄. The peak maximum occurs at χ_{Ni}=0.5, which suggests that the optimal nickel:sodium binding stoichiometry is 1:1. The y-axis value (A_{obs}−εₕ·[H]ₜ) is proportional to the concentration of the nickel-sodium complex Ni2-Na. The x-axis is the molar ratio of nickel (χ_{Ni}=[Ni2]/([Ni2]+[Na⁺])).

TABLE 5
Job Plot Data and Calculations Used for Ni2—K^{a}

| | Volume of | Amount of | Final | | | |
|---|---|---|---|---|---|---|
| | of H | H Added | Conc. of H | Aₕ | A_{obs} | |
| χ^{Ni} | (mL) | (mol) | (M) | (calculated) | (@330 nm) | A_{obs} − Aₕ |
| 1 | 3.000E−03 | 1.500E−06 | 5.000E−04 | 1.680E+00 | 1.680E+00 | 0.000E+00 |
| 0.9 | 2.700E−03 | 1.350E−06 | 4.500E−04 | 1.510E+00 | 1.384E+00 | 1.280E−01 |
| 0.8 | 2.400E−03 | 1.200E−06 | 4.000E−04 | 1.340E+00 | 1.121E+00 | 2.230E−01 |
| 0.7 | 2.100E−03 | 1.050E−06 | 3.500E−04 | 1.180E+00 | 8.467E−01 | 3.290E−01 |
| 0.6 | 1.800E−03 | 9.000E−07 | 3.000E−04 | 1.010E+00 | 5.668E−01 | 4.410E−01 |
| 0.5 | 1.500E−03 | 7.500E−07 | 2.500E−04 | 8.400E−01 | 3.145E−01 | 5.250E−01 |
| 0.4 | 1.200E−03 | 6.000E−07 | 2.000E−04 | 6.720E−01 | 2.332E−01 | 4.390E−01 |
| 0.3 | 9.000E−04 | 4.500E−07 | 1.500E−04 | 5.040E−01 | 1.534E−01 | 3.510E−01 |
| 0.2 | 6.000E−04 | 3.000E−07 | 1.000E−04 | 3.360E−01 | 9.725E−02 | 2.390E−01 |
| 0.1 | 3.000E−04 | 1.500E−07 | 5.000E−05 | 1.680E−01 | 7.084E−02 | 9.720E−02 |
| 0 | 0.000E+00 | 0.000E+00 | 0.000E+00 | 0.000E+00 | 9.125E−04 | −9.130E−04 |

^{a}The molar absorptivity of H (εₕ) at 379 nm = 3360 M⁻¹cm⁻¹. Stock solution of His 500 μM.

FIG. 14. Job Plot showing the coordination interactions between complex Ni2 and KBAr^{F}₄. The peak maximum occurs at χ_{Ni}=0.5, which suggests that the optimal nickel potassium binding stoichiometry is 1:1. The y-axis value (A_{obs}−εₕ·[H]ₜ) is proportional to the concentration of the nickel-potassium complex Ni2-K. The x-axis is the molar ratio of nickel (χ_{Ni}=[Ni2]/([Ni2]+[Na⁺])).

TABLE 6
Job Plot Data and Calculations Used for Ni2—Cs^{a}

| | Volume | Amount of | Final | | | |
|---|---|---|---|---|---|---|
| | of H | H Added | Conc. of H | Aₕ | A_{obs} | |
| χ^{Ni} | (mL) | (mol) | (M) | (calculated) | (@330 nm) | A_{obs} − Aₕ |
| 1 | 3.000E−03 | 1.500E−06 | 5.000E−04 | 1.649E+00 | 1.649E+00 | 0.000E+00 |
| 0.9 | 2.700E−03 | 1.350E−06 | 4.500E−04 | 1.485E+00 | 1.466E+00 | 1.885E−02 |
| 0.8 | 2.400E−03 | 1.200E−06 | 4.000E−04 | 1.320E+00 | 1.231E+00 | 8.835E−02 |
| 0.7 | 2.100E−03 | 1.050E−06 | 3.500E−04 | 1.155E+00 | 1.007E+00 | 1.480E−01 |
| 0.6 | 1.800E−03 | 9.000E−07 | 3.000E−04 | 9.897E−01 | 7.914E−01 | 1.983E−01 |
| 0.5 | 1.500E−03 | 7.500E−07 | 2.500E−04 | 8.247E−01 | 6.064E−01 | 2.183E−01 |
| 0.4 | 1.200E−03 | 6.000E−07 | 2.000E−04 | 6.598E−01 | 4.728E−01 | 1.870E−01 |
| 0.3 | 9.000E−04 | 4.500E−07 | 1.500E−04 | 4.948E−01 | 3.575E−01 | 1.374E−01 |
| 0.2 | 6.000E−04 | 3.000E−07 | 1.000E−04 | 3.299E−01 | 2.236E−01 | 1.063E−01 |
| 0.1 | 3.000E−04 | 1.500E−07 | 5.000E−05 | 1.649E−01 | 1.284E−01 | 3.653E−02 |
| 0 | 0.000E+00 | 0.000E+00 | 0.000E+00 | 0.000E+00 | 5.027E−03 | −5.027E−03 |

^{a}The molar absorptivity of H (εₕ) at 379 nm = 3300 M⁻¹cm⁻¹. Stock solution of His 500 μM.

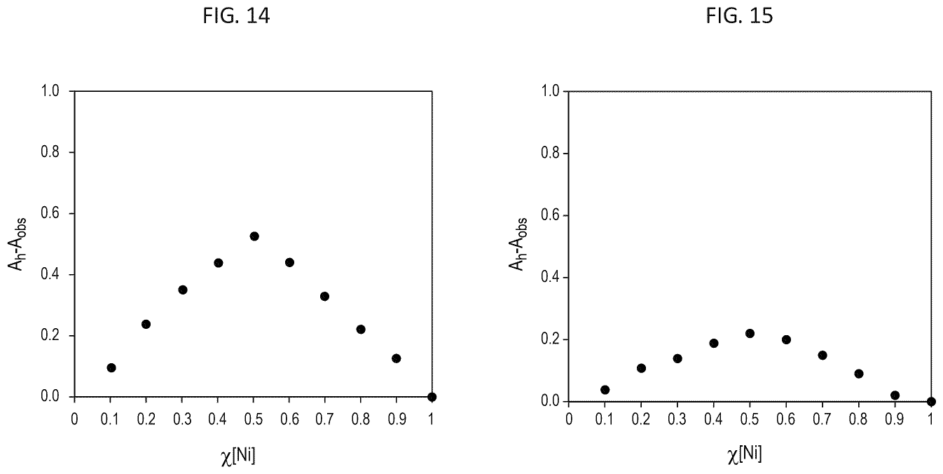

FIG. 15. Job Plot showing the coordination interactions between complex Ni2 and CsBAr^{F}₄. The peak maximum occurs at χ_{Ni}=0.5, which suggests that the optimal nickel:cesium binding stoichiometry is 1:1. The y-axis value (A_{obs}−εₕ·[H]ₜ) is proportional to the concentration of the nickel-cesium complex Ni2-Cs. The x-axis is the molar ratio of nickel (χ_{Ni}=[Ni2]/([Ni2]+[Cs⁺])).

TABLE 7
Comparison of the ³¹P NMR Chemical
Shifts for the Nickel Complexes^{a}

| | trans-Ni Species | cis-Ni Species |
|---|---|---|
| Complex | (³¹P NMR, ppm) | (³¹P NMR, ppm) |
| Ni1 | 13.34 (d. J = 325.6 Hz) | — |
| | −12.05 (d, J = 335.3 Hz) | |
| Ni1—Li | 7.95 (broad d, J = 328.0 Hz) | 5.49 (d, J = 31.6 Hz) |
| | −18.28 (d, J = 345 Hz) | −8.62 (d, J = 31.6 Hz) |
| Ni1—Na | 10.34 (broad d, J = 318.3 Hz) | 10.46 (d, J = 36.4 Hz) |
| | −16.56 (d, J = 318.3 Hz) | −8.82 (d, J = 36.4 Hz) |
| Ni1—K | 10.53 (broad d, J = 306.2 Hz) | 10.70 (d. J = 36.4 Hz) |
| | −16.17 (d, J = 315.9 Hz) | −8.41 (d, J = 34.0 Hz) |
| Ni1—Cs | 12.06 (d, J = 330.5 Hz) | 10.96 (d, J = 38.9 Hz) |
| | −13.18 (d, J = 315.9 Hz) | −9.42 (d, J = 34.0 Hz) |
| Ni2 | −3.48 (d, J = 314.6 Hz) | — |
| | −14.02 (d, J = 317.0 Hz) | |
| Ni2—Li | −11.42 (d, J = 318.3 Hz) | −9.49 (d, J = 34.0 Hz) |
| | −19.86 (d. J = 318.3 Hz) | −16.16 (d, J = 36.4 Hz) |
| Ni2—Na | −5.53 (d, J = 315.9 Hz) | −8.18 (broad s) |
| | −16.92 (d, J = 313.5 Hz) | |
| Ni2—K | −5.32 (d, J = 313.5 Hz) | −8.06 (s) |
| | −17.07 (d, J = 315.9 Hz) | −8.21 (s) |
| Ni2—Cs | −4.58 (d, J = 318.3 Hz) | −6.76 (d, J = 36.4 Hz) |
| | −16.46 (d, J = 318.3 Hz) | −8.72 (d, J = 36.4 Hz) |

^{a}NMR spectra (243 MHz) were acquired in toluene-d₈/Et₂O-d₁₀ (4:1) at RT.

TABLE 8
Comparison of the trans and cis Distribution
of Nickel Complexes in Solution^{a}

| | trans-Ni Species | cis-Ni Species | |
|---|---|---|---|
| Complex | (%) | (%) | K_{cis/trans} |
| Ni1 | 100 | 0 | — |
| Ni1—Li | 90 | 10 | 0.1 |
| Ni1—Na | 10 | 90 | 9.0 |
| Ni1—K | 12 | 88 | 7.3 |
| Ni1—Cs | 67 | 33 | 0.5 |
| Ni2 | 100 | 0 | — |
| Ni2—Li | 15 | 85 | 5.7 |
| Ni2—Na | 46 | 54 | 1.2 |
| Ni2—K | 39 | 61 | 1.6 |
| Ni2—Cs | 87 | 13 | 0.1 |

^{a}Percentages of cis and trans species were calculated from integration of the complex's ³¹P NMR spectra in toluene-d₈/Et₂O-d₁₀ (4:1) at RT.

### Example 11. Metal Titration: UV-Vis Absorption Spectroscopy

Stock solutions of Ni2 and CsBAr^{F}₄ were prepared inside an inert nitrogen-filled glovebox. A 500 μM stock solution of Ni2 were obtained by dissolving 25 μmol of Ni2 in 50 mL of Et₂O/toluene (1:1). A 10 mL aliquot of this 500 μM solution was diluted to 50 mL using a volumetric flask to give a final concentration of 100 μM. The 3.0 mM stock solution of CsBAr^{F}₄ was obtained by dissolving 30 μmol of CsBAr^{F}₄ in 10 mL of Et₂O/toluene (1:1) using a volumetric flask. A 3.0 mL solution of Ni2 was transferred to a 1 cm quartz cuvette and then sealed with a septum screw cap. A 100 μL airtight syringe was loaded with the 3.0 mM solution of MBAr^{F}₄. The cuvette was placed inside a UV-vis spectrophotometer and the spectrum of the Ni2 solution was recorded. Aliquots containing 0.25 equiv. of CsBAr^{F}₄ (25 L), relative to the nickel complex, were added and the solution was allowed to reach equilibrium before the spectra were measured (about 10-20 min). The titration experiments were stopped after the addition of up to 2.0 equiv. of MBAr^{F}₄.

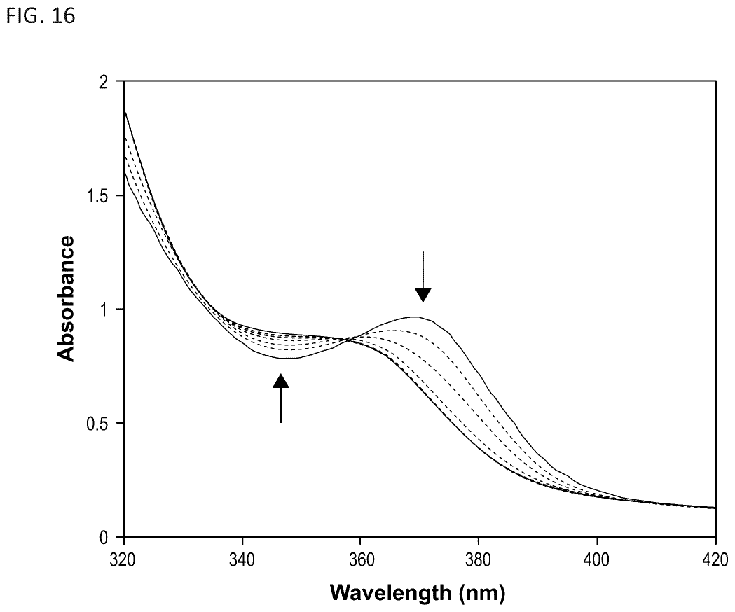

FIG. 16. UV-vis absorbance spectra of complex Ni2 (100 μM in 1:1 Et₂O/Toluene) after the addition of up to 2.0 equiv. of CsBAr^{F}₄. The starting trace of Ni2 is shown in black and the final trace (+2.0 equiv. of Cs⁺ relative to Ni) is shown in red.

### Example 12. Metal Exchange Studies: NMR Spectroscopy

Stock solutions of Ni2 and CsBAr^{F}₄ were prepared inside an inert nitrogen-filled glovebox. Solid Ni2 (10 mg, 12.5 μmol) was dissolved in 2 mL of Et₂O inside a 20 mL scintillation vial. A solution containing CsBAr^{F}₄ (if any, stock solution in Et₂O) was added and the mixture was stirred until it became clear. The resulting solution was dried under vacuum for at least 3 h to completely remove the Et₂O solvent and then dissolved in 0.6 deuterated NMR solvent for NMR characterization.

For the experiments using toluene-d₈/hexane-d₁₄, after drying for 3 h, 5 mL of pentane was added and the vial was well shaken and dried again for another 3 h prior to measuring the sample by NMR spectroscopy.

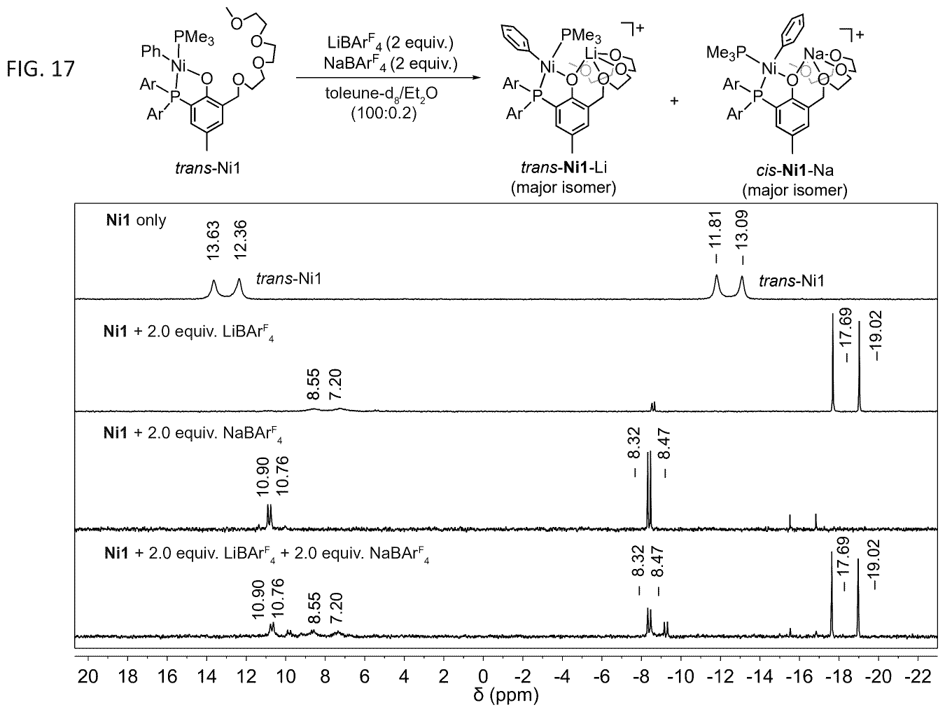

FIG. 17. ³¹P NMR spectra (202 MHz) of complex Ni1 only, Ni1 with LiBAr_{F}⁴, Ni1 with NaBAr_{F}⁴, or Ni1 with LiBAr^{F}₄/NaBAr^{F}₄ in toluene-d₈/Et₂O (100:0.2). The presence of both trans-Ni1-Li and cis-Ni1-Na species observed in spectrum of Ni1 with LiBAr_{F}⁴/NaBAr^{F}₄ indicate that the cations are not exchanging under these conditions. Furthermore, no mononuclear Ni1 was detected in this sample.

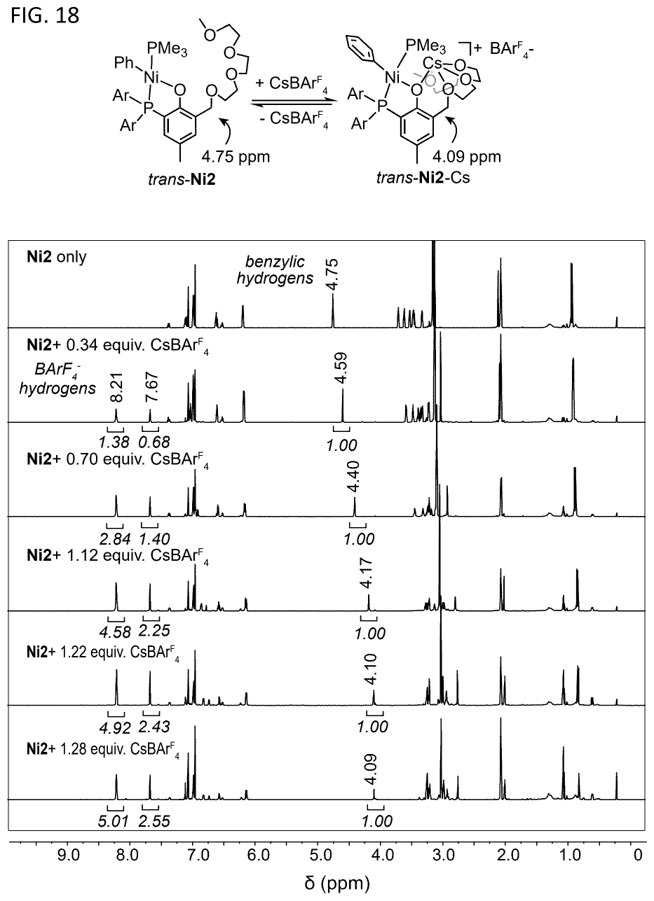

FIG. 18. ¹H NMR spectra (600 MHz) of complex Ni2 (20.8 mM) before and after the addition of various equivalence of CsBAr^{F}₄ in toluene-d₈:Et₂O-d₁₀ (98:2) at 60° C. The benzylic hydrogen peak at 4.75 ppm shifts upfield upon the introduction of Cs⁺. The presence of only one species in different nickel:cesium ratios suggests that cation exchange is fast on the ³¹P NMR timescale under these conditions. The relative amounts of cesium salt present in each sample were calculated based on the peak integration values for the benzylic vs. BAr^{F}₄⁻ hydrogen atoms.

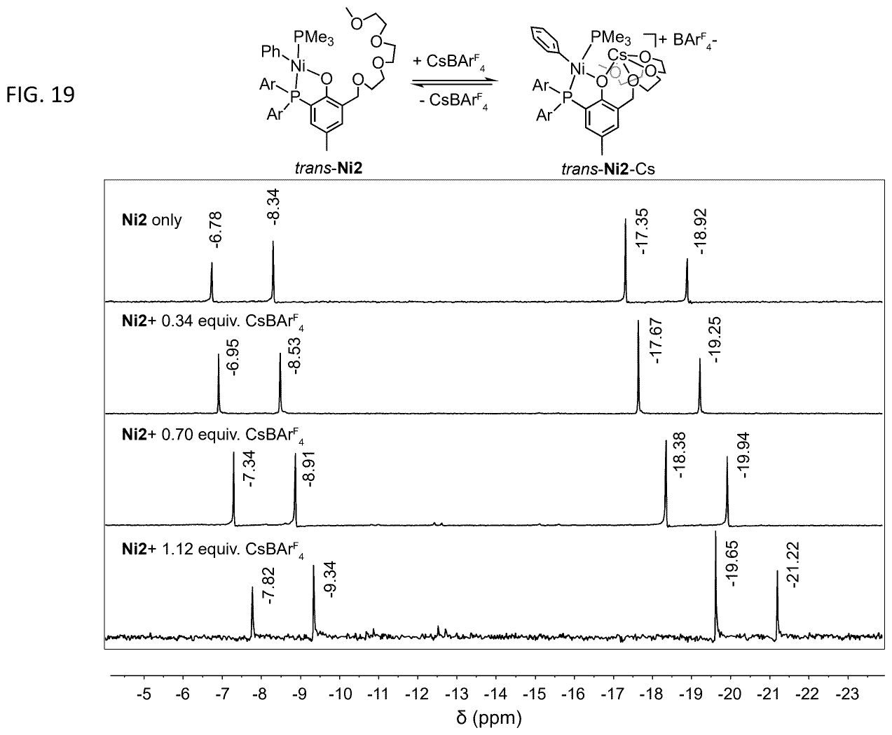

FIG. 19. ³¹P NMR spectra (202 MHz) of complex Ni2 (80 mM) before and after the addition of various equivalence of CsBAr^{F}₄ in toluene-d₈:Et₂O (98:2) at 60° C. The relative amounts of cesium salt present in each sample were calculated based on the peak integration values for the benzylic vs. BAr^{F}₄⁻ hydrogen atoms in FIG. 17. These results suggest that the polymerizations performed in Table 14 are under dynamic switching conditions.

FIG. 20. ¹H NMR spectra (400 MHz) of complex Ni2 (9.0 mM) before and after the addition of various equivalence of CsBAr^{F}₄ in toluene-d₈:hexane-d₁₄ (1:3) at RT. The relative amounts of cesium salt present in each sample were calculated based on the peak integration values for the benzylic vs. BAr^{F}₄⁻ hydrogen atoms, not on the amount of salt added in the experiment. Spectrum with Ni2+0.32 equiv. Cs⁺ shows two different sets of aromatic C—H peaks corresponding to the BAr^{F}₄⁻ anion.

FIG. 21. ¹H NMR spectra (400 MHZ) showing the PEG region of complex Ni2 (9.0 mM) before and after the addition of various equivalence of CsBAr^{F}₄ in toluene-d₈:hexane-d₁₄ (1:3) at RT. The full spectra are shown in FIG. 20. The relative amounts of cesium salt present in each sample were calculated based on the peak integration values for the benzylic vs. BAr^{F}₄⁻ hydrogen atoms, not on the amount of salt added in the experiment.

### Example 13. BindFit Analysis of NMR Data

The ¹H NMR titration data for Ni2+CsBAr^{F}₄ (FIG. 18) were analyzed using the Program BindFit (suprmolcular.org) (Thordarson, P., Determining association constants from titration experiments in supramolecular chemistry. Chem. Soc. Rev. 2011, 40 (3), 1305-1323), (Brynn Hibbert, D.; Thordarson, P., The death of the Job plot, transparency, open science and online tools, uncertainty estimation methods and other developments in supramolecular chemistry data analysis. Chem. Commun. 2016, 52 (87), 12792-12805) . A plot of [Cs⁺]/[Ni2] (where [Cs⁺]₀ and [Ni2]₀ are the total equiv. of cesium salt and nickel complex added, respectively) vs. the chemical shift of the benzyl hydrogen signal in Ni2 was generated. A 1:1 binding model was used to fit the data using the L-BFGS-B method. Different initial guests for Kₐ were attempted and the fit that gave the smallest error was deemed the best fit.

FIG. 22. Plot of the titration data in FIG. 18 for the binding of Cs⁺ to Ni2 in toluene-d₈:Et₂O-d₁₀ (98:2) at RT. The data were fit using BindFit to a 1:1 binding model to yield Kₐ=199±139 M⁻¹ (data points are shown as black dots and the fit is shown as a black curve). Without being bound by theory, the large error in the calculated Kₐ is most likely due to the lack of data points in the saturated region of the curve, which was not possible to obtain because CsBAr^{F}₄ has low solubility of in the solvent mixture.

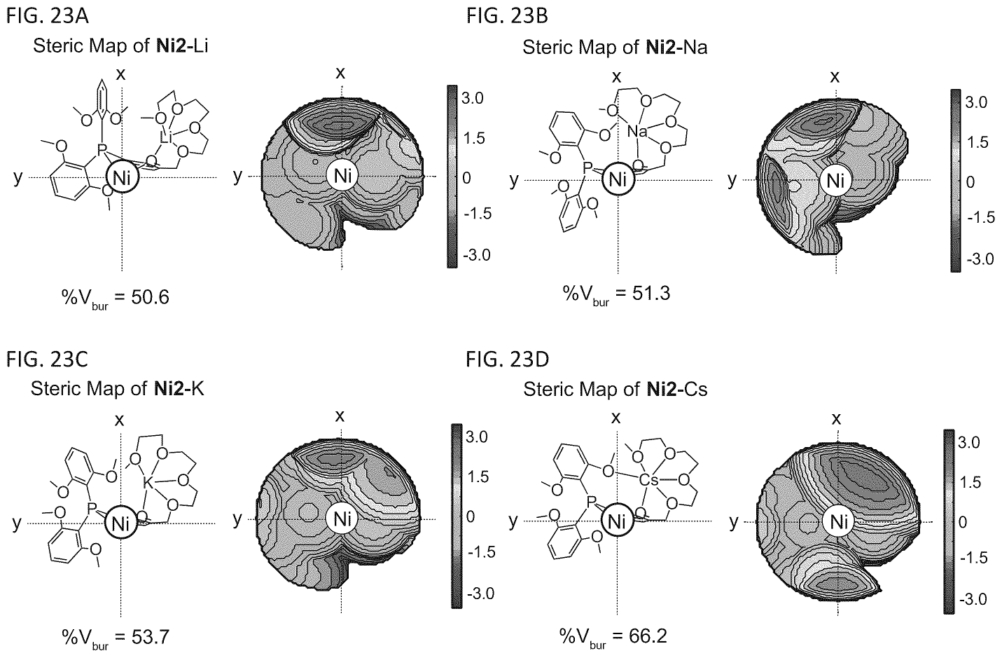

FIG. 23A-FIG. 23D. Topographic steric maps of (FIG. 23A) Ni2-Li, (FIG. 23B) Ni2-Na, (FIG. 23C) Ni2-K, and (FIG. 23D) Ni2-Cs complexes calculated from their X-ray structures using SambVca 2.1. Only the phenoxyphosphine ligands were considered in the calculation of % V_{bur}. The nickel atom was set as the center of the coordination sphere, the nickel square plane defined the xz-plane, and the z-axis bisects the P(1)-Ni(1)-O(1) angle.

TABLE 9
Summary of the % V_{bur} of Various Nickel Complexes^{a}

| Complex | % V_{bur} |
|---|---|
| Ni1 | — |
| Ni1—Li | 53.3 |
| Ni1—Na | 50.7 |
| Ni1—K | 57.3 |
| Ni1—Cs | 62.5 |
| Ni2 | — |
| Ni2—Li | 50.6 |
| Ni2—Na | 51.3 |
| Ni2—K | 53.7 |
| Ni2—Cs | 66.2 |

^{a}The crystallographic data for the Ni1—M complexes were reported previously (Tran, T. V.; Nguyen, Y. H.; Do, L. H., Development of Highly Productive Nickel-Sodium Phenoxyphosphine Ethylene Polymerization Catalysts and their Reaction Temperature Profiles. Polym. Chem. 2019, 10 (27), 3718-3721), (Tran, T. V.; Karas, L. J.; Wu, J. I.; Do, L. H., Elucidating Secondary Metal Cation Effects on Nickel Olefin Polymerization Catalysts. ACS Catal. 2020, 10 (18), 10760-10772).

TABLE 10
Comparison of the Cis and Trans Isomer Distribution^{a}

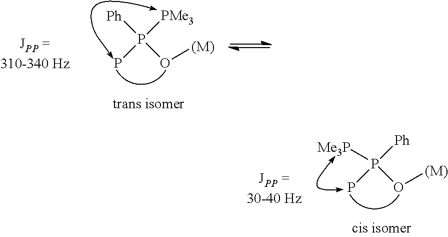

| Complex | trans (%) | cis (%) | K_{cis/trans} |
|---|---|---|---|
| Nil | 100 | 0 | — |
| Nil-Li | 90 | 10 | 0.1 |
| Nil-Na | 10 | 90 | 9.0 |
| Ni1-K | 12 | 88 | 7.3 |
| Nil-Cs | 67 | 33 | 0.5 |
| Ni2 | 100 | 0 | — |
| Ni2-Li | 15 | 85 | 5.7 |
| Ni2-Na | 46 | 54 | 1.2 |
| Ni2-K | 39 | 61 | 1.6 |
| Ni2-Cs | 87 | 13 | 0.1 |

^{a}Relative distribution determined from quantification of their ³¹P NMR spectra in toluene-d₈/Et₂O (4:1).

### Example 14. Polymerization Studies

### General Procedure for Ethylene Polymerization.

Inside the drybox, the nickel complex (Ni1 or Ni2) and MBAr^{F}₄ (if any) were dissolved in a mixture of 8 mL of toluene and 2 mL of Et₂O (if any) in a 20 mL vial and stirred for 10 min. Solid Ni(COD)₂ (8-10 equiv. relative to nickel) was added and stirred for 5 min until a clear solution was obtained. The mixture was loaded into a 10 ml syringe equipped with an 8-inch stainless steel needle. The loaded syringe was sealed by sticking the needle tip into a rubber septum and brought outside of the drybox. To prepare the polymerization reactor, 90 mL of dry toluene was placed in an empty autoclave. The autoclave was pressurized with ethylene to 80 psi, stirred for 5 min, and then the reactor pressure was reduced to 5 psi. This process was repeated 3 times to remove trace amounts of oxygen inside the reaction vessel. The reactor was then heated to the desired temperature and the catalyst solution was injected into the autoclave through a side arm. The autoclave was sealed and purged with ethylene at 40 psi (no stirring) three times. Finally, the reactor pressure was increased to the desired pressure, and the contents were stirred vigorously. To stop the polymerization, the autoclave was vented and cooled in an ice bath. A solution of MeOH (700 mL) was added to precipitate the polymer. The polymer was collected by vacuum filtration, rinsed with MeOH, and dried under vacuum at 80° C. overnight. The reported yields are average values obtained from duplicate or triplicate runs.

To obtain consistent polymer yields from run to run, the amount of catalyst used in each run must be kept as consistent as possible. To minimize errors due to weighing inconsistencies, we used a batch catalyst preparation method. First, we weighed out 50 μmol of the catalyst and then dissolved it into 50 mL of toluene. This solution was divided equally into 10 vials so that each vial contained 5 μmol of catalyst. Next, we combined each 5 μmol of catalyst with 20 mL of toluene and partitioned this 25 mL mixture into 10 vials so that each vial contained 0.5 μmol of catalyst. Finally, each vial was dried completely under vacuum and stored in a refrigerator inside the drybox until ready for use.

For all polymerization reactions, the reaction temperature was controlled by manual cooling of the reactor with an air stream when the reactor increases more than 5° C. above the starting temperature.

To clean the Parr reactor, the vessel was washed with hot toluene (80° C.) to remove the polymer sample from the previous run and rinsed with acetone before drying under vacuum for at least 1 h to remove trace amounts of water.

### Example 15. Procedure for Ethylene Polymerization Under Non-Switching Conditions

Using Complex Ni1 (FIG. 7A): Inside the drybox, 0.1 μmol of the Ni1 complex (stock solution in toluene) was dissolved in 5 mL of toluene in a 20 mL vial. A 0.2 mL stock solution containing MBAr^{F}₄ in Et₂O (if any) was added, followed by the addition of 0.8 μmol of solid Ni[COD]₂. The resulting mixture was stirred for 10 min until a clear solution was obtained and then loaded into a 10-mL syringe equipped with an 8-inch stainless steel needle. To prepare the polymerization reactor, 95 mL of dry toluene was placed in an empty autoclave. The autoclave was pressurized with ethylene to 80 psi, stirred for 5 min, and then the reactor pressure was reduced to 5 psi. This process was repeated 3 times to remove trace amounts of oxygen inside the reaction vessel. The polymerization process was continued using the general polymerization procedure described above.

Using Complex Ni2 (FIG. 7B): Inside the drybox, 4 μmol of the Ni2 complex (stock solution in Et₂O) was dissolved in 2 mL of Et₂O in a 20 mL vial. A 2 mL stock solution containing CsBAr^{F}₄ in Et₂O (if any) was added and the mixture was stirred for 10 min. The mixture was then dried vacuum for at least 3 h to completely remove the Et₂O solvent. Solid Ni[COD]₂ (8 μmol) was added to the catalyst mixture, followed by addition of 5 mL of toluene and stirred until a clear solution was obtained. The mixture was loaded into a 10-mL syringe equipped with an 8-inch stainless steel needle. To prepare the polymerization reactor, 7.5 mL of dry toluene and 37.5 mL of dry hexane was placed in an empty autoclave. The autoclave was pressurized with ethylene to 80 psi, stirred for 5 min, and then the reactor pressure was reduced to 5 psi. This process was repeated 3 times to remove trace amounts of oxygen inside the reaction vessel. The polymerization process was continued using the general polymerization procedure described above.

Analysis of Bimodal Polymers: The GPC traces of bimodal polymers were analyzed further using the program OriginPro 2022. The peaks were fit using the “multiple peak fit” algorithm and the integration values of each peak were compared.

### Example 16. Procedure for Ethylene Polymerization Under Dynamic Switching Conditions

Using Ni2/CsBAr^{F}₄ (FIG. 8A): Inside the drybox, 4 μmol of the Ni2 complex (stock solution in Et₂O) was dissolved in 2 mL of Et₂O in a 20 mL vial. A 2 mL stock solution containing CsBAr^{F}₄ in Et₂O (if any) was added and the mixture was stirred for 10 min. The mixture was dried under strong vacuum for at least 3 h to completely remove the Et₂O. Solid Ni[COD]₂ (8 μmol) was added to the catalyst mixture, followed by addition of 4 mL of toluene and 1 mL of Et₂O and stirred until a clear solution was obtained. The mixture was loaded into a 10-ml syringe equipped with an 8-inch stainless steel needle. To prepare the polymerization reactor, 45 mL of dry toluene was placed in an empty autoclave. The autoclave was pressurized with ethylene to 80 psi, stirred for 5 min, and then the reactor pressure was reduced to 5 psi. This process was repeated 3 times to remove trace amounts of oxygen inside the reaction vessel. The polymerization process was continued using the general polymerization procedure described above.

Using Ni2/CsBAr^{F}₄/LiBAr^{F}₄ (FIG. 8B): Inside the drybox, 1 μmol of the Ni2 complex (stock solution in Et₂O) was dissolved in 2 mL of Et₂O in a 20 mL vial. A 2 mL stock solution of CsBAr^{F}₄ and LiBAr^{F}₄ in Et₂O (if any) was added and the mixture was stirred for 10 min. The mixture was dried under strong vacuum for at least 3 h to completely remove the Et₂O. Solid Ni[COD]₂ (8 μmol) was added to the resulting catalyst mixture, followed by addition of 3 mL of toluene and 2 mL of Et₂O and stirred until a clear solution was obtained. The mixture was loaded into a 10-mL syringe equipped with an 8-inch stainless steel needle. To prepare the polymerization reactor, 95 mL of dry toluene was placed in an empty autoclave. The autoclave was pressurized with ethylene to 80 psi, stirred for 5 min, and then the reactor pressure was reduced to 5 psi. This process was repeated 3 times to remove trace amounts of oxygen inside the reaction vessel. The polymerization process was continued using the general polymerization procedure described above.

### Example 17. Calculating Moles of Nickel Complexes in Non-Switching Polymerization Studies

We calculated the amounts of Ni1-Li and Ni1-Na species present in each reaction in Table 12 by taking into consideration the reaction yield, catalyst activity, and ratio of polymer fractions (A_{15.2}/A_{18.2}). The equations used for our calculations are provided below. Our results showed that the ratio of Ni1-Li:Ni1-Na calculated were different than that of LiBAr^{F}₄:NaBAr^{F}₄ added, which reflects differences in the solubility of the alkali salts, the binding affinity of Ni1 for Li⁺ vs. Na⁺, and the activity of Ni1-Li vs. Ni1-Na.

The A_{15.8}/A_{18.2} term is equal to the ratio of the polymer yields from Ni1-Li and Ni1-Na, which can be determined from their activities:

$$\frac{{A}_{15.8}}{{A}_{18.2}} = \frac{( 42800 kg / mol \cdot h ) ( x )}{( 16600 kg / mol \cdot h ) ( y )} = \frac{2.58 ( x )}{( y )} , where \begin{matrix} \\ x = moles of Ni 1 - Li \\ y = moles of Ni 1 - Na\end{matrix}$$

$$y = \frac{2.58 ( x )}{( \frac{{A}_{15.8}}{{A}_{18.2}} )}$$

The polymer yield is equal to the activities of Ni1-Li and Ni1-Na and the reaction time:

$$PE yield = ( 42800 kg / mol \cdot h ) ( 0.5 h ) ( x ) + ( 16600 kg / mol \cdot h ) ( 0.5 ) ( y )$$

$$PE yield = ( 21400 kg / mol ) ( x ) + \frac{( 8300 kg / mol ) ( 2.58 ) ( x )}{( \frac{{A}_{15.8}}{{A}_{18.2}} )} \qquad * substitute with y term above$$

$$x = \frac{PE yield}{( 21400 kg / mol ) + \frac{( 8300 kg / mol ) ( 2.58 )}{( \frac{{A}_{15.8}}{{A}_{18.2}} )}}$$

FIG. 24. Plot of Li⁺/Na⁺ molar ratio vs. A_{15.8}/A: 22 obtained from ethylene polymerization studies of Ni1 with LiBAr^{F}₄ and NaBAr^{F}₄ salts (see Table 12). The data (black dots) were fit to an exponential function to give an empirical relationship between Li⁺/Na⁺ molar ratio and A_{15.8}/A_{18.2}. The data points obtained from Li⁺/Na⁺>1.0 have large experimental error because the amount of the PE produced at 18.2 mL retention volume was very small so its quantification from the GPC trace is not accurate.

FIG. 25A-FIG. 25D. Proposed process for both non-switching (FIG. 25A, FIG. 25C) and dynamic switching (FIG. 25B, FIG. 25D) modalities in olefin polymerization by non-living cation-tunable nickel complexes. It is possible that species with nuclearity greater than 2 could form but are not considered in FIG. 25A-FIG. 25D. The squiggly lines represent polymer segments produced by different catalyst forms. Here, both “blocks” comprise entirely of ethylene. However, without being bound by theory, it may be possible to use this strategy to produce block copolymers when starting with more than one type of monomer.

TABLE 11
Ethylene Polymerization Using Ni1 and Ni1—M^{a}

| | | | Temp. | Polymer | Activity | Mₙ^{b} | | Branches^{e} | | | ν_{growth/} |
|---|---|---|---|---|---|---|---|---|---|---|---|
| Entry | Cat. | Salt | (° C.) | Yield (g) | (kg/mol · h) | (×10³) | Ð^{b} | (/1000 C) | ν_{growth}^{f} | νₜₑᵣₘ^{g} | νₜₑᵣₘ |
| 1 | Ni1 | none | 30 | trace | 0 | — | — | — | — | — | — |
| 2^{d} | Ni1 | Li⁺ | 30 | 3.53 | 35000 | 40.1 | 1.3 | 12 | 1260714 | 880.3 | 1432 |
| 3 | Ni1 | Na⁺ | 30 | 9.07 | 18000 | 1.72 | 1.4 | 27 | 647857 | 10546.5 | 61 |
| 4 | Ni1 | K⁺ | 30 | 1.46 | 2900 | 4.53 | 1.6 | 25 | 104286 | 644.6 | 162 |
| 5 | Ni1 | Cs⁺ | 30 | 0.18 | 360 | 33.93 | 1.5 | 9 | 12857 | 10.6 | 1212 |

^{a}Data previously reported (Tran, T. V.; Karas, L. J.; Wu, J. I.; Do, L. H., Elucidating Secondary Metal Cation Effects on Nickel Olefin Polymerization Catalysts. ACS Catal. 2020, 10 (18), 10760-10772). Polymerization conditions: Ni1 catalyst (0.5 μmol), MBAr^{F}₄ (1 μmol, if any), Ni(COD)₂ (4 μmol), ethylene (450 psi), 100 mL toluene, 1 h. Temperature was controlled by manual external cooling when necessary to ensure the reaction temperature does not exceed greater than 5° C. from the starting temperature.
^{b}The total number of branches per 1000 carbons was determined by 1H NMR spectroscopy.
^{c}Determined by GPC in trichlorobenzene at 140° C.
^{d}Ni1 (0.1 μmol), LiBAr^{F}₄ (0.2 μmol), Ni(COD)₂ (0.8 μmol).
^{e}The total number of branches per 1000 carbons was determined by ¹H NMR spectroscopy.
^{f}Unit: mol C₂H₄/mol Ni · h.
^{g}Unit: mol PE/mol Ni · h.

TABLE 12
Ethylene Polymerization Using Ni2 and Ni2—M at Different Temperatures^{a}

| | | | Temp. | Polymer | Activity | Mₙ^{b} | | Branches^{e} | | | ν_{growth/} |
|---|---|---|---|---|---|---|---|---|---|---|---|
| Entry | Cat. | Salt | (° C.) | Yield (g) | (kg/mol · h) | (×10³) | Ð^{b} | (/1000 C) | ν_{growth}^{f} | νₜₑᵣₘ^{g} | νₜₑᵣₘ |
| 1 | Ni2 | none | 30 | 0.279 | 279 | 270.7 | 2.0 | 4 | 9964 | 1.0 | 9668 |
| 2 | Ni2 | Li⁺ | 30 | 2.94 | 2940 | 684.9 | 1.5 | 3 | 105000 | 4.3 | 24461 |
| 3 | Ni2 | Na⁺ | 30 | 2.43 | 2400 | 1234 | 1.3 | 2 | 86786 | 2.0 | 44071 |
| 4 | Ni2 | K⁺ | 30 | 1.88 | 1880 | 948.5 | 1.4 | 1 | 67143 | 2.0 | 33875 |
| 5 | Ni2 | Cs⁺ | 30 | 1.26 | 1260 | 1415 | 1.6 | 12 | 45000 | 0.9 | 50536 |
| 6^{c} | Ni2 | none | 60 | 0.105 | 525 | 115.5 | 2.2 | — | 18750 | 4.5 | 4125 |
| 7^{c} | Ni2 | Li⁺ | 60 | 6.2 | 31000 | 181.6 | 1.6 | — | 1107143 | 170.7 | 6486 |
| 8^{c} | Ni2 | Na⁺ | 60 | 1.13 | 5650 | 198.7 | 1.6 | — | 201786 | 28.4 | 7096 |
| 9^{c} | Ni2 | K⁺ | 60 | 1.7 | 8500 | 196.4 | 1.6 | — | 303571 | 43.3 | 7014 |
| 10^{c} | Ni2 | Cs⁺ | 60 | 0.64 | 3200 | 707.9 | 1.4 | — | 114286 | 4.5 | 25282 |
| 11^{c} | Ni2 | none | 90 | 4.6 | 23000 | 40.6 | 2.0 | — | 821429 | 566.5 | 1450 |
| 12^{c} | Ni2 | Li⁺ | 90 | 9.9 | 49500 | 15.2 | 2.6 | — | 1767857 | 3256.6 | 543 |
| 13^{c} | Ni2 | Na⁺ | 90 | 11.7 | 58500 | 30.7 | 1.8 | — | 2089286 | 1905.5 | 1096 |
| 14^{c} | Ni2 | K⁺ | 90 | 3.7 | 18500 | 49.8 | 1.6 | — | 660714 | 371.5 | 1779 |
| 15^{c} | Ni2 | Cs⁺ | 90 | 4.7 | 23500 | 117.3 | 1.7 | — | 839286 | 200.3 | 4189 |
| 16^{d} | Ni2 | Cs⁺ | 90 | 3.3 | 33000 | 185.2 | 1.5 | — | 1178571 | 178.2 | 6614 |

^{a}Polymerization conditions: catalyst (1.0 μmol), MBAr^{F}₄ (5.0 μmol, if any), Ni(COD)₂ (10 μmol), ethylene (450 psi), 98 mL toluene/2 mL Et₂O, 1 h. Temperature was controlled by manual external cooling when necessary to ensure that the reaction temperature does not exceed greater than 5° C. from the starting temperature.
^{b}Determined by GPC in trichlorobenzene at 160° C.
^{c}Ni2 (0.2 μmol), MBAr^{F}₄ (1 μmol, if any), Ni(COD)₂ (1.6 μmol), temperature quickly increased to 114° C. after addition of catalyst mixture.
^{d}Ni2 (0.1 μmol), MBAr^{F}₄ (0.5 μmol), Ni(COD)₂ (1 μmol).
^{e}The total number of branches per 1000 carbons was determined by ¹H NMR spectroscopy in TCE-d₂ at 120° C.
^{f}Unit: mol C₂H₄/mol Ni · h.
^{g}Unit: mol PE/mol Ni · h.

TABLE 13
Ethylene Polymerization Using Ni1 with Various Li⁺/Na⁺ Ratios Under Non-Switching Conditions (30° C.)^{a}

| | | Li⁺ | Na⁺ | | | | | | | Ni1—Li | Ni1—Na |
|---|---|---|---|---|---|---|---|---|---|---|---|
| | | Added | Added | Polymer | Activity | Mₙ^{b} | Branches^{c} | | A_{15.8}/ | Calc. | Calc. |
| Entry | Cat. | (equiv.) | (equiv.) | Yield (g) | (kg/mol · h) | (×10³) | (/1000 C) | Ð^{b} | A_{18.2}^{d} | (×10⁸ mol) | (×10⁸ mol) |
| 1 | Ni1 | — | 2 | 0.83 | 16600 | 1.54 | 27 | 1.7 | — | — | — |
| 2 | Ni1 | 2 | 40 | 0.85 | 17000 | 2.19 | 25 | 3.9 | 0.04 | 0.07 | 4.94 |
| 3 | Ni1 | 2 | 20 | 0.91 | 18200 | 2.99 | 17 | 4.9 | 0.4 | 0.58 | 4.04 |
| 4 | Ni1 | 2 | 10 | 1.14 | 22800 | 4.62 | 15 | 5.1 | 1.0 | 1.25 | 3.63 |
| 5 | Ni1 | 2 | 4 | 1.26 | 25200 | 10.29 | 10 | 3.6 | 2.6 | 2.05 | 2.29 |
| 6 | Ni1 | 2 | 2 | 1.33 | 26600 | 14.02 | 9 | 2.6 | 3.8 | 2.40 | 1.83 |
| 7 | Ni1 | 2 | 1 | 1.65 | 33000 | 18.89 | 8 | 2.3 | 3.2 | 2.85 | 2.58 |
| 8 | Ni1 | 2 | 0.5 | 1.95 | 39000 | 21.17 | 7 | 2.0 | 3.1 | 3.34 | 3.13 |
| 9 | Ni1 | 2 | — | 2.14 | 42800 | 31.13 | 11 | 1.7 | — | — | — |

^{a}Polymerization conditions: Ni1 (0.1 μmol), MBAr^{F}₄ (varied), Ni(COD)₂ (0.8 μmol), ethylene (450 psi), 100 mL toluene/0.2 mL Et₂O, 30° C., 0.5 h. Temperature was controlled by manual external cooling when necessary to ensure that the reaction temperature does not exceed greater than 5° C. from the starting temperature.
^{b}Determined by GPC in trichlorobenzene at 160° C.
^{c}The total number of branches per 1000 carbons was determined by ¹H NMR spectroscopy in TCE-d₂ at 120° C.
^{d}The GPC peaks at ~15.8 (corresponding to polymer from Ni1—Li) and 18.2 min (corresponding to polymer from Ni1—Na) were fit to two different Gaussian functions. The integrated areas A_{15.8} and A_{18.2} correspond to the peaks at 15.8 and 18.2 min, respectively.

TABLE 14
Ethylene Polymerization Using Ni2 with Cs⁺ Under
Non-Switching Conditions (30° C.)^{a}

| | | CsBAr^{F}₄ | Polymer | Activity | Mₙ^{b} | | | A_{13.4}/ |
|---|---|---|---|---|---|---|---|---|
| Entry | Cat. | (equiv.) | Yield (g) | (kg/mol · h) | (×10³) | Ð^{b} | Modality | A_{15.5} |
| 1 | Ni2 | 0 | 0.21 | 52 | 203 | 2.4 | monomodal | — |
| 2 | Ni2 | 0.25 | 0.95 | 238 | 93 | 3.5 | bimodal | 0.4 |
| 3 | Ni2 | 0.50 | 0.07 | 18 | 84 | 3.0 | slightly | 0.1 |
| | | | | | | | bimodal | |
| 4 | Ni2 | 1.00 | 0.33 | 82 | 916 | 1.5 | monomodal | — |

^{a}Polymerization conditions: Ni2 (4 μmol), CsBAr^{F}₄ (varied), Ni(COD)₂ (32 μmol), ethylene (450 psi), 12.5 mL toluene/37.5 mL hexane, 30° C., 1 h. Temperature was controlled by manual external cooling when necessary to ensure that the reaction temperature does not exceed greater than 5° C. from the starting temperature.
^{b}Determined by GPC in trichlorobenzene at 160° C.

TABLE 15
Ethylene Polymerization Using Ni2 with Cs⁺ Under
Dynamic Switching Conditions (30° C.)^{a}

| | | CsBAr^{F}₄ | Polymer | Activity | Mₙ^{b} | | Branches^{c} |
|---|---|---|---|---|---|---|---|
| Entry | Cat. | (equiv.) | Yield (g) | (kg/mol · h) | (×10³) | Ð^{b} | (/1000 C) |
| 1 | Ni2 | 0 | 0.7 | 175 | 484 | 1.6 | 4 |
| 2 | Ni2 | 0.25 | 0.37 | 93 | 305 | 1.9 | — |
| 3 | Ni2 | 0.50 | 0.46 | 115 | 695 | 1.6 | 3 |
| 4 | Ni2 | 1.00 | 0.96 | 240 | 945 | 1.4 | 12 |

^{a}Polymerization conditions: catalyst (4 μmol), Ni(COD)₂ (8 μmol), ethylene (450 psi), 98 mL toluene/2 mL Et₂O, 30° C., 1 h. Temperature was controlled by manual external cooling when necessary to ensure that the reaction temperature does not exceed greater than 5° C. from the starting temperature.
^{b}Determined by GPC in trichlorobenzene at 160° C.
^{c}The total number of branches per 1000 carbons was determined by ¹H NMR spectroscopy in TCE-d₂ at 120° C.

TABLE 16
Ethylene Polymerization Using Ni2 with Cs⁺ Under
Dynamic Switching Conditions (60° C.)^{a}

| | | | Polymer | | | |
|---|---|---|---|---|---|---|
| | | CsBAr^{F}₄ | Yield | Activity | Mₙ^{b} | |
| Entry | Cat. | (equiv.) | (g) | (kg/mol · h) | (×10³) | Ð^{b} |
| 1 | Ni2 | 0 | 0.105 | 525 | 116 | 2.2 |
| 2 | Ni2 | 0.25 | 0.11 | 550 | 168 | 1.4 |
| 3 | Ni2 | 0.50 | 0.18 | 900 | 278 | 1.4 |
| 4 | Ni2 | 0.75 | 0.2 | 1000 | 318 | 1.4 |
| 5 | Ni2 | 1.00 | 0.26 | 1300 | 462 | 1.3 |
| 6 | Ni2 | 2.00 | 0.31 | 1550 | 586 | 1.4 |
| 7 | Ni2 | 5.00 | 0.64 | 3200 | 708 | 1.4 |

^{a}Polymerization conditions: catalyst (0.2 μmol), Ni(COD)₂ (1.6 μmol), ethylene (450 psi), 98 mL toluene/2 mL Et₂O, 60° C., 1 h. Temperature was controlled by manual external cooling when necessary to ensure that the reaction temperature does not exceed greater than 5° C. from the starting temperature.
^{b}Determined by GPC in trichlorobenzene at 160° C.

TABLE 17
Ethylene Polymerization Using Ni2 with Li⁺/
Cs⁺ Under Dynamic Switching Conditions^{a}

| | | | | Polymer | | | |
|---|---|---|---|---|---|---|---|
| | | LiBAr^{F}₄ | CsBAr^{F}₄ | Yield | Activity | Mₙ^{b} | |
| Entry | Cat. | (equiv.) | (equiv.) | (g) | (kg/mol · h) | (×10³) | Ð^{b} |
| 1 | Ni2 | 5 | — | 0.64 | 31000 | 182 | 1.6 |
| 2 | Ni2 | 3.75 | 1.25 | 0.31 | 14620 | 319 | 1.5 |
| 3 | Ni2 | 2.5 | 2.5 | 0.26 | 8560 | 495 | 1.4 |
| 4 | Ni2 | 1.25 | 3.75 | 0.2 | 3420 | 348 | 1.6 |
| 5 | Ni2 | — | 5 | 0.18 | 3200 | 708 | 1.4 |

^{a}Polymerization conditions: catalyst (0.2 μmol), Ni(COD)₂ (1.6 μmol), ethylene (450 psi), 98 mL toluene/2 mL Et₂O, 60° C., 1 h. Temperature was controlled by manual external cooling when necessary to ensure that the reaction temperature does not exceed greater than 5° C. from the starting temperature.
^{b}Determined by GPC in trichlorobenzene at 160° C.

TABLE 18
Comparison of Thermally Stable Ethylene Polymerization Catalystsª

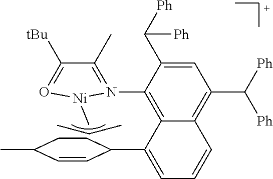

Cat3

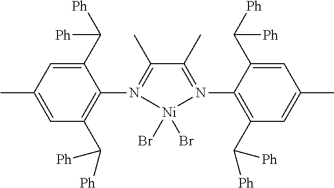

Cat4

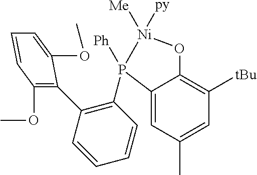

Cat5

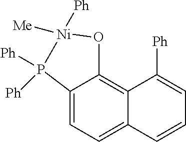

Cat6

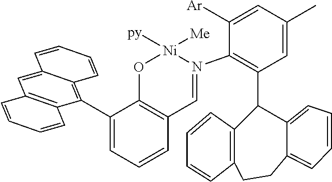

Cat7

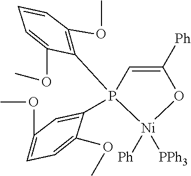

Cat8

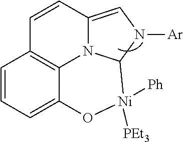

Cat9

| | | Time | Temp. | Yield | Activity | Productivity | Mₙ | |
|---|---|---|---|---|---|---|---|---|
| Complex | % V_{bur} | (h) | (° C.) | (g) | (kg/mol · h) | (kg/mol) | (kg/mol) | Ð |
| Cat3 (1.0 μmol) | — ^{b} | 1.0 | 80 | 0.60 | 600 | 600 | 1226 | 2.0 |
| Cat4 (1.57 μmol) | 49 | 0.17 | 100 | 0.75 | 2810 | 478 | 422 | 1.2 |
| Cat5 (5.0 μmol ) | 43 ^{c} | 0.33 | 90 | 16.7 | 10020 | 3340 | 9.4 | 2.7 |
| Cat6 (5.0 μmol) | 41 | 0.33 | 90 | 24.7 | 14835 | 4940 | 1.6 | 3.4 |
| Cat7 (5.0 μmol)^{c} | 52 ^{c} | 0.25 | 90 | 1.65 | 1320 | 330 | 9.5 | 1.8 |
| Cat8 (0.25 μmol) | 46 | <0.02 | 90 | 0.29 | 57500 | 1160 | 4.1 | 3.1 |
| Cat9 (2.5 μmol) | — ^{b} | 0.5 | 100 | 0.30 | 240 | 120 | 2.6 | 2.3 |
| Ni1-Cs (0.5 μmol) | 62 | 0.5 | 90 | 5.73 | 23000 | 11460 | 15.7 | 1.4 |
| Ni2-Cs (0.1 μmol) | 66 | 1.0 | 90 | 3.30 | 33000 | 33000 | 185 | 1.5 |

^{a}References: Cat3 (Liang, T .; Goudari, S. B .; Chen, C., A Simple and Versatile Nickel Platform for the Generation of Branched High Molecular Weight Polyolefins. Nat. Commun. 2020, 11 (1), 372), Cat4 (Rhinchart, J. L .; Brown, L. A .; Long, B. K., A Robust Ni(II) α-Diimine Catalyst for High Temperature Ethylene Polymerization. J. Am. Chem. Soc. 2013, 135 (44), 16316-16319), Cat5 (Zhang, Y .; Mu, H .; Pan, L .; Wang, X .; Li, Y., Robust Bulky [P,O] Neutral Nickel Catalysts for Copolymerization of Ethylene with Polar Vinyl Monomers. ACS Catal. 2018, 8, 5963-5976), Cat6 (Wang, X .- 1 .; Zhang, Y .- p .; Wang, F .; Pan, L .; Wang, B .; Li, Y .- s., Robust and Reactive Neutral Nickel Catalysts for Ethylene Polymerization and Copolymerization with a Challenging 1,1-Disubstituted Difunctional Polar Monomer. ACS Catal. 2021, 11, 2902-2911), Cat7 (Wang, C .; Kang, X .; Dai, S .; Cui, F .; Li, Y .; Mu, H .; Mecking, S .; Jian, Z., Efficient Suppression of Chain Transfer and Branching via Cs-Type Shielding in a Neutral Nickel(II) Catalyst. Angewandte Chemie International Edition 2021, 60 (8), 4018-4022), Cat8 (Xiong, S .; Hong, A .; Bailey, B. C .; Spinney, H. A .;
Senecal, T. D .; Bailey, H .; Agapie, T., Highly Active and Thermally Robust Nickel Enolate Catalysts for the Synthesis of Ethylene-Acrylate Copolymers. Angewandte Chemie International Edition 2022, n/a (n/a), e202206637), Cat9 (Tao, W .- j .; Nakano, R .; Ito, S .; Nozaki, K., Copolymerization of Ethylene and Polar Monomers by Using Ni/IzQO Catalysts. Angewandte Chemie International Edition 2016, 55 (8), 2835-2839.), Nil-Cs (Tran, T. V .; Karas, L. J .; Wu, J. L; Do, L. H., Elucidating Secondary Metal Cation Effects on Nickel Olefin Polymerization Catalysts. ACS Catal. 2020, 10 (18), 10760-10772), Ni2-Cs (the present invention).
^{b}X-ray structural data not available for calculating % V_{bur}.
^{c}Buried volume calculated from related structure.

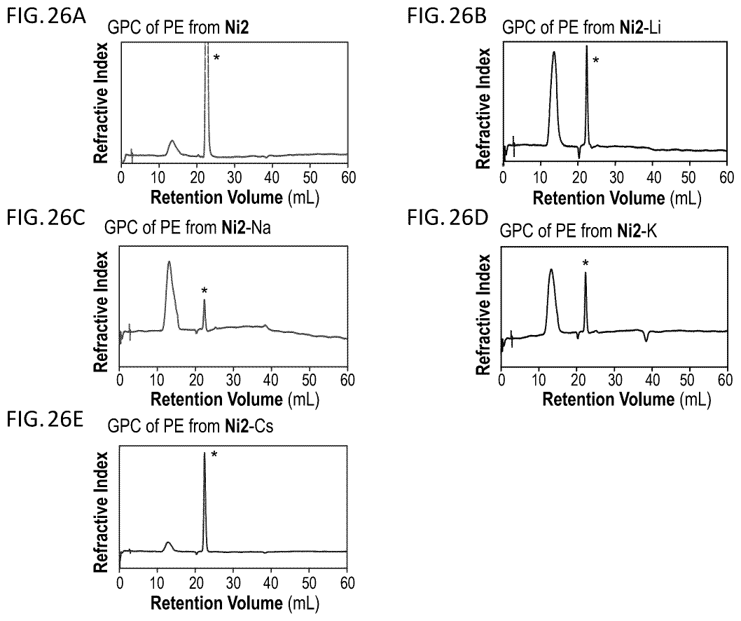

FIG. 26A-FIG. 26E. GPC chromatograms of the polyethylene samples obtained from the reactions shown in Table 12, entries 1 (FIG. 26A), 2 (FIG. 26B), 3 (FIG. 26C), 4 (FIG. 26D), and 5 (FIG. 26E). The peak at ˜22 mL retention volume marked with an asterisk (*) is derived from a contaminant in the GPC column, not the sample itself.

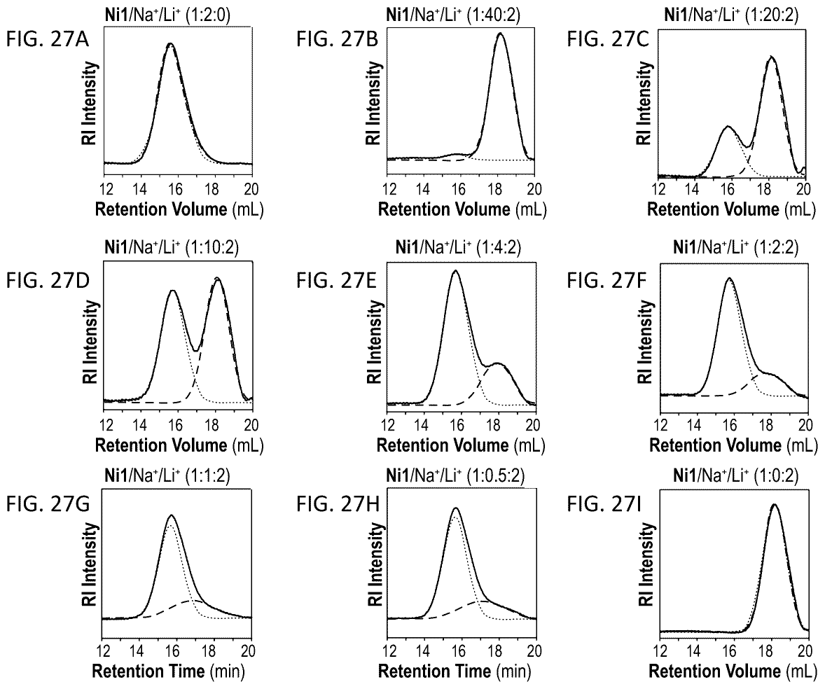

FIG. 27A-FIG. 27I. GPC chromatograms of the polyethylene obtained in Table 13, in which various Ni1:Na⁺:Li⁺ ratios were used. The black traces are the raw data and the Gaussian fits are shown in dashed and dotted traces.

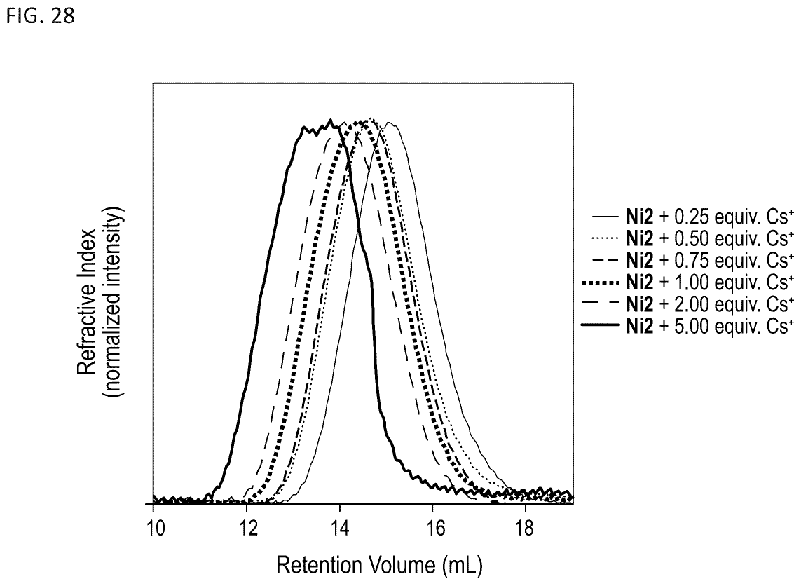

FIG. 28. GPC of monomodal polyethylene obtained in Table 16, entries 2-7 (from the addition of 0.25 to 5.00 equiv. of CsBAr_{F}⁴ relative to Ni2). Without being bound by theory, the GPC trace for entry 7 (Ni2+5.00 equiv. Cs⁺,) is not smooth most likely because of either the poor solubility of the polymer in trichlorobenzene at 160° C. or the difficulty of the instrument to detect ultra-high molecular weight polymers.

### Example 18. X-Ray Data Collection and Refinement

Single crystals suitable for X-ray diffraction studies were picked out of the crystallization vials and mounted onto Mitogen loops using Paratone oil. The crystals were collected at a 6.0 cm detector distance at −150° C. on a Brucker Apex II diffractometer using Mo Kα radiation (%=0.71073 Å). The structures were solved by direct methods using the program SHELXT and refined by SHELXLE. Hydrogen atoms connected to carbon were placed at idealized positions using standard riding models and refined isotropically. All non-hydrogen atoms were refined anisoptriocally.

Crystals of complex Ni2-Li were grown by layering of pentane into a solution of the nickel complex with LiBAr_{F}⁴ in a mixture of toluene and Et₂O at −30° C. The phenyl group (C32-C37) coordinated to nickel was modeled with positional disorder. Six of the CFs groups BAr^{F}₄⁻ showed rotational disorder. No solvent molecules were found in the crystal lattice

Crystals of complex Ni2-Na were grown by layering of pentane into a solution of the nickel complex with NaBAr^{F}₄ in a mixture of benzene and Et₂O at RT. Two of the CF₃ groups on the BAr^{F}₄ showed rotational disorder and were modeled accordingly. A single ordered benzene molecule was found in the crystal lattice and resides on a symmetry axis.

Crystals of complex Ni2-K were grown by layering of pentane into a solution of the nickel complex with KBAr^{F}₄ in a mixture of benzene and Et₂O at RT. Two of the CF₃ groups on the BAr^{F}₄⁻ showed rotational disorder and were modeled accordingly. A single ordered benzene molecule was found in the crystal lattice and resides on a symmetry axis.

Crystals of complex Ni2-Cs were grown by layering of pentane into a solution of the nickel complex with CsBAr^{F}₄ in a mixture of toluene and Et₂O at −30° C. Six of the CF₃ groups on the BAr^{F}₄⁻ showed rotational disorder and were modeled accordingly. No solvent molecules were found in the crystal lattice.

TABLE 19
Crystal Data and Structure Refinement for Ni2—Li and Ni2—Cs

| | Ni2—Li | Ni2—Na•(benzene) | Ni2—K•(benzene) | Ni2—Cs |
|---|---|---|---|---|
| Empirical Formula | NiLiC₄₀H₅₄O₉P₂ | NiNaC₄₀H₅₄O₉P₂ | NiKC₄₀H₅₄O₉P₂ | NiCsC₄₀H₅₄O₉P₂ |
| | (BC₃₂H₁₂F₂₄) | (BC₃₂H₁₂F₂₄)(C₆H₆) | (BC₃₂H₁₂F₂₄)(C₆H₆) | (BC₃₂H₁₂F₂₄) |
| Temperature (° C.) | −150 | −150 | −150 | −150 |
| Wavelength (Å) | 0.71073 | 0.71073 | 0.71073 | 0.71073 |
| Crystal System Space Group | Triclinic, P-1 | Monoclinic, C2/c | Monoclinic, C2/c | Monoclinic, P2₁/c |
| Unit Cell Dimensions | | | | |
| a (Å) | 12.626(4) | 39.802(17) | 39.569(3) | 19.0606(4) |
| b (Å) | 15.849(5) | 12.877(6) | 12.9171(9) | 20.3960(3) |
| c (Å) | 19.404(6) | 31.238(13) | 31.172(2) | 20.4253(4) |
| α (°) | 82.826(3) | 90 | 90 | 90 |
| β (°) | 80.458(3) | 99.090(5) | 99.248(2) | 100.18(1) |
| γ (°) | 87.287(3) | 90 | 90 | 90 |
| Volume (Å³) | 3798(2) | 15809(12) | 15725.6(18) | 7817.0(3) |
| Z, Calculated Density (Mg/m³) | 2, 1.460 | 12, 1.433 | 12, 1.454 | 4, 1.526 |
| Absorption Coefficient (mm⁻¹) | 0.411 | 0.401 | 0.451 | 0.858 |
| F(000) | 1704 | 6964 | 7028 | 3616 |
| Theta Range for Data Collection (°) | 1.072 to 27.546 | 1.036 to 27.376 | 1.043 to 27.504 | 1.085 to 27.504 |
| Limiting Indices | −16 ≤ h ≤ 16 | −51 ≤ h ≤ 46 | −51 ≤ h ≤ 51 | −24 ≤ h ≤ 24 |
| | −20 ≤ k ≤ 20 | −12 ≤ k ≤ 16 | −16 ≤ k ≤ 16 | −26 ≤ k ≤ 26 |
| | −25 ≤ l ≤ 25 | −40 ≤ l ≤ 40 | −38 ≤ l ≤ 40 | −26 ≤ l ≤ 26 |
| Reflections Collected/Unique | 62572/17367 | 123627/17907 | 91646/18001 | 80622/17914 |
| | [R(int) = 0.0590] | [R(int) = 0.0334] | [R(int)]0.0637] | [R(int) = 0.1403] |
| Data/ Restraints/Parameters | 17367/224/989 | 17907/60/939 | 18001/32/936 | 17914/198/986 |
| Goodness of Fit on F² | 1.032 | 1.020 | 1.035 | 1.005 |
| Final R Indices | R1 = 0.0617 | R1 = 0.0842 | R1 = 0.0932 | R1 = 0.0731 |
| [I > 2σ(I)] | wR2 = 0.1484 | wR2 = 0.2327 | wR2 = 0.2543 | wR2 = 0.1423 |
| R Indices (All Data)* | R1 = 0.1160 | R1 = 0.1025 | R1 = 0.1491 | R1 = 0.1957 |
| | wR2 = 0.1779 | wR2 = 0.2514 | wR2 = 0.2941 | wR2 = 0.1911 |

*R₁ = Σ ||Fₒ| − |Fₒ||/Σ|Fₒ|; wR₂ = [Σ[w(Fₒ² − F_{c}²)²]/Σ[w(Fₒ²)₂]]^{1/2}; GOF = [Σ[w(Fₒ² − F_{c}²)₂]/(n − p)]^{1/2}, where n is the number of reflections and p is the total number of parameters refined.

TABLE 20
Comparison of Bond Distances and Angles from the Crystallographic Data

| Distance (Å) or Angle (°) | Ni2—Li | Ni2—Na | Ni2—K | Ni2—Cs |
|---|---|---|---|---|
| Ni(1)—P(1) | 2.2471(11) | 2.1859(12) | 2.1802(14) | 2.1795(19) |
| Ni(1)—P(2) | 2.1148(11) | 2.1921(13) | 2.1854(16) | 2.182(2) |
| Ni(1)—C(X) | 1.947(15) | 1.906(4) | 1.902(5) | 1.898(6) |
| Ni(1)—O(1) | 1.923(2) | 1.935(3) | 1.918(3) | 1.900(4) |
| P(1)—Ni(1)—O(1) | 82.84(7) | 86.59(8) | 86.71(12) | 87.26(14) |

FIG. 29. Crystallographic asymmetric unit showing complex Ni2-Li from two different perspectives (ORTEP view, displacement ellipsoids drawn at 50% probability level). Hydrogen atoms, pentane solvent, and borate anion have been omitted for clarity. Atom colors: green=nickel, orange=phosphorus, purple=lithium, red=oxygen, black=carbon.

FIG. 30. Crystallographic asymmetric unit showing complex Ni2-Na from two different perspectives (ORTEP view, displacement ellipsoids drawn at 50% probability level). Hydrogen atoms, pentane solvent, and borate anion have been omitted for clarity. Atom colors: green=nickel, orange=phosphorus, pink=sodium, red=oxygen, black=carbon.

FIG. 31. Crystallographic asymmetric unit showing complex Ni2-K from two different perspectives (ORTEP view, displacement ellipsoids drawn at 50% probability level). Hydrogen atoms, pentane solvent, and borate anion have been omitted for clarity. Atom colors: green=nickel, orange=phosphorus, blue=potassium, red=oxygen, black=carbon.

FIG. 32. Crystallographic asymmetric unit showing complex Ni2-Cs from two different perspectives (ORTEP view, displacement ellipsoids drawn at 50% probability level). Hydrogen atoms, pentane solvent, and borate anion have been omitted for clarity. Atom colors: green=nickel, orange=phosphorus, cyan=cesium, red=oxygen, black=carbon.

### EXPERIMENTAL SECTION (EXAMPLE 19-EXAMPLE 34)

### General Procedures

Commercial reagents were used as received. All air and moisture-sensitive manipulations were performed using standard Schlenk techniques or under a nitrogen atmosphere using a glovebox. Anhydrous solvents were obtained from an Innovative Technology solvent drying system saturated with argon. High-purity polymer-grade ethylene was obtained from Matheson TriGas without further purification. The LiBAr^{F}₄, NaBAr^{F}₄, KBAr^{F}₄, and CsBAr^{F}₄ (BAr^{F}₄=tetrakis(3,5-trifluoromethylphenyl)borate anion) salts were prepared according to literature procedures (Brookhart, M.; Grant, B.; Volpe, A. F. Jr. [(3,5-(CF3)2C6H3)4B]—[H(OEt2)2]+: A Convenient Reagent for Generation and Stabilization of Cationic, Highly Electrophilic Organometallic Complexes. Organometallics 1992, 11, 3920-3922; Carreras, L.; Rovira, L.; Vaquero, M.; Mon, I.; Martin, E.; Benet-Buchholz, J.; Vidal-Ferran, A. Syntheses, Characterisation and Solid-State Study of Alkali and Ammonium BArF Salts. RSC Advances 2017, 7, 32833-32841). Compounds 2A, 4A, 7A, 9A and NiPhBr(PMe₃)₂ were synthesized according to literature procedures (Tran, T. V.; Nguyen, Y. H.; Do, L. H. Development of Highly Productive Nickel-Sodium Phenoxyphosphine Ethylene Polymerization Catalysts and Their Reaction Temperature Profiles. Polym. Chem. 2019, 10, 3718-3721) NMR spectra were acquired using JEOL spectrometers (ECA-400, -500, and -600) and referenced using residual solvent peaks. All ¹³C NMR spectra were proton decoupled. ³¹P NMR spectra were referenced to phosphoric acid. For polymer characterization, ¹H NMR spectroscopy: each NMR sample contained ˜15 mg of polymer in 0.6 mL of 1,1,2,2-tetrachloroethane-d₂ (TCE-d₂) and was recorded on a 600 MHz spectrometer using standard acquisition parameters at 110° C. The samples were preheated for 30 min before data acquisition. The ¹H NMR spectra were assigned based on the chemical shift values reported in the literature (Contrella, N. D.; Sampson, J. R.; Jordan, R. F. Copolymerization of Ethylene and Methyl Acrylate by Cationic Palladium Catalysts That Contain Phosphine-Diethyl Phosphonate Ancillary Ligands. Organometallics 2014, 33, 3546-3555; Drent, E.; van Dijk, R.; van Ginkel, R.; van Oort, B.; Pugh, R. I. Palladium Catalysed Copolymerisation of Ethene with Alkylacrylates: Polar Comonomer Built into the Linear Polymer Chain. Chem. Commun. 2002, 7, 744-745) IR spectra were obtained using a ThermoNicolet Avator 360 FT-IR instrument. Gel permeation chromatography (GPC) data were obtained using a Malvern high-temperature GPC instrument equipped with refractive index, viscometer, and light scattering detectors at 160° C. with 1,2,4-trichlorobenzene (stabilized with 125 ppm 2,6-di-tert-butyl-4-methylphenol, BHT) as the mobile phase. The GPC instrument was calibrated using narrow polystyrene standards with universal calibration. All molecular weights reported are based on the triple detection method. Differential Scanning calorimetry (DSC) experiments were conducted on a TA DSC2500 equipped with an autosampler and refrigerated cooling system using aluminum hermetic sealed pans. Experiments were performed by heating under nitrogen (50 mL/min) at 10° C./min from 0 to 180° C. and cooling from 180 to 0° C. with 3˜ min isotherms at each extreme. All DSC experiments were recorded using the TRIOS software from TA. Thermal Gravimetric Analysis (TGA) experiments were collected on a TA TGA5500 equipped with an autosampler using a 100 μL platinum pan. Each sample was run after vigorous drying under vacuum. Experiments were heated at 5° C./min from RT to 650° C. under nitrogen flow (25 mL/min). Ts=temperature at which 5% mass loss of the polymers is observed by TGA.

### Synthesis and Characterization

### Example 19. Preparation of Compound 3A

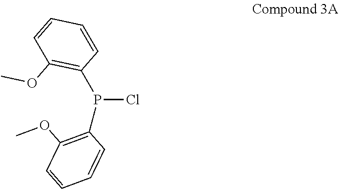 [SMILES: COc1ccccc1P(Cl)c1ccccc1OC]

This synthesis was modified from a reported procedure (Tran, T. V.; Nguyen, Y. H.; Do, L. H. Development of Highly Productive Nickel-Sodium Phenoxyphosphine Ethylene Polymerization Catalysts and Their Reaction Temperature Profiles. Polym. Chem. 2019, 10, 3718-3721). A 500 mL Schlenk flask was charged with excess magnesium turnings (1.5 g) under nitrogen in 30 mL of dry THF. The compound 2-bromoanisole (2.6 mL, 20 mmol, 2.0 equiv.) was added to the reaction mixture and then stirred at RT for 30 mins. The resulting Grignard reagent was slowly cannula transferred over 30 min to a solution of PCl₃ (0.8 mL, 10 mmol, 1.0 equiv.) in 50 mL of dry THF at −78° C. After the addition was complete, the heterogeneous mixture was continued stirring for 90 min and then warmed up to RT. Finally, the solvent was removed under vacuum, and the crude product was used in the next step without further purification. ³¹P NMR (CDCl₃, 202 MHz): δ (ppm)=70.03 (s), 62.85 (s) (two phosphorus-containing species were observed).

### Example 20. Preparation of Compound 5A

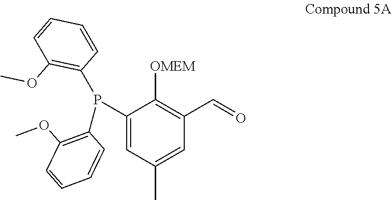

This synthesis was modified from a reported procedure (Tran, T. V.; Nguyen, Y. H.; Do, L. H. Development of Highly Productive Nickel-Sodium Phenoxyphosphine Ethylene Polymerization Catalysts and Their Reaction Temperature Profiles. Polym. Chem. 2019, 10, 3718-3721). To a solution of 4A (2 g, 3.86 mmol, 1 equiv.) in 50 mL of dry THF in a Schlenk flask under nitrogen at −78° C., n-BuLi (1.6 M in hexanes, 2.8 mL, 4.48 mmol, 1.1 equiv.) was added dropwise using a syringe. The reaction mixture was then stirred at −78° C. for 1 h. Dry DMF was then added to the reaction mixture (1.5 mL, 19.3 mmol, 5 equiv.) and the mixture was slowly warmed to RT and stirred overnight. An NH₄Cl solution was added to quench the reaction and the products were extracted into Et₂O. The organic layers were combined, washed with H₂O, dried over Na₂SO₄, filtered, and evaporated to dryness, affording a yellow oil (5A). This compound was used directly in the next step without further purification.

### Example 21. Preparation of Compound 6A

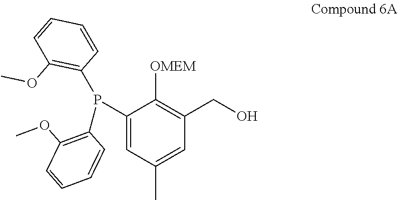

This synthesis was modified from a reported procedure (Tran, T. V.; Nguyen, Y. H.; Do, L. H. Development of Highly Productive Nickel-Sodium Phenoxyphosphine Ethylene Polymerization Catalysts and Their Reaction Temperature Profiles. Polym. Chem. 2019, 10, 3718-3721). Compound 5A was dissolved in 150 mL of MeOH and 50 mL of THF. Small aliquots of NaBH₄ (730 mg, 19.3 mmol, 5 equiv.) were added at 0° C. and the mixture was slowly warmed to RT and then stirred for 4 h. The reaction solvent was removed under vacuum and the residue was redissolved in Et₂O. The ether layer was washed with H₂O, dried over Na₂SO₄, filtered, and evaporated to dryness. The crude material was purified by silica gel column chromatography (1:3 hexane:ethyl acetate) to afford a white solid (640 mg, 1.36 mmol, 35%). ¹H NMR (CDCl₃, 600 MHz): δ (ppm)=7.32 (t, 2H), 7.19, (s, 1H), 6.85 (m, 4H), 6.61 (m, 2H), 6.51 (s, 1H), 5.28 (s, 2H), 4.61 (s, 2H), 3.87 (m, 2H), 3.72 (s, 6H), 3.57 (m, 2H), 3.36 (s, 3H), 2.14 (s, 3H). ¹³C NMR (CDCl₃, 126 MHZ): δ (ppm)=161.31, 161.18, 157.83, 157.67, 135.18, 134.80, 134.50, 133.85, 132.86, 130.48, 123.63, 121.14, 110.22, 100.02, 99.91, 71.52, 69.20, 60.98, 59.14, 55.79, 20.97. ³¹P NMR (CDCl₃, 202 MHZ): δ (ppm)=−38.45.

### Example 22. Preparation of Compound 8A

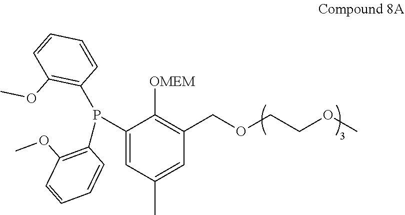

This synthesis was modified from a reported procedure (Tran, T. V.; Nguyen, Y. H.; Do, L. H. Development of Highly Productive Nickel-Sodium Phenoxyphosphine Ethylene Polymerization Catalysts and Their Reaction Temperature Profiles. Polym. Chem. 2019, 10, 3718-3721). To a mixture of 6A (0.6 g, 1.28 mmol, 1 equiv.) in 100 mL of dry THF in a Schlenk flask under nitrogen at 0° C., small aliquots of KHMDS (0.768 g, 3.84 mmol, 3 equiv.) were added. The reaction mixture was stirred at RT for 4 h. A solution containing compound 7A (3.4 g, 7.68 mmol, 6 equiv.) in 50 mL of THF was cannula transferred into the reaction mixture and then stirred for 2 d. The reaction was quenched by the slow addition of cold H₂O and the product was extracted into Et₂O. The organic layers were combined, washed with H₂O, dried over Na₂SO₄, filtered, and evaporated to dryness at 30° C. to afford a pale-yellow oil. This compound was used directly in the next step without further purification.

### Example 23. Preparation of Compound 9A

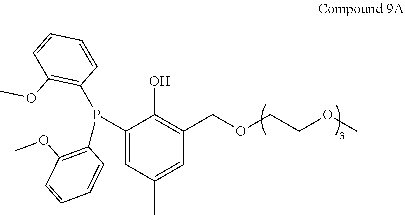

Compound 8A (566 mg, 0.88 mmol, 1 equiv.) was dissolved in 5 mL of MeOH and then treated with 25 mL of 2 M HCl in Et₂O. The reaction mixture was stirred at RT overnight. The solvent was removed under vacuum and the product was dissolved in 50 mL of EtOAc. A 25 mL solution of 1 M NaHCO₃ in H₂O was then added. The mixture was stirred at RT for 30 min and the product was extracted into Et₂O. The organic layers were combined, washed with H₂O, dried over Na₂SO₄, filtered, and evaporated to dryness. The crude material was purified by silica gel column chromatography (1:3 hexane:ethyl acetate) to afford a white waxy solid (417 mg, 0.76 mmol, 86%). ¹H NMR (CDCl₃, 500 MHz): δ (ppm)=7.34 (t, 2H), 7.22 (d, 1H), 6.97 (s, 1H), 6.85 (m, 4H), 6.78 (m, 2H), 6.54 (m, 1H), 4.67 (s, 2H), 3.74 (s, 6H), 3.69 (m, 2H), 3.67 (m, 2H), 3.60 (m, 6H), 3.50 (m, 2H), 3.35 (s, 3H), 2.12 (s, 3H). ¹³C NMR (CDCl₃, 126 MHz): δ (ppm)=161.55, 161.45, 155.98, 155.85, 134.40, 133.77, 130.63, 130.22, 129.06, 124.03, 123.96, 122.60, 121.54, 121.48, 121.07, 110.35, 72.02, 71.01, 70.79, 70.64, 70.43, 69.76, 59.13, 55.83, 20.73. ³¹P NMR (CDCl₃, 202 MHZ): δ (ppm)=−44.12.

### Example 24. Preparation of Compound Ni1

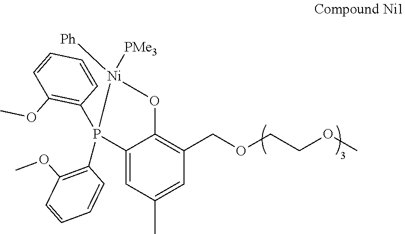

This synthesis was modified from a reported procedure (Tran, T. V.; Nguyen, Y. H.; Do, L. H. Development of Highly Productive Nickel-Sodium Phenoxyphosphine Ethylene Polymerization Catalysts and Their Reaction Temperature Profiles. Polym. Chem. 2019, 10, 3718-3721). Inside the glovebox, compound 9A (150 mg, 0.28 mmol, 1.0 equiv.) was dissolved in 15 mL of dry THF. Small aliquots of NaH (60%, 44.8 mg, 1.12 mmol, 4.0 equiv.) were added and the mixture was stirred at RT for 2 h. The mixture was filtered to remove excess NaH and then a solution of NiPhBr(PMe₃)₂ (98 mg, 0.27 mmol, 0.96 equiv.) in 2 mL of benzene was added. The resulting mixture was stirred at RT for 4 h, the solution was filtered to remove the precipitate, and the filtrate was dried completely under vacuum. The crude material was dissolved in a mixture of 5 mL of pentane and 0.5 mL of benzene and allowed to stand for 2 h. Another filtration was performed to remove the precipitate, and the filtrate was dried again. Finally, the resulting solid was washed with cold pentane and dried under vacuum to afford a yellow solid (128 mg, 0.17 mmol, 62%). ¹H NMR (C₆D₆, 500 MHz): δ (ppm)=7.64 (m, 2H), 7.36 (s, 1H), 7.23 (d, 2H), 7.02 (m, 2H), 6.73 (t, 2H), 6.66 (t, 2H), 6.61 (m, 1H), 6.36 (d, 2H), 4.85 (s, 2H), 3.72 (m, 2H), 3.60 (m, 2H), 3.47 (m, 2H), 3.43 (m, 4H), 3.29 (m, 2H), 3.06 (s, 3H), 2.95 (s, 6H), 2.03 (s, 3H), 0.81 (d, 9H). ¹³C NMR (C₆D₆, 126 MHz): δ (ppm)=173.87, 173.59, 161.06, 151.31, 151.04, 137.37, 134.29, 133.24, 132.08, 131.27, 128.25, 128.06, 125.53, 122.60, 120.77, 120.70, 120.62, 120.39, 120.03, 118.23, 117.85, 110.77, 72.40, 71.30, 71.10, 70.95, 70.20, 58.71, 55.10, 20.75, 11.88, 11.68. ³¹P NMR (C₆D₆, 202 MHZ): δ (ppm)=14.17, 12.69, −11.28, −12.85.

### Example 25. Metal Exchange Studies: NMR Spectroscopy

Inside the glovebox, the nickel complex (25 μmol) and various amounts of NaBAr^{F}₄ or CsBAr_{F}⁴ were dissolved in 0.5 mL of toluene-d₈:ether mixture (48:2) in a 20 mL vial and stirred for 10 mins. The mixture was then transferred to an NMR tube and then measured by ³¹P NMR spectroscopy at RT. For samples containing MA, the concentration of the polar monomer was 0.05 M.

### Example 26. Polymerization Studies

### General Procedure for Ethylene and Alkyl Acrylate Copolymerization.

Inside the glovebox, Ni1 and MBAr_{F}⁴ were dissolved in 5 mL of toluene/ether (3:2) in a 20 mL vial and stirred for 10 min. Solid Ni(COD)₂ (4.0 equiv.) was added and stirred until a clear solution was obtained. The mixture was loaded into a 10 mL syringe equipped with an 8-inch stainless steel needle. The loaded syringe was sealed by sticking the needle tip into a rubber septum and brought outside of the glove box. To prepare the polymerization reactor, 45 mL of dry toluene was placed in an empty autoclave. The autoclave was pressurized with ethylene to 400 psi and then the reactor pressure was reduced to 50 psi. This process was repeated 3 times to remove trace amounts of dioxygen inside the reaction vessel. A certain amount of polar monomer was then injected into the Parr reactor through the side arm. The Parr reactor was then heated to a set temperature and then held for 15 mins to allow the system to equilibrate. The catalyst solution was then injected into the autoclave through a sidearm. Finally, the reactor pressure was increased to the desired pressure, and the contents were stirred vigorously. To stop the polymerization, the autoclave was vented and cooled. A solution of MeOH (200 mL) was added to precipitate the polymer and 5 drops of conc. HCl was added to quench the catalyst. The polymer was collected by filtration, rinsed with MeOH, and dried under vacuum at 60° C. overnight. The reported yields are average values obtained from duplicate runs.

### Special Notes:

For all polymerization reactions, the reaction temperature was controlled by manual cooling of the reactor with an air stream when the reactor increases more than 5° C. above the desired temperature.

To clean the Parr reactor, the vessel was washed with hot toluene (90° C.) to remove the polymer sample from the previous run and rinsed with acetone before drying under vacuum for at least 2 h to remove trace amounts of water.

Incorporation of alkyl acrylates were calculated using formulas reported in the literature (Tahmouresilerd, B., Xiao, D.; Do, L. H. Rigidifying Cation-Tunable Nickel Catalysts Increases Activity and Polar Monomer Incorporation in Ethylene and Methyl Acrylate Copolymerization. Inorg. Chem. 2021, 60, 19035-19043; Xiong, S.; Hong, A.; Bailey, B. C.; Spinney, H. A., Senecal, T. D., Bailey, H.; Agapie, T. Highly Active and Thermally Robust Nickel Enolate Catalysts for the Synthesis of Ethylene-Acrylate Copolymers. Angew. Chem., Int. Ed. 2022, 67, e202206637).

### Example 27. Ethylene and Methyl Acrylate Copolymerization Under Non-Switching Conditions with Two Different Cations

Inside the glovebox, 2 mmol of Ni1 was dissolved in 4.8 mL toluene in a 20 mL vial followed by the addition of various amounts of MBAr^{F}₄ and M′BAr^{F}₄ (where M and M′ are different alkali ions; the total amount of salt used is 2.0 equiv. relative to Ni). To this solution, 0.2 mL of Et₂O was added and the mixture was stirred for 10 min. Solid Ni(COD)₂ (4.0 equiv.) was added and stirred until a clear solution was obtained. The mixture was loaded into a 10 mL syringe equipped with an 8-inch stainless steel needle. The loaded syringe was sealed by sticking the needle tip into a rubber septum and brought outside of the glovebox. To prepare the polymerization reactor, 45 mL of dry toluene was placed in an empty autoclave. The autoclave was pressurized with ethylene to 400 psi and then the reactor pressure was reduced to 50 psi. This process was repeated 3 times to remove trace amounts of dioxygen inside the reaction vessel. Methyl acrylate was then injected into the Parr reactor through the sidearm. The Parr reactor was then heated and held at the desired temperature for 15 min to allow the system to equilibrate. The catalyst solution was then injected into the autoclave through a sidearm. Finally, the reactor pressure was increased to the desired pressure, and the contents were stirred vigorously. To stop the polymerization, the autoclave was vented and cooled. A solution of MeOH (200 mL) was added to precipitate the polymer and 5 drops of conc. HCl was added to quench the catalyst. The polymer was collected by filtration, rinsed with MeOH, and dried under vacuum at 60° C. overnight. The reported yields are average values obtained from duplicate runs.

### Example 28. Ethylene and Methyl Acrylate Copolymerization Under Dynamic Switching Conditions with Two Different Cations

Inside the glovebox, 2 mmol of Ni1 was dissolved in 3 mL of toluene in a 20 mL vial followed by the addition of various amounts of MBAr^{F}₄ and M′BAr^{F}₄ (where M and M′ are different alkali ions; the total amount of salt used is 2.0 equiv. relative to Ni). To this solution, 2 mL of Et₂O was added and the mixture was stirred for 10 min. Solid Ni(COD)₂ (4.0 equiv.) was added and stirred until a clear solution was obtained. The mixture was loaded into a 10 mL syringe equipped with an 8-inch stainless steel needle. The loaded syringe was sealed by sticking the needle tip into a rubber septum and brought outside of the glovebox. To prepare the polymerization reactor, 45 mL of dry toluene was placed in an empty autoclave. The autoclave was pressurized with ethylene to 400 psi and then the reactor pressure was reduced to 50 psi. This process was repeated 3 times to remove trace amounts of dioxygen inside the reaction vessel. Methyl acrylate was then injected into the Parr reactor through the sidearm. The Parr reactor was heated and held at the desired temperature for 15 min to let the system equilibrate. The catalyst solution was then injected into the autoclave through a sidearm. Finally, the reactor pressure was increased to the desired pressure, and the contents were stirred vigorously. To stop the polymerization, the autoclave was vented and cooled. A solution of MeOH (200 mL) was added to precipitate the polymer and 5 drops of conc. HCl was added to quench the catalyst. The polymer was collected by filtration, rinsed with MeOH, and dried under vacuum at 60° C. overnight. The reported yields are average values obtained from duplicate runs.

### Example 29. Ethylene and Alkyl Acrylate Copolymerization

TABLE 4A
Nickel Catalyst Amount Optimizationª

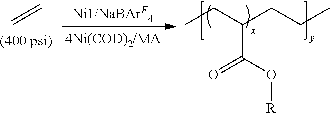

| | Catalyst | | | | | | |
|---|---|---|---|---|---|---|---|
| | Amount | Yield | Activity | Incorp.^{b} | Mₙ^{c} | | |
| Entry | (μmol) | (mg) | (kg/mol Ni ·h) | (mol %) | (kg/mol) | Ð^{c} | MA/Chain |
| 1 | 0.5 | 0 | 0 | — | — | — | — |
| 2 | 1 | 35 | 70 | 0.66 | 1.6 | 2.2 | 0.37 |
| 3 | 2 | 328 | 328 | 1.08 | 2.2 | 1.1 | 0.83 |

^{a}Polymerization conditions: Nil (varies), NaBAr^{F}₄ (2 equiv. relative to Ni), Ni(COD)₂ (4 equiv. relative to Ni), ethylene (400 psi), temperature (30° C.), methyl acrylate (0.05M), 48 mL toluene/2 mL Et₂O, 30 min. Temperature was controlled by manual external cooling when necessary to ensure that the reaction temperature did not exceed 5° C. from the starting temperature.
^{b}Methyl acrylate incorporation was determined by ¹H NMR spectroscopy.
^{c}Determined by GPC in trichlorobenzene at 160 °C.

TABLE 5A
Methyl Acrylate Monomer Concentration Optimization^{a}

| | | [MA] | Yield | Activity | Incorp.^{b} | Mₙ^{c} | |
|---|---|---|---|---|---|---|---|
| Entry | Cation | (M) | (mg) | (kg/mol Ni · h) | (mol %) | (kg/mol) | Ð^{c} |
| 1 | Na⁺ | 0.05 | 328 | 328 | 1.08 | 2.2 | 1.1 |
| 2 | Na⁺ | 0.1 | 105 | 105 | 1.72 | 1.8 | 1.3 |
| 3 | Na⁺ | 0.25 | 0 | 0 | — | — | — |
| 4 | Li⁺ | 0.05 | 1020 | 1020 | 0.71 | 18.9 | 1.4 |
| 5 | Li⁺ | 0.25 | 0 | 0 | — | — | — |

^{a}Polymerization conditions: Ni1 (2 μmol), MBAr^{F}₄ (4 μmol), Ni(COD)₂ (8 μmol), ethylene (400 psi), temperature (30° C.), 48 mL toluene/2 mL Et₂O, 30 min. Temperature was controlled by manual external cooling when necessary to ensure that the reaction temperature did not exceed 5 ° C. from the starting temperature.
^{b}Methyl acrylate incorporation was determined by ¹H NMR spectroscopy.
^{c}Determined by GPC in trichlorobenzene at 160° C.

TABLE 6A
Reaction Time Optimization^{a}

| | Time | [MA] | Yield | Activity | Incorp.^{b} | Mₙ^{c} | |
|---|---|---|---|---|---|---|---|
| Entry | (h) | (M) | (mg) | (kg/mol Ni · h) | (mol %) | (kg/mol) | Ð^{c} |
| 1 | 0.5 | 0.05 | 328 | 328 | 1.08 | 2.2 | 1.1 |
| 2 | 1 | 0.05 | 312 | 312 | 1.06 | 2.7 | 1.4 |
| 3 | 2 | 0.05 | 227 | 227 | 1.09 | 2.6 | 1.5 |

^{a}Polymerization conditions: Ni1 catalyst (2 μmol), NaBAr^{F}₄ (4 μmol), Ni(COD)₂ (8 μmol), ethylene (400 psi), temperature (30° C.), 48 mL toluene/2 mL Et₂O, 30 min. Temperature was controlled by manual external cooling when necessary to ensure the reaction temperature did not exceed 5° C. from the starting temperature.
^{b}Methyl acrylate incorporation was determined by ¹H NMR spectroscopy.
^{c}Determined by GPC in trichlorobenzene at 160° C.

TABLE 7A
Thermal Stability of Ni1—Cs in Copolymerization^{a}

| | Temp. | [MA] | Yield | Activity | Incorp.^{b} | Mₙ^{c} | |
|---|---|---|---|---|---|---|---|
| Entry | (° C.) | (M) | (mg) | (kg/mol Ni · h) | (mol %) | (kg/mol) | Ð^{c} |
| 1 | 30 | 0.05 | 196 | 196 | 1.26 | 12.3 | 1.6 |
| 2 | 50 | 0.05 | 363 | 363 | 1.47 | 11.8 | 1.2 |
| 3 | 70 | 0.05 | 512 | 512 | 2.10 | 5.5 | 1.2 |
| 4 | 90 | 0.05 | 485 | 485 | 1.96 | 5.4 | 1.4 |

^{a}Polymerization conditions: Ni1 catalyst (2 μmol), CsBAr^{F}₄ (4 μmol), Ni(COD)₂ (8 μmol), ethylene (400 psi), 48 mL toluene/2 mL Et₂O, 30 min. Temperature was controlled by manual external cooling when necessary to ensure the reaction temperature did not exceed 5° C. from the starting temperature.
^{b}Methyl acrylate incorporation was determined by ¹H NMR spectroscopy.
^{c}Determined by GPC in trichlorobenzene at 160° C.

TABLE 8A
Ethylene and Alkyl Acrylate Copolymerization Using Ni1 with Different Cations^{a}

| | | | | Activity | | | | | |
|---|---|---|---|---|---|---|---|---|---|
| | | Alkyl | Yield | (kg/mol | Inc.^{b} | Mₙ^{c} | | Acrylate/ | Tₘ |
| Entry | Cation | Acrylate | (mg) | Ni · h) | (mol %) | (kg/mol) | Ð^{c} | Chain | (° C.) |
| 1 | — | MA | — | — | — | — | — | — | — |
| 2 | Li⁺ | MA | 1020 | 1020 | 0.71 | 18.9 | 1.4 | 4.66 | 129 |
| 3 | Na⁺ | MA | 328 | 328 | 1.08 | 2.2 | 1.1 | 0.83 | 107 |
| 4 | K⁺ | MA | 340 | 340 | 1.12 | 3.1 | 1.4 | 1.21 | 115 |
| 5 | Cs⁺ | MA | 196 | 196 | 1.26 | 12.3 | 1.6 | 5.39 | 119 |
| 6 | Li⁺ | BA | 843 | 843 | 0.26 | 14.8 | 1.3 | 1.36 | 124 |
| 7 | Na⁺ | BA | 492 | 492 | 0.58 | 2.3 | 1.4 | 0.47 | 112 |
| 8 | K⁺ | BA | 467 | 467 | 0.76 | 3.7 | 1.8 | 0.98 | 121 |
| 9 | Cs⁺ | BA | 312 | 312 | 0.89 | 15.1 | 1.5 | 4.65 | 116 |
| 10 | Li⁺ | EA | 366 | 366 | 0.2 | 11.7 | 1.5 | 0.83 | 124 |

^{a}Polymerization conditions: Ni1 catalyst (2 μmol), MBAr^{F}₄ (4 μmol), Ni(COD)₂ (8 μmol), ethylene (400 psi), alkyl acrylate (0.05M), 48 mL toluene/2 mL Et₂O, 30° C., 30 min. In the absence of cations, Ni1 is not active for polymerization. Temperature was controlled by manual external cooling when necessary to ensure the reaction temperature did not exceed 5° C. from the starting temperature.
^{b}Alkyl acrylate incorporation was determined by ¹H NMR spectroscopy.
^{c}Determined by GPC in trichlorobenzene at 160° C.
MA = methyl acrylate, BA = tert-butyl acrylate, EA = ethyl acrylate.

TABLE 9A
Ethylene and Alkyl Acrylate Copolymerization
Using Ni1 and CsBAr^{F}₄ at 70° C.^{a}

| | | Alkyl | | Activity | | | |
|---|---|---|---|---|---|---|---|
| | Polar | Acrylate | Yield | (kg/mol | Inc.^{b} | Mₙ^{c} | |
| Entry | Monomer | Conc. (M) | (mg) | Ni · h) | (mol %) | (kg/mol) | Ð^{c} |
| 1 | MA | 0.05 | 512 | 512 | 2.1 | 5.5 | 1.2 |
| 2 | EA | 0.05 | 647 | 647 | 1.6 | 9.2 | 1.2 |
| 3 | BA | 0.05 | 988 | 988 | 2.0 | 6.4 | 1.4 |

^{a}Polymerization conditions: Ni1 catalyst (2 μmol), CsBAr^{F}₄ (4 μmol), Ni(COD)₂ (8 μmol), ethylene (400 psi), 48 mL toluene/2 mL Et₂O, 70° C., 30 min. Temperature was controlled by manual external cooling when necessary to ensure the reaction temperature did not exceed 5° C.
from the starting temperature.
^{b}Alkyl acrylate incorporation was determined by ¹H NMR spectroscopy.
^{c}Determined by GPC in trichlorobenzene at 160° C.

TABLE 10A
Effects of Solvent Polarity on Ethylene and Methyl Acrylate
Copolymerization Using Ni1 with Cs⁺/Na⁺ (1:1)^{a}

| | | | | Activity | | | | |
|---|---|---|---|---|---|---|---|---|
| | Tol. | Ether | Yield | (kg/mol | Inc.^{b} | Mₙ^{c} | | |
| Entry | (mL) | (mL) | (mg) | Ni · h) | (mol %) | (kg/mol) | Ð^{c} | Modality |
| 1 | 49.8 | 0.2 | 341 | 341 | 0.95 | 4.5 | 3.2 | Bimodal |
| 2 | 48.0 | 2.0 | 213 | 213 | 1.02 | 5.5 | 1.4 | Slightly |
| | | | | | | | | bimodal |
| 3 | 47.0 | 3.0 | 117 | 117 | 1.34 | 4.6 | 1.4 | Monomodal |
| 4 | 46.0 | 4.0 | 56 | 56 | 1.47 | 5.7 | 1.7 | Monomodal |
| 5 | 45.0 | 5.0 | 0 | 0 | — | — | — | — |

^{a}Polymerization conditions: Ni1 catalyst (2 μmol), Ni(COD)₂ (8 μmol), NaBAr^{F}₄ (2 μmol), CsBAr^{F}₄ (2 μmol), ethylene (400 psi), methyl acrylate (0.05M), 30° C., 30 min. Temperature was controlled by manual external cooling when necessary to ensure the reaction temperature did not exceed 5° C. from the starting temperature.
^{b}Methyl acrylate incorporation was determined by ¹H NMR spectroscopy.
^{c}Determined by GPC in trichlorobenzene at 160° C.

TABLE 11A
Effect of Solvent Polarity on Ethylene and Methyl Acrylate
Copolymerization Using Ni1 with Li⁺/Na⁺ (1:1)^{a}

| | Tol. | Ether | Yield | Activity | Inc.^{b} | Mₙ^{c} | | |
|---|---|---|---|---|---|---|---|---|
| Entry | (mL) | (mL) | (mg) | (kg/mol Ni · h) | (mol %) | (kg/mol) | Ð^{c} | Modality |
| 1 | 49.8 | 0.2 | 647 | 647 | 0.82 | 4.3 | 2.8 | Bimodal |
| 2 | 48.0 | 2.0 | 591 | 591 | 1.04 | 11.8 | 1.2 | Monomodal |
| 3 | 47.0 | 3.0 | 565 | 565 | 1.05 | 10.0 | 2.0 | Monomodal |
| 4 | 46.0 | 4.0 | 143 | 143 | 1.07 | 7.1 | 2.0 | Monomodal |
| 5 | 45.0 | 5.0 | 31 | 31 | 1.25 | 1.0 | 1.7 | Monomodal |

^{a}Polymerization conditions: Ni1 catalyst (2 μmol), Ni(COD)₂ (8 μmol), ethylene (400 psi), NaBAr^{F}₄ (2 μmol), LiBAr^{F}₄ (2 μmol), methyl acrylate (0.05M), 30° C., 30 min. Temperature was controlled by manual external cooling when necessary to ensure the reaction temperature did not exceed 5° C. from the starting temperature.
^{b}Methyl acrylate incorporation was determined by ¹H NMR spectroscopy.
^{c}Determined by GPC in trichlorobenzene at 160° C.

TABLE 12A
Non-Switching Ethylene and Methyl Acrylate Copolymerization
Using Ni1 with Different Amounts of Li⁺/Na⁺.

| | LiBAr^{F}₄ | NaBAr^{F}₄ | Yield | Activity | Inc.^{b} | Mₙ^{c} | |
|---|---|---|---|---|---|---|---|
| Entry | (equiv.) | (equiv.) | (mg) | (kg/mol Ni · h) | (mol %) | (kg/mol) | Ð^{c} |
| 1 | 2 | — | 997 | 997 | 0.37 | 12.6 | 1.4 |
| 2 | 1.5 | 0.5 | 695 | 695 | 0.63 | 7.8 | 1.8 |
| 3 | 1 | 1 | 647 | 647 | 0.82 | 4.3 | 2.8 |
| 4 | 0.5 | 1.5 | 496 | 496 | 0.79 | 2.5 | 2.4 |
| 5 | — | 2 | 431 | 431 | 0.86 | 2.4 | 1.5 |

^{a}Polymerization conditions: Ni1 catalyst (2 μmol), Ni(COD)₂ (8 μmol), ethylene (400 psi), methyl acrylate (0.05M), 49.8 mL toluene/0.2 mL Et20, 30° C., 30 min. Temperature was controlled by manual external cooling when necessary to ensure the reaction temperature did not exceed 5° C. from the starting temperature.
^{b}Methyl acrylate incorporation was determined by ¹H NMR spectroscopy.
^{c}Determined by GPC in trichlorobenzene at 160° C.

TABLE 13A
Dynamic Switching of Ethylene and Methyl Acrylate Copolymerization
Using Nil with Different Amounts of LiBAr^{F}₄/NaBAr^{F}4ª

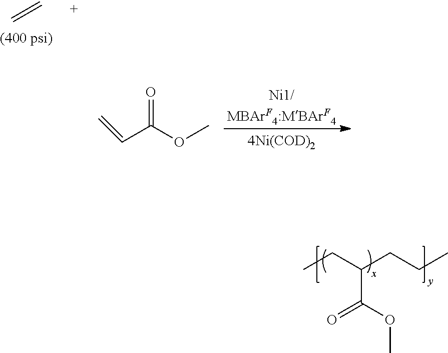

| | | | | | Average | | | |
|---|---|---|---|---|---|---|---|---|
| | Li⁺ | Na⁺ | Run 1 | Run 2 | Yield | Activity | Inc.^{b} | Mₙ^{c} |
| Entry | (equiv.) | (equiv.) | (mg) | (mg) | (mg) | (kg/mol Ni · h) | (mol %) | (kg/mol) |
| 1 | 2 | — | 1050 | 989 | 1020 | 1020 | 0.71 | 18.9 |
| 2 | 1.67 | 0.33 | 872 | 953 | 913 | 913 | 0.73 | 18.5 |
| 3 | 1.5 | 0.5 | 688 | 685 | 686 | 686 | 0.83 | 15.4 |
| 4 | 1.33 | 0.67 | 722 | 659 | 690 | 690 | 0.96 | 15.9 |
| 5 | 1 | 1 | 591 | 603 | 597 | 597 | 1.04 | 11.8 |
| 6 | 0.5 | 1.5 | 423 | 372 | 397 | 397 | 1.11 | 6.0 |
| 7 | — | 2 | 369 | 286 | 328 | 328 | 1.08 | 2.2 |

aPolymerization conditions: Nil catalyst (2 μmol), Ni(COD)₂ (8 μmol), ethylene (400 psi), methyl acrylate (0.05M), 48 mL toluene/2 mL Et₂O, 30° C., 30 min. Temperature was controlled by manual external cooling when necessary to ensure the reaction temperature did not exceed 5° C. from the starting temperature.
^{b}Methyl acrylate incorporation was determined by ¹H NMR spectroscopy.
^{c}Determined by GPC in trichlorobenzene at 160 °C.

TABLE 14A
Dynamic Switching of Ethylene and Methyl Acrylate Copolymerization
Using Ni1 with Different Amounts of LiBAr^{F}₄/NaBAr^{F}₄^{a}

| | Li⁺ | Na⁺ | Run 1 | Run 2 | | T^{m} | MA/ | T₅ |
|---|---|---|---|---|---|---|---|---|
| Entry | (equiv.) | (equiv.) | (mg) | (mg) | Ð^{c} | (° C.) | chain | (° C.) |
| 3 | 2 | — | 1050 | 989 | 1.4 | 125 | 4.7 | 431 |
| 2 | 1.67 | 0.33 | 872 | 953 | 1.3 | 123 | 4.7 | 428 |
| 3 | 1.5 | 0.5 | 688 | 685 | 1.6 | 124 | 4.5 | 425 |
| 4 | 1.33 | 0.67 | 722 | 659 | 1.4 | 123 | 5.0 | 427 |
| 5 | 1 | 1 | 591 | 603 | 1.2 | 123 | 4.3 | 417 |
| 6 | 0.5 | 1.5 | 423 | 372 | 1.3 | 114 | 2.3 | 379 |
| 7 | — | 2 | 369 | 286 | 1.1 | 107 | 0.8 | 329 |

^{a}Polymerization conditions: Ni1 catalyst (2 μmol), Ni(COD)₂ (8 μmol), ethylene (400 psi), methyl acrylate (0.05M), 48 mL toluene/2 mL Et20, 30° C., 30 min. Temperature was controlled by manual external cooling when necessary to ensure the reaction temperature did not exceed 5° C. from the starting temperature.
^{b}Methyl acrylate incorporation was determined by ¹H NMR spectroscopy.
^{c}Determined by GPC in trichlorobenzene at 160° C.

TABLE 15A
Dynamic Switching of Ethylene and Methyl Acrylate Copolymerization
Using Ni1 with Different Amounts of CsBAr^{F}₄/NaBA^{F}₄^{a}

| | | | | | Average | | | |
|---|---|---|---|---|---|---|---|---|
| | Cs⁺ | Na⁺ | Run 1 | Run 2 | Yield | Activity | Inc.^{b} | Mₙ^{c} |
| Entry | (equiv.) | (equiv.) | (mg) | (mg) | (mg) | (kg/mol Ni · h) | (mol %) | (kg/mol) |
| 1 | 2 | — | 112 | 91 | 102 | 102 | 1.45 | 17.8 |
| 2 | 1.67 | 0.33 | 144 | 149 | 147 | 147 | 1.50 | 8.3 |
| 3 | 1.5 | 0.5 | 125 | 183 | 154 | 154 | 1.43 | 6.6 |
| 4 | 1.33 | 0.67 | 173 | 151 | 162 | 162 | 1.35 | 5.9 |
| 5 | 1 | 1 | 117 | 170 | 144 | 144 | 1.34 | 4.6 |
| 6 | 0.5 | 1.5 | 253 | 272 | 262 | 262 | 1.31 | 3.4 |
| 7 | — | 2 | 289 | 243 | 266 | 266 | 1.15 | 3.1 |

^{a}Polymerization conditions: Ni1 catalyst (2 μmol), Ni(COD)₂ (8 μmol), ethylene (400 psi), methyl acrylate (0.05M), 47 mL toluene/3 mL Et₂O, 30° C., 30 min. Temperature was controlled by manual external cooling when necessary to ensure the reaction temperature did not exceed 5° C. from the starting temperature.
^{b}Methyl acrylate incorporation was determined by ¹H NMR spectroscopy.
^{c}Determined by GPC in trichlorobenzene at 160° C.

TABLE 16A
Dynamic Switching of Ethylene and Methyl Acrylate Copolymerization
Using Ni1 with Different Amounts of CsBAr^{F}₄/NaBA^{F}₄^{a}

| | Cs⁺ | Na⁺ | Run 1 | Run 2 | | Tₘ | MA/ | T₅ |
|---|---|---|---|---|---|---|---|---|
| Entry | (equiv.) | (equiv.) | (mg) | (mg) | Ð^{c} | (° C.) | chain | (° C.) |
| 1 | 2 | — | 112 | 91 | 1.3 | 117 | 8.9 | 419 |
| 2 | 1.67 | 0.33 | 144 | 149 | 1.3 | 115 | 4.3 | 405 |
| 3 | 1.5 | 0.5 | 125 | 183 | 1.7 | 117 | 3.2 | 390 |
| 4 | 1.33 | 0.67 | 173 | 151 | 1.2 | 116 | 2.8 | 365 |
| 5 | 1 | 1 | 117 | 170 | 1.4 | 113 | 2.1 | 360 |
| 6 | 0.5 | 1.5 | 253 | 272 | 1.5 | 111 | 1.5 | 357 |
| 7 | — | 2 | 289 | 243 | 2.3 | 107 | 1.2 | 309 |

^{a}Polymerization conditions: Ni1 catalyst (2 μmol), Ni(COD)₂ (8 μmol), ethylene (400 psi), methyl acrylate (0.05M), 47 mL toluene/3 mL Et₂O, 30° C., 30 min. Temperature was controlled by manual external cooling when necessary to ensure the reaction temperature did not exceed 5° C. from the starting temperature.
^{b}Methyl acrylate incorporation was determined by ¹H NMR spectroscopy.
^{c}Determined by GPC in trichlorobenzene at 160° C.

TABLE 17A
Dynamic Switching of Ethylene and Methyl Acrylate Copolymerization
Using Ni1 with Different Amounts of LiBArF₄/CsBArF₄^{a}.

| | Li⁺ | Cs⁺ | | Yield | Activity | Inc.^{b} | Mₙ^{c} |
|---|---|---|---|---|---|---|---|
| Entry | (equiv.) | (equiv.) | Run | (mg) | (kg/mol Ni · h) | (mol %) | (kg/mol) |
| 1 | 2 | — | 1 | 657 | 657 | 0.94 | 17.1 |
| | | | 2 | 671 | 671 | 0.89 | 16.7 |
| | | | Avg. | 664 ± 10 | 664 ± 10 | 0.92 ± 0.03 | 16.9 ± 0.3 |
| 2 | 1.67 | 0.33 | 1 | 613 | 613 | 1.03 | 19.2 |
| | | | 2 | 658 | 658 | 1.02 | 17.5 |
| | | | Avg. | 636 ± 32 | 636 ± 32 | 1.03 ± 0.01 | 18.4 ± 1.2 |
| 3 | 1.5 | 0.5 | 1 | 561 | 561 | 1.12 | 20.0 |
| | | | 2 | 497 | 497 | 1.04 | 19.1 |
| | | | Avg. | 529 ± 45 | 529 ± 45 | 1.08 ± 0.06 | 19.6 ± 0.6 |
| 4 | 1.33 | 0.67 | | 562 | 562 | 1.14 | 19.6 |
| | | | 2 | 481 | 481 | 1.13 | 18.6 |
| | | | Avg. | 522 ± 57 | 522 ± 57 | 1.14 ± 0.01 | 19.1 ± 0.7 |
| 5 | 1 | 1 | 1 | 533 | 533 | 1.14 | 21.0 |
| | | | 2 | 487 | 487 | 1.27 | 18.4 |
| | | | Avg. | 510 ± 32 | 510 ± 32 | 1.21 ± 0.09 | 19.7 ± 1.8 |
| 6 | 0.5 | 1.5 | 1 | 136 | 136 | 1.45 | 21.2 |
| | | | 2 | 185 | 185 | 1.37 | 20.0 |
| | | | Avg. | 161 ± 35 | 161 ± 35 | 1.41 ± 0.06 | 20.6 ± 0.8 |
| 7 | — | 2 | 1 | 112 | 112 | 1.46 | 18.4 |
| | | | 2 | 91 | 91 | 1.44 | 17.1 |
| | | | Avg. | 102 ± 15 | 102 ± 15 | 1.45 ± 0.01 | 17.8 ± 0.9 |

^{a}Polymerization conditions: Ni1 catalyst (2 μmol), Ni(COD)₂ (4 equiv.), ethylene (400 psi), methyl acrylate (0.05M), 47 mL toluene/3 mL Et₂O, 30° C., 30 min. Temperature was controlled by manual external cooling when necessary to ensure the reaction temperature did not exceed 5° C. from the starting temperature.
^{b}Methyl acrylate incorporation was determined by ¹H NMR spectroscopy.
^{c}Determined by GPC in trichlorobenzene at 160° C.

TABLE 18A
Dynamic Switching of Ethylene and Methyl Acrylate Copolymerization
Using Ni1 with Different Amounts of LiBAr^{F}₄/CsBAr^{F}₄^{a}.

| | | | | | Tₘ | | T₅ |
|---|---|---|---|---|---|---|---|
| Entry | Li⁺ (equiv.) | Cs⁺ (equiv.) | Run | Ð^{c} | (° C.) | MA/chain | (° C.) |
| 1 | 2 | — | 1 | 2.0 | 123 | 5.6 | 424 |
| | | | 2 | 1.2 | 121 | 5.2 | 417 |
| | | | Avg. | 1.6 ± 0.6 | 122 ± 1.4 | 5.4 ± 0.3 | 421 ± 4.9 |
| 2 | 1.67 | 0.33 | 1 | 1.2 | 123 | 6.9 | 427 |
| | | | 2 | 1.3 | 122 | 6.2 | 427 |
| | | | Avg. | 1.3 ± 0.1 | 123 ± 0.7 | 6.6 ± 0.5 | 427 ± 0 |
| 3 | 1.5 | 0.5 | 1 | 1.7 | 121 | 7.8 | 431 |
| | | | 2 | 1.2 | 124 | 6.9 | 435 |
| | | | Avg. | 1.5 ± 0.3 | 123 ± 2.1 | 7.4 ± 0.6 | 433 ± 2.8 |
| 4 | 1.33 | 0.67 | 1 | 1.2 | 118 | 7.8 | 429 |
| | | | 2 | 1.3 | 121 | 7.3 | 427 |
| | | | Avg. | 1.3 ± 0.1 | 120 ± 2.1 | 7.6 ± 0.3 | 428 ± 1.4 |
| 5 | 1 | 1 | 1 | 1.9 | 118 | 8.3 | 425 |
| | | | 2 | 1.2 | 118 | 8.1 | 423 |
| | | | Avg. | 1.6 ± 0.5 | 118 ± 0 | 8.2 ± 0.1 | 424 ± 1.4 |
| 6 | 0.5 | 1.5 | 1 | 1.9 | 117 | 10.7 | 426 |
| | | | 2 | 1.2 | 119 | 9.5 | 423 |
| | | | Avg. | 1.6 ± 0.5 | 118 ± 1.4 | 10.1 ± 0.8 | 425 ± 2.1 |
| 7 | — | 2 | 1 | 1.4 | 117 | 9.3 | 419 |
| | | | 2 | 1.2 | 116 | 8.5 | 419 |
| | | | Avg. | 1.3 ± 0.1 | 117 ± 0.7 | 8.9 ± 0.6 | 419 ± 0 |

^{a}Polymerization conditions: Ni1 catalyst (2 μmol), Ni(COD)₂ (4 equiv.), ethylene (400 psi), methyl acrylate (0.05M), 47 mL toluene/3 mL Et₂O, 30° C., 30 min. Temperature was controlled by manual external cooling when necessary to ensure the reaction temperature did not exceed 5° C. from the starting temperature.
^{b}Methyl acrylate incorporation was determined by ¹H NMR spectroscopy.
^{c}Determined by GPC in trichlorobenzene at 160° C.

### Example 30. Empirically-Derived Mathematical Formulas for the Copolymerizations

Using our experimental data, mathematical formulas were derived for different catalyst systems (i.e., Ni+M+M′) to relate the ratio of M:M′ (where M≠M′; x), polar monomer incorporation (y), and the polymer molecular weight (z). To relate any two variables, data fitting using either linear or exponential mathematical functions were found to be adequate. For example, plotting x vs. y or x vs. z allowed us to obtain formulas to describe the effects of the M:M′ ratio on the polar monomer incorporation and polymer molecular weight, respectively. To relate all three variables, we used non-linear regression⁸ to model the experimental data with a custom program developed in Python (v3.8). Initially, the experimental data were visualized in a 3D plot to assist us in determining the most appropriate function to use. We employed the ‘curve_fit’ module from the SciPy library for fitting equations, which implements non-linear regression analysis. Parameter estimation was performed using the ‘pcov’ method, representing the covariance matrix of the parameter estimates. Mathematically, pcov is derived as the inverse of the Jacobian matrix, comprising the partial derivatives of the fitting function with respect to the parameters, scaled by the variance of the residuals. The codes used for these analytical calculations are provided below.

############ CODE FOR EXPERIMENTAL DATA PLOTTING ##############
import matplotlib.pyplot as plt
from mpl_toolkits import mplot3d
import numpy as np
#data = np.genfromtxt(fname=‘3D_CsNa_1.txt’)
data = np.genfromtxt(fname=‘cs_na.dat’)
#data = np.genfromtxt(fname=‘3D_LiNa.txt’)
fig = plt.figure( )
ax = plt.axes(projection=‘3d’)
# Plot the line
x = data[:,0]
y = data[:,1]
z = data[:,2]
print(x)
print(y)
ax.plot3D(x, y, z, ‘bo−’, label=‘3D Line’)
ax.invert_yaxis( )
ax.invert_xaxis( )
# Set labels and title
ax.set_xlabel(‘X-axis')
ax.set_ylabel(‘Y-axis')
ax.set_zlabel(‘Z-axis')
ax.set_title(‘3D Line Diagram of CsNa’)
# Add legend
ax.legend( )
# Show the plot
plt.show( )

############ CODE FOR CURVE FITTING ##############
import numpy as np
import pandas as pd
from scipy.optimize import curve_fit
import scipy optimize as optimize
# CsNa
data = np.genfromtxt(fname=‘cs_na.dat’)
x = data[:,0]
y = data[:,1]
z = data[:,2]
A=[ ]
for i in range(len(x)):
a = [ ]
a.append(z[i])
a.append(y[i])
a.append(x[i])
A.append(a)
A = np.array(A)
def func(data, a, b,c,d):
return a* np.exp(y) + z*b + c*y + d
guess = (2,1,10,1)
params, pcov = optimize.curve_fit(func, A[:,:2], A[:,2], guess)
print(params)
x = params[0]* np.exp(y)+ params[1]*z+params[2]*y + params[3]
print(“fit x”,x)
# LiNa
data = np.genfromtxt(fname=‘li_na.dat’)
x = data[:,0]
y = data[:,1]
z = data[:,2]
A= [ ]
for i in range(len(x)):
a = [ ]
a.append(z[i])
a.append(y[i])
a.append(x[i])
A.append(a)
A = np.array(A)
#A= np.array([(5,0.73,18.5),(3,0.83,15.4),(2,0.96,15.9),(1,1.04,11.8),(0.33,1.11,6),(0,1.08,2.2)])
def func(data, a, b,c,d):
#return a* np.exp(data[:,0]*b+ data[:,1]*c) +d
#return a + b*data[:,0] + c*data[:,1] + d*data[:,0]*data[:,1] + e*data[:,1]**3
return a + b*z+ c*y + d*y*z
guess = (−25,−6,24,15)
params, pcov = optimize.curve_fit(func, A[:,:2], A[:,2], guess)
print(params)
x = params[0] + params[1]*z + params[2]*y + params[3]*y*z
#z1 = −24.26648734 + −6.29626462* data[:,0] + 24.48095181*data[:,1]+
15.4199771*data[:,0]*data[:,1]
#z = params[0] + params[1]*data[:,0] + params[2]*data[:,1] + params[3]*data[:,0]*data[:,1] +
params[4]*data[:,1]**3
#print(z)
#print(z1)
print(“fit x”,x)
#LiCs
data = np.genfromtxt(fname=‘li_cs.dat’)
x = data[:,0]
y = data[:,1]
z = data[:,2]
A = [ ]
for i in range(len(x)):
a = [ ]
a.append(z[i])
a.append(y[i])
a.append(x[i])
A.append(a)
#print(A)
A = np.array(A)
#A
np.array([(5,1.03,18.4),(3,1.08,19.6),(2,1.14,19.1),(1,1.21,19.7),(0.33,1.41,20.6),(0,1.45,17.8)])
def func(data, a, b,c,d):
#return a*data[:,0]+ b*data[:,0]*np.sin(data[:,0]) + c*np.sin(data[:,1])+d
#return a*z + b*z*np.sin(z) + c*np.sin(y) +d
#return b*data[:,0]*np.sin(data[:,0]) + c*np.sin(data[:,1])+d
return a* np.exp(z) + y*b + c*z + d
#return a* np.exp(data[:,0])+ data[:,1]*b +c*data[:,0]
guess = (2,1,10,1)
params, pcov = optimize.curve_fit(func, A[:,:2], A[:,2], guess)
print(params)
#x = params[0]*z + params[1]*z*np.sin(z) + params[2]*np.sin(y) +params[3]
x = params[0]* np.exp(z)+ params[1]*y + params[2]*z + params[3]
#z = params[0]*data[:,0]*np.sin(data[:,0]) + params[1]*np.sin(data[:,1])+ params[2]
#z = params[0]* np.exp(data[:,0])+ data[:,1]*params[1] +params[2]*data[:,0]
print(“fit x”,x)
#print(z1)
#print(“ddddddddddd”)
# Curve fitting
fig = plt.figure( )
ax = plt.axes(projection=‘3d’)
x_0 = data[:,0]
y = data[:,1]
z = data[:,2]
print(“original x:”, x_0)
ax.plot3D(x_0,y,z, color=‘blue’, alpha=0.5, label=‘Original’)
ax.plot3D(x,y,z, color=‘red’, alpha=0.5, label = ‘Fit’)
#ax.plot3D(x,y,z1, color=‘green’, alpha=0.5, label = ‘Fit1’)
ax.set_zlim(0,20)
ax.set xlabel(‘X’)
ax.set_ylabel(‘Y’)
ax.set_zlabel(‘Z’)
ax.set_title(‘3D Line Diagram of CsNa’)
ax.legend( )
#plt.subplots_adjust(left=0.0, bottom=0.0, right=1.0, top=1.0)
plt.show( )
############ XXXXXXXXXXXXX ##############

3D Curve Fitting for Li⁺/Na⁺

The experimental plot is non-monotonic because the data exhibit irregular increases and decreases. Therefore, the most appropriate function for fitting is a polynomial function, which is capable of accommodating multiple inflection points.

### 3D Curve Fitting for Cs/Na⁺

These data appear to show periodic behavior so curve fitting was attempted using a sinusoidal function. However, the periodic fluctuation was found to be minimal. Instead, we successfully modeled the data by combining an exponential and polynomial function.

3D Curve Fitting for Li⁺/Cs⁺

These data were challenging to model because they showed neither a typical periodic function nor a monotonic function. We decided to use a polynomial function to capture all of the inflection points, supplemented by a low-magnitude exponential function for enhanced fitting accuracy. This combination provides a robust model that accommodates the intricate variations in the data.

TABLE 19A
Calculated and Experimental Parameters Using
Empirically-Derived Mathematical Formulas.

| Table and | | Cation | | Calculated | Experimental |
|---|---|---|---|---|---|
| Entry | Cations | Ratio | Formula^{a} | value | value |
| Table 13A | Li⁺/Na⁺ | 2:1 | z = 17.896 − 15.95e^{[-(x+0.0148)/1.105]} | 15.32 | 15.9 |
| and Table | | | | | |
| 14A | | | y = 1.1067 − 0.0785x | 0.95 | 0.96 |
| Entry 4 | | | x = 5.92y + 1.043z − 0.895yz − | 2.05 | 2 |
| | | | 6.542 | | |
| Table 15A | Cs⁺/Na⁺ | 2:1 | z = 1.049x + 3.336 | 5.4 | 5.9 |
| and Table | | | | | |
| 16A | | | y = 0.057x + 1.234 | 1.35 | 1.35 |
| Entry 4 | | | x = 14.198e^{y} + 0.587z − 48.237y + | 2 | 2 |
| | | | 8.82 | | |
| Table 17A | Li⁺/Cs⁺ | 2:1 | z = 19.42 − 0.115x | 19.19 | 19.1 |
| and Table | | | | | |
| 18A | | | y = 1.015 + 0.447e^{[-(x-0.013)/1.392]} | 1.12 | 1.14 |
| Entry 4 | | | x = 10⁻⁸e^{z} − 14.99y − 3.015z + | 2.07 | 2 |
| | | | 74.816 | | |

^{a}Here, x = ratio of two cations, y = mol % of MA incorporation, and z = Mₙ of copolymers.

TABLE 20A
Conventional Ethylene and Methyl Acrylate Copolymerizations
Using Ni1-Cs with Different Amounts of MA^{a}

| | | | Activity | | | | | |
|---|---|---|---|---|---|---|---|---|
| | | Yield | (kg PE/mol | Inc.^{b} | Mₙ^{c} | | Tₘ | |
| Entry | [MA] | (mg) | Ni · h) | (%) | (kg/mol) | Ð^{c} | (° C.) | MA/Chain |
| 1 | 0.0125 | 532 | 532 | 0.42 | 21.4 | 1.9 | 126 | 3.2 |
| 2 | 0.025 | 218 | 218 | 0.76 | 19.1 | 1.5 | 123 | 5.1 |
| 3 | 0.05 | 102 | 102 | 1.45 | 17.8 | 1.3 | 117 | 8.9 |
| 4 | 0.1 | 46 | 46 | 1.77 | 5.7 | 2.0 | 113 | 3.5 |
| 5 | 0.25 | 0 | — | — | — | — | — | — |

^{a}Polymerization conditions: Catalyst amount (2 μmol), CsBAr^{F}₄ (4 μmol), Ni(COD)₂ (8 μmol), ethylene (400 psi), 47 mL toluene/3 mL Et₂O, 30° C., 30 min. Temperature was controlled by manual external cooling when necessary to ensure the reaction temperature did not exceed 5° C. from the starting temperature.
^{b}Methyl acrylate incorporation was determined by ¹H NMR spectroscopy.
^{c}Determined by GPC in trichlorobenzene/dichlorobenzene at 160° C.

TABLE 21A
Synthesis of Ethylene Homopolymers Using Ni1 with
LiBAr^{F}₄ or CsBAr^{F}₄ For Polymer Characterization Studies^{a}

| | | | | | Activity | | |
|---|---|---|---|---|---|---|---|
| | Nil | Li⁺ | Cs⁺ | Yield | (kg PE/mol | Mₙ^{b} | B^{c} |
| Entry | (μmol) | (equiv.) | (equiv.) | (mg) | Ni · h) | (kg/mol) | (/1000 C) |
| 1 | 1 | — | 2 | 981 | 1308 | 18.5^{d} | 17 |
| | | | | 1049 | 1399 | 19.9 | 9 |
| 2 | 0.5 | 2 | — | 11600 | 46400 | 6.6 | 10 |

^{a}Polymerization conditions: Ni(COD)₂ (4 equiv.), ethylene (400 psi), 47 mL toluene/3 mL Et₂O, 30° C., 45 min. Temperature was controlled by manual external cooling when necessary to ensure the reaction temperature did not exceed 5° C. from the starting temperature.
^{b}Determined by GPC in trichlorobenzene at 150° C.
^{c}Branching was determined by ¹H NMR spectroscopy.
^{d}This PE sample was determined to have a Tₘ = 125° C. and T₅ = 430° C. based on differential scanning calorimetry and thermal gravimetric analysis, respectively.

TABLE 22A
Synthesis of Ethylene and MA Copolymers Using Ni1 with
LiBAr^{F}₄/CsBAr^{F}₄ For Polymer Characterization Studies^{a}

| | | | | | Activity | | | |
|---|---|---|---|---|---|---|---|---|
| | Li⁺ | Cs⁺ | Temp | Yield | (kg/mol | Inc.^{b} | Mₙ^{c} | B^{d} |
| Entry | (equiv.) | (equiv.) | (° C.) | (mg) | Ni · h) | (%) | (kg/mol) | (/1000 C) |
| 1 | 2 | — | 30 | 956 | 637 | 0.78 | 23.3 | 9 |
| | | | | 913 | 609 | 0.87 | 22.1 | 11 |
| 2 | 1.5 | 0.5 | 30 | 799 | 533 | 1.08 | 19.8 | 10 |
| | | | | 823 | 549 | 1.18 | 20.2 | 18 |
| 3 | 1 | 1 | 30 | 782 | 521 | 1.33 | 21.4 | 12 |
| | | | | 707 | 471 | 1.41 | 20.4 | 17 |
| 4^{e} | — | 2 | 70 | 712 | 475 | 1.94 | 6.6 | 14 |
| | | | | 789 | 526 | 1.87 | 7.4 | 10 |

^{a}Polymerization conditions: Ni1 catalyst (2 mol), Ni(COD)₂ (8 μmol), ethylene (400 psi), methyl acrylate (0.05M), 47 mL toluene/3 mL Et₂O, 45 min. Temperature was controlled by manual external cooling when necessary to ensure that the reaction temperature did not exceed 5° C. from the starting temperature.
^{b}Methyl acrylate incorporation was determined by ¹H NMR spectroscopy.
^{c}Determined by GPC in trichlorobenzene at 150° C.
^{d}Branching was determined by ¹H NMR spectroscopy.
^{e}Copolymerization was performed in 48 mL toluene/2 mL Et₂O solvent mixture.

### Example 31. Polymer Degradation Studies

For the degradation studies of ethylene homopolymers and ethylene methyl acrylate copolymers, 30 mg of the polymer samples were dispersed in 20 mL of H₂O and then treated with 0.1 mL of tert-butylperoxy 2-ethylhexyl carbonate (if any) followed by stirring at 75° C. for 24 h at a fixed rpm of 600. After this time, the heterogeneous solution was cooled to RT and the degraded polymers were collected by filtration, washed with water and acetone, and then dried overnight under vacuum at 70° C. The degraded polymers were characterized by JH NMR and IR spectroscopy. ¹H NMR spectroscopy: each NMR sample contained 10 mg of degraded polymer in 0.6 mL of 1,1,2,2-tetrachloroethane-d₂ (TCE-d₂) and was recorded using a 600 MHz spectrometer with standard acquisition parameters at 110° C. The samples were preheated for 30 min before data acquisition. The ¹H NMR spectra were assigned based on the chemical shift values reported in the literature (Lu, B.; Takahashi, K.; Zhou, J.; Nakagawa, S.; Yamamoto, Y.; Katashima, T.; Yoshie, N.; Nozaki, K. Mild Catalytic Degradation of Crystalline Polyethylene Units in Solid State Assisted by Carboxylic Acid Groups. J. Am. Chem. Soc. 2024, 146, 19599-19608; Baur, M.; Lin, F.; Morgen, T. O.; Odenwald, L.; Mecking, S. Polyethylene materials with in-chain ketones from non-alternating catalytic copolymerization. Science 2021, 347, 604-607).

### Example 32. Calculations for ΔMₙ (%) and Peroxide Index (PI)

The reduction in polymer molecular weight after thermal degradation is denoted by ΔMₙ (%) and can be expressed as:

$$Δ {M}_{n} ( \% ) = ( {MW}_{i} - {MW}_{f} ) / {MW}_{i} \times 100 \%$$

where, MW_{f}=MW of the polymer after thermal degradation with or without peroxide MWᵢ=MW of the polymer before thermal degradation.

The Peroxide Index (PI) is the ratio of change in polymer molecular weight in the presence of peroxide compared to that without peroxide.

$$PI = {[ Δ {M}_{n} ]}_{peroxide} / {[ Δ {M}_{n} ]}_{no peroxide}$$

where, [ΔMₙ]_{peroxide}=the change in polymer molecular weight in the presence of peroxide [ΔMₙ]_{no peroxide}=the change in polymer molecular weight in the absence of peroxide.

TABLE 23A
Polymer Degradation Studies

| | | | | | Recov. | | | | | |
|---|---|---|---|---|---|---|---|---|---|---|
| Polymer | Inc. | B | | Time | Polymer | % | Mₙ^{a} | | ΔMₙ | |
| Type | (%) | (/1000 C) | Peroxide | (h) | (mg) | Recov. | (kg/mol) | Ð^{a} | (%) | PI |
| PE^{b} | — | 17 | No | 0 | — | — | 18.5 | 1.8 | — | 4.3 |
| | | | No | 24 | 25 | 83 | 15.1 | 2.0 | 18 | |
| | | | Yes | 24 | 24 | 80 | 4.1 | 1.3 | 78 | |
| | — | 9 | No | 0 | — | — | 19.9 | 1.8 | — | 5.8 |
| | | | No | 24 | 27 | 90 | 17.4 | 2.0 | 12 | |
| | | | Yes | 24 | 25 | 83 | 5.9 | 3.1 | 70 | |
| | | | | | | | Average | | 15 (no | 5.0 |
| | | | | | | | | | perox.) | |
| | | | | | | | | | 74 (w/ | |
| | | | | | | | | | perox.) | |
| PE-MA^{c} | 0.78 | 9 | No | 0 | — | — | 23.3 | 1.6 | — | 7.4 |
| (Li⁺:Cs⁺ = | | | No | 24 | 25 | 83 | 20.7 | 1.7 | 11 | |
| 2:0) | | | Yes | 24 | 22 | 73 | 4.0 | 1.9 | 83 | |
| | 0.87 | 11 | No | 0 | — | — | 19.6 | 1.8 | — | 8.4 |
| | | | No | 24 | 26 | 87 | 17.4 | 2.0 | 11 | |
| | | | Yes | 24 | 23 | 77 | 1.4 | 2.5 | 93 | |
| | | | | | | | Average | | 11 (no | 7.9 |
| | | | | | | | | | perox. | |
| | | | | | | | | | 88 (w/ | |
| | | | | | | | | | perox.) | |
| PE-MA^{c} | 1.08 | 10 | No | 0 | — | — | 19.8 | 1.8 | — | 7.6 |
| (Li⁺:Cs⁺ = | | | No | 24 | 28 | 93 | 17.4 | 1.7 | 12 | |
| 1.5:0.5) | | | Yes | 24 | 25 | 83 | 1.3 | 2.6 | 93 | |
| | 1.18 | 18 | No | 0 | — | — | 20.2 | 1.7 | — | 7.6 |
| | | | No | 24 | 25 | 83 | 17.8 | 1.5 | 12 | |
| | | | Yes | 24 | 26 | 87 | 1.8 | 3.1 | 91 | |
| | | | | | | | Average | | 12 (no | 7.6 |
| | | | | | | | | | perox.) | |
| | | | | | | | | | 92 (w/ | |
| | | | | | | | | | perox.) | |
| PE-MA^{c} | 1.33 | 12 | No | 0 | — | — | 21.4 | 2.0 | — | 8.9 |
| (Li⁺:Cs⁺ = | | | No | 24 | 28 | 93 | 19.0 | 1.9 | 11 | |
| 1.1) | | | Yes | 24 | 25 | 83 | 0.4 | 2.1 | 98 | |
| | 1.41 | 17 | No | 0 | — | — | 20.4 | 1.8 | — | 24 |
| | | | No | 24 | 28 | 93 | 19.5 | 1.9 | 4 | |
| | | | Yes | 24 | 24 | 80 | 0.7 | 2.7 | 96 | |

| | | |
|---|---|---|
| Average | 7.5 (no | 12.9 |

perox.)
97 (w/
perox.)

^{a}Determined by GPC in trichlorobenzene at 150° C.
^{b}Polyethylene from Table 21A used for degradation.
^{c}Ethylene-MA copolymer from Table 22A used for degradation.

### Example 33. Polymer Mechanical Properties

Tensile tests were performed on an Instron Model 5567 equipped with a 1000 N load cell. The tensile bars were held in two clamps and extended at a rate of 10 mm/min at RT until failure. The T-bone tensile specimen (ASTM D638, type V) were made by compression molding using a hydraulic press. Two steel plates in the press were first pre-heated to 200° C. The mold was then filled with solid polymer powder and compressed at RT first. The filled mold was then sandwiched between two steel plates and placed between the two pre-heated steel plates. The compression force was ramped up from 5 to 20 ton in three steps. In each step, the force was held for 2 min before the pressure was released. The molds were then cooled to RT using an inbuilt water-cooling system, taken out, and kept at RT for 30 min. Tensile testing was then performed on the T-shaped molds to determine the strain and stress at break.

TABLE 24A
Tensile Strength Testing with Ethylene Homopolymers and Ethylene-MA Copolymers.

| | | | | | % | |
|---|---|---|---|---|---|---|
| | | | | | Elongation | Tensile |
| | | Inc. | Mn | Branching | at Break | Strength |
| Polymer Type | Entry | (%) | (kg/mol) | (/1000 C) | (%) | (MPa) |
| PE^{a} | 1 | 0 | 6.6 | 10 | 7.24 | 14.7 |
| | 2 | | | | 5.84 | 14.1 |
| | Average | 0 | 6.6 | 10 | 6.54 ± 0.99 | 14.4 ± 0.44 |
| PE-MA^{b} | 1 | 1.94 | 6.6 | 14 | 6.83 | 18.4 |
| (2 equiv. Cs⁺, 70° C.) | 2 | 1.87 | 7.4 | 10 | 5.82 | 19.2 |
| | Average | 1.90 | 7.0 | 12 | 6.33 ± 0.71 | 18.8 ± 0.56 |
| PE^{a} | 1 | 0 | 18.5 | 17 | 10.1 | 20.3 |
| | 2 | 0 | 19.9 | 9 | 8.4 | 19.1 |
| | Average | 0 | 19.2 | 13 | 9.2 ± 1.2 | 19.7 ± 0.85 |
| PE-MA^{b} | 1 | 0.78 | 23.3 | 9 | 11.3 | 24.8 |
| (Li*:Cs⁺ = 2:0) | 2 | 0.87 | 22.1 | 11 | 9.6 | 21.6 |
| | Average | 0.82 | 22.7 | 10 | 10.4 ± 1.2 | 23.2 ± 2.3 |
| PE-MA+ | 1 | 1.08 | 19.8 | 10 | 9.4 | 20.7 |
| (Li+:Cs⁺ = 1.5:0.5) | 2 | 1.18 | 20.2 | 18 | 11.6 | 21.7 |
| | Average | 1.13 | 20.0 | 14 | 10.5 ± 1.6 | 21.2 ± 0.7 |
| PE-MA^{b} | 1 | 1.33 | 21.4 | 12 | 8.6 | 20.2 |
| (Li⁺:Cs⁺ = 1:1) | 2 | 1.41 | 20.4 | 17 | 8.2 | 20.0 |
| | Average | 1.37 | 20.9 | 14 | 8.4 ± 0.3 | 20.1 ± 0.1 |

^{a}Polyethylene from Table 21A used for tensile testing.
^{b}Ethylene-MA copolymer from Table 22A used for tensile testing.

### Example 34. Water Contact Angle Measurements

The water contact angles on polymer films were measured with an Ossila Contact Angle Goniometer (Ossila BV, The Netherlands) using the static drop method.¹³ Samples for water contact angle measurements were prepared via evaporation of 5% (w/w) solutions of the polymer dissolved in hot toluene onto glass slides under ambient conditions. The solvent was evaporated on top of a glass slide, and a second layer of the polymer solution was then applied to increase the film thickness. The water contact angles of the polymer thin films were measured in at least six different positions at 25° C. with an accuracy of ±2°.

TABLE 25A
Water Contact Angle Measurements for Homo and Copolymers.

| Entry | Polymer Type | Incorporation (mol %) | Contact Angle (°) |
|---|---|---|---|
| 1 | PE^{a} | — | 107.6 |
| | | | 108.4 |
| | | | 107.3 |
| | | | 108.2 |
| | | | 107.9 |
| | | | 107.4 |
| | | Average | 107.8 ± 0.4 |
| 2 | PE-MA^{b} | 0.8 | 98.8 |
| | (Li⁺:Cs⁺ = 2:0) | | 99.3 |
| | | | 99.9 |
| | | | 100.1 |
| | | | 99.6 |
| | | | 99.9 |
| | | Average | 99.6 ± 0.5 |
| 3 | PE-MA^{b} | 1.1 | 96.7 |
| | (Li⁺:Cs⁺ = 1.5:0.5) | | 97.7 |
| | | | 98.5 |
| | | | 96.8 |
| | | | 98.9 |
| | | | 98.4 |
| | | Average | 97.8 ± 0.9 |
| 4 | PE-MA^{b} | 1.4 | 94.4 |
| | (Li⁺:Cs⁺ = 1:1) | | 95.0 |
| | | | 94.4 |
| | | | 93.0 |
| | | | 94.0 |
| | | | 93.3 |
| | | Average | 94.0 ± 0.7 |
| 5 | PE-MA^{c} | 2.1 | 89.4 |
| | (2 equiv. Cs⁺, 70° C.) | | 91.7 |
| | | | 91.1 |
| | | | 92.7 |
| | | | 93.0 |
| | | | 91.7 |
| | | Average | 91.6 ± 1.3 |

^{a}Polyethylene from Table 21A, Entry 1 used for WCA measurement.
^{b}Ethylene-MA copolymer from Table 22A used for WCA measurement.
^{c}Ethylene-MA copolymer from Table 7A, Entry 3 used for WCA measurement.

TABLE 26A
Comparison of Top-Performing Metal Catalysts Reported
for Ethylene and Methyl Acrylate Copolymerization.

| | Cat. | | | | | | | | | |
|---|---|---|---|---|---|---|---|---|---|---|
| | Amount | MA | C2H4 | Temp. | Time | Yield | Activity | Inc. | Mₙ | |
| Catalyst | (μmol) | (M) | (psi) | (° C.) | (h) | (g) | (kg/mol Ni · h) | (mol %) | (kg/mol) | Ð |
| A (Ni[P, O])¹⁴ | 80 | 0.04 | 435 | 70 | 1 | 6.88 | 86 | 4.5 | 34 | 2 |
| B (Pd[P, O])⁴ | 15 | 1.5 | 411 | 80 | — | — | 150 | 2.6 | 0.8 | 1.8 |
| C (Ni[N, N])¹⁵ | 10 | 0.1 | 88 | 40 | 4 | 0.6 | 15 | 0.5 | 4.5 | 1.6 |
| D (Pd[P, O])¹⁶ | 0.75 | 2.2 | 435 | 80 | 1 | 0.41 | 540 | 0.5 | 6.9 | 2.9 |
| E (Pd[P, O])¹⁷ | 20 | 1 | 132 | 100 | 1 | 0.6 | 30 | 10 | 11 | 2.08 |
| F (Pd[P, O])¹⁸ | 10 | 5.5 | 435 | 90 | 15 | 2.59 | 17 | 13 | 3.2 | 1.64 |
| G (Ni[P, O])¹⁹ | 3 | 0.05 | 290 | 50 | 1 | 6.61 | 2200 | 0.32 | 2700 | 1.62 |
| H (Ni[P, O])²⁰ | 5 | 0.05 | 441 | 80 | 0.5 | 1.14 | 456 | 0.5 | 147 | 2.9 |
| I (Ni[P, O])²¹ | 5 | 0.1 | 118 | 80 | 0.5 | 0.2 | 80 | 2.3 | 10.6 | 2,2 |
| Ni1-Li (this | 2 | 0.05 | 400 | 30 | 0.5 | 1.02 | 1020 | 0.71 | 18.9 | 1.4 |
| work) | | | | | | | | | | |

¹⁴Xin, B. S.; Sato N.; Tanna, A.; Oishi, Y.; Konishi, Y.; Shimizu, F. Nickel Catalyzed Copolymerization of Ethylene and Alkyl Acrylates J. Am. Chem. Soc. 2017, 139, 311-3614.
⁴Contrella, N. D.; Sampson, J. R.; Jordan, R. F. Copolymerization of Ethylene and Methyl Acrylate by Cationic Palladium Catalysts That Contain Phosphine-Diethyl Phosphonate Ancillary Ligands. Organometallics 2014, 33, 3546-3555
¹⁵Saki, Z.; D'Auria, I; Dall'anese, A.; Milani, B.; Pellecchia, C. Copolymerization of Ethylene and Methyl Acrylate by PyridyliminoNi(II) Catalysts Affording Hyperbranched Poly(ethylene-co-methylacrylate)s with Tunable Structures of the Ester Groups. Macromolecules 2020, 53, 9294-9305.
¹⁶Mitsushige, Y.; Carrow, B. P.; Ito, S.; Nozaki, K. Ligand-controlled insertion regioselectivity accelerates copolymerisation of ethylene with methyl acrylate by cationic bisphosphine monoxide-palladium catalysts. Chem. Sci. 2016, 7, 737-744.
¹⁷Sui, X.; Dai, S.; Chen, C. Ethylene Polymerization and Copolymerization with Polar Monomers by Cationic Phosphine Phosphonic Amide Palladium Complexes. ACS Catal. 2015, 5, 5932-5937.
¹⁸Kochi, T.; Yoshimura, K.; Nozaki, K. Synthesis of anionic methylpalladium complexes with phosphine-sulfonate ligands and their activities for olefin polymerization. Dalton Trans. 2006, 25-27.
¹⁹Yang, Q.; Kang, X.; Liu, Y.; Mu, H.; Jian, Z. Ultrahigh Molecular Weight Ethylene-Acrylate Copolymers Synthesized with Highly Active Neutral Nickel Catalysts. Angew. Chem. Int. Ed. 2025, e202421904.
²⁰Zou, C.; Si, G.; Chen, C. A general strategy for heterogenizing olefin polymerization catalysts and the synthesis of polyolefins and composites. Nat. Commun. 2022, 13, 1954.
²¹Wang, W.; Nie, N.; Xu, M., Zou, C. Lewis acid modulation in phosphorus phenol nickel catalyzed ethylene polymerization and copolymerization. Polym. Chem. 2023, 14, 4933-4939.

The various methods and techniques described above provide a number of ways to carry out the application. Of course, it is to be understood that not necessarily all objectives or advantages described can be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as taught or suggested herein. A variety of alternatives are mentioned herein. It is to be understood that some preferred embodiments specifically include one, another, or several features, while others specifically exclude one, another, or several features, while still others mitigate a particular feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be employed in various combinations by one of ordinary skill in this art to perform methods in accordance with the principles described herein. Among the various elements, features, and steps some will be specifically included and others specifically excluded in diverse embodiments.

Although the application has been disclosed in the context of certain embodiments and examples, it will be understood by those skilled in the art that the embodiments of the application extend beyond the specifically disclosed embodiments to other alternative embodiments and/or uses and modifications and equivalents thereof.

Preferred embodiments of this application are described herein, including the best mode known to the inventors for carrying out the application. Variations on those preferred embodiments will become apparent to those of ordinary skill in the art upon reading the foregoing description. It is contemplated that skilled artisans can employ such variations as appropriate, and the application can be practiced otherwise than specifically described herein. Accordingly, many embodiments of this application include all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

All patents, patent applications, publications of patent applications, and other material, such as articles, books, specifications, publications, documents, things, and/or the like, referenced herein are hereby incorporated herein by this reference in their entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

It is to be understood that the embodiments of the application disclosed herein are illustrative of the principles of the embodiments of the application. Other modifications that can be employed can be within the scope of the application. Thus, by way of example, but not of limitation, alternative configurations of the embodiments of the application can be utilized in accordance with the teachings herein. Accordingly, embodiments of the present application are not limited to that precisely as shown and described.

Various embodiments of the invention are described above in the Detailed Description. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventors that the words and phrases in the specification and claims be given the ordinary and accustomed meanings to those of ordinary skill in the applicable art(s).

The foregoing description of various embodiments of the invention known to the applicant at this time of filing the application has been presented and is intended for the purposes of illustration and description. The present description is not intended to be exhaustive nor limit the invention to the precise form disclosed and many modifications and variations are possible in the light of the above teachings. The embodiments described serve to explain the principles of the invention and its practical application and to enable others skilled in the art to utilize the invention in various embodiments and with various modifications as are suited to the particular use contemplated. Therefore, it is intended that the invention not be limited to the particular embodiments disclosed for carrying out the invention.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention.

What is claimed is:

1. A method for catalyzing copolymerization of a first optionally substituted olefin and at least one other optionally substituted olefin, comprising:
providing at least one catalyst having a structure selected from Formula (1) and Formula (2): 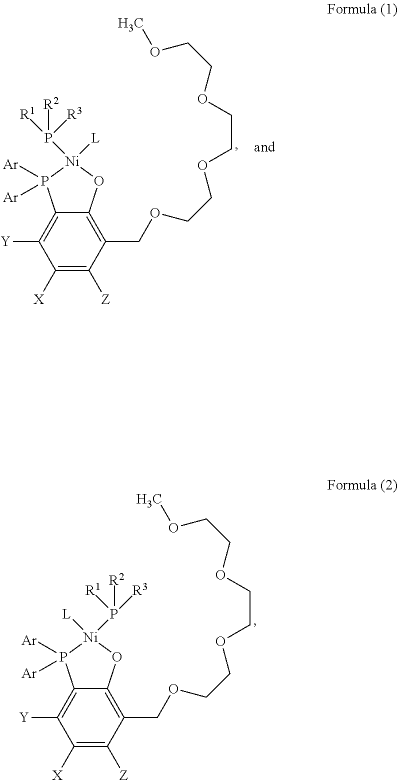
wherein in Formula (1) and Formula (2):
Ar is 2,6-dimethoxyphenyl or 2-methoxyphenyl;
L is an optionally substituted phenyl group;
X, Y, and Z are each independently selected from hydrogen, an electron donating group, and an electron withdrawing group; and
R¹, R², and R³ are each independently selected from optionally substituted aryl, optionally substituted alkyl, and optionally substituted cycloalkyl;
providing at least one alkali salt;
providing a first optionally substituted olefin;
providing at least one other optionally substituted olefin, wherein the at least one other optionally substituted olefin is an acrylamide, acrylic acid, acrylic ester, vinyl halide, vinyl alcohol, or allyl alcohol; and
contacting the first optionally substituted olefin and the at least one other optionally substituted olefin with the at least one catalyst and the at least one alkali salt, whereby the first optionally substituted olefin and the at least one other optionally substituted olefin undergoes copolymerization to form a copolymer, and wherein the first optionally substituted olefin and the at least one other optionally substituted olefin are different from one another.

2. The method of claim 1, wherein X is selected from hydrogen, an electron donating group, and an electron withdrawing group; and Y and Z are each independently selected from hydrogen, an electron donating group, and an electron withdrawing group, provided that Y and Z are not both hydrogen.

3. The method of claim 1, wherein the electron donating group is selected from the group consisting of: alkoxy, phenoxy, amino, alkylamino, dialkylamino, hydroxy, alkyl, and cycloalkyl; and the electron withdrawing group is selected from the group consisting of: —NO₂, —CN, —C(O)-alkyl, —C(O)Oalkyl, —C(O)Nalkyl, —SO₃H, —SO₂alkyl, —PO₃H, —PO₃alkyl, —CF₃, and -halo.

4. The method of claim 1, wherein the at least one alkali salt comprises an alkali cation and a weakly coordinating anion.

5. The method of claim 4, wherein the alkali cation is Li⁺, Na⁺, K⁺, or Cs⁺.

6. The method of claim 4, wherein the weakly coordinating anion is tetrakis(3,5-bis(trifluoromethyl)phenyl)borate, tetrakis(pentafluorophenyl)borate, tetraphenylborate, trifluoromethylsulfonate, hexafluorophosphate, hexafluoroantimonate, or tetrafluoroborate.

7. The method of claim 1, wherein the at least one alkali salt is lithium tetrakis(3,5-bis(trifluoromethyl)phenyl)borate, sodium tetrakis(3,5-bis(trifluoromethyl)phenyl)borate, potassium tetrakis(3,5-bis(trifluoromethyl)phenyl)borate, or cesium tetrakis(3,5-bis(trifluoromethyl)phenyl)borate, or any combination thereof.

8. The method of claim 1, wherein the first optionally substituted olefin is ethylene, propene, butene, 1-hexene, 1-heptene, 1-octene, styrene, allylbenzene, 2-hexene, 3-hexene, 2-heptene, 3-heptene, 2-octene, 3-octene, or 4-octene.

9. The method of claim 1, wherein the first optionally substituted olefin is ethylene.

10. The method of claim 8, wherein the at least one other optionally substituted olefin is an acrylic ester.

11. The method of claim 10, wherein the acrylic ester is methyl acrylate, ethyl acrylate, n-propyl acrylate, isopropyl acrylate, n-butyl acrylate, isobutyl acrylate, or tert-butyl acrylate, or any combination thereof.

12. The method of claim 9, wherein the at least one other optionally substituted olefin is an acrylic ester.

13. The method of claim 12, wherein the acrylic ester is methyl acrylate, ethyl acrylate, n-propyl acrylate, isopropyl acrylate, n-butyl acrylate, isobutyl acrylate, or tert-butyl acrylate, or any combination thereof.

14. The method of claim 1, wherein the step of contacting the first optionally substituted olefin and the at least one other optionally substituted olefin with the at least one catalyst and the at least one alkali salt is performed in the presence of at least one solvent.

15. The method of claim 14, wherein the at least one solvent is a non-polar solvent, a polar solvent, or combination thereof.

16. The method of claim 1, further comprising contacting at least one activator with the at least one catalyst, the at least one alkali salt, the first optionally substituted olefin, and the at least one other optionally substituted olefin.

17. The method of claim 16, wherein the at least one activator is selected from the group consisting of Ni(COD)₂, triarylborane, methylaluminoxane, and trialkylaluminum.

18. The method of claim 1, further comprising contacting the copolymer with at least one peroxide.

19. The method of claim 18, wherein the at least one peroxide is at least one organic peroxide, at least one inorganic peroxide, or any combination thereof.

20. The method of claim 18, wherein the at least one peroxide is tert-butylperoxy 2-ethylhexyl carbonate, dicumyl peroxide, polyether poly(t-butyl)-peroxycarbonate, or t-amyl peroxyacetate.
